(19) United States
(12) Patent Application Publication
(10) Pub. No.: US 2019/0372449 A1
(43) Pub. Date: Dec. 5, 2019

(54) MAGNETOHYDRODYNAMIC ELECTRIC POWER GENERATOR

(71) Applicant: BRILLIANT LIGHT POWER, INC., CRANBURY, NJ (US)

(72) Inventor: RANDELL L. MILLS, CRANBURY, NJ (US)

(73) Assignee: BRILLIANT LIGHT POWER, INC., CRANBURY, NJ (US)

(21) Appl. No.: 16/485,124

(22) PCT Filed: Feb. 12, 2018
(86) PCT No.: PCT/US2018/017765

§ 371 Date: Aug. 9, 2019

Related U.S. Application Data
(60) Provisional application No. 62/457,935, filed on Feb. 12, 2017.
(60) Provisional application No. 62/461,768, filed on Feb. 21, 2017.
(60) Provisional application No. 62/463,684, filed on Feb. 26, 2017.
(60) Provisional application No. 62/481,571, filed on Apr. 4, 2017.
(60) Provisional application No. 62/513,284, filed on May 31, 2017.
(60) Provisional application No. 62/513,324, filed on May 31, 2017.
(60) Provisional application No. 62/524,307, filed on Jun. 23, 2017.
(60) Provisional application No. 62/532,986, filed on Jul. 14, 2017.
(60) Provisional application No. 62/537,353, filed on Jul. 26, 2017.
(60) Provisional application No. 62/545,463, filed on Aug. 14, 2017.
(60) Provisional application No. 62/556,941, filed on Sep. 11, 2017.
(60) Provisional application No. 62/573,453, filed on Oct. 17, 2017.
(60) Provisional application No. 62/584,632, filed on Nov. 10, 2017.
(60) Provisional application No. 62/594,511, filed on Dec. 4, 2017.
(60) Provisional application No. 62/612,304, filed on Dec. 29, 2017.
(60) Provisional application No. 62/618,444, filed on Jan. 17, 2018.

(51) Int. Cl. H02K 44/08; H02K 44/04; H02K 44/06; H02S 10/30

(52) U.S. Cl. CPC H02K 44/085; H02S 10/30; H02K 44/06; H02K 44/04

(57) ABSTRACT

A power generator that provides at least one of electrical and thermal power comprising (i) at least one reaction cell for the catalysis of atomic hydrogen to form hydrinos identifiable by unique analytical and spectroscopic signatures, (ii) a reaction mixture comprising at least two components chosen from: a source of H₂O catalyst or H₂O catalyst; a source of atomic hydrogen or atomic hydrogen; reactants to form the source of H₂O catalyst or H₂O catalyst and a source of atomic hydrogen or atomic hydrogen; and a molten metal to cause the reaction mixture to be highly conductive, (iii) a molten metal injection system comprising at least one pump such as an electromagnetic pump that causes a plurality of molten metal streams to intersect, (iv) an ignition system comprising an electrical power source that provides low-voltage, high-current electrical energy to the plurality of intersected molten metal streams to ignite a plasma to initiate rapid kinetics of the hydrino reaction and an energy gain due to forming hydrinos, (v) a source of H₂ and O₂ supplied to the plasma, (vi) a molten metal recovery system, and (vii) a power converter capable of (a) converting the high-power light output from a blackbody radiator of the cell into electricity using concentrator thermophotovoltaic cells or (b) converting the energetic plasma into electricity using a magnetohydrodynamic converter.

### CROSS-REFERENCES OF RELATED APPLICATIONS

This application claims the benefit of U.S. Provisional Application Nos. 62/457,935, filed Feb. 12, 2017, 62/461,768, filed Feb. 21, 2017, 62/463,684, filed Feb. 26, 2017, 62/481,571, filed Apr. 4, 2017, 62/513,284, filed May 31, 2017, 62/513,324, filed May 31, 2017, 62/524,307, filed Jun. 23, 2017, 62/532,986, filed Jul. 14, 2017, 62/537,353, filed Jul. 26, 2017, 62/545,463, filed Aug. 14, 2017, 62/556,941, filed Sep. 11, 2017, 62/573,453, filed Oct. 17, 2017, 62/584,632, filed Nov. 10, 2017, 62/594,511, filed Dec. 4, 2017, 62/612,304, filed Dec. 29, 2017, and 62/618,444, filed Jan. 17, 2018, all of which are incorporated herein by reference.

The present disclosure relates to the field of power generation and, in particular, to systems, devices, and methods for the generation of power. More specifically, embodiments of the present disclosure are directed to power generation devices and systems, as well as related methods, which produce optical power, plasma, and thermal power and produces electrical power via a magnetohydrodynamic power converter, an optical to electric power converter, plasma to electric power converter, photon to electric power converter, or a thermal to electric power converter. In addition, embodiments of the present disclosure describe systems, devices, and methods that use the ignition of a water or water-based fuel source to generate optical power, mechanical power, electrical power, and/or thermal power using photovoltaic power converters. These and other related embodiments are described in detail in the present disclosure.

Power generation can take many forms, harnessing the power from plasma. Successful commercialization of plasma may depend on power generation systems capable of efficiently forming plasma and then capturing the power of the plasma produced.

Plasma may be formed during ignition of certain fuels. These fuels can include water or water-based fuel source. During ignition, a plasma cloud of electron-stripped atoms is formed, and high optical power may be released. The high optical power of the plasma can be harnessed by an electric converter of the present disclosure. The ions and excited state atoms can recombine and undergo electronic relaxation to emit optical power. The optical power can be converted to electricity with photovoltaics.

Certain embodiments of the present disclosure are directed to a power generation system comprising: a plurality of electrodes such as solid or molten metal electrodes configured to deliver power to a fuel to ignite the fuel and produce a plasma; a source of electrical power configured to deliver electrical energy to the plurality of electrodes; and at least one magnetohydrodynamic power converter positioned to receive high temperature and pressure plasma or at least one photovoltaic (“PV”) power converter positioned to receive at least a plurality of plasma photons.

In an embodiment, a SunCell® power system that generates at least one of electrical energy and thermal energy comprises at least one vessel capable of a maintaining a pressure of below, at, or above atmospheric; reactants comprising: (i) at least one source of catalyst or a catalyst comprising nascent H₂O, (ii) at least one source of H₂O or H₂O, (iii) at least one source of atomic hydrogen or atomic hydrogen, and (iv) a molten metal; a molten metal injection system comprising at least two molten metal reservoirs each comprising a pump and an injector tube; at least one reactant supply system to replenish reactants that are consumed in a reaction of the reactants to generate at least one of the electrical energy and thermal energy; at least one ignition system comprising a source of electrical power to supply opposite voltages to the at least two molten metal reservoirs each comprising an electromagnetic pump, and at least one power converter or output system of at least one of the light and thermal output to electrical power and/or thermal power.

In an embodiment, the molten metal may comprise any conductive metal or alloy known in the art. The molten metal or alloy may have a low melting point. Exemplary metals and alloys are gallium, indium, tin, zinc, and Galinstan alloy wherein an example of a typical eutectic mixture is 68% Ga, 22% In, and 10% Sn (by weight) though proportions may vary between 62-95% Ga, 5-22% In, 0-16% Sn (by weight). In an embodiment wherein the metal may be reactive with at least one of oxygen and water to form the corresponding metal oxide, the hydrino reaction mixture may comprise the molten metal, the metal oxide, and hydrogen. The metal oxide may serve as the source of oxygen to form HOH catalyst. The oxygen may be recycled between the metal oxide and HOH catalyst wherein hydrogen consumed to form hydrino may be resupplied.

The molten metal injection system may comprise at least two molten metal reservoirs each comprising an electromagnetic pump to inject streams of the molten metal that intersect inside of the vessel wherein each reservoir may comprise a molten metal level controller comprising an inlet riser tube. The ignition system may comprise a source of electrical power to supply opposite voltages to the at least two molten metal reservoirs each comprising an electromagnetic pump that supplies current and power flow through the intersecting streams of molten metal to cause the reaction of the reactants comprising ignition to form a plasma inside of the vessel. The ignition system may comprise: (i) the source of electrical power to supply opposite voltages to the at least two molten metal reservoirs each comprising an electromagnetic pump and (ii) at least two intersecting streams of molten metal ejected from the at least two molten metal reservoirs each comprising an electromagnetic pump wherein the source of electrical power is capable of delivering a short burst of high-current electrical energy sufficient to cause the reactants to react to form plasma. The source of electrical power to deliver a short burst of high-current electrical energy sufficient to cause the reactants to react to form plasma may comprise at least one supercapacitor. Each electromagnetic pump may comprise one of a (i) DC or AC conduction type comprising a DC or AC current source supplied to the molten metal through electrodes and a source of constant or in-phase alternating vector-crossed magnetic field, or (ii) an induction type comprising a source of alternating magnetic field through a shorted loop of molten metal that induces an alternating current in the metal and a source of in-phase alternating vector-crossed magnetic field. At least one union of the pump and corresponding reservoir or another union between parts comprising the vessel, injection system, and converter may comprise at least one of a wet seal, a flange and gasket seal, an adhesive seal, and a slip nut seal wherein the gasket may comprise carbon. The DC or AC current of the molten metal ignition system may be in the range of 10 A to 50,000 A. The circuit of the molten metal ignition system may be closed by the intersection of the molten metal streams to cause ignition to further cause an ignition frequency in the range of 0 Hz to 10,000 Hz. The induction-type electromagnetic pump may comprise ceramic channels that form the shorted loop of molten metal. The power system may further comprise an inductively coupled heater to form the molten metal from the corresponding solid metal wherein the molten metal may comprise at least one of silver, silver-copper alloy, and copper. The power system may further comprise a vacuum pump and at least one chiller. The power system may comprise at least one power converter or output system of the reaction power output such as at least one of the group of a thermophotovoltaic converter, a photovoltaic converter, a photoelectronic converter, a magnetohydrodynamic converter, a plasmadynamic converter, a thermionic converter, a thermoelectric converter, a Sterling engine, a Brayton cycle engine, a Rankine cycle engine, and a heat engine, a heater, and a boiler. The boiler may comprise a radiant boiler. A portion of the reaction vessel may comprise a blackbody radiator that may be maintained at a temperature in the range of 1000 K to 3700 K. The reservoirs of the power system may comprise boron nitride, the portion of the vessel that comprises the blackbody radiator may comprise carbon, and the electromagnetic pump parts in contact with the molten metal may comprise an oxidation resistant metal or ceramic. The hydrino reaction reactants may comprise at least one of methane, carbon monoxide, carbon dioxide, hydrogen, oxygen, and water. The reactants supply may maintain each of the methane, carbon monoxide, carbon dioxide, hydrogen, oxygen, and water at a pressure in the range of 0.01 Torr to 1 Torr. The light emitted by the blackbody radiator of the power system that is directed to the thermophotovoltaic converter or a photovoltaic converter may be predominantly blackbody radiation comprising visible and near infrared light, and the photovoltaic cells may be concentrator cells that comprise at least one compound chosen from crystalline silicon, germanium, gallium arsenide (GaAs), gallium antimonide (GaSb), indium gallium arsenide (InGaAs), indium gallium arsenide antimonide (InGaAsSb), indium phosphide arsenide antimonide (InPAsSb), InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GalnAs—Ge. The light that is emitted by the reaction plasma and that is directed to the thermophotovoltaic converter or a photovoltaic converter may be predominantly ultraviolet light, and the photovoltaic cells may be concentrator cells that comprise at least one compound chosen from a Group III nitride, GaN, AlN, GaAlN, and InGaN.

In an embodiment, the PV converter may further comprise a UV window to the PV cells. The PV window may replace at least a portion of the blackbody radiator. The window may be substantially transparent to UV. The window may be resistant to wetting with the molten metal. The window may operate at a temperature that is at least one of above the melting point of the molten metal and above the boiling point of the molten metal. Exemplary windows are sapphire, quartz, MgF₂, and fused silica. The window may be cooled and may comprise a means for cleaning during operation or during maintenance. The SunCell® may further comprise a source of at least one of electric and magnetic fields to confine the plasma in a region that avoids contact with at least one of the window and the PV cells. The source may comprise an electrostatic precipitation system. The source may comprise a magnetic confinement system. The plasma may be confined by gravity wherein at least one of the window and PV cells are at a suitable height about the position of plasma generation.

Alternatively, the magnetohydrodynamic power converter may comprise a nozzle connected to the reaction vessel, a magnetohydrodynamic channel, electrodes, magnets, a metal collection system, a metal recirculation system, a heat exchanger, and optionally a gas recirculation system wherein the reactants may comprise at least one of H₂O vapor, oxygen gas, and hydrogen gas. The reactants supply may maintain each of the O₂, the H₂, and a reaction product H₂O at a pressure in the range of 0.01 Torr to 1 Torr. The reactants supply system to replenish the reactants that are consumed in a reaction of the reactants to generate at least one of the electrical energy and thermal energy may comprise at least one of O₂ and H₂ gas supplies, a gas housing, a selective gas permeable membrane in the wall of at least one of the reaction vessel, the magnetohydrodynamic channel, the metal collection system, and the metal recirculation system, O₂, H₂, and H₂O partial pressure sensors, flow controllers, at least one valve, and a computer to maintain at least one of the O₂ and H₂ pressures. In an embodiment, at least one component of the power system may comprise ceramic wherein the ceramic may comprise at least one of a metal oxide, alumina, zirconia, magnesia, hafnia, silicon carbide, zirconium carbide, zirconium diboride, and silicon nitride. The molten metal may comprise silver, and the magnetohydrodynamic converter may further comprise a source of oxygen to form an aerosol of silver particles supplied to at least one of the reservoirs, reaction vessel, magnetohydrodynamic nozzle, and magnetohydrodynamic channel wherein the reactants supply system may additionally supply and control the source of oxygen to form the silver aerosol. The molten metal may comprise silver. The magnetohydrodynamic converter may further comprise a cell gas comprising ambient gas in contact with the silver in at least one of the reservoirs and the vessel. The power system may further comprise a means to maintain a flow of cell gas in contact with the molten silver to form silver aerosol wherein the cell gas flow may comprise at least one of forced gas flow and convection gas flow. The cell gas may comprise at least one of a noble gas, oxygen, water vapor, H₂, and O₂. The means to maintain the cell gas flow may comprise at least one of a gas pump or compressor such as a magnetohydrodynamic gas pump or compressor, the magnetohydrodynamic converter, and a turbulent flow caused by at least one of the molten metal injection system and the plasma.

The inductive type electromagnetic pump of the power system may comprise a two-stage pump comprising a first stage that comprises a pump of the metal recirculation system, and the second stage comprises the pump of the metal injection system to inject the stream of the molten metal that intersects with the other inside of the vessel. The source of electrical power of the ignition system may comprise an induction ignition system that may comprise a source of alternating magnetic field through a shorted loop of molten metal that generates an alternating current in the metal that comprises the ignition current. The source of alternating magnetic field may comprise a primary transformer winding comprising a transformer electromagnet and a transformer magnetic yoke, and the silver may at least partially serve as a secondary transformer winding such as a single turn shorted winding that encloses the primary transformer winding and comprises as an induction current loop. The reservoirs may comprise a molten metal cross connecting channel that connects the two reservoirs such that the current loop encloses the transformer yoke wherein the induction current loop comprises the current generated in molten silver contained in the reservoirs, the cross connecting channel, the silver in the injector tubes, and the injected streams of molten silver that intersect to complete the induction current loop.

In an embodiment, the emitter generates at least one of electrical energy and thermal energy wherein the emitter comprises at least one vessel capable of a maintaining a pressure of below, at, or above atmospheric; reactants, the reactants comprising: a) at least one source of catalyst or a catalyst comprising nascent H2O; b) at least one source of H2O or H2O; c) at least one source of atomic hydrogen or atomic hydrogen that may permeate through the wall of the vessel; d) a molten metal such as silver, copper, or silver-copper alloy; and e) an oxide such as at least one of CO₂, B₂O₃, LiVO₃, and a stable oxide that does not react with H₂; at least one molten metal injection system comprising a molten metal reservoir and an electromagnetic pump; at least one reactant ignition system comprising a source of electrical power to cause the reactants to form at least one of light-emitting plasma and thermal-emitting plasma wherein the source of electrical power receives electrical power from the power converter; a system to recover the molten metal and oxide; at least one power converter or output system of at least one of the light and thermal output to electrical power and/or thermal power; wherein the molten metal ignition system comprises at least one of ignition system comprising i) an electrode from the group of: a) at least one set of refractory metal or carbon electrodes to confine the molten metal; b) a refractory metal or carbon electrode and a molten metal stream delivered by an electromagnetic pump from an electrically isolated molten metal reservoir, and c) at least two molten metal streams delivered by at least two electromagnetic pumps from a plurality of electrically isolated molten metal reservoirs; and ii) a source of electrical power to deliver high-current electrical energy sufficient to cause the reactants to react to form plasma wherein the molten metal ignition system current is in the range of 50 A to 50,000 A; wherein the molten metal injection system comprises an electromagnetic pump comprising at least one magnet providing a magnetic field and current source to provide a vector-crossed current component; wherein the molten metal reservoir comprises an inductively coupled heater; the emitter further comprising a system to recover the molten metal and oxide such as at least one of the vessel comprising walls capable of providing flow to the melt under gravity and the reservoir in communication with the vessel and further comprising a cooling system to maintain the reservoir at a lower temperature than then the vessel to cause metal to collect in the reservoir; wherein the vessel capable of a maintaining a pressure of below, at, or above atmospheric comprises an inner reaction cell comprising a high temperature blackbody radiator, and an outer chamber capable of maintaining a pressure of below, at, or above atmospheric; wherein the blackbody radiator is maintained at a temperature in the range of 1000 K to 3700 K; wherein the inner reaction cell comprising a blackbody radiator comprises a refractory material such as carbon or W; wherein the blackbody radiation emitted from the exterior of the cell is incident on the light-to-electricity power converter; wherein the at least one power converter of the reaction power output comprises at least one of a thermophotovoltaic converter and a photovoltaic converter; wherein the light emitted by the cell is predominantly blackbody radiation comprising visible and near infrared light, and the photovoltaic cells are concentrator cells that comprise at least one compound chosen from crystalline silicon, germanium, gallium arsenide (GaAs), gallium antimonide (GaSb), indium gallium arsenide (InGaAs), indium gallium arsenide antimonide (InGaAsSb), and indium phosphide arsenide antimonide (InPAsSb), Group III/V semiconductors, InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge, and the power system further comprises a vacuum pump and at least one heat rejection system and the blackbody radiator further comprises a blackbody temperature sensor and controller. Optionally, the emitter may comprise at least one additional reactant injection system, wherein the additional reactants comprise: a) at least one source of catalyst or a catalyst comprising nascent H2O; b) at least one source of H2O or H2O, and c) at least one source of atomic hydrogen or atomic hydrogen. The additional reactant injection system may further comprise at least one of a computer, H2O and H2 pressure sensors, and flow controllers comprising at least one or more of the group of a mass flow controller, a pump, a syringe pump, and a high precision electronically controllable valve; the valve comprising at least one of a needle valve, proportional electronic valve, and stepper motor valve wherein the valve is controlled by the pressure sensor and the computer to maintain at least one of the H2O and H2 pressure at a desired value; wherein the additional reactants injection system maintains the H2O vapor pressure in the range of 0.1 Torr to 1 Torr.

In an embodiment, the generator that produces power by the conversion of H to hydrino may produce at least one of the following products from hydrogen:

a) a hydrogen product with a Raman peak at integer multiple of 0.23 to 0.25 cm⁻¹ plus a matrix shift in the range of 0 to 2000 cm⁻¹;

b) a hydrogen product with a infrared peak at integer multiple of 0.23 to 0.25 cm⁻¹ plus a matrix shift in the range of 0 to 2000 cm⁻¹;

c) a hydrogen product with an X-ray photoelectron spectroscopy peak at an energy in the range of 500 to 525 eV plus a matrix shift in the range of 0 to 10 eV;

d) a hydrogen product that causes an upfield MAS NMR matrix shift;

e) a hydrogen product that has an upfield MAS NMR or liquid NMR shift of greater than −5 ppm relative to TMS;

f) a hydrogen product with at least two electron-beam emission spectral peaks in the range of 200 to 300 nm having a spacing at an integer multiple of 0.23 to 0.3 cm⁻¹ plus a matrix shift in the range of 0 to 5000 cm⁻¹; and

g) a hydrogen product with at least two UV fluorescence emission spectral peaks in the range of 200 to 300 nm having a spacing at an integer multiple of 0.23 to 0.3 cm⁻¹ plus a matrix shift in the range of 0 to 5000 cm⁻¹.

In one embodiment, the present disclosure is directed to a power system that generates at least one of electrical energy and thermal energy comprising:
at least one vessel capable of a maintaining a pressure of below, at, or above atmospheric;
   reactants, the reactants comprising:
   a) at least one source of catalyst or a catalyst comprising nascent H₂O;
   b) at least one source of H₂O or H₂O;
   c) at least one source of atomic hydrogen or atomic hydrogen; and
   d) a molten metal;
   at least one molten metal injection system comprising a molten metal reservoir and an electromagnetic pump;
   at least one additional reactants injection system, wherein the additional reactants comprise:
   a) at least one source of catalyst or a catalyst comprising nascent H₂O;
   b) at least one source of H₂O or H₂O, and
   c) at least one source of atomic hydrogen or atomic hydrogen.
   at least one reactants ignition system comprising a source of electrical power,
wherein the source of electrical power receives electrical power from the power converter;
   a system to recover the molten metal;
   at least one power converter or output system of at least one of the light and thermal output to electrical power and/or thermal power.
In an embodiment, the molten metal ignition system comprises:
   a) at least one set of electrodes to confine the molten metal; and
   b) a source of electrical power to deliver a short burst of high-current electrical energy sufficient to cause the reactants to react to form plasma.
   The electrodes may comprise a refractory metal.
In an embodiment, the source of electrical power that delivers a short burst of high-current electrical energy sufficient to cause the reactants to react to form plasma comprises at least one supercapacitor.
The molten metal injection system may comprise an electromagnetic pump comprising at least one magnet providing a magnetic field and current source to provide a vector-crossed current component.
The molten metal reservoir may comprise an inductively coupled heater.
The molten metal ignition system may comprise at least one set of electrodes that are separated to form an open circuit, wherein the open circuit is closed by the injection of the molten metal to cause the high current to flow to achieve ignition.
The molten metal ignition system current may be in the range of 500 A to 50,000 A.
The circuit of the molten metal ignition system may be closed by metal injection to cause an ignition frequency in the range of 1 Hz to 10,000 Hz wherein the molten metal comprises at least one of silver, silver-copper alloy, and copper and the addition reactants may comprise at least one of H₂O vapor and hydrogen gas.
In an embodiment, the additional reactants injection system may comprise at least one of a computer, H₂O and H₂ pressure sensors, and flow controllers comprising at least one or more of the group of a mass flow controller, a pump, a syringe pump, and a high precision electronically controllable valve; the valve comprising at least one of a needle valve, proportional electronic valve, and stepper motor valve wherein the valve is controlled by the pressure sensor and the computer to maintain at least one of the H₂O and H₂ pressure at a desired value.
The additional reactants injection system may maintain the H₂O vapor pressure in the range of 0.1 Torr to 1 Torr.
In an embodiment, the system to recover the products of the reactants comprises at least one of the vessel comprising walls capable of providing flow to the melt under gravity, an electrode electromagnetic pump, and the reservoir in communication with the vessel and further comprising a cooling system to maintain the reservoir at a lower temperature than another portion of the vessel to cause metal vapor of the molten metal to condense in the reservoir
wherein the recovery system may comprise an electrode electromagnetic pump comprising at least one magnet providing a magnetic field and a vector-crossed ignition current component.

In an embodiment, the power system comprises a vessel capable of a maintaining a pressure of below, at, or above atmospheric comprising an inner reaction cell, a top cover comprising a blackbody radiator, and an outer chamber capable of maintaining the a pressure of below, at, or above atmospheric.

wherein the top cover comprising a blackbody radiator is maintained at a temperature in the range of 1000 K to 3700 K

wherein at least one of the inner reaction cell and top cover comprising a blackbody radiator comprises a refractory metal having a high emissivity.

The power system may comprise at least one power converter of the reaction power output comprising at least one of the group of a thermophotovoltaic converter, a photovoltaic converter, a photoelectronic converter, a plasmadynamic converter, a thermionic converter, a thermoelectric converter, a Sterling engine, a Brayton cycle engine, a Rankine cycle engine, and a heat engine, and a heater.

In an embodiment, the light emitted by the cell is predominantly blackbody radiation comprising visible and near infrared light, and the photovoltaic cells are concentrator cells that comprise at least one compound chosen from perovskite, crystalline silicon, germanium, gallium arsenide (GaAs), gallium antimonide (GaSb), indium gallium arsenide (InGaAs), indium gallium arsenide antimonide (InGaAsSb), indium phosphide arsenide antimonide (InPAsSb), InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge.

In an embodiment, the light emitted by the cell is predominantly ultraviolet light, and the photovoltaic cells are concentrator cells that comprise at least one compound chosen from a Group III nitride, GaN, AlN, GaAlN, and InGaN.

The power system may further comprise a vacuum pump and at least one chiller. In one embodiment, the present disclosure is directed to a power system that generates at least one of electrical energy and thermal energy comprising: at least one vessel capable of a maintaining a pressure of below, at, or above atmospheric; reactants, the reactants comprising:
a) at least one source of catalyst or a catalyst comprising nascent H₂O;
b) at least one source of H₂O or H₂O;
c) at least one source of atomic hydrogen or atomic hydrogen; and
d) a molten metal;
   at least one molten metal injection system comprising a molten metal reservoir and an electromagnetic pump;
   at least one additional reactants injection system, wherein the additional reactants comprise:
a) at least one source of catalyst or a catalyst comprising nascent H₂O;
b) at least one source of H₂O or H₂O, and
c) at least one source of atomic hydrogen or atomic hydrogen;
   at least one reactants ignition system comprising a source of electrical power to cause the reactants to form at least one of light-emitting plasma and thermal-emitting plasma wherein the source of electrical power receives electrical power from the power converter;
   a system to recover the molten metal;
   at least one power converter or output system of at least one of the light and thermal output to electrical power and/or thermal power;
wherein the molten metal ignition system comprises:
a) at least one set of electrodes to confine the molten metal; and
b) a source of electrical power to deliver a short burst of high-current electrical energy sufficient to cause the reactants to react to form plasma;
wherein the electrodes comprise a refractory metal;
wherein the source of electrical power to deliver a short burst of high-current electrical energy sufficient to cause the reactants to react to form plasma comprises at least one supercapacitor;
wherein the molten metal injection system comprises an electromagnetic pump comprising at least one magnet providing a magnetic field and current source to provide a vector-crossed current component;
wherein the molten metal reservoir comprises an inductively coupled heater;
wherein the molten metal ignition system comprises at least one set of electrodes that are separated to form an open circuit, wherein the open circuit is closed by the injection of the molten metal to cause the high current to flow to achieve ignition;
wherein the molten metal ignition system current is in the range of 500 A to 50,000 A;
wherein the molten metal ignition system wherein the circuit is closed to cause an ignition frequency in the range of 1 Hz to 10,000 Hz;
wherein the molten metal comprises at least one of silver, silver-copper alloy, and copper;
wherein the addition reactants comprise at least one of H₂O vapor and hydrogen gas;
wherein the additional reactants injection system comprises at least one of a computer, H₂O and H₂ pressure sensors, and flow controllers comprising at least one or more of the group of a mass flow controller, a pump, a syringe pump, and a high precision electronically controllable valve; the valve comprising at least one of a needle valve, proportional electronic valve, and stepper motor valve wherein the valve is controlled by the pressure sensor and the computer to maintain at least one of the H₂O and H₂ pressure at a desired value;
wherein the additional reactants injection system maintains the H₂O vapor pressure in the range of 0.1 Torr to 1 Torr;
wherein the system to recover the products of the reactants comprises at least one of the vessel comprising walls capable of providing flow to the melt under gravity, an electrode electromagnetic pump, and the reservoir in communication with the vessel and further comprising a cooling system to maintain the reservoir at a lower temperature than another portion of the vessel to cause metal vapor of the molten metal to condense in the reservoir;
wherein the recovery system comprising an electrode electromagnetic pump comprises at least one magnet providing a magnetic field and a vector-crossed ignition current component;
wherein the vessel capable of a maintaining a pressure of below, at, or above atmospheric comprises an inner reaction cell, a top cover comprising a blackbody radiator, and an outer chamber capable of maintaining the a pressure of below, at, or above atmospheric;
wherein the top cover comprising a blackbody radiator is maintained at a temperature in the range of 1000 K to 3700 K;
wherein at least one of the inner reaction cell and top cover comprising a blackbody radiator comprises a refractory metal having a high emissivity;
wherein the blackbody radiator further comprises a blackbody temperature sensor and controller;
wherein the at least one power converter of the reaction power output comprises at least one of the group of a thermophotovoltaic converter and a photovoltaic converter;
wherein the light emitted by the cell is predominantly blackbody radiation comprising visible and near infrared light, and the photovoltaic cells are concentrator cells that comprise at least one compound chosen from crystalline silicon, germanium, gallium arsenide (GaAs), gallium antimonide (GaSb), indium gallium arsenide (InGaAs), indium gallium arsenide antimonide (InGaAsSb), and indium phosphide arsenide antimonide (InPAsSb), Group III/V semiconductors, InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge, and the power system further comprises a vacuum pump and at least one chiller.
In one embodiment, the present disclosure is directed to a power system that generates at least one of electrical energy and thermal energy comprising:
at least one vessel capable of a maintaining a pressure of below, at, or above atmospheric;
   reactants, the reactants comprising:
   a) at least one source of H₂O or H₂O;
   b) H2 gas; and
   c) a molten metal;
      at least one molten metal injection system comprising a molten metal reservoir and an electromagnetic pump;
      at least one additional reactants injection system, wherein the additional reactants comprise:
   a) at least one source of H₂O or H₂O, and
   b) H2;
      at least one reactants ignition system comprising a source of electrical power to cause the reactants to form at least one of light-emitting plasma and thermal-emitting plasma wherein the source of electrical power receives electrical power from the power converter;
      a system to recover the molten metal;
      at least one power converter or output system of at least one of the light and thermal output to electrical power and/or thermal power;
wherein the molten metal ignition system comprises:
   a) at least one set of electrodes to confine the molten metal; and
   b) a source of electrical power to deliver a short burst of high-current electrical energy sufficient to cause the reactants to react to form plasma;
wherein the electrodes comprise a refractory metal;
wherein the source of electrical power to deliver a short burst of high-current electrical energy sufficient to cause the reactants to react to form plasma comprises at least one supercapacitor;
wherein the molten metal injection system comprises an electromagnetic pump comprising at least one magnet providing a magnetic field and current source to provide a vector-crossed current component;
wherein the molten metal reservoir comprises an inductively coupled heater to at least initially heat a metal that forms the molten metal;
wherein the molten metal ignition system comprises at least one set of electrodes that are separated to form an open circuit, wherein the open circuit is closed by the injection of the molten metal to cause the high current to flow to achieve ignition; wherein the molten metal ignition system current is in the range of 500 A to 50,000 A;
wherein the molten metal ignition system wherein the circuit is closed to cause an ignition frequency in the range of 1 Hz to 10,000 Hz;
wherein the molten metal comprises at least one of silver, silver-copper alloy, and copper;
wherein the additional reactants injection system comprises at least one of a computer, H₂O and H₂ pressure sensors, and flow controllers comprising at least one or more of the group of a mass flow controller, a pump, a syringe pump, and a high precision electronically controllable valve; the valve comprising at least one of a needle valve, proportional electronic valve, and stepper motor valve wherein the valve is controlled by the pressure sensor and the computer to maintain at least one of the H₂O and H₂ pressure at a desired value;
wherein the additional reactants injection system maintains the H₂O vapor pressure in the range of 0.1 Torr to 1 Torr;
wherein the system to recover the products of the reactants comprises at least one of the vessel comprising walls capable of providing flow to the melt under gravity, an electrode electromagnetic pump, and the reservoir in communication with the vessel and further comprising a cooling system to maintain the reservoir at a lower temperature than another portion of the vessel to cause metal vapor of the molten metal to condense in the reservoir;
wherein the recovery system comprising an electrode electromagnetic pump comprises at least one magnet providing a magnetic field and a vector-crossed ignition current component;
wherein the vessel capable of a maintaining a pressure of below, at, or above atmospheric comprises an inner reaction cell, a top cover comprising a high temperature blackbody radiator, and an outer chamber capable of maintaining the a pressure of below, at, or above atmospheric;
wherein the top cover comprising a blackbody radiator is maintained at a temperature in the range of 1000 K to 3700 K;
wherein at least one of the inner reaction cell and top cover comprising a blackbody radiator comprises a refractory metal having a high emissivity;
wherein the blackbody radiator further comprises a blackbody temperature sensor and controller;
wherein the at least one power converter of the reaction power output comprises at least one of a thermophotovoltaic converter and a photovoltaic converter;
wherein the light emitted by the cell is predominantly blackbody radiation comprising visible and near infrared light, and the photovoltaic cells are concentrator cells that comprise at least one compound chosen from crystalline silicon, germanium, gallium arsenide (GaAs), gallium antimonide (GaSb), indium gallium arsenide (InGaAs), indium gallium arsenide antimonide (InGaAsSb), and indium phosphide arsenide antimonide (InPAsSb), Group III/V semiconductors, InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge, and
the power system further comprises a vacuum pump and at least one chiller.

In one embodiment, the present disclosure is directed to a power system that generates at least one of electrical energy and thermal energy comprising:
at least one vessel capable of a maintaining a pressure of below, at, or above atmospheric;
   reactants, the reactants comprising:
   a) at least one source of catalyst or a catalyst comprising nascent H₂O;
   b) at least one source of H₂O or H₂O;
   c) at least one source of atomic hydrogen or atomic hydrogen; and
   d) a molten metal;
      at least one molten metal injection system comprising a molten metal reservoir and an electromagnetic pump;
      at least one additional reactants injection system, wherein the additional reactants comprise:
   a) at least one source of catalyst or a catalyst comprising nascent H₂O;
      b) at least one source of H₂O or H₂O, and
   c) at least one source of atomic hydrogen or atomic hydrogen;
      at least one reactants ignition system comprising a source of electrical power to cause the reactants to form at least one of light-emitting plasma and thermal-emitting plasma wherein the source of electrical power receives electrical power from the power converter;
      a system to recover the molten metal;
      at least one power converter or output system of at least one of the light and thermal output to electrical power and/or thermal power;
wherein the molten metal ignition system comprises:
   a) at least one set of electrodes to confine the molten metal; and
   b) a source of electrical power to deliver a short burst of high-current electrical energy sufficient to cause the reactants to react to form plasma;
wherein the electrodes comprise a refractory metal;
wherein the source of electrical power to deliver a short burst of high-current electrical energy sufficient to cause the reactants to react to form plasma comprises at least one supercapacitor;
wherein the molten metal injection system comprises an electromagnetic pump comprising at least one magnet providing a magnetic field and current source to provide a vector-crossed current component;
wherein the molten metal reservoir comprises an inductively coupled heater to at least initially heat a metal that forms the molten metal;
wherein the molten metal ignition system comprises at least one set of electrodes that are separated to form an open circuit, wherein the open circuit is closed by the injection of the molten metal to cause the high current to flow to achieve ignition;
wherein the molten metal ignition system current is in the range of 500 A to 50,000 A;
wherein the molten metal ignition system wherein the circuit is closed to cause an ignition frequency in the range of 1 Hz to 10,000 Hz;
wherein the molten metal comprises at least one of silver, silver-copper alloy, and copper;
wherein the addition reactants comprise at least one of H₂O vapor and hydrogen gas;
wherein the additional reactants injection system comprises at least one of a computer, H₂O and H₂ pressure sensors, and flow controllers comprising at least one or more of the group of a mass flow controller, a pump, a syringe pump, and a high precision electronically controllable valve; the valve comprising at least one of a needle valve, proportional electronic valve, and stepper motor valve wherein the valve is controlled by the pressure sensor and the computer to maintain at least one of the H₂O and H₂ pressure at a desired value;
wherein the additional reactants injection system maintains the H₂O vapor pressure in the range of 0.1 Torr to 1 Torr;
wherein the system to recover the products of the reactants comprises at least one of the vessel comprising walls capable of providing flow to the melt under gravity, an electrode electromagnetic pump, and the reservoir in communication with the vessel and further comprising a cooling system to maintain the reservoir at a lower temperature than another portion of the vessel to cause metal vapor of the molten metal to condense in the reservoir;
wherein the recovery system comprising an electrode electromagnetic pump comprises at least one magnet providing a magnetic field and a vector-crossed ignition current component;
wherein the vessel capable of a maintaining a pressure of below, at, or above atmospheric comprises an inner reaction cell, a top cover comprising a blackbody radiator, and an outer chamber capable of maintaining the a pressure of below, at, or above atmospheric;
wherein the top cover comprising a blackbody radiator is maintained at a temperature in the range of 1000 K to 3700 K;
wherein at least one of the inner reaction cell and top cover comprising a blackbody radiator comprises a refractory metal having a high emissivity;
wherein the blackbody radiator further comprises a blackbody temperature sensor and controller;
wherein the at least one power converter of the reaction power output comprises at least one of the group of a thermophotovoltaic converter and a photovoltaic converter;
wherein the light emitted by the cell is predominantly blackbody radiation comprising visible and near infrared light, and the photovoltaic cells are concentrator cells that comprise at least one compound chosen from crystalline silicon, germanium, gallium arsenide (GaAs), gallium antimonide (GaSb), indium gallium arsenide (InGaAs), indium gallium arsenide antimonide (InGaAsSb), and indium phosphide arsenide antimonide (InPAsSb), Group III/V semiconductors, InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs-Ge, and
the power system further comprises a vacuum pump and at least one chiller.

In another embodiment, the present disclosure is directed to a power system that generates at least one of electrical energy and thermal energy comprising:
at least one vessel capable of a pressure of below atmospheric;
shot comprising reactants, the reactants comprising:
   a) at least one source of catalyst or a catalyst comprising nascent H₂O;
   b) at least one source of H₂O or H₂O;
   c) at least one source of atomic hydrogen or atomic hydrogen; and
   d) at least one of a conductor and a conductive matrix;
at least one shot injection system comprising at least one augmented railgun, wherein the augmented railgun comprises separated electrified rails and magnets that produce a magnetic field perpendicular to the plane of the rails, and the circuit between the rails is open until closed by the contact of the shot with the rails;
at least one ignition system to cause the shot to form at least one of light-emitting plasma and thermal-emitting plasma, at least one ignition system comprising:
   a) at least one set of electrodes to confine the shot; and
   b) a source of electrical power to deliver a short burst of high-current electrical energy;
   wherein the at least one set of electrodes form an open circuit, wherein the open circuit is closed by the injection of the shot to cause the high current to flow to achieve ignition, and the source of electrical power to deliver a short burst of high-current electrical energy comprises at least one of the following:
      a voltage selected to cause a high AC, DC, or an AC-DC mixture of current that is in the range of at least one of 100 A to 1,000,000 A, 1 kA to 100,000 A, 10 kA to 50 kA;
      a DC or peak AC current density in the range of at least one of 100 A/cm² to 1,000,000 A/cm², 1000 A/cm² to 100,000 A/cm², and 2000 A/cm² to 50,000 A/cm²;
      the voltage is determined by the conductivity of the solid fuel or wherein the voltage is given by the desired current times the resistance of the solid fuel sample;
      the DC or peak AC voltage is in the range of at least one of 0.1 V to 500 kV, 0.1 V to 100 kV, and 1 V to 50 kV, and
   the AC frequency is in range of at least one of 0.1 Hz to 10 GHz, 1 Hz to 1 MHz, 10 Hz to 100 kHz, and 100 Hz to 10 kHz.
a system to recover reaction products of the reactants comprising at least one of gravity and an augmented plasma railgun recovery system comprising at least one magnet providing a magnetic field and a vector-crossed current component of the ignition electrodes;
at least one regeneration system to regenerate additional reactants from the reaction products and form additional shot comprising a pelletizer comprising a smelter to form molten reactants, a system to add H₂ and H₂O to the molten reactants, a melt dripper, and a water reservoir to form shot,
wherein the additional reactants comprise:
   a) at least one source of catalyst or a catalyst comprising nascent H₂O;
   b) at least one source of H₂O or H₂O;
   c) at least one source of atomic hydrogen or atomic hydrogen; and
   d) at least one of a conductor and a conductive matrix; and
at least one power converter or output system of at least one of the light and thermal output to electrical power and/or thermal power comprising at least one or more of the group of a photovoltaic converter, a photoelectronic converter, a plasmadynamic converter, a thermionic converter, a thermoelectric converter, a Sterling engine, a Brayton cycle engine, a Rankine cycle engine, and a heat engine, and a heater.

In another embodiment, the present disclosure is directed to a power system that generates at least one of electrical energy and thermal energy comprising:
at least one vessel capable of a pressure of below atmospheric;
shot comprising reactants, the reactants comprising at least one of silver, copper, absorbed hydrogen, and water;
at least one shot injection system comprising at least one augmented railgun wherein the augmented railgun comprises separated electrified rails and magnets that produce a magnetic field perpendicular to the plane of the rails, and the circuit between the rails is open until closed by the contact of the shot with the rails;
at least one ignition system to cause the shot to form at least one of light-emitting plasma and thermal-emitting plasma, at least one ignition system comprising:
   a) at least one set of electrodes to confine the shot; and
   b) a source of electrical power to deliver a short burst of high-current electrical energy;
   wherein the at least one set of electrodes that are separated to form an open circuit,
   wherein the open circuit is closed by the injection of the shot to cause the high current to flow to achieve ignition, and he source of electrical power to deliver a short burst of high-current electrical energy comprises at least one of the following:
      a voltage selected to cause a high AC, DC, or an AC-DC mixture of current that is in the range of at least one of 100 A to 1,000,000 A, 1 kA to 100,000 A, 10 kA to 50 kA;
      a DC or peak AC current density in the range of at least one of 100 A/cm² to 1,000,000 A/cm², 1000 A/cm² to 100,000 A/cm², and 2000 A/cm² to 50,000 A/cm²;
      the voltage is determined by the conductivity of the solid fuel wherein the voltage is given by the desired current times the resistance of the solid fuel sample;
      the DC or peak AC voltage is in the range of at least one of 0.1 V to 500 kV, 0.1 V to 100 kV, and 1 V to 50 kV, and
   the AC frequency is in range of at least one of 0.1 Hz to 10 GHz, 1 Hz to 1 MHz, 10 Hz to 100 kHz, and 100 Hz to 10 kHz.
a system to recover reaction products of the reactants comprising at least one of gravity and a augmented plasma railgun recovery system comprising at least one magnet providing a magnetic field and a vector-crossed current component of the ignition electrodes;
at least one regeneration system to regenerate additional reactants from the reaction products and form additional shot comprising a pelletizer comprising a smelter to form molten reactants, a system to add H₂ and H₂O to the molten reactants, a melt dripper, and a water reservoir to form shot,
   wherein the additional reactants comprise at least one of silver, copper, absorbed hydrogen, and water;
at least one power converter or output system comprising a concentrator ultraviolet photovoltaic converter wherein the photovoltaic cells comprise at least one compound chosen from a Group III nitride, GaAlN, GaN, and InGaN.

In another embodiment, the present disclosure is directed to a power system that generates at least one of electrical energy and thermal energy comprising:
at least one vessel;
shot comprising reactants, the reactants comprising:
   a) at least one source of catalyst or a catalyst comprising nascent H2O;
   b) at least one source of H2O 2O or H2O;
   c) at least one source of atomic hydrogen or atomic hydrogen; and
   d) at least one of a conductor and a conductive matrix;
at least one shot injection system;
at least one shot ignition system to cause the shot to form at least one of light-emitting plasma and thermal-emitting plasma;
a system to recover reaction products of the reactants;
at least one regeneration system to regenerate additional reactants from the reaction products and form additional shot,
   wherein the additional reactants comprise:
   a) at least one source of catalyst or a catalyst comprising nascent H2O;
   b) at least one source of H2O 2O or H2O;
   c) at least one source of atomic hydrogen or atomic hydrogen; and
   d) at least one of a conductor and a conductive matrix;
at least one power converter or output system of at least one of the light and thermal output to electrical power and/or thermal power.

Certain embodiments of the present disclosure are directed to a power generation system comprising: a plurality of electrodes configured to deliver power to a fuel to ignite the fuel and produce a plasma; a source of electrical power configured to deliver electrical energy to the plurality of electrodes; and at least one photovoltaic power converter positioned to receive at least a plurality of plasma photons.

In one embodiment, the present disclosure is directed to a power system that generates at least one of direct electrical energy and thermal energy comprising:
at least one vessel;
reactants comprising:
   a) at least one source of catalyst or a catalyst comprising nascent H₂O;
   b) at least one source of atomic hydrogen or atomic hydrogen;
   c) at least one of a conductor and a conductive matrix; and
at least one set of electrodes to confine the hydrino reactants,
a source of electrical power to deliver a short burst of high-current electrical energy;
a reloading system;
at least one system to regenerate the initial reactants from the reaction products, and
at least one plasma dynamic converter or at least one photovoltaic converter.

In one exemplary embodiment, a method of producing electrical power may comprise supplying a fuel to a region between a plurality of electrodes; energizing the plurality of electrodes to ignite the fuel to form a plasma; converting a plurality of plasma photons into electrical power with a photovoltaic power converter; and outputting at least a portion of the electrical power.

In another exemplary embodiment, a method of producing electrical power may comprise supplying a fuel to a region between a plurality of electrodes; energizing the plurality of electrodes to ignite the fuel to form a plasma; converting a plurality of plasma photons into thermal power with a photovoltaic power converter; and outputting at least a portion of the electrical power.

In an embodiment of the present disclosure, a method of generating power may comprise delivering an amount of fuel to a fuel loading region, wherein the fuel loading region is located among a plurality of electrodes; igniting the fuel by flowing a current of at least about 100 A/cm² through the fuel by applying the current to the plurality of electrodes to produce at least one of plasma, light, and heat; receiving at least a portion of the light in a photovoltaic power converter; converting the light to a different form of power using the photovoltaic power converter; and outputting the different form of power.

In an additional embodiment, the present disclosure is directed to a water arc plasma power system comprising: at least one closed reaction vessel; reactants comprising at least one of source of H₂O and H₂O; at least one set of electrodes; a source of electrical power to deliver an initial high breakdown voltage of the H₂O and provide a subsequent high current, and a heat exchanger system, wherein the power system generates arc plasma, light, and thermal energy, and at least one photovoltaic power converter. The water may be supplied as vapor on or across the electrodes. The plasma may be permitted to expand into a low-pressure region of the plasma cell to prevent inhibition of the hydrino reaction due to confinement. The arc electrodes may comprise a spark plug design. The electrodes may comprise at least one of copper, nickel, nickel with silver chromate and zinc plating for corrosion resistance, iron, nickel-iron, chromium, noble metals, tungsten, molybdenum, yttrium, iridium, and palladium. In an embodiment, the water arc is maintained at low water pressure such as in at least one range of about 0.01 Torr to 10 Torr and 0.1 Torr to 1 Torr. The pressure range may be maintained in one range of the disclosure by means of the disclosure for the SF-CIHT cell. Exemplary means to supply the water vapor are at least one of a mass flow controller and a reservoir comprising H₂O such as a hydrated zeolite or a salt bath such as a KOH solution that off gases H₂O at the desired pressure range. The water may be supplied by a syringe pump wherein the delivery into vacuum results in the vaporization of the water.

Certain embodiments of the present disclosure are directed to a power generation system comprising: an electrical power source of at least about 100 A/cm² or of at least about 5,000 kW; a plurality of electrodes electrically coupled to the electrical power source; a fuel loading region configured to receive a solid fuel, wherein the plurality of electrodes is configured to deliver electrical power to the solid fuel to produce a plasma; and at least one of a plasma power converter, a photovoltaic power converter, and thermal to electric power converter positioned to receive at least a portion of the plasma, photons, and/or heat generated by the reaction. Other embodiments are directed to a power generation system, comprising: a plurality of electrodes; a fuel loading region located between the plurality of electrodes and configured to receive a conductive fuel, wherein the plurality of electrodes are configured to apply a current to the conductive fuel sufficient to ignite the conductive fuel and generate at least one of plasma and thermal power; a delivery mechanism for moving the conductive fuel into the fuel loading region; and at least one of a photovoltaic power converter to convert the plasma photons into a form of power, or a thermal to electric converter to convert the thermal power into a nonthermal form of power comprising electricity or mechanical power. Further embodiments are directed to a method of generating power, comprising: delivering an amount of fuel to a fuel loading region, wherein the fuel loading region is located among a plurality of electrodes; igniting the fuel by flowing a current of at least about 2,000 A/cm² through the fuel by applying the current to the plurality of electrodes to produce at least one of plasma, light, and heat; receiving at least a portion of the light in a photovoltaic power converter; converting the light to a different form of power using the photovoltaic power converter; and outputting the different form of power.

Additional embodiments are directed to a power generation system, comprising: an electrical power source of at least about 5,000 kW; a plurality of spaced apart electrodes, wherein the plurality of electrodes at least partially surround a fuel, are electrically connected to the electrical power source, are configured to receive a current to ignite the fuel, and at least one of the plurality of electrodes is moveable; a delivery mechanism for moving the fuel; and a photovoltaic power converter configured to convert plasma generated from the ignition of the fuel into a non-plasma form of power. Additionally provided in the present disclosure is a power generation system, comprising: an electrical power source of at least about 2,000 A/cm²; a plurality of spaced apart electrodes, wherein the plurality of electrodes at least partially surround a fuel, are electrically connected to the electrical power source, are configured to receive a current to ignite the fuel, and at least one of the plurality of electrodes is moveable; a delivery mechanism for moving the fuel; and a photovoltaic power converter configured to convert plasma generated from the ignition of the fuel into a non-plasma form of power.

Another embodiments is directed to a power generation system, comprising: an electrical power source of at least about 5,000 kW or of at least about 2,000 A/cm²; a plurality of spaced apart electrodes, wherein at least one of the plurality of electrodes includes a compression mechanism; a fuel loading region configured to receive a fuel, wherein the fuel loading region is surrounded by the plurality of electrodes so that the compression mechanism of the at least one electrode is oriented towards the fuel loading region, and wherein the plurality of electrodes are electrically connected to the electrical power source and configured to supply power to the fuel received in the fuel loading region to ignite the fuel; a delivery mechanism for moving the fuel into the fuel loading region; and a photovoltaic power converter configured to convert photons generated from the ignition of the fuel into a non-photon form of power. Other embodiments of the present disclosure are directed to a power generation system, comprising: an electrical power source of at least about 2,000 A/cm²; a plurality of spaced apart electrodes, wherein at least one of the plurality of electrodes includes a compression mechanism; a fuel loading region configured to receive a fuel, wherein the fuel loading region is surrounded by the plurality of electrodes so that the compression mechanism of the at least one electrode is oriented towards the fuel loading region, and wherein the plurality of electrodes are electrically connected to the electrical power source and configured to supply power to the fuel received in the fuel loading region to ignite the fuel; a delivery mechanism for moving the fuel into the fuel loading region; and a plasma power converter configured to convert plasma generated from the ignition of the fuel into a non-plasma form of power.

Embodiments of the present disclosure are also directed to power generation system, comprising: a plurality of electrodes; a fuel loading region surrounded by the plurality of electrodes and configured to receive a fuel, wherein the plurality of electrodes is configured to ignite the fuel located in the fuel loading region; a delivery mechanism for moving the fuel into the fuel loading region; a photovoltaic power converter configured to convert photons generated from the ignition of the fuel into a non-photon form of power; a removal system for removing a byproduct of the ignited fuel; and a regeneration system operably coupled to the removal system for recycling the removed byproduct of the ignited fuel into recycled fuel. Certain embodiments of the present disclosure are also directed to a power generation system, comprising: an electrical power source configured to output a current of at least about 2,000 A/cm² or of at least about 5,000 kW; a plurality of spaced apart electrodes electrically connected to the electrical power source; a fuel loading region configured to receive a fuel, wherein the fuel loading region is surrounded by the plurality of electrodes, and wherein the plurality of electrodes is configured to supply power to the fuel to ignite the fuel when received in the fuel loading region; a delivery mechanism for moving the fuel into the fuel loading region; and a photovoltaic power converter configured to convert a plurality of photons generated from the ignition of the fuel into a non-photon form of power. Certain embodiments may further include one or more of output power terminals operably coupled to the photovoltaic power converter; a power storage device; a sensor configured to measure at least one parameter associated with the power generation system; and a controller configured to control at least a process associated with the power generation system. Certain embodiments of the present disclosure are also directed to a power generation system, comprising: an electrical power source configured to output a current of at least about 2,000 A/cm² or of at least about 5,000 kW; a plurality of spaced apart electrodes, wherein the plurality of electrodes at least partially surround a fuel, are electrically connected to the electrical power source, are configured to receive a current to ignite the fuel, and at least one of the plurality of electrodes is moveable; a delivery mechanism for moving the fuel; and a photovoltaic power converter configured to convert photons generated from the ignition of the fuel into a different form of power.

Additional embodiments of the present disclosure are directed to a power generation system, comprising: an electrical power source of at least about 5,000 kW or of at least about 2,000 A/cm²; a plurality of spaced apart electrodes electrically connected to the electrical power source; a fuel loading region configured to receive a fuel, wherein the fuel loading region is surrounded by the plurality of electrodes, and wherein the plurality of electrodes is configured to supply power to the fuel to ignite the fuel when received in the fuel loading region; a delivery mechanism for moving the fuel into the fuel loading region; a photovoltaic power converter configured to convert a plurality of photons generated from the ignition of the fuel into a non-photon form of power; a sensor configured to measure at least one parameter associated with the power generation system; and a controller configured to control at least a process associated with the power generation system. Further embodiments are directed to a power generation system, comprising: an electrical power source of at least about 2,000 A/cm²; a plurality of spaced apart electrodes electrically connected to the electrical power source; a fuel loading region configured to receive a fuel, wherein the fuel loading region is surrounded by the plurality of electrodes, and wherein the plurality of electrodes is configured to supply power to the fuel to ignite the fuel when received in the fuel loading region; a delivery mechanism for moving the fuel into the fuel loading region; a plasma power converter configured to convert plasma generated from the ignition of the fuel into a non-plasma form of power; a sensor configured to measure at least one parameter associated with the power generation system; and a controller configured to control at least a process associated with the power generation system.

Certain embodiments of the present disclosure are directed to a power generation system, comprising: an electrical power source of at least about 5,000 kW or of at least about 2,000 A/cm²; a plurality of spaced apart electrodes electrically connected to the electrical power source; a fuel loading region configured to receive a fuel, wherein the fuel loading region is surrounded by the plurality of electrodes, and wherein the plurality of electrodes is configured to supply power to the fuel to ignite the fuel when received in the fuel loading region, and wherein a pressure in the fuel loading region is a partial vacuum; a delivery mechanism for moving the fuel into the fuel loading region; and a photovoltaic power converter configured to convert plasma generated from the ignition of the fuel into a non-plasma form of power. Some embodiments may include one or more of the following additional features: the photovoltaic power converter may be located within a vacuum cell; the photovoltaic power converter may include at least one of an antireflection coating, an optical impedance matching coating, or a protective coating; the photovoltaic power converter may be operably coupled to a cleaning system configured to clean at least a portion of the photovoltaic power converter; the power generation system may include an optical filter; the photovoltaic power converter may comprise at least one of a monocrystalline cell, a polycrystalline cell, an amorphous cell, a string/ribbon silicon cell, a multi junction cell, a homojunction cell, a heterojunction cell, a p-i-n device, a thin-film cell, a dye-sensitized cell, and an organic photovoltaic cell; and the photovoltaic power converter may comprise at multi junction cell, wherein the multi junction cell comprises at least one of an inverted cell, an upright cell, a lattice-mismatched cell, a lattice-matched cell, and a cell comprising Group III-V semiconductor materials.

Additional exemplary embodiments are directed to a system configured to produce power, comprising: a fuel supply configured to supply a fuel; a power supply configured to supply an electrical power; and at least one pair of electrodes configured to receive the fuel and the electrical power, wherein the electrodes selectively directs the electrical power to a local region about the electrodes to ignite the fuel within the local region. Some embodiments are directed to a method of producing electrical power, comprising: supplying a fuel to electrodes; supplying a current to the electrodes to ignite the localized fuel to produce energy; and converting at least some of the energy produced by the ignition into electrical power.

Other embodiments are directed to a power generation system, comprising: an electrical power source of at least about 2,000 A/cm²; a plurality of spaced apart electrodes electrically connected to the electrical power source; a fuel loading region configured to receive a fuel, wherein the fuel loading region is surrounded by the plurality of electrodes, and wherein the plurality of electrodes is configured to supply power to the fuel to ignite the fuel when received in the fuel loading region, and wherein a pressure in the fuel loading region is a partial vacuum; a delivery mechanism for moving the fuel into the fuel loading region; and a photovoltaic power converter configured to convert plasma generated from the ignition of the fuel into a non-plasma form of power.

Further embodiments are directed to a power generation cell, comprising: an outlet port coupled to a vacuum pump; a plurality of electrodes electrically coupled to an electrical power source of at least about 5,000 kW; a fuel loading region configured to receive a water-based fuel comprising a majority H₂O, wherein the plurality of electrodes is configured to deliver power to the water-based fuel to produce at least one of an arc plasma and thermal power; and a power converter configured to convert at least a portion of at least one of the arc plasma and the thermal power into electrical power. Also disclosed is a power generation system, comprising: an electrical power source of at least about 5,000 A/cm²; a plurality of electrodes electrically coupled to the electrical power source; a fuel loading region configured to receive a water-based fuel comprising a majority H₂O, wherein the plurality of electrodes is configured to deliver power to the water-based fuel to produce at least one of an arc plasma and thermal power; and a power converter configured to convert at least a portion of at least one of the arc plasma and the thermal power into electrical power. In an embodiment, the power converter comprises a photovoltaic converter of optical power into electricity.

Additional embodiments are directed to a method of generating power, comprising: loading a fuel into a fuel loading region, wherein the fuel loading region includes a plurality of electrodes; applying a current of at least about 2,000 A/cm² to the plurality of electrodes to ignite the fuel to produce at least one of an arc plasma and thermal power; performing at least one of passing the arc plasma through a photovoltaic converter to generate electrical power; and passing the thermal power through a thermal-to-electric converter to generate electrical power; and outputting at least a portion of the generated electrical power. Also disclosed is a power generation system, comprising: an electrical power source of at least about 5,000 kW; a plurality of electrodes electrically coupled to the power source, wherein the plurality of electrodes is configured to deliver electrical power to a water-based fuel comprising a majority H₂O to produce a thermal power; and a heat exchanger configured to convert at least a portion of the thermal power into electrical power; and a photovoltaic power converter configured to convert at least a portion of the light into electrical power. In addition, another embodiment is directed to a power generation system, comprising: an electrical power source of at least about 5,000 kW; a plurality of spaced apart electrodes, wherein at least one of the plurality of electrodes includes a compression mechanism; a fuel loading region configured to receive a water-based fuel comprising a majority H₂O, wherein the fuel loading region is surrounded by the plurality of electrodes so that the compression mechanism of the at least one electrode is oriented towards the fuel loading region, and wherein the plurality of electrodes are electrically connected to the electrical power source and configured to supply power to the water-based fuel received in the fuel loading region to ignite the fuel; a delivery mechanism for moving the water-based fuel into the fuel loading region; and a photovoltaic power converter configured to convert plasma generated from the ignition of the fuel into a non-plasma form of power.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 2I28 is a schematic drawing of magnetic yoke assembly of the electromagnetic pump of SF-CIHT cell or SunCell® power generator with and without the magnets in accordance with an embodiment of the present disclosure.

FIG. 2I69 is a schematic drawing of a thermophotovoltaic SunCell® power generator showing an exploded cross sectional view of the electromagnetic pump and reservoir assembly in accordance with an embodiment of the present disclosure.

FIG. 2I80 is a schematic drawing of a thermophotovoltaic SunCell® power generator comprising dual EM pump injectors as liquid electrodes having components housed in a single outer pressure vessel showing the cross sectional view in accordance with an embodiment of the present disclosure.

FIG. 2I81 is a schematic drawing of a thermophotovoltaic SunCell® power generator comprising dual EM pump injectors as liquid electrodes showing the reservoir and blackbody radiator assembly in accordance with an embodiment of the present disclosure.

FIG. 2I82 is a schematic drawing of a thermophotovoltaic SunCell® power generator comprising dual EM pump injectors as liquid electrodes showing a transparent view of the reservoir and blackbody radiator assembly in accordance with an embodiment of the present disclosure.

FIG. 2I83 is a schematic drawing of a thermophotovoltaic SunCell® power generator comprising dual EM pump injectors as liquid electrodes showing the lower hemisphere of the blackbody radiator and the twin nozzles in accordance with an embodiment of the present disclosure.

FIG. 2I84 is a schematic drawing of a thermophotovoltaic SunCell® power generator comprising dual EM pump injectors as liquid electrodes showing the generator with the outer pressure vessel showing the penetrations of the base of the outer pressure vessel in accordance with an embodiment of the present disclosure.

FIG. 2I85 is a schematic drawing of a thermophotovoltaic SunCell® power generator comprising dual EM pump injectors as liquid electrodes showing the generator with the outer pressure vessel top removed showing the penetrations of the base of the outer pressure vessel in accordance with an embodiment of the present disclosure.

FIG. 2I86 is a schematic coronal xz section drawing of a thermophotovoltaic SunCell® power generator comprising dual EM pump injectors as liquid electrodes in accordance with an embodiment of the present disclosure.

FIG. 2I87 is a schematic yz cross section drawing of a thermophotovoltaic SunCell® power generator comprising dual EM pump injectors as liquid electrodes in accordance with an embodiment of the present disclosure.

FIG. 2I88 is a schematic drawing of a thermophotovoltaic SunCell® power generator comprising dual EM pump injectors as liquid electrodes showing the generator support components in accordance with an embodiment of the present disclosure.

FIG. 2I89 is a schematic drawing of a thermophotovoltaic SunCell® power generator comprising dual EM pump injectors as liquid electrodes showing the generator support components in accordance with an embodiment of the present disclosure.

FIG. 2I90 is a schematic drawing of a thermophotovoltaic SunCell® power generator comprising dual EM pump injectors as liquid electrodes showing the generator support components in accordance with an embodiment of the present disclosure.

FIG. 2I91 is a schematic drawing of a thermophotovoltaic SunCell® power generator comprising dual EM pump injectors as liquid electrodes showing the generator support components in accordance with an embodiment of the present disclosure.

FIG. 2I92 is a schematic drawing of a thermophotovoltaic SunCell® power generator comprising dual EM pump injectors as liquid electrodes showing the generator support components in accordance with an embodiment of the present disclosure.

FIG. 2I93 is a schematic drawing of a thermophotovoltaic SunCell® power generator comprising dual EM pump injectors as liquid electrodes showing the vertically retractable antenna in the up or reservoir heating position in accordance with an embodiment of the present disclosure.

FIG. 2I94 is a schematic drawing of a thermophotovoltaic SunCell® power generator comprising dual EM pump injectors as liquid electrodes showing the vertically retractable antenna in the down or cooling heating position in accordance with an embodiment of the present disclosure.

FIG. 2I95 is a schematic drawing of a thermophotovoltaic SunCell® power generator comprising dual EM pump injectors as liquid electrodes showing the actuator to vary the vertical position of the heater coil in accordance with an embodiment of the present disclosure.

FIG. 2I96 is a schematic drawing of a thermophotovoltaic SunCell® power generator comprising dual EM pump injectors as liquid electrodes showing the drive mechanism of the actuator to vary the vertical position of the heater coil in accordance with an embodiment of the present disclosure.

FIG. 2I97 is a cross sectional schematic drawing of a thermophotovoltaic SunCell® power generator comprising dual EM pump injectors as liquid electrodes showing the actuator to vary the vertical position of the heater coil in accordance with an embodiment of the present disclosure.

FIG. 2I98 is a schematic drawing of a thermophotovoltaic SunCell® power generator comprising dual EM pump injectors as liquid electrodes showing the electromagnetic pump assembly in accordance with an embodiment of the present disclosure.

FIG. 2I99 is a schematic drawing of a thermophotovoltaic SunCell® power generator comprising dual EM pump injectors as liquid electrodes showing the slip nut reservoir connectors in accordance with an embodiment of the present disclosure.

FIG. 2I100 is a schematic drawing showing external and cross sectional views of a thermophotovoltaic SunCell® power generator comprising dual EM pump injectors as liquid electrodes comprising the slip nut reservoir connectors in accordance with an embodiment of the present disclosure.

FIG. 2I101 is a top, cross sectional schematic drawing of a thermophotovoltaic SunCell® power generator comprising dual EM pump injectors as liquid electrodes in accordance with an embodiment of the present disclosure.

FIG. 2I102 is a cross sectional schematic drawing showing the particulate insulation containment vessel in accordance with an embodiment of the present disclosure.

FIG. 2I103 is a cross sectional schematic drawing of a thermophotovoltaic SunCell® power generator comprising dual EM pump injectors as liquid electrodes showing the particulate insulation containment vessel in accordance with an embodiment of the present disclosure.

FIGS. 2I104-2I114 are schematic drawings of a thermophotovoltaic SunCell® power generator comprising dual EM pump injectors as liquid electrodes having an X-ray level sensor, slip nut connectors, and a lower chamber to house the power conditioners and power supplies in accordance with an embodiment of the present disclosure.

FIG. 2I115 is a schematic drawing of the electromagnetic pump (EM) Faraday cage that houses two EM magnets and cooling loops in accordance with an embodiment of the present disclosure.

FIG. 2I116 is a schematic drawing of the electromagnetic pump (EM) Faraday cage that houses one EM magnet and cooling loops in accordance with an embodiment of the present disclosure.

FIGS. 2I117-2I126 are schematic drawings of a thermophotovoltaic SunCell® power generator comprising dual EM pump injectors as liquid electrodes having an X-ray level sensor, slip nut connectors, and a lower chamber to house the power conditioners and power supplies in accordance with an embodiment of the present disclosure.

FIGS. 2I127-2I130 are schematic drawings of a prototype thermophotovoltaic SunCell® power generator comprising dual EM pump injectors as liquid electrodes and slip nut connectors in accordance with an embodiment of the present disclosure.

FIG. 2I131 is a schematic drawing of the parts of the prototype thermophotovoltaic SunCell® power generator comprising dual EM pump injectors as liquid electrodes and slip nut connectors in accordance with an embodiment of the present disclosure.

FIG. 2I132 is a schematic drawing of a SunCell® power generator showing details of an optical distribution and the photovoltaic converter system in accordance with an embodiment of the present disclosure.

FIG. 2I133 is a schematic drawing of a triangular element of the geodesic dense receiver array of the photovoltaic converter or heat exchanger in accordance with an embodiment of the present disclosure.

FIG. 2I134 is a schematic drawing of a SunCell® power generator showing details of a cubic secondary radiator and the photovoltaic converter system with the inductively coupled heater in the active position in accordance with an embodiment of the present disclosure.

FIG. 2I135 is a schematic drawing of a SunCell® power generator showing details of a cubic secondary radiator and the photovoltaic converter system with the inductively coupled heater in the stored position in accordance with an embodiment of the present disclosure.

FIG. 2I136 is a schematic drawing of a cubic photovoltaic converter system comprising a cubic secondary radiator in accordance with an embodiment of the present disclosure.

FIG. 2I137 is a schematic drawing of a SunCell® power generator showing details of a cubic secondary radiator and the photovoltaic converter system with the heating antenna removed in accordance with an embodiment of the present disclosure.

FIG. 2I138 is a schematic drawing of a thermophotovoltaic SunCell® power generator comprising dual EM pump injectors as liquid electrodes showing the electromagnetic pump assembly with an inlet riser in accordance with an embodiment of the present disclosure.

FIG. 2I139 is a schematic drawing of a reservoir-to-EM-pump-assembly wet seal in accordance with an embodiment of the present disclosure.

FIG. 2I140 is a schematic drawing of a reservoir-to-EM-pump-assembly wet seal in accordance with an embodiment of the present disclosure.

FIG. 2I141 is a schematic drawing of a reservoir-to-EM-pump-assembly internal or inverse slip nut seal in accordance with an embodiment of the present disclosure.

FIG. 2I142 is a schematic drawing of a reservoir-to-EM-pump-assembly compression seal in accordance with an embodiment of the present disclosure.

FIG. 2I143 is a schematic drawing of a thermophotovoltaic SunCell® power generator comprising dual EM pump injectors as liquid electrodes showing a tilted electromagnetic pump assembly with an inlet riser and a PV converter of increased radius to decrease the blackbody light intensity in accordance with an embodiment of the present disclosure.

FIGS. 2I144-2I145 are each a schematic drawing of a thermophotovoltaic SunCell® power generator comprising dual EM pump injectors as liquid electrodes showing a tilted electromagnetic pump assembly with an inlet riser in accordance with an embodiment of the present disclosure.

FIGS. 2I146-2I147 are each a schematic drawing of a thermophotovoltaic SunCell® power generator comprising dual EM pump injectors as liquid electrodes showing a tilted electromagnetic pump assembly with an inlet riser and a transparent reaction cell chamber in accordance with an embodiment of the present disclosure.

FIG. 2I148 is a top-view schematic drawing of the RF antenna of the inductively coupled heater comprising two separate antenna coils, each comprising an upper pancake cradle and a lower EM-pump-tube-plane-parallel, omega-shaped pancake coil, each antenna coil capacitor box, and a two-way actuator for horizontal movement in accordance with an embodiment of the present disclosure.

FIG. 2I149 is a top-view schematic drawing of the RF antenna of the inductively coupled heater comprising two separate antenna coils, each comprising an upper pancake cradle and a lower EM-pump-tube-plane-parallel, omega-shaped pancake coil, a common antenna coil capacitor box with flexible antenna connections, and a two-way actuator for horizontal movement in accordance with an embodiment of the present disclosure.

FIG. 2I150 is two views of a schematic drawing of the RF antenna of the inductively coupled heater comprising an upper segmented oval that is circumferential to both reservoirs with each loop comprising a flexible antenna section and a lower EM-pump-tube-plane-parallel, omega-shaped pancake coil having a common antenna coil capacitor box with flexible antenna connections and a two-way actuator for horizontal movement in accordance with an embodiment of the present disclosure.

FIG. 2I151 is two views of a schematic drawing of the RF antenna of the inductively coupled heater comprising a split upper circumferential oval coil and a lower pan cake coil connected to one half of the oval coil wherein the two halves of the oval are joined by loop current connectors when the halves are in the closed position as shown in accordance with an embodiment of the present disclosure.

FIG. 2I152 is four views of a schematic drawing of the RF antenna of the inductively coupled heater comprising a split upper circumferential oval coil and a lower pan cake coil connected to one half of the oval coil wherein the two halves of the oval are joined by loop current connectors when the halves shown in the open position are moved to the closed position in accordance with an embodiment of the present disclosure.

FIGS. 2I153-2I155 are each a schematic drawing of a SunCell® thermal power generator comprising dual EM pump injectors as liquid electrodes showing a cavity thermal absorber having walls with embedded coolant tubes to receive the thermal power from the blackbody radiator and transfer the heat to the coolant and then a secondary heat exchanger to output hot air in accordance with an embodiment of the present disclosure.

FIG. 2I156 is a schematic drawing of a SunCell® thermal power generator comprising upper and lower heat exchangers to output steam in accordance with an embodiment of the present disclosure.

FIGS. 2I157-2I158 are each a schematic drawing of a SunCell® thermal power generator comprising dual EM pump injectors as liquid electrodes showing upper and lower boiler tubes to output steam in accordance with an embodiment of the present disclosure.

FIG. 2I159 is a schematic drawing of the boiler tubes and boiler chamber of a SunCell® thermal power generator to output steam in accordance with an embodiment of the present disclosure.

FIG. 2I160 is a schematic drawing of the reaction chamber, boiler tubes, and boiler chamber of a SunCell® thermal power generator to output steam in accordance with an embodiment of the present disclosure.

FIG. 2I161 is a schematic drawing of magnetohydrodynamic (MHD) converter components of a cathode, anode, insulator, and bus bar feed-through flange in accordance with an embodiment of the present disclosure.

FIGS. 2I162-2I166 are schematic drawings of a SunCell® power generator comprising dual EM pump injectors as liquid electrodes showing tilted reservoirs and a magnetohydrodynamic (MHD) converter comprising a pair of MHD return EM pumps in accordance with an embodiment of the present disclosure.

FIGS. 2I167-2I173 are schematic drawings of a SunCell® power generator comprising dual EM pump injectors as liquid electrodes showing tilted reservoirs and a magnetohydrodynamic (MHD) converter comprising a pair of MHD return EM pumps and a pair of MHD return gas pumps or compressors in accordance with an embodiment of the present disclosure.

FIGS. 2I174-2I176 are schematic drawings of SunCell® power generator comprising dual EM pump injectors as liquid electrodes showing tilted reservoirs, a ceramic EM pump tube assembly, and a magnetohydrodynamic (MHD) converter comprising a pair of MHD return EM pumps in accordance with an embodiment of the present disclosure.

FIG. 2I177 is a schematic drawing of a magnetohydrodynamic (MHD) SunCell® power generator comprising dual EM pump injectors as liquid electrodes showing tilted reservoirs, a ceramic EM pump tube assembly, and a straight MHD channel in accordance with an embodiment of the present disclosure.

FIG. 2I178 is a schematic drawing of a magnetohydrodynamic (MHD) SunCell® power generator comprising dual EM pump injectors as liquid electrodes showing tilted reservoirs, and a straight MHD channel in accordance with an embodiment of the present disclosure.

FIGS. 2I179-2I183 are schematic drawings of a magnetohydrodynamic (MHD) SunCell® power generator comprising dual EM pump injectors as liquid electrodes showing tilted reservoirs, a spherical reaction cell chamber, a straight MHD channel, and gas addition housing in accordance with an embodiment of the present disclosure.

FIG. 2I184 is schematic drawings of magnetohydrodynamic (MHD) SunCell® power generators comprising dual EM pump injectors as liquid electrodes showing tilted reservoirs, a spherical reaction cell chamber, a straight magnetohydrodynamic (MHD) channel, gas addition housing, and single-stage induction EM pumps for injection and either single-stage induction or DC conduction MHD return EM pumps in accordance with an embodiment of the present disclosure.

FIG. 2I185 is a schematic drawing of a single-stage induction injection EM pump in accordance with an embodiment of the present disclosure.

FIG. 2I186 is a schematic drawing of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return, and an induction ignition system in accordance with an embodiment of the present disclosure.

FIG. 2I187 is a schematic drawing of the reservoir baseplate assembly and connecting components of the inlet riser tube, injector tube and nozzle, and flanges in accordance with an embodiment of the present disclosure.

FIG. 2I188 is a schematic drawing of a two-stage induction EM pump wherein the first stage serves as the MHD return EM pump and the second stage serves as the injection EM pump in accordance with an embodiment of the present disclosure.

FIG. 2I189 is a schematic drawing of an induction ignition system in accordance with an embodiment of the present disclosure.

FIGS. 2I190-2I191 are schematic drawings of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return each having a forced air cooling system, and an induction ignition system in accordance with an embodiment of the present disclosure.

FIG. 2I192 is a schematic drawing of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return each having a forced liquid cooling system, an induction ignition system, and inductively coupled heating antennas on the EM pump tubes, reservoirs, reaction cell chamber, and MHD return conduit in accordance with an embodiment of the present disclosure.

FIGS. 2I193-2I195 are schematic drawings of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return each having a forced air cooling system, and an induction ignition system in accordance with an embodiment of the present disclosure.

FIG. 2I196 is a schematic drawing of two SunCell® thermal power generators, one comprising a half-spherical-shell-shaped radiant thermal absorber heat exchanger having walls with embedded coolant tubes to receive the thermal power from reaction cell comprising a blackbody radiator and transfer the heat to the coolant and another comprising a circumferential cylindrical heat exchanger and boiler in accordance with an embodiment of the present disclosure.

FIG. 3 is a schematic drawing of the silver-oxygen phase diagram from Smithells Metals Reference Book-8^{th} Edition, 11-20 in accordance with an embodiment of the present disclosure.

FIG. 4 is the absolute spectrum in the 5 nm to 450 nm region of the ignition of a 80 mg shot of silver comprising absorbed H₂ and H₂O from gas treatment of silver melt before dripping into a water reservoir showing an average NIST calibrated optical power of 1.3 MW, essentially all in the ultraviolet and extreme ultraviolet spectral region in accordance with an embodiment of the present disclosure.

FIG. 5 is the spectrum (100 nm to 500 nm region with a cutoff at 180 nm due to the sapphire spectrometer window) of the ignition of a molten silver pumped into W electrodes in atmospheric argon with an ambient H₂O vapor pressure of about 1 Torr showing UV line emission that transitioned to 5000K blackbody radiation when the atmosphere became optically thick to the UV radiation with the vaporization of the silver in accordance with an embodiment of the present disclosure.

FIG. 6 is a schematic drawing of a hydrino reaction cell chamber comprising a means to detonate a wire to serve as at least one of a source of reactants and a means to propagate the hydrino reaction to form macro-aggregates or polymers comprising lower-energy hydrogen species such as molecular hydrino in accordance with an embodiment of the present disclosure.

Disclosed herein are catalyst systems to release energy from atomic hydrogen to form lower energy states wherein the electron shell is at a closer position relative to the nucleus. The released power is harnessed for power generation and additionally new hydrogen species and compounds are desired products. These energy states are predicted by classical physical laws and require a catalyst to accept energy from the hydrogen in order to undergo the corresponding energy-releasing transition.

Classical physics gives closed-form solutions of the hydrogen atom, the hydride ion, the hydrogen molecular ion, and the hydrogen molecule and predicts corresponding species having fractional principal quantum numbers. Atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen called “hydrino atoms,” wherein n=1/2, 1/3, 1/4, . . . , 1/p (p≤137 is an integer) replaces the well-known parameter n=integer in the Rydberg equation for hydrogen excited states. Each hydrino state also comprises an electron, a proton, and a photon, but the field contribution from the photon increases the binding energy rather than decreasing it corresponding to energy desorption rather than absorption. Since the potential energy of atomic hydrogen is 27.2 eV, m H atoms serve as a catalyst of m·27.2 eV for another (m+1)th H atom [1]. For example, a H atom can act as a catalyst for another H by accepting 27.2 eV from it via through-space energy transfer such as by magnetic or induced electric dipole-dipole coupling to form an intermediate that decays with the emission of continuum bands with short wavelength cutoffs and energies of m²·13.6 eV

$$( \frac{91.2}{{m}^{2}} nm ) .$$

In addition to atomic H, a molecule that accepts m·27.2 eV from atomic H with a decrease in the magnitude of the potential energy of the molecule by the same energy may also serve as a catalyst. The potential energy of H₂O is 81.6 eV. Then, by the same mechanism, the nascent H₂O molecule (not hydrogen bonded in solid, liquid, or gaseous state) formed by a thermodynamically favorable reduction of a metal oxide is predicted to serve as a catalyst to form H(1/4) with an energy release of 204 eV, comprising an 81.6 eV transfer to HOH and a release of continuum radiation with a cutoff at 10.1 nm (122.4 eV).

In the H-atom catalyst reaction involving a transition to the

$$H [ \frac{{a}_{H}}{p = m + 1} ]$$

state, m H atoms serve as a catalyst of m·27.2 eV for another (m+1)th H atom. Then, the reaction between m+1 hydrogen atoms whereby m atoms resonantly and nonradiatively accept m·27.2 eV from the (m+1)th hydrogen atom such that mH serves as the catalyst is given by

$$\begin{matrix}m \cdot 27.2 eV + mH + H -> {mH}_{fast}^{+} + {me}^{-} + H * [ \frac{{a}_{H}}{m + 1} ] + m \cdot 27.2 eV & ( 1 ) \\ H * [ \frac{{a}_{H}}{m + 1} ] -> H [ \frac{{a}_{H}}{m + 1} ] + [ {( m + 1 )}^{2} - {1}^{2} ] \cdot 13.6 eV - m \cdot 27.2 eV & ( 2 ) \\ {mH}_{fast}^{+} + {me}^{-} -> mH + m \cdot 27.2 eV & ( 3 )\end{matrix}$$

And, the overall reaction is

$$H -> H [ \frac{{a}_{H}}{p = m + 1} ] + [ {( m + 1 )}^{2} - {1}^{2} ] \cdot 13.6 eV \qquad ( 4 )$$

The catalysis reaction (m=3) regarding the potential energy of nascent H₂O [1] is

$$\begin{matrix}81.6 eV + {H}_{2} O + H [ {a}_{H} ] -> 2 {H}_{fast}^{+} + {O}^{-} + {e}^{-} + H * [ \frac{{a}_{H}}{4} ] + 81.6 eV & ( 5 ) \\ H * [ \frac{{a}_{H}}{4} ] -> H [ \frac{{a}_{H}}{4} ] + 122.4 eV & ( 6 ) \\ 2 {H}_{fast}^{+} + {O}^{-} + {e}^{-} -> {H}_{2} O + 81.6 eV & ( 7 )\end{matrix}$$

And. the overall reaction is

$$H * [ {a}_{H} ] -> H [ \frac{{a}_{H}}{4} ] + 81.6 eV + 122.4 eV \qquad ( 8 )$$

After the energy transfer to the catalyst (Eqs. (1) and (5)), an intermediate

$$H * [ \frac{{a}_{H}}{m + 1} ]$$

is formed having the radius of the H atom and a central field of m+1 times the central field of a proton. The radius is predicted to decrease as the electron undergoes radial acceleration to a stable state having a radius of 1/(m+1) the radius of the uncatalyzed hydrogen atom, with the release of m²·13.6 eV of energy. The extreme-ultraviolet continuum radiation band due to the

$$H * [ \frac{{a}_{H}}{m + 1} ]$$

intermediate (e.g. Eq. (2) and Eq. (6)) is predicted to have a short wavelength cutoff and energy

$${E}_{( H -> H [ \frac{{a}_{H}}{p = m + 1} ] )} \qquad ( 9 )$$

given by

$${E}_{( H \to H [ \frac{{a}_{H}}{p = m + 1} ] )} = {m}^{2} \cdot 13.6 eV ; \\ {λ}_{( H \to H [ \frac{{a}_{H}}{p = m + 1} ] )} = \frac{91.2}{{m}^{2}} nm \qquad ( 9 )$$

and extending to longer wavelengths than the corresponding cutoff. Here the extreme-ultraviolet continuum radiation band due to the decay of the H*[a_{H}/4] intermediate is predicted to have a short wavelength cutoff at E=m²·13.6=9·13.6=122.4 eV (10.1 nm) [where p=m+1=4 and m=3 in Eq. (9)] and extending to longer wavelengths. The continuum radiation band at 10.1 nm and going to longer wavelengths for the theoretically predicted transition of H to lower-energy, so called “hydrino” state H(1/4), was observed only arising from pulsed pinch gas discharges comprising some hydrogen. Another observation predicted by Eqs. (1) and (5) is the formation of fast, excited state H atoms from recombination of fast H⁺. The fast atoms give rise to broadened Balmer α emission. Greater than 50 eV Balmer a line broadening that reveals a population of extraordinarily high-kinetic-energy hydrogen atoms in certain mixed hydrogen plasmas is a well-established phenomenon wherein the cause is due to the energy released in the formation of hydrinos. Fast H was previously observed in continuum-emitting hydrogen pinch plasmas.

Additional catalyst and reactions to form hydrino are possible. Specific species (e.g. He⁺, Ar⁺, Sr⁺, K, Li, HCl, and NaH, OH, SH, SeH, nascent H₂O, nH (n=integer)) identifiable on the basis of their known electron energy levels are required to be present with atomic hydrogen to catalyze the process. The reaction involves a nonradiative energy transfer followed by q·13.6 eV continuum emission or q·13.6 eV transfer to H to form extraordinarily hot, excited-state H and a hydrogen atom that is lower in energy than unreacted atomic hydrogen that corresponds to a fractional principal quantum number. That is, in the formula for the principal energy levels of the hydrogen atom:

$$\begin{matrix}{E}_{n} = - \frac{{e}^{2}}{{n}^{2} 8 π {ɛ}_{o} {a}_{H}} = - \frac{13.598 eV}{{n}^{2}} . & ( 10 ) \\ n = 1 , 2 , 3 , … & ( 11 )\end{matrix}$$

where a_{H} is the Bohr radius for the hydrogen atom (52.947 pm), e is the magnitude of the charge of the electron, and εₒ is the vacuum permittivity, fractional quantum numbers:

$$n = 1 , \frac{1}{2} , \frac{1}{3} , \frac{1}{4} , … , \frac{1}{p} ; \\ where p \leq 137 is an integer \qquad ( 12 )$$

replace the well known parameter n=integer in the Rydberg equation for hydrogen excited states and represent lower-energy-state hydrogen atoms called “hydrinos.” The n=1 state of hydrogen and the

$$n = \frac{1}{integer}$$

states of hydrogen are nonradiative, but a transition between two nonradiative states, say n=1 to n=1/2, is possible via a nonradiative energy transfer. Hydrogen is a special case of the stable states given by Eqs. (10) and (12) wherein the corresponding radius of the hydrogen or hydrino atom is given by

$$r = \frac{{a}_{H}}{p} , \qquad ( 13 )$$

where p=1,2,3, . . . . In order to conserve energy, energy must be transferred from the hydrogen atom to the catalyst in units of an integer of the potential energy of the hydrogen atom in the normal n=1 state, and the radius transitions to

$$\frac{{a}_{H}}{m + p} .$$

Hydrinos are formed by reacting an ordinary hydrogen atom with a suitable catalyst having a net enthalpy of reaction of

m·27.2 eV (14)

where m is an integer. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

The catalyst reactions involve two steps of energy release: a nonradiative energy transfer to the catalyst followed by additional energy release as the radius decreases to the corresponding stable final state. Thus, the general reaction is given by

$$\begin{matrix}m \cdot 27.2 eV + {Cat}^{q +} + H [ \frac{{a}_{H}}{p} ] \to {Cat}^{( q + r ) +} + r {e}^{-} + H * [ \frac{{a}_{H}}{( m + p )} ] + m \cdot 27.2 eV & ( 15 ) \\ H * [ \frac{{a}_{H}}{( m + p )} ] \to H [ \frac{{a}_{H}}{( m + p )} ] + [ {( p + m )}^{2} - {p}^{2} ] \cdot 13.6 eV - m \cdot 27.2 eV & ( 16 ) \\ {Cat}^{( q + r ) +} + r {e}^{-} \to {Cat}^{q +} + m \cdot 27.2 eV and & ( 17 )\end{matrix}$$

the overall reaction is

$$H * [ \frac{{a}_{H}}{p} ] \to H [ \frac{{a}_{H}}{( m + p )} ] + [ {( p + m )}^{2} - {p}^{2} ] \cdot 13.6 eV \qquad ( 18 )$$

q, r, m, and p are integers.

$$H * [ \frac{{a}_{H}}{( m + p )} ]$$

has the radius of the hydrogen atom (corresponding to the 1 in the denominator) and a central field equivalent to (m+p) times that of a proton, and

$$H [ \frac{{a}_{H}}{( m + p )} ]$$

is the corresponding stable state with the radius of

$$\frac{1}{( m + p )}$$

that of H .

The catalyst product, H (1/p), may also react with an electron to form a hydrino hydride ion H⁻(1/p), or two H (1/p) may react to form the corresponding molecular hydrino H₂(1/p). Specifically, the catalyst product, H (1/p), may also react with an electron to form a novel hydride ion H⁻(1/p) with a binding energy E_{B}:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{2}} + \frac{{2}^{2}}{{{a}_{0}^{3} [ \frac{1 + \sqrt{s ( s + 1 )}}{p} ]}^{3}} ) \qquad ( 19 )$$

where p=integer >1, s=1/2, h is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, aₒ₀ is the Bohr radius, and the ionic radius is

$${r}_{1} = \frac{{a}_{0}}{p} ( 1 + \sqrt{s ( s + 1 )} ) .$$

From Eq. (19), the calculated ionization energy of the hydride ion is 0.75418 eV , and the experimental value is 6082.99±0.15 cm⁻¹ (0.75418 eV). The binding energies of hydrino hydride ions may be measured by X-ray photoelectron spectroscopy (XPS).

Upfield-shifted NMR peaks are direct evidence of the existence of lower-energy state hydrogen with a reduced radius relative to ordinary hydride ion and having an increase in diamagnetic shielding of the proton. The shift is given by the sum of the contributions of the diamagnetism of the two electrons and the photon field of magnitude p (Mills GUTCP Eq. (7.87)):

$$\frac{Δ {B}_{T}}{B} = - {μ}_{0} \frac{{pe}^{2}}{12 {m}_{e} {a}_{0} ( 1 + \sqrt{s ( s + 1 )} )} ( 1 + p {α}^{2} ) = - ( p 29.9 + {p}^{2} 1.59 \times {10}^{- 3} ) ppm \qquad ( 20 )$$

where the first term applies to H⁻ with p=1 and p=integer >1 for H⁻(1/p) and α is the fine structure constant. The predicted hydrino hydride peaks are extraordinarily upfield shifted relative to ordinary hydride ion. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 relative to a bare proton, may be −(p29.9+p²2.74) ppm (Eq. (20)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p29.9+p²1.59×10⁻³) ppm (Eq. (20)) within a range of about at least one of about 0.1% to 99%, 1% to 50%, and 1% to 10%. In another embodiment, the presence of a hydrino species such as a hydrino atom, hydride ion, or molecule in a solid matrix such as a matrix of a hydroxide such as NaOH or KOH causes the matrix protons to shift upfield. The matrix protons such as those of NaOH or KOH may exchange. In an embodiment, the shift may cause the matrix peak to be in the range of about —0.1 ppm to −5 ppm relative to TMS. The NMR determination may comprise magic angle spinning nuclear magnetic resonance spectroscopy (MAS NMR).

H (1/p) may react with a proton and two H (1/p) may react to form H₂ (1/p)⁺ and H₂ (1/p), respectively. The hydrogen molecular ion and molecular charge and current density functions, bond distances, and energies were solved from the Laplacian in ellipsoidal coordinates with the constraint of nonradiation.

$$( η - ζ ) {R}_{ξ} \frac{\partial }{\partial ξ} ( {R}_{ξ} \frac{\partial φ}{\partial ξ} ) + ( ζ - ξ ) {R}_{η} \frac{\partial }{\partial η} ( {R}_{η} \frac{\partial φ}{\partial η} ) + ( ξ - η ) {R}_{ζ} \frac{\partial }{\partial ζ} ( {R}_{ζ} \frac{\partial φ}{\partial ζ} ) = 0 \qquad ( 21 )$$

The total energy E_{T} of the hydrogen molecular ion having a central field of +pe at each focus of the prolate spheroid molecular orbital is

$$\begin{matrix} ( 22 ) \\ \begin{matrix}{E}_{T} = - {p}^{2} \{ \frac{{e}^{2}}{8 {πɛ}_{o} {a}_{H}} ( 4 ln 3 - 1 - 2 ln 3 ) [ 1 + p \sqrt{\frac{ 2 ℏ \sqrt{\frac{\frac{ 2 {e}^{2}}{4 {{πɛ}_{o} ( 2 {a}_{H} )}^{3}}}{{m}_{e}}}}{{m}_{e} {c}^{2}}} ] - \\ \frac{1}{2} ℏ \sqrt{\frac{\frac{{pe}^{2}}{4 {{πɛ}_{o} ( \frac{2 {a}_{H}}{p} )}^{3}} - \frac{{pe}^{2}}{8 {{πɛ}_{o} ( \frac{3 {a}_{H}}{p} )}^{3}}}{μ}} \} \\ = - {p}^{2} 16.13392 eV - {p}^{3} 0.118755 eV\end{matrix}\end{matrix}$$

where p is an integer, c is the speed of light in vacuum, and μ is the reduced nuclear mass. The total energy of the hydrogen molecule having a central field of +pe at each focus of the prolate spheroid molecular orbital is

$$\begin{matrix} ( 23 ) \\ \begin{matrix}{E}_{T} = - {p}^{2} \{ \frac{{e}^{2}}{8 {πɛ}_{o} {a}_{0}} [ ( 2 \sqrt{ 2} - \sqrt{2} + \frac{\sqrt{2}}{2} ) ln \frac{\sqrt{2} + 1}{\sqrt{2} - 1} - \sqrt{2} ] [ 1 + p \sqrt{\frac{ 2 ℏ \sqrt{\frac{ \frac{{e}^{2}}{4 {πɛ}_{o} {a}_{0}^{3}}}{{m}_{e}}}}{{m}_{e} {c}^{2}}} ] - \\ \frac{1}{2} ℏ \sqrt{\frac{\frac{{pe}^{2}}{8 {{πɛ}_{o} ( \frac{{a}_{0}}{p} )}^{3}} - \frac{{pe}^{2}}{8 {{πɛ}_{o} ( \frac{( 1 + \frac{1}{\sqrt{2}} ) {a}_{0}}{p} )}^{3}}}{μ}} \} \\ = - {p}^{2} 31.351 eV - {p}^{3} 0.326469 eV\end{matrix}\end{matrix}$$

The bond dissociation energy, E_{D}, of the hydrogen molecule H₂ (1/p) is the difference between the total energy of the corresponding hydrogen atoms and E_{T}

E_{D}=E(2H(1/p))−E_{T} (24)

where

E(2H(1/p))=−p²27.20 eV (25)

E_{D} is given by Eqs. (23-25):

$$\begin{matrix}{E}_{D} = - {p}^{2} 27.20 eV - {E}_{T} \\ = - {p}^{2} 27.20 eV - ( - {p}^{2} 31.351 eV - {p}^{3} 0.326469 eV ) \\ = {p}^{2} 4.151 eV + {p}^{3} 0.326469 eV\end{matrix} \qquad ( 26 )$$

H₂(1/p) may be identified by X-ray photoelectron spectroscopy (XPS) wherein the ionization product in addition to the ionized electron may be at least one of the possibilities such as those comprising two protons and an electron, a hydrogen (H) atom, a hydrino atom, a molecular ion, hydrogen molecular ion, and H₂(1/p) wherein the energies may be shifted by the matrix.

The NMR of catalysis-product gas provides a definitive test of the theoretically predicted chemical shift of H₂(1/p). In general, the ¹H NMR resonance of H₂(1/p) is predicted to be upfield from that of H₂ due to the fractional radius in elliptic coordinates wherein the electrons are significantly closer to the nuclei. The predicted shift,

$$\frac{Δ {B}_{T}}{B} ,$$

for H₂(1/p) is given by the sum of the contributions of the diamagnetism of the two electrons and the photon field of magnitude p (Mills GUTCP Eqs. (11.415-11.416)):

$$\begin{matrix}\frac{Δ {B}_{T}}{B} = - {μ}_{0} ( 4 - \sqrt{2} ln \frac{\sqrt{2} + 1}{\sqrt{2} - 1} ) \frac{{pe}^{2}}{36 {a}_{0} {m}_{e}} ( 1 + p {α}^{2} ) & ( 27 ) \\ \frac{Δ {B}_{T}}{B} = - ( p 28.01 + {p}^{2} 1.49 \times {10}^{- 3} ) ppm & ( 28 )\end{matrix}$$

where the first term applies to H₂ with p=1 and p=integer >1 for H₂(1/p). The experimental absolute H₂ gas-phase resonance shift of −28.0 ppm is in excellent agreement with the predicted absolute gas-phase shift of −28.01 ppm (Eq. (28)). The predicted molecular hydrino peaks are extraordinarily upfield shifted relative to ordinary H₂. In an embodiment, the peaks are upfield of TMS. The NMR shift relative to TMS may be greater than that known for at least one of ordinary H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 ppm relative to a bare proton, may be −(p28.01+p²2.56) ppm (Eq. (28)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p28.01+p²1.49×10⁻³) ppm (Eq. (28)) within a range of about at least one of about 0.1% to 99%, 1% to 50%, and 1% to 10%.

The vibrational energies, E_{vib}, for the ν=0 to ν=1 transition of hydrogen-type molecules H₂(1/p) are

E_{vib}=p²0.515902 eV (29)

where p is an integer.

The rotational energies, Eᵣₒₜ for the J to J+1 transition of hydrogen-type molecules H₂(1/p) are

$${E}_{rot} = {E}_{J + 1} - {E}_{J} = \frac{{ℏ}^{2}}{I} [ J + 1 ] = {p}^{2} ( J + 1 ) 0.01509 eV \qquad ( 30 )$$

where p is an integer and I is the moment of inertia. Ro-vibrational emission of H₂(1/4) was observed on e-beam excited molecules in gases and trapped in solid matrix.

The p² dependence of the rotational energies results from an inverse p dependence of the internuclear distance and the corresponding impact on the moment of inertia I. The predicted internuclear distance 2c′ for H₂(1/p) is

$$2 {c}^{′} = \frac{{a}_{o} \sqrt{2}}{p} \qquad ( 31 )$$

At least one of the rotational and vibration energies of H₂(1/p) may be measured by at least one of electron-beam excitation emission spectroscopy, Raman spectroscopy, and Fourier transform infrared (FTIR) spectroscopy. H₂(1/p) may be trapped in a matrix for measurement such as in at least one of MOH, MX, and M₂CO₃ (M=alkali; X=halide) matrix.

In an embodiment, the molecular hydrino product is observed as an inverse Raman effect (IRE) peak at about 1950 cm⁻¹. The peak is enhanced by using a conductive material comprising roughness features or particle size comparable to that of the Raman laser wavelength that supports a Surface Enhanced Raman Scattering (SERS) to show the IRE peak.

I. Catalysts

In the present disclosure the terms such as hydrino reaction, H catalysis, H catalysis reaction, catalysis when referring to hydrogen, the reaction of hydrogen to form hydrinos, and hydrino formation reaction all refer to the reaction such as that of Eqs. (15-18)) of a catalyst defined by Eq. (14) with atomic H to form states of hydrogen having energy levels given by Eqs. (10) and (12). The corresponding terms such as hydrino reactants, hydrino reaction mixture, catalyst mixture, reactants for hydrino formation, reactants that produce or form lower-energy state hydrogen or hydrinos are also used interchangeably when referring to the reaction mixture that performs the catalysis of H to H states or hydrino states having energy levels given by Eqs. (10) and (12).

The catalytic lower-energy hydrogen transitions of the present disclosure require a catalyst that may be in the form of an endothermic chemical reaction of an integer m of the potential energy of uncatalyzed atomic hydrogen, 27.2 eV, that accepts the energy from atomic H to cause the transition. The endothermic catalyst reaction may be the ionization of one or more electrons from a species such as an atom or ion (e.g. m=3 for Li→Li²) and may further comprise the concerted reaction of a bond cleavage with ionization of one or more electrons from one or more of the partners of the initial bond (e.g. m=2 for NaH→Na²⁺+H). He⁺ fulfills the catalyst criterion—a chemical or physical process with an enthalpy change equal to an integer multiple of 27.2 eV since it ionizes at 54.417 eV, which is 2·27.2 eV. An integer number of hydrogen atoms may also serve as the catalyst of an integer multiple of 27.2 eV enthalpy. catalyst is capable of accepting energy from atomic hydrogen in integer units of one of about

$$27.2 eV \pm 0.5 eV and \frac{27.2}{2} eV \pm 0.5 eV .$$

In an embodiment, the catalyst comprises an atom or ion M wherein the ionization of t electrons from the atom or ion M each to a continuum energy level is such that the sum of ionization energies of the t electrons is approximately one of

$$m • 27.2 eV and m • \frac{27.2}{2} eV$$

where m is an integer.

In an embodiment, the catalyst comprises a diatomic molecule MH wherein the breakage of the M—H bond plus the ionization of t electrons from the atom M each to a continuum energy level is such that the sum of the bond energy and ionization energies of the t electrons is approximately one of

$$m \cdot 27.2 eV and m • \frac{27.2}{2} eV$$

where m is an integer.

In an embodiment, the catalyst comprises atoms, ions, and/or molecules chosen from molecules of AlH, AsH, BaH, BiH, CdH, ClH, CoH, GeH, InH, NaH, NbH, OH, RhH, RuH, SH, SbH, SeH, SiH, SnH, SrH, TlH, C₂, N₂, O₂, CO₂, NO₂, and NO₃ and atoms or ions of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, 2K⁺, He⁺, Ti²⁺, Na⁺, Rb⁺, Sr⁺, Fe³⁺, Mo²⁺, Mo⁴⁺, In³⁺, He⁺, Ar⁺, Xe⁺, Ar²⁺ and H⁻, and Ne⁺ and H⁺.

In other embodiments, MH⁻ type hydrogen catalysts to produce hydrinos provided by the transfer of an electron to an acceptor A, the breakage of the M—H bond plus the ionization of t electrons from the atom M each to a continuum energy level such that the sum of the electron transfer energy comprising the difference of electron affinity (EA) of MI-1 and A, M—H bond energy, and ionization energies of the t electrons from M is approximately m·27.2 eV where m is an integer. MH⁻ type hydrogen catalysts capable of providing a net enthalpy of reaction of approximately m·27.2 eV are OH⁻, SiH⁻, CoH⁻, NiH⁻, and SeH⁻.

In other embodiments, MH⁺ type hydrogen catalysts to produce hydrinos are provided by the transfer of an electron from an donor A which may be negatively charged, the breakage of the M—H bond, and the ionization of t electrons from the atom M each to a continuum energy level such that the sum of the electron transfer energy comprising the difference of ionization energies of MH and A, bond M—H energy, and ionization energies of the t electrons from M is approximately m·27.2 eV where m is an integer.

In an embodiment, at least one of a molecule or positively or negatively charged molecular ion serves as a catalyst that accepts about m27.2 eV from atomic H with a decrease in the magnitude of the potential energy of the molecule or positively or negatively charged molecular ion by about m27.2 eV. Exemplary catalysts are H₂O, OH, amide group NH₂, and H₂S.

O₂ may serve as a catalyst or a source of a catalyst. The bond energy of the oxygen molecule is 5.165 eV, and the first, second, and third ionization energies of an oxygen atom are 13.61806 eV, 35.11730 eV, and 54.9355 eV, respectively. The reactions O₂→O+O²+, O₂→O+O³⁺, and 2O→2O⁺ provide a net enthalpy of about 2, 4, and 1 times Eₕ, respectively, and comprise catalyst reactions to form hydrino by accepting these energies from H to cause the formation of hydrinos.

II. Hydrinos

A hydrogen atom having a binding energy given by

$${E}_{B} = \frac{13.6 eV}{{( 1 / p )}^{2}}$$

where p is an integer greater than 1, preferably from 2 to 137, is the product of the H catalysis reaction of the present disclosure. The binding energy of an atom, ion, or molecule, also known as the ionization energy, is the energy required to remove one electron from the atom, ion or molecule. A hydrogen atom having the binding energy given in Eqs. (10) and (12) is hereafter referred to as a “hydrino atom” or “hydrino.” The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

According to the present disclosure, a hydrino hydride ion (H⁻) having a binding energy according to Eq. (19) that is greater than the binding of ordinary hydride ion (about 0.75 eV) for p=2 up to 23, and less for p=24 (H⁻) is provided. For p=2 to p=24 of Eq. (19), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Exemplary compositions comprising the novel hydride ion are also provided herein.

Exemplary compounds are also provided comprising one or more hydrino hydride ions and one or more other elements. Such a compound is referred to as a “hydrino hydride compound.”

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the present disclosure, a compound is provided comprising at least one increased binding energy hydrogen species such as (a) a hydrogen atom having a binding energy of about

$$\frac{13.6 eV}{{( \frac{1}{p} )}^{2}} ,$$

such as within a range of about 0.9 to 1.1 times

$$\frac{13.6 eV}{{( \frac{1}{p} )}^{2}}$$

where p is an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

such as within a range of about 0.9 to 1.1 times

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer from 2 to 24; (c) H₄⁺(1/p); (d) a trihydrino molecular ion, H₃⁺(1/p), having a binding energy of about

$$\frac{22.6}{{( \frac{1}{p} )}^{2}} eV$$

such as within a range of about 0.9 to 1.1 times

$$\frac{22.6}{{( \frac{1}{p} )}^{2}} eV$$

where p is an integer from 2 to 137; (e) a dihydrino having a binding energy of about

$$\frac{15.3}{{( \frac{1}{p} )}^{2}} eV$$

such as within a range of about 0.9 to 1.1 times

$$\frac{15.3}{{( \frac{1}{p} )}^{2}} eV$$

where p is an integer from 2 to 137; (f) a dihydrino molecular ion with a binding energy of about

$$\frac{16.3}{{( \frac{1}{p} )}^{2}} eV$$

such as within a range of about 0.9 to 1.1 times

$$\frac{16.3}{{( \frac{1}{p} )}^{2}} eV$$

where p is an integer, preferably an integer from 2 to 137.

According to a further embodiment of the present disclosure, a compound is provided comprising at least one increased binding energy hydrogen species such as (a) a dihydrino molecular ion having a total energy of about

$$\begin{matrix}{E}_{T} = - {p}^{2} \{ \frac{{e}^{2}}{8 {πɛ}_{o} {a}_{H}} ( 4 ln 3 - 1 - 2 ln 3 ) [ 1 + p \sqrt{\frac{ 2 ℏ \sqrt{\frac{\frac{ 2 {e}^{2}}{4 {{πɛ}_{o} ( 2 {a}_{H} )}^{3}}}{{m}_{e}}}}{{m}_{e} {c}^{2}}} ] - \\ \frac{1}{2} ℏ \sqrt{\frac{\frac{{pe}^{2}}{4 {{πɛ}_{o} ( \frac{2 {a}_{H}}{p} )}^{3}} - \frac{{pe}^{2}}{8 {{πɛ}_{o} ( \frac{3 {a}_{H}}{p} )}^{3}}}{μ}} \} \\ = - {p}^{2} 16.13392 eV - {p}^{3} 0.118755 eV\end{matrix}$$

such as within a range of about 0.9 to 1.1 times

$$\begin{matrix}{E}_{T} = - {p}^{2} \{ \frac{{e}^{2}}{8 {πɛ}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πɛ}_{o} ( 2 {a}_{H} )}^{3}}}{{m}_{e}}}}{{m}_{e} {c}^{2}}} ] - \\ \frac{1}{2} ℏ \sqrt{\frac{\frac{{pe}^{2}}{4 {{πɛ}_{o} ( \frac{2 {a}_{H}}{p} )}^{3}} - \frac{{pe}^{2}}{8 {{πɛ}_{o} ( \frac{3 {a}_{H}}{p} )}^{3}}}{μ}} \} \\ = - {p}^{2} 16.13392 eV - {p}^{3} 0.118755 eV\end{matrix}$$

where p is an integer, h is Planck's constant bar, mₑ is the mass of the electron, c is the speed of light in vacuum, and μ is the reduced nuclear mass, and (b) a dihydrino molecule having a total energy of about

$$\begin{matrix}{E}_{T} = - {p}^{2} \{ \frac{{e}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{{e}^{2}}{4 {πɛ}_{o} {a}_{0}^{3}}}{{m}_{e}}}}{{m}_{e} {c}^{2}}} ] - \\ \frac{1}{2} ℏ \sqrt{\frac{\frac{{pe}^{2}}{8 {{πɛ}_{o} ( \frac{{a}_{0}}{p} )}^{3}} - \frac{{pe}^{2}}{8 {{πɛ}_{o} ( \frac{( 1 + \frac{1}{\sqrt{2}} ) {a}_{0}}{p} )}^{3}}}{μ}} \} \\ = - {p}^{2} 31.351 eV - {p}^{3} 0.326469 eV\end{matrix}$$

such as within a range of about 0.9 to 1.1 times

$$\begin{matrix}{E}_{T} = - {p}^{2} \{ \frac{{e}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{{e}^{2}}{4 {πɛ}_{o} {a}_{0}^{3}}}{{m}_{e}}}}{{m}_{e} {c}^{2}}} ] - \\ \frac{1}{2} ℏ \sqrt{\frac{\frac{{pe}^{2}}{8 {{πɛ}_{o} ( \frac{{a}_{0}}{p} )}^{3}} - \frac{{pe}^{2}}{8 {{πɛ}_{o} ( \frac{( 1 + \frac{1}{\sqrt{2}} ) {a}_{0}}{p} )}^{3}}}{μ}} \} \\ = - {p}^{2} 31.351 eV - {p}^{3} 0.326469 eV\end{matrix}$$

where p is an integer and aₒ is the Bohr radius.

According to one embodiment of the present disclosure wherein the compound comprises a negatively charged increased binding energy hydrogen species, the compound further comprises one or more cations, such as a proton, ordinary H₂⁺, or ordinary H₃⁺.

A method is provided herein for preparing compounds comprising at least one hydrino hydride ion. Such compounds are hereinafter referred to as “hydrino hydride compounds.” The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

The novel hydrogen compositions of matter can comprise:

(a) at least one neutral, positive, or negative hydrogen species (hereinafter “increased binding energy hydrogen species”) having a binding energy

(i) greater than the binding energy of the corresponding ordinary hydrogen species, or

(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the present disclosure are hereinafter referred to as “increased binding energy hydrogen compounds.”

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy

(i) greater than the total energy of the corresponding ordinary hydrogen species, or

(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present disclosure has a total energy greater than the total energy of the corresponding ordinary hydrogen species. The hydrogen species having an increased total energy according to the present disclosure is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (19) for p=24 has a first binding energy that is less than the first binding energy of ordinary hydride ion, while the total energy of the hydride ion of Eq. (19) for p=24 is much greater than the total energy of the corresponding ordinary hydride ion.

Also provided herein are novel compounds and molecular ions comprising

(a) a plurality of neutral, positive, or negative hydrogen species (hereinafter “increased binding energy hydrogen species”) having a binding energy

(i) greater than the binding energy of the corresponding ordinary hydrogen species, or

(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the present disclosure are hereinafter referred to as “increased binding energy hydrogen compounds.”

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy

(i) greater than the total energy of ordinary molecular hydrogen, or

(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the present disclosure are hereinafter referred to as “increased binding energy hydrogen compounds.”

In an embodiment, a compound is provided comprising at least one increased binding energy hydrogen species chosen from (a) hydride ion having a binding energy according to Eq. (19) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”);

(c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”). In the disclosure, increased binding energy hydrogen species and compounds is also referred to as lower-energy hydrogen species and compounds. Hydrinos comprise an increased binding energy hydrogen species or equivalently a lower-energy hydrogen species.

III. Chemical Reactor

The present disclosure is also directed to other reactors for producing increased binding energy hydrogen species and compounds of the present disclosure, such as dihydrino molecules and hydrino hydride compounds. Further products of the catalysis are power and optionally plasma and light depending on the cell type. Such a reactor is hereinafter referred to as a “hydrogen reactor” or “hydrogen cell.” The hydrogen reactor comprises a cell for making hydrinos. The cell for making hydrinos may take the form of a chemical reactor or gas fuel cell such as a gas discharge cell, a plasma torch cell, or microwave power cell, and an electrochemical cell. In an embodiment, the catalyst is HOH and the source of at least one of the HOH and H is ice. In an embodiment, the cell comprises an arc discharge cell and that comprises ice at least one electrode such that the discharge involves at least a portion of the ice.

In an embodiment, the arc discharge cell comprises a vessel, two electrodes, a high voltage power source such as one capable of a voltage in the range of about 100 V to 1 MV and a current in the range of about 1 A to 100 kA, and a source of water such as a reservoir and a means to form and supply H₂O droplets. The droplets may travel between the electrodes. In an embodiment, the droplets initiate the ignition of the arc plasma. In an embodiment, the water arc plasma comprises H and HOH that may react to form hydrinos. The ignition rate and the corresponding power rate may be controlled by controlling the size of the droplets and the rate at which they are supplied to the electrodes. The source of high voltage may comprise at least one high voltage capacitor that may be charged by a high voltage power source. In an embodiment, the arc discharge cell further comprises a means such as a power converter such as one of the present invention such as at least one of a PV converter and a heat engine to convert the power from the hydrino process such as light and heat to electricity.

Exemplary embodiments of the cell for making hydrinos may take the form of a liquid-fuel cell, a solid-fuel cell, a heterogeneous-fuel cell, a CIHT cell, and an SF-CIHT or SunCell® cell. Each of these cells comprises: (i) a source of atomic hydrogen; (ii) at least one catalyst chosen from a solid catalyst, a molten catalyst, a liquid catalyst, a gaseous catalyst, or mixtures thereof for making hydrinos; and (iii) a vessel for reacting hydrogen and the catalyst for making hydrinos. As used herein and as contemplated by the present disclosure, the term “hydrogen,” unless specified otherwise, includes not only proteum (¹H), but also deuterium (²H) and tritium (³H). Exemplary chemical reaction mixtures and reactors may comprise SF-CIHT, CIHT, or thermal cell embodiments of the present disclosure. Additional exemplary embodiments are given in this Chemical Reactor section. Examples of reaction mixtures having H₂O as catalyst formed during the reaction of the mixture are given in the present disclosure. Other catalysts may serve to form increased binding energy hydrogen species and compounds. The reactions and conditions may be adjusted from these exemplary cases in the parameters such as the reactants, reactant wt %'s, H₂ pressure, and reaction temperature. Suitable reactants, conditions, and parameter ranges are those of the present disclosure. Hydrinos and molecular hydrino are shown to be products of the reactors of the present disclosure by predicted continuum radiation bands of an integer times 13.6 eV, otherwise unexplainable extraordinarily high H kinetic energies measured by Doppler line broadening of H lines, inversion of H lines, formation of plasma without a breakdown fields, and anomalously plasma afterglow duration as reported in Mills Prior Publications. The data such as that regarding the CIHT cell and solid fuels has been validated independently, off site by other researchers. The formation of hydrinos by cells of the present disclosure was also confirmed by electrical energies that were continuously output over long-duration, that were multiples of the electrical input that in most cases exceed the input by a factor of greater than 10 with no alternative source. The predicted molecular hydrino H₂(1/4) was identified as a product of CIHT cells and solid fuels by MAS H NMR that showed a predicted upfield shifted matrix peak of about −4.4 ppm, ToF-SIMS and ESI-ToFMS that showed H₂(1/4) complexed to a getter matrix as m/e=M+n2 peaks wherein M is the mass of a parent ion and n is an integer, electron-beam excitation emission spectroscopy and photoluminescence emission spectroscopy that showed the predicted rotational and vibration spectrum of H₂(1/4) having 16 or quantum number p=4 squared times the energies of H₂, Raman and FTIR spectroscopy that showed the rotational energy of H₂(1/4) of 1950 cm⁻¹, being 16 or quantum number p=4 squared times the rotational energy of H₂, XPS that showed the predicted total binding energy of H₂(1/4) of 500 eV, and a ToF-SIMS peak with an arrival time before the m/e=1 peak that corresponded to H with a kinetic energy of about 204 eV that matched the predicted energy release for H to H(1/4) with the energy transferred to a third body H as reported in Mills Prior Publications and in R. Mills X Yu, Y. Lu, G Chu, J. He, J. Lotoski, “Catalyst Induced Hydrino Transition (CIHT) Electrochemical Cell”, International Journal of Energy Research, (2013) and R. Mills, J. Lotoski, J. Kong, G Chu, J. He, J. Trevey, “High-Power-Density Catalyst Induced Hydrino Transition (CIHT) Electrochemical Cell” (2014) which are herein incorporated by reference in their entirety.

Using both a water flow calorimeter and a Setaram DSC 131 differential scanning calorimeter (DSC), the formation of hydrinos by cells of the present disclosure such as ones comprising a solid fuel to generate thermal power was confirmed by the observation of thermal energy from hydrino-forming solid fuels that exceed the maximum theoretical energy by a factor of 60 times. The MAS H NMR showed a predicted H₂(1/4) upfield matrix shift of about −4.4 ppm. A Raman peak starting at 1950 cm⁻¹ matched the free space rotational energy of H₂(1/4) (0.2414 eV). These results are reported in Mills Prior Publications and in R. Mills, J. Lotoski, W. Good, J. He, “Solid Fuels that Form HOH Catalyst”, (2014) which is herein incorporated by reference in its entirety.

IV. Solid Fuel Catalyst Induced Hydrino Transition (SF-CIHT) Cell and Power Converter

In an embodiment, a power system that generates at least one of direct electrical energy and thermal energy comprises at least one vessel, reactants comprising: (a) at least one source of catalyst or a catalyst comprising nascent H₂O; (b) at least one source of atomic hydrogen or atomic hydrogen; and (c) at least one of a conductor and a conductive matrix, and at least one set of electrodes to confine the hydrino reactants, a source of electrical power to deliver a short burst of high-current electrical energy, a reloading system, at least one system to regenerate the initial reactants from the reaction products, and at least one direct converter such as at least one of a plasma to electricity converter such as PDC, magnetohydrodynamic converter, a photovoltaic converter, an optical rectenna such as the one reported by A. Sharma, V. Singh, T. L. Bougher, B. A. Cola, “A carbon nanotube optical rectenna”, Nature Nanotechnology, Vol. 10, (2015), pp. 1027-1032, doi:10.1038/nnano.2015.220 which is incorporated by reference in its entirety, and at least one thermal to electric power converter. In a further embodiment, the vessel is capable of a pressure of at least one of atmospheric, above atmospheric, and below atmospheric. In an embodiment, the regeneration system can comprise at least one of a hydration, thermal, chemical, and electrochemical system. In another embodiment, the at least one direct plasma to electricity converter can comprise at least one of the group of plasmadynamic power converter, \vec{E}×\vec{B} direct converter, magnetohydrodynamic power converter, magnetic mirror magnetohydrodynamic power converter, charge drift converter, Post or Venetian Blind power converter, gyrotron, photon bunching microwave power converter, and photoelectric converter. In a further embodiment, the at least one thermal to electricity converter can comprise at least one of the group of a heat engine, a steam engine, a steam turbine and generator, a gas turbine and generator, a Rankine- cycle engine, a Brayton-cycle engine, a Stirling engine, a thermionic power converter, and a thermoelectric power converter.

The SunCell® may comprise a plurality of electrodes. In an embodiment, the hydrino reaction occurs selectively at a polarized electrode such as a positively polarized electrode. The reaction selectivity may be due to the much higher kinetics of the hydrino reaction at the positively biased electrode. In an embodiment, at least one component of the SunCell® such as the reaction cell chamber 5b31 walls may be biased positively to increase the hydrino reaction rate. The SunCell® may comprise a conductive reservoir 5c connected to the lower hemisphere 5b41 of the blackbody radiator wherein the reservoir is biased positively. The bias may be achieved by the contact between the molten metal in the reservoir 5c and at least one of the EM pump tube 5k6 and 5k61 that are biased positively. The EM may be biased positively through the connection of the ignition electromagnetic pump bus bar 5k2a to the positive terminal of the source of electrical power 2.

The ignition may cause release of high power EUV light that may ionize a photoelectric active electrode to cause a voltage at the electrode. The ignition plasma may be optically thick to the EUV light such that the EUV light may be selective confined to the positive electrode to further cause selective localization of the photoelectron effect at the positive electrode. The SunCell® may further comprise an external circuit connected across an electrical load to harness the voltage due to the photoelectron effect and the hydrino-based power. In an embodiment, the ignition event to form hydrinos causes an electromagnetic pulse that may be captured as electrical power at a plurality of electrodes wherein a rectifier may rectify the electromagnetic power.

In addition to UV photovoltaic and thermal photovoltaic of the current disclosure, the SunCell® may comprise other electric conversion means known in the art such as thermionic, magnetohydrodynamic, turbine, microturbine, Rankine or Brayton cycle turbine, chemical, and electrochemical power conversion systems. The Rankine cycle turbine may comprise supercritical CO₂, an organic such as hydrofluorocarbon or fluorocarbon, or steam working fluid. In a Rankine or Brayton cycle turbine, the SunCell® may provide thermal power to at least one of the preheater, recuperator, boiler, and external combustor-type heat exchanger stage of a turbine system. In an embodiment, the Brayton cycle turbine comprises a SunCell® turbine heater integrated into the combustion section of the turbine. The SunCell® turbine heater may comprise ducts that receive airflow from at least one of the compressor and recuperator wherein the air is heated and the ducts direct the heated compressed flow to the inlet of the turbine to perform pressure-volume work. The SunCell® turbine heater may replace or supplement the combustion chamber of the gas turbine. The Rankine or Brayton cycle may be closed wherein the power converter further comprises at least one of a condenser and a cooler.

The converter may be one given in Mills Prior Publications and Mills Prior Applications. The hydrino reactants such as H sources and HOH sources and SunCell® systems may comprise those of the present disclosure or in prior US Patent Applications such as Hydrogen Catalyst Reactor, PCT/US08/61455, filed PCT Apr. 24, 2008; Heterogeneous Hydrogen Catalyst Reactor, PCT/US09/052072, filed PCT Jul. 29, 2009; Heterogeneous Hydrogen Catalyst Power System, PCT/US10/27828, PCT filed Mar. 18, 2010; Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed PCT Jan. 10, 2014; Photovoltaic Power Generation Systems and Methods Regarding Same, PCT/US14/32584 filed PCT Apr. 1, 2014; Electrical Power Generation Systems and Methods Regarding Same, PCT/US2015/033165 filed PCT May 29, 2015; Ultraviolet Electrical Generation System Methods Regarding Same, PCT/US2015/065826 filed PCT Dec. 15, 2015, and Thermophotovoltaic Electrical Power Generator, PCT/US16/12620 filed PCT Jan. 8, 2016 (“Mills Prior Applications”) herein incorporated by reference in their entirety.

In an embodiment, H₂O is ignited to form hydrinos with a high release of energy in the form of at least one of thermal, plasma, and electromagnetic (light) power. (“Ignition” in the present disclosure denotes a very high reaction rate of H to hydrinos that may be manifest as a burst, pulse or other form of high power release.) H₂O may comprise the fuel that may be ignited with the application a high current such as one in the range of about 100 A to 100,000 A. This may be achieved by the application of a high voltage such as about 5,000 to 100,000 V to first form highly conducive plasma such as an arc. Alternatively, a high current may be passed through a compound or mixture comprising H₂O wherein the conductivity of the resulting fuel such as a solid fuel is high. (In the present disclosure a solid fuel is used to denote a reaction mixture that forms a catalyst such as HOH and H that further reacts to form hydrinos. The plasma volatge may be low such as in the range of about 1 V to 100V. However, the reaction mixture may comprise other physical states than solid. In embodiments, the reaction mixture may be at least one state of gaseous, liquid, molten matrix such as molten conductive matrix such a molten metal such as at least one of molten silver, silver-copper alloy, and copper, solid, slurry, sol gel, solution, mixture, gaseous suspension, pneumatic flow, and other states known to those skilled in the art.) In an embodiment, the solid fuel having a very low resistance comprises a reaction mixture comprising H₂O. The low resistance may be due to a conductor component of the reaction mixture. In embodiments, the resistance of the solid fuel is at least one of in the range of about 10⁻⁹ ohm to 100 ohms, 10⁻⁸ ohm to 10 ohms, 10⁻³ ohm to 1 ohm, 10⁻⁴ ohm to 10⁻¹ ohm, and 10⁻⁴ ohm to 10⁻² ohm. In another embodiment, the fuel having a high resistance comprises H₂O comprising a trace or minor mole percentage of an added compound or material. In the latter case, high current may be flowed through the fuel to achieve ignition by causing breakdown to form a highly conducting state such as an arc or arc plasma.

In an embodiment, the reactants can comprise a source of H₂O and a conductive matrix to form at least one of the source of catalyst, the catalyst, the source of atomic hydrogen, and the atomic hydrogen. In a further embodiment, the reactants comprising a source of H₂O can comprise at least one of bulk H₂O, a state other than bulk H₂O, a compound or compounds that undergo at least one of react to form H₂O and release bound H₂O. Additionally, the bound H₂O can comprise a compound that interacts with H₂O wherein the H₂O is in a state of at least one of absorbed H₂O, bound H₂O, physisorbed H₂O, and waters of hydration. In embodiments, the reactants can comprise a conductor and one or more compounds or materials that undergo at least one of release of bulk H₂O, absorbed H₂O, bound H₂O, physisorbed H₂O, and waters of hydration, and have H₂O as a reaction product. In other embodiments, the at least one of the source of nascent H₂O catalyst and the source of atomic hydrogen can comprise at least one of: (a) at least one source of H₂O; (b) at least one source of oxygen, and (c) at least one source of hydrogen.

In an embodiment, the hydrino reaction rate is dependent on the application or development of a high current. In an embodiment of an SF-CIHT cell, the reactants to form hydrinos are subject to a low voltage, high current, high power pulse that causes a very rapid reaction rate and energy release. In an exemplary embodiment, a 60 Hz voltage is less than 15 V peak, the current ranges from 100 A/cm² and 50,000 A/cm² peak, and the power ranges from 1000 W/cm² and 750,000 W/cm². Other frequencies, voltages, currents, and powers in ranges of about 1/100 times to 100 times these parameters are suitable. In an embodiment, the hydrino reaction rate is dependent on the application or development of a high current. In an embodiment, the voltage is selected to cause a high AC, DC, or an AC-DC mixture of current that is in the range of at least one of 100 A to 1,000,000 A, 1 kA to 100,000 A, 10 kA to 50 kA. The DC or peak AC current density may be in the range of at least one of 100 A/cm² to 1,000,000 A/cm², 1000 A/cm² to 100,000 A/cm², and 2000 A/cm² to 50,000 A/cm². The DC or peak AC voltage may be in at least one range chosen from about 0.1 V to 1000 V, 0.1 V to 100 V, 0.1 V to 15 V, and 1 V to 15 V. The AC frequency may be in the range of about 0.1 Hz to 10 GHz, 1 Hz to 1 MHz, 10 Hz to 100 kHz, and 100 Hz to 10 kHz. The pulse time may be in at least one range chosen from about 10⁻⁶ s to 10 s, 10⁻⁵ s to 1 s, 10⁻⁴ s to 0.1 s, and 10⁻³ s to 0.01 s.

In an embodiment, the transfer of energy from atomic hydrogen catalyzed to a hydrino state results in the ionization of the catalyst. The electrons ionized from the catalyst may accumulate in the reaction mixture and vessel and result in space charge build up. The space charge may change the energy levels for subsequent energy transfer from the atomic hydrogen to the catalyst with a reduction in reaction rate. In an embodiment, the application of the high current removes the space charge to cause an increase in hydrino reaction rate. In another embodiment, the high current such as an arc current causes the reactant such as water that may serve as a source of H and HOH catalyst to be extremely elevated in temperature. The high temperature may give rise to the thermolysis of the water to at least one of H and HOH catalyst. In an embodiment, the reaction mixture of the SF-CIHT cell comprises a source of H and a source of catalyst such as at least one of nH (n is an integer) and HOH. The at least one of nH and HOH may be formed by the thermolysis or thermal decomposition of at least one physical phase of water such as at least one of solid, liquid, and gaseous water. The thermolysis may occur at high temperature such as a temperature in at least one range of about 500K to 10,000K, 1000K to 7000K, and 1000K to 5000K. In an exemplary embodiment, the reaction temperature is about 3500 to 4000K such that the mole fraction of atomic H is high as shown by J. Lede, F. Lapicque, and J Villermaux [J. Lede, F. Lapicque, J. Villermaux, “Production of hydrogen by direct thermal decomposition of water”, International Journal of Hydrogen Energy, 1983, V8, 1983, pp. 675-679; H. H. G. Jellinek, H. Kachi, “The catalytic thermal decomposition of water and the production of hydrogen”, International Journal of Hydrogen Energy, 1984, V9, pp. 677-688; S. Z. Baykara, “Hydrogen production by direct solar thermal decomposition of water, possibilities for improvement of process efficiency”, International Journal of Hydrogen Energy, 2004, V29, pp. 1451-1458; S. Z. Baykara, “Experimental solar water thermolysis”, International Journal of Hydrogen Energy, 2004, V29, pp. 1459-1469 which are herein incorporated by reference]. The thermolysis may be assisted by a solid surface such as one of the cell compoments. The solid surface may be heated to an elevated temperature by the input power and by the plasma maintained by the hydrino reaction. The thermolysis gases such as those down stream of the ignition region may be cooled to prevent recombination or the back reaction of the products into the starting water. The reaction mixture may comprise a cooling agent such as at least one of a solid, liquid, or gaseous phase that is at a lower temperature than the temperature of the product gases. The cooling of the thermolysis reaction product gases may be achieved by contacting the products with the cooling agent. The cooling agent may comprise at least one of lower temperature steam, water, and ice.

The SunCell® may comprise a thermolysis hydrogen generator comprising a SunCell® radiator, a metal oxide, a water source, a water sprayer, and a hydrogen and oxygen gas collection system. The blackbody radiation from the blackbody radiator 5b4 may be incident a metal oxide that decomposes to oxygen and the metal upon heating. The hydrogen generator may comprise a water source and a water sprayer that spays the metal. The metal may react with the water to form the metal oxide and hydrogen gas. The gases may be collected using separator and collection systems known in the art. The reaction may be represented by

MₓO_{y}=xM+y/2O₂

xM+yH₂O=MₓO_{y}+yH₂

The metal and oxide may be ones know in the art to support thermolysis of H₂O to form hydrogen such as ZnO/Zn and SnO/Sn. Other exemplary oxides are manganese oxide, cobalt oxide, iron oxide, and their mixtures as known in the art and given in https://www.stage-ste.eu/documents/SF%201%20201%20solar_fuels%20by%20SolarPACES.pdf which is incorporated by reference in its entirety.

In an embodiment, the SF-CIHT or SunCell® generator comprises a power system that generates at least one of electrical energy and thermal energy comprising:
at least one vessel;
reactants comprising:
   a) at least one source of catalyst or a catalyst comprising nascent H2O;
   b) at least one source of H2O or H2O;
   c) at least one source of atomic hydrogen or atomic hydrogen; and
   d) at least one of a conductor and a conductive matrix;
at least one reactants injection system;
at least one reactants ignition system to cause the reactants to form at least one of light-emitting plasma and thermal-emitting plasma;
a system to recover reaction products of the reactants;
at least one regeneration system to regenerate additional reactants from the reaction products,
   wherein the additional reactants comprise:
   a) at least one source of catalyst or a catalyst comprising nascent H2O;
   b) at least one source of H2O or H2O;
   c) at least one source of atomic hydrogen or atomic hydrogen; and
   d) at least one of a conductor and a conductive matrix; and

at least one power converter or output system of at least one of the light and thermal output to electrical power and/or thermal power such as at least one of the group of a photovoltaic converter, a photoelectronic converter, a plasmadynamic converter, a thermionic converter, a thermoelectric converter, a Sterling engine, a Brayton cycle engine, a Rankine cycle engine, and a heat engine, and a heater.

In an embodiment, the shot fuel may comprise at least one of a source of H, H₂, a source of catalyst, a source of H₂O, and H₂O. Suitable shot comprises a conductive metal matrix and a hydrate such as at least one of an alkali hydrate, an alkaline earth hydrate, and a transition metal hydrate. The hydrate may comprise at least one of MgCl₂.6H₂O, BaI₂.2H₂O, and ZnCl₂.4H₂O. Alternatively, the shot may comprise at least one of silver, copper, absorbed hydrogen, and water.

The ignition system may comprise:

a) at least one set of electrodes to confine the reactants; and

b) a source of electrical power to deliver a short burst of high-current electrical energy wherein the short burst of high-current electrical energy is sufficient to cause the reactants to react to form plasma. The source of electrical power may receive electrical power from the power converter. In an embodiment, the reactants ignition system comprises at least one set of electrodes that are separated to form an open circuit, wherein the open circuit is closed by the injection of the reactants to cause the high current to flow to achieve ignition. In an embodiment, the ignition system comprises a switch to at least one of initiate the current and interrupt the current once ignition is achieved. The flow of current may be initiated by reactants that completes the gap between the electrodes. The switching may be performed electronically by means such as at least one of an insulated gate bipolar transistor (IGBT), a silicon controlled rectifier (SCR), and at least one metal oxide semiconductor field effect transistor (MOSFET). Alternatively, ignition may be switched mechanically. The current may be interrupted following ignition in order to optimize the output hydrino generated energy relative to the input ignition energy. The ignition system may comprise a switch to allow controllable amounts of energy to flow into the fuel to cause detonation and turn off the power during the phase wherein plasma is generated. In an embodiment, the source of electrical power to deliver a short burst of high-current electrical energy comprises at least one of the following:
a voltage selected to cause a high AC, DC, or an AC-DC mixture of current that is in the range of at least one of 100 A to 1,000,000 A, 1 kA to 100,000 A, 10 kA to 50 kA;
a DC or peak AC current density in the range of at least one of 100 A/cm² to 1,000,000 A/cm², 1000 A/cm² to 100,000 A/cm², and 2000 A/cm² to 50,000 A/cm²;

wherein the voltage is determined by the conductivity of the solid fuel wherein the voltage is given by the desired current times the resistance of the solid fuel sample;

the DC or peak AC voltage is in the range of at least one of 0.1 V to 500 kV, 0.1 V to 100 kV, and 1 V to 50 kV, and

the AC frequency is in range of at least one of 0.1 Hz to 10 GHz, 1 Hz to 1 MHz, 10 Hz to 100 kHz, and 100 Hz to 10 kHz.

The output power of the SF-CIHT cell may comprise thermal and photovoltaic-convertible light power. In an embodiment, the light to electricity converter may comprise one that exploits at least one of the photovoltaic effect, the thermionic effect, and the photoelectron effect. The power converter may be a direct power converter that converts the kinetic energy of high-kinetic-energy electrons into electricity. In an embodiment, the power of the SF-CIHT cell may be at least partially in the form of thermal energy or may be at least partially converted into thermal energy. The electricity power converter may comprise a thermionic power converter. An exemplary thermionic cathode may comprise scandium-doped tungsten. The cell may exploit the photon-enhanced thermionic emission (PETE) wherein the photo-effect enhances electron emission by lifting the electron energy in a semiconductor emitter across the bandgap into the conduction band from which the electrons are thermally emitted. In an embodiment, the SF-CIHT cell may comprise an absorber of light such as at least one of extreme ultraviolet (EUV), ultraviolet (UV), visible, and near infrared light. The absorber may be outside if the cell. For example, it may be outside of the window of the PV converter 26a. The absorber may become elevated in temperature as a result of the absorption. The absorber temperature may be in the range of about 500° C. to 4000° C. The heat may be input to a thermophotovoltaic or thermionic cell. Thermoelectric and heat engines such as Stirling, Rankine, Brayton, and other heat engines known in the art are within the scope of the disclosure.

At least one first light to electricity converter such as one that exploits at least one of the photovoltaic effect, the thermionic effect, and the photoelectron effect of a plurality of converters may be selective for a first portion of the electromagnetic spectrum and transparent to at least a second portion of the electromagnetic spectrum. The first portion may be converted to electricity in the corresponding first converter, and the second portion for which the first converter is non-selective may propagate to another, second converter that is selective for at least a portion of the propagated second portion of electromagnetic spectrum.

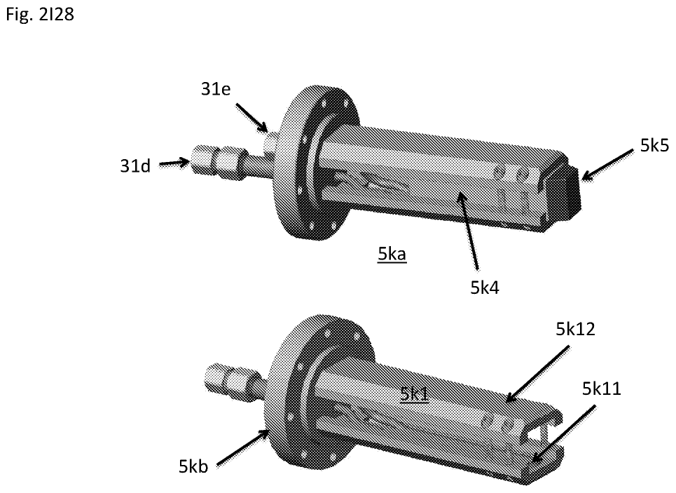

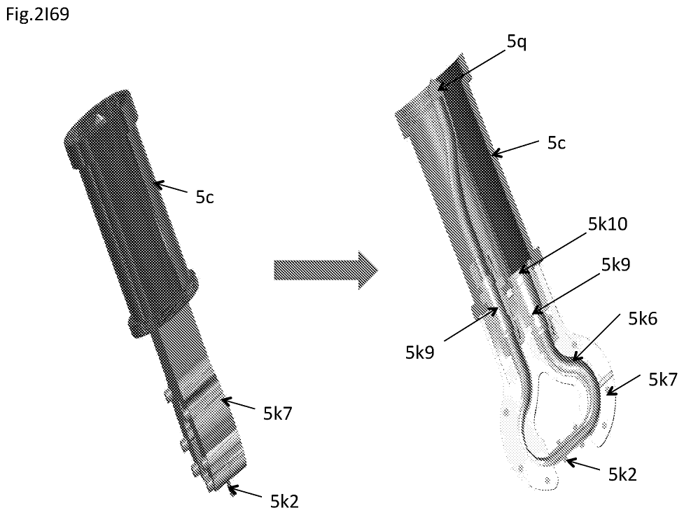

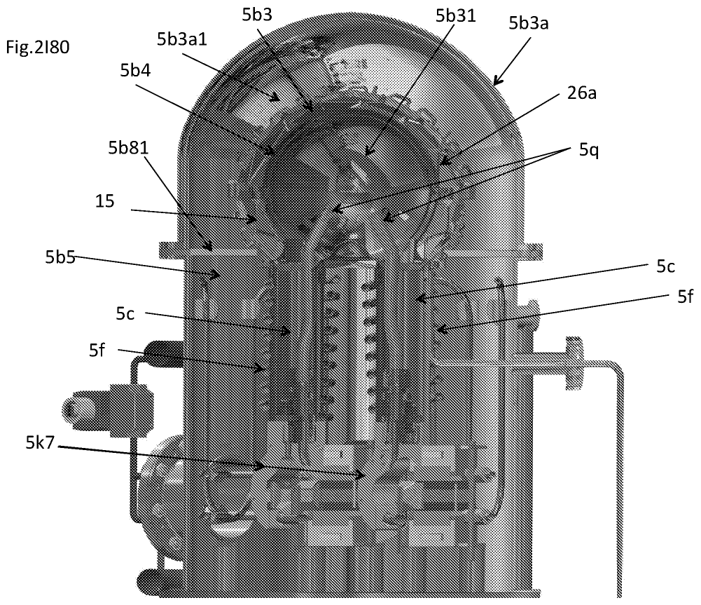

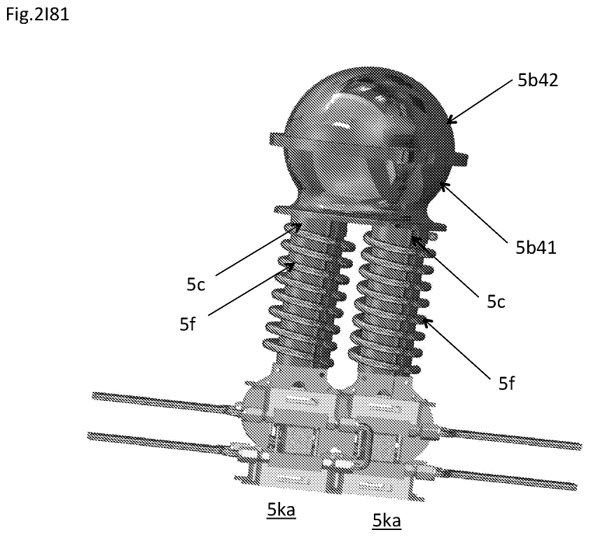

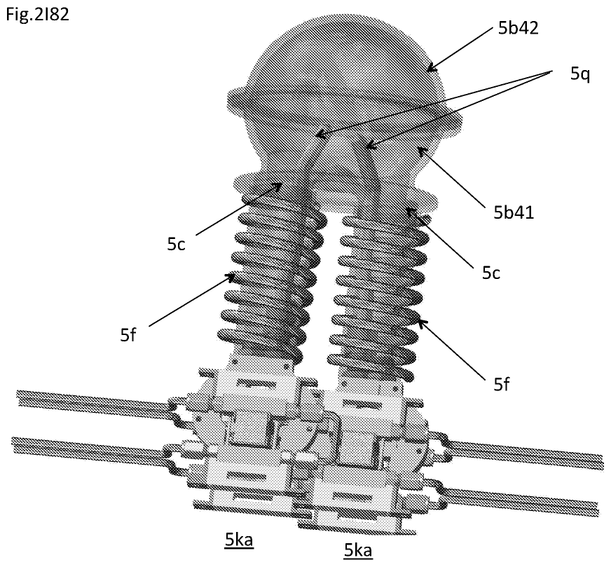

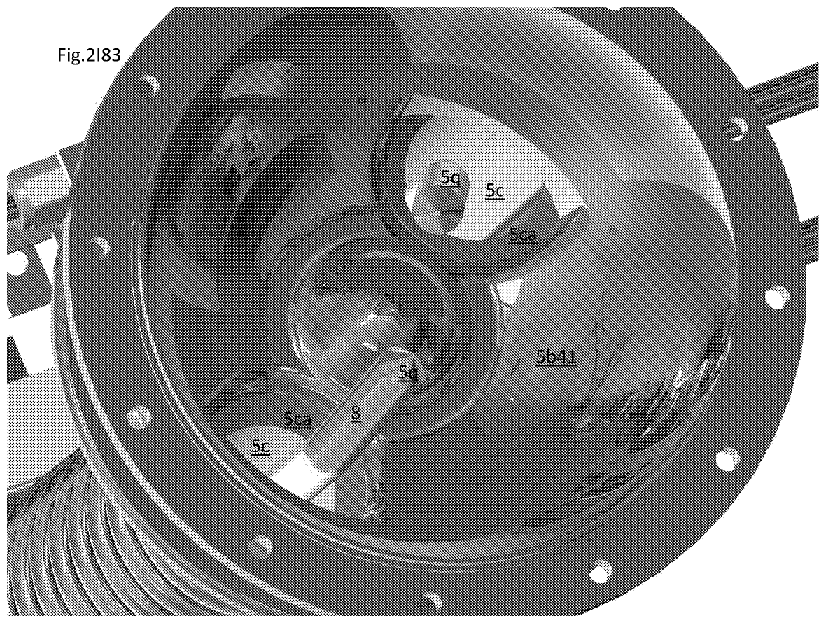

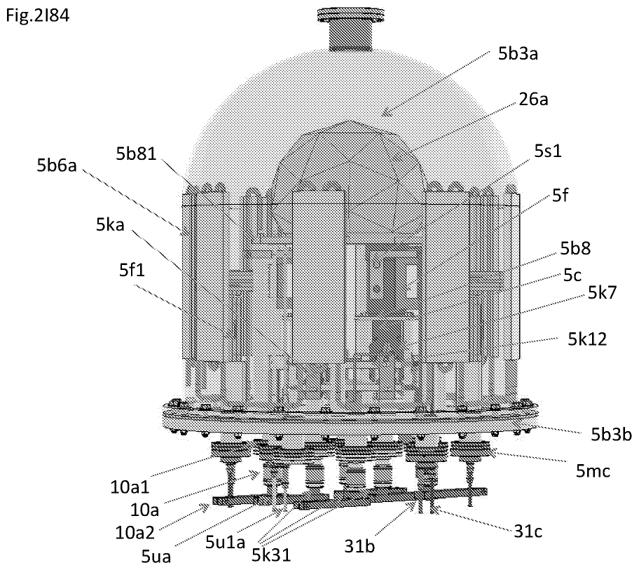

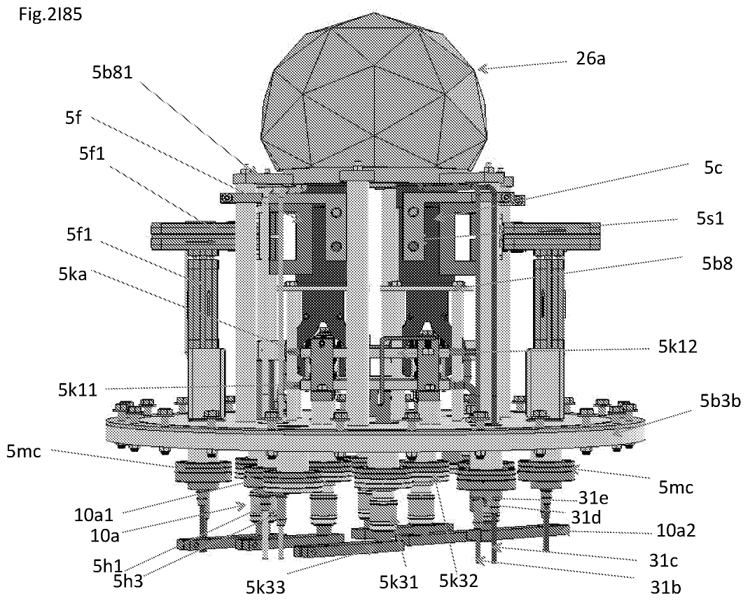

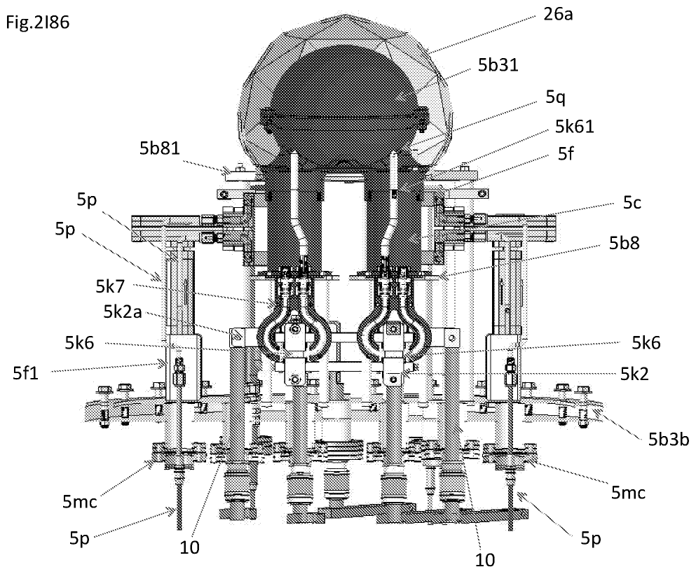

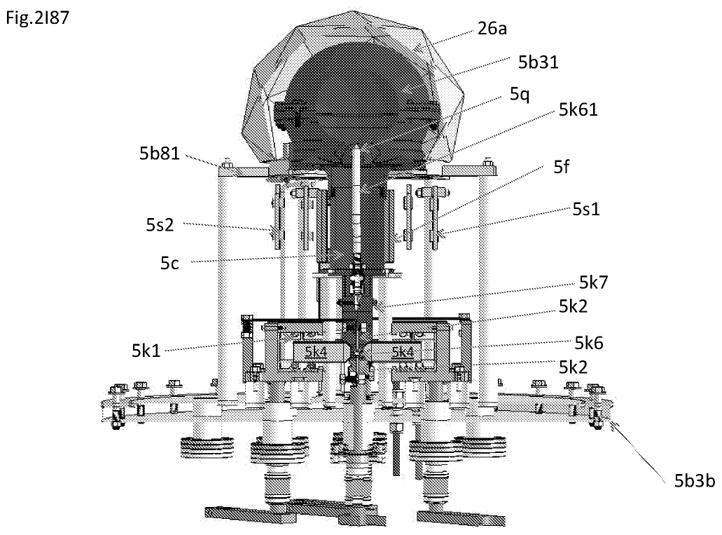

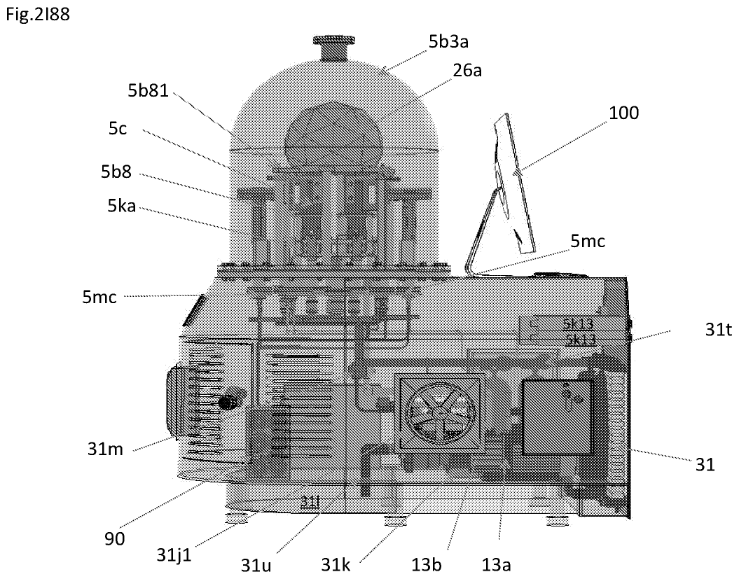

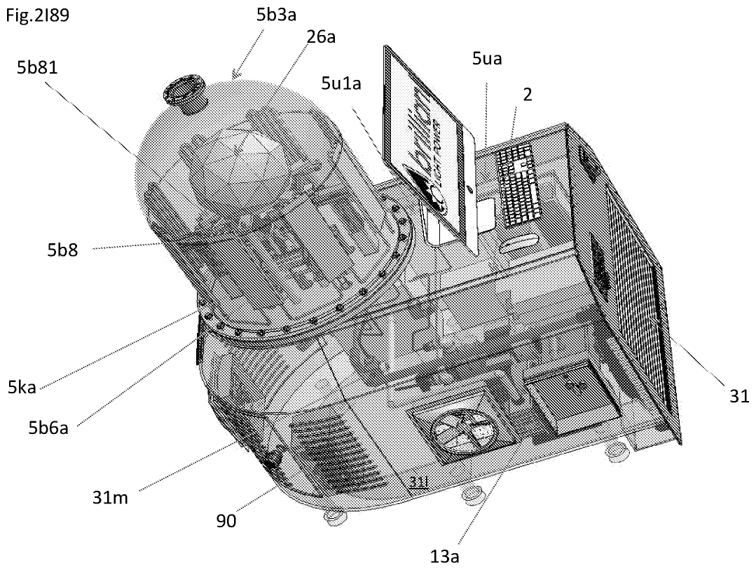

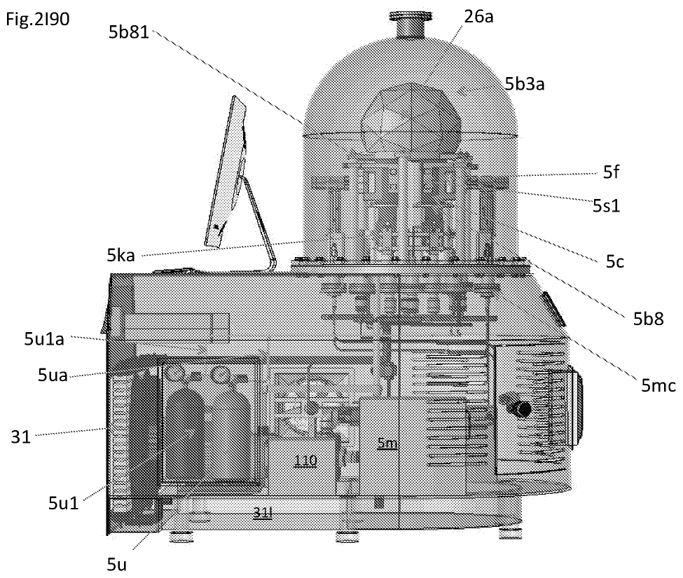

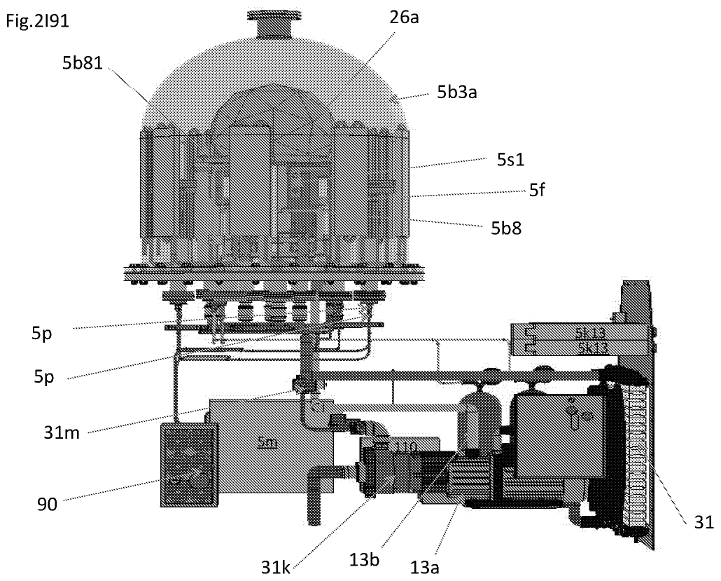

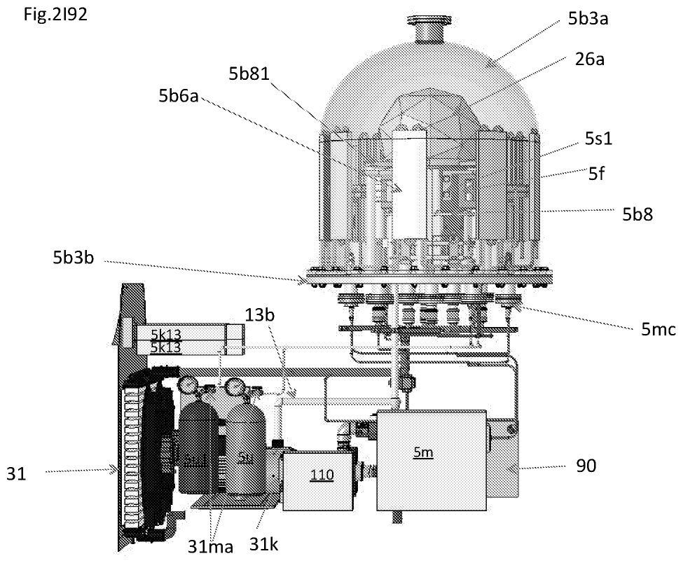

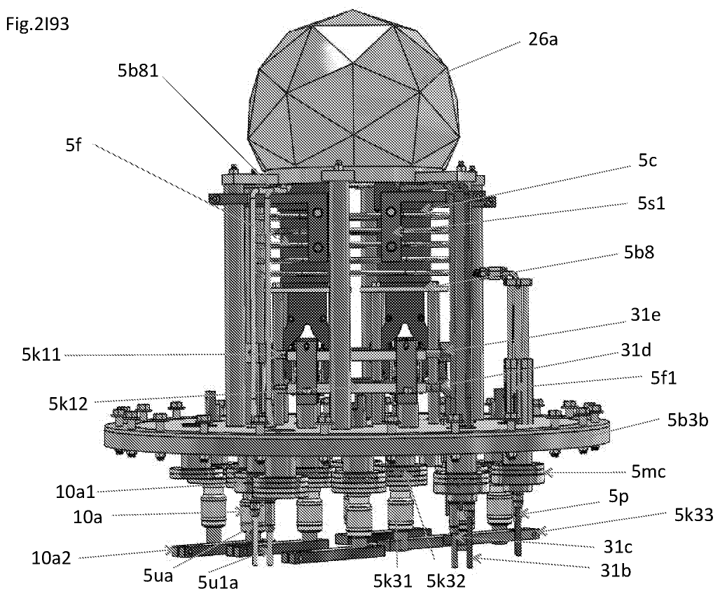

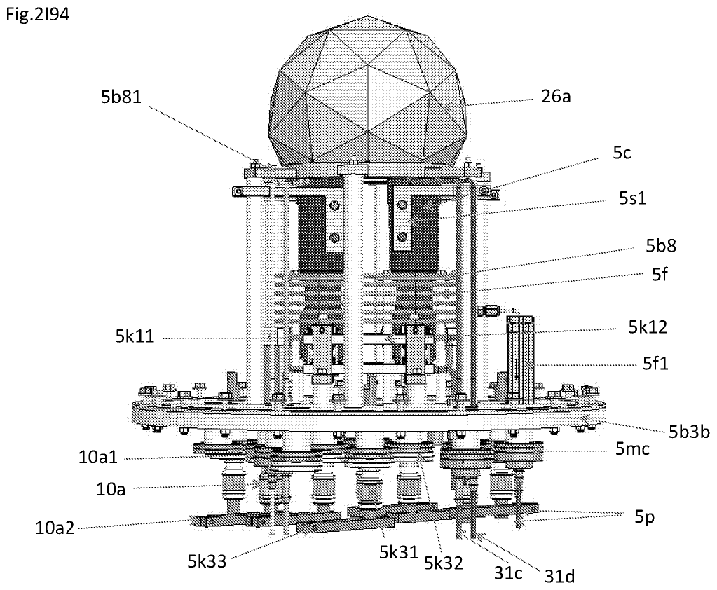

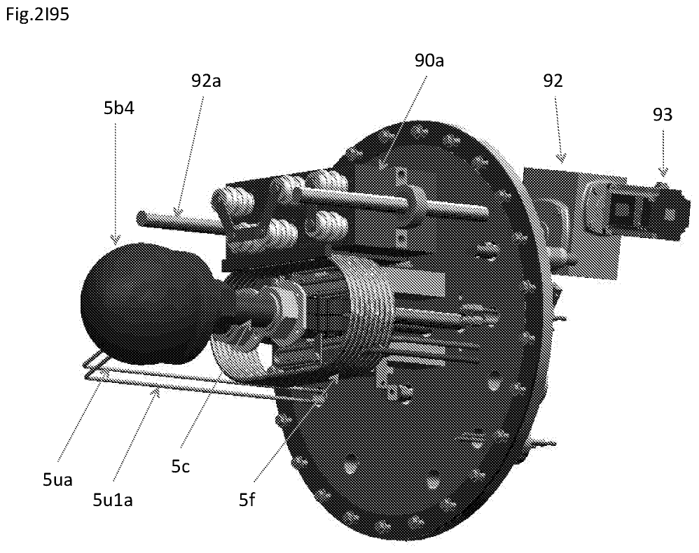

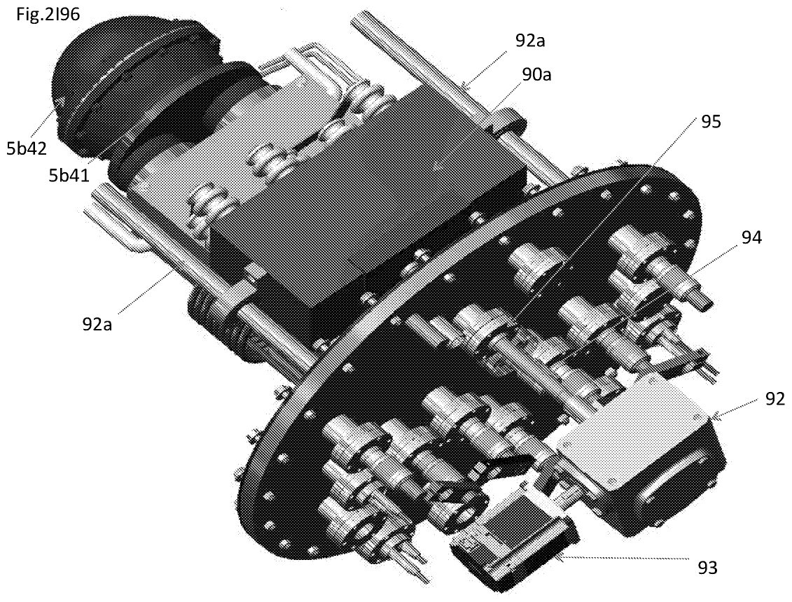

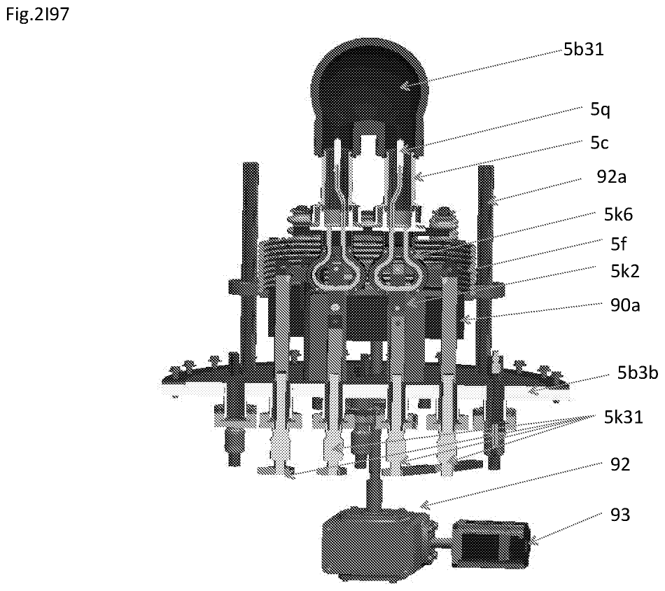

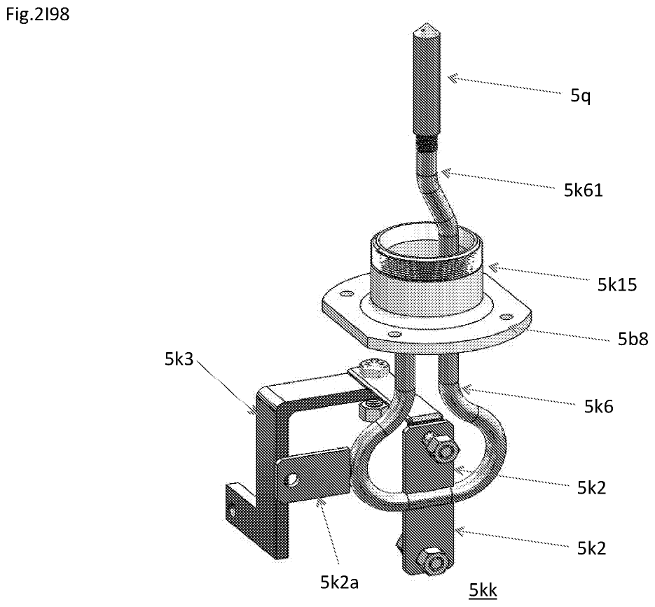

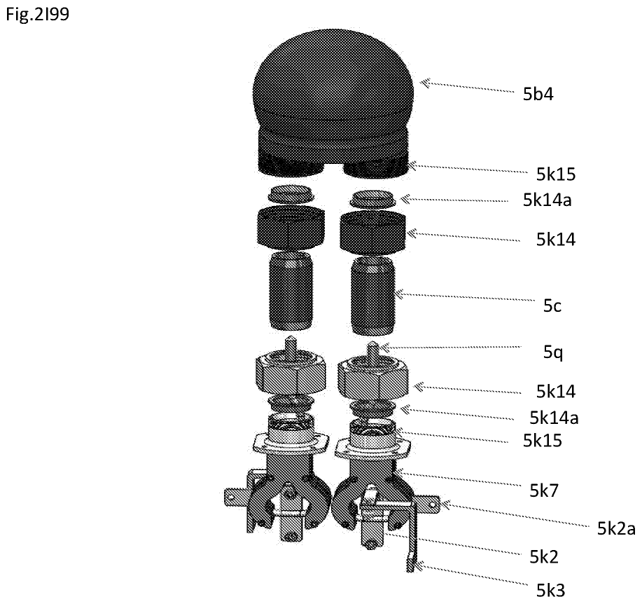

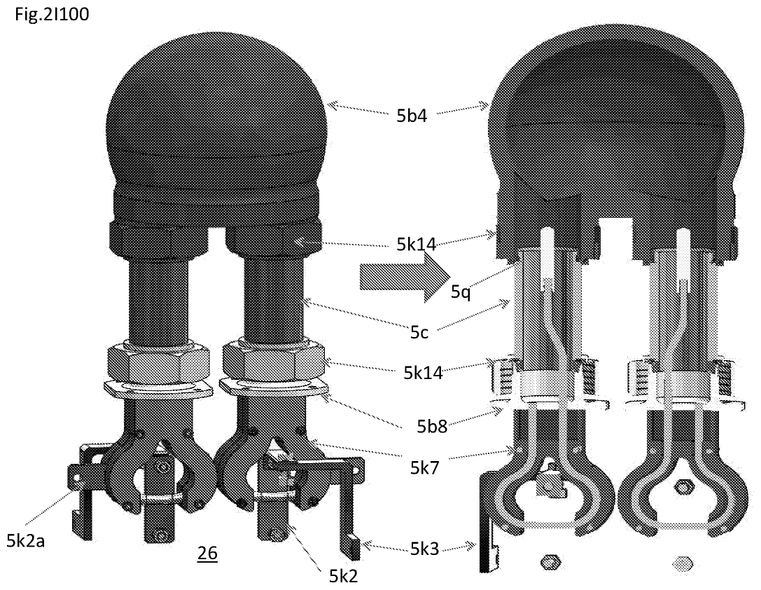

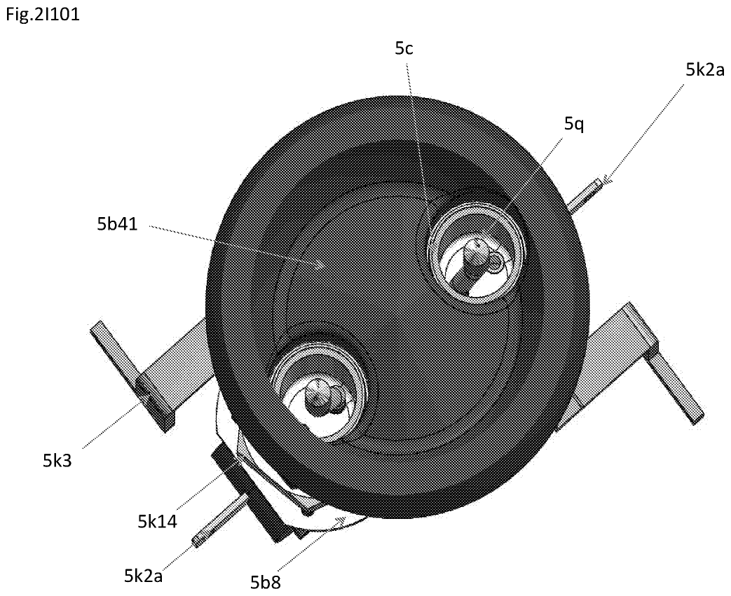

In embodiment, the SF-CIHT cell or generator also referred to as the SunCellg® shown in FIGS. 2I28, 2I69, and 2I80-2I149 comprises six fundamental low-maintenance systems, some having no moving parts and capable of operating for long duration: (i) a start-up inductively coupled heater comprising a power supply 5m, leads 5p, and antenna coil 5f to first melt silver or silver-copper alloy to comprise the molten metal or melt and optionally an electrode electromagnetic pump comprising magnets to initially direct the ignition plasma stream; (ii) a fuel injector such as one comprising a hydrogen supply such as a hydrogen permeation supply through the blackbody radiator wherein the hydrogen may be derived from water by electrolysis or thermolysis, and an injection system comprising an electromagnetic pump 5ka to inject molten silver or molten silver-copper alloy and a source of oxygen such as an oxide such as LiVO₃ or another oxide of the disclosure, and alternatively a gas injector 5z1 to inject at least one of water vapor and hydrogen gas; (iii) an ignition system to produce a low-voltage, high current flow across a pair of electrodes 8 into which the molten metal, hydrogen, and oxide, or molten metal and at least one of H₂O and hydrogen gases are injected to form a brilliant light-emitting plasma; (iv) a blackbody radiator heated to incandescent temperature by the plasma; (v) a light to electricity converter 26a comprising so-called concentrator photovoltaic cells 15 that receive light from the blackbody radiator and operate at a high light intensity such as over one thousand Suns; and (vi) a fuel recovery and a thermal management system 31 that causes the molten metal to return to the injection system following ignition. In another, embodiment, the light from the ignition plasma may directly irradiate the PV converter 26a to be converted to electricity.

In an embodiment, the plasma emits a significant portion of the optical power and energy as EUV and UV light. The pressure may be reduced by maintaining a vacuum in the reaction chamber, cell 1, to maintain the plasma at condition of being less optically thick to decease the attenuation of the short wavelength light. In an embodiment, the light to electricity converter comprises the photovoltaic converter of the disclosure comprising photovoltaic (PV) cells that are responsive to a substantial wavelength region of the light emitted from the cell such as that corresponding to at least 10% of the optical power output. In an embodiment, the fuel may comprise silver having at least one of trapped hydrogen and trapped H₂O. The light emission may comprise predominantly ultraviolet light such as light in the wavelength region of about 120 nm to 300 nm. The PV cell may response to at least a portion of the wavelength region of about 120 nm to 300 nm. The PV cell may comprise a group III nitride such as at least one of InGaN, GaN, and AlGaN. In an embodiment, the PV cell comprises SiC. In an embodiment, the PV cell may comprise a plurality of junctions. The junctions may be layered in series. In another embodiment, the junctions are independent or electrically parallel. The independent junctions may be mechanically stacked or wafer bonded. At least one of layers of multi junction cells and cells connected in series may comprise bypass diodes to minimize current and power loss due to current mismatches between layers of cells. An exemplary multi junction PV cell comprises at least two junctions comprising n-p doped semiconductor such as a plurality from the group of InGaN, GaN, and AlGaN. The n dopant of GaN may comprise oxygen, and the p dopant may comprise Mg. An exemplary triple junction cell may comprise InGaN//GaN//AlGaN wherein // may refer to an isolating transparent wafer bond layer or mechanical stacking. The PV may be run at high light intensity equivalent to that of concentrator photovoltaic (CPV). The substrate may be at least one of sapphire, Si, SiC, and GaN wherein the latter two provide the beast lattice matching for CPV applications. Layers may be deposited using metalorganic vapor phase epitaxy (MOVPE) methods known in the art. The cells may be cooled by cold plates such as those used in CPV or diode lasers such as commercial GaN diode lasers. The grid contact may be mounted on the front and back surfaces of the cell as in the case of CPV cells. In an embodiment, the PV converter may have a protective window that is substantially transparent to the light to which it is responsive. The window may be at least 10% transparent to the responsive light. The window may be transparent to UV light. The window may comprise a coating such as a UV transparent coating on the PV cells. The coating may comprise may comprise the material of UV windows of the disclosure such as a sapphire or MgF₂ window. Other suitable windows comprise LiF and CaF₂. The coating may be applied by deposition such as vapor deposition.

The cells of the PV converter 26a may comprise a photonic design that forces the emitter and cell single modes to cross resonantly couple and impedance-match just above the semiconductor bandgap, creating there a ‘squeezed’ narrowband near-field emission spectrum. Specifically, exemplary PV cells may comprise surface-plasmon-polariton thermal emitters and silver-backed semiconductor-thin-film photovoltaic cells.

The EM pump 5ka (FIGS. 2I28, 2I69, and 2I80-2I163) may comprise an EM pump heat exchanger 5k1, an electromagnetic pump coolant lines feed-through assembly 5kb, magnets 5k4, magnetic yolks and optionally thermal barrier 5k5 that may comprise a gas or vacuum gap having optional radiation shielding, pump tube 5k6, bus bars 5k2, and bus bar current source connections 5k3 having feed-through 5k31 that may be supplied by current from the PV converter. At least one of the magnets 5k4 and yoke 5k5 of the magnetic circuit may be cooled by EM pump heat exchanger 5k1 such as one that is cooled with a coolant such as water having coolant inlet lines 31d and coolant outlet lines 31e to a chiller 31a. Exemplary EM pump magnets 5k4 comprise at least one of cobalt samarium such as SmCo-30MGOe and neodymium-iron-boron (N44SH) magnets. The magnets may comprise a return magnetic flux circuit.

In an embodiment, at least one of very high power and energy may be achieved by the hydrogen undergoing transitions to hydrinos of high p values in Eq. (18) in a process herein referred to as disproportionation as given in Mills GUT Chp. 5 which is incorporated by reference. Hydrogen atoms H (1/p) p=1, 2,3, . . . 137 can undergo further transitions to lower-energy states given by Eqs. (10) and (12) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H (1/p′) given by Eq. (35) is represented by

H(1/p′)+H(1/p)→H+H(1/(p+m))+[2pm+m²−p′²+1]·13.6 eV (35)

The EUV light from the hydrino process may dissociate the dihydrino molecules and the resulting hydrino atoms may serve as catalysts to transition to lower energy states. An exemplary reaction comprises the catalysis H to H(1/17) by H(1/4) wherein H(1/4) may be a reaction product of the catalysis of another H by HOH. Disproportionation reactions of hydrinos are predicted to given rise to features in the X-ray region. As shown by Eqs. (5-8) the reaction product of HOH catalyst is

$$H [ \frac{{a}_{H}}{4} ] .$$

Consider a likely transition reaction in hydrogen clouds containing H₂O gas wherein the first hydrogen-type atom

$$H [ \frac{{a}_{H}}{p} ]$$

is an H atom and the second acceptor hydrogen-type atom

$$H [ \frac{{a}_{H}}{{p}^{′}} ]$$

serving as a catalyst is

$$H [ \frac{{a}_{H}}{4} ] .$$

Since the potential energy of

$$H [ \frac{{a}_{H}}{4} ]$$

is 4²·27.2 eV=16.27.2 eV=435.2 eV, the transition reaction is represented by

$$\begin{matrix}16 \cdot 27.2 eV + H [ \frac{{a}_{H}}{4} ] + H [ \frac{{a}_{H}}{1} ] \to {H}_{fast}^{+} + {e}^{-} + H * [ \frac{{a}_{H}}{17} ] + 16 \cdot 27.2 eV & ( 36 ) \\ H * [ \frac{{a}_{H}}{17} ] \to H [ \frac{{a}_{H}}{17} ] + 3481.6 eV & ( 37 ) \\ {H}_{fast}^{+} + {e}^{-} \to H [ \frac{{a}_{H}}{1} ] + 231.2 eV & ( 38 )\end{matrix}$$

And, the overall reaction is

$$H [ \frac{{a}_{H}}{4} ] + H [ \frac{{a}_{H}}{1} ] \to H [ \frac{{a}_{H}}{1} ] + H [ \frac{{a}_{H}}{17} ] + 3712.8 eV \qquad ( 39 )$$

The extreme-ultraviolet continuum radiation band due to the

$$H * [ \frac{{a}_{H}}{p + m} ]$$

intermediate (e.g. Eq. (16) and Eq. (37)) is predicted to have a short wavelength cutoff and energy

$${E}_{( H \to H [ \frac{{a}_{H}}{p + m} ] )}$$

given by

$${E}_{( H \to H [ \frac{{a}_{H}}{p + m} ] )} = [ {( p + m )}^{2} - {p}^{2} ] \cdot 13.6 eV - m \cdot 27.2 eV \\ {λ}_{( H \to H [ \frac{{a}_{H}}{p + m} ] )} = \frac{91.2}{[ {( p + m )}^{2} - {p}^{2} ] \cdot 13.6 eV - m \cdot 27.2 eV} nm \qquad ( 40 )$$

and extending to longer wavelengths than the corresponding cutoff. Here the extreme-ultraviolet continuum radiation band due to the decay of the

$$H * [ \frac{{a}_{H}}{17} ]$$

intermediate is predicted to have a short wavelength cutoff at E=3481.6 eV; 0.35625 nm and extending to longer wavelengths. A broad X-ray peak with a 3.48 keV cutoff was recently observed in the Perseus Cluster by NASA's Chandra X-ray Observatory and by the XMM-Newton [E. Bulbul, M. Markevitch, A. Foster, R. K. Smith, M. Loewenstein, S. W. Randall, “Detection of an unidentified emission line in the stacked X-Ray spectrum of galaxy clusters,” The Astrophysical Journal, Volume 789, Number 1, (2014); A. Boyarsky, O. Ruchayskiy, D. Iakubovskyi, J. Franse, “An unidentified line in X-ray spectra of the Andromeda galaxy and Perseus galaxy cluster,” (2014), arXiv:1402.4119 [astro-ph.CO]] that has no match to any known atomic transition. The 3.48 keV feature assigned to dark matter of unknown identity by BuiBul et al. matches the

$$H [ \frac{{a}_{H}}{4} ] + H [ \frac{{a}_{H}}{1} ] \to H [ \frac{{a}_{H}}{17} ]$$

transition and further confirms hydrinos as the identity of dark matter.

In an embodiment, the generator may produce high power and energy with a low pressure of H₂O. The water vapor pressure may be in at least one range of about 0.001 Torr to 100 Torr, 0.1 mTorr to 50 Torr, 1 mTorr and 5 Torr, 10 mTorr to 1 Ton, and 100 mTorr to 800 Torr. The low H₂O vapor pressure may be at least one of supplied and maintained by a source of water vapor and a means to control at least one of the flow rate and pressure. The water supply may be sufficient to maintain a desired ignition rate. The water vapor pressure may be controlled by at least one of steady state or dynamic control and equilibrium control. The generator may comprise a pump 13a that maintains a lower water vapor pressure in a desired region. The water may be removed by differential pumping such that the regions of the cell outside of the electrode region may have a lower pressure such as a lower partial pressure of water.

The cell water vapor pressure may be maintained by a water reservoir/trap in connection with the cell. The cell water vapor pressure may be in at least one of steady state or equilibrium with the water vapor pressure above the water surface of the water reservoir/trap. The water reservoir/trap may comprise a means to lower the vapor pressure such as at least one of a chiller to maintain a reduced temperature such as a cryo-temperature, a H₂O absorbing material such as activated charcoal or a desiccant, and a solute. The water vapor pressure may be a low pressure established in equilibrium or steady state with ice that may be super-cooled. The cooling may comprise a cryo-chiller or bath such as a carbon dioxide, liquid nitrogen, or liquid helium bath. A solute may be added to the water reservoir/trap to lower the water vapor pressure. The vapor pressure may be lowered according to Raoult's Law. The solute many be highly soluble and in high concentration. Exemplary solutes are sugar and an ionic compound such as at let one of alkali, alkaline earth, and ammonium halides, hydroxides, nitrates, sulphates, dichromates, carbonates, and acetates such as K₂SO₄, KNO₃, KCl, NH₄SO₄, NaCl, NaNO₂, Na₂Cr₂O₇, Mg(NO₃)₂, K₂CO₃, MgCl₂, KC₂H₃O₂, LiCl, and KOH. The trap desiccant may comprise a molecular sieve such as exemplary molecular sieve 13X, 4-8 mesh pellets.

In an embodiment to remove excess water, the trap can be sealed and heated; then the liquid water can be pumped off or it can be vented as steam. The trap can be re-cooled and rerun. In an embodiment, H₂ is added to the cell 26 such in a region such as at the electrodes to react with O₂ reaction product to convert it to water that is controlled with the water reservoir/trap. The H₂ may be provided by electrolysis at a hydrogen permeable cathode such as a PdAg cathode. The hydrogen pressure may be monitored with a sensor that provides feedback signals to a hydrogen supply controller such an electrolysis controller.

In an exemplary embodiment, the water partial pressure is maintained at a desired pressure such as one in the range of about 50 mTorr to 500 mTorr by a hydrated molecular sieve such as 13X. Any water released from the molecular sieve may be replaced with a water supply such as one from tank 311 supplied by a corresponding manifold and lines. The area of the molecular sieves may be sufficient to supply water at a rate of at least that required to maintain the desired partial pressure. The off gas rate of the molecular sieve may match the sum of the consumption rate of the hydrino process and the pump off rate. At least one of the rate of release and the partial pressure may be controlled by controlling the temperature of the molecular sieves. The cell may comprise a controller of the molecular sieves with a connection to the cell 26. The container may further comprise a means to maintain the temperature of the molecular sieve such as a heater and a chiller and a temperature controller.

In an alternative steady state embodiment, the water vapor pressure is maintained by a flow controller such as one that controls at least one of the mass flow and the water vapor pressure in the cell. The water supply rate may be adjusted to match that consumed in the hydrino and any other cell reactions and that removed by means such as pumping. The pump may comprise at least one of the water reservoir/trap, a cryopump, a vacuum pump, a mechanical vacuum pump, a scroll pump, and a turbo pump. At least one of the supply and removal rates may be adjusted to achieve the desired cell water vapor pressure. Additionally, a desired partial pressure of hydrogen may be added. At least one of the H₂O and H₂ pressures may be sensed and controlled by sensors and controllers such as pressure gauges such as Baratron gauges and mass flow controllers. The water may be injected through the EM pump tube 5k4 by a flow controller that may further comprise a pressure arrestor and a back-flow check valve to present the molten metal from flowing back into the water supplier such as the mass flow controller. The gas may be supplied by a syringe pump. As an alternative to a mass flow controller, the water vapor pressure may be maintained by a high precision electronically controllable valve such as at least one of a needle valve, proportional electronic valve, and stepper motor valve. The valve may be controlled by a water vapor pressure sensor and a computer to maintain the cell water vapor pressure at a desired value such as in the range of about 0.5 Torr to 2 Torr wherein the control may be to a small tolerance such as within 20%. The valve may have a fast response to maintain the tolerance with rapid changes in water vapor pressure in the cell. The dynamic range of the flow through the valve may be adjusted to accommodate different minimum and maximum ranges by changing the water vapor pressure on the supply side of the valve. The supply side pressure may be increased or decreased by increasing or decreasing the temperature, respectively, of a water reservoir 311. The water may be supplied through the EM pump tube 5k6.

In another embodiment, at least one of water such as steam and hydrogen may be simultaneously injected with the molten metal such as molten silver metal. The at least one of water, steam, and hydrogen injector may comprise a delivery tube that is terminated in a fast solenoid valve. The solenoid vale may be electrically connected in at least one of series and parallel to the electrodes such that current flows through the valve when current flows though the electrodes. In this case, the at least one of water such as steam and hydrogen may be simultaneously injected with the molten metal. In another embodiment, the injector system comprises an optical sensor and a controller to cause the injections. The controller may open and close a fast valve such as a solenoid valve when the metal injection or ignition is sensed. In an embodiment, lines for the injection of at least two of the melt such as silver melt, water such as steam, and hydrogen may be coincident. The coincidence may be through a common line. In an embodiment, the injector comprises an injection nozzle. The nozzle of the injector may comprise a gas manifold such as one aligned with the metal streams comprising the electrodes 8. The nozzle may further comprise a plurality of pinholes from the manifold that deliver a plurality of gas jets of at least one of H₂O and H₂. In an embodiment, H₂ in bubbled through a reservoir of H₂O at a pressure greater than that of the cell, and the H₂O is entrained in the H₂ carrier gas. The elevated pressure gas mixture flows through the pinholes into the melt to maintain the gas jets. At the electrodes, the gas, that may be a mixture, may be combined with the conductive matrix, the metal melt. With the application of a high current, the corresponding fuel mixture may ignite to form hydrinos.

In an embodiment to improve the energy balance of the generator, the chiller such as 31 may be driven by thermal power that may comprise heat produced by the cell. The heat power may be from internal dissipation and from the hydrino reaction. The chiller may comprise an absorption chiller known by those skilled in the art. In an embodiment, heat to be rejected is absorbed by a coolant or refrigerant such as water that may vaporize. The adsorption chiller may use heat to condense the refrigerant. In an embodiment, the water vapor is absorbed in an absorbing material (sorbent) such as Silicagel, Zeolith, or a nanostructure material such as that of P. McGrail of Pacific Northwest Laboratory. The absorbed water is heated to cause its release in a chamber wherein the pressure increases sufficiently to cause the water to condense.

The SF-CIHT generator comprises the components having the parameters such as those of the disclosure that are sensed and controlled. In embodiments the computer with sensors and control systems may sense and control, (i) the inlet and outlet temperatures and coolant pressure and flow rate of each chiller of each cooled system such as at least one of the PV converter, EM pump magnets, and the inductively coupled heater, (ii) the ignition system voltage, current, power, frequency, and duty cycle, (iii) the EM pump injection flow rate using a sensor such as an optical, Doppler, Lorentz, or electrode resistance sensor and controller, (iv) the voltages, currents, and powers of the inductively coupled heater and the electromagnetic pump 5k, (v) the pressure in the cell, (vi) the wall temperature of cell components, (vii) the heater power in each section, (viii) current and magnetic flux of the electromagnetic pump, (ix) the silver melt temperature, flow rate, and pressure, (xi) the pressure, temperature, and flow rate of each permeated or injected gas such as H₂ and H₂O and mixtures formed by a regulator that may be delivered through a common gas injection manifold, (xi) the intensity of incident light to the PV converter, (xii) the voltage, current, and power output of the PV converter, (xiii) the voltage, current, power, and other parameters of any power conditioning equipment, and (xiv) the SF-CIHT generator output voltage, current, and power to at least one of the parasitic loads and the external loads, (xv) the voltage, current, and power input to any parasitic load such as at least one of the inductively coupled heater, the electromagnetic pump, the chillers, and the sensors and controls, and (xvi) the voltage, current, and charge state of the starter circuit with energy storage. In an embodiment, a parameter to be measured may be separated from a region of the system that has an elevated temperature that would damage the sensor during its measurement. For example, the pressure of a gas such as at least one of H₂ and H₂O may be measured by using a connecting gas line such as a cooling tower that connects to the cell such as 5b or 5c and cools the gas before entering a pressure transducer such as a Baratron capacitance manometer. In the event that the parameter exceeds at desire range such as an excessive temperature is experienced, the generator may comprise a safety shut off mechanism such as one know in the art. The shut off mechanism may comprise a computer and a switch that provides power to at least one component of the generator that may be opened to cause the shut off.

In an embodiment, the cell may comprise at least one getter such as at least one for air, oxygen, hydrogen, CO₂, and water. An oxygen getter such an oxygen reactive material such as carbon or a metal that may be finely divided may scavenge any oxygen formed in the cell. In the case of carbon, the product carbon dioxide may be tapped with a CO₂ scrubber that may be reversible. Carbon dioxide scrubbers are known in the art such as organic compounds such as amines such as monoethanolamine, minerals and zeolites, sodium hydroxide, lithium hydroxide, and metal-oxide based systems. The finely divided carbon getter may also serve the purpose of scavenging oxygen to protect oxygen sensitive materials in the cell such as vessels or pump tube comprising oxygen sensitive materials such as Mo, W, graphite, and Ta. In this case, the carbon dioxide may be removed with a CO₂ scrubber or may be pumped off with the vacuum pump where fine-divided carbon is used solely for component protection.

A metal getter may selectively react with oxygen over H₂O such that it can be regenerated with hydrogen. Exemplary metals having low water reactivity comprise those of the group of Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, and Zn. The getter or oxygen scrubber may be removed from the SF-CIHT cell and regenerated. The removal may be periodic or intermittent. The regeneration may be achieved by hydrogen reduction. The regeneration may occur in situ. The in situ regeneration may be intermittent or continuous. Other oxygen getters and their regeneration such as zeolites and compounds that form reversible ligand bonds comprising oxygen such as salts of such as nitrate salts of the 2-aminoterephthalato-linked deoxy system, [{(bpbp)Co₂^{II}(NO₃)}₂(NH₂bde)] (NO₃)₂. 2H₂O (bpbp⁻−2,6-bis(N,N-bis(2-pyridylinethyl)aminomethyl)-4-tert-butylphenolato, NH₂bdc²=2-amino-1,4-benzenedicarboxylato) are known to those skilled in the art. Highly combustible metals may also be used as the oxygen getter such as exemplary metals: alkali, alkaline earth, aluminum, and rare earth metals. The highly combustible metals may also be used as a water scavenger. Hydrogen storage materials may be used to scavenge hydrogen. Exemplary hydrogen storage materials comprise a metal hydride, a mischmetal such as M1: La-rich mischmetal such as M1Ni_{3.65}Al_{0.3}Mn_{0.3} or M1(NiCoMnCu)₅, Ni, R—Ni, R—Ni+about 8 wt % Vulcan XC-72, LaNi₅, Cu, or Ni—Al, Ni—Cr such as about 10% Cr, Ce—Ni—Cr such as about 3/90/7 wt %, Cu—Al, or Cu—Ni—Al alloy, a species of a M-N—H system such as LiNH₂, Li₂NH, or Li₃N, and a alkali metal hydride further comprising boron such as borohydrides or aluminum such as aluminohydides. Further suitable hydrogen storage materials are metal hydrides such as alkaline earth metal hydrides such as MgH₂, metal alloy hydrides such as BaReH₉, LaNi₅H₆, FeTiH_{1.7}, and MgNiH₄, metal borohydrides such as Be(BH₄)₂, Mg(BH₄)₂, Ca(BH₄)₂, Zn(BH₄)₂, Sc(BH₄)₃, Ti(BH₄)₃, Mn(BH₄)₂, Zr(BH₄)₄, NaBH₄, LiBH₄, KBH₄, and Al(BH₄)₃, AlH₃, NaAlH₄, Na₃AlH₆, LiAlH₄, Li₃AlH₆, LiH, LaNi₅H₆, La₂Co₁Ni₉H₆, and TiFeH₂, NH₃BH₃, polyaminoborane, amine borane complexes such as amine borane, boron hydride ammoniates, hydrazine-borane complexes, diborane diammoniate, borazine, and ammonium octahydrotriborates or tetrahydroborates, imidazolium ionic liquids such as alkyl(aryl)-3-methylimidazolium N-bis(trifluoromethanesulfonyl)imidate salts, phosphonium borate, and carbonite substances. Further exemplary compounds are ammonia borane, alkali ammonia borane such as lithium ammonia borane, and borane alkyl amine complex such as borane dimethylamine complex, borane trimethylamine complex, and amino boranes and borane amines such as aminodiborane, n-dimethylaminodiborane, tris(dimethylamino)borane, di-n-butylboronamine, dimethylaminoborane, trimethylaminoborane, ammonia-trimethylborane, and triethylaminoborane. Further suitable hydrogen storage materials are organic liquids with absorbed hydrogen such as carbazole and derivatives such as 9-(2-ethylhexyl)carbazole, 9-ethylcarbazole, 9-phenylcarbazole, 9-methylcarbazole, and 4,4′-bis(N-carbazolyl)-1,1′-biphenyl. The getter may comprise an alloy capable of storing hydrogen, such as one of the AB₅ (LaCePrNdNiCoMnAl) or AB₂ (VTiZrNiCrCoMnAlSn) type, where the “ABₓ” designation refers to the ratio of the A type elements (LaCePrNd or TiZr) to that of the B type elements (VNiCrCoMnAlSn). Additional suitable hydrogen getters are those used in metal hydride batteries such as nickel-metal hydride batteries that are known to those skilled in the Art. Exemplary suitable getter material of hydride anodes comprise the hydrides of the group of R—Ni, LaNi₅H₆, La₂Co₁Ni₉H₆, ZrCr₂H_{3.8}, LaNi_{3.55}Mn_{0.4}Al_{0.3}Co_{0.75}, ZrMn_{0.5}Cr_{0.2}V_{0.1}Ni_{1.2}, and other alloys capable of storing hydrogen, such as one of the AB₅ (LaCePrNdNiCoMnAl) or AB₂ (VTiZrNiCrCoMnAlSn) type, where the “ABₓ” designation refers to the ratio of the A type elements (LaCePrNd or TiZr) to that of the B type elements (VNiCrCoMnAlSn). In other embodiments, the hydride anode getter material comprises at least one of MmNi₅ (Mm=misch metal) such as MmNi_{3.5}Co_{0.7}Al_{0.8}, the AB₅-type: MmNi_{3.2}Co_{1.0}Mn_{0.6}Al_{0.11}Mo_{0.09} (Mm=misch metal: 25 wt % La, 50 wt % Ce, 7 wt % Pr, 18 wt % Nd), La_{1-y}R_{y}Ni₅₋ₓMₓ, AB₂-type: Ti_{0.51}Zr_{0.49}V_{0.70}Ni_{1.18}Cr_{0.12} alloys, magnesium-based alloys such as Mg_{1.9}Al_{0.1}Ni_{0.8}Co_{0.1}Mn_{0.1} alloy, Mg_{0.72}Sc_{0.28}(Pd_{0.1.012}+Rh_{0.012}), and Mg₈₀Ti₂₀, Mg₈₀V₂₀, La_{0.8}Nd_{0.1}Ni_{2.4}CO_{2.5}Si_{0.1}, LaNi₅₋ₓMₓ (M=Mn, Al), (M=Al, Si, Cu), (M=Sn), (M=Al, Mn, Cu) and LaNi₄Co, MmNi_{3.55}Mn_{0.44}Al_{0.3}Co_{0.75}, LaNi_{3.55}Mn_{0.44}Al_{0.3}Co_{0.75}, MgCu₂, MgZn₂, MgNi₂, AB compounds such as TiFe, TiCo, and TiNi, ABₙ compounds (n=5, 2, or 1), AB₃₋₄ compounds, and ABₓ (A=La, Ce, Mn, Mg; B=Ni, Mn, Co, Al). Other suitable hydride getters are ZrFe₂, Zr_{0.5}Cs_{0.5}Fe₂, Zr_{0.8}Sc_{0.2}Fe₂, YNi₅, LaNi₅, LaNi_{4.5}Co_{0.5}, (Ce, La, Nd, Pr)Ni₅, Mischmetal-nickel alloy, Ti_{0.98}Zr_{0.02}V_{0.43}Fe_{0.09}Cr_{0.05}Mn_{1.5}, La₂Co₁Ni₉, FeNi, and TiMn₂. Getters of the disclosure and others known to those skilled in the art may comprise a getter of more than one species of cell gas. Additional getters may be those known by ones skilled in the art. An exemplary multi-gas getter comprises an alkali or alkaline earth metal such as lithium that may getter at least two of O₂, H₂O, and H₂. The getter may be regenerated by methods known in the art such as by reduction, decomposition, and electrolysis. In an embodiment, the getter may comprise a cryotrap that at least one of condenses the gas such as at least one of water vapor, oxygen, and hydrogen and traps the gas in an absorbing material in a cooled state. The gas may be released form the absorbing material at a higher temperature such that with heating and pumping the off-gas, the getter may be regenerated. Exemplary materials that absorb at least one of water vapor, oxygen, and hydrogen that can be regenerated by heating and pumping is carbon such as activated charcoal and zeolites. The timing of the oxygen, hydrogen, and water scrubber regeneration may be determined when the corresponding gas level increases to a non-tolerable level as sensed by a sensor of the corresponding cell gas content. In an embodiment, at least one of the cell generated hydrogen and oxygen may be collected and sold as a commercial gas by systems and methods known by those skilled in the art. Alternatively, the collected hydrogen gas may be used in the SunCell®.

The hydrogen and water that is incorporated into the melt may flow from the tanks 5u and 311 through manifolds and feed lines under pressure produced by corresponding pumps such as mechanical pumps. Alternatively, the water pump may be replaced by creating steam pressure by heating the water tank 311, and the hydrogen pump may be replaced by generating the pressure to flow hydrogen by electrolysis. Alternatively, H₂O is provided as steam by H₂O tank 311, a steam generator, and a steam line. Hydrogen may permeate through a hollow cathode connected with the hydrogen tank that is pressurized by the electrolysis or thermolysis. These replacement systems may eliminate the corresponding systems having moving parts.

In an embodiment, the SF-CIHT cell components and system are at least one of combined, miniaturized, and otherwise optimized to at least one of reduce weight and size, reduce cost, and reduce maintenance. In an embodiment, the SF-CIHT cell comprises a common compressor for the chiller and the cell vacuum pump. The chiller for heat rejection may also serve as a cryopump to serve as a vacuum pump. H₂O and O₂ may be condensed by the cryopump. In an embodiment, the ignition system comprising a bank of capacitors is miniaturized by using a reduced number of capacitors such as an exemplary single 2.75 V, 3400 F Maxwell super-capacitor as near to the electrodes as possible. In an embodiment, at least one capacitor may have its positive terminal directly connected to the positive bus bar or positive electrode and at least one capacitor may have its negative terminal directly connected to the negative bus bar or negative electrode wherein the other terminals of the capacitors of opposite polarity may be connected by a bus bar such that current flows through the circuit comprising the capacitors when molten metal closes the circuit by bridging the electrodes that may comprise molten metal injectors. The set of capacitors connected across the electrodes in series may be replicated by an integer multiple to provide about the integer multiple times more current, if desirable. In an embodiment, the voltage on the capacitors may be maintained within a desired range by charging with power from the PV converter.

The power conditioning of the SF-CIHT generator may be simplified by using all DC power for intrinsic loads wherein the DC power is supplied by the PV converter. In an embodiment, DC power from the PV converter may supply at least one of the (i) the DC charging power of the capacitors of the ignition system comprising the source of electrical power 2 to the electrodes 8, (ii) the DC current of the at least one electromagnetic pump, (iii) the DC power of the resistive or inductively coupled heaters, (iv) the DC power of the chiller comprising a DC electric motor, (v) the DC power of the vacuum pump comprising a DC electric motor, and (vi) the DC power to the computer and sensors. The output power conditioning may comprise DC power from the PV converter or AC power from the conversion of DC power from the PV converter to AC using an inverter.

In an embodiment, the light to electricity converter comprises the photovoltaic converter of the disclosure comprising photovoltaic (PV) cells that are responsive to a substantial wavelength region of the light emitted from the cell such as that corresponding to at least 10% of the optical power output. In an embodiment, the PV cells are concentrator cells that can accept high intensity light, greater than that of sunlight such as in the intensity range of at least one of about 1.5 suns to 75,000 suns, 10 suns to 10,000 suns, and 100 suns to 2000 suns. The concentrator PV cells may comprise c-Si that may be operated in the range of about 1 to 1000 suns. The silicon PV cells may be operated at a temperature that performs at least one function of improving the bandgap to better match the blackbody spectrum and improving the heat rejection and thereby reducing the complexity of the cooling system. In an exemplary embodiment, concentrator silicon PV cells are operated at 200 to 500 Suns at about 130° C. to provide a bandgap of about 0.84 V to match the spectrum of a 3000° C. blackbody radiator. The PV cells may comprise a plurality of junctions such as triple junctions. The concentrator PV cells may comprise a plurality of layers such as those of Group III/V semiconductors such as at least one of the group of InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge. The plurality of junctions such as triple or double junctions may be connected in series. In another embodiment, the junctions may be connected in parallel. The junctions may be mechanically stacked. The junctions may be wafer bonded. In an embodiment, tunnel diodes between junctions may be replaced by wafer bonds. The wafer bond may be electrically isolating and transparent for the wavelength region that is converted by subsequent or deeper junctions. Each junction may be connected to an independent electrical connection or bus bar. The independent bus bars may be connected in series or parallel. The electrical contact for each electrically independent junction may comprise grid wires. The wire shadow area may be minimized due to the distribution of current over multiple parallel circuits or interconnects for the independent junctions or groups of junctions. The current may be removed laterally. The wafer bond layer may comprise a transparent conductive layer. An exemplary transparent conductor is a transparent conductive oxide (TCO) such as indium tin oxide (ITO), fluorine doped tin oxide (FTO), and doped zinc oxide and conductive polymers, graphene, and carbon nanotubes and others known to those skilled in the art. Benzocyclobutene (BCB) may comprise an intermediate bonding layer. The bonding may be between a transparent material such a glass such as borosilicate glass and a PV semiconductor material. An exemplary two-junction cell is one comprising a top layer of GaInP wafer bonded to a bottom layer of GaAs (GaInP//GaAs). An exemplary four-junction cell comprises GaInP/GaAs/GaInAsP/GaInAs on InP substrate wherein each junction may be individually separated by a tunnel diode (/) or an isolating transparent wafer bond layer (//) such as a cell given by GaInP//GaAs//GaInAsP//GalnAs on InP. The PV cell may comprise InGaP//GaAs//InGaAsNSb//Conductive Layer//Conductive Layer//GaSb//InGaAsSb. The substrate may be GaAs or Ge. The PV cell may comprise Si—Ge—Sn and alloys. All combinations of diode and wafer bonds are within the scope of the disclosure. An exemplary four-junction cell having 44.7% conversion efficacy at 297-times concentration of the AM1.5d spectrum is made by SOITEC, France. The PV cell may comprise a single junction. An exemplary single junction PV cell may comprise a monocrystalline silicon cell such as one of those given in Sater et al. (B. L. Sater, N. D. Sater, “High voltage silicon VMJ solar cells for up to 1000 suns intensities”, Photovoltaic Specialists Conference, 2002. Conference Record of the Twenty-Ninth IEEE, 19-24 May 2002, pp. 1019 - 1022.) which is herein incorporated by reference in its entirety. Alternatively, the single junction cell may comprise GaAs or GaAs doped with other elements such as those from Groups III and V. In an exemplary embodiment, the PV cells comprise triple junction concentrator PV cells or GaAs PV cells operated at about 1000 suns. In another exemplary embodiment, the PV cells comprise c-Si operated at 250 suns. In an exemplary embodiment, the PV may comprise GaAs that may be selectively responsive for wavelengths less than 900 nm and InGaAs on at least one of InP, GaAs, and Ge that may be selectively responsive to wavelengths in the region between 900 nm and 1800 nm. The two types of PV cells comprising GaAs and InGaAs on InP may be used in combination to increase the efficiency. Two such single junction types cells may be used to have the effect of a double junction cell. The combination may implemented by using at least one of dichroic mirrors, dichroic filters, and an architecture of the cells alone or in combination with mirrors to achieve multiple bounces or reflections of the light as given in the disclosure. In an embodiment, each PV cell comprises a polychromat layer that separates and sorts incoming light, redirecting it to strike particular layers in a multi junction cell. In an exemplary embodiment, the cell comprises an indium gallium phosphide layer for visible light and gallium arsenide layer for infrared light where the corresponding light is directed. The PV cell may comprise a GaAs_{1-x-y}NₓBi_{y} alloy.

The PV cells may comprise silicon. The silicon PV cells may comprise concentrator cells that may operate in the intensity range of about 5 to 2000 Suns. The silicon PV cells may comprise crystalline silicon and at least one surface may further comprise amorphous silicon that may have a different bandgap than the crystalline Si layer. The amorphous silicon may have a wider bandgap than the crystalline silicon. The amorphous silicon layer may perform at least one function of causing the cells to be electro-transparent and preventing electron-hole pair recombination at the surfaces. The silicon cell may comprise a multijunction cell. The layers may comprise individual cells. At least one cell such as a top cell such as one comprising at least one of Ga, As, InP, Al, and In may be ion sliced and mechanically stacked on the Si cell such as a Si bottom cell. At least one of layers of multi-junction cells and cells connected in series may comprise bypass diodes to minimize current and power loss due to current mismatches between layers of cells. The cell surface may be textured to facilitate light penetration into the cell. The cell may comprise an antireflection coating to enhance light penetration into the cell. The antireflection coating may further reflect wavelengths below the bandgap energy. The coating may comprise a plurality of layers such as about two to 20 layers. The increased number of layer may enhance the selectivity to band pass a desired wavelength range such as light above the bandgap energy and reflect another range such as wavelengths below the bandgap energy. Light reflected from the cell surface may be bounced to at least one other cell that may absorb the light. The PV converter 26a may comprise a closed structure such as a geodesic dome to provide for multiple bounces of reflected light to increase the cross section for PV absorption and conversion. The geodesic dome may comprise a plurality of receiver units such as triangular units covered with PV cells. The dome may serve as an integrating sphere. The unconverted light may be recycled. Light recycling may occur through reflections between member receiver units such as those of a geodesic dome. The surface may comprise a filter that may reflect wavelengths below the bandgap energy of the cell. The cell may comprise a bottom mirror such as a silver or gold bottom layer to reflector un-absorbed light back through the cell. Further unabsorbed light and light reflected by the cell surface filter may be absorbed by the blackbody radiator and re-emitted to the PV cell. In an embodiment, the PV substrate may comprise a material that is transparent to the light transmitted from the bottom cell to a reflector on the back of the substrate. An exemplary triple junction cell with a transparent substrate is InGaAsP (1.3 eV), InGaAsP (0.96 eV), InGaAs (0.73 eV), InP substrate, and copper or gold IR reflector. In an embodiment, the PV cell may comprise a concentrator silicon cell. The multijunction III-V cell may be selected for higher voltage, or the Si cell may be selected for lower cost. The bus bar shadowing may be reduced by using transparent conductors such as transparent conducting oxides (TCOs).

The PV cell may comprise perovskite cells. An exemplary perovskite cell comprises the layers from the top to bottom of Au, Ni, Al, Ti, GaN, CH₃NH₃SnI₃, monolayer h-BN, CH₃NH₃PbT₃₋ₓBrₓ, HTM/GA, bottom contact (Au).

The cell may comprise a multi p-n junction cell such as a cell comprising an AlN top layer and GaN bottom layer to converter EUV and UV, respectively. In an embodiment, the photovoltaic cell may comprise a GaN p-layer cell with heavy p-doping near the surface to avoid excessive attenuation of short wavelength light such as UV and EUV. The n-type bottom layer may comprise AlGaN or AlN. In an embodiment, the PV cell comprises GaN and AlₓGa₁₋ₓN that is heavily p-doped in the top layer of the p-n junction wherein the p-doped layer comprises a two-dimensional-hole gas. In an embodiment, the PV cell may comprise at least one of GaN, AlGaN, and AlN with a semiconductor junction. In an embodiment, the PV cell may comprise n-type AlGaN or AlN with a metal junction. In an embodiment, the PV cell responds to high-energy light above the band gap of the PV material with multiple electron-hole pairs. The light intensity may be sufficient to saturate recombination mechanisms to improve the efficiency.

The converter may comprise a plurality of at least one of (i) GaN, (ii) AlGaN or AlN p-n junction, and (iii) shallow ultra-thin p-n heterojunction photovoltaics cells each comprising a p-type two-dimensional hole gas in GaN on an n-type AlGaN or AlN base region. Each may comprise a lead to a metal film layer such as an Al thin film layer, an n-type layer, a depletion layer, a p-type layer and a lead to a metal film layer such as an Al thin film layer with no passivation layer due to the short wavelength light and vacuum operation. In an embodiment of the photovoltaic cell comprising an AlGaN or AlN n-type layer, a metal of the appropriate work function may replace the p-layer to comprise a Schottky rectification barrier to comprise a Schottky barrier metal/semiconductor photovoltaic cell.

In another embodiment, the converter may comprise at least one of photovoltaic (PV) cells, photoelectric (PE) cells, and a hybrid of PV cells and PE cells. The PE cell may comprise a solid-state cell such as a GaN PE cell. The PE cells may each comprise a photocathode, a gap layer, and an anode. An exemplary PE cell comprises GaN (cathode) cessiated/AlN (separator or gap)/Al, Yb, or Eu (anode) that may be cessiated. The PV cells may each comprise at least one of the GaN, AlGaN, and AlN PV cells of the disclosure. The PE cell may be the top layer and the PV cell may be the bottom layer of the hybrid. The PE cell may convert the shortest wavelength light. In an embodiment, at least one of the cathode and anode layer of the PE cell and the p-layer and the n-layer of a PV cell may be turned upside down. The architecture may be changed to improve current collection. In an embodiment, the light emission from the ignition of the fuel is polarized and the converter is optimized to use light polarization selective materials to optimize the penetration of the light into the active layers of the cell. The light may be polarized by application of a field such as an electric field or a magnetic field by corresponding electrodes or magnets.

In an embodiment, the fuel may comprise silver, copper, or Ag-Cu alloy melt that may further comprise at least one of trapped hydrogen and trapped H₂O. The light emission may comprise predominantly ultraviolet light and extreme ultraviolet such as light in the wavelength region of about 10 nm to 300 nm. The PV cell may be response to at least a portion of the wavelength region of about 10 nm to 300 nm. The PV cells may comprise concentrator UV cells. The cells may be responsive to blackbody radiation. The blackbody radiation may be that corresponding to at least one temperature range of about 1000K to 6000K. The incident light intensity may be in at least one range of about 2 to 100,000 suns and 10 to 10,000 suns. The cell may be operated in a temperature range known in the art such as at least one temperature range of about less than 300° C. and less than 150° C. The PV cell may comprise a group III nitride such as at least one of InGaN, GaN, and AlGaN. In an embodiment, the PV cell may comprise a plurality of junctions. The junctions may be layered in series. In another embodiment, the junctions are independent or electrically parallel. The independent junctions may be mechanically stacked or wafer bonded. An exemplary multi junction PV cell comprises at least two junctions comprising n-p doped semiconductor such as a plurality from the group of InGaN, GaN, and AlGaN. The n dopant of GaN may comprise oxygen, and the p dopant may comprise Mg. An exemplary triple junction cell may comprise InGaN//GaN//AlGaN wherein // may refer to an isolating transparent wafer bond layer or mechanical stacking. The PV may be run at high light intensity equivalent to that of concentrator photovoltaic (CPV). The substrate may be at least one of sapphire, Si, SiC, and GaN wherein the latter two provide the best lattice matching for CPV applications. Layers may be deposited using metalorganic vapor phase epitaxy (MOVPE) methods known in the art. The cells may be cooled by cold plates such as those used in CPV or diode lasers such as commercial GaN diode lasers. The grid contacts may be mounted on the front and back surfaces of the cells as in the case of CPV cells. In an embodiment, the surface of the PV cell such as one comprising at least one of GaN, AlN, and GaAlN may be terminated. The termination layer may comprise at least one of H and F. The termination may decrease the carrier recombination effects of defects. The surface may be terminated with a window such as AlN.

In an embodiment, at least one of the photovoltaic (PV) and photoelectric (PE) converter may have a protective window that is substantially transparent to the light to which it is responsive. The window may be at least 10% transparent to the responsive light. The window may be transparent to UV light. The window may comprise a coating such as a UV transparent coating on the PV or PE cells. The coating may be applied by deposition such as vapor deposition. The coating may comprise the material of UV windows of the disclosure such as a sapphire or MgF₂ window. Other suitable windows comprise LiF and CaF₂. Any window such as a MgF₂ window may be made thin to limit the EUV attenuation. In an embodiment, the PV or PE material such as one that is hard, glass-like such as GaN serves as a cleanable surface. The PV material such as GaN may serve as the window. In an embodiment, the surface electrodes of the PV or PE cells may comprise the window. The electrodes and window may comprise aluminum. The window may comprise at least one of aluminum, carbon, graphite, zirconia, graphene, MgF₂, an alkaline earth fluoride, an alkaline earth halide, Al₂O₃, and sapphire. The window may be very thin such as about 1 A to 100 A thick such that it is transparent to the UV and EUV emission from the cell. Exemplary thin transparent thin films are Al, Yb, and Eu thin films. The film may be applied by MOCVD, vapor deposition, sputtering and other methods known in the art.

In an embodiment, the cell may covert the incident light to electricity by at least one mechanism such as at least one mechanism from the group of the photovoltaic effect, the photoelectric effect, the thermionic effect, and the thermoelectric effect. The converter may comprise bilayer cells each having a photoelectric layer on top of a photovoltaic layer. The higher energy light such as extreme ultraviolet light may be selectively absorbed and converted by the top layer. A layer of a plurality of layers may comprise a UV window such as the MgF₂ window. The UV window may protect ultraviolet UV) PV from damage by ionizing radiation such as damage by soft X-ray radiation. In an embodiment, low-pressure cell gas may be added to selectively attenuate radiation that would damage the UV PV. Alternatively, this radiation may be at least partially converted to electricity and at least partially blocked from the UV PV by the photoelectronic converter top layer. In another embodiment, the UV PV material such as GaN may also convert at least a portion of the extreme ultraviolet emission from the cell into electricity using at least one of the photovoltaic effect and the photoelectric effect.

The photovoltaic converter may comprise PV cells that convert ultraviolet light into electricity. Exemplary ultraviolet PV cells comprise at least one of p-type semiconducting polymer PEDOT-PSS: poly(3,4-ethylenedioxythiophene) doped by poly(4-styrenesuifonate) film deposited on a Nb-doped titanium oxide (SrTiO3:Nb) (PEDOT-PSS/SrTiO3:Nb heterostructure), GaN, GaN doped with a transition metal such as manganese, SiC, diamond, Si, and TiO₂. Other exemplary PV photovoltaic cells comprise n-ZnO/p-GaN heterojunction cells.

To convert the high intensity light into electricity, the generator may comprise an optical distribution system and photovoltaic converter 26a such as that shown in FIG. 2I132. The optical distribution system may comprise a plurality of semitransparent mirrors arranged in a louvered stack along the axis of propagation of light emitted from the cell wherein at each mirror member 23 of the stack, light is at least partially reflected onto a PC cell 15 such as one aligned parallel with the direction of light propagation to receive transversely reflected light. The light to electricity panels 15 may comprise at least one of PE, PV, and thermionic cells. The window to the converter may be transparent to the cell emitted light such as short wavelength light or blackbody radiation such as that corresponding to a temperature of about 2800K to 4000K wherein the power converter may comprise a thermophotovoltaic (TPV) power converter. The window to the PV converter may comprise at least one of sapphire, LiF, MgF₂, and CaF₂, other alkaline earth halides such as fluorides such as BaF₂, CdF₂, quartz, fused quartz, UV glass, borosilicate, and Infrasil (ThorLabs). The semitransparent mirrors 23 may be transparent to short wavelength light. The material may be the same as that of the PV converter window with a partial coverage of reflective material such as mirror such as UV mirror. The semitransparent mirror 23 may comprise a checkered pattern of reflective material such as UV mirror such as at least one of MgF₂-coated Al and thin fluoride films such as MgF₂ or LiF films or SiC films on aluminum.

In an embodiment, the TPV conversion efficiency may be increased by using a selective emitter, such as ytterbium on the surface of the blackbody emitter 5b4. Ytterbium is an exemplary member of a class of rare earth metals, which instead of emitting a normal blackbody spectrum emit spectra that resemble line radiation spectra. This allows the relatively narrow emitted energy spectrum to match very closely to the bandgap of the TPV cell.

In an embodiment, the generator further comprises a switch such as an IGBT or another switch of the disclosure or known in the art to turn off the ignition current in the event that the hydrino reaction self propagates by thermolysis. The reaction may self sustain at least one of an elevated cell and plasma temperature such as one that supports thermolysis at a sufficient rate to maintain the temperature and the hydrino reaction rate. The plasma may comprise optically thick plasma. The plasma may comprise a blackbody. The optically thick plasma may be achieved by maintaining a high gas pressure. In an exemplary embodiment, thermolysis occurred with injection of each of molten silver and molten silver-copper (28 wt %) alloy at tungsten electrodes with a continuous ignition current in the range of 100 A to 1000 A with superimposed pulses in the range of about 2 kA to 10 kA, a plasma blackbody temperature of 5000 K and an electrode temperature in the range of about 3000K to 3700K. The thermolysis may occur at high temperature of at least one of the plasma and cell component in contact with the plasma such as the walls of the reaction cell chamber 5b31. The temperature may be in at least one range of about 500K to 10,000K, 1000K to 7000K, and 1000K to 5000K. In another embodiment, at least one of the cell components such as the reservoir 5c may serve as a cooling agent to cool the thermolysis H to present it from reverting back to H₂O.

The maintained blackbody temperature may be one that emits radiation that may be converted into electricity with a photovoltaic cell. In an exemplary embodiment, the blackbody temperature may be maintained in at least one range of about 1000 K to 4000 K. The photovoltaic cell may comprise a thermophotovoltaic (TPV) cell. Exemplary photovoltaic cells for thermophotovoltaic conversion comprise crystalline silicon, germanium, gallium arsenide (GaAs), gallium antimonide (GaSb), indium gallium arsenide (InGaAs), indium gallium arsenide antimonide (InGaAsSb), and indium phosphide arsenide antimonide (InPAsSb) cells. Other exemplary cells are InGaAsP (1.3 eV)/InGaAsP (0.96 eV)/InGaAs (0.73 eV)/InP substrate/copper or gold IR reflector and InAlGaAs (1.3 eV)/InGaAs (0.96 eV)/graded buffer layer/Ge subcell/copper or gold IR reflector. The PV cell may comprise a multijunction GaAs cell stack on top of a multijunction GaSb cell such as a 3J GaAs cell on a 2J GaSb cell. The converter may comprise mirrors to at least one of direct and redirect radiation onto the thermophotovoltaic converter. In an embodiment, back mirrors reflect unconverted radiation back to the source to contribute to the power that is re-radiated to the converter. Exemplary mirrors comprise at least one of the cone material such as aluminum and anodized aluminum, MgF₂-coated Al and thin fluoride films such as MgF₂ or LiF films or SiC films on aluminum and sapphire, alumina such as alpha alumina that may be sputter coated on a substrate such as stainless steel, MgF₂ coated sapphire, boro-silica glass, alkali-aluminosilicate glass such as Gorilla Glass, LiF, MgF₂, and CaF₂, other alkaline earth halides such as fluorides such as BaF₂, CdF₂, quartz, fused quartz, UV glass, borosilicate, Infrasil (ThorLabs), and ceramic glass that may be mirrored on the outer surface when transparent. The mirror such as the anodized aluminum mirror may diffuse the light to uniformly irradiate the PV converter. Transparent materials such as at least one of sapphire, alumina, boro-silica glass, LiF, MgF₂, and CaF₂, other alkaline earth halides such as fluorides such as BaF₂, CdF₂, quartz, fused quartz, UV glass, borosilicate, Infrasil (ThorLabs), and ceramic glass may serve as the window for the TPV converter. Another embodiment of the TPV converter comprises blackbody emitter filters to pass wavelengths matched to the bandgap of the PV and reflect mismatched wavelengths back to the emitter wherein the emitter may comprise a hot cell component such as the electrodes. The blackbody radiator 5b4 may be coated with selective emitter such as a rare earth metal such as ytterbium that emits a spectrum that is more favorable for thermophotovoltaic conversion such as a spectrum that resembles a line radiation spectrum.

The band gaps of the cells are selected to optimize the electrical output efficiency for a given blackbody operating temperature and corresponding spectrum. In an exemplary embodiment operated at about 3000K or 3500K the band gaps of the TPV cell junctions are Given in TABLE 1.

TABLE 1
Optimal band gap combinations for cell having n = 1, 2.3, or 4 junctions (J).

| | 1J | 2J | 3J | 4J |
|---|---|---|---|---|
| 3000K | 0.75 eV | 0.62 eV, 0.96 eV | 0.61 eV, 0.82 eV, 1.13 eV | 0.61 eV, 0.76 eV, 0.95 eV, 1.24 eV |
| 3500K | 0.86 eV | 0.62 eV, 1.04 eV | 0.62 eV, 0.87 eV, 1.24 eV | 0.62 eV, 0.8 eV, 1.03 eV, 1.37 eV |

To optimize the performance of a thermophotovoltaic converter comprising a multi-junction cells, the blackbody temperature of the light emitted from the cell may bemaintained about constant such as within 10%. Then, the power output may be controlled with power conditioning equipment with excess power stored in a device such as a battery or capacitor or rejected such as rejected as heat. In another embodiment, the power from the plasma may be maintained by reducing the reaction rate by means of the disclosure such as by changing the firing frequency and current, the metal injection rate, and the rate of injection of at least one of H₂O and H₂ wherein the blackbody temperature may be maintained by controlling the emissivity of the plasma. The emissivity of the plasma may be changed by changing the cell atmosphere such as one initially comprising metal vapor by the addition of a cell gas such as a noble gas.

In an embodiment, the cell gases such as the pressure of water vapor, hydrogen, and oxygen, and the total pressure are sensed with corresponding sensors or gauges. In an embodiment, at least one gas pressure such as at least one of the water and hydrogen pressure are sensed by monitoring at least one parameter of the cell that changes in response to changes in the pressure of at least one of these cell gases. At least one of a desirable water and hydrogen pressure may be achieved by changing one or more pressures while monitoring the effect of changes with the supply of the gases. Exemplary monitored parameters that are changed by the gases comprise the electrical behavior of the ignition circuit and the light output of the cell. At least one of the ignition-current and light-output may be maximized at a desired pressure of at least one of the hydrogen and water vapor pressure. At least one of a light detector such as a diode and the output of the PV converter may measure the light output of the cell. At least one of a voltage and current meter may monitor the electrical behavior of the ignition circuit. The generator may comprise a pressure control system such as one comprising software, a processor such as a computer, and a controller that receives input data from the monitoring of the parameter and adjusts the gas pressure to achieve the optimization of the desired power output of the generator. In an embodiment comprising a fuel metal comprising copper, the hydrogen may be maintained at a pressure to achieve reduction of the copper oxide from the reaction of the copper with oxygen from the reaction of H₂O to hydrino and oxygen wherein the water vapor pressure is adjusted to optimize the generator output by monitoring the parameter. In an embodiment, the hydrogen pressure may be controlled at about a constant pressure by supplying H₂ by electrolysis. The electrolysis current may be maintained at about a constant current. The hydrogen may be supplied at a rate to react with about all hydrino reaction oxygen product. Excess hydrogen may diffuse through the cell walls to maintain a constant pressure over that consumed by the hydrino reaction and reaction with oxygen product. The hydrogen may permeate through a hollow cathode to the reaction cell chamber 5b31. In an embodiment, the pressure control system controls the H₂ and H₂O pressure in response to the ignition current and frequency and the light output to optimize at least one. The light may be monitored with a diode, power meter, or spectrometer. The ignition current may be monitored with a multi-meter or digital oscilloscope. The injector rate of the molten metal of the electromagnetic pump 5kmay also be controlled to optimize at least one the electrical behavior of the ignition circuit and the light output of the cell.

In another embodiment, the sensor may measure multiple components. In an exemplary embodiment, the cell gases and the total pressure are measured with a mass spectrometer such as a quadrupole mass spectrometer such as a residual gas analyzer. The mass spectrometer may sense in batch or in trend mode. The water or humidity sensor may comprise at least one of an absolute, a capacitive, and a resistive humidity sensor. The sensor capable of analyzing a plurality of gases comprises a plasma source such as a microwave chamber and generator wherein the plasma excited cell gases emit light such as visible and infrared light. The gases and concentrations are determined by the spectral emission such as the characteristic lines and intensities of the gaseous components. The gases may be cooled before sampling. The metal vapor may be removed from the cell gas before the cell gas is analyzed for gas composition. The metal vapor in the cell such as one comprising at least one of silver and copper may be cooled to condense the metal vapor such that the cell gases may flow into the sensor in the absence of the metal vapor. The SF-CIHT cell also herein also referred to as the SF-CIHT generator or generator may comprise a channel such as a tube for the flow of gas from the cell wherein the tube comprises an inlet from the cell and an outlet for the flow of condensed metal vapor and an outlet of the non-condensable gas to at least one gas sensor. The tube may be cooled. The cooling may be achieved by conduction wherein the tube is heat sunk to a cooled cell component such as the magnets of the electrode electromagnetic pump. The tube may be actively cooled by means such as water-cooling and passive means such as a heat pipe. The cell gas comprising metal vapor may enter the tube wherein the metal vapor condenses due to the tube's lower temperature. The condensed metal may flow to the cone reservoir by means such as at least one of gravity flow and pumping such that the gases to be sensed flow into the sensors in the absence of metal vapor. Alternatively, the gas pressure may be measured in the outer chamber 5b3a wherein the gas may permeate into the reaction cell chamber 5b31. The permeation may be through the blackbody radiator 5b4.

In an embodiment, the generator comprises a blackbody radiator 5b4 that may serve as a vessel comprising a reaction cell chamber 5b31. In an embodiment, the PV converter 26a comprises PV cells 15 on the interior of a metal enclosure comprising a cell chamber 5b3 that contains the blackbody radiator 5b4. The PV cooling plates may be on the outside of the cell chamber. At least one of the chambers 5b3, 5b3a, and 5b31 are capable of maintaining a pressure of at least one of below atmospheric, atmospheric, and above atmospheric pressure. The PV converter may further comprise at least one set of electrical feed-throughs to deliver electrical power from the PV cells inside the inner surface of the cell chamber to outside of the cell chamber. The feed-through may be at least one of airtight and vacuum or pressure capable.

In an embodiment, at least one cell component such as the reservoir 5c may be insulated. The insulation may comprise heat shields may also comprise others forms of thermal insulation such as ceramic insulation materials such as MgO, fire brick, Al₂O₃, zirconium oxide such as Zicar, alumina enhanced thermal barrier (AETB) such as AETB 12 insulation, ZAL-45, and SiC-carbon aerogel (AFSiC). An exemplary AETB 12 insulation thickness is about 0.5 to 5 cm. The insulation may be encapsulated between two layers such as an inner refractory metal or material cell component wall and an outer insulation wall that may comprise the same or a different material such as stainless steel. The cell component may be cooled. The outer insulation encapsulation wall may comprise a cooling system such as one that transfers heat to a chiller or radiator 31.

In an embodiment, the chiller may comprise a radiator 31 and may further comprise at least one fan 31j1 and at least one coolant pump 31k to cool the radiator and circulate the coolant. The radiator may be air-cooled. An exemplary radiator comprises a car or truck radiator. The chiller may further comprise a coolant reservoir or tank 311. The tank 311 may serve as a buffer of the flow. The cooling system may comprise a bypass valve to return flow from the tank to the radiator. In an embodiment, the cooling system comprises at least one of a bypass loop to recirculate coolant between the tank and the radiator when the radiator inlet line pressure is low due to lowering or cessation of pumping in the cooling lines, and a radiator overpressure or overflow line between the radiator and the tank. The cooling system may further comprise at least one check valve in the bypass loop. The cooling system may further comprise a radiator overflow valve such as a check valve and an overflow line from the radiator to the overflow tank 311. The radiator may serve as the tank. The chiller such as the radiator 31 and fan 31j1 may have a flow to and from the tank 311. The cooling system may comprise a tank inlet line from the radiator to the tank 311 to deliver cooled coolant. The coolant may be pumped from the tank 311 to a common tank outlet manifold that may supply cool coolant to each component to be cooled. The radiator 31 may serve as the tank wherein the radiator outlet provides cool coolant. Alternatively, each component to be cooled such as the inductively coupled heater, EM pump magnets 5k4, and PV converter 26a may have a separate coolant flow loop with the tank that is cooled by the chiller such as the radiator and fan. Each loop may comprise a separate pump of a plurality of pumps 31k or a pump and a valve of a plurality of valves 31m. Each loop may receive flow from a separate pump 31k that regulates the flow in the loop. Alternatively, each loop may receive flow from a pump 31k that provides flow to a plurality of loops wherein each loop comprises a valve 31m such as a solenoid valve that regulates the flow in the loop. The flow through each loop may be independently controlled by its controller such as a heat sensor such as at least one of a thermocouple, a flow meter, a controllable value, pump controller, and a computer.

In an embodiment, the reaction cell chamber 5b31 is sealed to confine at least one of the fuel gas such as at least one of water vapor and hydrogen and a source of oxygen such as an oxide, and the metal vapor of the fuel melt such as Ag or Ag—Cu alloy vapor. The outer surface of the reaction cell chamber 5b31 may comprise a blackbody radiator 5b4 that may comprise a material capable of operating at a very high temperature such as in the range of about 1000° C. to 4000° C. In an embodiment, the blackbody radiator 5b4 may comprise a material that has a higher melting point than the melting point of molten metal such as silver. Exemplary materials are at least one of the metals and alloys from the group of WC, TaW, CuNi, Hastelloy C, Hastelloy X, Inconel, Incoloy, carbon steel, stainless steel, chromium-molybdenum steel such as modified 9Cr-1Mo—V (P91), 21/4Cr-1Mo steel (P22), Nd, Ac, Au, Sm, Cu, Pm, U, Mn, doped Be, Gd, Cm, Tb, doped Si, Dy, Ni, Ho, Co, Er, Y, Fe, Sc, Tm, Pd, Pa, Lu, Ti, Pt, Zr, Cr, V, Rh, Hf, Tc, Ru, doped B, Ir, Nb, Mo, Ta, Os, Re, W, carbon, a ceramic such as SiC, MgO, alumina, Hf—Ta—C, boron nitride, and other high temperature materials known in the art that can serve as a blackbody.

The blackbody radiator absorbs power from the plasma to heat up to its high operating temperature. In a thermophotovoltaic embodiment, the blackbody radiator 5b4 provides light incident to the PV converter 26a. The blackbody radiator may have a high emissivity such as one close to one. In an embodiment, the emissivity may be adjusted to cause blackbody power that match the capability of the PV converter. In exemplary embodiments, the emissivity may be increased or decreased by means of the disclosure. In an exemplary case of a metal blackbody radiator 5b4, the surface may be at least one of oxidized and roughened to increase the emissivity. The emissivity of the may be non-linear with wavelength such as inversely proportional to the wavelength such that short wavelength emission is favored from its outer surface. At least one of filters, lenses, and mirrors in the gap between the blackbody radiator 5b4 and the PV converter 26a may be selective for passing short wavelength light to the PV converter while returning infrared light to the radiator 5b4. In an exemplary embodiment, the operating temperature of a W or carbon blackbody radiator 5b4 is the operating temperature of a W incandescent light bulb such as up to 3700 K. With an emissivity of 1, the blackbody radiator power is up to 10.6 MW/m² according to the Stefan Boltzmann equation. In an embodiment, the blackbody radiation is made incident the PV converter 26a comprising concentrator photovoltaic cells 15 such as those of the disclosure that are responsive to the corresponding radiation such as one responsive to visible and near infrared light. The cells may comprise multi junction cells such as double or triple junction cells comprising III/V semiconductors such as those of the disclosure.

The SF-CIHT generator may further comprise a blackbody temperature sensor and a blackbody temperature controller. The blackbody temperature of the blackbody radiator 5b4 may be maintained and adjusted to optimize the conversion of the blackbody light to electricity. The blackbody temperature of the blackbody radiator 5b4 may be sensed with a sensor such as at least one of a spectrometer, an optical pyrometer, the PV converter 26a, and a power meter that uses the emissivity to determine the blackbody temperature. A controller such as one comprising a computer and hydrino reaction parameter sensors and controllers may control the power from the hydrino reaction by means of the disclosure. In exemplary embodiments to control the temperature and the stability of the blackbody temperature, the hydrino reaction rate is controlled by controlling at least one of the water vapor pressure, hydrogen pressure, fuel injection rate, ignition frequency, and ignition voltage and current. For a given hydrino reaction power from the reaction cell chamber 5b31 heating the blackbody radiator 5b4, a desired operating blackbody temperature of the blackbody radiator 5b4 may be achieved by at least one of selecting and controlling the emissivity of at least one of the inner and outer surface of the blackbody radiator 5b4. In an embodiment, the radiated power from the blackbody radiator 5b4 is about a spectral and power match to the PV converter 26a. In an embodiment, the emissivity of the outer surface is selected, such as one in the range of about 0.1 to 1, in order that the top cover 5b4 radiates a power to the PV converter that does not exceed its maximum acceptable incident power at a desired blackbody temperature. The blackbody temperature may be selected to better match the photovoltaic conversion responsiveness of the PV cell so that the conversion efficiency may be maximized. The emissivity may be changed by modification of the blackbody radiator 5b4 outer surface. The emissivity may be increased or decreased by applying a coating of increased or decreased emissivity. In an exemplary embodiment, a pyrolytic carbon coating may be applied to the blackbody radiator 5b4 to increase its emissivity. The emissivity may also be increased by at least one of oxidizing and roughening a W surface, and the emissivity may be decreased by at least one of reducing an oxidized surface and polishing a rough W surface. The generator may comprise a source of oxidizing gas such as at least one of oxygen and H₂O and a source of reducing gas such as hydrogen and a means to control the composition and pressure of the atmosphere in the cell chamber. The generator may comprise gas sensors such as a pressure gauge, a pump, gas supplies, and gas supply controllers to control the gas the composition and pressure to control the emissivity of the blackbody radiator 5b4.

The blackbody radiator 5b4 and the PV converter 26a may be separated by a gap such as a gas or vacuum gap to prevent the PV converter from overheating due to heat conduction to the PV converter. The blackbody radiator 5b4 may comprise a number of suitable shapes such as one comprising flat plates or a dome. The shape may be selected for at least one of structural integrity and optimization of transmitting light to the PV area. Exemplary shapes are cubic, right cylindrical, polygonal, and a geodesic sphere. The blackbody radiator 5b4 such as a carbon one may comprise pieces such as plates that may be glued together. An exemplary cube reaction cell chamber 5b31 and blackbody radiator 5b4 that may comprise carbon may comprise two half cubes that machined from a solid cube of carbon and glued together.

The base of the cavity may comprise geometry such as conical channels to permit the molten metal to flow back into the reservoirs. The base may be thicker that the upper walls to serve as insulation so that the power preferentially radiates from the non-base surfaces. The cavity may comprise walls that vary in thickness along the perimeter in order to produce a desired temperature profile along the outer surface comprising the blackbody radiator 5b4. In an exemplary embodiment, the cubic reaction cell chamber 5b31 may comprise walls that comprise spherical sections centered on each wall to produce a uniform blackbody temperature of the outer surfaces. The spherical sections may be machined into the wall form, or they may be glued to the planar inner walls surfaces. The spherical radius of the spherical sections may be selected to achieve the desired blackbody surface temperature profile.

To enhance the cell electrical output and efficiency, the area of the blackbody emitter 5b4 and receiving PV converter 26a may be optimally matched. In an embodiment, other cell components such as the reservoir 5c may comprise a material such as a refractory material such as carbon, BN, SiC, or W to serve as a blackbody radiator to the PV converter that is arranged circumferentially to the component to receive the blackbody radiation. At least one of the cell components such as the blackbody radiator 5b4 and reservoir 5c may comprise a geometry that optimizes the stacking of the PV cells 15 to accept light from the component. In an exemplary embodiment, the cell component may comprise faceted surfaces such as polygons such as at least one of triangles, pentagons, hexagons, squares, and rectangles with a matching geometry of the PV cells 15. The geometry of the blackbody radiator and PV converter may be selected to optimize the photon transfer from the former to the latter considering parameters such as the angle of incidence of illuminating photons and the corresponding effect on PV efficiency. In an embodiment, the PV converter 26a may comprise a means to move the PV cells such as a PV carousel to cause more uniformity of the time averaged radiation incident on the cells. The PV carousel may rotate an axial symmetrical PC converter such as one comprising a transverse polygonal ring about the symmetry or z-axis. The polygon may comprise a hexagon. The rotation may caused by a mechanical drive connection, pneumatic motor, electromagnetic drive, or other drive known by those skilled in the art.

The blackbody radiator 5b4 surface may be altered to alter the emissivity with a corresponding change on the power radiated from the blackbody radiator. The blackbody radiator emissivity may be changed by (i) altering the polish, roughness, or texture of the surface, (ii) adding a coating such as a carbide such as at least one of tungsten, tantalum, and hafnium carbide or a pyrolytic coating to carbon, and (iii) adding a cladding such as W cladding to a carbon blackbody radiator. In the latter case, the W may be attached to the carbon mechanically by fasteners such as screws with expansion means such as slots. In an exemplary embodiment, the emissivity of TaC such as a TaC coating, tiling, or cladding on a carbon blackbody radiator 5b4 is about 0.2 versus about 1 for carbon.

The blackbody radiator 5b4 may comprise a cavity of a first geometry such as a spherical cavity 5b31 within a solid shape of a second geometry such as a cube (FIGS. 2I134-2I138). In another embodiment, the first cavity 5b31 of a first geometry may be internal to a second cavity 5b4a1 of a second geometry. An exemplary embodiment comprises a spherical shell cavity in a hollow cube cavity. The corresponding second cavity 5b4a1 may comprise a blackbody cavity comprising a blackbody radiator outer surface 5b4a. The interior of the second cavity may be heated to a blackbody temperature by the internal first cavity of the first geometry. The blackbody radiation from the corresponding second blackbody radiator 5b4a may be incident PV cells 15 that may be organized in a matching geometric structure. The cells may be arranged in arrays having the matching geometry. In an embodiment, the light power received into the PV cells may be reduced to a tolerable intensity for that emitted at the operating temperature of the blackbody radiator by at least one of increasing the spacing between the second cavity and the PV cells, using PV cells comprising a partial mirror on the surface to reflect a portion of the incident light, using a secondary radiator such as tungsten rather than carbon one that has a reduced emissivity, and using a reflector in front of the PV cells that has pinholes that only partially transmit the blackbody radiation from the primary or secondary blackbody radiator to the PV cells and ideally reflects the non-transmitted light. In an embodiment, the geometry of the secondary radiator 5b4a and matching-geometry PV converter 26a may be selected to decrease the complexity of the PV cold plates, PV cooler, or PV heat exchanger 26b. An exemplary cubic geometry may minimize the number of PV cold plates, maximize the size of the PV cold plates, and result in low complexity for electrical interconnections and coolant line connections such as those to the inlet 31b and outlet 31c of the PV coolant system.

The W secondary blackbody radiator may be protected from sublimation by means to support the halogen cycle. In an embodiment, the gas of the chamber enclosing the W blackbody radiator such as chamber 5b3 (FIG. 2I80) may comprise a halogen source such as I₂ or Br₂ or a hydrocarbon bromine compound that forms a complex with subliming tungsten. The complex may decompose on the hot tungsten surface to redeposit the tungsten on the blackbody radiator 5b4. The window on the PV cells 15 that may be multilayered may support a temperature gradient to support the volatilization of a tungsten-halogen species to support the halogen cycle.

In an embodiment, a carbon cell component such as a carbon blackbody radiator 5b4 may be protected from sublimation by applying an external pressure. In an exemplary embodiment, carbon is stable to sublimation to 4500 K by application of about 100 atmospheres of pressure. The pressure may be applied as by a high-pressure gas such as at least one of an inert gas, hydrogen, and molten metal vapor such as silver vapor.

In an embodiment, the blackbody radiator 5b4 comprises a spherical dome that may be connected to the reservoir 5c. The blackbody radiator may be a shape other than spherical such as cubic and may further be coated or clad with a material to change its emissivity to better match the radiated power to the capability of the PV cells. An exemplary clad blackbody radiator 5b4 comprises a carbon cube clad with a refractory material of lower emissivity than carbon having a low vapor pressure from vaporization or sublimation at the blackbody operating temperature. At least one cell component such as at least one of the reservoir 5c, blackbody radiator 5b4, and blackbody radiator cladding may comprise at least one of graphite (sublimation point=3642° C.), a refractory metal such as tungsten (M.P.=3422° C.) or tantalum (M.P.=3020° C.), a ceramic, a ultra-high-temperature ceramic, and a ceramic matrix composite such as at least one of borides, carbides, nitrides, and oxides such as those of early transition metals such as hafnium boride (HfB₂), zirconium diboride (ZrB₂), hafnium nitride (HfN), zirconium nitride (ZrN), titanium carbide (TiC), titanium nitride (TiN), thorium dioxide (ThO₂), niobium boride (NbB₂), and tantalum carbide (TaC) and their associated composites. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), hafnium carbide (HfC) (M.P.=3900° C.), Ta₄HfC₅ (M.P.=4000 ° C.), Ta₄HfC₅TaX₄HfCX₅ (4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.), and vanadium nitride (VN) (M.P.=2050° C.), and a turbine blade material such as one or more from the group of a superalloy, nickel-based superalloy comprising chromium, cobalt, and rhenium, one comprising ceramic matrix composites, U-500, Rene 77, Rene N5, Rene N6, PWA 1484, CMSX-4, CMSX-10, Inconel, IN-738, GTD-111, EPM-102, and PWA 1497. The ceramic such as MgO and ZrO may be resistant to reaction with H₂. In an exemplary embodiment, the emissivity of TaC such as a TaC coating, tiling, or cladding on a carbon blackbody radiator 5b4 is about 0.2 versus about 1 for carbon. An exemplary cell component such as the reservoir comprises MgO, alumina, ZrO, ZrB₂, SiC, or BN. An exemplary blackbody radiator 5b4 may comprise carbon or tungsten. The cell component material such as graphite may be coated with another high temperature or refractory material such as a refractory metal such as tungsten or a ceramic such as ZrB₂, TaC, HfC, WC, or another one of the disclosure or known in the art. Another graphite surface coating comprises diamond-like carbon that may be formed on the surface by plasma treatment of the cone. The treatment method may comprise one known in the art for depositing diamond-like carbon on substrates. In an embodiment, silver vapor may deposit on the surface by pre-coating or during operation to protect the cone surface from erosion. In an embodiment, the reaction cell chamber 5b31 may comprise reaction products of carbon and cell gas such as at least one of H₂O, H₂, CO, and CO₂ to suppress further reaction of the carbon. In an embodiment at least one component such as the lower portion of the pump tube 5k6 and EM pump assembly 5kk may comprise high temperature steel such as Haynes 230. In an embodiment, the noble gas-H₂ plasma such as argon-H₂ (3 to 5%) maintained by the hydrino reaction may convert graphitic form of carbon to at least one of diamond-like form or diamond.

The cell component such as the reservoir 5c or blackbody radiator 5b4 may be cast, milled, hot pressed, sintered, plasma sintered, infiltrated, spark plasma sintered, 3D printed by powder bed laser melting, and formed by other methods known to those in the art. In an embodiment, at least one component such as the outer housing 5b3a may be fabricated by stamping or stamp pressing the component material such as metal.

In the case of thermionic and thermoelectric embodiments, the thermionic or thermoelectric converter may be in direct contact with the hot blackbody radiator 5b4. The blackbody radiator 5b4 may also transfer heat to a heat engine such as a Rankine, Brayton, or Stirling heat engine or heater that may server as the heat-to-electricity converter. In an embodiment, a medium other than standard ones such as water or air may be used as the working medium of the heat engine. In exemplary embodiments, a hydrocarbon or supercritical carbon dioxide may replace water in a Rankine cycle of a turbine-generator, and air with an external combustor design may be used as the working medium of Brayton cycle of a turbine-generator. An exemplary supercritical carbon dioxide cycle generator comprises that of Echogen Power Systems (https://www.dresser-rand.com/products-solutions/systems-solutions/waste-heat-recovery-system/ http://www.echogen.com/_CE/pagecontent/Documents/News/Echogen_brochure_2016.pdf). Alternatively, the hot cover 5b4 may serve as a heat source or a heater or a light source. The heat flow to the heat engine or heater may be direct or indirect wherein the SF-CIHT generator may further comprise a heat exchanger or heat transfer means such as one of the disclosure. In another embodiment, the SunCell® may comprise a magnetohydrodynamic (MHD) or plasmahydrodynamic (PHD) electrical generator wherein high-pressure plasma generated in the reaction cell chamber 5b31 is flowed into the MHD or PHD generator and converted into electricity. The return flow may be into the reaction cell chamber.

At least one of the cell chamber 5b3 or 5b3a1 and the reaction cell chamber 3b31 may be evacuated with pump 13a through pump lines such as 13b. Corresponding pump line valves may be used to select the pumped vessel. The cell may further comprise a high temperature capable sensor or sensors for at least one of oxygen, hydrogen, water vapor, metal vapor, gaseous oxide such as CO₂, CO, and total pressure. The water and hydrogen pressure may be controlled to a desired pressure such as one of the disclosure such as a water vapor pressure in the range of 0.1 Torr to 1 Torr by means of the disclosure. In an exemplary embodiment, a valve and a gas supply wherein the valve opening is controlled to supply a flow to maintain the desired pressure of the gas with feedback using the measured pressure of the gas maintain the desired gas pressure. The H₂O and H₂ may be supplied by hydrogen tank and line 311 that may comprise an electrolysis system to provide H₂, H₂O/steam tank and line 311, hydrogen feed line 5ua, argon tank 5u1 and feed line Sula, and gas injector such as at least one of H₂, argon, and H₂O/steam injector that may be though the EM pump tube. Oxygen produced in the cell may be reacted with supplied hydrogen to form water as an alternative to pumping off or gettering the oxygen. Hydrino gas may diffuse through the walls and joints of the cell or flow out a selective gas valve.

In another embodiment, the reaction cell chamber 5b31 is operated under an inert atmosphere. The SF-CIHT generator may comprise a source of inert gas such as a tank, and at least one of a pressure gauge, a pressure regulator, a flow regulator, at least one valve, a pump, and a computer to read the pressure and control the pressure. The inert gas pressure may be in the range of about 1 Torr to 10 atm.

In an embodiment, following startup the heater may be disengaged, and cooling may be engaged to maintain the cell components such as the reservoir 5c, EM pump, and PV converter 26a at their operating temperatures such as those given in the disclosure.

In embodiment, the SF-CIHT cell or generator also referred to as the SunCell® shown in FIGS. 2I28, 2I69, and 2I80-2I149 comprises six fundamental low-maintenance systems, some having no moving parts and capable of operating for long duration: (i) a start-up inductively coupled heater comprising a power supply 5m, leads 5p, and antenna coil 5f to first melt silver or silver-copper alloy to comprise the molten metal or melt and optionally an electrode electromagnetic pump comprising magnets to initially direct the ignition plasma stream; (ii) a fuel injector such as one comprising a hydrogen supply such as a hydrogen permeation supply through the blackbody radiator wherein the hydrogen may be derived from water by electrolysis or thermolysis, and an injection system comprising an electromagnetic pump 5ka to inject molten silver or molten silver-copper alloy and a source of oxygen such as an oxide such as CO₂, CO, LiVO₃ or another oxide of the disclosure, and alternatively a gas injector that may comprise a port through the EM pump tube 5k6 to inject at least one of water vapor and hydrogen gas; (iii) an ignition system to produce a low-voltage, high current flow across a pair of electrodes 8 into which the molten metal, hydrogen, and oxide, or molten metal and at least one of H₂O and hydrogen gases are injected to form a brilliant light-emitting plasma; (iv) a blackbody radiator heated 5b4 to incandescent temperature by the plasma; (v) a light to electricity converter 26a comprising so-called concentrator photovoltaic cells 15 that receive light from the blackbody radiator and operate at a high light intensity such as over one thousand Suns; and (vi) a fuel recovery and a thermal management system that causes the molten metal to return to the injection system following ignition and cools at least on cell component such as the inductively heater antenna 5f, the EM pump magnets 5k4, and the PV converter 26a. In another, embodiment, the light from the ignition plasma may directly irradiate the PV converter 26a to be converted to electricity. In another embodiment, the EM pump 5ka may comprise a thermoelectric pump, a mechanical pump such as a gear pump such as a ceramic gear pump, or another known in the art such one comprising an impeller that is capable of high temperature operation such as in the temperature range of about 900° C. to 2000° C.

In an embodiment, the blackbody radiator to the PV converter 26a may comprise a high temperature material such as carbon, a refractory metal such as W, Re, or a ceramic such as borides, carbides, and nitrides of transition elements such as hafnium, zirconium, tantalum, and titanium, Ta₄HfC₅ (M.P.=4000° C.), TaB₂, HfC, BN, HfB₂, HfN, ZrC, TaC, ZrB₂, TiC, TaN, NbC, ThO₂, oxides such as MgO, MoSi₂, W—Re—Hf—C alloys and others of the disclosure. The blackbody radiator may comprise a geometry that efficiently transfers light to the PV and optimizes the PV cell packing wherein the power for the light flows from the reaction cell chamber 5b31. An exemplary blackbody radiator may comprise a polygon or a spherical dome. The blackbody radiator may be separated from the PV converter 26a by a gas or vacuum gap with the PV cells positioned to receive blackbody light from the blackbody radiator.

The generator may further comprise a peripheral chamber capable of being sealed to the atmosphere and further capable of maintaining at least one of a pressure less than, equal to, and greater than atmospheric. The generator may comprise a spherical pressure or vacuum vessel peripherally to the dome comprising a cell chamber 5b3 wherein the PV converter comprises a housing or pressure vessel. The cell chamber may be comprised of suitable materials known to one skilled in the art that provide structure strength, sealing, and heat transfer. In an exemplary embodiment, the cell chamber comprises at least one of stainless steel and copper. The PV cells may cover the inside of the cell chamber, and the PV cooling system such as the heat exchanger 87 may cover the outer surface of the cell chamber. In a thermophotovoltaic embodiment, the PV converter 26a may comprise a selective filter for visible wavelengths to the PV converter 26a such as a photonic crystal.

In an embodiment, the blackbody radiator comprises a spherical dome 5b4. In an embodiment, the inner surface of the graphite sphere is coated with high-temperature-capable carbide such as Ta₄HfC₅ (M.P.=4000° C.), tungsten carbide, niobium carbide, tantalum carbide, zirconium carbide, titanium carbide, or hafnium carbide. The corresponding metal may be reacted with the carbon of the graphite surface to form a corresponding metal carbide surface. The dome 5b4 may be separated from the PV converter 26a by a gas or vacuum gap. In an embodiment to reduce the light intensity incident on the PV cells, the PV cells may be positioned further from the blackbody radiator. For example, the radius of the peripheral spherical chamber may be increased to decrease the intensity of the light emitted from the inner spherical blackbody radiator wherein the PV cells are mounted on the inner surface of the peripheral spherical chamber (FIG. 2I143). The PV converter may comprise a dense receiver array (DRA) comprised of a plurality of PV cells. The DRA may comprise a parquet shape. The individual PV cells may comprise at least one of triangles, pentagons, hexagons, and other polygons. The cells to form a dome or spherical shape may be organized in a geodesic pattern. In an exemplary embodiment of a secondary blackbody radiator that is operated at an elevated temperature such as 3500 K, the radiant emissivity is about 8.5 MW/m² times the emissivity. In this case, the emissivity of a carbon dome 5b4 having an emissivity of about 1 may be decreased to about 0.35 by applying a tungsten carbide coat. The blackbody radiator 5b4 may comprise a cladding 26c (FIG. 2I143) of a different material to change the emissivity to one more desirable. In an exemplary embodiment, the emissivity of TaC such as a TaC coating, tiling, or cladding on a carbon blackbody radiator 5b4 is about 0.2 versus about 1 for carbon. In another embodiment, the PV cells such as those comprising an outer geodesic dome may be at least one of angled and comprise a reflective coating to reduce the light that is absorbed by the PV cells to a level that is within the intensity capacity of the PV cells. At least one PV circuit element such as at least one of the group of the PV cell electrodes, interconnections, and bus bars may comprise a material having a high emissivity such as a polished conductor such as polished aluminum, silver, gold, or copper. The PV circuit element may reflect radiation from the blackbody radiator 5b4 back to the blackbody radiator 5b4 such that the PV circuit element does not significantly contribute to shadowing PV power conversion loss.

In an embodiment, the blackbody radiator 5b4 may comprise a plurality of sections that may be separable such as separable top and bottom hemispheres. The two hemispheres may join at a flange. A W done may be fabricated by techniques known in the art such as sintering W powder, spark plasma sintering, casting, and 3D printing by powder bed laser melting. The lower chamber 5b5 may join at the hemisphere flange. The cell chamber may attach to the lower chamber by a flange capable of at least one of vacuum, atmospheric pressure, and pressure above vacuum. The lower chamber may be sealed from at least one of the cell chamber and reaction cell chamber. Gas may permeate between the cell chamber and the reaction cell chamber. The gas exchange may balance the pressure in the two chambers. Gas such as at least one of hydrogen and a noble gas such as argon may be added to the cell chamber to supply gas to the cell reaction chamber by permeation or flow. The permeation and flow may be selective for the desired gas such as argon-H₂. The metal vapor such as silver metal vapor may be impermeable or be flow restricted such that it selectively remains only in the cell reaction chamber. The metal vapor pressure may be controlled by maintaining the reservoir 5c at a temperature that condenses the metal vapor and maintains it vapor pressure at a desired level. The generator may be started with a gas pressure such as an argon-H₂ gas pressure below the operating pressure such as atmospheric such that excess pressure does not develop as the cell heats up and the gases expand. The gas pressure may be controlled with a controller such as a computer, pressure sensors, valves, flow meters, and a vacuum pump of the disclosure.

In an embodiment, the hydrino reaction is maintained by silver vapor that serves as the conductive matrix. At least one of continuous injection wherein at least a portion becomes vapor and direct boiling of the silver from the reservoir 5c may provide the silver vapor. The electrodes may provide high current to the reaction to remove electrons and initiate the hydrino reaction. The heat from the hydrino reaction may assist in providing metal vapor such as silver metal vapor to the reaction cell chamber.

The ignition power supply may comprise at least one of capacitors and inductors. The ignition circuit may comprise a transformer. The transformer may output high current. The generator may comprise an inverter that receives DC power from the PV converter and outputs AC. The generator may comprise DC to DC voltage and current conditioners to change the voltage and current from the PV converter that may be input to the inverter. The AC input to the transformer may be from the inverter. The inverter may operate at a desired frequency such as one in the range of about one to 10,000 Hz. In an embodiment, the PV converter 26a outputs DC power that may feed directly into the inverter or may be conditioned before being input to the inverter. The inverted power such as 60 Hz. AC may directly power the electrodes or may be input to a transformer to increase the current. In an embodiment, the source of electrical power 2 provides continuous DC or AC current to the electrodes. The electrodes and electromagnetic pump may support continuous ignition of the injected melt such as molten Ag that may further comprise a source of oxygen such as an oxide. Hydrogen may be added by permeation through the blackbody radiator.

Load following may be achieved by means of the disclosure. In an embodiment, the blackbody radiator 5b4 to the PV converter 26a may radiate away its stored energy very quickly when the power from the reaction cell chamber 5b31 is adjusted downward. In an embodiment, the radiator behaves as an incandescent filament having a similar light cessation time with interruption of power flow from the reaction cell chamber 5b31 to the radiator 5b4. In another embodiment, electrical load following may be achieved by operating the radiator at about a constant power flow corresponding to about a constant operating temperature wherein unwanted power to the load is dissipated or dumped into a resistive element such as a resistor such as a SiC resistor or other heating elements of the disclosure.

In an embodiment, the generator may comprise a smart control system that intelligently activates and deactivates loads of a plurality of loads to control the peak aggregate load. The generator may comprise a plurality of generators that may be ganged for at least one of reliability and providing peak power. At least one of smart metering and control may be achieved by telemetry such as by using a cell phone or personal computer with WiFi.

In an embodiment, the blackbody light from the blackbody radiator 5b4 is randomly directed. The light may be at least one of reflected, absorbed, and reradiated back and forth between the radiator blackbody radiator 5b4 and PV cells 15. The PV cells may be optimally angled to achieve the desired PV absorption and light to electricity conversion. The reflectivity of the PV cover glass may be varied as a function of position. The variation of reflectivity may be achieved with a PV window of spatially variable reflectivity. The variability may be achieved with a coating. An exemplary coating is a MgF₂—ZnS anti-reflective coating. The PV cells may be geometrically arranged to achieve the desired PV cell absorption and refection involving power flow interactions between at least two of the blackbody radiator 5b4 and the PV cells, between a plurality of PV cells, and between a plurality of PV cells and the blackbody radiator 5b4. In an embodiment, the PC cells may be arranged into a surface that has a variable radius as a function of surface angle such as a puckered surface such as puckered geodesic dome. In an embodiment, the blackbody radiator 5b4 may have elements at angles relative to each other to at least one of directionally emit, absorb, and reflect radiation to or from the PV cells. In an embodiment, the blackbody radiator 5b4 may comprise element emitter plates on the blackbody radiator surface to match the PV orientation to achieve a desired transfer of power to the PV cells. At least one of the blackbody radiator, reflector, or absorber surfaces may have at least one of an emissivity, reflectivity, absorption coefficient, and surface area that is selected to achieve the desired power flow to the PV converter involving the radiator and the PV cells. The power flow may involve radiation bouncing between the PV cells and the blackbody radiator. In an embodiment, at least one of the emissivity and surface area of the inner versus outer surface of the blackbody radiator 5b4 are selected to achieve a desired power flow to the PV cells versus power flow back into the reaction cell chamber 5b31.

In an embodiment, the high-energy light such as at least one of UV and EUV may dissociate at least one of H₂O and H₂ in the reaction cell chamber 5b31 to increase the rate of the hydrino reaction. The dissociation may be an alternative to the effect of thermolysis.

In another embodiment, the generator is operated to maintain a high metal vapor pressure in the reaction cell chamber 5b31. The high metal vapor pressure may at least one of create an optically thick plasma to convert the UV and EUV emission from the hydrino reaction into blackbody radiation and serve as a reactant such as a conductive matrix for the hydrino reaction to increase its rate of reaction. The hydrino reaction may propagate in the reaction cell chamber supported by thermolysis of water. At least one of the metal vapor and blackbody temperatures may be high such as in the range of 1000K to 10,000K to support the thermolysis of water to increase the hydrino reaction rate. The hydrino reaction may occur in at least one of the gas phase and plasma phase. The metal may be injected by the electromagnetic pump and vaporized by at least one of the ignition current and heat from the hydrino reaction. The reaction conditions, current, and metal injection rate may be adjusted to achieve the desired metal vapor pressure.

The operation of the generator at a temperature over the boiling point of metal source of the metal vapor may result in a reaction cell chamber pressure that is greater than atmospheric. The metal vapor pressure may be controlled by at least one of the controlling the amount of metal vapor supplied to the chamber by the electromagnetic (EM) pump and by controlling the temperature of a cell component such as the cell reservoir. In an embodiment, at least one of the reaction cell chamber 5b31 and the reservoirs 5c may comprise at least one baffle to cause a convection current flow of hot vapor from one zone of the reaction cell chamber wherein the vapor has the highest temperature such as in the zone where the hydrino reaction occurs to the cooler liquid metal surface of the reservoirs 5c. The thermal circulation may control the silver vapor pressure by condensing the vapor wherein the vapor pressure may be determined by at least one of the transport rate and the vapor pressure dependency on the liquid silver temperature that may be controlled. The reservoirs may be sufficiently deep to maintain a liquid silver level. The reservoirs may be cooled by a heat exchanger to maintain the liquid silver. The temperature may be controlled using cooling such as water-cooling. In an exemplary embodiment, straight baffles extending from the reservoirs into the reaction cell chamber may separate an outer cool flow from an inner hot flow. In another embodiment, the EM pump may be controlled to stop the pumping when the desired metal vapor pressure is achieved. Alternatively, the pressure of the cell chamber 5b3 or 5b3a1 may be matched to that of the reaction cell chamber 5b31 such that there is a desired tolerable pressure gradient across chambers. The difference in chamber pressures may be reduced or equalized or equilibrated by adding gas such as a noble gas to the cell chamber from a gas supply controlled by a valve, regulator, controller, and pressure sensor. In an embodiment, gases are permable between the cell chamber 5b3 or 5b3a1 and the reaction cell chamber 5b31. The chamber gas, but not the metal vapor, may move and equilibrate the pressure of the two chambers. Both chambers may be pressurized with a gas such as a noble gas to an elevated pressure. The pressure may be higher than the highest operating partial pressure of the metal vapor. The highest metal vapor partial pressure may correspond to the highest operating temperature. During operation, the metal vapor pressure may increase the reaction cell pressure such that the gas selectively flows from the reaction cell chamber 5b3 to the cell chamber 5b3 or 5b3a1 until the pressures equilibrate and vice versa. In an embodiment, the gas pressures between the two chambers automatically equilibrate. The equilibration may be achieved by the selective mobility of the gas between chambers. In an embodiment, excursions in pressure are avoided so that large pressure differentials are avoided.

The pressure in the cell chamber may be maintained greater than that in the reaction cell chamber. The greater pressure in the external cell chamber may serve to mechanically hold the cell components blackbody radiator 56b4 and reservoir 5c together.

In an embodiment, the metal vapor is maintained at a steady state pressure wherein condensation of the vapor is minimized. The electromagnetic pump may be stopped at a desired metal vapor pressure. The EM pump may be intermittently activated to pump to maintain the desired steady state pressure. The metal vapor pressure may be maintained in the at least one range of 0.01 Torr to 200 atm, 0.1 Torr to 100 atm, and 1 Torr to 50 atm.

In an embodiment to achieve a high hydrino power, the electrode electromagnetic pumping action is controlled to control the ignition current parameters such as waveform, peak current, peak voltage, constant current, and constant voltage. In an embodiment, the waveform may be any desired that optimizes the desire power output and efficiency. The waveform maybe constant current, constant voltage, constant power, saw tooth, square wave, sinusoidal, trapezoid, triangular, ramp up with cutoff, ramp up-ramp down, and other waveforms know in the art. In cases wherein the waveform has a portion having about zero voltage or current, the duty cycle may be in the range of about 1% to 99%. The frequency may be any desired such as in at least one range of about 0.001 Hz to 1 MHz, 0.01 Hz to 100 kHz, and 0.1 Hz to 10 kHz. The peak current of the waveform may be in at least one range of about 10 A to 1 MA, 100 A to 100 kA, and 1 kA to 20 kA. The voltage may be given by the product of the resistance and current. In an embodiment, the source of electrical power 2, may comprise an ignition capacitor bank 90. In an embodiment, the source of electrical power 2 such as the capacitor bank may be cooled. The cooling system may comprise one of the disclosure such as a radiator.

In an embodiment, the source of electrical power 2 comprises a capacitor bank with different numbers of series and parallel capacitors to provide the optimal electrode voltage and current. The PV converter may charge the capacitor bank to the desired optimal voltage and maintain the optimal current. The ignition voltage may be increased by increasing the resistance across the electrodes. The electrode resistance may be increased by operating the electrodes at a more elevated temperature such as in the temperature range of about 1000K to 3700K. The electrode temperature may be controlled to maintain a desired temperature by controlling the ignition process and the electrode cooling. The voltage may be in at least one range of about 1 V to 500 V, 1 V to 100 V, 1 V to 50 V, and 1 V to 20 V. The current may be in at least one range of about 10 A to 100 kA, 100 A to 10 kA, and 100 A to 5 kA. In an exemplary embodiment, the voltage is about 16 V at a constant current between 150 A and 250 A. In an embodiment, the power due to the hydrino reaction is higher at the positive electrode due to a higher hydrino reaction rate. The higher rate may be due to the more effective removal of electrons from the reaction plasma by the positive electrode. In an embodiment, the hydrino reaction is dependent on the removal of electrons that is favored at higher applied electrode voltage. The removal of electrons may also be enhanced by grounding the cell components in contact with the reaction plasma. The generator may comprise additional grounded or positively biased electrodes. The capacitor may be contained in a ignition capacitor housing 90 (FIG. 2I89).

The ignition voltage may be elevated such as in at least one range of about 1 V to 100 V, 1 V to 50 V, and 1 V to 25 V. The current may be pulsed or continuous. The current may in at least one range of about 50 A to 100 kA, 100 A to 10 kA, and 300 A to 5 kA. The vaporized melt may provide a conductive path to remove electrons from the hydrino catalysis reaction to increase the reaction rate. In an exemplary embodiment, the silver vapor pressure is elevated such as in the range of about 0.5 atm to 100 atm due to vaporization in the temperature range of about 2162° C. to 4000° C.

In an embodiment, the SunCell® may comprise liquid electrodes. The electrodes may comprise liquid metal. The liquid metal may comprise the molten metal of the fuel. The injection system may comprise at least two reservoirs 5c and at least two electromagnetic pumps that may be substantially electrically isolated from each other. The nozzles 5q of each of the plurality of injections system may be oriented to cause the plurality of molten metal streams to intersect. Each stream may have a connection to a terminal of a source of electricity 2 to provide voltage and current to the intersecting streams. The current may flow from one nozzle 5q through its molten metal stream to the other stream and nozzle 5q and back to the corresponding terminal of the source of electricity 2. The cell comprises a molten metal return system to facilitate the return on the injected molten metal to the plurality of reservoirs. In an embodiment, the molten metal return system minimizes the shorting of at least one of the ignition current and the injection current through the molten metal. The reaction cell chamber 5b31 may comprise a floor that directs the return flow of the injected molten metal into the separate reservoirs 5c such that the silver is substantially isolated in the separate reservoirs 5c to minimize the electrical shortage through silver connecting the reservoirs. The resistance for electrical conduction may be substantially higher through the return flow of silver between reservoirs than through the intersecting silver such that the majority of the current flows through the intersecting streams. The cell may comprise a reservoir electrical isolator or separator that may comprise an electrical insulator such as a ceramic or a refractory material of low conductivity such as graphite.

The hydrino reaction may cause the production of a high concentration of electrons that may slow further hydrino production and thereby inhibit the hydrino reaction rate. A current at the ignition electrodes 8 may remove the electrons. In an embodiment, a solid electrode such as a solid refractory metal electrode is prone to melting when it is the positive electrode or anode due to the preference of electrons to be removed at the anode causing a high hydrino reaction rate and local heating. In an embodiment, the electrodes comprise a hybrid of liquid and solid electrodes. The anode may comprise a liquid metal electrode and the cathode may comprise a solid electrode such as a W electrode and vice versa. The liquid metal anode may comprise at least one EM pump and nozzle wherein the liquid metal is injected to make contact with the cathode to complete the ignition electrical circuit.

In an embodiment, the ignition power is terminated when the hydrino reaction propagates in the absence of electrical power input. The hydrino reaction may propagate in the reaction cell chamber supported by thermolysis of water. The ignition-power independent reaction may be self propagates under suitable reaction conditions. The reaction conditions may comprise at least one of an elevated temperature and suitable reactant concentrations. At least one of the hydrino reaction conditions and current may be controlled to achieve a high temperature on at least a potion of the electrodes to achieve thermolysis. At least one of the reaction temperature and the temperature of a portion of the electrodes may be high such as in at least one range of about 1000° C. to 20,000° C., 1000° C. to 15,000° C., and 1000° C. to 10,000° C. Suitable reaction concentrations may comprise a water vapor pressure in at least one range of about 0.1 Torr to 10,000 Torr, 0.2 Torr to 1000 Torr, 0.5 Torr to 100 Torr, and 0.5 Torr to 10 Torr. Suitable reaction concentrations may comprise a hydrogen pressure in at least one range of about 0.1 Torr to 10,000 Torr, 0.2 Torr to 1000 Torr, 0.5 Torr to 100 Torr, and 0.5 Torr to 10 Torr. Suitable reaction concentrations may comprise a metal vapor pressure in at least one range of about 1 Torr to 100,000 Torr, 10 Torr to 10,000 Torr, and 1 Torr to 760 Torr. The reaction cell chamber may be maintained at a temperature that maintains a metal vapor pressure that optimizes the hydrino reaction rate.

In an embodiment, a compound may be added to the molten metal such as molten Ag or AgCu alloy to at least one of lower its melting point and viscosity. The compound may comprise a fluxing agent such as borax. In an embodiment, a solid fuel such as one of the disclosure may be added to the molten metal. In an embodiment, the molten metal such as molten silver, copper, or AgCu alloy comprise a composition of matter to bind or disperse water in the melt such as fluxing agent that may be hydrated such as borax that may be hydrated to various extents such as borax dehydrate, pentahydrate, and decahydrate. The melt may comprise a fluxing agent to remove oxide from the inside of the pump tube. The removal may maintain a good electrical contact between the molten metal and the pump tube 5k6 at region of the electromagnetic pump bus bar 5k2.

In an embodiment, a compound comprising a source of oxygen may be added to the molten metal such as molten silver, copper, or AgCu alloy. In an embodiment, the metal melt comprises a metal that does not adhere to cell components such as the cone reservoir and cone or dome. The metal may comprise an alloy such as Ag—Cu such as AgCu (28 wt %) or Ag—Cu—Ni alloy. The compound may be melted at the operating temperature of the reservoir 5c and the electromagnetic pump such that it at least one of dissolves and mixes with the molten metal. The compound may at least one of dissolve and mixes in the molten metal at a temperature below its melting point. Exemplary compounds comprising a source of oxygen comprise oxides such as metal oxides or Group 13, 14, 15, 16, or 17 oxides. Exemplary metals of the metal oxide are at least one of metals having low water reactivity such as those of the group of Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, and Zn. The corresponding oxide may react thermodynamically favorably with hydrogen to form HOH catalyst. Exemplary metal oxides and their corresponding melting points are sodium tetraborate decahydrate (M.P.=743° C., anhydrate), CuO (M.P.=1326° C.), NiO (M.P.=1955° C.), PbO (M.P.=888° C.), Sb₂O₃ (M.P.=656° C.), Bi₂O₃ (M.P.=817° C.), Co₂O₃ (M.P.=1900° C.), CdO (M.P.=900-1000° C.), GeO₂ (M.P.=1115° C.), Fe₂O₃ (M.P.=1539-1565° C.), MoO₃ (M.P.=795° C.), TeO₂ (M.P.=732° C.), SnO₂ (M.P.=1630° C.), WO₃ (M.P.=1473° C.), WO₂ (M.P.=1700° C.), ZnO (M.P.=1975° C.), TiO₂ (M.P.=1843° C.), Al₂O₃ (M.P.=2072° C.), an alkaline earth oxide, a rare earth oxide, a transition metal oxide, an inner transition metal oxide, an alkali oxide such as Li₂O (M.P.=1438° C.), Na₂O (M.P.=1132° C.), K₂O (M.P.=740° C.), Rb₂O (M.P.=>500° C.), Cs₂O (M.P.=490° C.), a boron oxide such as B₂O₃ (M.P.=450° C.), V₂O₅ (M.P.=690° C.), VO (M.P.=1789° C.), Nb₂O₅ (M.P.=1512° C.), NbO₂ (M.P.=1915° C.), SiO₂ (M.P.=1713° C.), Ga₂O₃ (M.P.=1900° C.), In₂O₅ (M.P.=1910° C.), Li₂WO₄ (M.P.=740° C.), Li₂B₄O₇ (M.P.=917° C.), Na₂MoO₄ (M.P.=687° C.), LiVO₃ (M.P.=605° C.), Li₂VO₃, Mn₂O₅ (M.P.=1567° C.), and Ag₂WO₄ (M.P.=620° C.). Further exemplary oxides comprise mixtures of oxides such as a mixture comprising at least two of an alkali oxide such as Li₂O and Na₂O and Al₂O₃, B₂O₃, and VO₂. The mixture may result in a more desirable physical property such as a lower melting point or higher boiling point. The oxide may be dried. In an exemplary embodiment of the source of oxygen such as Bi₂O₃ or, Li₂WO₄, the hydrogen reduction reaction of the source of oxygen is thermodynamically favorable, and the reaction of the reduction product with water to form the source of oxygen may occur under operating conditions such as at red heat conditions. In an exemplary embodiment, at red heat, bismuth reacts with water to form the trioxide bismuth(III) oxide (2Bi(s)+3H2O(g)→Bi2O3(s)+3H2(g)). In an embodiment, the oxide is vaporized into the gas phase or plasma. The moles of oxide in the reaction cell chamber 5b31 may limit its vapor pressure. In an embodiment, the source of oxygen to form HOH catalyst may comprise multiple oxides. Each of a plurality of oxides may be volatile to serve as a source of HOH catalyst within certain temperature ranges. For example LiVO₃ may serve as the main oxygen source above its melting point and below the melting point of a second source of oxygen such as a second oxide. The second oxide may serve as an oxygen source at a higher temperature such as above its melting point. Exemplary second oxides are Al₂O₃, ZrO, MgO, alkaline earth oxides, and rare earth oxides. The oxide may be essentially all gaseous at the operating temperature such as 3000K. The pressure may be adjusted by the moles added to the reaction cell chamber 5b31. The ratio of the oxide and silver vapor pressures may be adjusted to optimize the hydrino reaction conditions and rate.

In an embodiment, the source of oxygen may comprise an inorganic compound such as at least one of, H₂O, CO, CO₂, N₂O, NO, NO₂, N₂O₃, N₂O₄, N₂O₅, SO, SO₂, SO₃, PO, PO₂, P₂O₃, P₂O₅. The source of oxygen such as at least one of CO₂ and CO may be a gas at room temperature. The oxygen source such as a gas may be in the outer pressure vessel chamber 5b31a. The oxygen source may comprise a gas. The gases may at least one of diffuse or permeate from the outer pressure vessel chamber 5b31a to the reaction cell chamber 5b31 and diffuse or permeate from the reaction cell chamber 5b31 to the outer pressure vessel chamber 5b31a. The oxygen source gas concentration inside of the reaction cell chamber 5b31 may be controlled by controlling its pressure in the outer pressure vessel chamber 5b31a. The oxygen source gas may be added to the reaction cell chamber as a gas inside of the reaction cell chamber by a supply line. The supply line may enter in a colder region such as in the EM pump tube at the bottom of a reservoir. The oxygen source gas may be supplied by the decomposition or vaporization of a solid or liquid such as frozen CO₂, a carbonate, or carbonic acid. The pressure in at least one of the outer pressure vessel chamber 5b31a and the reaction cell chamber 5b31 may be measured with a pressure gauge such as one of the disclosure. The gas pressure may be controlled with a controller and a gas source.

The reaction cell chamber 5b31 gas may further comprise H₂ that may permeate the blackbody radiator 5b4 or be supplied through the EM pump tube or another inlet. Another gas such as at least one of CO₂, CO, and H₂O may be supplied by at least one of permeation and flow through an inlet such as the EM pump tube. The H₂O may comprise at least one of water vapor and gaseous water or steam. The gas in the outer chamber that permeates the blackbody radiator such as a carbon blackbody radiator 5b4 to supply the reaction cell chamber 5b31 may comprise at least one of H₂, H₂O, CO, and CO₂. The gases may at least one of diffuse or permeate from the outer pressure vessel chamber 5b31a to the reaction cell chamber 5b31 and diffuse or permeate from the reaction cell chamber 5b31 to the outer pressure vessel chamber 5b31a. Controlling the corresponding gas pressure in the outer chamber may control the reaction cell chamber 5b31 concentration of each gas. The reaction cell chamber 5b31 pressure or concentration of each gas may be sensed with a corresponding sensor. The presence of CO, CO₂ and H₂ in the reaction cell chamber 5b31 may suppress the reaction of H₂O with any cell components comprised of carbon such as a carbon reaction cell chamber. In an embodiment, the oxygen product of the reaction of H₂O to hydrino such as H₂(1/4) may be beneficial to the hydrino reaction. The oxidative side reaction of the oxygen product with the cell components may be suppressed by the presence of hydrogen. A coating of the molten metal that may form during operation may also protect the cell component from reaction with at least one of H₂O and oxygen. In an embodiment, a wall such as the inner wall of the reaction cell chamber may be coated with a coating such as pyrolytic graphite in the case of a reaction cell chamber wherein the coating is selectively permeable to a desired gas. In an exemplary embodiment, the blackbody radiator 5b4 comprises carbon and the inner wall of the reaction cell chamber 5b31 comprises pyrolytic graphite that is permeable to H₂ while being impermeable to at least one of O₂, CO, CO₂, and H₂O. The inner wall may be coated with molten metal such as silver to prevent wall reaction with oxidizing species such as O₂ and H₂O.

The source of oxygen may comprise a compound comprising an oxyanion. The compound may comprise a metal. The compound may be chosen from one of oxides, hydroxides, carbonate, hydrogen carbonate, sulfates, hydrogen sulfates, phosphates, hydrogen phosphates, dihydrogen phosphates, nitrates, nitrites, permanganates, chlorates, perchlorates, chlorites, perchlorites, hypochlorites, bromates, perbromates, bromites, perbromites, iodates, periodates, iodites, periodites, chromates, dichromates, tellurates, selenates, arsenates, silicates, borates, cobalt oxides, tellurium oxides, and other oxyanions such as those of halogens, P, B, Si, N, As, S, Te, Sb, C, S, P, Mn, Cr, Co, and Te wherein the metal may comprise one or more of an alkali, alkaline earth, transition, inner transition, or rare earth, Al, Ga, In, Ge, Sn, Pb, Sb, Bi, Se, and Te. The source of oxygen may comprise at least one of MNO₃, MClO₄, MO, MₓO, and MₓO_{y} wherein M is a metal such as a transition metal, inner transition metal, rare earth metal, Sn, Ga, In, lead, germanium, alkali metal or alkaline earth metal and x and y are integers. The source of oxygen may comprise at least one of SO₂, SO₃, S₂O₅Cl₂, F₅SOF, M₂S₂O₈, SOₓX_{y} such as SOCl₂, SOF₂, SO₂F₂, or SOBr₂, XₓX′_{y}O_{z} wherein X and X′ are halogen such as ClO₂F, ClO₂F₂, ClOF₃, ClO₃F, and ClO₂F₃, tellurium oxide such as TeOₓ such as TeO₂ or TeO₃, Te(OH)₆, SeOₓ such as SeO₂ or SeO₃, a selenium oxide such as SeO₂, SeO₃, SeOBr₂, SeOCl₂, SeOF₂, or SeO₂F₂, P₂O₅, POₓX_{y} wherein X is halogen such as POBr₃, POI₃, POCl₃ or POF₃, an arsenic oxide such as As₂O₃ or As₂O₅, an antimony oxide such as Sb₂O₃, Sb₂O₄, or Sb₂O₅, or SbOCl, Sb₂(SO4)₃, a bismuth oxide, another bismuth compound such as BiAsO4, Bi(OH)₃, Bi₂O₃, BiOBr, BiOCl, BiOI, Bi₂O₄, a metal oxide or hydroxide such as Y₂O₃, GeO, FeO, Fe₂O₃, or NbO, NiO, Ni₂O₃, SnO, SnO₂, Ag₂O, AgO, Ga₂O, As₂O₃, SeO₂, TeO₂, In(OH)₃, Sn(OH)₂, In(OH)₃, Ga(OH)₃, or Bi(OH)₃, CO₂, CO, a permanganate such as KMnO₄ and NaMnO₄, P₂O₅, a nitrate such as LiNO₃, NaNO₃ and KNO₃, a transition metal oxide or hydroxide (Sc, Ti, V, Cr, Mn, Fe, Co, Ni, Cu, or Zn with at least one O and OH), an oxyhydroxide such as FeOOH, a second or third transition series oxide or hydroxide such as those of Y, Zr, Nb, Mo, Tc, Ag, Cd, Hf, Ta, W, Os, a noble metal oxide such as PdO or PtO, a metal and an oxyanion such as Na₂TeO₄ or Na₂TeO₃, CoO, a compound containing at least two atoms from the group of oxygen and different halogen atoms such as F₂O, Cl₂O, ClO₂, Cl₂O₆, Cl₂O₇, ClOF₃, ClO₂F, ClO₂F₃, ClO₃F, I₂O₅, a compound that can form a metal upon reduction. The source of oxygen may comprise a gas comprising oxygen such as at least one O₂, N₂O, and NO₂.

In an embodiment, the melt comprises at least one additive. The additive may comprise one of a source of oxygen and a source of hydrogen. The at least one of a source of oxygen and a source of hydrogen source may comprise one or more of the group of:

H2, NH3, MNH2, M2NH, MOH, MAlH4, M3AlH6, and MBH4, MH, MNO3, MNO, MNO2, M2NH, MNH2, NH3, MBH4, MAlH4, M3AlH6, MHS, M2CO3, MHCO3, M2SO4, MHSO4, M3PO4, M2HPO4, MH2PO4, M2MoO4, M2MoO3, MNbO3, M2B4O7, MBO2, M2WO4, M2CrO4, M2Cr2O7, M2TiO3, MZrO3, MAlO2, M2Al2O2, MCoO2, MGaO2, M2GeO3, MMnO4, M2MnO4, M4SiO4, M2SiO3, MTaO3, MVO3, MIO3, MFeO2, MIO4, MOCl, MClO2, MClO3, MClO4, MClO4, MScO3, MScOn, MTiOn, MVOn, MCrOn, MCr2On, MMn2On, MFeOn, MxCoOn (x is an integer or fraction), MNiOn, MNi2On, MCuOn, MZnOn, wherein n=1, 2,3, or 4 and M is metal such as an alkali metal, Mg3(BO3)2, and M2S2O8;

a mixed metal oxide or an intercalation oxide such as a lithium ion battery intercalation compound such as at least one of the group of LiCoO₂, LiFePO₄, LiNiₓMn_{y}Co_{z}O₂, LiMn₂O₄, LiFeO₂, Li₂MnO₃, Li₂MnO₄, LiNiO₂, LiFeO₂, LiTaO₃, LiVO₃, Li₂VO₃, Li₂NbO₃, Li₂SeO₃, Li₂SeO₄, Li₂TeO₃, Li₂TeO₄, Li₂WO₄, Li₂CrO₄, Li₂Cr₂O₇, Li₂HfO₃, Li₂MoO₃ or Li₂MoO₄, Li₂TiO₃, Li₂ZrO₃, and LiAlO₂;

a fluxing agent such as sodium tetraborate (M.P.=743° C., anhydrate), K2SO4 (M.P.=1069° C.), Na2CO3 (M.P.=851° C.), K2CO3 (M.P.=891° C.), KOH (M.P.=360° C.), MgO, (M.P.=2852° C.), CaO, (M.P.=2613° C.), SrO, (M.P.=2531° C.), BaO, (M.P.=1923° C.), CaCO3 (M.P.=1339° C.);

a molecular oxidant that may comprise a gas such as CO, CO2, SO2, SO3, S2O5Cl2, F5SOF, SOxXy such as SOCl2, SOF2, SO2F2, SOBr2, PO2, P2O3, P2O5, POxXy such as POBr3, POI3, POCl3 or POF3, I2O5, Re2O7, I2O4, I2O5, I2O9, SO2, CO, CO2, N2O, NO, NO2, N2O3, N2O4, N2O5, Cl2O, Cl1O2, Cl2O3, Cl2O6, Cl2O7, NH4X wherein X is a nitrate or other suitable anion known to those skilled in the art such as one of the group comprising NO3-, NO2-, SO42-, HSO4-, CoO2-, IO3-, IO4-, TiO3-, CrO4-, FeO2-, PO43-, HPO42-, H2PO4-, VO3-, ClO4- and Cr2O72;

an oxyanion such as one of the group of NO3-, NO2-, SO42-, HSO4-, CoO2-, IO3-, IO4-, TiO3-, CrO4-, FeO2-, PO43-, HPO42-, H2PO4-, VO3-, ClO4- and Cr2O72-;

an oxyanion of a strong acid, an oxidant, a molecular oxidant such as one of the group of V2O3, I2O5, MnO2, Re2O7, CrO3, RuO2, AgO, PdO, PdO2, PtO, PtO2, and NH4X wherein X is a nitrate or other suitable anion known by those skilled in the art;

a hydroxide such as one of the group of Na, K, Rb, Cs, Mg, Ca, Sr, Ba, Al, V, Zr, Ti, Mn, Zn, Cr, Sn, In, Cu, Ni, Pb, Sb, Bi, Co, Cd, Ge, Au, Ir, Fe, Hg, Mo, Os, Pd, Re, Rh, Ru, Se, Ag, Tc, Te, Tl, and W, MOH, MOH, M′(OH)2 wherein M is an alkali metal and M′ is alkaline earth metal, a transition metal hydroxide, Co(OH)2, Zn(OH)2, Ni(OH)2, other transition metal hydroxides, a rare earth hydroxide, Al(OH)3, Cd(OH)2, Sn(OH)2, Pb(OH), In(OH)3, Ga(OH)3, Bi(OH)3, compounds comprising Zn(OH)₄²⁻, Sn(OH)₄²⁻, Sn(OH)₆²⁻, Sb(OH)₄⁻, Pb(OH)₄²⁻, Cr(OH)₄⁻, and Al(OH)₄⁻, complex ion hydroxides such as Li2Zn(OH)4, Na2Zn(OH)4, Li2Sn(OH)4, Na2Sn(OH)4, Li2Pb(OH)4, Na2Pb(OH)4, LiSb(OH)4, NaSb(OH)4, LiAl(OH)4, NaAl(OH)4, LiCr(OH)4, NaCr(OH)4, Li2Sn(OH)6, and Na2Sn(OH)6;

an acid such as H2SO3, H2SO4, H3PO3, H3PO4, HClO4, HNO3, HNO, HNO2, H2CO3, H2MoO4, HNbO3, H2B4O7, HBO2, H2WO4, H2CrO4, H2Cr2O7, H2TiO3, HZrO3, MAlO2, HMn2O4, HIO3, HIO4, HClO4, or a source of an acid such as an anhydrous acid such as at least one of the group of SO2, SO3, CO, CO2, NO2, N2O3, N2O5, Cl2O7, PO2, P2O3, and P2O5;

a solid acid such as one of the group of MHSO4, MHCO3, M2HPO4, and MH2PO4 wherein M is metal such as an alkali metal;

an oxyhydroxide such as one of the group of WO2(OH), WO2(OH)2, VO(OH), VO(OH)2, VO(OH)3, V2O2(OH)2, V2O2(OH)4, V2O2(OH)6, V2O3(OH)2, V2O3(OH)4, V2O4(OH)2, FeO(OH), (α-MnO(OH) groutite and γ-MnO(OH) manganite), MnO(OH), MnO(OH)2, Mn2O3(OH), Mn2O2(OH)3, Mn2O(OH)5, MnO3(OH), MnO2(OH)3, MnO(OH)5, Mn2O2(OH)2, Mn2O6(OH)2, Mn2O4(OH)6, NiO(OH), TiO(OH), TiO(OH)2, Ti2O3(OH), Ti2O3(OH)2, Ti2O2(OH)3, Ti2O2(OH)4, and NiO(OH), bracewellite (CrO(OH)), diaspore (AlO(OH)), ScO(OH), YO(OH), VO(OH), goethite (α-Fe3+O(OH)), groutite (Mn3+O(OH)), guyanaite (CrO(OH)), montroseite ((V,Fe)O(OH)), CoO(OH), NiO(OH), Ni1/2Co1/20(OH), and Ni1/3Co1/3Mn1/30(OH), RhO(OH), InO(OH), tsumgallite (GaO(OH)), manganite (Mn3+O(OH)), yttrotungstite-(Y) YW2O6(OH)3, yttrotungstite-(Ce) ((Ce, Nd, Y)W2O6(OH)3), unnamed (Nd-analogue of yttrotungstite-(Ce)) ((Nd, Ce, La)W2O6(OH)3), frankhawthorneite (Cu2[(OH)2[TeO4]), khinite (Pb2+Cu₃²⁺(TeO6)(OH)2), parakhinite (Pb2+Cu₃²⁻TeO6(OH)2), and MxOyHz wherein x, y, and z are integers and M is a metal such as a transition, inner transition, or rare earth metal such as metal oxyhydroxides;

an oxide such as one of the group of oxyanion compounds, aluminate, tungstate, zirconate, titanate, sulfate, phosphate, carbonate, nitrate, chromate, and manganate, oxides, nitrites, borates, boron oxide such as B₂O₃, metal oxides, nonmetal oxides, oxides of alkali, alkaline earth, transition, inner transition, and rare earth metals, and Al, Ga, In, Sn, Pb, S, Te, Se, N, P, As, Sb, Bi, C, Si, Ge, and B, and other elements that form oxides or oxyanions, an oxide comprising at least one cation from the group of alkaline, alkaline earth, transition, inner transition, and rare earth metal, and Al, Ga, In, Sn, and Pb cations, a metal oxide anion and a cation such as an alkali, alkaline earth, transition, inner transition and rare earth metal cation, and those of other metals and metalloids such as those of Al, Ga, In, Si, Ge, Sn, Pb, As, Sb, Bi, Se, and Te such as MM′2xO3x+1 or MM′2xO4 (M=alkaline earth, M′=transition metal such as Fe or Ni or Mn, x=integer) and M2M′2xO3x+1 or M2M′2xO4 (M=alkali, M′=transition metal such as Fe or Ni or Mn, x=integer), M2Oand MO where in M is metal such as an alkali metal such as Li2O, Na2O, and K2O, and alkaline earth metal such as MgO, CaO, SrO, and BaO, MCoO2 wherein M is metal such as an alkali metal, CoO2, MnO2, Mn2O3, Mn3O4, PbO2, Ag2O2, AgO, RuO2, compounds comprising silver and oxygen, oxides of transition metals such as NiO and CoO, those of V, Zr, Ti, Mn, Zn, Cr, Sn, In, Cu, Ni, Pb, Sb, Bi, Co, Cd, Ge, Au, Ir, Fe, Hg, Mo, Os, Pd, Re, Rh, Ru, Se, Ag, Tc, Te, Tl, and W transition metals and Sn such as SnO, those of alkali metals such as Li2O, Na2O, and K2O, and alkaline earth metal such as MgO, CaO, SrO, and BaO, MoO2, TiO2, ZrO2, SiO2, Al2O3, NiO, Ni2O3, FeO, FeO3, TaO2, Ta2O5, VO, VO2, V2O3, V2O5, B2O3, NbO, NbO2, Nb2O5, SeO2, SeO3, TeO2, TeO3, WO2, WO3, Cr3O4, Cr2O3, CrO2, CrO3, MnO, Mn2O7, HfO2, Co2O3, CoO, Co3O4, PdO, PtO2, BaZrO3, Ce2O3, LiCoO2, Sb2O3, BaWO4, BaCrO₄, BaSi₂O₅, Ba(BO2)2, Ba(PO3)2, BaSiO3, BaMoO4, Ba(NbO3)2, BaTiO₃, BaTi2O5, BaWO4, CoMoO₄, Co2SiO4, CoSO4, CoTiO3, CoWO4, Co2TiO4, Nb2O5, Li2MoO4, LiNbO3, LiSiO4, Li3PO4, Li2SO4, LiTaO3, Li2B4O7, Li2TiO3, Li2WO4, LiVO3, Li₂VO₃, Li2ZrO3, LiFeO2, LiMnO₄, LiMn2O4, LiGaO2, Li2GeO3, LiGaO2;

a hydrate such as one of the disclosure such as borax or sodium tetraborate hexahydrate;

a peroxide such as H2O2, M2O2 where M is an alkali metal, such as Li2O2, Na2O2, K2O2, other ionic peroxides such as those of alkaline earth peroxides such as Ca, Sr, or Ba peroxides, those of other electropositive metals such as those of lanthanides, and covalent metal peroxides such as those of Zn, Cd, and Hg;

a superoxide such as MO2 where M is an alkali metal, such as NaO2, KO2, RbO2, and CsO2, and alkaline earth metal superoxides;

a compound comprising at least one of an oxygen species such as at least one of O2, O3, O₃⁺, O₃⁻, O, O+, H2O, H3O+, OH, OH+, OH−, HOOH, OOH−, O−, O2−, O₂⁻, and O₂²⁻ and a H species such as at least one of H2, H, H+, H2O, H3O+, OH, OH+, OH−, HOOH, and OOH−;

an anhydride or oxide capable of undergo a hydration reaction comprising an element, metal, alloy, or mixture such as one from the group of Mo, Ti, Zr, Si, Al, Ni, Fe, Ta, V, B, Nb, Se, Te, W, Cr, Mn, Hf, Co, and Mg, Li2MoO3, Li2MoO4, Li2TiO3, Li2ZrO3, Li2SiO3, LiAlO2, LiNiO2, LiFeO2, LiTaO3, LiVO3, Li₂VO₃, Li2B4O7, Li2NbO3, Li2SeO3, Li2SeO4, Li2TeO3, Li2TeO4, Li2WO4, Li2CrO4, Li2Cr2O7, Li2MnO4, Li2HfO3, LiCoO2, and MO wherein M is metal such as an alkaline earth metal such as Mg of MgO, As2O3, As2O5, Sb2O3, Sb2O4, Sb2O5, Bi2O3, SO2, SO3, CO, CO2, NO2, N2O3, N2O5, Cl2O7, PO2, P2O3, and P2O5;

a hydride such as one from the group of R—Ni, La2Co1Ni9H6, La2Co1Ni9H6, ZrCr2H3.8, LaNi3.55Mn0.4Al0.3Co0.75, ZrMn0.5Cr0.2V0.1Ni1.2, and other alloys capable of storing hydrogen such as one chosen from MmNi5 (Mm=misch metal) such as MmNi3.5Co0.7Al0.8, AB5 (LaCePrNdNiCoMnAl) or AB2 (VTiZrNiCrCoMnAlSn) type, where the “ABx” designation refers to the ratio of the A type elements (LaCePrNd or TiZr) to that of the B type elements (VNiCrCoMnAlSn), ABS-type, MmNi3.2Co1.0Mn0.6Al0.11Mo0.09 (Mm=misch metal: 25 wt % La, 50 wt % Ce, 7 wt % Pr, 18 wt % Nd), La1-yRyNi5-xMx, AB2-type: Ti0.51Zr0.49V0.70Ni1.18Cr0.12 alloys, magnesium-based alloys, Mg1.9Al0.1Ni0.8Co0.1Mn0.1 alloy, Mg0.72Sc0.28(Pd0.012+Rh0.012), and Mg80Ti20, Mg80V20, La0.8Nd0.2Ni2.4Co2.5Si0.1, LaNi5-xMx (M=Mn, Al), (M=Al, Si, Cu), (M=Sn), (M=Al, Mn, Cu) and LaNi4Co, MmNi3.55Mn0.44Al0.3Co0.75, LaNi3.55Mn0.44Al0.3Co0.75, MgCu2, MgZn2, MgNi2, AB compounds, TiFe, TiCo, and TiNi, ABn compounds (n=5, 2, or 1), AB3-4 compounds, ABx (A=La, Ce, Mn, Mg; B=Ni, Mn, Co, Al), ZrFe2, Zr0.5Cs0.5Fe2, Zr0.8Sc0.2Fe2, YNi5, LaNi5, LaNi4.5Co0.5, (Ce, La, Nd, Pr)Ni5, Mischmetal-nickel alloy, Ti0.98Zr0.02V0.43Fe0.09Cr0.05Mn1.5, La2Co1Ni9, FeNi, TiMn2, TiFeH2, a species of a M-N—H system such as LiNH2, Li2NH, or Li3N, and a alkali metal hydride further comprising boron such as borohydrides or aluminum such as aluminohydides, alkaline earth metal hydrides such as MgH2, metal alloy hydrides such as BaReH9, LaNi5H6, FeTiH1.7, and MgNiH4, metal borohydrides such as Be(BH4)2, Mg(BH4)2, Ca(BH4)2, Zn(BH4)2, Sc(BH4)3, Ti(BH4)3, Mn(BH4)2, Zr(BH4)4, NaBH4, LiBH4, KBH4, and Al(BH4)3, AlH3, NaAlH4, Na3AlH6, LiAlH4, Li3AlH6, LiH, LaNi5H6, La2Co1Ni9H6, and TiFeH2, NH3BH3, hydride metals or semi-metals comprising alkali metals (Na, K, Rb, Cs), alkaline earth metals (Mg, Ca, Ba, Sr), elements from the Group IIIA such as B, Al, Ga, Sb, from the Group IVA such as C, Si, Ge, Sn, and from the Group VA such as N, P, As, transition metal alloys and intermetallic compounds ABn, in which A represents one or more element(s) capable of forming a stable hydride and B is an element that forms an unstable hydride, intermetallic compounds given in TABLE 2, intermetallic compounds wherein part of sites A and/or sites B are substituted with another element such as for M representing LaNiS, the intermetallic alloy may be represented by LaNi5-xAx, where A is, for example, Al, Cu, Fe, Mn, and/or Co, and La may be substituted with Mischmetal, a mixture of rare earth metals containing 30% to 70% of cerium, neodymium and very small amounts of elements from the same series, the remainder being lanthanum, an alloy such as Li3Mg, K3Mg, Na3Mg that forms a mixed hydride such as MMgH3 (M=alkali metal), polyaminoborane, amine borane complexes such as amine borane, boron hydride ammoniates, hydrazine-borane complexes, diborane diammoniate, borazine, and ammonium octahydrotriborates or tetrahydroborates, imidazolium ionic liquids such as alkyl(aryl)-3-methylimidazolium N-bis(trifluoromethanesulfonyl)imidate salts, phosphonium borate, and carbonite substances.

Further exemplary compounds are ammonia borane, alkali ammonia borane such as lithium ammonia borane, and borane alkyl amine complex such as borane dimethylamine complex, borane trimethylamine complex, and amino boranes and borane amines such as aminodiborane, n-dimethylaminodiborane, tris(dimethylamino)borane, di-n-butylboronamine, dimethylaminoborane, trimethylaminoborane, ammonia-trimethylborane, and triethylaminoborane. Further suitable hydrogen storage materials are organic liquids with absorbed hydrogen such as carbazole and derivatives such as 9-(2-ethylhexyl)carbazole, 9-ethylcarbazole, 9-phenylcarbazole, 9-methylcarbazole, and 4,4′-bis(N-carbazolyl)-1,1′-biphenyl;

TABLE 2
Elements and combinations that form hydrides.

| A | B | | ABn |
|---|---|---|---|
| Mg, Zr | Ni, Fe, Co | /2 | Mg2Ni, Mg2Co, |
| | | | Zr2Fe |
| Ti, Zr | Ni, Fe | | TiNi, TiFe, ZrNi |
| La, Zr, Ti, Y, Ln | V, Cr, Mn, Fe, Ni | | LaNi2, YNi2, |
| | | | YMn2, ZrCr2, ZrMn2, |
| | | | ZrV2, TiMn2 |
| La, Ln, Y, Mg | Ni, Co | | LnCo3, YNi3, |
| | | | LaMg2Ni9 |
| La, rare earths | Ni, Cu, Co, Pt | | LaNi5, LaCo5, |
| | | | LaCu5, LaPt5 |

a hydrogen permeable membrane such as Ni(H2), V(H2), Ti(H2), Fe(H2), or Nb(H2);

a compound comprising at least one of oxygen and hydrogen such as one of the disclosure wherein other metals may replaced the metals of the disclosure, M may also be another cation such as an alkaline earth, transition, inner transition, or rare earth metal cation, or a Group 13 to 16 cation such as Al, Ga, In, Sn, Pb, Bi, and Te, and the metal may be one of the molten metal such as at least one of silver and copper, and other such sources of at least one of hydrogen and oxygen such as ones known by those skilled in the art. In an embodiment, at least one of the energy released by the hydrino reaction and the voltage applied across the electrodes is sufficient to break the oxygen bonding of the source of oxygen to release oxygen. The voltage may be in at least one range of about 0.1 V to 30V, 0.5 V to 4V, and 0.5 V to 2V. In an embodiment, the source of oxygen is more stable than the hydrogen reduction products such as water and the source of oxygen that comprises less oxygen. The hydrogen reduction products may react with water to form the source of oxygen. The reduced source of oxygen may react at least one of water and oxygen to maintain a low concentration of these oxidants in the reaction cell chamber 5b31. The reduced source of oxygen may maintain the dome 5b4. In an exemplary embodiment comprising a W dome and a highly stable oxide such as Na₂O, the reduced source of oxygen is Na metal vapor that reacts with both H₂O and O₂ to scavenge these gases from the reaction cell chamber. The Na may also reduce W oxide on the dome to W to maintain it from corrosion.

Exemplary sources of oxygen such as one with a suitable melting and boiling point capable of being dissolved or mixed into the melt such as molten silver are at least one selected from the group of NaReO4, NaOH, NaBrO3, B2O3, PtO2, MnO2, Na5P3O10, NaVO3, Sb2O3, Na2MoO4, V2O5, Na2WO4, Li2MoO4, Li2CO3, TeO2, Li2WO4, Na2B4O7, Na2CrO4, Bi2O3, LiBO2, Li2SO4, Na2CO3, Na2SO4, K2CO3, K2MoO4, K2WO4, Li2B4O7, KBO2, NaBO2, Na4P2O7, CoMoO4, SrMoO4, Bi4Ge3O12, K2SO4, Mn2O3, GeO2, Na2SiO3, Na2O, Li3PO4, SrNb2O6, Cu2O, LiSiO4, LiNbO3, CuO, Co2SiO4, BaCrO4, BaSi2O5, NaNbO3, Li2O, BaMoO4, BaNbO3, WO3, BaWO4, SrCO3, CoTiO3, CoWO4, LiVO3, Li₂VO₃, Li2ZrO3, LiMn2O4, LiGaO2, Mn3O4, Ba(BO2)2*H2O, Na3VO4, LiMnO4, K2B4O7*4H2O, and NaO2.

In an embodiment, the source of oxygen such as peroxide such as Na₂O₂, the source of hydrogen such as a hydride or hydrogen gas such as argon/H₂ (3% to 5%), and a conductive matrix such molten silver may serve as a solid fuel to form hydrinos. The reaction may be run in an inert vessel such as an alkaline earth oxide vessel such as an MgO vessel.

The additive may further comprise the compound or element formed by hydrogen reduction of the source of oxygen. The reduced source of oxygen may form the source of oxygen such as the oxide by reaction with at least one of excess oxygen and water in the reaction cell chamber 5b31. At least one of the source of oxygen and reduced source of oxygen may comprise a weight percentage of the injected melt comprising at least two of the molten metal such as silver, the source of oxygen such as borax, and the reduced source of oxygen that maximizes the hydrino reaction rate. The weight percentage of at least one of the source of oxygen and the reduced source of oxygen may be in at least one weight percentage range of about 0.01 wt % to 50 wt %, 0.1 wt % to 40 wt %, 0.1 wt % to 30 wt %, 0.1 wt % to 20 wt %, 0.1 wt % to 10 wt %, 1 wt % to 10 wt %, and 1 wt % to 5 wt %. The reaction cell chamber gas may comprise a mixture of gases. The mixture may comprise a noble gas such as argon and hydrogen. The reaction cell chamber 5b31 may be maintained under an atmosphere comprising a partial pressure of hydrogen. The hydrogen pressure may be in at least one range of about 0.01 Torr to 10,000 Torr, 0.1 Torr to 1000 Torr, 1 Torr to 100 Torr, and 1 Torr to 10 Torr. The noble gas such as argon pressure may be in at least one range of about 0.1 Torr to 100,000 Torr, 1 Torr to 10,00 Torr, and 10 Torr to 1000 Torr. The source of oxygen may undergo reaction with the hydrogen to form H₂O. The H₂O may serve as HOH catalyst to form hydrinos. The source of oxygen may be thermodynamically unfavorable to hydrogen reduction. The HOH may form during ignition such as in the plasma. The reduced product may react with water formed during ignition. The water reaction may maintain the water in the reaction cell chamber 5b31 at low levels. The low water levels may be in at least one range of about less than 40 Torr, less than 30 Torr, less than 20 Torr, less than 10 Torr, less than 5 Torr, and less than 1 Torr. The low water vapor pressure in the reaction cell chamber may protect at least one cell component such as the dome 5b4 such as a W or graphite dome from undergoing corrosion. The tungsten oxide as the source of oxygen could participate in a tungsten cycle to maintain a tungsten dome 5b4 against corrosion. The balance of the oxygen and tungsten inventory may stay near constant. Any tungsten oxide corrosion product by reaction of the oxygen from the tungsten oxide with tungsten metal may be replaced by tungsten metal from tungsten oxide that was reduced to provide the oxygen reactant.

The additive may comprise a compound to enhance the solubility of another additive such as the source of oxygen. The compound may comprise a dispersant. The compound may comprise a flux. The generator may further comprise a stirrer to mix the molten metal such as silver with the additive such as the source of oxygen. The stirrer may comprise at least one of a mechanical, pneumatic, magnetic, electromagnetic such as one that uses a Lorentz force, piezoelectric, and other stirrers known in the art. The stirrer may comprise a sonicator such as an ultrasonic sonicator. The stirrer may comprise an electromagnetic pump. The stirrer may comprise at least one of the electrode electromagnetic pump and the injection electromagnetic pump 5ka. The stirring may occur in a cell component that holds the melt such as at least one of the reservoir and EM pump. The melt composition may be adjusted to increase the solubility of the additive. The melt may comprise at least one of silver, silver-copper alloy, and copper wherein the melt composition may be adjusted to increase the solubility of the additive. The compound that increases the solubility may comprise a gas. The gas may have a reversible reaction with the additive such as the source of oxygen. The reversible reaction may enhance the solubility of the source of oxygen. In an exemplary embodiment, the gas comprises at least one of CO and CO₂. An exemplary reversible reaction is the reaction of CO₂ and an oxide such as an alkali oxide such as Li₂O to form the carbonate. In another embodiment, the reaction comprises the reaction of the reduction products of the source of oxygen such as the metal and water of a metal oxide such as an alkali oxide such as Li₂O or Na₂O, a transition metal oxide such as CuO, and bismuth oxide.

In an exemplary embodiment, the melt or injected molten metal comprises molten silver and at least one of LiVO₃ and M₂O (M=Li or Na) in at least one concentration range of about 0.1 to 5 mol %, 1 to 3 mol %, and 1.5 to 2.5 mol %. The reaction cell chamber 5b31 gas comprises an inert gas such as argon with hydrogen gas maintained in at least one range of about 1 to 10%, 2 to 5%, and 3 to 5%. The consumed hydrogen may be replaced by supplying hydrogen to the cell chamber 5b3 or 5b31 a while monitoring at least one of the hydrogen partial pressure and the total pressure such as in the cell chamber wherein the hydrogen pressure may be inferred from the total pressure due to the inert nature and constancy of the argon gas inventory. The hydrogen add back rate may be in at least one range of about 0.00001 moles/s to 0.01 moles/s, 0.00005 moles/s to 0.001 moles/s, and 0.0001 moles/s to 0.001 moles/s. The blackbody radiator 5b4 may comprise W or carbon. The blackbody radiator 5b4 may comprise metal cloth or weave such as one comprising tungsten comprising fine tungsten filaments wherein the weave density is permeable to gases, but prevents silver vapor from permeating from inside the reaction cell chamber to the cell chamber. At least one of the reservoir 5c and EM pump components such as the pump tube 5k6 may comprise at least one of niobium, molybdenum, tantalum, tungsten, rhenium, titanium, vanadium, chromium, zirconium, hafnium, ruthenium, rhodium, osmium and iridium. The components may be joined by at least one joining or fabrication technique of the group of sintering powder welds, laser welds, electron beam welding, electric discharge machining, casting, using treaded joints, using Swageloks comprising refractory materials, using alloying agents such as rhenium, titanium and zirconium (TZM) for Mo, and electroplating joining. In an embodiment comprising a refractory metal, the section of the pump tube 5k6 at the EM pump bus bars 5k2 may be machined from a solid piece or cast by means such as power sintering cast. The section may comprise an inlet and outlet tube for adjoining the corresponding inlet and nozzle portion of the pump tube. The joining may be by means of the disclosure. The adjoined pipe sections may be electron beam welded as straight sections and then bent to form the pump loop. The pump tube inlet portion from the reservoir and the nozzle portion may be abutted to the bottom of the reservoir and passed through the bottom, respectively. The tube may be welded at each penetration of the bottom of the reservoir by electron beam welding.

In an embodiment, threaded refractory metal cell component pieces are sealed together using O-rings such as refractory metal or material O-rings. The threaded connecting pieces may join at a flat and knife-edge pairs wherein the knife-edge compresses the O-ring. Exemplary refractory metals or materials are those of the disclosure such as W, Ta, Nb, Mo, and WC. In an embodiment, parts of the cell such as parts of the EM pump such as at least one of the pump tube nozzle 5q, the pump tube 5k6 inlet and outlet of the reservoir 5c, and the reservoir 5c, the cone reservoir 5b, and the dome 5b4 may be connected to the contiguous part by at least one of threads, O-rings, VCR-type fittings, flare and compression fittings, and Swagelok fittings or Swagelok-type fittings. At least one of the fittings and O-rings may comprise a refractory material such as W. At least one of the O-rings, compression ring of the VCR-type fittings, Swagelok fittings, or Swagelok-type fittings may comprise a softer refractory material such as Ta or graphite. At least one of the cell parts and fittings may comprise at least one of Ta, W, Mo, W—La₂O₃ alloy, Mo, TZM, and niobium (Nb). The part such as the dome 5b4 may be machined from solid W or W-lanthanum oxide alloy. The part such as the blackbody radiator 5b4 such as a W dome may be formed by selective laser melting (SLM).

In an embodiment, the generator further comprises a cell chamber capable of pressures below atmospheric, atmospheric, and above atmospheric that houses the dome 5b4 and corresponding reaction cell chamber 5b31. The cell chamber 5b3 housing and the lower chamber 5b5 housing may be in continuity. Alternatively, the lower chamber 5b5 may be separate having its own pressure control system that may be operated at a different pressure than the cell chamber such as atmospheric pressure or vacuum. The separator of the cell chamber 5b3 and the lower chamber 5b5 may comprise a plate at the top 5b81 or bottom 5b8 of the reservoir 5c. The plate 5b8 may be fastened to the reservoir by threads between the plate 5b81 or 5b8 and the reservoir 5c. At least one of the threaded blackbody radiator and the reservoirs with base plates may be machine as single pieces from forged tungsten. The pressed tungsten electromagnetic pump bus bars 5k2 may be sinter welded to the pump tube wall indentation by applying tungsten powder that forms a sinter weld during operation at high temperature. The use of a refractory material such as tungsten for the cell components may avoid the necessity of having a thermal barrier such as a thermal insulator such as SiC between the blackbody radiator and the reservoir or between the reservoir and the EM pump.

In an embodiment, the reaction cell chamber 5b31 may comprise a silver boiler. In an embodiment, the vapor pressure of the molten metal such as silver is allowed to about reach equilibrium at the operating temperature such that the process of metal evaporation about ceases and power loss to silver vaporization and condensation with heat rejection is about eliminated. Exemplary silver vapor pressures at operating temperatures of 3000K and 3500K are 10 atm and 46 atm, respectively. The maintenance of the equilibrium silver vapor pressure at the cell operating temperature comprises a stable means to maintain the cell pressure with refluxing liquid silver during cell power generation operation. Since the dome 5b4 may rupture at the high pressure and temperature, in an embodiment, the pressure in the cell chamber 5b3 is matched to the pressure in the reaction cell chamber 5b31 such that essentially no net pressure differential exists across the blackbody radiator 5b4. In an embodiment, a slight excess pressure such as in the range of about 1 mTorr to 100 Torr may be maintained in the reaction cell chamber 5b31 to prevent creep of a tungsten dome blackbody radiator 5b4 such as creep against the force of gravity. In an embodiment creep may be suppressed by the addition of a stabilizing additive to the metal of the blackbody radiator 5b4. In an embodiment, tungsten is doped with an additive such as small amounts of at least one of K, Re, CeO₂, HfC, Y₂O₃, HfO₂, La₂O₃, ZrO₂, Al₂O₃, SiO₂, and K₂O to reduce creep. The additive may be in any desirable amount such as in a range of 1 ppm to 10 wt %.

In an embodiment of the reaction cell chamber 5b31 operated as a silver boiler, the cell components such as the blackbody radiator 5b4 and reservoir 5c comprise a refractory material such as tungsten or carbon and boron nitride, respectively. In a startup mode, the reservoir 5c may be heated to sufficient temperature with a heater such as the inductively coupled heater 5m to cause metal vapor pressure such as silver metal vapor pressure to heat the blackbody radiator 5b4. The temperature may be above the melting point of silver when the EM pump and electrodes are activated to cause pumping and ignition. In an embodiment, a source of oxygen such as an oxide such as LiVO₃ may be coated on the blackbody radiator 5b4 wall to be incorporated into the melt as the metal vapor refluxes during warm up during the startup.

In an embodiment, the hydrino reaction is maintained by silver vapor that serves as the conductive matrix. At least one of continuous injection wherein at least a portion becomes vapor and direct boiling of the silver from the reservoir may provide the silver vapor. The electrodes may provide high current to the reaction to remove electrons and initiate the hydrino reaction. The heat from the hydrino reaction may assist in providing metal vapor such as silver metal vapor to the reaction cell chamber. In an embodiment, the current through the electrodes may be at least partially diverted to alternative or supplementary electrodes in contact with the plasma. The current diversion may occur after the pressure of the silver vapor becomes sufficiently high such that the silver vapor at least partially serves as the conductive matrix. The alternative or supplementary electrodes in contact with the plasma may comprise one or more center electrodes and counter electrodes about the perimeter of the reaction cell chamber. The cell wall may serve as an electrode.

In an embodiment, the PV converter 26a is contained in an outer pressure vessel 5b3a having an outer chamber 5b3a1 (FIGS. 2I80-2I94). The outer pressure vessel may have any desirable geometrical shape that contains the PV converter and inner cell components comprising the source of light to illuminate the PV converter. The outer chamber may comprise a cylindrical body with at least one domed end cap. The outer pressure vessel may comprise a dome or spherical geometry or other suitable geometry capable of containing the PV converter and dome 5b4 and capable of maintaining a pressure of at least one of less than, equal to, or greater than vacuum. In an embodiment, the PV converter 26a comprising PV cells, cold plates, and cooling system are located inside of the outer pressure vessel wherein electrical and coolant lines penetrate the vessel through sealed penetrations and feed-throughs such as one of those of the disclosure. In an embodiment, the outer pressure vessel may comprise a cylindrical body that may comprise at least one dome top. In an embodiment, the generator may comprise a cylindrical chamber that may have a domed cap to house the blackbody radiator 5b4 and the PV converter 26a. The generator may comprise a top chamber to house the PV converter and a bottom chamber to house to the electromagnetic pump. The chambers may be operated at the same or different pressures.

In an embodiment, the outer pressure vessel comprises the PV converter support such as the PV dome that forms the cell chamber 5b3 that contains the dome 5b4 that encloses the reaction cell chamber 5b3. The outer pressure vessel may comprise a dome or spherical geometry or other suitable geometry capable of containing the dome 5b4 and capable of maintaining a pressure of at least one of less than, equal to, or greater than vacuum. In an embodiment, the PV cells 15 are on the inside of the outer pressure vessel wall such as a spherical dome wall, and the cold plates and cooling system are on the outside of the wall. Electrical connections may penetrate the vessel through sealed penetrations and feed-throughs such as one of those of the disclosure. Heat transfer may occur across the wall that may be thermally conductive. A suitable wall material comprises a metal such as copper, stainless steel, or aluminum. The PV window on the inside of the PV cells may comprise transparent sections that may be joined by an adhesive such as silicon adhesive to form a gas tight transparent window. The window may protect the PV cell from gases that redeposit metal vaporized from the dome 5b4 back to the dome. The gases may comprise those of the halogen cycle. The pressure vessel PV vessel such as a domed vessel may seal to a separator plate 5b81 or 5b8 between an upper and lower chamber or other chamber by a ConFlat or other such flange seal. The upper chamber may contain the blackbody radiator 5b4 and PV cells 15, and the lower chamber may contain the EM pump. The lower chamber may further comprise lower chamber cold plates or cooling lines 5b6a (FIG. 2I89).

Tungsten's melting point of 3422° C. is the highest of all metals and second only to carbon (3550° C.) among the elements. Refractory ceramics and alloys have higher melting points, notably Ta₄HfC₅TaX₄HfC X₅ with a melting point of 4215° C., hafnium carbide at 3900° C., and tantalum carbide at 3800 C. In embodiment cell components such as the blackbody radiator 5b4 and reservoir 5c may comprise a refractory material such as at least one of W, C, and a refractory ceramic or alloy. In an embodiment wherein the blackbody radiator comprises graphite, the cell chamber 5b3 contains a high-pressure gas such as a high-pressure inert gas atmosphere that suppress the sublimation of graphic.

In an embodiment, the blackbody radiator may comprise carbon. The carbon sublimed from a graphite blackbody radiator such as a spherical graphite blackbody radiator may be removed from the cell chamber 5b3 by electrostatic precipitation (ESP). The ESP system may comprise an anode, a cathode, a power supply, and a controller. The particles may be charged by one electrode and collected by another counter electrode. The collected soot may be dislodged from the collection electrode and caused to drop into a collection bin. The dislodging may be achieved by a mechanical system. In an embodiment, the inner wall of the transparent vessel may be charged negative and the dome may be charged positive with an applied source of voltage. Negatively charged carbon particles that sublime from the graphite blackbody radiator 5b4 may migrate back to the dome under the influence of the field between the wall and the blackbody radiator 5b4. In an embodiment, the carbon may be removed by active transport such a by flowing gas through the cell chamber 53b and then a carbon particle filter.

In an embodiment, the dome 5b4 may comprise graphite, and the reservoir may comprise a refractory material such as boron nitride. The graphite may comprise isotropic graphite. The graphite of components of the disclosure may comprise glassy carbon as given in Compressed glassy carbon: An ultrastrong and elastic interpenetrating graphene network, Science Advances 9 Jun. 2017: Vol. 3, no. 6, e1603213 DOI: 10.1126/scialv.1603213, http://advances.sciencemag.org/content/3/6/e1603213.full which is herein incorpated by reference. In an embodiment, the graphite blackbody radiator such as a spherical dome may comprise a liner to prevent the molten metal inside of the reaction cell chamber 5b31 from eroding the graphite. The liner may comprise a refractory material such as tungsten. The liner may comprise a mesh or sheet that is formed to the inside of the graphite dome. The liner may prevent shear forces of flowing molten metal from eroding the inner surface of the reaction cell chamber.

The PV converter may comprise PV cells each with a window that may comprise at least one thermophotovoltaic filter such as an infrared filter. The filter may preferentially reflect light having wavelengths that are not converted to electricity by the PV converter. The cells of the PV converter may be mirrored on the backside to reflect light that passed through the cells back to the blackbody radiator. The mirror may be selective for infrared light that is not converted to electricity by the PV cells. The infrared mirror may comprise a metal. The back of the cells may be metalized. The metal may comprise an infrared reflector such as gold. The metal may be attached to the semiconductor substrate of the PV cell by contract points. The contract points may be distributed over the back of the cells. The points may comprise a bonding material such as Ti—Au alloy or Cr—Au alloy. The PV cells may comprise at least one junction. Representative cells to operate at 3500 K comprise GaAs on GaAs substrate or InAlGaAs on InP or GaAs substrate as a single junction cell and InAlGaAs on InP or GaAs substrate as a double junction cell. Representative cells to operate at 3000 K comprise GaAs on GaAs substrate or InAlGaAs on InP or GaAs substrate as a single junction cell and InAlGaAs on InP or GaAs substrate as a double junction cell.

In an embodiment, the geodesic PV converter 26 of the blackbody radiator 5b4 may comprise and optical distribution system 23 such as one of the disclosure (FIG. 2I132). The optical distribution system 23 may split the light into different wavelength regions. The splitting may be achieved by at least one of mirrors and filters such as those of the disclosure. The slit light may be incident corresponding PV cell 15 selective to the split and incident light. The optical distribution system 23 may be arranged as columns projecting outward from the geodesic sphere surrounding the spherical blackbody radiator 5b4.

The generator may comprise a precise gas pressure sensing and control system for at least one of the cell chamber and reaction cell chamber pressures. The system of the disclosure may comprise gas tanks and lines such as at least one of hydrogen and noble gas tanks and lines such as 5u and 5ual. The gas system may further comprise pressure sensors, a manifold, inlet lines, feed-throughs, an injector, an injector valve, a vacuum pump such as 13a, a vacuum pump line such as 13b, control valves, and lines and feed-throughs. A noble gas such as argon or xenon may be added to the cell chamber 5b3 or 5b3a1 to match the pressure in the reaction cell chamber 5b31. The reaction cell chamber pressure may be measured by measuring the blackbody temperature and using the relationship between metal vapor pressure and temperature. The temperature of the dome may be measured using its blackbody spectral emission. The temperature may be measured using an optical pyrometer that may use an optical fiber to collect and transport the light to the sensor. The temperature may be measured by a plurality of diodes that may have filters selective to sample portions of the blackbody curve to determine the temperature. The cell component such as the reservoir 5c may comprise a refractory material such as at least one of alumina, sapphire, boron nitride, and silicon carbide that is at least partially transparent to at least one of visible and infrared light. The component such as the reservoir such as a boron nitride reservoir may comprise recesses or thinned spots in the component to better permit the light to pass through the component to the optical temperature sensor.

In addition to a noble gas, the gas in at least one of the outer pressure vessel chamber 5b3a1, the cell chamber 5b3 may also comprise hydrogen. The hydrogen supplied to the at least one chamber by tank, lines, valves, and injector may diffuse through a cell component that is hydrogen permeable at the cell operating temperature to replace that consumed to form hydrinos. The hydrogen may permeate the blackbody radiator 5b4. The hydrino gas product may diffuse out of the chambers such as 5b3 or 5b3a1 and 5b31 to ambient atmosphere or to a collection system. Alternatively, hydrino gas product may be selectively pumped out of at least one chamber. In another embodiment, the hydrino gas may be collected in getter that may be periodically replaced or regenerated.

In an embodiment, the gas of the chamber enclosing the W blackbody radiator may further comprise a halogen source such as I₂ or Br₂ or a hydrocarbon bromine compound that forms a complex with subliming tungsten. The complex may decompose on the hot tungsten dome surface to redeposit the tungsten on the blackbody radiator 5b4. Some dome refractory metal such as W may be added to the molten metal such as silver to be vaporized and deposited on the inner dome surface to replace evaporated or sublimed metal.

In an embodiment, the cell further comprises a hydrogen supply to the reaction cell chamber. The supply may penetrate the cell through at least one of the EM pump tube, the reservoir, and the blackbody radiator. The supply may comprise a refractory material such as at least one of W and Ta. The supply may comprise a hydrogen permeable membrane such as one comprising a refractory material. The hydrogen supply may penetrate a region of the cell that is lower in temperature than that of the blackbody radiator. The supply may penetrate the cell at the EM pump tube or reservoir. The supply may comprise a hydrogen permeable membrane that is stable at the operating temperature of the molten silver in the EM pump tube or reservoir. The hydrogen permeable membrane may comprise Ta, Pt, Ir, Pd, Nb, Ni, Ti or other suitable hydrogen permeable metal with suitable melting point know to those skilled in the art.

In an embodiment, at least one outer chamber or chamber external to the reaction cell chamber 5b31 is pressurized to an external pressure of about the inside pressure of the reaction cell chamber at the operating temperature of the reaction cell chamber and blackbody radiator. The external pressure may match the inside pressure to within a range of about plus of minus 0.01% to plus minus 500%. In an exemplary embodiment, the external pressure of at least one chamber of one vessel external the blackbody radiator and the reaction cell chamber is about 10 atm to match the 10 atm silver vapor pressure of the reaction cell chamber at an operating temperature of about 3000K. The blackbody radiator is capable of supporting the external pressure differential that decreases as the blackbody radiator temperature increase to the operating temperature.

In an embodiment shown in FIGS. 2I80-2I103, the SunCell® comprises an outer pressure vessel 5b3a having a chamber 5b3a1 that contains the PV converter 26a, the blackbody radiator 5b4, the reservoir 5c, and the EM pump. The walls of the outer pressure vessel 5b3a may be water-cooled by coolant lines, cold plates, or heat exchanger 5b6a. SunCell® components such as the walls of the outer pressure vessel 5b3a may comprise a heat or radiation shield to assist with cooling. The shield may have a low emissivity to reflect heat. The outer pressure vessel 5b3a may comprise heat exchanger fins on the outside. The fins may comprise a high thermal conductor such as copper or aluminum. The generator may further comprise a means to provide forced convection heat transfer from the heat fins. The means may comprise a fan or blower that may be located in the housing under the pressure vessel. The fan or blower may force air upwards over the fins. The outer pressure vessel may comprise a section such as a cylindrical section to contain and mount cell components such as the PV converter 26a, the blackbody radiator 5b4, the reservoir 5c, and the EM pump assembly 5ka. The connections to mount and support cell components comprise means to accommodate different rates or amounts of thermal expansion between the components and the mounts and supports such that expansion damage is avoided. The mounts and supports may comprise at least one of expansion joints and expandable connectors or fasteners such as washers and bushings. The connectors and fasteners may comprise compressible carbon such as Graphoil or Perma-Foil (Toyo Tanso) or ones comprised of hexagonal boron nitride. The gasket may comprise pressed MoS₂, WS₂, Celmet™ such as one comprising Co, Ni, or Ti such as porous Ni C6NC (Sumitomo Electric), cloth or tape such as one comprising ceramic fibers comprising high alumina and refractory oxides such as Cotronics Corporation Ultra Temp 391, or another material of the disclosure. In an embodiment, the electrical, gas, sensor, control, and cooling lines may penetrate the bottom of the outer pressure vessel 5b3a. The outer pressure vessel may comprise a cylindrical and dome housing and a baseplate 5b3b to which the housing seals. The housing may comprise carbon fiber, or stainless steel or steel that is coated. The coating may comprise nickel plating. The housing may be removable for easy access to the internal SunCell® components. The baseplate 5b3b may comprise the feed throughs of the at least one of the electrical, gas, sensor, control, and cooling lines. The feed through may be pressure tight and electrically isolating in the case that the lines can electrically short to the housing. In an embodiment, the PV converter cooling system comprises a manifold with branches to the cold plates of the elements such as triangular elements of the dense receiver array. The baseplate feed throughs may comprise i.) Ignition bus bar connectors 10a2 connected to the source of electrical power 2 such as one comprising an ignition capacitor bank in housing 90 that may further comprise DC to DC converters powered by the PV converter 26a output, and 10a2 further connected to feed throughs 10a for the ignition bus bars 9 and 10 that penetrate the baseplate at ignition bus bar feed through assembly 10a1 (exemplary ignition voltage and current are about 50 V DC and 50 to 100 A), ii.) EM pump bus bar connectors 5k33 connected to EM power supplies 5k13 and further connected to EM pump feed throughs 5k31 that penetrate the baseplate at EM pump bus bar feed through flange 5k33; the power supplies 5k13 may comprise DC to DC converters powered by the PV converter 26a output (exemplary EM pump voltage and current are about 0.5 to 1 V DC and 100 to 500 A), iii.) inductively coupled heater antenna feed through assemblies 5mc wherein the antenna are powered by inductively couple heater power supply 5m that may comprise DC to DC converters powered by the PV converter 26a output, a transformer, at least one IGBT, and a radio frequency transmitter (exemplary inductively coupled heater frequency, voltage, and current are about 15 kHz, 250 V AC or DC equivalent, and 100 to 300 A), iv.) penetrations 5h1 and 5h3 for the hydrogen gas line 5ua and argon gas line 5ua1, connected to the hydrogen tank 5u and argon tank 5u1, respectively, v.) penetrations for the EM pump coolant lines 31d and 31e connected to heat exchanger coolant line 5k11 wherein the coolant line 5k11 and EM pump cold plate 5k12 of the EM pump heat exchangers 5k1 may each comprise one piece that spans the two heat exchangers 5k1, vi.) penetrations for the PV coolant lines 31b and 31c, and vii.) penetrations for the power flow from the PV converter 26a to the power conditioner or inverter 110. The inlet coolant lines such as 31e are connected to the radiator inlet line 31t and outlet coolant lines such as 31d are connected to water pump outlet 31u. In addition to the radiator 31, the generator is cooled by air fan 31j1. In an embodiment, the PV converter 26a comprises lower and an upper hemispherical pieces that fasten together to fit around the blackbody radiator 5b4. The PV cells may each comprise a window on the PV cell. The PV converter may rest on a PV converter support plate 5b81. The support plate may be suspended to avoid a contact with the blackbody radiator or reservoir and may be perforated to allow for gas exchange between the entire outer pressure vessel. The hemisphere such as the lower hemisphere may comprise mirrors about a portion of the area such as the bottom portion to reflect light to PV cells of the PV converter. The mirrors may accommodate any mismatch between an ideal geodesic dome to receive light from the blackbody radiator and that which may be formed of the PV elements. The non-ideality may be due to space limitations of fitting PV elements about the blackbody radiator due to the geometry of the PV elements that comprise the geodesic dome.

An exemplary PV converter may comprise a geodesic dome comprised of an array modular triangular elements each comprising a plurality of concentrator PC cells and backing cold plates. The elements may snap together. The exemplary array may comprise a pentakis dodecahedron. The exemplary array may comprise six pentagons and 16 triangles. In an embodiment, the base of the PV converter 26a may comprise reflectors in locations where triangular PV elements of the geodesic PV converter array do not fit. The reflectors may reflect incident light to at least one of another portion of the PV converter and back to the blackbody radiator. In an embodiment, the power from the base of the lower hemisphere 5b41 is at least partially recovered as at least one of light and heat. In an embodiment, the PV converter 26a comprises a collar of PV cells around the base of the lower hemisphere 5b41. In an embodiment, the power is collected as heat by a heat exchanger such as a heat pipe. The heat may be used for cooling. The heat may be supplied to an absorption chiller known by those skilled in the art to achieve the cooling.

In an embodiment, the footprint of the cooling system such as at least one of a chiller and a radiator may be reduced by allowing the coolant such as water such as pool-filtered water to undergo a phase change. The phase change may comprise liquid to gas. The phase change may occur within the cold plates that remove heat from the PV cells. The phase change of liquid to gas may occur in microchannels of the microchannel cold plates. The coolant system may comprise a vacuum pump to reduce the pressure in at least one location in the cooling system. The phase change may be assisted by maintaining a reduced pressure in the coolant system. The reduced pressure may be maintained in the condenser section of the cooling system. At least one of the PV converter, the cold plates and the PV cells may be immersed in a coolant that undergoes a phase change such as boiling to increase the heat removal. The coolant may comprise one known in the art such as an inert coolant such as 3M Fluorinert.

In an embodiment, the coolant system may comprise multiple coolant loops. A first coolant loop may extract heat from the PV cells directly or through cold plates such as ones comprising microchannel plates. The coolant system may further comprise at least one heat exchanger. A first heat exchanger may transfer heat from the first coolant loop to another. A coolant phase change may occur in at least one of the other coolant loops. The phase change may be reversible. The phase change may increase the capacity of the coolant at a given flow rate to exchange heat to the environment and cool the PV converter. The another coolant loop may comprise a heater exchanger to transfer heat from its coolant to air. The operating parameters such as flow conditions, flow rate, pressure, temperature change, average temperature, and other parameters may be controlled in each coolant loop to control the desired heat transfer rate and the desired operating parameters within the first coolant loop such as the operating parameters of the coolant within the microchannel plates of the cold plates. Exemplary conditions in the microchannels are a temperature change range of the coolant of about 10° C. to 20° C., an average temperature of about 50° C. to 70° C., and laminar flow with avoidance of turbulent flow.

In an embodiment to decrease the size of the cooling system, the first coolant loop may be operated at an elevated temperature such as one that is as high as possible without significant degradation of PV cell performance such as one in the of 40° C. to 90° C. The temperature differential of the coolant may be smaller in the first loop than in another coolant loop. In an exemplary embodiment, the temperature differential of the coolant in the first loop may be about 10° C.; whereas, the temperature differential of the coolant in the another loop such as a secondary loop may be higher such as about 50° C. Exemplary corresponding temperature ranges are 80° C. to 90° C. and 40° C. to 90° C., respectively. A phase change may occur in at least one cooling loop to increase the heat transfer to decrease the cooling system size.

In an embodiment, the microchannel plates that cool the PV cells may be replaced by at least one of heat exchangers, heat pipes, heat transfer blocks, coolant jets, and a coolant bath such as one comprising an inert coolant such as distilled or deionized water or a dielectric liquid such as 3M Fluorinert, R134a, or Vertrel XF. In the case of water coolant, the coolant system may further comprise a water purification or treatment system to prevent the water from being excessively corrosive. The coolant may comprise an anti-corrosive agent such as one known in the art for copper. The radiator may comprise at least one of stainless steel that resists corrosion, copper, or aluminum. The coolant may comprise an anti-freeze such as at least one of Dowtherm, ethylene glycol, ammonia, and an alcohol such as at least one of methanol and ethanol. The cell may be run continuously to prevent the coolant from freezing. The coolant system may also comprise a heater to prevent the water from freezing. The PV cells may be immersed in the coolant bath. The PV cell may transfer heat from the non-illuminated side to the coolant bath. The coolant system may comprise at least one pump wherein the coolant may be circulated to absorb heat in one location of the cooling system and reject it in another location. The PV cells may be operated under at least one condition of a higher operating temperature and a higher temperature range whereby the cooling system may be reduced in size. The coolant system may comprise a condenser wherein a phase change occurs with the transfer of heat from the PV cells. The coolant system may be pressurized, atmospheric pressure or below atmospheric pressure. The pressure may be controlled to control the coolant boiling point temperature. The coolant system operated under pressure may comprise a pump having an inlet and an outlet and a pressure blow-off valve that returns coolant to the lower pressure pump inlet side wherein it is pumped through an outlet to a heat exchanger such as a radiator or chiller. In the case of a chiller, the chilled coolant may be recirculated to decrease the temperature and increase the temperature difference between the coolant PV to increase the heat transfer rate. The cooled coolant may be further pumped to the PV cell-coolant heat transfer interface to receive heat whereby the coolant may boil. The coolant system may be operated at a heat flow below the critical heat flux, the point at which enough vapor is being formed that the cooled surface is no longer continuously wetted. The coolant may be operated under sub-cooled boiling. The PV cells may be operated at a temperature that maintains sub-cooled boiling while maximizing the heat transfer rate to the ambient due to a large coolant-air heat gradient across the corresponding heat exchanger such as a radiator. An exemplary PV operating temperature is 130° C. The system may be operated to avoid film boiling. The heat exchanger between hot coolant and ambient air may comprise a radiator such as a wrap-around radiator such as one having a car radiator design. The heat exchanger may comprise at least one fan to move air. The fan may be centered. The cell may also be centered.

The PV cells may be mounted on a heat transfer medium such as heat sinks such as copper plates. The copper plates may interface at least one of a heat transfer means such as at least one of heat exchangers, heat pipes, and heat transfer blocks that transfer the heat and interface the coolant to increase the heat transfer contact area. The heat transfer means may spread the heat radially. The coolant may undergo a phase change to increase the heat transfer whereby the coolant system size may be reduced. The heat transfer means may be coated with pins to increase the surface area for heat transfer. The coolant system may comprise a means to condense the coolant and a heat rejection system such as at least one coolant circulation pump and a heat exchanger between the coolant and ambient such as a radiator which may be pressurized. In an embodiment, at least one of the radius of the PV converter, the radius of the PV cell coolant system such as the radius of at least one of the heat exchanger, heat pipes, or heat transfer blocks of PV coolant system may be increased to decrease the heat flux load to be transferred to from the PV cells to ambient in order to effectively cool the PV cells. The PV converter may comprise a shape that maintains an equal distance from the blackbody radiator 5b4. The blackbody radiator may be spherical and the PV converter may have a constant distance from the blackbody radiator to achieve a desired light intensity incident to the PV that may comprise uniform irradiation intensity.

In an embodiment, the PV converter cooling system may comprise a spherical manifold that comprises a coolant reservoir with a heat-sink studded spherical boiling surface comprising heat sinks and boiler plates on the back of the PV cells. The bolier plates may be coated with pins to increase the surface area for heat transfer. The coolant may be flowed by at least one pump. The flow may comprise spherical flow from at least one inlet at the top and at least one outlet at the bottom of the coolant reservoir. The heated coolant may be pumped through a radiator to be cooled and retuned to the reservoir. In another embodiment, the coolant may be pumped through channels in the boiler plates that are bonded to the back to the PC cells and receive heat from the PV cells.

The heat transfer plates or elements may comprise a porous metallic surface coating to such as one comprising sintered metal particles. The surface may provide a porous layer structure characterized by a pattern of inter-connected passages. The passages are correctly sized to provide numerous stable sites for vapor nucleation, hence greatly increasing the heat flux (as much as 10×) for a given difference in temperature between the surface and the coolant saturation temperature. The surface coating may also increase the critical heat flux (CHF). The surface may comprise a conductive micro-porous coating, forming micro-cavities for nucleation. An exemplary surface comprises a sintered copper micro-porous surface coating (SCMPSC, cf. Jun et al. Nuclear Engineering and Technology, 2016). The surface enhancement approaches may be used in conjunction with the short pins (also porous coated) to further increase surface area. The surface area enhancements such as porous coated pins or stubs may be cast. In an exemplary embodiment, stubs with porous surface area enhancements such as copper ones may be cast on the back of a heat transfer plate such as a copper plate.

The return flow from the radiator may be configured to provide convection on the surface of the boilerplates. A plurality of inlets may divide the coolant flow into multiple inlet jets angled tangentially on the wall of the spherical or cylindrical coolant reservoir to provide a bulk swirling motion. The motion may give rise to convective boiling at the surface, which removes the vapor bubbles from the nucleation sites, inhibiting the CHF. In an embodiment, coolants other than water may be used since boiling in the presence of enhanced nucleation sites can be increased for fluids with smaller surface tension, such as organic liquids, refrigerants, and heat transfer fluids. The coolant may be selected based on the saturation (P-T) state of a non-pressurized system. In an embodiment to achieve temperature uniformity and account to variation in convective conductance to the coolant across PV elements, each element may be cooled with the same micro-channel heat sink.

In an embodiment, the PV converter 26a may comprise a plurality of triangular receiver units (TRU), each comprising a plurality of photovoltaic cells such as front concentrator photovoltaic cells, a mounting plate, and a cooler on the back of the mounting plate. The cooler may comprise at least one of a multichannel plate, a surface supporting a coolant phase change, and a heat pipe. The triangular receiver units may be connected together to form at least a partial geodesic dome. The TRUs may further comprise interconnections of at least one of electrical connections, bus bars, and coolant channels. In an embodiment, the receiver units and the pattern of connections may comprise a geometry that reduces the complexity of the cooling system. The number of the PV converter components such as the number of triangular receiver units of a geodesic spherical PV converter may be reduced. The PV converter may comprise a plurality of sections. The sections may join together to form a partial enclosure about the blackbody radiator 5b4. At least one of the PV converter and the blackbody radiator may be multi-faceted wherein the surfaces of the blackbody radiator and the receiver units may be geometrically matched. The enclosure may be formed by at least one of triangular, square, rectangular, cylindrical, or other geometrical units. The blackbody radiator 5b4 may comprise at least one of a square, a sphere, or other desirable geometry to irradiate the units of the PV converter. In an exemplary embodiment, the enclosure may comprise five square units about the blackbody radiator 5b4 that may be spherical or square. The enclosure may further comprise receiver units to receive light from the base of the blackbody radiator. The geometry of the base units may be one that optimizes the light collection. The enclosure may comprise a combination of squares and triangles. The enclosure may comprise a top square, connected to an upper section comprising four alternating square and triangle pairs, connected to six squares as the midsection, connected to at least a partial lower section comprising four alternating square and triangle pairs connected to a partial or absent bottom square.

A schematic drawing of a triangular element of the geodesic dense receiver array of the photovoltaic converter is shown in FIG. 2I133. The PV converter 26a may comprise a dense receiver array comprised of triangular elements 200 each comprised of a plurality of concentrator photovoltaic cells 15 capable of converting the light from the blackbody radiator 5b4 into electricity. The PV cells 15 may comprise at least one of GaAs P/N cells on a GaAs N wafer, InAlGaAs on InP, and InAlGaAs on GaAs. The cells may each comprise at least one junction. The triangular element 200 may comprise a cover body 203, such as one comprising stamped Kovar sheet, a hot port 202 and a cold port 204 such as ones comprising press fit tubes, and attachment flanges 203 such as ones comprising stamped Kovar sheet for connecting contiguous triangular elements 200.

In an embodiment comprising a thermal power source, the heat exchanger 26a comprises a plurality of heat exchanger elements 200 such as triangular elements 200 shown in FIG. 2I133 each comprise a comprising a hot coolant outlet 202 and a colder coolant inlet 204 and a means to absorb the light from the blackbody radiator 5b4 and transfer the power as heat into the coolant that is flowed through the element. At least one of the coolant inlet and outlet may attach to a common water manifold. As shown in the embodiment of FIGS. 2I108-2I109, the heat exchanger system 26a further comprises a coolant pump 31k, a coolant tank 311, and a load heat exchanger such as a radiator 31 and air fan 31j1 that provides hot air to a load with air flow through the radiator. In addition to a geodesic geometry, heat exchangers of other geometries such as those known in the art are within the scope of the disclosure. An exemplary cubic geometry is shown in FIGS. 2I134 to 2I138 showing hot coolant inlet and cold outlet lines 31b and 31c, respectively, to the heat load wherein the modular flat panel heat exchanger elements 26b are absent the PV cells 15. The heat exchanger 26a may have a desired geometry that optimizes at least one of the heat transfer, size, power requirements, simplicity, and cost. In an embodiment, the area of the heat exchanger system 26a is scaled to the area of the blackbody radiator 5b4 such that the received power density is a desired one.

At least one receiver unit may be replaced or partially replaced with mirrors that at least one of reflect the blackbody radiation directly or indirectly to other receiver units or other locations on the receiver units that are covered with PV cells. The receiver unit may be populated with PV cells on the optimal high intensity illuminated areas such as a central circular area in the case of a spherical blackbody radiator 5b4 wherein non-PV-populated areas may be covered by mirrors. The cells that receive similar amounts of radiation may be connected to form an output of a desired matching current wherein the cells may be connected in series. The enclosure comprising larger area receiver units such as square receives units may each comprise a corresponding cooler or heat exchanger 26b (FIGS. 2I134-2I138). The cooler or heat exchanger 26b of each receiver unit such as a square one may comprise at least one of a coolant housing comprising at least one coolant inlet and one coolant outlet, at least one coolant distribution structure such as a flow diverter baffle such as a plate with passages, and a plurality of coolant fins mounted onto the PV cell mounting plate. The fins may be comprised of a highly thermally conductive material such as silver, copper, or aluminum. The height, spacing, and distribution of the fins may be selected to achieve a uniform temperature over the PV cell area. The cooler may be mounted to a least one of mounting plate and the PV cells by thermal epoxy. The PV cells may be protected on the front side (illuminated side) by a clover glass or window. In an embodiment, the enclosure comprising receiver units may comprise a pressure vessel. The pressure of the pressure vessel may be adjusted to at least partially balance the internal pressure of the molten metal vapor pressure inside of the reaction cell chamber 5b31.

In an embodiment (FIG. 2I143), the radius of the PV converter may be increased relative to the radius of the blackbody radiator to decrease the light intensity based on the radius-squared dependency of the light power flux. Alternatively, the light intensity may be decreased by an optical distribution system comprising a series of semitransparent mirrors 23 along the blackbody radiator ray path (FIG. 2I132) that partially reflects the incident light to PV cells 15 and further transmits a portion of the light to the next member of the series. The optical distribution system may comprise mirrors to reduce the light intensity along a radial path, a zigzag path, or other paths that are convenient for stacking a series of PV cells and mirrors to achieve the desired light intensity distribution and conversion. In an embodiment, the blackbody radiator 5b4 may have a geometry that is mated to the light distribution and PV conversion system comprising series of mirrors, lenses, or filters in combination with the corresponding PV cells. In an exemplary embodiment, the blackbody radiator may be square and to match a rectilinear light distribution and PV conversion system geometry.

The parameters of the cooling system may be selected to optimize the cost, performance, and power output of the generator. Exemplary parameters are the identity of the coolant, a phase change of the coolant, the coolant pressure, the PV temperature, the coolant temperature and temperature range, the coolant flow rate, the radius of the PV converter and coolant system relative to that of the blackbody radiator, and light recycling and wavelength band selective filters or reflectors on the front or back of the PV to reduce the amount of PV incident light that cannot be converted to electricity by the PV or to recycle that which failed to convert upon passing through the PV cells. Exemplary coolant systems are ones that perform at least one of i.) form steam at the PV cells, transport steam, and condense the steam to release heat at the exchange interface with ambient, ii.) form stream at the PV cells, condense it back to liquid, and reject heat from a single phase at the heat exchanger with ambient such as a radiator, and iii.) remove heat from the PV cells with microchannel plates and reject the heat at the heat exchanger with ambient. The coolant may remain in a single phase during cooling the PV cells.

The PV cell may be mounted to cold plates. The heat may be removed from the cold plates by coolant conduits or coolant pipes to a cooling manifold. The manifold may comprise a plurality of toroidal pipes circumferential around the PV converter that may be spaced along the vertical or z-axis of the PV converter and comprise the coolant conduits or coolant pipes coming off of it.

The blackbody radiator may comprise a plurality of pieces that seal together to comprise a reaction cell chamber 5b31. The plurality of pieces may comprise a lower hemisphere 5b41 and an upper hemisphere 5b42. Other shapes are within the scope of the present disclosure. The two hemispheres may faster together at a seal 5b71. The seal may comprise at least one of a flange, at least one gasket 5b71, and fasteners such as clamps and bolts. The seal may comprise a graphite gasket such as Perma-Foil (Toyo Tanso) and refractory bolts such as graphite or W bolts and nuts wherein the metal bolts and nuts such as W bolts and nuts may further comprise a graphite or Perma-Foil gasket or washer to compensate for the different coefficients of thermal expansion between carbon and the bolt and nut metal such as W. The lower hemisphere of the blackbody radiator 5b41 and the reservoir 5c may be joined. The joining may comprise a sealed flange, threaded joint, welded joint, glued joint, or another joint such as ones of the disclosure or known to those skilled in the art. The seal may comprise a glued or chemically bonded seal formed by a sealant. Exemplary graphite glues are Aremco Products, Inc. Graphi-Bond 551RN graphite adhesive and Resbond 931 powder with Resbond 931 binder. The glued carbon sections may be thermally treated to form a chemical carbon bond. The bond may be the same or similar to the structure of each piece. The bonding may comprise graphitization. In an embodiment, the two pieces such as the upper and lower hemispheres may be at least one of threaded and screwed together and glued. The joining sections may be tongue-and-grooved to increase the contact area.

In an embodiment, the lower hemisphere 5b41 and the reservoir 5c may comprise a single piece. The reservoir may comprise a bottom plate that is attached by a joint such as one of the disclosure or known to those skilled in the art. Alternatively, the bottom plate and the reservoir body may comprise one piece that may further comprise one piece with the lower hemisphere. The reservoir bottom plate may connect to a reservoir support plate 5b8 that provides a connection to the outer pressure vessel 5b3a wall to support the reservoir 5c. The EM pump tube 5k6 and nozzle 5q may penetrate and connect to the reservoir 5c bottom plate with joints such as mechanical fittings such as at least one of Swagelok-type and VCR-type fittings 5k9 and Swagelok-type joint O-ring 5k10 (FIG. 2I69). In an embodiment, at least one of the top hemisphere 5b42, the bottom hemisphere 5b42, the reservoir 5c, the bottom plate of the reservoir 5c, and the EM pump tube 5k6, nozzle 5q and connectors 5k9 comprise at least one of W, Mo, and carbon. The carbon tube components such as ones having a bend such as a carbon riser or injector tube and nozzle may be formed by casting. In an embodiment, the top hemisphere 5b42, the bottom hemisphere 5b41, the reservoir 5c, and the bottom plate of the reservoir 5c comprise carbon. In an embodiment, the carbon cell parts such as the reservoir and blackbody radiator may comprise a liner. The liner may prevent the underlying surface such as a carbon surface from eroding. The liner may comprise at least one of a refractory material sheet or mesh. The liner may comprise W foil or mesh or WC sheet. The foil may be annealed. In an embodiment, the liner of a graphite cell component such as the inside of the blackbody radiator, the reservoir, and VCR-type fittings may comprise a coating such as pyrolytic graphite, silicon carbide or another coating of the disclosure or known in the art that prevents carbon erosion. The coating may be stabilized at high temperature by applying and maintaining a high gas pressure on the coating.

In embodiments comprising cell component coatings, at least one of the coating and the substrate such as carbon may be selected such that the thermal expansion coefficients match.

In an embodiment, at least one electrode of a pair of electrodes comprises a liquid electrode 8. In an embodiment, electrodes may comprise a liquid and a solid electrode. The liquid electrode may comprise the molten metal stream of the electromagnetic pump injector. The ignition system may comprise an electromagnetic pump that injects molten metal onto the solid electrode to complete the circuit. The completion of the ignition circuit may cause ignition due to current flow from the source of electricity 2. The solid electrode may be electrically isolated from the molten electrode. The electrical isolation may be provided by an electrically insulating coating of the solid electrode at its penetration such as at the reservoir 5c sidewall. The solid electrode may comprise the negative electrode, and the liquid electrode may comprise the positive electrode. The liquid positive electrode may eliminate the possibility of the positive electrode melting due to high heat from the high kinetics at the positive electrode. The solid electrode may comprise wrought W. The electrode may comprise a conductive ceramic such as at least one of a carbide such as one of WC, HfC, ZrC, and TaC, a boride such as ZrB₂, and composites such as ZrC—ZrB₂ and ZrC—ZrB₂—SiC composite that may work up to 1800° C. The conductive ceramic electrode may comprise a coating or covering such as a sleeve or collar.

In an embodiment, the SunCell® comprises at least two EM pump injectors that produce at least two molten metal streams that intersect to comprise at least dual liquid electrodes. The corresponding reservoirs of the EM pumps may be vertical having nozzles that deviate from the vertical such that the ejected molten metal streams intersect. Each EM pump injector may be connected to a source of electrical power of opposite polarity such that current flows through the metal streams at the point of intersection. The positive terminal of the source of electrical power 2 may be connected to one EM pump injector and the negative terminal may be connected to the other EM pump injector. The ignition electrical connections may comprise ignition electromagnetic pump bus bars 5k2a. The source of electrical power 2 may supply voltage and current to the ignition process while avoiding substantial electrical inference with the EM pump power supplies. The source of electrical power 2 may comprise at least one of a floating voltage power supply and a switching power supply. The electrical connection may be at an electrically conductive component of the EM pump such as at least one of EM pump tube 5k6, heat transfer blocks 5k7, and EM pump bus bars 5k2. Each heat transfer blocks 5k7 may be thermally coupled to the pump tubes 5k6 by conductive paste such as a metal powder such as W or Mo powder. The ignition power may be connected to each set of heat transfer blocks 5k7 such that a good electrical connection of opposite polarity is established between the source of electrical power 2 and each set of heat transfer blocks 5k7. The heat transfer blocks may distribute the heat from the ignition power along the heat transfer blocks. The nozzles may be run submerged in liquid metal to prevent electrical arc and heating damage. The level control system comprising the reservoir molten metal level sensor and EM pump controller such as the EM pump current controller may maintain the reservoir molten metal levels within reasonable tolerance such that the injection from submerged nozzles is at least one of not significantly altered by the submersion level and the level control system controls the EM pumping to adjust for the submersion level. The EM pump may pump metal out of the submerged nozzle 5q such that the ejected molten metal may form a stream that travels against gravity. The stream may be directed to intersect the opposing stream of a SunCell® embodiment comprising dual molten metal injectors. The SunCell® may comprise at least one molten metal stream deflector. At least one stream such as the submerged electrode stream may be directed to a stream deflector. The stream deflector may redirect the stream to intersect the opposing stream of a dual molten metal injector embodiment. The deflector may comprise a refractory material such as carbon, tungsten, or another of the disclosure. The deflector may comprise an extension of the reaction cell chamber 5b31 such as an extension or protrusion of the lower hemisphere of the blackbody radiator 5b41. The deflector may comprise an electrical insulator. An insulator may electrically isolate the deflector.

In an dual molten metal EM pump injector embodiment such as one comprising at least one submerged nozzle (FIGS. 2I139-2I147), at least one reservoir and the corresponding nozzle section of the EM pump tube 5k61 may be slanted such that the molten stream is directed more towards the center than if non-slanted. The slanted reservoir may comprise a slanted base plate of the EM pump assembly 5kk. The reservoir support plate 5b8 may comprise a matching tilt to support the slanted base plate of the EM pump assembly 5kk. Alternatively, at least one of the reservoir 5c, EM pump assembly 5kk, and EM pump 5ka comprising the magnets 5k4 and magnetic cooling 5k1 may be tilted away from center at the base of the EM pump 5ka to cause the inward slant at the top of the reservoir 5c. The reservoir support plate 5b8 may comprise a matching tilt to support the slanted reservoir and EM pump assembly 5ka. The top of the reservoir tube 5c may be cut at an angle to fit against the floor of a flat union with the lower hemisphere of the blackbody radiator 5b41. Alternatively, the lower hemisphere of the blackbody radiator 5b41 may comprise a corresponding slanted union such as one comprising a slanted collar and connector such as a slip nut connector that extends from the lower hemisphere 5b41 to allow for a heat gradient from the blackbody radiator 5b4 to the reservoir 5c. In an exemplary embodiment of the slip nut joint 5k14, the reservoir 5c comprises boron nitride, the lower hemisphere 5b41 slip nut connector comprises carbon, the nut comprises carbon, and the gasket 5k14a comprises carbon wherein the coefficient of thermal expansion of the graphite and the BN are selected to achieve a seal that can be thermally cycled. In an embodiment, the carbon and BN parts have matching coefficients of thermal expansion, or the coefficient of thermal expansion of BN is slightly larger than that of the carbon parts to comprise a compression joint as well. The gasket may compress to prevent thermal expansion from exceeding the tensile strength of the carbon parts. The compression may be reversible to allow thermal cycling.

The height and position of the inlet riser may be selected to maintain the submersion of the nozzle during operation of the SunCell®. The inlet riser may comprise an open-ended tube wherein flow into the tube occurs until the molten metal level is about that of the height of the tube opening. The tube-end opening may be cut at a matching slant to the molten metal level. The size of the tube opening may be selected to throttle or dampen the inward flow rate to maintain stability of level control between the two reservoirs of a dual molten metal injector system. The tube opening may comprise a porous covering such as mesh to achieve the flow throttling. The EM pump rate may throttle the level control to maintain relative level stability. The EM pump rate may be adjusted by controlling the EM pump current wherein at least one of the tube opening throttling and the dynamic current adjustment range are sufficient to achieve relative level control stability and alignment of the streams for an embodiment comprising one stream slightly oblique to the other.

The inlet riser may comprise a refractory electrical insulator such as a BN tube that may be inserted into or over a holder attached to the EM pump assembly base. In an exemplary embodiment, the holder comprises a shorter metal tube such Mo or SS attached to the EM pump assembly base. The inlet riser such as a top-slotted BN tube may be held in place inside the holder by a tightener such as setscrews or by a compression fitting. The inlet riser may be connected to the holder by a coupler that fits over the ends of both the inlet riser and holder. In an embodiment, the inlet riser may comprise carbon. The carbon inlet riser connection to the EM pump assembly 5kk may comprise at least one of threads and a compression fitting to at holder such as a tube holder that may be fastened to the base of the EM pump assembly by a fastener such as at least one of threads and welds. The holder such as a tube holder may comprise a material that is not reactive with the inlet riser holder. An exemplary holder to secure a carbon inlet riser comprises a tube that is resistant to the carbide reaction such as a nickel or rhenium tube or a SS tube that is resistant of carbonization such as one comprising SS 625 or Haynes 230. The inlet riser tube such as a carbon tube may become coated with the molten metal during operation wherein the molten metal may protect the tube from erosion by the reaction plasma.

In an embodiment, at least one of the inlet riser tube 5qa, the nozzle section of the EM pump tube 5k61, and the nozzle 5q may comprise a refractory material that is stable to oxidation such as refractory noble metal such as Pt, Re, Ru, Rh, or Ir or a refractory oxide such as MgO (M.P. 2825° C.), ZrO₂ (M.P. 2715° C.), magnesia zirconia that is stable to H₂O, strontium zirconate (SrZrO₃ M.P. 2700° C.), HfO₂ (M.P. 2758° C.), thorium dioxide (M.P. 3300° C.), or another of the disclosure. The ceramic pump injector parts such as the inlet riser tube 5qa, the nozzle section of the EM pump tube 5k61, and the nozzle 5q may be fastened to the metal EM pump inlet or outlet near or at the EM pump assembly 5kk. The fastener may comprise one of the disclosure. The fastener may comprise at least one of threaded or metallized and threaded ceramic parts, threaded pump component parts, and metallized ceramic parts brazed to the metal EM pump inlet or outlet near or at the EM pump assembly 5kk. The metallization may comprise a metal that does not oxidize such as nickel or a refractory metal. The fastener may comprise a flare fitting. The ceramic part may comprise the flare that may be conical, or it may be flat. The male portion of the fastener may be attached to the base of the EM pump assembly 5kk. The male portion of the flare fitting may comprise a metal threaded collar and a male pipe section to mate with a female threaded collar that tightens the flare of the ceramic part to the male pipe section as the matching threads are tightened. The fastener may further comprise a gasket such as a Graphoil or Perma-Foil (Toyo Tanso) gasket. The metal parts, such as those of the EM pump assembly 5kk, may comprise a material such as nickel that is nonreactive with the gasket. Any void formed by the mating threaded parts may be packed with an inert material to prevent molten metal such as molten silver infiltration and to serve as a means to relieve pressure from thermal expansion and contraction. The packing may comprise a gasket material such as one of the disclosure such as Graphoil or Perma-Foil (Toyo Tanso). In an exemplary embodiment, the fastener of the ceramic tube to the base of the EM pump assembly 5kk may comprise at least one of (i) ceramic part and EM pump assembly 5kk part threads, (ii) ceramic part metallization and threading or brazing the metal to the metal EM pump inlet or outlet near or at the EM pump assembly (alumina is a common material to be metallized and brazed), and (iii) a flare fitting comprising ceramic tubes wherein each has a conical or flat flared end and a threaded metal slip-over female collar to attach to a threaded collar welded to the EM pump assemble base plate; the flare fitting may further comprise a Graphoil or Perma-Foil (Toyo Tanso) gasket, and the EM pump assembly may comprise nickel metal parts to prevent reaction with carbon and also water. The materials such as those of the male fastener parts may be selected to match the thermal coefficient of expansion of the female parts.

In an embodiment to avoid component corrosion, (i) the reaction cell chamber 5b31 such as a carbon one may be at least one of coated with a protective layer of molten metal such a silver, comprise pyrolytic graphite or a pyrolytic graphite surface coating, be biased negative wherein the negative bias may be provided by at least one of the ignition voltage such as a connection to the negative injector and reservoir, (ii) the interior surface of the EM pump tube may comprise an non-water reactive material such as nickel, and (iii) the reservoir, inlet riser, and injectors may comprise a ceramic such as MgO or other refractory and stable ceramic known to those skilled in the art. In an embodiment, the negative bias applied to a carbon lower hemisphere 5b41 protects the carbon from a carbon reduction reaction with an oxide reservoir such as an MgO or ZrO₂ reservoir. The bias may be applied to the carbon part and not the contacting oxide part. Alternatively, the union between the oxide and carbon may comprise a wet seal or a gasket to limit contact between the oxide and carbon. In an embodiment, the temperature and pressure are controlled such that it is not thermodynamically possible for carbon to reduce the oxide such as MgO. An exemplary pressure (P) and temperature (T) condition is about when T/P0.0449<1200. The carbon may comprise pyrolytic carbon to reduce the carbon reduction reactivity. The atmosphere may comprise CO₂ to lower the free energy of carbon reduction. The carbon may be coated with a protective coating such as silver from the vaporization of the molten silver or Graphite Cova coating (http://www.graphitecova.com/files/coating_4.pdf). The Cova coating may comprise the following plurality of layers aluminum plus compounds/aluminum plus alloys/pure aluminum/metal/graphite. in an embodiment, the graphite is coated with a coating to avoid reaction with hydrogen. An exemplary coating comprises metallic and non-metallic layers consisting of ZrC; Nb, Mo, and/or Nb-Mo alloy; and/or Mo₂C.

In an embodiment, at least one of the reservoirs 5c, the lower hemisphere 5b41, and the upper hemisphere 5b42 comprises a ceramic such as an oxide such as a metal oxide such as ZrO₂, HfO₂, Al₂O₃, or MgO. At least two parts of the group of the lower hemisphere 5b41, the upper hemisphere 5b42, and reservoirs 5c may be glued together. In an embodiment, at least two parts of the group of the lower hemisphere 5b41, the upper hemisphere 5b42, and reservoirs 5c may be molded as a single component. In an embodiment, the reservoir may be joined to at least one of the lower hemisphere and the EM pump assembly 5kk by at least one of a slip nut joint, a wet seal joint, a gasket joint, and another joint of the disclosure. The slip nut joint may comprise a carbon gasket. At least one of the nut, the EM pump assembly 5kk, and the lower hemisphere may comprise a material that is resistant to carbonization and carbide formation such and nickel, carbon, and a stainless steel (SS) that is resistant of carbonization such as SS 625 or Haynes 230 SS. In an embodiment, the carbon reduction reaction between a carbon lower hemisphere and an oxide reservoir such as a MgO reservoir at their union is avoided by at least one means such as a joint comprising a wet seal that is cooled below the carbon reduction reaction temperature and a slip nut joint that is maintained below the carbon reduction reaction temperature due to a suitable length of the collars of the carbon lower hemisphere that joins to the oxide reservoir. In an embodiment, the carbon reduction reaction is avoided by maintaining a joint comprising oxide in contact with carbon at a non-reactive temperature, one below the carbon reduction reaction temperature. In an embodiment, the MgO carbon reduction reaction temperature is above the range of about 2000° C. to 2300° C. The power conversion may be achieved with a system such as magnetohydrodynamic that is capable of efficient conversion with the joint at the non-reactive temperature. In an embodiment, the lower hemisphere 5b41, the upper hemisphere 5b42, and reservoirs 5c comprise ceramic such as a metal oxide such as zirconia wherein the parts are least one of molded and glued together, and the joint at the EM pump assembly comprises a wet seal. In an embodiment, the lower hemisphere 5b41 and reservoirs 5c comprise zirconia wherein the parts are least one of molded and glued together, and the joint at the EM pump assembly comprises a wet seal. In an embodiment, the blackbody radiator 5b4 comprises ZrO₂ stabilized with MgO, TiO₂, or yttria. The PV dome may be reduced in radius relative to that of a SunCell® having a carbon blackbody radiator of the same incident power density due to the lower ZrO₂ emissivity of about 0.2. The more concentric geometry of the PV converter may provide a more favorable about normal incidence of the blackbody radiation onto the PV cells.

In an embodiment comprising a lower hemisphere 5b41 comprising an electrical insulator, the reservoirs 5c may comprise a conductor such as a metal such as a refractory metal, carbon, stainless steel, or other conducting material of the disclosure. The lower hemisphere 5b41 comprising an electrical insulator may comprise a metal oxide such as ZrO₂, HfO₂, Al₂O₃, or MgO or carbon coated with an insulator such as Mullite or other electrically insulating coating of the disclosure.

In an embodiment, the emissivity of the blackbody radiator 5b4 is low for light above the band gap of the PV cell and high for radiation below the PV cell band gap. The light below the PV band gap may be recycled by being reflected from the PV cells, absorbed by the blackbody radiator 5b4, and re-emitted as the blackbody radiation at the blackbody radiator's operating temperature such as in the range of about 2500 K to 3000 K. In an embodiment, the reflected radiation that is below the band gap may be transparent to the blackbody radiator 5b4 such that it is absorbed by the reaction cell chamber 5b31 gases and plasma. The absorbed reflected power may heat the blackbody radiator to assist to maintain its temperature and thereby achieve recycling of the reflected below band gap light. In an embodiment comprising a blackbody radiator having a low emissivity and a high transmission for below band gap light, the blackbody radiator such as a ceramic one such as zirconia one comprises an additive such as a coating or internal layer to absorb the reflected below band gap light and recycle it to the PC cells. The coating or internal layer may comprise a high emissivity such that it absorbs light reflected from the PV cells. The additive may comprise carbon, carbide, boride, oxide, nitride, or other refractory material of the disclosure. Exemplary additives are graphite, ZrB₂, zirconium carbide, and ZrC composites such as ZrC13 ZrB₂ and ZrC—ZrB₂—SiC. The additive may comprise a powder layer. The blackbody radiator 5b4 may comprise a laminated structure such as inner surface refractory such as ceramic/middle high emissivity refractory compound/outer surface refractory such as ceramic. The surface refractory such as ceramic may be impermeable to water and oxygen gas. An exemplary laminated structure is inner surface ZrO₂/middle ZrC/outer surface ZrO₂. The laminated structure may be fabricated by casting the inner layer in a mold, spraying the casted layer with middle layer compound, and then casting the outer layer in a mold.

Since zirconia is employed in the deposition of optical coatings and it is a high-index material usable from the near-UV to the mid-IR, due to its low absorption in this spectral region, the blackbody radiator comprises zirconia wherein the below band gap light is transmitted through the blackbody radiator, absorbed inside of the reaction cell chamber 5b31, and is recycled to the PV converter 26a. In an embodiment, near-UV to mid-IR light is transparent to the blackbody radiator 5b4 such as a zirconia blackbody radiator. The blackbody emission of the reaction cell chamber plasma may be transmitted directly to the PV cells as well as absorbed to heat the blackbody radiator to its blackbody operating temperature.

In an embodiment, the PV converter comprises a window to cover the PV cells and protect them from vaporized material from the blackbody radiator such as vaporized metal oxide such as MgO or ZrO₂. The window may comprise a wiper such as a mechanical wiper that may automatically clean the window. In an embodiment, the PV window comprises a material and design to form a transparent coating of condensed vaporized metal oxide from the blackbody radiator 5b4. In an exemplary embodiment, the blackbody radiator 5b4 comprises a material such as zirconia that is transparent to radiation in the wavelength range of about near-UV to mid-IR such that zirconia deposition onto the PV window does not significantly opacify the window to the blackbody radiation from the blackbody radiator.

In an embodiment, a high gas pressure such as that of an inert gas such as a noble gas such as argon is maintained on the blackbody radiator to suppress vaporization. The gas pressure may be in at least one range of about 1 to 500 atm, 2 to 200 atm and 2 to 10 atm. The gas pressure may be maintained in the outer pressure vessel 5b3a. The pressure with in the outer pressure vessel 5b3a may be reduced during startup to reduce the power consumed by the inductively coupled heater wherein the pressure may be reestablished after the cell is generating power in excess of that required to maintain the desired operating temperature. The blackbody radiator such as a metal oxide one may be coated with a coating to suppress vaporization. The coating may comprise one of the disclosure. An exemplary metal oxide coating is ThO₂ (M. P.=3390° C.). The thorium oxide as well as yttrium oxide and zirconium oxide may further serve as a gas mantle on the blackbody radiator 5b4 to produce higher PV conversion efficiency. In an embodiment, the metal oxide ceramic component such as the blackbody radiator 5b4 is maintained in an oxidizing atmosphere such as one comprising at least one of H₂O and O₂ that increases the stability of the metal oxide. In an embodiment, the SunCell® comprises a source of heated metal oxide that at least one of serve as a source to deposit on at least one component that losses metal oxide by vaporization and serves as a source of vaporized metal oxide to suppress vaporization from at least one metal oxide cell component.

In an embodiment, the inside walls of the reaction cell chamber 5b31 comprises a refractory material that is not reactive to water. The refractory material may comprise at least one of rhenium, iridium, a ceramic such as a metal oxide such as zirconium oxide, a boride such as zirconium diboride, and a carbide such as tantalum carbide, hafnium carbide, zirconium carbide, and tantalum hafnium carbide. The walls of a carbon reaction cell chamber 5b31 may comprise rhenium since it is resistant to carbide formation. The rhenium coating may be applied to the carbon walls by chemical vapor deposition. The method may comprise that of Yonggang Tong, Shuxin Bai, Hong Zhang, Yicong Ye, “Rhenium coating prepared on carbon substrate by chemical vapor deposition”, Applied Surface Science, Volume 261, 15 Nov. 2012, pp. 390-395 which is incorporated in its entirety by reference. An iridium coating on the walls of a carbon reaction cell chamber 5b31 may be applied on a rhenium interlayer to increase the adhesive strength and relieve some thermal expansion mismatch. The rhenium coating may be applied to the carbon walls by chemical vapor deposition, and the iridium coating may be applied electrochemically. The methods may comprise those of Li'an Zhu, Shuxin Bai, Hong Zhang, Yicong Ye , Wei Gao, “Rhenium used as an interlayer between carbon-carbon composites and iridium coating: Adhesion and wettability”, Surface & Coatings Technology, Vol. 235, (2013), pp. 68-74 which is incorporated in its entirety by reference. In an embodiment, the blackbody radiator comprises a ceramic that is stable to reaction with water that is coated with a material that is non-volatile at the operating temperature such as ZrC, W, carbon, HfC, TaC, tantalum hafnium carbide or other suitable refractory material of the disclosure. The material that is non-reactive with water may comprise the inner walls of the reaction cell chamber 5b31. Exemplary embodiments comprise ZrO₂ coated with graphite or ZrC.

In an embodiment, the carbon walls of the reaction cell chamber 5b31 are coated with a coating that prevents the carbon from reacting with the source of oxygen or the catalyst such as at least one of Li₂O, water, and HOH. The coating may comprise fluorine. The inner surface of a carbon reaction cell chamber may be coated with fluorine terminally bound to the carbon. In an embodiment, the reaction cell chamber comprises a source of fluorine such as molten metal fluoride such as silver fluoride or a fluoride of the metal of a cell component in contact with the molten metal such as nickel fluoride, rhenium fluoride, molybdenum fluoride, or tungsten fluoride to maintain the fluorine terminated carbon that is protective of oxidation such as that by the source of oxygen or water.

In an embodiment, the reaction cell chamber 5b31 comprises a species or a source of a species that intercalates into carbon. The species may comprise at least one of an alkali metal such as lithium, a metal that reacts with water such as an alkaline or alkaline earth metal, and a metal that does not react with water such as nickel, copper, silver, or rhenium. The lithium metal may exchange for Li₂O or LiOH formed by reaction of intercalated lithium with water.

In an embodiment, the source of oxygen to form HOH catalyst may comprise an oxide. The oxide may be insoluble in the molten metal such as silver. The oxide may comprise lithium oxide. The walls of the reaction cell chamber may be coated with molten metal such as silver. The source of oxygen may react with hydrogen to form HOH catalyst. The silver coating may protect the reaction cell chamber walls such as ones comprising carbon from contacting the source of oxygen. The silver coating may protect the carbon wall from reacting with the source of oxygen. The carbon walls may comprise intercalated lithium. The lithium may react with the carbon to reduce it. The carbon may be reduced by applying a negative potential to the carbon. The carbon may have the composition of a carbon anode of a lithium ion battery. The anode composition may protect the carbon from oxidation by at least one of the source of oxygen and HOH. The reducing potential may be applied relative to at least one of the molten metal such as silver, at least one reservoir 5c, and at least one molten metal electrode such as the positive electrode. The carboreduction reaction of the graphite walls by the source of oxygen such as lithium oxide may be impeded by at least one of the silver coating, intercalated metal ions such as lithium ions, and the applied voltage. The lithiated carbon may be formed electrochemically as known by those skilled in the art. The lithiation may be formed by using the carbon as the anode of an electrochemical cell having a lithium counter electrode wherein the lithiation is formed by charging the cell. In an embodiment, the molten metal such as silver comprises an intercalant such as lithium. The intercalant may intercalate into the carbon by the application of a negative potential to the reaction cell chamber 5b31. The reaction cell chamber may comprise an electrochemical cell to form lithium intercalated carbon. The carbon dome may be electrically connected to the negative molten metal injector system. The carbon dome may be connected to the negative reservoir. The negative reservoir may comprise carbon. The carbon dome may be connected to the carbon reservoir by a joint such as a slip nut. The carbon dome and the negative reservoir may comprise a single unit. The carbon reservoir may be joined to the EM pump assembly 5kk base by a wet seal or another union of the disclosure or known in the art. The positive molten metal injector may serve as the counter electrode of the electrochemical cell that at least one of forms and maintains the species intercalated carbon such as lithium intercalated carbon.

In an embodiment, the blackbody radiator 5b4 may comprise a surface coating to cause the selective emission of high-energy light in greater proportion than it blackbody radiation. The coating may permit the operation of the blackbody radiator 5b4 at a lower temperature such as one in a range of about 2500 K to 3000 K while achieving PV conversion efficiencies corresponding to a higher blackbody temperature. The blackbody radiator 5b4 such as a metal oxide blackbody radiator such as a ZrO₂ or HfO₂ one may be operated in a suitable operating temperature range to avoid vaporization while achieving a desired PV conversion efficiency due to the coating. The coating may comprise a thermophotovoltaic filter of the disclosure or known in the art. The coating may comprise a selective line emitter such as a mantel coating. Exemplary mantles on the blackbody radiator 5b4 to produce higher PV conversion efficiency are thorium oxide and yttrium oxide.

In an embodiment, the light may propagate directly from the hydrino plasma to the PV cells of the PV converter 26a. The reaction cell chamber 5b31 may remain at a lower blackbody temperature at a given optical power flow to the PV cells due to transparency of the reaction cell chamber 5b31 (FIGS. 2I146-2I147). The reaction cell chamber 5b31 may comprise a transparent material such as a transparent refractory material such as a ceramic. The ceramic may comprise a metal oxide. The metal oxide may be polycrystalline. The reaction cell chamber 5b31 may comprise at least one of optically transparent alumina (sapphire) Al₂O₃, zirconia (cubic zirconia) ZrO₂, hafnia (HfO₂), thoria ThO₂, and mixtures thereof. The hydrino plasma maintained inside of the reaction cell chamber 5b31 may emit light such as blackbody and line emission that is transparent to the reaction cell chamber 5b31. The transparency may be for at least wavelengths having energies that are above the bandgap of the PV cells of the PV converter 26a. The PV cells may reflect unconverted light that has energies of at least one of above and below the bandgap. The light may be reflected to at least one of a mirror, another PV cell, and the blackbody radiator that may comprise the plasma inside of the reaction cell chamber 5b31. The plasma may be highly absorptive of the reflected radiation due to scattering, ionization, and blackbody features of the plasma. The reflected light may be recycled back to the PV cells for further conversion into electricity. The reaction cell chamber 5b31 may comprise sections with mirrors to at least one of reflect the light to PV cells and recycle the light. The reaction cell chamber 5b31 may comprise non-transparent sections. The non-transparent sections may be at least one of opaque or cooler. A silver mirror may form at a desired location to maintain non-transparency. The mirror may form from the molten silver by condensation. At least one of the reservoirs 5c and the lower portion of the lower hemisphere 5b41 may be nontransparent. The reaction cell chamber 5b31 may be capable of operating at a temperature above the boiling point of the molten metal such as silver to avoid the metal from condensing on the transparent sections. The dome 5b4 may be capable of operating at a temperature above the boiling point of silver 2162° C. so that it remains transparent to the plasma blackbody radiation to irradiate the PV cells. Exemplary transparent ceramics capable of operating above the boiling point of silver (B. P.=2162° C.) are zirconia (cubic zirconia) ZrO₂, hafnia (HfO₂), thoria ThO₂, and mixtures thereof. In an embodiment, the transparent dome 5b4 such as a sapphire dome may operate below the boiling point of the molten metal wherein the plasma superheats the molten metal to prevent it from condensing on the transparent dome sections. Parts of the cell such as the lower hemisphere 5b41, upper hemisphere 5b42, and reservoirs 5c may comprise a single part or may comprise a plurality of parts that are joined. The joining may be by means of the disclosure such as by gluing the parts together using ceramic glue. In an embodiment, the transparent dome 5b4 may comprise a plurality of transparent domes each of smaller diameter. The plurality of domes may comprise a single piece or a glued together composite dome.

In an embodiment, the plasma temperature inside of the transparent reaction cell chamber 5b31 is maintained at one that is about optimal for electrical conversion by PV cells such as commercial PV cells such as at least one of Si and III-V semiconductor based PV cells such as those of the disclosure wherein the cells may comprise concentrator cells. The blackbody temperature may be maintained at about that of the Sun such as about 5600K.

In an embodiment, the radiator 5b4 such as a transparent dome that may transmit the majority of the plasma radiation comprises a cooling system to cool the dome to avoid exceeding its maximum operating temperature. The cooling system may comprise a gas maintained in the housing 5b3 to remove heat by at least one means of conduction, convection, and forced convection. The cooling system may comprise a forced gas cooling system with a gas chiller. Alternatively, the cooling system may comprise at least one coolant line, a coolant line surface mesh on the dome surface that may be transparent, a coolant that may be about transparent, a coolant pump, and a chiller. The about transparent coolant may comprise a molten salt such as an alkali or alkaline earth molten salt such as a halide salt. In an embodiment, the base of the dome may be cooled to prevent light blockage. In an embodiment, the dome may be covered with refractory conductor strips to cause heat to flow to the perimeter to be removed by the cooling system. In an embodiment, portions of the dome may be covered with high emissivity refractory material such as one of the disclosure to enhance radiative heat losses from the dome to cool it. In an embodiment comprising a plurality of element domes that may comprise a single piece or a glued together composite dome, the cooling system may comprise coolant lines that run along the seems between element domes.

In an embodiment, the hydrino reaction plasma is maintained in the center of the reaction cell chamber 5b31 comprising a transparent sphere to achieve a thermal gradient from the center of the reaction cell chamber 5b31 to the transparent dome 5b4. The hydrino reaction rate may be spatially controlled to localize in the center of the sphere by controlling the injection of the hydrino reactants and controlling the reaction conditions such as the maintenance of the conductive molten metal matrix to the center as well as controlling the ignition parameters such as the voltage and current. In another embodiment, a buffer layer of non-plasma gas may be injected along the inside wall of the dome 5b4 to prevent direct contact of the hydrino plasma with the wall. Alternatively, the SunCell® may comprise a charging source such as an electrical power supply and electrodes to cause the wall and plasma may be like-charged to cause electrical repulsion between the plasma and wall to prevent direct plasma contact with the wall. In an embodiment, the SunCell® may comprise a source of magnetic field for plasma magnetic confinement. The plasma may be confined to the about center of the dome by the magnetic fields. The dome may comprise a magnetic bottle with the plasma confined to the center so that the transparent walls to do not overheat.

In an embodiment, at least one of the inlet riser tube 5qa and injector 5k61 tube may comprise carbon or a ceramic. The ceramic may comprise one that does not react with H₂O such as an oxide such as at least one of ZrO₂, HfO₂, ThO₂, MgO, Al₂O₃, others of the disclosure, and one known to those skilled in the art. The ceramic may comprise carbide that at least one of forms a protective oxide coat and is resistant to reaction with water such as ZrC. The tube may comprise threads at the base end and may be threaded into the base of the EM pump assembly 5kk.

In an embodiment, at least one of the inlet riser tube 5qa, injector 5k61, and reservoir 5c are at least partially electrically conductive and are negatively biased to avoid corrosion. Exemplary conductive refractory ceramics are silicon carbide, yttria stabilized zirconia, and other known to those skilled in the art. The negatively biased parts such as at least one of the inlet riser tube 5qa, injector 5k61, and reservoir 5c may comprise a refractory conductor such as graphite. The positively biased parts may comprise a refractory material that is stable to oxidation such as refractory noble metal such as Pt, Re, Ru, Rh, or Ir or a refractory oxide such as MgO or others of the disclosure. In an embodiment, the cell component may comprise a non-reactive surface coating to avoid corrosion such as corrosion by oxidation with an oxidant such oxygen and water vapor. The coating of exemplary parts such as at least one of the EM pump tube 5k4, the inlet riser tube 5qa, and the injector 5k61 may comprise Ni, Co, a refractory noble metal such as Pt, Re, Ru, Rh, or Ir, or ceramic such as MgO, Al₂O₃, Mullite, or another of the disclosure. The parts that are in contact with high temperature H₂O may comprise an oxidation resistant stainless steel such as at least one of Haynes 230, Pyromet® alloy 625, Carpenter L-605 alloy, and BioDur® Carpenter CCM® alloy. Parts that operate at an elevated temperature may be coated with a non-reactive refractory coating. The coating may be achieved by methods known by those skilled in the art such as by electroplating, chemical deposition, spraying, and vapor deposition. In an exemplary embodiment, at least one of a Mo or W inlet riser tube 5qa and injector 5k61 may be coated with at least one of rhenium (M.P.=3180° C.), iridium (M.P.=2410° C.), and corresponding alloys. In an embodiment, the component such as a Mo tube injector 5k61 and W nozzle 5q may be coated with rhenium using the carbonyl thermal decomposition method. Rhenium decacarbonyl (Re₂(CO)₁₀) decomposes at 170° C., the Re₂(CO)₁₀ may be vaporized and decomposed onto the part maintained at a temperature of over 170° C. Other suitable coating methods are those known in the art such as electroplating, vapor deposition, and chemical deposition methods. A weld or fastener such as a flare fitting may be used to connect at least one of a metal inlet riser tube 5qa and the injector 5k61 such as at least one of Re plated Mo and W ones to the base plate of the EM pump assembly 5kk. Like nickel, rhenium does not react with water under ordinary conditions. Metals that do not react with water may be at least one of protected from oxidation and the oxide may be reduced to metal and water by maintaining an atmosphere comprising hydrogen. Nickel oxide and rhenium oxide may each be formed by reaction with oxygen. In an exemplary embodiment, maintaining a hydrogen atmosphere may reduce at least one of nickel oxide and rhenium oxide. The EM pump assembly 5kk may comprise collars for the inlet riser tube 5qa and the injector 5k61. The collars may be welded to the base plate or machined into the base plate. The collars as well as the inlet riser tube 5qa and injector 5k61 tube may comprise a material that is resistant to reaction with H₂O. The collars, inlet riser tube 5qa, and injector 5k61 tube may be at least one of nickel, platinum, noble metal, and rhenium coated. At least one of the coated inlet riser tube 5qa and the injector 5k61 may be joined to the base plate of the EM pump assembly 5kk by threads to the collars.

Pyrolytic graphite has little to no reactivity with hydrogen and does not intercalate silver; thus, the carbon parts such as the reaction cell chamber 5b31 may comprise pyrolytic graphite that may used with a hydrogen atmosphere and molten silver. Silver also has the favorable property that it does not form an alloy many metals such as nickel and rhenium.

The union or joint between cell components may comprise a brazed joint. The brazed joint may comprise one known to those skilled in the art such as one of those described in the article R. M. do Nascimento, A. E. Martinelli, A. J. A. Buschinelli, “Review Article: Recent advances in metal-ceramic brazing”, Ceramica, Vol. 49, (2003) pp. 178-198 that is herein incorporated by reference in its entirely. The braze may comprise a commercial one such as one comprising S-Bond® active solders (http://www.s-bond.com) that enable the joining of ceramics, such as oxides, nitrides, carbides, carbon/graphite silicides, sapphire, and others, to metals as well as to each other. S-Bond alloys have active elements such as titanium and cerium added to Sn—Ag, Sn—In—Ag, and Sn—Bi alloys to create a solder that can be reacted directly with the ceramic and sapphire surfaces prior to bonding. S-Bond alloys produce reliable, hermetic joints with all metals including steel, stainless steels, titanium, nickel alloys, copper and aluminum alloys, provided thermal expansion mismatch at joining temperatures is managed.

In an embodiment, at least one of the inlet riser tube 5qa, injector 5k61 tube, and the reservoir 5c may be brazed to the EM assembly 5kk base plate. At least one of the inlet riser tube 5qa, injector 5k61 tube, and the reservoir 5c may comprise a ceramic such as a metal oxide such as at least one ZrO₂, HfO₂, and Al₂O₃ that may be brazed to the EM assembly 5kk base plate. The EM assembly 5kk base plate may comprise a metal such as stainless steel (SS) such as 400 series SS, tungsten, nickel, titanium, niobium, tantalum, molybdenum, a ceramic such a ZrO₂, or another of the disclosure. The base plate may comprise a material that has a similar coefficient of thermal expansion as the reservoir. The braze may comprise a filler metal that may comprise a noble metal such as at least one of rhodium, ruthenium, palladium, rhenium, iridium, platinum, gold, silver, and their alloys such as Pd—Au alloy. An active metal such as at least one of hafnium, zirconium, and titanium may be added to the filler metal such as a noble metal. The active metal may be added as a fine powder. The active metal may be added as a hydride such as titanium hydride that decomposes during brazing to form fine titanium particles. The active metal may be added to the filler metal in a desired mole percentage such as in the range of about 1 to 2 mole % to achieve the braze. The active metal may serve to wet the ceramic. The active metal may partially substitute for ceramic metal to achieve at least one of wetting of the ceramic and bonding with the ceramic. The joined parts may be matched in thermal coefficient as closely a possible while achieving the desired operational characteristics of the components. In an exemplary embodiment, at least one component such as at least one of the inlet riser tube 5qa, injector 5k61 tube, and the reservoir 5c may comprise at least one of ZrO₂, HfO₂, and Al₂O₃ that is brazed to a molybdenum EM assembly 5kk base plate. In another exemplary embodiment, at least one component such as at least one of the inlet riser tube 5qa, injector 5k61 tube, and the reservoir 5c may comprise at least one of ZrO₂, HfO₂, and Al₂O₃ that is brazed to a 410 stainless steel EM assembly 5kk base plate wherein the braze comprises Paloro-3V palladium-gold-vanadium alloy (Morgan Advanced Materials). The metal percentages of the alloy may be adjusted to achieve a desire maximum operating temperature such as one in the range of about 1150° C. to 1300° C. wherein the braze temperature may be higher such as 100° C. higher.

The mismatch of thermal coefficients of expansion between the joined cell components may be at least partially corrected by using a transition element that comprises a metal connector that is brazed to the EM assembly 5kk base plate and the ceramic part. The metal connector may have a thermal expansion coefficient that more closely matches that of the ceramic component. The connector may accommodate a larger thermal mismatch with the EM assembly 5kk base plate due to the deformability of the bases plate and connector metals. An exemplary connector is a molybdenum collar that is brazed to the metal oxide part on one end and brazed or welded to a stainless steel EM assembly 5kk base plate on the other end wherein molybdenum more closely matches the thermal expansion coefficient of the ceramic such as zirconium oxide, and the deformation of the metals accommodate the higher thermal expansion mismatch stresses at the union of the two metals. In another embodiment, the connector may comprise a bellows to accommodate differential expansion. The bellows may be electroformed.

The brazing may be performed in a vacuum. The brazing may be performed in a high temperature vacuum furnace. The filler and active metal may be formed into a geometry that matches the geometry of the joint such as a ring to comprise the brazing material. The parts may be juxtaposed with the brazing material intervening between the parts. The furnace may be operated at a temperature of about the melting point of the brazing material to melt it and form braze. The brazed metal parts may be coated with an oxidation resistant coating such as a nickel, noble metal, or platinum coating, or another of the disclosure.

In an exemplary embodiment, the EM assembly 5kk base plate, EM pump tube 5k6, and EM pump bus bars 5k2 comprise molybdenum. The parts may be welded together by means known in the art such as laser or electron beam welding. The collars for the inlet riser tube 5qa and injector 5k61 tube may be machined into the baseplate and the inlet riser tube 5qa and injector 5k61 tube may be connected to the baseplate during assembly by threads. The reservoir 5c comprising ZrO₂, HfO₂, or Al₂O₃ is brazed to a molybdenum EM assembly 5kk base plate using palladium filler with 1 to 2 mole % titanium fine power as the active metal. The reservoir is placed on the base plate of the assembled EM assembly 5kk with the brazing material intervening between the parts being brazed. The brazing is performed at about 1600° C. in a vacuum furnace to melt the palladium (M. P.=1555° C.). Alternatively, the filler may comprise an alloy such as Pd—Au 90% (M. P.=1300° C.). The surface of the baseplate inside of the reservoir 5c and the inside of the EM pump tube 5k6 are coated with an oxidative protective coating such as platinum or nickel. The coating may be formed by electroplating, vapor deposition, or other methods known to those skilled in the art.

Rigid posts such as metal or ceramic posts may support the reservoir support plate 5b8. The former may be electrically isolated by mounting the posts on an insulator such as an anodized aluminum base plate wherein the connections between the posts and base plate may comprise anodized fasteners such a bolts or screws. The metal posts may be coated with an insulating coating such as BN, SiC, Mullite, black oxide, or other of the disclosure.

In another embodiment, the nozzle 5q may comprise at least one pore, slit, or small opening that passes the molten metal at a low flow rate to coat the nozzle. The flow may continuously regenerate the molten metal surface that is sacrificed by plasma valorization rather than the nozzle. The pores may be formed by drilling, electrode electrical discharge machine, laser drilling, and during fabrication such as by casting and by other methods known in the art. In another embodiment, the nozzle 5q may comprise a flow diverter that directs a portion of the ejected molten metal to flow over the nozzle to protect the nozzle form plasma vaporization. In another embodiment, the ignition circuit comprising the source of electricity 2 further comprises an arc sensor that senses an arc at the nozzle rather through the molten metal streams and an arc protection circuit that terminates the arc current on the nozzle.

In an embodiment, the injection tube 5k61 may be bent to place the nozzle 5q in about the center at the top of the reservoir 5c. In an embodiment, the injection tube 5k61 may be angled from the vertical to center the nozzle 5q at the top of the reservoir 5c. The angle may be fixed at the connector at the bottom of the reservoir 5k9. The connector may establish the angle. The connector may comprise a Swagelok 5k9 with a locking nut to the reservoir base and further comprising an angled female connector to a threaded-end injection tube 5k61. The female connector may comprise a bent collar with a female connector or an angled nut so that the angle of the female threads are tilted. Alternatively, the reservoir base may be angled to establish the angle of the injector tube. In another embodiment, the threads in the reservoir baseplate may be tilted. A Swagelok fitting 5k9 may be threaded into the tilted or angled threads. A connected straight injection portion of the EM pump tube 5k61 may be angled due to the angled threads. The angle may place the nozzle 5q in the center of the reservoir 5c. The Swagelok fitting 5k9 that is angled relative to the base of the reservoir may be connected to an angled collar beneath the reservoir baseplate to permit an about vertical connection with the EM pump tube 5k6 where it connects to penetrate the reservoir baseplate. The pump tube 5k6 may comprise stainless steel (SS) that is resistant to reaction with water such as SS used in boilers. The pump tube may be welded into the EM pump tube assembly such as the tilted one.

In an embodiment, the SunCell® generator comprises two reservoirs 5c and one molten metal injector in one of the reservoirs, the injection reservoir. The molten metal injector may comprise an EM pump injector. The other reservoir, non-injector reservoir, may fill with molten metal. The excess molten metal injected by the single injector may overflow and run back into the reservoir that has the injector. The lower hemisphere 5b41 may be sloped to return metal flow to the injection reservoir. The reservoirs may serve as oppositely polarized terminals or electrodes by being electrically connected to the corresponding terminals of the ignition source of electrical power 2. The polarity may be such to prevent the nozzle 5q of the injector from being damaged by the intense hydrino reaction plasma. The non-injector reservoir may comprise the positive electrode and the injector reservoir may comprise the negative electrode.

The reservoir support plate or baseplate 5b8 may comprise an electrical insulator such as SiC or boron nitride. Alternatively, the support plate may be a metal such as titanium capable of operating at the local temperature. The metal may be at least one of non-magnetic and highly conductive to limit the RF power absorbed from the inductively coupled heater and have a high melting point. Exemplary metals are W and Mo. The baseplate may comprise carbon. Electrical isolation of the metal baseplate 5b8 may be provided by an insulator between the plate and the mounting fixtures and also the reservoir and the plate. The insulators may comprise insulator washers or bushings such as SiC or ceramic ones. The support plate of the dual reservoirs may be one or separate support plates. The reservoir support plate may comprise a longitudinally split plate with insulator collars or bushing such as SiC or BN ones to electrically isolate the reservoirs. The reservoir support plate may comprise a longitudinally split, two piece base plate with slots for gaskets such as electrically insulating gaskets such as SiC or BN gaskets on which the reservoirs are seated. Alternatively, the each reservoir may be supported by an independent baseplate such that there is a current break between the baseplates. The baseplate may comprise a material that has a low absorption cross section for the RF power of the inductively coupled heater. The baseplate may comprise a thermal shock resistant ceramic such as silicon carbide or boron nitride. The baseplate may comprise a metal with low RF absorption. The baseplate may comprise a metal that is coated with a coating such as one of the disclosure that may have a low RF absorption cross section.

The intersection point may be any desired such as in a region ranging from in the reservoir to a region at the top of the reaction cell chamber 5b31. The intersection point may be about in the center of the reaction cell chamber. The point of intersection may be controlled by at least one of the pump pressure and the relative bend or tilt of the nozzles from vertical. The reservoirs may be separate and electrically isolated. The molten metal such as molten silver may flow back from the reaction cell chamber to each reservoir to be recycled. The returning silver may be prevented from electrically shorting across the two reservoirs by a metal stream interrupter or splitter to interrupt the continuity of silver that would otherwise bridge the two reservoirs and provide a conductive path. The splitter may comprise an irregular surface comprised of a material that causes silver to bead to interrupt the electrical connection between reservoirs. The splitter may comprise a cutback of each reservoir wall at the region of shorting such that the silver drops over the cut back or drip edge such that the continuity is broken. The splitter may comprise a dome or hemisphere capping the intersection of the two reservoirs wherein the base of the dome or hemisphere comprises the cut back for each reservoir. In an embodiment, the two reservoirs 5c and their bottoms or base plates and the lower hemisphere of the blackbody radiator 5b41 may comprise one piece. The lower hemisphere of the blackbody radiator 5b41 may comprise a raised dome or transverse ridge in the bottom into which the reservoirs are set. In an embodiment, the top of each reservoir may comprise a ring plate or washer that serves as a lip over which returning silver flows. The lip may cause an interruption in the metal stream flowing into each reservoir to break any current path between the reservoirs that may otherwise flow through the returning silver. The top of each reservoir may comprise a machined circumferential groove into which the washer is seated to form the lip or drip edge 5ca as shown in FIG. 2I83. At least one cell component such as the splitter such as a dome or hemisphere splitter, reservoirs 5c, lower hemisphere of the blackbody radiator 5b41, the raised or domed bottom of the lower hemisphere of the blackbody radiator 5b41, and lip on each reservoir may comprise carbon.

In an embodiment, the base of the blackbody radiator such as the floor of the reaction cell chamber 5b31 such as the floor of the lower hemisphere of the blackbody radiator 5b41 may comprise grooves or channels to direct the flow of the molten metal in preferred pathways into the inlet of the reservoirs 5c such that any electrical connection between the two oppositely electrified reservoirs is broken or about broken. The channels may direct the molten metal to at least one of the front, sides, and back of the reservoir. The channels may each comprise a gradation to cause gravity flow into the reservoirs. The channels may be at least one of graded and tilted. The grade may cause a slope towards a desired reservoir position such as the back of the reservoir relative to the center of the reaction cell chamber. The tilt of the graded channel that directs flow to a given reservoir of the two reservoirs of a dual injector embodiment may be the mirror opposite of the channel of the other reservoir to cause the flow to the opposite relative position. In an exemplary embodiment having a designated xy-coordinate system at the center of the floor of the reaction chamber with the reservoirs at positions (−1,0) and (1,0), the flow of the graded and oppositely tilted channels directs molten metal to the relative polar angles centered on the each reservoir of 3/2π and 1/2π. The floor may comprise at least one protrusion in the center and in front of each reservoir opening. The flow may be preferentially to at least one of the sides and back of the reservoirs.

In an embodiment, the generator comprises a sensor and ignition controller to reduce at least one of the ignition voltage and current to prevent a short through a cell component such as the lower hemisphere 5b41 from causing damage to the component. The electrical short sensor may comprise a current or voltage sensor that feeds a signal into the ignition controller that controls at least one of the ignition current and voltage.

In an embodiment, the molten metal may flow passively through a conduit between the two reservoirs with flow from the overfilled to the under filled reservoir. The cell may comprise rotary separator in the conduit between the reservoirs to interrupt the electrical circuit within the molten metal. The electrical short of the ignition current through the molten metal may be interrupted by a splitter comprising a movable device such as an electrically insulating gate. The gate may comprise a movable device with a plurality of vanes to interrupt the molten metal electrical conductive path. An exemplary design is that of an impeller than may comprise a refractory material such as SiC or boron nitride. The impeller may be housed in the conduit and permit metal flow without permitting an electrical connection between reservoirs.

In an embodiment, the return molten metal stream may be broken up by at least one system comprising (i) a drip edge such as a flat washer placed in the top of the reservoir inlet, (ii) at least one of nozzles 5q, molten metal level, and inlet riser lowered in the reservoirs 5c, (iii) a lower hemisphere 5b41 return molten metal flow path that disperses the flow to avoid large streams or breaks up any connective current path, (iv) a plurality of electrically insulating protrusions from the reservoir wall, (iv) a plurality of electrically insulating corrugations or reliefs cut into the drip edge, reservoir top inlet, or reservoir wall, (v) a grating such as an electrically insulating grating on the top of the reservoir, and (vi) an applied magnetic field that causes a Lorentz force to deflect the stream in to beads when an electrical shorting current flows through the stream.

In an embodiment, the SunCell® comprises a reservoir silver level equalization system comprising silver level sensors, EM pump current controllers, and a controller such as a programmable logic controller (PLC) or a computer 100 that receives input from the level sensors and drives the current controllers to maintain about equal metal levels in the reservoirs 5c. In an embodiment, the SunCell® comprises a molten metal equalizer to maintain about equal levels such as silver levels in each reservoir 5c. The equalizer may comprise a reservoir level sensor and an EM pump rate controller on each reservoir and a controller to activate each EM pump to maintain about equal levels. The sensor may comprise one based on at least one physical parameter such as radioactivity opacity, resistance or capacitance, thermal emission, temperature gradient, sound such as ultrasound frequency, level-dependent acoustic resonance frequency, impedance, or velocity, optical such as infrared emission, or other sensor known in the art suitable for detecting a parameter indicative of the reservoir molten metal level by a change in the parameter due to a change in the level or a change across the level interface. The level sensor may indicate the activation level of the EM pumps and thereby indicate molten metal flow. The ignition status may be monitored by the monitoring at least one of the ignition current and voltage.

The sensor may comprise a source 5s1 of radioactivity such as a radionuclide such as at least one of americium such as ²⁴¹Am that emits a 60 keV gamma ray, ¹³³Ba ¹⁴C, ¹⁰⁹Cd, ¹³⁷CS, ⁵⁷Co, ⁶⁰Co, ¹⁵²Eu, ⁵⁵Fe, ⁵⁴Mn, ²²Na, ²¹⁰Pb, ²¹⁰Po, ⁹⁰Sr, ²⁰⁴Tl, or ⁶⁵Zn. The radionuclide radiation may be collimated. The collimator may produce a plurality of beams such as two, each at 45° from a center axis wherein one radioisotope source may form two fan beams to penetrate each of the two reservoirs and then become incident the corresponding detector of a pair. The collimator may comprise a shutter to block the radiation when the sensor is not in operation. The source 5s1 may comprise an X-ray or gamma ray generator such as a Bremsstrahlung X-ray source such as those at http://www.source1xray.com/index-1.html. The sensor may further comprise at least one radiation detector 5s2 on the opposite side of the reservoir relative to the source of radioactivity. The sensor may further comprise a position scanner or means such as a mechanical means to move at least one of the sources of radiation and radiation detector along the vertical reservoir axis while maintaining alignment between source and detector. The movement may be across the molten metal level. The scanner may comprise the actuator that moves the inductively couple heater antenna 5f wherein at least one of the source of radiation such as an ²⁴¹Am source and radiation detector may be attached to at least one of the coil 5f, the coil capacitor box 90a, and the moving actuator mechanism. The change in the penetrating radiation counts upon crossing the level with the collimated radiation may identify the level. Alternatively, the scanner may cyclically change the relative orientation of the source and detector to scan above and below the metal level in order to detect it. In another embodiment, the sensor may comprise a plurality of sources 5s1 arranged along the vertical axis of each reservoir. The sensor may comprise a plurality of radiation detectors 5s2 on the opposite side of the reservoir relative to the corresponding source. In an embodiment, the radiation detectors may be paired with sources of radiation such that the radiation travels along an axial path from the source through the reservoir to the detector. The source of radiation may be attenuated by the reservoir metal when present such that the radiation detector will record a lower signal as the level rises over the radiation path and will record a higher signal when the level drops below the path. The source may comprise a broad beam or one having a broad angular extent of radiation that traverses the reservoir to a spatially extended detector or extended array of detectors such as an X-ray sensitive linear diode array to provide a measurement of the longitudinal or depth profile of the metal content of the reservoir in the radiation path. An exemplary X-ray sensitive linear diode array (LDA) is X-Scan Imaging Corporation X18800 LDA. The attenuation of the counts by the metal level may indicate the level. An exemplary source may comprise a spread beam from a radioactive or X-ray tube source, and the detector may comprise an extended scintillation or Geiger counter detector. The detector may comprise at least one of a Geiger counter, a CMOS detector, a scintillator detector, and a scintillator such as sodium iodide or cesium iodide with a photodiode detector. The detector may comprise an ionization detector such a MOSFET detector such as one in a smoke detector. The ionization chamber electrodes may comprise at least one thin foil or wire grid on the radiation incoming side and a counter electrode as is typical of a smoke detector circuit.

In an embodiment, the sensor comprising a source of penetrating radiation such as X-rays, a detector, and a controller further comprises an algorithm to process the intensity of the signal received at the detector from the source into a reservoir molten metal level reading. The sensor may comprise a single, wide-angle emitter and single wide-angle detector. The X-rays or gamma rays may penetrate the inside of the reservoir at an angle to the reservoir transverse plane to increase the path length through the molten metal containing region in flight to the detector. The angle may sample a greater depth of the molten metal to increase the discrimination for determining the depth of the molten metal in the reservoir. The detector signal intensity may be calibrated against known reservoir molten metal levels. As the level rises, the detector intensity signal decreases wherein the level may be determined from the calibration. Exemplary sources are a radioisotope such as americium 241 and an X-ray source such as a Bremsstrahlung device. Exemplary detectors are a Geiger counter and a scintillator and photodiode. The X-ray source may comprise an AmeTek source such as Mini-X and the detector may comprise a NaI or YSO crystal detector. At least one of the radiation source such as the X-ray source and detector may be scanned to get a longitudinal profile of the X-ray attenuation and thereby the metal level. The scanner may comprise a mechanical scanner such as a cam driven scanner. The cam may be turned by a rotating shaft that may be driven by an electric motor. The scanner may comprise a mechanical, pneumatic, hydraulic, piezoelectric, electromagnetic, servomotor-driven or other such scanner or means known by those skilled in the art to reversibly translate or re-orient at least one of the X-ray source and detector to depth profile the metal level. The radioisotope such as americium may be encased in a refractory material such as W, Mo, Ta, Nb, alumina, ZrO, MgO, or another refractory material such as one of the disclosure to permit is it to be placed in close proximity to the reservoir where the temperature is high. At least one of the X-ray source and emitter and detector may be mounted in a housing that may have at least one of the pressure and temperature controlled. The housing may be mounted to the outer pressure vessel 5b3a. The housing may be removal to permit easy removal of the outer pressure vessel 5b3a. The housing may be horizontally removal to permit the vertical removal of the outer pressure vessel 5b3a. The housing may have an inner window for passage of X-rays while maintaining a pressure gradient across the window. The window may comprise carbon fiber. The outer end of the housing may be open to atmosphere or closed off.

In an embodiment, the level sensor comprises a source of X-rays or gamma rays that is inside of a well or housing inside of the reservoir 5c. The source of X-rays or gamma rays may be a radionuclide such as ⁴¹Am, ¹³³Ba, ¹⁴C, ¹⁰⁹Cd, ¹³⁷Cs, ⁵⁷Co, ⁶⁰Co, ¹⁵²Eu, ⁶⁶Fe, ⁵⁴Mn, ²²Na, ²¹⁰Pb, ²¹⁰Po, ⁹⁰Sr, ²⁰⁴Tl, or ⁶⁵Zn. The well may be fastened to the base plate of the EM pump assembly 5kk. The radionuclide may be encapsulated in a refractory material such as carbon, W, boron nitride, or silicon carbide. The radionuclide may comprise a refractory alloy. The radionuclide may comprise an element or compound with a high melting point such as ¹⁴C, Ta₄Hf¹⁴C₅ (M.P. 4215° C.), ¹³³BaO, ¹⁴⁷Pm₂O₂, ¹⁴⁴Ce₂O₃, ⁹⁰SrTiO₃, ⁶⁰Co, ²⁴²Cm₂O₃, or ¹⁴⁴Cm₂O₃. The walls of the well may comprise a material that is readily penetrated by X-rays or gamma rays. An exemplary well is a boron nitride well. The reservoir may comprise a material that is readily penetrated by X-rays or gamma rays such as boron nitride or silicon carbide reservoir. The level sensor may comprise a plurality of sources of X-rays or gamma rays that may be collimated to form a plurality of beams. The level sensor may comprise a plurality of X-ray or gamma ray detectors outside of the wall of the reservoir and positioned to be incident the X-rays or gamma rays when not attenuated by the molten metal such as silver. The location of the differential in the attenuation of the beams indicates the position of the level as determined by the processor. In an embodiment, the source of X-rays or gamma rays such as a radionuclide inside the well may not be collimated. The intensity of the X-ray or gamma ray signal may be detected at the at least one detector external to the reservoir. The detector may comprise a scintillator crystal and a photodiode such as a Gadox, CsI, Nal, or CdW photodiode. The signal intensity as a function of molten metal level may be calibrated. The level sensor may comprise a processor that processes the measured signal intensity and the calibration data from a lookup table and determines the molten metal level.

In an embodiment, the level sensor comprises a particle backscattering type. The level sensor may comprise a source of particles such as at least one of helium ions, protons, X-rays or gamma rays, electrons, and neutrons. The source may comprise a collimated source. The particles may be incident the reservoir 5c at a plurality of vertical coordinate positions or may be scanned over a plurality of vertical positions over time. The particles may backscatter with an intensity change when incident on the reservoir at a vertical position that is above the molten metal level as compared to below the level. The intensity change may increase or decrease depending on the particle and its energy. X-rays may be absorbed by molten metal such as silver such that the backscattering from the far reservoir wall may be decreased due to the intervening molten metal. Consequently, the intensity of backscattered X-rays may decrease when the X-rays are incident the reservoir at a vertical coordinate position below the level. The energy of the X-ray may be selected to have a high attenuation in the molten metal such as silver compared to the attenuation in the reservoir wall. The X-ray energy may be selected to be just at an electronic edge, energy above the binding energy of an electronic shell. The X-ray source may comprise a radioisotope or an X-ray generator. In an embodiment, a decrease in backscattered X-rays is detected as a means to identify the level wherein the X-ray energy is selected such that the backscattered signal is highly attenuated by the silver below the level compared to no column of silver above the level. The energy of high absorption may be the edges such as the 25 keV energy of the silver K edge.

In an embodiment, the incident particle may give rise to a secondary particle or the same particle of a different energy. A change in the intensity of secondary particle emission may be used to detect the level. In an exemplary embodiment, X-rays of a first energy are incident the reservoir at different vertical positions, and X-rays of a second energy are detected by a detector. The change in intensity of the X-rays of the second energy or fluorescent X-rays as the level is crossed between beams or between beams indicates the level. The detector may be at a location that maximizes the fluorescent X-ray signal such as along the same axis as the incident beam at 0° or 180° or at 90°, for example. In an embodiment, the fluorescent X-rays of silver increase when the incident beam is incident the reservoir below the level versus above the level. The level sensor may comprise an X-ray fluorescence (XRF) or energy-dispersive X-ray fluorescence (EDXRF) system known in the art. The X-ray source may comprise a radioisotope or an X-ray generator. The EDXRF system may comprise a source of high-energy particles such as electrons or protons. The detector may comprise a silicon drift detector or others known by those skilled in the art.

The intensity may increase when neutrons backscatter from the silver column indicating the level location. The neutrons may be generated from ²⁴¹Am and beryllium metals. The neutron source may comprise a neutron generator such as one that uses electric fields to accelerate at least one of deuterium and tritium ions to cause D-D or D-T fusion with neutron production. The back-scattered particle may be detected with the corresponding detector such as an X-ray or neutron detector. In another embodiment, the particles may be emitted from the source on one side of the reservoir and detected on the same axis on the other side of the reservoir. The vertical reservoir position of an increased attenuation of the particle beam detected as a detector intensity drop may identify the position of the level. Exemplary neutron backscattering and gamma ray attenuation level sensors of the present disclosure are ones that are commercially available from Thermo Scientific (https://tools.thermofisher.com/content/sfs/brochures/EPM-ANCoker-0215.pdf) modified for the geometry of the reservoir 5c.

In an embodiment, the level sensor may comprise a source of electromagnetic radiation that selectively reflects from the molten metal below the molten metal level and a detector of the intensity of the reflected radiation. The level may be detected by the enhanced laser reflection intensity below the level compared to the reflection intensity above the level. The position of the level may be determined from the position of the incident beam along the vertical reservoir axis that results in enhanced reflection intensity. The radiation may comprise a wavelength that is sufficiently transparent to the reservoir wall such that it penetrates the wall and is reflected back to the detector. The reservoir 5c wall may be capable of transmitting light. The reservoir may be comprised of at least one of alumina, sapphire, boron nitride, and silicon carbide that are transparent to visible and infrared light. The radiation may penetrate a thin film of the molten metal. The laser may be sufficiently powerful to penetrate a thin film of the molten metal. In an embodiment, the reservoir wall may comprise boron nitride that has some transparency for radiation in the wavelength range of the radiation such as in the region of UV to infrared. The laser may comprise a high-power visible or infrared diode laser. A cell component such as the reservoir may be transparent to the laser beam. Suitable refractory materials that are transparent to infrared are MgO, sapphire, and Al₂O₃. The laser may comprise an infrared laser to better maintain focus. In an embodiment, comprising a boron nitride, the wavelength may be about 5 microns since BN has transmission window at this wavelength. In an embodiment, the laser that has sufficient power to penetrate the reservoir walls such as boron nitrides walls, any silver wall coating, and silver vapor in the axial path from the laser to the detector. The walls may be thinned at the spots of laser beam-wall contact. The walls may be machined to prevent the laser beam from diffusing or spreading. The walls may be planed flat. The walls may be machined to form a lens that refocuses light that transverses the wall. The lens may be matched to the laser wavelength. The wall may comprise an embedded lens. The lens may comprise an antireflective coating. The lens may comprise a quarter wave plate to decrease reflection. A transmitted light signal indicates the absence of the reservoir silver column, and the absence of a light signal indicates the presence of the silver column, and the vertical reservoir position of the light signal discontinuity may be used to identify the level. The laser may comprise a lens to increase at least one of the focus and the power density (beam intensity). Exemplary commercial lasers are given at http://www.freemascot.com/match-lighting-laser.html or http://www.freemascot.com/50mw-532nm-handheld-green-laser-pointer-1010-black.html?gclid=CNu8gl-EqtlCFZmNswodZLMNQA. At least one of the laser and detector may stand off from the reservoir to be located in a region that is not overly elevated in temperature to compromise the laser or detector function. At least one of the laser and detector such as a photodiode may be cooled.

The molten metal may comprise silver. Silver has a transmission window at wavelength of about 300 nm. The radiation may comprise a wavelength in the range of about 250-320 nm. The source of radiation may comprise a UV diode such as UVTOP310. The UV diode may comprise a lens that may comprise a hemisphere lens to make a directed beam. The source of radiation may comprise a laser such as a diode pumped laser. Exemplary lasers in the wavelength region of the transmission window of silver are KrF excimer, Nd:YAF 4^{th} harmonic, InGaN diode, XeCl, He—Cd, nitrogen, XeF excimer, and Ne⁺ lasers. The detector may comprise a photodiode.

The laser-type level sensor may comprise a laser scanner that moves at least one of the laser and detector vertically over time to intercept the area above, at, and below the level to detect the level. Alternatively, the current radiation-illumination-type level sensor may comprise a plurality of radiation sources and corresponding detectors spaced vertically such that the level is at a location in proximity to the plurality of sources such that the location of the level may be detected by the differential reflection between sources and their detectors. The radiation source and detector may be angled relative to each other such that the source radiation may reflect from the molten metal column when present and become incident the corresponding detector. The wall of the reservoir may be machined thinner at the point of incidence and reflection of the radiation to permit it to propagate from the source to the detector upon reflection from the molten metal column. In another embodiment, the radiation may penetrate both walls of the reservoir in the absence of the column of molten metal in the beam path, and the column may block the beam when the beam path is below the level. The transmission of the beam through the reservoir may be detected by the detector that may be located on the opposite side of the radiation source such as a laser. The radiation source and corresponding detector may be scanned in unison, or the level sensor may comprise a plurality of radiation sources and corresponding detectors spaced along the vertical axis of the reservoir to detect the level by the difference in transmission of the beams above versus below the molten metal level. In an embodiment, the RF coil 5f has openings for the incident and the reflected or transmitted beam. The coil 5f may be designed to compensate for any opening to provide the desired heating power distribution in the absence of the openings.

The sensor may comprise at least one of at least one drip edge, downward angled tube, or a source of heat such as a laser such as a diode laser and a vibrator to at least partially eliminate a molten metal film on the reservoir wall above the level that may reflect the radiation. In an embodiment, any molten metal film may be removed by a drip edge at the position of returning metal at the point of the beam path intersection with the reservoir wall. The cell may comprise at least one of a reservoir vibrator or pinger and a heater. Any molten metal film at the intersection point may be removed by vibration or by heating the wall at the point. The beam may be intensified to penetrate the metal film by using at least one of a more powerful beam and a lens.

The laser beam may be oriented at an angle with respect to the reservoir wall to cause reflection at an angle to increase the transmission through any thin silver layer such that the reflection is reduced as monitored. In an embodiment, the laser beam angle is adjusted to create an evanescent wave wherein the reflection increases below the silver level versus above it. In an embodiment, the sensor may comprise a fiber optic cable in a well having some transparency with reflected light quantified. The reflection intensity detected by a detector such as a photodiode permits the determination of the location of the level by a processor.

The laser wavelength may be selected to increase the transmission through the reservoir wall and any silver film coating. An exemplary wavelength is about 315 nm since silver has a transmission window at about 315 nm. The light detector such as a photodiode that may optionally comprise an optical wavelength pass filter may be selectively responsive to the laser light. In an embodiment, a lamp may replace the laser. The lamp may comprise a powerful light-emitting diode (LED) array. The level sensor may comprise a short wavelength source such as one capable of emitting UV light such as in the wavelength region of about 315-320 nm. The short wavelength source may comprise a deuterium lamp to illuminate the reservoir. The lamp may comprise a visible or infrared lamp. In an embodiment, the source of illumination such as short wavelength light above the silver level may be the plasma emission.

In an embodiment, the plasma illuminates the space above the molten metal level with intense light that is transparent to the reservoir. The transparent reservoir may comprise a transparent material such as at least one of boron nitride, silicon carbide, and alumina. The molten metal level may be recorded by measuring the discontinuity of light at the metal level using at least one light detector such as a photodiode.

In an embodiment, the reservoir 5c wall is capable of transmitting light. The reservoir may be comprised of at least one of alumina, sapphire, boron nitride, and silicon carbide that are transparent to visible and infrared light. In an embodiment, the molten metal level sensor comprising a light transmission type level sensor detects light transmitted from inside the reservoir 5c to the outside, and the vertical variation in transmitted light intensity at least one light senor is processed by a processor to determine the molten metal level. The processor may receive data from both reservoirs and correlate the data to remove any opacification influence from molten metal flowing on the reservoir wall that may otherwise falsely indicate the presence of the molten metal level.

In an embodiment, the plasma created by the ignition in the reaction cell chamber 5b31 illuminates the reservoir 5c wall, and some light penetrates the wall selectively in regions above the molten metal level. A light sensor such as a camera or a photodiode may detect the light that is transmitted through the reservoir wall. The light sensor such as a photodiode may be vertically scanned or the level sensor may comprise a plurality of vertically separated light sensors such as photodiodes. In an embodiment to determine the molten metal level, the processor processes at least one of i) the difference in light intensity over a camera image, ii) the difference in light intensity between a plurality of light sensors, and iii) the difference in light intensity between vertical positions of a scanned light sensor.

To facilitate the transmission or passage of plasma light through the reservoir wall to a light sensor, the reservoir may comprise at least one light passage such as an indentation, recess, or thinned region in the wall. The at least one light sensor such as a camera, a plurality of optical sensors, or a scanned optical sensor such as a diode may record the transmitted light variation with passage height along the reservoir. The light may be conducted to each remote light sensor by a fiber optic cable such as a high temperature fiber optical cable such as a quartz cable. The fiber optic cables or other light conduit may increase the internal light signal over the background blackbody light. The internal signal from plasma light may be increased over the blackbody radiation by using a light detector that is selective for shorter wavelengths relative to the spectrum of the blackbody radiation from the external reservoir wall. The detector may comprise a selective short wavelength detector or filter on the detector. The detector or filter may permit selective detection of blue or UV radiation. The detector may detect short wavelength light that is transmitted by the reservoir wall such as light longer than about 320 nm in the case of a boron nitride wall. The background light such as blackbody radiation may be blocked with a light blind with penetrations along the line of sight of the light passages. The level sensor may comprise at least one stationary or scanned mirror to reflect the transmitted light from at least one wall location to a remote light sensor. In an exemplary embodiment to accommodate the near proximity of the heater antenna 5f to the reservoir 5c, the transmitted light is reflected downward to the base of the generator to be incident the light detector. The mirror may be mounted on the antenna 5f A processor may receive and process the light sensor data to determine the molten metal level.

In an embodiment, the level sensor comprises a field source such as a current coil, an antenna, or a lamp internal to the cell such as internal to the reservoir that emits a field such as at least one of a magnetic field and an electromagnetic radiation to an external field detector. The intensity or spatial variation of the detected signal is a function of the molten metal level, and a processor uses the corresponding data to identify the molten metal level.

In an embodiment, the light transmission molten metal level sensor comprises a light source that illuminates the reservoir wall to produce an image or a vertical light intensity variation that in input to a processor to identify the level. The light source may comprise at least one of a lamp, laser, and the plasma. The lamp may be internal to the reservoir. The lamp may comprise an incandescent lamp such as a W lamp or W halogen lamp. The lamp may comprise a bare W filament connected to leads encased in an electrical insulator that may comprise a refractory ceramic such as SiC or BN. The lamp may comprise two separated electrodes that can support plasma such as arc plasma. The lamp may comprise a carbon arc. The insulation may serve as a support, or the lamp may comprise a conduit that serves as a support. The conduit may comprise a refractory material such a one of the disclosure. Leads to an external power supply may power the lamp. The power supply may be one shared with at least one of the EM pump power supply, the ignition power supply, and the inductively coupled heater power supply. The power supply may be in the second chamber of the outer cell housing. The leads may penetrate the reservoir at a feed through in the base of the EM pump assembly 5kk. The lamp may be housed in a well that may penetrate at the base of the EM pump assembly 5kk. The well wall may be at least partially transparent to the internal lamp. The well may comprise a refractory material such as at least one of alumina, sapphire, boron nitride, and silicon carbide that are at least partially transparent to light. In an embodiment, the lamp may illuminate the inside of the well. The lamp may be beneath the well. The well may comprise at least one mirror or light diffuser to cause the light to be transmitted radially from the well (in the horizontal plane).

The light sensor may eliminate interference from the background blackbody emission of the reservoir wall. The light sensor may be selectively responsive to the plasma or lamplight. The light sensor may comprise a filter to pass a selective wavelength region characteristic of the plasma or lamplight. The light sensor may be responsive to a plurality of wavelengths characteristic of the plasma or lamplight. The light sensor may comprise an optical pyrometer or optical temperature sensor.

In an embodiment, the cell is heated to a desired temperature profile that supports plasma formation and molten metal recirculation and at about the commencement time of the molten metal injection by the EM pumps. The heater coil 5f may extend over at least a portion of the blackbody radiator 5b4 to heat it to a desired temperature profile. The heater may be retractable by the actuator. The ignition voltage may be applied such that ignition and plasma formation occur at the time that the molten metal streams from the dual EM pumps intersect. The plasma light may be transmitted through the reservoir wall directly or through passages to permit the molten metal level to be detected.

The sensor may comprise a series of electrical contacts spaced along the vertical axis of the reservoir and at least one of a conductivity and capacitance meter to measure at least one of the conductivity and capacitance between electrical contacts wherein at least one of the conductivity and capacitance changes measurably across the molten metal level inside the reservoir. The electrical contracts may each comprise a conductive ring around the inside or outside circumference or a portion of the circumference of the reservoir. The conductivity meter may comprise an ohmmeter. In an embodiment, the at least one of conductivity or capacitance probes may comprise a plurality of leads that enter through the EM pump tube, travel along the EM pump tube, and exit the EM pump tube at a plurality of spatially separated locations within the desired height range of the molten metal level. The lead exits may terminate in a sensor or probe. Alternatively, the wires may travel in a well that may be welded in to the bottom of the EM pump assembly 5kk . The probe may comprise a conductor or capacitor. The conductivity between or the relative conductivities at the separate probes may be used to detect the molten metal level wherein the conductivity increases when the probe is in contact with the molten metal. The leads may comprise electrically insulated wires that penetrate the EM pump tube outside of the reservoir at a sealed feed through such as a Swagelok. The leads may exit the EM pump tube inside of the reservoir through electrically insulated penetrations that may or may not be sealed. The wires may be coated with a refractory electrical insulator such as boron nitride or another refractory coating of the disclosure. The wire may be coated with Al that is anodized. The wire may comprise a refractory conductor such as Mo, W, or another of the disclosure. In an embodiment, the wires may be replaced by refractory fiber optic cables wherein the level is sensed fiberoptically.

In an embodiment comprising reservoirs comprising an electrical insulator such as SiC, BN, Al₂O₃, or ZrO₂, the plurality of longitudinally spaced wires may pass through the wall of the reservoir and span the range of the molten metal level. The wires may be bare. The wires may be sealed by a compression seal. The wires may be sintered or cast in place during reservoir fabrication. Alternatively, the wires may be inserted through tightly-fitting penetrations. The penetration such as holes may created by machining, electrical discharge milling, water jet drilling, laser drilling or other method known in the art. The tightly-fitting wires may have a higher thermal coefficient of expansion than that of the reservoir material such that a compression seal forms when the reservoir is heated. The wires may sense at least one of a conductivity change and a capacitance change with a change in molten metal level.

The level sensor that senses the molten silver level by at least one of a change conductivity, inductance, capacitance, and impedance as a function of molten metal level may comprise a reference electrical contact such as one on the base of the EM pump assembly 5kk and at least one probe wire housed in a well that is fastened to the bottom of the reservoir such as at the bottom of the EM pump assembly 5kk. The capacitance sensor may comprise two plates that may fill with molten metal depending on the level and be responsive to the level. The inductance sensor may comprise a coil wherein the flux linked by the coil is dependent on the molten metal level. The well may be fastened by a fastener such as a Swagelok or may be welded to the bottom of the EM pump assembly. The wires may be electrically and physically attached to the inner wall of the well at each wire's end. The corresponding electrical contacts of the at least one wire may be vertically spaced. An exemplary well comprises a refractory metal tube such as a Mo tube that may be fastened with a welled-in stainless steel Swagelok at bottom of the EM pump assembly 5kk wherein a conductivity probe wire insulated by an alumina sheath enters the open end at the bottom, travels inside the tube, and is attached by a weld to a Mo cone welded at the end of the tube. A metal probe capable of re-crystallization at elevated temperature may be pre-heated to recrystallize the metal before applying it as a probe. The conductivity is measured between the probe wire and a reference contact attached to the base of the EM pump assembly 5kk. In another embodiment, the outlet portion of the EM pump tube 5k6 serves as the well. As the silver level rises, the conductivity between the probe and the reference drops due to the parallel path of the probe current through the molten metal. The conductivity as a function of the metal level may be calibrated. The calibration may be according to the well temperature. The well may further contain at thermocouple to measure the well temperature at the probe to permit the selection of the corresponding calibration. Alternatively, the conductivity sensor may comprise two matched probes in separate reservoirs such as two matched re-crystallized W tubes wherein the relative EM pumping rates are controlled to match the conductivities of the two probes to control and match the levels of the molten metal in the two reservoirs. The sensor may further comprise a calibration curve for any offset conductivity between probes as a function of at least one of the average conductivity and the operating temperature. The conductivity probe may comprise an electrically insulating sheath or coating to prevent arcing with the ignition power while maintaining a sufficient electrical connection to sense the conductivity. The conductivity probe may comprise a semiconductor that may be doped. The conductivity may be measured with a high frequency probe current or voltage and the corresponding voltage or current signal to determine the conductivity may be further filtered to remove the effects of noise such as that due to the ignition current.

The level sensor that senses the molten silver level by at least one of differential conductivity or capacitance between or at a plurality of conductors as a function of molten metal level may comprise a plurality of conductors such as wires through the reservoir wall. The reservoir wall may comprise an electrical insulator such as boron nitride or silicon carbide. The wires may be sealed by compression due to the differential expansion of the wires relative to the wall material. For example, Mo, Ta, and Nb each have a favorable higher thermal expansion coefficient than SiC. The seal may be achieved for a cell at room temperature by performing at least one initial step of heating the wall and cooling the wires by means such as by applying a cryogen such as liquid nitrogen before inserting the wires through holes in the reservoir wall that are a tight fit in the absence of wall heating or wire cooling. In another embodiment, the wires may be sealed by molding, gluing, or sealing. Alternatively, the seal may be achieved during fabrication by incorporating the wires into the wall material. The wires may be sealed into place during reservoir fabrication using a glue or sealant.

The sensor may comprise a level-dependent acoustic resonance frequency sensor. The reservoir may comprise a cavity. In general, cavities such as musical instruments such as partially filled water bottles each have a resonance frequency such as a fundamental note depending on the water fill level. In an embodiment, the reservoir cavity has a resonance acoustic frequency that is dependent on the molten metal fill level. The frequency may shift as the molten metal level changes and the volume of the gas filled portion versus metal filled portion of the reservoir cavity changes. At least one resonance acoustic wave may be supported in the reservoir with a frequency that is dependent on the fill level. The sensor may be calibrated using the fill level and corresponding frequency at a given operating condition such as reservoir and cell temperatures.

The resonance acoustic sensor may comprise a means to excite an acoustic wave such as a standing acoustic wave and an acoustic frequency analyzer to detect the frequency of the level dependent acoustic wave. The means to excite the sound in the reservoir cavity may comprise a mechanical, pneumatic, hydraulic, piezoelectric, electromagnetic, servomotor-driven source means to reversible deform the wall of the reservoir. The means to at least one of excite and receive the sound in the reservoir cavity may comprise a driven diaphragm. The diaphragm may cause sound to propagate into the reservoir. The diaphragm may comprise a component of the cell such as at least one of an EM pump, the upper hemisphere and the lower hemisphere. The contact between the acoustic excitation source and the component for acoustic excitation may be through a probe such as a refractory material probe that is stable to the temperature of the contact point with the component. The means to excite the sound in the reservoir cavity may comprise a pinger such as a sonar pinger. The frequency analyzer may be a microphone that may receive the resonance frequency response of the reservoir as sound through gas surrounding the component. The means to receive and analyze the sound may comprise a microphone, a transducer, a pressure transducer, a capacitor plate that may be deformable by sound and may have a residual charge, and may comprise other sound analyzers known in the art. In an embodiment, at least one of the means to cause the acoustic excitation of the reservoir and to receive the resonance acoustic frequency may comprise a microphone. The microphone may comprise a frequency analyzer to determine the fill level. At least one of the excitation source and the receiver may be located outside of the outer pressure vessel 5b3a.

In an embodiment, the acoustic sensor comprises a piezoelectric transducer of sound frequency. The sensor may receive sound through a sound guide such as a hollow conduit or a solid conduit. The sound may be exited with a reservoir pinger. The piezoelectric transducer may comprise an automotive knock sensor. The knock senor may be matched to the acoustic resonance characteristics of the reservoir with the silver at the desired level. The resonance characteristics may be determined using an accelerometer. The sound conduit conductor may be directly attached to the reservoir and the transducer. The sound conductor may comprise a refractory material such as tungsten or carbon. The transducer may be located outside of the hot area such as outside of the outer pressure vessel 5b3a. In an exemplary embodiment, a knock sensor is threaded into a hole in the base plate 5b3b of the outer vessel 5b3a connected to the sound conductor that is in contact with the reservoir on the opposite end. The conduit may travel along the vertical axis to avoid interference with the motion of the coil 5f. A notch filter could selectively pass the frequencies appropriate for sensing the silver level in the reservoir. The controller may adjust the EM pump currents to change the silver level to the desired level as determined from the frequencies that are a function of level.

The acoustic sensor may comprise at least one probe or cavity inside of the reservoir. The cavity may comprise a well. The well may be welded into the base of the EM pump assembly 5kk. The well may be hollow or solid. The probe may comprise a closed-end tube or a rod connected to the base of the EM pump assembly 5kk by a fastener such as a Swagelok. The probed or cavity may be caused to vibrate by a pinger. The pinger may be located outside of the elevated temperature regions by a connecting rod such as a refractory material connecting rod such as one comprising Mo, W, or Ta or stainless steel that transmits the pinging action of the pinger. The orientation may be one that is most efficient at vibrational excitation. A vibration sensor such as a microphone may sense the vibrational frequency wherein the frequency is characteristic and used to determine the molten metal level about the probe or cavity. The probe or cavity may be selected to facilitate the acoustic frequency sensing of the molten metal level. The frequency dependence of the molten level may be calibrated. The calibration may be adjusted for the operating temperature that may be measured. A metal probe capable of re-crystallization at elevated temperature may be pre-heated to recrystallize the metal before applying as a probe. Alternatively, the acoustic sensor may comprise two matched probes in separate reservoirs such as two matched re-crystallized W tubes wherein the relative EM pumping rates are controlled to match the frequencies of the two probes to control and match the levels of the molten metal in the two reservoirs. The sensor may further comprise a calibration curve for any offset frequency between probes as a function of at least one of the average frequency and the operating temperature.

The probe or cavity may comprise a refractory material such as at least one of Mo, titanium-zirconium-molybdenum (TZM), molybdenum-hafnium-carbon (WIC), molybdenum-lanthanum oxide (ML), molybdenum-ILQ (MoILQ), molybdenum-tungsten (MoW), molybdenum-rhenium (MoRe), molybdenum-copper (MoCu), molybdenum-zirconium oxide (MoZrO₂), W, carbon, Ta, alumina, zirconia, MgO, SiC, BN, and other refractory metals, alloys, and ceramics of the disclosure and those known in the art. A metal probe may comprise an electrical insulating cover or sheath or an electrical insulating coating such as Mullite, SiC, or another of the disclosure or known in the art to prevent arcing with the ignition power. The ceramic probe may comprise a hollow cavity such as hollow tube with the ends sealed. The ceramic probe may be fastened to the bottom of the EM pump assembly by a threaded joint such as a matching threaded welded in collar on the base of the EM pump tube assembly. Other exemplary fasteners comprise a locking collar, a clamp, a setscrew collar or holder, and a Swagelok holder device. An exemplary ceramic probe comprises a bored out boron nitride (BN) tube that is not bored at one end and is sealed at the other that screws into a threaded stainless steel collar welded to the base of the EM pump tube assembly. The probe may further comprise a pin that penetrates the base of the EM pump assembly and the sealed end of the ceramic probe to penetrate the hollow portion. The pin may be threaded. The pin may screw into at least one of the base of the EM pump assembly and the sealed end of the ceramic tube. The tube may comprise boron nitride. The pin may be used to at least one of transmit and receive acoustic energy along the probe. The probe may comprise a piezoelectric or microelectromechanical system (MEMS) wherein the excitation and sensing of at least one of the acoustic frequency, vibration, and acceleration may be achieved by applying and sensing the piezoelectric voltage or MEMS signal. The sensor may comprise an accelerometer that measures the molten metal damped acceleration or probe vibrational frequency. The excitation and sensing may be achieved using the same device. The pinging and sensing means may be combined in the same device. The molten metal level may be controlled to match the acoustic responses of separate probes in separate reservoirs wherein any off set may be determined by calibration and used in the matching control algorithm.

In an embodiment, the acoustic sensor may comprise a pinger that excites motion such as vibration in the outlet portion of the EM pump tube 5k6. The excitation may be continuous, at a desired frequency such as a mechanical resonance frequency of the EM pump tube, or intermittent. The end of the EM pump tube may comprise an attached vibrational dampener. The vibrational dampener may comprise blades that are transverse to the longitudinal axis of the EM pump tube. The vibrational dampener may comprise a refractory material. The material may be an electrical insulator such as boron nitride or SiC. The dampener may fasten to the nozzle 5q by a fastener. The fastening may be achieved using threaded parts. The threaded dampener and nozzle or end of the EM pump tube may be screwed together. The dampener may be near the surface of the molten metal. The dampener may be submerged or partially above the metal surface. The depth of the dampener in the molten metal may determine the amount of vibrational dampening. The vibrational dampening may be measured by at least one of a frequency, acceleration, or amplitude change in the acoustic energy re-emitted by the EM pump tube. The emitted acoustic energy may be sensed on the EM pump tube such as a position outside of the reservoir. Alternatively, the emitted acoustic energy may be sensed from the reservoir wall. A high-temperature-capable conduit that may be attached to the reservoir wall may transmit the sound. The attachment may comprise a threaded-in connection or a clamped collar around the reservoir. In an embodiment, the acoustic sensor comprises an external sound dampening or cancellation means to improve the acoustic signal to noise. The dampening means may comprise sound absorbing material such as those known in the art. The sound cancellation means may comprise an active sound cancellation system such as one known in the art.

Alternatively, the vibrating object inside of the reservoir such as the EM pump tube or probe may transmit its vibrations to the reservoir wall that will likewise vibrate. The reservoir wall vibrations may be measured electromagnetically by a device that detects shifts in the frequency or position of reflected light that is initially incident to the vibrating wall. The incident electromagnetic radiation may be in a wavelength range that has a high reflectivity such as in the visible to microwave region. An analyzer may comprise a heterodyne or an interferometer to measure frequency shifts or a position sensor to measure the position shift. The analyzer may comprise a means to convert the reflected beam into electrical signals such as a photovoltaic cell, photodiode, or phototransistor. The sensor may comprise a signal processor to process the frequency or position shifts into the acoustic signal that is a function of the molten metal level. The acoustic sensor may comprise a visible, infrared, or microwave laser interferometer microphone. The laser may comprise a diode laser. An exemplary laser microphone that relies on the frequency shifts of a returning or reflected laser beam caused by the reservoir wall movement wherein the frequency shifts are detected by an interferometry is that given by Princeton University (http://www.princeton.edu/˜romalis/PHYS210/Microphone/). An exemplary laser microphone that relies on the position shifts of a returning or reflected laser beam caused by the reservoir wall movement is that given by Lucidscience (http://www.lucidscience.com/pro-laser%20spy%20device-1.apx; hackaday http://hackaday.com/2010/09/25/laser-mic-makes-eavesdropping-remarkably-simple/). In another embodiment, the time of flight of laser pulses as a function of time are used to measure the wall displacements and frequency and amplitude of the acoustic signal. The acoustic sensor may comprise a light detection and ranging (LIDAR) system. A microphone that may be attached to the reservoir wall may measure the wall vibrations. The microphone may comprise a piezoelectric device.

The acoustic analyzer may be one of the disclosure such as a microphone and frequency analyzer. The molten metal level may be controlled to match the acoustic responses of separate sensors of separate reservoirs wherein any off set may be determined by calibration and used in the matching control algorithm. Alternatively, the sensor may comprise the probe further comprising a vibration dampener on the end of it. The dampener may amplify the signal due to any molten metal level change.

The sensor may comprise two parallel plates introduced with electrical sensing connections through penetrations in the base of the EM pump assembly 5kk. The molten metal may fill the plates to the level of the molten metal. The metal plates may be caused to vibrate by the pinger. At least one of inductance and capacitance changes due to the change in vibration frequency that is a function of the molten metal level between the plates. In another embodiment, at least one of an opposing pair of magnetic coils and capacitor plates are embedded in an electrical insulator well such as one comprising boron nitride. The pinger may vibrate the well, and at least one of the inductance and capacitance between the coils or plates may be read through the electrical connections wherein those parameters are a function of the metal level between the opposed members of the pair. The reading may be achieved by applying at least one of a current and a voltage on the coils and plates.

The level sensor may comprise a light detection and ranging (LIDAR) system wherein the time of flight of laser pulses emitted from an emitter of the sensor, reflected from the level, and detected by detector of the sensor are measured by the sensor to acquire the position of the molten metal level. In another embodiment, the level sensor may comprise a guided radar system. Electromagnetic radiation of a different frequency such as radar may replace the light of a LIDAR system.

In another embodiment, the level sensor may comprise an ultrasonic device such as a thickness gauge that comprises an ultrasonic emitter and receiver that senses the molten metal level by converting the time of flight of a pulse of sound energy, sent into and reflected back from the reservoir interior. The sound may travel vertically to sense the depth of the molten metal. The emitter and receiver may be located at the base of the EM pump assembly 5kk to send and receive sound along the vertical or reservoir longitudinal axis, also referred to as the z-axis. In another embodiment, the emitter and receiver may be located at side of the reservoir. The sound may be sent and received along the transverse axis or plane. The reflections may be from the reservoir opposite wall or molten metal surface when the metal level intercepts the sound. The emitter and receiver may comprise a plurality of devices spatially separated along the z-axis to image the level. The emitter and receiver may comprise the same device such as a piezoelectric transducer. The transducer may be in direct contact with the base of EM pump assembly 5kk or the reservoir wall. Alternatively, the sound may be transmitted using a sound conduit that may be capable of operating at high temperature. An exemplary thickness sensor is an Eleometer MTG series gauge (http://www.elcometerusa.com/ultrasonic-ndi/Material-Thickness-Gauges/). The time of flight data may be processed by a processor calibrated to determine the metal level from the data and to control the relative EM pump rates to control the reservoir metal levels.

In another embodiment, the level sensor may comprise at least one stub sensor known in the art such as a microwave stub sensor. The stub sensor may be scanned over the region of the molten metal level to detect it. The scanning may be achieved by an actuator such as a mechanical, electro-mechanical, piezoelectric, hydraulic, pneumatic, or other type of actuator of the disclosure or known in the art. Alternatively, the level sensor may comprise a plurality of stub sensors that may sense the level by a comparison of the signal between the plurality of stub sensors.

In an embodiment, the level sensor may comprise an eddy current level measurement sensor (ECLMS). The ECLMS may comprise at least three coils such as a primary and two secondary sensing coils. The ECLMS may further comprise a high frequency current source such as an RF source. The RF current may be applied to the primary coil to generate a high frequency magnetic field that consequently generates an eddy current in the molten metal at the surface. The eddy current may induce voltages in the two sensing coils that may be located on either side of the primary coil. The difference in voltages of the sensing coils changes with different distances from the sensor to the metal surface. The ECLMS can be calibrated to the molten metal level so it may read the level during cell operation.

The sensor may comprise an impedance meter that is responsive to the reservoir silver level. The impedance meter may comprise a coil that is responsive to the inductance that is function of the metal level. The coil may comprise the inductively coupled heater coil. The coil may comprise a high-temperature or refractory metal wire such as W or Mo coated with high temperature insulation. The wire pitch of a coil may be such that non-insulated wire does not electrically short. The molten silver may comprise an additive such as a ferromagnetic or paramagnetic metal or compound such as ones known in the art to increase the inductance response. The inductance may be measured by the phase shift between the current and voltage measured on an alternating current waveform driven coil. The frequency may be radio frequency such as in the range of about 5 kHz to 1 MHz.

In an embodiment, the level sensor may comprise an imaging sensor that comprises a plurality of emitter and receivers that emit electromagnetic signals from a plurality of locations and receive the signals at a plurality of locations to image the level. The image signal may calibrated against the level. The emitters and receivers may comprise antennas such as RF antennas. The frequency range may be in the kHz to GHz range. An exemplary range is 5 to 10 GHz RF. The imaging sensor may comprise a RF array to construct data from reflected signals. The sensor may comprise a processor to provide density type feedback from the raw data to identify the level. An exemplary imaging sensor is the Walabot comprising a programmable 3D sensor that looks into objects using radio frequency technology that penetrates the reservoir wall. Walabot uses an antenna array to illuminate the area in front of it, and sense the returning signals. The signals are produced and recorded by VYYR2401 A3 System-on-Chip integrated circuit. The data is communicated to a host device using a USB interface, which is implemented using Cypress controller. The sensor may comprise RF filters to remove RF interference from the inductively coupled heater.

The sensor may comprise a series of temperature measurement devices such as thermistors or thermocouples spaced along the vertical axis of the reservoir to measure the temperature between temperature measurement devices wherein the temperature changes measurably across the molten metal level inside the reservoir. In an embodiment, the sensor comprises a plurality of thermocouple spatially separated at different heights within the reservoir. The sensed temperature is a function of the molten silver level. The thermocouples may be sheathed in thermowell that may be welded into the bottom of the EM pump assembly 5kk. The thermowells may comprise a refractory material such as Mo, Ta, or another of the disclosure. The thermowells may be fastened in by fasteners such as Swageloks. The thermocouples such as those of the disclosure may be capable of high temperature. Multiple thermocouples may be spaced vertically in one thermowell. The outlet of the EM pump tube 5k6 may serve as the thermowell. The penetration of the EM pump tube outside of the reservoir may comprise one known in the art such as a Swagelok or electrical feed through. The thermocouples may be replaced by another temperature sensor such as an optical temperature sensor.

The sensor may comprise an infrared camera. The infrared temperature signature may change across the silver level. The level sensor may comprise at least one well and a source of electromagnetic radiation and a corresponding detector. The well may comprise a closed conduit into the interior of the reservoir 5c that may be attached at the base of the reservoir. The attachment may be at the base of the EM pump assembly 5kk . The well may comprise an electromagnetic radiation transparent material such as an electrical insulator such as alumina, MgO, ZrO₂, boron nitride, and silicon carbide. The sensor may illuminate the inside of the well with electromagnetic radiation that may pass through the wall of the well and reflect off of the molten metal level. The sensor to image the molten metal level may detect the reflected electromagnetic radiation. The electromagnetic radiation may comprise a beam that may be scanned over the region of the level. The sensor may comprise a processor to process the reflected image to determine the molten metal level. The reflected electromagnetic radiation may illuminate an area on the electromagnetic radiation detector. The area may change with relative position of the level, incident electromagnetic radiation, and detector. The illuminated detector area may change in size in response to the metal level and the corresponding cross section of a tapered well at the intersection with the molten metal level. For example, the reflection may comprise a ring that may have a smaller diameter, as the level is higher. The electromagnetic radiation of the sensor may be selected to decrease the background electromagnetic radiation. The electromagnetic radiation of the sensor may comprise a wavelength at which the blackbody radiation of the heated well or cell does not have significant background intensity. The electromagnetic radiation may comprise at least one of infrared, visible, and UV radiation. An exemplary wavelength range is about 250 nm to 320 nm wherein silver has a transmission window so that the refection is selectively due to a column of silver rather than a thin silver film.

In an embodiment, the sensor comprises a pressure sensor wherein the pressure increases as the level increases. The pressure increase may be due to the head pressure increase due to the additional weight of the molten metal column in the reservoir 5c.

In an embodiment, the sensor comprises a weight sensor to detect the change in weight of at least one reservoir or the change in the center of gravity between the reservoirs wherein the weight increases as the reservoir molten metal level increases. The differential weight distribution between the reservoirs shifts the measured center of gravity. The weight sensor may be located at a location that has a displacement or pressure change in response to an increase in mass in the corresponding reservoir. The location may be on the support of the corresponding reservoir. The weight sensor may be inside the reservoir wherein the sensor may be responsive to at least one of the weight and pressure changes with molten metal level. The sensor may transmit its signal on at least one wire that may penetrate the cell. The molten metal level may be controlled to match the weight or pressure responses of separate probes in separate reservoirs wherein any off set may be determined by calibration and used in the matching control algorithm. The wire may run from the sensor inside of the reservoir, into the EM pump tube 5k6 inlet, and penetrate the EM pump tube 5k6 on a section outside of the reservoir 5c. The penetration may be sealed with a feed through or fastener such as a Swagelok. The weight sensor may comprise a sensor that requires pressure with minimum displacement. The sensor may comprise a piezoelectric sensor or other such sensor known by those skilled in the art.

In an embodiment, the weight or pressure sensor may be housed in a housing that is removed from the elevated temperature of the cell while maintaining pressure or weight continuity. The pressure or weight connectivity may be achieved by a molten metal connection from a cell component such as the reservoir or EM pump tube such as a portion tube outside of the reservoir. The molten metal connection may comprise a column of molten metal that has a higher density than that of the molten metal in the reservoir. For example, a column of gold contained in a tube connected to the EM pump tube outside of the reservoir may connect to the housing containing the weight or pressure sensor. In an embodiment, the continuity connection may comprise a metal with a higher density and a lower metaling point than those of the metal in the reservoir in order to facilitate the use of a weight or pressure sensor that operates at a lower temperature.

The level sensor that responds to molten metal weight may comprise a balance wherein the tilt of the balance changes with silver level. The balance may comprise two rigidly connected arms. The arms may be attached to a support at a fulcrum. The balance may comprise a contact at the end of each arm. Each contact may abut a diaphragm or bellows on the reservoir bottom. The diaphragm may be dimpled such as outwardly dimpled to provide more movement. The diaphragm may be hemispherical. The diaphragm may be displaced downward as a function of the weight of molten metal in the corresponding reservoir. At least one of a portion of the arm or contacts may be electrically insulating to prevent current from flowing between reservoirs. The balance may comprise a balance beam with attached pistons on each end of the beam. The pistons may comprise electrical insulators. Each piston may abut its diaghragm in the base of the reservoir. A tilt sensor such as at least one of a displacement, strain, or torsion sensor may sense the tilt of the beam or arm. The tilt sensor may comprise an extension from the beam that amplifies the tilt sensed by the tilt sensor. An exemplary tilt sensor may comprise a connection from at least one portion of the arm or balance beam to a strain gauge. An exemplary balance comprises a metal beam such as a stainless steel beam having alumina or boron nitride pistons at the ends. Each piston may be in contact with its welded-in, thin stainless steel diaghragm in the base of the EM pump assembly wherein the tilt may be measured by a stain gauge through a connection to one end of the beam. The connection may permit the strain gauge to be removed from the elevated temperature region of the SunCell®. In an embodiment, at least one of the connection and the pistons may comprise a refractory material that may also resist heating by the inductively coupled heater. The balance may be adjusted to achieve weight balance of the beam-ends or between the arms at the desired molten metal reservoir levels. The balance may be achieved by adding weights to one beam end or to one arm. Alternatively, the position of the fulcrum may be adjusted. In an embodiment, the balance-type sensor further comprises a processor to receive tilt data and adjust the EM pump current to equalize the molten metal levels of the reservoirs. The level sensor comprising a balance-type may further comprise sensors for translational motion induced forces such in the case of motive power source SunCells®. The balance-type level sensor may further comprise a least one of an accelerometer, MEMS device, and gyroscope to provide data to the processor that modifies the response to tilt data to correct for external translational induced forces in the control of the relative EM pump rates. The balance-type level sensor may further comprise a vibrational dampening or cancellation means such as at least one of dampening mounts or bushings, shock absorbers, and a active vibration cancelation systems such as those known in the art to reduce the effects of external vibrations.

In an embodiment, the weight-type level sensor comprises an extensometer such as a crack opening displacement (COD) gauge. Exemplary COD gauges are one of Epsilon Models 3548COD, 3448COD, 3549COD, and 3648COD extensometers that are each strain gaged. The extensometer may comprise rods such as alumina or silicon carbide rods that contact the diaphragms in the EM pump tube assembly 5kk. The extensometer may comprise a non-contacting type such as one comprising lasers to measure distances. An exemplary sensor is Epsilon Models LE-05 and LE-15 laser extensometers wherein each comprises a high-speed laser scanner to determine the spacing between reflective points such as one on each of the two diaphragms. The diaphragm may comprise a reflecting surface for reflecting the laser beam. An exemplary reflective surface comprising a non-oxidizing reflective foil having a high melting point is a Pt foil (MP=1768° C.). The extensometer signal may be filtered to remove noise such as that from vibrations.

In an embodiment, the diaphragm comprises a substantial portion of the area of the bottom of the EM pump assembly 5kk to maximize the sensitivity to a column height change and the corresponding weight change. In an embodiment, the diaphragm has a relatively low resistance to deformation compared to the compressive resistance or spring constant of the displacement gauge or extensometer. In this case, the level detection becomes less sensitive to the diaphragm temperature that may change its resistance to deformation. In an embodiment, the diaphragm comprises a material that changes its resistance in responds to deformation. The diaphragm may comprise a leg of a Wheatstone bridge that senses the deformation as a function of molten metal level as a calibrated resistance change.

In an embodiment, the level sensor comprises a driven mechanical probe that is at least partially submerged in the molten metal when the metal level is a desired height, the molten metal resists the motion of the driven probe, and the resistance is measured to as input to a processor that determines the level from the resistance. The probe may be at lease one of rotated and translated. The probe may comprise a refractory material such W, SiC, carbon, or BN. The probe may penetrate the reservoir 5c at the EM pump assembly 5kk. The mechanical motion may be supported by a bearing that may be capable of high temperature such as 962° C. to 1200° C. The senor may comprise a bellows that permits longitudinal translation. The resistance as a function of the metal level may be measured with a strain gauge.

In an embodiment, the level sensor comprises at least one of a time resolved electrical parameter senor such as a time resolved reactance, impedance, resistance, inductance, capacitance, voltage, current, and power sensor that measures at least one electrical parameter of the electromagnetic pump that is dependent on the molten metal head pressure at the electromagnetic pump. At least one electrical parameter may be changed and the EM pump, and the electrical parameter response may be measured wherein the response is a function of the head pressure. A processor may use the response data and a lookup calibration data set to determine the molten metal level.

In an embodiment, the generator comprises a circuit control system that senses the molten silver level in each reservoir and adjusts the EM pump current to maintain about matching levels in the reservoirs. The control system may about continuously maintain minimum injection pressures on each EM pump such that the opposing molten silver streams intersect to cause ignition. In an embodiment, the injection system comprises two metal streams in the same plane wherein the streams hit with non-matched EM pump speeds so that the speeds can be variably controlled to maintain matched reservoir silver levels. In an embodiment, the generator may comprise a level sensor on one reservoir rather than comprise two level sensors, one for each reservoir. The total amount of molten metal such as silver is constant in the case of a closed reaction cell chamber 5b31. Thus, by measurement of the level in one reservoir, the level in the other reservoir may be determined. The generator may comprise a circuit control system for the EM pump of one reservoir rather than comprise two circuit control systems, one for the EM pump of each reservoir. The current of the EM pump of the reservoir without a level sensor may be fixed. Alternatively, the EM pump for the reservoir without a level sensor may comprise a circuit control system that is responsive to the level sensed in the reservoir with the level sensor.

A spontaneous increase in the molten metal flow rate through the EM pump may occur due to an increased head pressure when the molten metal level is elevated in the corresponding reservoir. The head pressure may contribute to the pump pressure and give rise to a corresponding contribution in the flow rate. In an embodiment, the reservoir height is sufficient to given rise to a sufficient head pressure differential between the extremes comprising the lowest and highest desired molten metal levels to provide a control signal for at least one EM pump to maintain about equal molten metal levels. The EM pump sensor may comprise a flow sensor such as a Lorentz force sensor or other EM pump flow sensor known in the art. The flow rate may change due to the change in head pressure due to a change in level. At least one flow rate parameter such as the individual EM pump flow rate, the combined flow rate, the individual differential flow rate, the combined differential flow rate, the relative flow rates, the rate of change of the individual flow rate, the rate of change of the combined flow rates, the rate of change of the relative flow rates, and other flow rate measurements may be used to sense the molten metal level in at least one reservoir. The sensed flow rate parameter may be compared to at least one EM pump current to determine the control adjustment of at least one EM pump current to maintain the about equal reservoir molten metal levels.

In an embodiment, the lower hemisphere 5b41 may comprise mirror-image height-graded channels to direct overflow from one reservoir 5c to the other and further facilitate return of the molten metal such as silver to the reservoirs. In another embodiment, the levels are equalized by a conduit connecting the two reservoirs with a drip edge at each end of the conduit to prevent a short between the two reservoirs. Silver in an over-filled reservoir flows back to the other through the conduit to more equalize the levels.

In an embodiment, the molten metal levels between reservoirs 5c remain essentially the same by at least one of active and passive mechanisms. The active mechanism may comprise adjusting the EM pump rate in response to the molten metal level measured by the sensor. The passive mechanism may comprise a spontaneous increase in molten metal rate through the EM pump due to an increased head pressure when the molten metal level is elevated in the corresponding reservoir. The head pressure may contribute to a fixed or varied EM pump pressure to maintain the about equal reservoir levels. In an embodiment, the reservoir height is sufficient to given rise to a sufficient head pressure differential between the extremes comprising the lowest and highest desired molten metal levels to maintain the reservoir levels about the same during operation. The maintenance may be achieved due to the differential flow rate due to a differential head pressure corresponding to a differential in molten metal level between the reservoirs.

In an embodiment, the EM pump comprises an inlet riser 5qa (FIG. 2I138) comprising a plurality of molten metal inlet openings or apertures on the inlet riser. The inlet riser 5qa may comprise a hollow conduit such as a tube. The conduit may be connected to the EM pump tube 5k6 on the inlet side of the EM pump magnets 5k4. The connection may be at the base of the EM pump assembly 5kk. The connection may comprise one of the disclosure such as matching threads or a Swagelok. The inlet riser may comprise a refractory material such as a refractory metal, carbon, or a ceramic such as one of W, Mo, SiC, boron nitride, and other refractory materials of the disclosure. The inlet riser may have a lower height than that of the nozzle 5q to reduce or eliminate the potential for the ignition current to electrically short to the inlet riser tube. In an embodiment, the lowest inlet to the inlet riser may be at a greater height than the top of the nozzle 5q of the EM pump injector such that the nozzle remains submerged. The submerged nozzle may be the positive electrode that may be submerged to protect it form the hydrino reaction plasma. The inlet riser may be non-conducting. The inlet riser may be coated with a coating such as a coating of the disclosure. The coating may be a non-conductor. The inlet riser that may comprise a refractory metal such as Mo that may be covered with a sheath or cladding. The sheath or cladding may comprise a non-conductor. The sheath such as a BN sheath may be held to the inlet riser by thermal compression. In an embodiment, at least one of the union of the base of the EM pump tube assembly 5kk and at least one of the inlet riser tube 5qa and the EM pump tube injector 5k61 may comprise a mated threaded joint. The tube may screw into the inlet and outlet of the EM pump at the base of the EM pump tube assembly 5kk, respectively. An exemplary inlet riser of a reservoir having a submerged nozzle comprises a BN tube threaded into the EM pump assembly base at the EM pump outlet; the inlet comprising a V-shaped slot on the side of the tube and an open top with the bottom of the V at a greater height than the height of the tip of the nozzle such that the nozzle remains submerged wherein the nozzle may comprise the positive electrode. In another embodiment, the bottom portion of the inlet riser tube may comprise a first material such as a metal such as stainless steel or a refractory metal such as Mo that may be threaded or welded into the EM pump tube outlet at the base of the EM pump assembly and further comprise an upper secion comprising a second material such as a non-conductor or a conductor coated or clad with a non-conductor. An exemplary upper inlet riser tube section comprises BN that may be at least one of threaded into and compression fit to the lower tube portion.

The inlet openings may get smaller from top to bottom of the inlet riser to automatically control the pump rate and silver level by controlling the inlet flow rate to the EM pump. In an embodiment, the inlet riser 5qa comprises vertically spaced openings such that as the reservoir molten metal level increases the EM pumping rate increases due to at least one effect of (i) the molten metal flows into the inlet riser faster since the total opening cross section increases with molten metal level height, (ii) the molten metal height in the inlet riser increases as the molten metal level increases with a corresponding increase in EM pump head pressure, and (iii) the decrease in flow restriction due to the larger total opening cross section or area decreases any corresponding pressure drop according to Bernoulli's equation and may further add head pressure in the case that the inlet flow rate is limiting to the filling of the inlet riser to its maximum height in the absence of flow restriction. In contrast, the counter inlet riser and injector of a dual injector electrode system may experience the opposite effects and a corresponding decreasing EM pumping rate due to a dropping relative molten metal level. In an alternative embodiment to the plurality of vertically spaced openings that may progressing restrict inlet flow from top to bottom over the span of the openings, the inlet riser may comprise at least one vertical slot at the top end of the inlet riser that may span a height range such as that of the desired height range of the molten metal level. The slot may taper in width from the top to the bottom of the slot to cause a corresponding flow restriction with molten metal height. The inlet riser may be open or closed at the top. In another embodiment, each of the plurality of vertically spaced holes that inlet to a single EM pump inlet tube may be replaced by a corresponding inlet tube. In an embodiment, the plurality of inlet tubes combine before or after the magnets 5k4, or they remain separate such that they each serve as an individual EM pump injector that selectively pumps when the molten metal flows into the corresponding inlet end at its unique height. In an embodiment, the EM pump may comprise at least one of a voltage and current sensor to measure at least one of the total or individual voltages and currents. A processor may use the sensor data and control at least one of the total or individual voltages and currents to control the total or individual pumping rates.

The reservoir height and the average molten metal depth may be selected to achieve at least one of a desired head pressure and drop in head pressure with a limiting flow restriction through the openings. The molten metal levels tend towards balancing due to the automatic inflow and corresponding pumping rate adjustment as a function of the relative molten metal levels of the reservoirs of the EM pump-driven dual molten metal injector electrodes. The EM pumps of each injector may be set at about a constant current. The current may be sufficient to cause intersection of the dual injected metal streams at about the center of the reaction cell chamber 5b31 with small variations to either side off center over the range of pumping rates caused the level changes and corresponding pump inflow and EM pumping rates. The current supplied by each EM pump power supply 5k13 may be set at a desired constant level. Alternatively, the SunCell® may comprise EM pump power supplies 5k13, EM pump power supply current sensors and controllers, an ignition current sensor and a processor. Each EM pump current may be sensed by its current sensor and adjusted by a controller to give a desired initial ignition current as measured by an ignition current sensor and processed by a processor. An ignition controller may also control the ignition power parameters. The current may be maintained within a range that provides stability of the intersection of the molten metal streams in the about middle of the reaction cell chamber. In an exemplary embodiment, the current is maintained above the threshold for the streams to intersect and below a level that would cause one stream to propagate to the opposite reservoir in the absence of the intersection. An exemplary current range for each EM pump current is about 300 A to 550 A. The currents of both pumps may be about equal.

The EM pump rate may be controlled by at least one of the inlet flow rate control by the level-height-dependent inlet riser inflow cross section and by the molten metal level sensor, the level processor, and the EM pump current controller. The change in at least one of resistance, current, voltage, and power of the EM pump power supply 5k13 may be sensed with a corresponding sensor, and the EM pump current may be controlled to further control the relative EM pumping rates to achieve about balance between the reservoir molten metal levels. In an embodiment, the EM pump 5ka may comprise a power limiter to prevent the EM pump tube 5k6 from excessive resistive heating and corresponding elevated temperature in the case that the EM pump tube resistance increases excessively due to low molten metal filling and flow.

In an embodiment, the inlet riser openings may comprise a protection such as an entrance guard for particles such as carbon or metal oxide particles that may block the openings or clog at least one of the inlet riser and the EM pump tube 5k6. In an exemplary embodiment, the inlet riser openings span about 1 cm at the top of the inlet riser tube wherein the desired top molten metal level is at the top of the last opening and the smallest opening is slightly larger than the largest corrosion product while providing restriction to flow relative to the unrestricted EM pumping rate.

Each EM pump may be powered by an independent power supply. Alternatively, the plurality of EM pumps such as two EM pumps may be powered by a common power supply through parallel electrical connections. The current of each pump may be controlled by a current regulator of each parallel circuit. Each parallel circuit may comprise isolation diodes to cause each circuit to be electrically isolated. The electrical isolation may prevent shorting of the ignition power between EM pump injectors. In an embodiment, the EM pump coolant lines 5k11 may be common to both EM pump assemblies 5ka. In an embodiment, the nozzle 5q of at least one EM pump injector may be submerged in the molten silver. The submersion may at least partially prevent the nozzle from being degraded by the plasma.

The nozzle 5q may be below the molten metal level to prevent nozzle damage by the plasma. Alternatively, the nozzle section 5k61 of the pump tube may be elevated, and the nozzle may comprise a side hole to cause sideways injection towards the opposite matching nozzle such that the streams intersect. The nozzle may be angled to cause the point of intersection of the dual streams at a desired location. The nozzle may comprise a spherical tube end with a hole at an angular position on the sphere to direct the molten metal to the desired location in the reaction cell chamber 5b31. In an embodiment, the nozzle 5q comprises an extension to guide the direction of the molten metal streams. The extension may comprise a short tube to rifle the stream towards the point of intersection with the opposing stream of a dual molten metal injection system. The nozzle tube section such as a refractory one such as one comprising W or Mo may be vertical. It may comprise a threaded connection to another section of the pump tube. It may comprise a threaded connection to a Swagelok or VCR fitting such as the one at the reservoir penetration 5k9. The nozzle 5q such as a refractory one such as a W or Mo one may have an angled outlet. The nozzle may join the nozzle section 5k61 of the pump tube by a threaded joint. The screwed in nozzle may be held at the desired position that results in intersection of the molten metal streams by a fastener such as a setscrew or lock nut or by a weld. The weld may comprise a laser weld.

In an embodiment, the lower hemisphere of the blackbody radiator 5b41 comprising two reservoirs and two EM pumps that serve as dual liquid electrodes is divided into at least two sections connected by an electrically insulating seal. The seal may comprise flanges, gaskets, and fasteners. The gasket may comprise an electrical insulator. The seal may electrically isolate the two liquid electrodes. In an embodiment, the electrically insulated boundary between the two reservoirs may be achieved by orienting the flange and gasket of the upper 5b41 and lower 5b42 hemispheres vertically rather than horizontally such that the blackbody radiator 5b4 comprises left and right halves joined at the vertical flange. Each half may comprise a vertically sectioned half of the blackbody radiator 5b4 and one reservoir 5c.

In an embodiment, the lower hemisphere of the blackbody radiator 5b41 comprises a separate piece having two reservoirs 5c that are fastened or connected to it. The connections may each comprise a threaded union or joint. Each reservoir 5c may comprise threads on the outer surface at the top that mates with threads of the lower hemisphere 5b41. The threads may be coated with a paste or coating that at least partially electrically isolates each reservoir from the lower hemisphere to further electrically isolate the two reservoirs from each other. The coating may comprise one of the disclosure such as ZrO. In an embodiment, the electrically insulating surface coating may comprise a coating or high-temperature material of the disclosure such as at least one of ZrO, SiC, and functionalized graphite. The insulating surface coating may comprise a ceramic such as a zirconium-based ceramic. An exemplary zirconium oxide coating comprises yttria-stabilized zirconia such as 3 wt % yttria. Another possible zirconium ceramic coating is zirconium diboride (ZrB₂). The surface coating may be applied by thermal spray or other techniques known in the art. The coating may comprise an impregnated graphite coating. The coating may be multi-layer. An exemplary multi-layer coating comprises alternating layers of a zirconium oxide and alumina. The functionalized graphite may comprise terminated graphite. The terminated graphite may comprise at least one of H, F, and O terminated graphite. In an embodiment, at least one reservoir may be electrically isolated and at least one another may be in electrical contact with the lower hemisphere of the blackbody radiator 5b41 such that the lower hemisphere may comprise an electrode. The lower hemisphere may comprise the negative electrode. In an embodiment, the connection between each reservoir 5c and the lower hemisphere of the blackbody radiator 5b41 is distal from the reaction cell chamber 5b31 such the electrically insulating coating of the connection is maintained at a temperature below the melting or degradation temperature of the coating such as SiC or ZrO.

The electrical isolation between the reservoirs may be achieved by a spacer that comprises an electrical insulator such as a silicon carbide spacer. The lower hemisphere 5b41 may comprise an extended connection to the spacer that is sufficiently extended from the body of the lower hemisphere such that the temperature at the connection is suitably below that of the spacer. The spacer may be connected at the extended connection by threads and may connect to the reservoir 5c. The connection to the reservoir 5c may comprise threads. The spacer may comprise a silicon carbide cylinder that connects to an extension of the lower hemisphere 5b41 by threads and connects by threads to the reservoir 5c at the opposite end of the SiC cylinder. The union may be sealed by the threads directly and may further comprise at least one of a sealant and a gasket such as one at the connection between the spacer and the lower hemisphere and one at the connection between the spacer and the reservoir. The gasket may comprise graphite such as Perma-Foil (Toyo Tanso) or Graphoil, or one comprised of hexagonal boron nitride. The gasket may comprise pressed MoS₂, WS₂, Celmet™ such as one comprising Co, Ni, or Ti such as porous Ni C6NC (Sumitomo Electric), cloth or tape such as one comprising ceramic fibers comprising high alumina and refractory oxides such as Cotronics Corporation Ultra Temp 391, or another material of the disclosure. The SiC spacer may comprise reaction bonded SiC. The spacer comprising the threads may initially comprise Si that is carbonized to form the threaded SiC spacer. The spacer may be bonded to the lower hemisphere and the upper portion of the corresponding reservoir. The bonding may comprise a chemical bonding. The bonding may comprise SiC. SiC spacers may fuse to carbon components such as the corresponding lower hemisphere and reservoir. The fusing may occur at high temperature. Alternatively, the bonding may comprise an adhesive. The spacer may comprise the drip edge to prevent the returning flow of molten metal from electrically shorting the reservoirs. The drip edge may be machined or cast into the spacer such as the SiC spacer. Alternatively, the spacer may comprise a recess for inserting a drip edge such as an annular disc drip edge. The spacer may comprise other refractory, electrical insulating materials of the disclosure such as zirconium oxide, yttria stabilized zirconium oxide, and MgO. In an embodiment, the ignition system comprises a safety cutoff switch to sense an electrical short between the dual reservoir-injectors and terminate the ignition power to prevent damage to the injectors such as the nozzles 5q. The sensor may comprise a current sensor of the current between the reservoir circuits through the lower hemisphere 5b41.

In an embodiment shown in FIGS. 2I95-2I147, the joints of the cell are reduced in number to avoid the risk of failure. In an embodiment, at least one of the joints between (i) the lower hemisphere 5b41 and the upper hemisphere 5b42, (ii) the lower hemisphere and the non-conducting spacer, and (iii) the non-conducting spacer and the reservoir are eliminated. The joint elimination may be achieved by forming a single piece rather than joined pieces. For example, the lower and upper hemispheres may be formed to comprise a single dome 5b4. At least one joint between (i) the lower hemisphere and the non-conducting spacer and (ii) the non-conducting spacer and the reservoir may be eliminated by forming a single piece. The lower and upper hemispheres may comprise a single piece or two pieces wherein at least one joint between (i) the lower hemisphere and the non-conducting spacer and (ii) the non-conducting spacer and the reservoir may be eliminated by forming a single piece. The single piece may be formed by at least one method of casting, molding, sintering, pressing, 3D printing, electrical discharge machining, laser ablation machining, laser ablation with chemical etching such as laser ignition of carbon-oxygen combustion in an atmosphere comprising oxygen, pneumatic or liquid machining such as water jet machining, chemical or thermal etching, tool machining, and other methods known in the art.

In an embodiment, at least one section of a cell component such as the blackbody radiator 5b4 such as a dome blackbody radiator and at least one reservoir 5c is non-conductive. A circumferential section of at least one of a reservoir 5c and the blackbody radiator comprising a dome 5b4 or the lower hemisphere 5b41 and the upper hemisphere 5b42 may be non-conductive or comprise a non-conductor. The non-conducting section of the blackbody radiator may comprise a plane transverse to the line between the two nozzles of a dual liquid injector embodiment. The non-conductor may be formed by conversion of the material of a section of the component to be non-conductive. The non-conductor may comprise SiC or boron carbide such as B₄C. The SiC or B₄C section of the cell component may be formed by reacting a carbon cell component with a silicon source or boron source, respectively. For example, a carbon reservoir may be reacted with at least one of liquid silicon or a silicon polymer such as poly(methylsilyne) to form the silicon carbide section. The polymer may be formed at a desired section of the component. The cell component may be heated. An electrical current may be passed through the component to cause the reaction to form the non-conducting section. The non-conductive section may be formed by other methods known by those skilled in the art. The outside surface of the reservoir 5c may comprise raised circumferential bands to hold molten silicon or boron during the conversion of carbon to silicon carbide or boron carbide in the desired section. The silicon carbide may be formed by reaction bonding. An exemplary method of forming boron carbide from boron and carbon is given in haps://www.google.com/patents/US3914371, which is incorporated by reference. The silicon carbide or boron carbide sections may be formed by combustion synthesis as given in https.//www3.nd.edu/˜amoukasi/combustion_synthesis_of_silicon_carbide.pdf and Study Of Silicon Carbide Formation By Liquid Silicon Infiltration By Porous Carbon Structures by Jesse C. Margiotta, which are incorporated by reference. Other suitable reservoir materials are non-electrically conductive graphite such as pyrolytic graphite or doped graphite, SiC, silicon nitride, boron carbide, boron nitride, zirconia, alumina, AlN, AlN—BN such as SHAPAL Hi Msoft (Tokuyama Corporation), titanium diboride, and other high temperature ceramic. The reservoir may be a composite material wherein the non-conducting section may be formed for the parent reservoir material such as carbon. The reservoir may comprise a material that is coated with a refractory electrical insulator such as SiC, zirconia, or alumina. The coated material may be an electrical conductor such as carbon that is electrically insulated by the coating. In an exemplary embodiment, the carbon reservoir comprises continuously nucleated graphite such as Minteq Pyroid SN/CN Pyrolytic Graphite that may be anisotropic wherein the low electrical conductivity may be in the transverse plane and the ends of the reservoir may be coated with a non-conductor such as SiC to prevent current flow along the longitudinal reservoir axis. In an embodiment, a porous SiC reservoir may be coated with carbon to seal the pores. The coating may be by vapor deposition of carbon from a source such as an electrical carbon arc.

As shown in FIGS. 2I95-2I147, the dome 54b and reservoirs 5c may comprise a single piece. The single piece may be achieved by machining the material of the cell component as a single piece. Alternatively, the single piece in this instance may initially comprise a plurality of pieces, parts, or components that are joined by at least one seal that may comprise a glued or chemical bonded seal formed by a sealant. Other, pieces, parts, or components of the disclosure may similarly be glued or chemically joined. Exemplary graphite glues are Aremco Products, Inc. Graphi-Bond 551RN graphite adhesive and Resbond 931 powder with Resbond 931 binder. The reservoir may comprise a non-conducting section near the top close to the dome. The reservoir may connect to a baseplate. The reservoir may sit into a female collar. At least one of the external surfaces of the collar and the end of the reservoir just distal to the top of the collar may be threaded. A nut, tightened on the threads, may join the reservoir and the baseplate. The threads may be in pitched such that rotation of the nut draws the reservoir and baseplate together. The threads may have opposite pitch on opposing pieces with mating nut threads.

The reservoir may comprise a slip nut 5k14 at the baseplate 5b8 end wherein the slip nut is tightened on the outer threaded baseplate collar 5k15 to form a tight joint. In an embodiment, slip nut may comprise a grove and a gasket. The slip nut may be attached to the reservoir at a grove. The grove may be cast or machined into a cylindrical reservoir wall. An O-ring or gasket may be pressed into the grove and the slip nut may be tightened on the outer threaded baseplate collar 5k15 to form a tight joint. The outer threaded baseplate collar may further be tapered to receive the reservoir.

The slip nut 5k14 fastener may further comprise a gasket 5k14a or an O-ring such as a Graphoil or Perma-Foil (Toyo Tanso) or hexagonal boron nitride gasket or ceramic rope O-ring to seal the reservoir to the baseplate. A protrusion of the BN reservoir 5c wall may comprise the hexagonal boron nitride gasket. The BN gasket may be machined or cast into the wall of the BN reservoir 5c.

The gasket may comprise the same material as that of the reservoir. The gasket may be threaded onto the reservoir. The gasket may comprise a wide width such as in a width range of about 1 mm to 20 mm wide. The EM pump assembly 5kk collar and the nut of the slip nut may comprise flange-like seating surfaces for the BN gasket. The gasket may fill the cavity comprising the nut, the reservoir wall, and the gasket seat of the EM pump assembly 5kk collar. In an exemplary embodiment, the wide threaded BN gasket screws onto the BN reservoir wherein the collar and nut seats for the gasket are matching in width to create a larger gasket seating and sealing area. The BN gasket may be coated with BN glue to space fill voids of the slip nut seal. Exemplary glues are Cotronics Durapot 810 and Cotronics Durapot 820.

To avoid reactivity of the gasket comprising carbon to form carbide such as iron carbide, parts that comprise iron or other material such as a metal that reacts with carbon may be coated with an inert coating such as Mullite, SiC, BN, MgO, silicate, aluminate, ZrO, or others of the disclosure. The coating may comprise a sealant such as Cotronics Resbond 920 ceramic adhesive paste, Cotronics Resbond 940LE ceramic adhesive paste, or one of the disclosure. The coating may comprise a metal or element that does not form carbide wherein the elements may comprise an alloying element such as one in steel. Exemplary elements that do not form carbides in steel are Al, Co, Cu, N, Ni and Si. The joint parts such as the threaded collar and nut of the slip nut joint that contact carbon such as a carbon gasket may comprise or may be electroplated with a metal such as nickel that does not form carbide or forms carbide that is not stable at the cell operating temperature. The joint parts may be clad with a carbide-formation resistant material such as nickel. To avoid reactivity to form iron carbide, the gasket may be a material other than carbon in the case that the gasket contacts iron or a part such as a nut comprising iron. The joint parts may comprise a stainless steel that is resistant to carburization such as Hayes 230.

In an embodiment, the EM pump assembly 5kk may comprise carbon such that it is compatible with a graphite slip nut gasket wherein the nut may also comprise carbon. At least one of injection section of the EM pump tube 5k61 and the inlet riser tube 5qa may comprise carbon. The carbon parts may be formed by at least one of 3D printing, casting, molding, and machining.

Other such chemical incompatibilities should be avoided as well. The gasket or O-ring may comprise a metal such as nickel, tantalum, or niobium. The gasket may comprise pressed MoS₂, WS₂, Celmet™ such as one comprising Co, Ni, or Ti such as porous Ni C6NC (Sumitomo Electric), cloth or tape such as one comprising ceramic fibers comprising high alumina and refractory oxides such as Cotronics Corporation Ultra Temp 391, or another material of the disclosure. The joint between the reservoir such as one comprising BN and the collar of the EM pump assembly 5kk such as one comprising stainless steel may comprise a chemical bond such as a bond between BN and metal such as stainless steel. In an embodiment, the inside of the EM pump assembly collar is BN coated, and then the BN reservoir tube is bound to the inside of the collar by at least one of press fitting and heating. The chemical bond may be formed by other methods known in the art such as by a plasma activated sintering process as given by Yoo et al., “Diffusion bonding of boron nitride on metal substrates by plasma activated sintering process”, Scripta Materialia, Vol. 34, No. 9, (1996), pp. 1383-1386 which is herein incorporated by reference in its entirely. The joint may comprise a chemical bond formed by at least one method of the group of diffusion bonding under pressure application, thermal spray or mechanical bonding, sinter-bonding using P/M techniques such as hot isostatic pressing (HIP) when simultaneous sintering of ceramic powders and bonding onto the metal substrate can take place, and plasma assisted sintering (PAS) process to develop a good diffusion bonding between a BN ceramic layer and the metal substrate while sintering the ceramic layer. The bond between a BN reservoir and a metal EM pump assembly collar may comprise a bonding agent, compound, or composite ceramic such as one comprising BN with at least one of silicon nitride-alumina and titanium nitride-alumina ceramics, BN reinforced alumina and zirconia, borosilicate glasses, glass ceramics, enamels, and composite ceramics with titanium boride-boron nitride, titanium boride-aluminum nitride-boron nitride, and silicon carbide-boron nitride composition. The joint may comprise a slip nut or stuffing box type of the disclosure. The gasket such as hexagonal BN or a alumina-silicate fiber gasket coated with a bonding agent, compound, or composite ceramic may be chemically bonded (glued) to a surface-roughened ceramic reservoir such as a BN reservoir using the bonding agent under at least one bonding reaction condition such as heat and pressure. The gasket may comprise hexagonal BN or cloth or tape such as one comprising ceramic fibers comprising high alumina and refractory oxides such as Cotronics Corporation Ultra Temp 391, and the bonding agent may comprise a sealant such as a Cotronics Resbond ceramic adhesive paste such as Resbond 906.

In an embodiment, the seal may comprise a Swagelok. In an embodiment, the seal may comprise a Gyrolok such as one comprising at least one of a front ferrule, a back ferrule, a butte seal, a body, and a nut where at least one of the front ferrule, back ferrule, and butte seal may comprise a gasket such as one of the disclosure. The ferrules may be chamfered. Seal parts may be chemically compatible with the gasket; for example, parts in contact with a carbon gasket may comprise nickel.

The collar may comprise an internal taper to receive the reservoir to compress the gasket with the tightening of the slip nut. The reservoir may comprise an external taper to be received by the collar to compress the gasket with the tightening of the slip nut. The collar may comprise an external taper to apply tension to the O-ring with the tightening of the slip nut. The baseplate may comprise carbon. The reservoir may comprise a straight wall. The reservoir wall may comprise at least one groove for at least one gasket. In addition to threads on the outside of the collar to receive the slip nut, the EM pump tube assembly 5kk collar may be threaded internally to receive matching threads on the end of the reservoir such as a reservoir comprising boron nitride. The threads may be tapered. The threads may comprise pipe threads.

The union between the reservoir and the EM pump tube assembly 5kk collar may comprise an internal gasket between the internal portion of the collar and the reservoir such as one between the inside base of the collar and the end of the reservoir. The reservoir end may be tapered to trap the gasket. The taper may trap the gasket between the outside wall of the reservoir and the inside wall of the collar. The gasket seal may at the base of the reservoir. At least one of the gaskets and threads may be further sealed with a sealant such as Cotronics Resbond 920 ceramic adhesive paste or Cotronics Resbond 940LE ceramic adhesive paste.

In an embodiment, the union may comprise a mated thread union. The reservoir and the EM pump tube assembly 5kk collar may be threaded together. A sealant may be applied to the threads. Exemplary sealants are Cotronics Resbond 920 ceramic adhesive paste and Cotronics Resbond 940LE ceramic adhesive paste. The threads of this union or others of the disclosure may comprise a soft metal that forms an alloy with at least one of the joined parts. In an exemplary embodiment, the soft metal may form an alloy with the collar wherein the alloy may have a high melting point. Tin metal may serve as the soft metal sealant of the collar-to-reservoir threads wherein the collar may comprise at least one of nickel and iron and the reservoir may comprise boron nitride or silicon carbide. The collar may be coated with Sn by at least one method from the group of dipping the collar in molten tin, vapor deposition, and electroplating.

The baseplate may comprise fasteners to the EM pump tube such as Swageloks with at least one of gaskets such as Graphoil or Perma-Foil (Toyo Tanso), hexagonal boron nitride, or silicate gaskets and sealants. The gasket may comprise pressed MoS₂, WS₂, Celmet™ such as one comprising Co, Ni, or Ti such as porous Ni C6NC (Sumitomo Electric), cloth or tape such as one comprising ceramic fibers comprising high alumina and refractory oxides such as Cotronics Corporation Ultra Temp 391, or another material of the disclosure. Alternatively, the baseplate may comprise metal such as stainless steel or a refractory metal. The EM pump tube may be fastened to a metal baseplate by welds. The baseplate metal may be selected to match the thermal expansion of the reservoir and joint parts. The slip nut and gasket may accommodate a differential in expansion of the baseplate and reservoir components.

In an embodiment, the upper slip nut may comprise graphite that joins matching threads on the graphite lower hemisphere 5b41. The EM pump assembly 5kk may comprise stainless steel. The lower slip nut may comprise a metal such as Mo, W, Ni, Ti, or a different stainless steel type with a lower coefficient of thermal expansion than the EM pump assembly stainless steel (SS) so that the slip nut maintains compression on the slip nut gasket. An exemplary combination is SS austenitic (304) and SS ferritic (410) having linear temperature expansion coefficients of 17.3×10⁻⁶ m/mK and 9.9×10⁻⁶ m/mK, respectively. Alternatively, the slip nut may comprise a material with an expansion coefficient similar to that of the reservoir. In the case that the reservoir is either boron nitride or silicon carbide, the slip nut may comprise graphite, boron nitride, or silicon carbide. At least one component of the slip nut joint such as the threaded portion of the EM pump assembly may comprise thermal expansion grooves. The thermal expansion grooves may allow for thermal expansion in a desired direction such as circumferentially narrowing the grooves versus radial expansion. In an embodiment, the expansion grooves are cut across the entire collar of the EM pump tube assembly 5kk. The cuts may be very thin such that they seal with thermal expansion of the collar wherein more or less are added to achieve the seal the assembly operating temperature such as about 1000° C. The cuts may be made by means such as machining, water jet cutting, and laser cutting. The nut may comprise carbon, boron nitride, or SiC. The material type such as the type of carbon or boron nitride may be selected to allow for some nut expansion to avoid it breaking at the cell operating temperature such as in the temperature range of about 1000° C. to 1200° C. The number, placement, and width of the grooves or cuts may be selected to match the amount of collar metal expansion at the cell operating temperature. In an embodiment, the expansion grooves may be extend only partially through the collar such as extend 50% to 95% of the width of the collar to prevent molten metal leakage. The cuts may extend from the outer threads inward to allow expansion at the thread area of the collar where opposing nut threads of the slip nut mate when the nut is tightened. The cuts may substantially cover the portion of the threaded collar covered by the nut when it is tightened. The cuts may be through the entire collar with material such as metal added back by means such as welding to provide crush or cripple zones. The added back metal may be the same or a different metal. The added material or metal may be malleable.

In an embodiment, the union between the reservoir 5c such as a boron nitride tube reservoir and the EM pump tube assembly 5kk may comprise a compression fitting. The union may comprise an internally threaded EM pump tube assembly collar, a two-sided threaded cylindrical insert, and a threaded-end reservoir. The collar of the EM pump tube assembly 5kk may comprise a material of a first thermal coefficient of expansion such as 400 or 410 stainless steel. The two-sided threaded cylindrical may comprise a material having a second thermal coefficient of expansion such as 304 stainless steel that may be higher than that of the collar. Other material combinations are possible such 304 SS or 410 SS collar with a 304 SS baseplate with 304 welded-in EM pump tube 5k6 and an insert comprising a metal that does not melt at the operating temperature range such as one of about 1000° C. to 1200° C. such as Ni, Ti, Nb, Mo, Ta, Co, W, 304 SS, or 400 SS, 410 SS, Invar (FeNi36), Inovco (F333Ni4.5Co), FeNi42, or Kovar (FeNiCo alloy). The reservoir tube may thread into the inside threads of the insert, and the insert may thread into the inside of the collar. Alternatively, the insert may be threaded on the inside only and may be welded to the collar at the base of the EM pump assembly 5kk. In an embodiment, at least one union between at least two of the inside of the collar, the outside of the insert, the inside of the insert, and the reservoir are non-threaded. In an embodiment, the insert has a higher coefficient of thermal expansion than the collar; so, the insert may expand inward to compress the reservoir tube to form a compression seal as well as a threaded seal in the case wherein the mating insert surface and at least one of the collar and reservoir surfaces are threaded. The compression insert may form a tight seal by expanding to prevent a gap from forming between mating surfaces without causing excessive stress on the reservoir tube that could result in its failure. In another embodiment, the union comprises a compression seal wherein the reservoir is press fit into the collar with or without sealant. In an embodiment, at least one EM pump assembly-reservoir union component such as at least one of the group of the non-threaded collar, threaded collar, threaded insert, and non-threaded insert is heated to cause it to expand before mating or fitting it to the corresponding component of the union or pressing it into the corresponding component. In an embodiment, at least one EM pump assembly-reservoir union component such as at least one of the group of the threaded insert, non-threaded insert, and the reservoir tube is cooled to cause it to contract before mating or fitting it to the corresponding component of the union or pressing it into the corresponding component. The cooling may be to a cryogenic temperature. The cooling may be achieved by exposure of the component to a cryogen such as liquid nitrogen. The corresponding union may comprise at least one of a compression fitting, a threaded fitting, and a sealed fitting. In an embodiment, the reservoir tube such as a BN tube may sit in a recessed groove in the EM pump assembly base. In another embodiment, the reservoir may be welded or chemically bound to the EM pump assembly base. BN may be bound to a metal base by roughening the BN surface and allowing weld metal to flow into the corresponding pores to form a bound with the metal base plate.

Exemplary EM pump assembly-reservoir unions comprise a 410 SS, Invar (FeNi36), Inovco (F333Ni4.5Co), FeNi42, or Kovar (FeNiCo alloy) collar with a 304 SS baseplate with a 304 SS or niobium double-sided threaded or non-threaded insert with a mating threaded or non-threaded collar and BN reservoir wherein the non-threaded parts may comprise compression fittings formed by differential heating or cooling of parts to achieved the compression fitting.

The slip nut seal may comprise a plurality of seals. The slip nut seal may comprise back-to-back slip nuts. The slip nut seal may comprise a standard and an up-side-down slip nut and a gasket. In an embodiment, the slip nut may comprise an upper nut and lower nut and a gasket sandwiched between wherein both nuts may be threaded onto the external threads of the collar of the EM pump assembly 5kk. The pressure applied to the gasket by tightening the threads may push the gasket into the reservoir tube 5c to form a tight compression seal. The reservoir 5c may comprise a groove at the position of the compressed gasket to better receive the gasket and improve the seal. The seal between the reservoir and the EM pump assembly may comprise a gland seal or stuffing box seal. The gasket may comprise one of the disclosure. The stuffing box seal may further comprise a sealant such as one comprising an inert refractory fine powder such as a sealant of the disclosure. The sealant may have a high coefficient of thermal expansion to fill the stuffing box at elevated temperature. In an embodiment, the EM pump assembly base may replace the bottom nut of a stuffing box seal wherein a slip nut may comprise the upper nut. The packing may be circumferential to the reservoir wherein the reservoir may comprise a recess for the packing. The reservoir may further comprise an upper ledge inside of the slip nut to compress the packing.

In an embodiment, the union may simply comprise the outside-threaded reservoir such as a boron nitride reservoir screwed into the inside-threaded collar such as a 304 stainless steel collar. The threads of a union of the disclosure such as the one between the reservoir and collar may comprise pipe threads. The union may further comprise at least one of a thread sealant and a slip nut seal. Exemplary sealants are Cotronics Resbond 920 ceramic adhesive paste and Cotronics Resbond 940LE ceramic adhesive paste. In an embodiment, the sealant may comprise a soft metal that forms an alloy with the insert or collar wherein the alloy may have a high melting point. Tin metal may serve as the soft metal sealant of an insert or collar comprising at least one of nickel and iron. At least one of the insert and collar may be coated with Sn by at least one method from the group of dipping the insert in molten tin, vapor deposition, and electroplating.

In an embodiment, the union may comprise one of the disclosure such as at least one of a threaded or non-threaded union such as a compression seal, and the union may further comprise a seal comprising the flush abutment of the bottom edge of the reservoir on the base of the EM pump assembly. The seal between the reservoir bottom edge and the EM pump assembly base may further comprise a gasket such as a one comprising Celmet, MoS₂, or cloth or tape such as one comprising ceramic fibers comprising high alumina and refractory oxides such as Cotronics Corporation Ultra Temp 391. The union may further comprise a slip nut connection. The reservoir tube such as a BN reservoir tube may comprise a smaller outer diameter (OD) on the upper portion and a larger outer diameter on the lower portion. With the threading of the slip nut on the EM pump assembly collar, the slip nut may tighten the reservoir bottom edge to the EM pump assembly base by tighten against the ledge comprising the two diameters. In another embodiment, the ledge may be replaced with fasteners such as screwed-in pegs to tighten the nut against. The slip nut joint comprising the nut, the threaded collar, and the reservoir tube may further comprise a gasket between the top of the ledge and the inside of the nut. The ledge gasket may comprise Celmet, MoS₂, or cloth or tape such as one comprising ceramic fibers comprising high alumina and refractory oxides such as Cotronics Corporation Ultra Temp 391. An exemplary union comprises a 410 SS collar, 410 SS base, BN reservoir with a ledge at the collar threads comprising a smaller upper OD and a larger lower OD, a 410 SS slip nut, and a Celmet gasket wherein the lower edge of the BN reservoir is abutted to the base of the EM pump assembly and the abutment is tightened by the tightening of the slip nut against the ledge as it is treaded onto the collar.

In an embodiment, the reservoir may comprise an insulator such as a ceramic such as SiC, silicon nitride, boron carbide, boron nitride, zirconia, alumina, or other high temperature ceramic that is joined at the dome 5b4 by a union. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), hafnium carbide (HfC) (M.P.=3900° C.), Ta₄HfC₅ (M.P.=4000° C.), Ta₄HfC₅TaX₄FifCX₅ (4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.). The insulator reservoir 5c may comprise a drip edge at the top to prevent electrical shorting by return flow of the molten metal. The union may comprise a slip nut union such as one of the same type as that between the reservoir and baseplate. The slip nut may comprise at least one of a refractory material such as carbon, SiC, W, Ta, or another refractory metal. The ceramic reservoir may be milled by means such as diamond tool milling to form a precision surface suitable to achieve the slip nut seal. In an embodiment of a ceramic reservoir such as one comprising an alumina tube, at least one end of the reservoir may be threaded. The threads may be achieved by attaching a threaded collar. The threaded collar may be attached by an adhesive, bonding agent, or glue. The glue may comprise ceramic glue.

The joining surfaces that interface the gasket or O-ring may be roughened or grooved to form a high-pressure capable seal. The gasket or O-ring may be further sealed with a sealant. Silicon such as silicon powder or liquid silicon may be added to a gasket or O-ring comprising carbon wherein the reaction to form SiC may occur at elevated temperature to form a chemical bond as a sealant. Another exemplary sealant is graphite glue such as one of the disclosure. In addition to the slip nut to create a gasket or O-ring seal, the joined parts may comprise mating threads to prevent the parts from separating due to elevated reaction cell chamber pressure. The union may further comprise a structural support between the blackbody radiator 5b4 and the bottom of the reservoir 5c or baseplate to prevent the union from separating under internal pressure. The structural support may comprise at least one clamp that holds the parts together. Alternatively, the structural support may comprise end-threaded rods with end nuts that bolt the blackbody radiator and the bottom of the reservoir or baseplate together wherein the blackbody radiator and the bottom of the reservoir or baseplate comprise structural anchors for the rods. The rods and nuts may comprise carbon.

In an embodiment, the union may comprise at least one end flange and an O-ring or gasket seal. The union may comprise a slip nut or a clamp. The slip nut may be placed on the joined pieces before the flange is formed. Alternatively, the slip nut may comprise metal such as stainless steel or a refractory metal that is welded together from at least two pieces about at least one of the reservoir and a collar.

In an embodiment, at least one of the reservoir 5c and bottom collar of the blackbody radiator 5b4 and the reservoir and the baseplate-EM pump-injector assembly 5kk may be joined by at least one of threads that may have opposite pitch on opposing reservoir ends and slip nut unions. At least one of the threads of the threaded unions, threads of the slip nut, and slip nut gasket may be glued by a glue of the disclosure such as silicon that may form SiC with carbon or carbon glue.

In an embodiment, a reservoir that is less electrically conductive or insulating such as a SiC or B₄C reservoir may replace the carbon reservoir. The insulating reservoir may comprise at least one of (i) threads at the top to connect to the lower hemisphere 5b41 or a one-piece blackbody radiator dome 5b4 and (ii) a reservoir bottom wherein the reservoir and reservoir bottom are one piece. A SiC reservoir may join to a carbon lower hemisphere by at least one of a gasket and a sealant comprising silicon wherein the silicone may react with carbon to form SiC. Other sealants known in the art may be used as well. The reservoir bottom may comprise threaded penetrations for the EM pump tube fasteners such as Swagelok fasteners. The reservoir bottom may be a separate piece such as a baseplate that may comprise metal. The metal baseplate may comprise welded joints to the EM pump tube at the penetrations. The baseplate may comprise a threaded collar that connects to the mating fastener of the reservoir such as a slip nut. The collar may be tapered to receive the reservoir. The collar taper may be internal. The reservoir end may be tapered. The reservoir taper may be external to be received inside of the collar. The fastener may comprise a gasket such as a Graphoil or Perma-Foil (Toyo Tanso), hexagonal boron nitride, or silicate gasket. The gasket or O-ring may comprise a metal such as nickel, tantalum, or niobium. The gasket may comprise pressed MoS₂, WS₂, Celmet™ such as one comprising Co, Ni, or Ti such as porous Ni C6NC (Sumitomo Electric), cloth or tape such as one comprising ceramic fibers comprising high alumina and refractory oxides such as Cotronics Corporation Ultra Temp 391, or another material of the disclosure. The tightening of the slip nut may apply compression to the gasket.

In an embodiment, the blackbody radiator 5b4 may comprise one piece such as a dome or may comprise upper and lower hemispheres, 5b42 and 5b41. The dome 5b4 or lower hemisphere 5b41 may comprise at least one threaded collar at the base. The threads may mate to a reservoir 5c. The union of the collar and the reservoir may comprise external threads on the reservoir screwing into internal threads of the collar or vice versa. The union may further comprise a gasket. Alternatively, the union may comprise a slip nut on the reservoir that screws onto external threads on the collar. The collar may comprise an internal taper at the end that receives the reservoir. The union may comprise a gasket such as a Graphoil or Perma-Foil (Toyo Tanso), hexagonal boron nitride, or silicate gasket, pressed MoS₂ or WS₂, Celmet™ such as one comprising Co, Ni, or Ti such as porous Ni C6NC (Sumitomo Electric), ceramic rope, or other high temperature gasket material known by those skilled in the art such as cloth or tape such as one comprising ceramic fibers comprising high alumina and refractory oxides such as Cotronics Corporation Ultra Temp 391. The gasket may seat at the union between the reservoir and the collar. The reservoir may comprise a nonconductor such as SiC, B₄C, or alumina. The reservoir may be cast or machined. The dome or lower hemisphere may comprise carbon. The slip nut may comprise a refractory material such as carbon, SiC, W, Ta, or other refractory metal or material such as one of the disclosure.

The reservoir may further attach to a baseplate assembly at the EM pump end. The union may comprise the same type as at the blackbody radiator end. The baseplate assembly may comprise (i) the union collar that may be internally or externally threaded to mate with the matching threaded reservoir, (ii) the union collar that may be internally tapered at the end to receive the reservoir and externally threaded to mate with the slip nut, (iii) the reservoir bottom, and (iv) the EM pump tube components wherein the penetrations may be joined by welds. The baseplate assembly and slip nut may comprise stainless steel. In an embodiment, slip nut may be attached to the reservoir at a flange or grove. The grove may be cast or machined into a cylindrical reservoir wall. The reservoir and collar may both comprise a flange on at least one end wherein the union comprises an O-ring or gasket between the mating flanges of the joined pieces and a clamp the goes over the flanges and draws them together when tightened.

In another embodiment, the seal or joint such as the one between the reservoir and the EM pump assembly 5kk may comprise a wet seal or cold seal (FIG. 2I139). The wet seal may be of the design of a molten carbonate fuel cell wet seal. The wet seal may comprise mated flanges on each of the pieces to be joined that form a channel for the molten metal to fill such as reservoir flange 5k17 and EM pump assembly collar flange 5k19. In another embodiment shown in FIG. 2I140, the EM pump assembly collar flange 5k19 may at least one of (i) mate to the reservoir support plate 5b8, (ii) comprise the reservoir support plate 5b8, and (iii) comprise the reservoir support plate 5b8 and the base of the EM pump assembly 5kk1 comprising the inlet and outlet for the EM pump tube 5k4. The reservoir support plate 5b8 may be supported by posts 5b82 anchored to a support base 5b83. In an embodiment, the wet seal cooler 5k18 comprises a cooler of at least one of the perimeter of the reservoir support plate 5b8 and the support posts 5b82 that may heat sink the perimeter of the reservoir support plate 5b8. At least one of the reservoir flange 5k17, reservoir support plate 5b8, EM pump collar flange 5k19, collarless EM pump flange 5k19, base of the EM pump assembly 5kk1, and the reservoir 5c may be slanted in a slanted reservoir design. The flanges may be joined with fasteners such as clamps, bolts, screws, ones of the disclosure, and ones known by those skilled in the art. At least one of the fastener penetrations, the reservoir flange 5k17, and the EM pump assembly collar flange 5k19 may comprise a means for differential expansion of the wet seal parts and mountings such as any to the reservoir support plate 5b8. The wet seal coolant loop 5k18 channel may extend radially such that the outer extent of the channel may be maintained at a temperature below the melting point of the molten metal such as below 962° C. in the case of silver. The area of solidified metal of the wet seal may comprise that in contact with the fasteners such as bolts 5k20 to avoid leakage at the fasteners. The bolts may comprise carbon and may further comprise carbon washers such as Perma-Foil or Graphoil washers to serve as expansion cushions.

In an exemplary embodiment, the wet seal may comprise collar flange on the reservoir 5c such as a boron nitride tube that may be at least one of a glued-on and threaded-on, and a welded-on collar flange on the collar of the EM pump assembly 5kk. The wet seal flange such as the flange of a ceramic reservoir may be formed by at least one of threading and gluing a flange plate such as BN one onto the cylindrical reservoir such as a BN one. Exemplary glues are Cotronics Durapot 810 and Cotronics Durapot 820. Alternatively, the wet seal flange such as the flange of a ceramic reservoir may be formed by at least one of molding, hot pressing, and machining the ceramic such as BN. BN components such as at least one of the reservoir 5c, gaskets, and reservoir flange 5k17 may be fabricated by hot pressing BN powder with subsequent machining. Boron oxide may be added to parts made from boron nitride powders for better compressibility. Other BN additives that alter the BN properties such as thermal expansion, compressibility, and tensile and compression strengths to those desirable are CaO, B₂O₃, SiO₂, Al₂O₃, SiC, ZrO₂, and AN. Thin films of boron nitride may be fabricated by chemical vapor deposition from boron trichloride and nitrogen precursors. Boron nitride grades HBC and HBT contain no binder and can be used up to 3000° C.

The outer edge of the channel may comprise a circumferential band. The band may comprise an outer circumferential lip of the EM pump assembly collar flange into which the BN flange sits. The channel may be cooled to maintain the solid metal on the perimeter and molten metal at the entrance to the channel.

The joint cooling system may comprise one of the disclosure such as one comprising liquid or gaseous coolant or a radiator. The joint may be cooled at the perimeter by at least one coolant loop 5k18. The coolant loop 5k18 may comprise a line from the EM pump cooling heat exchanger 5k1, coolant line 5k11, or cold plate 5k12. The joint may be cooled at the perimeter by at least one heat sink such as radiator or convection or conduction fins. The joint may be cooled at the perimeter by at least one heat pipe. An exemplary wet seal cooler comprises a copper tube coolant loop 5k18 wherein the coolant may comprise water. At least one of the flanges may have a circumferential groove that serves as a channel for a circumferential cooling loop. The cooling loop may be radially inward with respect to the circumferential fasteners such as bolts to cause the molten metal to solidify radially inward from the bolts. In an embodiment, the EM pump assembly collar flange 5k19 and reservoir flange 5k17 may be sufficiently wide such that the temperature at the perimeter of the seal is below the melting point of the molten metal such that the coolant loop 5k18 is not necessary. The EM pump assembly collar flange 5k19 may comprise the reservoir support plate 5k8. The reservoir may be slanted on the reservoir flange 5k17 that may be horizontal. In other embodiments, the flanges 5k17 and 5k19, and reservoir 5c may be at any desired angles relative to each other to achieve the sealing and the injection of the molten metal into the reaction cell chamber 5b31. In an embodiment, the material and the thickness of the flanges such as 5k17 and 5k19 may determine the heat transfer and thereby the cooling. In an exemplary embodiment, the reservoir flange 5k17 directly mates to a plate that comprises the reservoir support plate 5b8, EM pump flange 5k19, and the EM pump assembly base 5kk that further comprises the inlet and outlet of the EM pump tube 5k4 of the EM pump, and the reservoir flange 5k17 comprises BN that has a high thermal conductivity. The thickness and width of the plate 5k17 and mating plate 5k19 may be selected to provide sufficient cooling to maintain the wet sealing. The seal may further comprise a cooler of the disclosure such as a coolant loop 5k18 embedded in the perimeter of at least one flange 5k17 and 5k19. The plate 5k17 may comprise a collar with an attached reservoir 5c that may be slanted. The reservoir may be attached to the plate flange 5k17 by at least one of molding, machining, threading, and gluing.

In an embodiment, slanted or tilted reservoirs may comprise a length suitable to result in a desired separation of the wet seals at the base of the reservoirs. The wet seal may comprise a Faraday cage covering the solidified metal section to reduce the heating of this section. The mating flanges, fasteners, and any other components of the wet seal may comprise materials that have a low absorption of RF from the inductively coupled heater such as Mo and BN. The cooling loop of the wet seal may cool at least the wet seal and may comprise a branch of a larger cooling systems such as one that further cools at least one of the reservoir 5c, the EM pump magnets 5k4, EM pump tube 5k6, and another EM pump or cell component. The wet seal cooling system may comprise at least one cooling loop, at least one pump, at least one temperature sensor, and a coolant flow controller.

In an embodiment, the mating flange seal may comprise a gasket. The gasket may be between the bolted flanges to form the seal. The gasket may comprise a male component that seals to a female component. A BN gasket may comprise a protrusion of the BN reservoir flange 5k17 wherein the BN gasket may comprise the male gasket component. The gasket may comprise another of the disclosure such as an alumina-silicate ceramic plate gasket.

In another embodiment, the reservoir ceramic such as BM may comprise at least one of a metalized ceramic or brazed seal to the metal EM pump assembly 5kk collar. Exemplary metallization materials and brazes comprise at least one of Ag, Ag—Cu, Cu, Mo—Mn, W—Mn, Mo—W—Mn, Mo—Mn—Ti, Cu-based alloy, Ni based alloy, Ag based alloy, Au based alloy, Pd based alloy, and active metal braze alloy.

In an embodiment of the slip nut seal, at least one of the group of: the nut, a threaded coating on the nut, and packing inside of the nut comprises an element that forms an alloy with the reservoir molten metal such as silver that has a higher melting point than the molten metal. The packing may comprise a power or cladding such as a metal powder or cladding. The seal may comprise a stuffing box-type wherein the sealant comprises the packing or cladding. The sealant may comprise a gasket comprising the element. The element may comprise at least one of Pt, a rare earth, Er, Gd, Dy, Ho, Pd, Si, Y, and Zr.

In an embodiment, the seal may comprise an inverse slip nut design (FIG. 141) wherein the nut 5k21 is threaded on the inside of the EM pump assembly 5kk collar, the reservoir tube 5c slips over the outside of the collar 5k15 of the EM pump assembly 5kk, and the gasket 5k14a is on the inner circumference of the reservoir tube 5c. An exemplary gasket and reservoir tube comprises boron nitride. The EM pump assembly 5kk may comprise stainless steel. The inverse slip nut seal may further comprise a compression retention sleeve 5k16 such as one comprised of W, Mo, or C that may oppose expansion forces of the collar 5k15 and reservoir 5c such as thermal expansion forces.

The seal may further comprise an inverse compression type (FIG. 142). In an exemplary embodiment, the EM pump assembly collar 5k15 expands against the reservoir tube 5c as the temperature is elevated from room temperature. The materials of the reservoir and EM pump assembly collar may be selected to have the desired coefficients of thermal expansion to achieve the compression seal without breaking the reservoir tube. In an embodiment of the inverse compression type seal, the seal further comprises a compression retention sleeve 5k16 around the reservoir tube 5c to increase the tube's tensile strength. The compression retention sleeve 5k16 may have a desired low thermal expansion coefficient to prevent the reservoir 5c from rupturing due to the inner expanding EM pump assembly collar 5k15. An exemplary compression retention sleeve 5k16 may comprise a refractory material such as W, Mo, or C. An exemplary compression seal may comprise at least one of a thin-walled collar 5k16 comprising a stainless steel of low thermal expansion coefficient such as 410 SS, Invar (FeNi36), Inovco (F333Ni4.5Co), FeNi42, or Kovar (FeNiCo alloy) to reduce the thermal expansion to prevent a BN reservoir 5c and a graphite compression retention sleeve 5k16 from cracking.

The seal may comprise at least one of an inverse slip nut and a compression seal. In an embodiment, the joint such as at least one of an inverse slip nut and a compression seal may further comprise threaded parts such as the outside of the EM pump tube collar threaded to the inside of the outer reservoir tube in the case of the compression seal. In an embodiment, the thread crests may be reduced in height relative to the thread recessions to comprise expansion joints along the compression joint contact area.

The baseplate and EM pump parts may be assembled to comprise the baseplate-EM pump-injector assembly 5kk (FIGS. 2I98 and 2I147). In the case of the dual molten metal injector embodiment, the generator comprises two electrically isolated baseplate-EM pump-injector assemblies. The electrical isolation may be achieved by physical separation of the two assemblies. Alternatively, the two assemblies are electrically isolated by electrical insulation between the assemblies. The nozzles of the dual liquid injector embodiment may be aligned. The reservoirs may be placed upside down or in an inverted position, and the metal to serve as the molten metal may be added to the reaction cell chamber through the open end of at least one reservoir. Then, the baseplate-EM pump-injector assembly may be connected to the reservoirs. The connection may be achieved with a connector of the disclosure such as a wet seal, compression, or the slip nut-collar connector. The baseplate-EM pump-injector assembly may comprise at least one of stainless steel or a refractory metal such as at least one of Mo and W. The parts such as the EM pump tube, reservoir bottom, nozzle, baseplate, and mating collar to the connector may be at least one of welded and fastened together. The fasteners may comprise threaded unions. Two base plates 5b8 of a dual molten injector embodiment may be connected by electrically insulating plates such as ceramic plates such as SiC, SiN, BN, BN +Ca, B₄C, alumina, or zirconia plates by means such as fasteners such as bolts to form a single reservoir structural support that may be elevated by posts such as ceramic posts or electrically insulated 410 SS, Invar (FeNi36), Inovco (F333Ni4.5Co), FeNi42, or Kovar (FeNiCo alloy) posts to reduce the effects of thermal expansion. The posts may comprise tubes to reduce the effects of thermal expansion. In an embodiment, the reservoir support plate 5b8 may comprise a single piece or pieces with braces to form a continuous plate to avoid thermal warping. The reservoir structural support that may be elevated by posts such as ceramic posts or electrically insulated 410 SS, Invar (FeNi36), Inovco (F333Ni4.5Co), FeNi42, or Kovar (FeNiCo alloy) posts that may comprise tubes to reduce the effects of thermal expansion.

In an embodiment, the SunCell® comprises a reservoir position adjustment system or reservoir adjustor to control the alignment of the molten metal injectors. In an embodiment comprising dual molten metal injectors, the SunCell® comprises a means to cause a length adjustment to the posts that support the reservoir support plates 5b8 to align the nozzles 5q such that the dual molten streams intersect. The SunCell® may comprise a reservoir support plate actuator such as at least one of a mechanical, pneumatic, hydraulic, electrometrical, and piezoelectric actuator such as one of the disclosure. The nozzles may lose alignment when the cell is heated due to differential expansion of the reservoir support posts. To avoid the thermal expansion caused misalignment, the post may comprise a material with a low coefficient of thermal expansion such as a refractory material. The posts may be at least one of thermally insulated and cooled to prevent their expansion. The SunCell® may comprise a post cooler such as a heat exchanger or a conduction or convention cooling means. The cooling may be achieved by conducting heat along the posts to a heat sink. The SunCell® may comprise a means to align the nozzles by selectively controlling the length of the posts supporting the reservoir support plates 5b8 by controlling and causing at least one of differential thermal expansion or contraction between different posts. The SunCell® may comprise at least one or more post heaters and post coolers to selectively and differentially heat or cool the reservoir support posts to cause the lengths to selectively change by expansion or contraction to cause the injectors to align.

In an embodiment, the SunCell® comprises a reservoir position adjustment system or reservoir adjustor such as a mechanical adjustor such as a push-pull rod adjuster that may penetrate the housing 5b3a. A threaded mechanism that acts on the rod at the housing 5b3a wall may provide the push-pull. The adjustor may provide movement along or about at least one axis. The adjustor may be capable of pushing or pulling at least one reservoir vertically or horizontally or rotating it about the x, y, or z-axis. The adjustment may be performed to cause the molten metal streams of the dual molten metal injector to intersect optimally. In an embodiment wherein the reservoir and the EM pump assembly may be rigidly connected by means such an as wet seal, the reservoir may rotate at the joint of the reservoir 5c with lower hemisphere 5b41. The reservoir central 5c axis and the EM pump assembly 5kk central axis with the nozzle may be along the same axis. An exemplary connector that permits a BN reservoir to rotate is a slip nut connector comprising a BN reservoir 5c, a graphite lower hemisphere 5b41, a graphite gasket, and a graphite nut. Both h-BN and graphite may comprise lubricants. The connectors to the EM pump such as those to the current 5k2 and ignition 5k2a bus bars may comprise a means such as a joint or pivot to allow the reservoir to rotate sufficiently to cause alignment of the injected molten metal streams. The bus bars may at least partially comprise stacked sheets or cables such as braided cables to permit the alignment motion. In an embodiment, adjusting the EM pump currents as controlled by a controller may control the vertical position of the streams, and the transverse position of the streams may be controlled by the reservoir adjustor. In an embodiment wherein the reservoir is rigidly fixed, the alignment may be achieved as a service operation wherein the SunCell® is partially disassembled, the nozzles are aligned, and the SunCell® is reassembled.

In an embodiment comprising dual molten metal injectors, the trajectory of the molten metal stream from one nozzle may be in a first plane and the plane of the trajectory of the molten metal stream from the second nozzle may be in a second plane that is rotated about at least one of the two Cartesian axes of the first plane. The streams may approach each other along oblique paths. In an embodiment, the trajectory of molten metal stream of the first nozzle is in the yz-plane, and the second nozzle may be displaced laterally from yz-plane and rotated towards that yz-plane such that the streams approach obliquely. In an exemplary embodiment, the trajectory of molten metal stream of the first nozzle is in the yz-plane, and the trajectory of molten metal stream of the second nozzle is in a plane defined by a rotation of the yz-plane about the z-axis such that second nozzle may be displaced laterally from yz-plane and rotated towards that yz-plane such that the streams approach obliquely. In an embodiment, the trajectories intersect at a first stream height and a second stream height that is each adjusted to cause the intersection. In an embodiment, the outlet tube of the second EM pump is off set from the outlet tube of the first EM pump tube, and the nozzle of second EM pump is rotated towards the nozzle of the first EM pump such that the molten streams approached each other obliquely, and stream intersection can be achieved by adjusting the relative heights of the streams. The stream heights may be controlled by a controller such as one that controls the EM pump current of at least one EM pump.

In an embodiment comprising two nozzles of two injectors initially aligned in the same yz-plane, the oblique relative trajectory of the injected molten metal streams to achieve intersection of the injected streams may be achieved by at least one operation of the rotation of at least one corresponding reservoir 5c slightly about the z-axis and the operation of slightly bending the nozzle that was translated out of the yz-plane by the rotation towards the yz-plane. The inductively coupled heater antenna 5f such as the pancake portion may be bent to be non-planar to accommodate the corresponding EM pump tube 5k6. Other components and connection may be rotated as necessary. For example, the EM pump magnets 5k4 may also be rotated to maintain their perpendicular position relative to the EM pump tube 5k6.

In another embodiment, the injection system may comprise a field source such as a source of at least one of a magnetic and an electric field to deflect at least one molten metal stream to achieve alignment of the injected streams. At least one of the injected molten metal streams may be deflected by a Lorentz force due the movement of corresponding conductor through an applied magnetic field and the force between at least one current such as the Hall and ignition current and the applied magnetic field. The deflection may be controlled by controlling at least one of the magnetic field strength, the molten metal flow rate, and the ignition current. The magnetic field may be provided by at least one of permanent magnets, electromagnets that may be cooled, and superconducting magnets. The magnetic field strength may be controlled by at least one of controlling the distance between the magnets and the molten stream and the magnetic field strength by controlling the current.

Measuring the ignition current or resistance may determine the optimal intersection. The optimal alignment may be achieved when the current is maximized at a set voltage or the resistance is lowest. A controller that may comprise at least one of a programmable logic controller and a computer may achieve the optimization.

In an embodiment, each reservoir may comprise a heater such as an inductively coupled heater to maintain the reservoir metal such as silver in a molten state for at least startup. The generator may further comprise a heater around the blackbody radiator to prevent the molten metal such as silver from adhering for at least during startup. In an embodiment wherein the blackbody radiator 5b4 heater is not necessary, the blackbody radiator such a 5b41 and 5b42 may comprise a material to which the molten metal such silver does not adhere. The non-adhesion may occur at a temperature that is achieved by heat transfer from the reservoir 5c heaters. The blackbody radiator may comprise carbon and may be heated to a temperature at or above that to which the molten metal such as silver is non-adherent before the EM pumps are activated. In an embodiment, the blackbody radiator is heated by the reservoir heaters during startup. The blackbody radiator 5b4 walls may be sufficiently thick to permit heat transfer from the reservoirs to the blackbody radiator to permit the blackbody radiator to achieve a temperature that is at least one of above the temperature at which the molten metal adheres to the blackbody radiator and greater than the melting point of the molten metal. In an embodiment, the inductively coupled heater (ICH) antenna that is in proximity to a heated cell component such as coiled around the reservoirs 5c is well thermally insulated from the cell component wherein the RF radiation from the ICH penetrates the insulation. The thermal insulation may reduce the heat flow from the cell component to the coolant of the ICH antenna to a desired flow rate.

The system further comprises a startup power/energy source such as a battery such as a lithium ion battery. Alternatively, external power such as grid power may be provided for startup through a connection from an external power source to the generator. The connection may comprise the power output bus bar.

In an embodiment, the blackbody radiator may be heated by an external radiative heater such as at least one heat lamp during startup. The heat lamps may be external to the PV converter 26a and may provide radiation through removal panels in the PV converter. Alternatively, the blackbody radiator may be heated during startup, and the heaters may be removed after the cell is continuously operating and producing enough power to maintain the reaction cell chamber 5b31 at a sufficient temperature to maintain the hydrino reaction.

In the case that the inductively coupled heater is inefficient at heating the reservoir such as ceramic reservoir such as a BN or SiC reservoir, the reservoir may comprise a refractory covering or sleeve capable of efficiently absorbing inductively coupled heater radiation. An exemplary RF absorbing sleeve comprises carbon.

The generator may comprise an actuator 5f1 such as at least one of a mechanical such as rack and pinion, screw, linear gear and others known in the art, pneumatic, hydraulic, and electromagnetic system to at least one of apply and retract the heater coil and store the heater coil. The electromagnetic actuator may comprise a speaker mechanism. The pneumatic and hydraulic may comprise pistons. The heater antenna may comprise a flexible section to permit the retraction. An exemplary flexible antenna is wire braided Teflon tubing that is copper braided. In an embodiment, the outer pressure vessel 5b3a may comprise recessed chambers to house the retracted antenna.

The inductively coupled heater antenna 5f may comprise sections that are movable. The inductively couple heater may comprise at least one coil 5f for each reservoir that may be retractable (FIGS. 2I84-2I152). The coil may comprise a shape or geometry that efficiently applies power to the reservoir. An exemplary shape is a cradle or adjustable clamshell for a cylindrical reservoir. The cradle may apply RF power to the corresponding reservoir during heat up and may be retracted thereafter. Each cradle may comprise a pancake coil and attach to a common pancake coil oriented in a plane parallel to the plane formed by the EM pump tubes of the EM pump assemble 5kk below its base. Each cradle pancake coil may be attached to the common pancake coil by a flexible or expandable antenna section. The common pancake coil may be attached to the inductively coupled heater capacitor box that may be mounted on the actuator. Alternatively, each cradle may be attached to a corresponding capacitor box and inductively coupled heater, or the two separate capacitor boxes may be connected to a common inductively coupled heater. At least one of the cradle pancake coils, common pancake coil, common capacitor box, and separate capacitor boxes may be mounted or attached to the actuator to achieve the movement to store the antenna following startup.

In an embodiment, the heater such as an inductively coupled heater comprises a single retractable coil 5f (FIGS. 2I93-2I94, 2I134-2I135, and 2I148-2I152). The coil may be circumferential about at least one of the reservoirs 5c. The heater may comprise a single multi-turn coil about both reservoirs 5c. The heater may comprise a low frequency heater such as a 15 kHz heater. The frequency of the heater may be in at least one range of about 1 kHz to 100 kHz, 1 kHz to 25 kHz, and 1 kHz to 20 kHz. The single coil may be retractable along the vertical axis of the reservoirs. The coil 5f may be moved along the vertical axis by an actuator such as one of the disclosure such as a pneumatic, hydraulic, electromagnetic, mechanical, or servomotor-driven actuator, gear-motor-drive actuator. The coil may be moved with mechanical devices known by those skilled in the art such as a screw, rack and pinion, and piston. Actuator parts that mechanically move over each other such as gear teeth or glide parts may be lubricated with a high temperature lubricant such as hexagonal boron nitride, MoS₂, or graphite. Others are talc, calcium fluoride, cerium fluoride, tungsten disulfide, soft metals (indium, lead, silver, tin), polytetrafluroethylene, some solid oxides, rare-earth fluorides, and diamond. The coil may be mounted to the actuator at one or more side or end positions or other convenient position that permits the desired motion while not overloading the actuator with weight. The antenna may be connected to the power supply through a flexible antenna section to permit the motion. In an embodiment, the inductively coupled heater comprises a split unit having the transmitter component separate from the balance of the heater. The separate transmitter component may comprise a capacitor/RF transmitter. The capacitor/RF transmitter may mount on the actuator. The capacitor/RF transmitter may be connected to the balance of the heater by flexible electrical lines and cooling lines in the outer pressure vessel chamber 5b3a1. These lines may penetrate the wall of the outer pressure vessel 5b3a. The capacitor/RF transmitter may be mounted on the actuator connected to the RF antenna wherein the antenna is also mounted on the actuator. The capacitors may be mounted in an enclosure box that may be cooled. The box may comprise a thermal reflective coating. The enclosure box may serve as the mounting fixture. The box may comprise mounting brackets to guide rails and other drive mechanisms. The inductively coupled heater may comprise a parallel resonance model heater that uses a long heater such as one 6 to 12 meter long. A heat exchanger such as cooling plates may be mounted on the capacitor/RF transmitter with cooling provided by the antenna cooling lines. The actuator may be driven by an electric servomotor or gear motor controlled by a controller that may be responsive to temperature profile inputs to achieve a desired temperature profile of the generator components such as the reservoirs 5c, EM pump, lower hemisphere 5b41, and upper hemisphere 5b42.

In an embodiment, the heater such as an inductively coupled heater comprises a single retractable coil 5f (FIGS. 2I93-2I94, 2I134-2I135, and 2I148-2I152) that is circumferential about the components of the cell that are desired to be heated such as at least one of at least a portion of the blackbody radiator 5b4, the reservoirs 5c, and the EM pump components such as the EM pump tube 5k6. In an embodiment, the heater may be stationary during heating. The geometry and coil turn density may be configured to selectively apply a desired heating power to each cell component or region of each cell component to reach a component or region specific desired temperature range such as in the range of 970° C. to 1200° C. Due to prior heating calibration and heater design, the monitoring of the temperature of a limited number points on the cell provides the temperatures of the non-monitored points on the cell. In an embodiment, the heater power and heating duration may be controlled to achieve the desired temperature ranges wherein temperature monitoring may not be necessary. Controlling at least one of the pumping of molten metal into the reaction cell chamber and the application of ignition power may control the heating of the blackbody radiator. Temperature sensors such as thermocouples or optical temperature sensors to provide input to the temperature controller may monitor the blackbody radiator temperature. An exemplary optical temperature sensor that may be scanned is Omega iR2P. Alternatively, the timed sequence of EM pumping and ignition power as well as inductively coupled heating power may be used to achieve a desired cell temperature profile such as one wherein the temperature of cell components that are in contact with the molten metal are above the metal melting point.

The heater coil 5f that simultaneously heats the desired cell components may permit the elimination of at least one of the heat transfer blocks 5k7, the particulate insulation, particulate insulation reservoir 5e1, and the control system to at least one of move the heater vertically and control the heater power level as the heater is moved vertically. The magnets of the inductively coupled heater 5k4 may comprise at least one of RF shields and sufficient water cooling provided by the cooling system such as one comprising EM pump coolant line 5k11 and EM pump cold plate 5k12 to prevent magnet overheating to the point of loss of magnetization from the heat power applied at the level of the EM pump tube 5k6. The RF shield may comprise multiple layers of an RF reflective material such as a highly electrically conducting material such as Al, Cu, or Ag that may comprise metal foil or screen.

In an embodiment, the inductively coupled heater shield may comprise a magnetic material to attenuate the magnetic flux that is incident on the EM pump magnets. Exemplary magnetic materials comprise Permalloy or Mu-Metal such as nickel based metals with high magnetic permeability such as one having a permeability of about 300,000 with a low saturation level. In an embodiment wherein the heater-applied magnetic field strength is high, the magnetic material may comprise a higher saturation material such as a magnetic metal such as carbon steel or nickel. In an embodiment, the magnetic material may have a design and permeability to minimize the negative effect on the permanent magnetic field lines of the permanent EM pump magnets due to permananet magnetic field being absorbed into the shielding metal and weakening the permananet field in the liquid metal in the EM pump tube. In another embodiment, the shielding comprises a Faraday cage 5k1a (FIG. 2I115) comprising a high conductivity metal such as copper around the components that are desired to be shielded such as the EM pump magnets 5k4. The Faraday cage parts 5ka1 such as panels may be fastened with fasteners such as highly conductive screws 5k1b such as copper screws. In an embodiment, the Faraday cage 5k1a does not affect the static magnetic field of the permanent magnets 5k4, so that the cage may completely surround the magnets. The Faraday cage may be cooled. The cooling may be provided by the EM pump cold plate 5k12 and EM pump coolant lines 5k11. In an embodiment, the cold plate may comprise a design used to cool concentrator PV cells such as one comprising microchannels. In an embodiment, each magnet may comprise an individual Faraday cage (FIG. 2I116). The wall thickness of the Faraday cage may be greater than the penetration depth of the RF emission of the inductively coupled heater. In an embodiment, the penetration depths of induction heating frequencies are less than 0.3 mm; thus, the cage wall may be thicker than 0.3 mm for the shielding wherein increasing wall thickness increases the shielding. In an embodiment, the EM pump magnets 5k4 may comprise a yoke 5k5 or trapezoidal magnet to direct the flux across the EM pump tube 5k6 and may further comprise a magnetic circuit wherein the magnets 5k4 and the magnet cooling systems 5k1 may be located in a position such as centered beneath the portion EM pump tubes 5k6 outside of the reservoir 5c. The magnetic circuit may comprise yokes that direct the flux transverse to the current at the position of the EM pump bars 5k2. In an embodiment, the magnets 5k4 may comprise pyramidal magnets that concentrate the high magnetic field through the EM pump tube 5k6 walls along the x-axis with current along the z-axis and pump flow along the y-axis. In an embodiment, the EM pump bus bars such as at least one of 5k2 and 5k3 may comprise a highly conductive conductor capable of operating at high temperature such as Mo. The magnetic circuit may comprise the EM pump magnets 5k4, a core comprising a highly permeable material that may further comprise magnets between sections thereof, a gap of the circuit for the EM pump tube 5k6, and yokes at the gap to concentrate the flux through the EM pump tube 5k6. The core may comprise a upward-C-shaped permeable material such as ferrite wherein the gap is the opening of the C. In another embodiment, the EM pump comprises a stator with a plurality of windings and at least one cylindrical duct that contains the molten metal to be pumped. In an exemplary embodiment, the stator with three pairs of helical windings generates a rotating twisted magnetic field. Axial thrust, as well as rotational torque is produced that acts on the molten metal in cylindrical ducts.

In an embodiment, the inductively coupled heater coil 5f may further comprise concentrators to intensify the electromagnetic field in desired regions by increasing corresponding currents in the cell component or region of a cell component. Exemplary concentrators may comprise ferrites at high frequency and shim steel at low frequencies. The concentrator may serve to achieve a desired temperature profile of the cell. In an embodiment comprising cell components that are desired to be heated but are not comprised of materials that readily couple to the RF power of the inductively coupled heater, the component may be clad with an RF absorbing material such as carbon. The cladding may comprise a split or expansion gap to accommodate differ thermal coefficients of expansion. An exemplary embodiment comprises cylindrical BN reservoirs 5c clad with cylindrical graphite sleeves that are split to accommodate differential thermal expansion.

In an embodiment, the inductively coupled heater antenna coil 5f that may be water-cooled may comprise at least a coil that is circumferential to the two reservoirs and coil or portion of a coil that is circumferential to at least a portion of the blackbody radiator 5b4. The coil may further comprise at least one pancake coil. The plane of the pancake coils may be parallel to the plane of the EM pump tube outside of the reservoir. The pancake coils may be positioned along at least one side of the external portion of the EM pump tube. The pancake coil may heat both EM pump tubes. Alternatively, the antenna 5f may comprise a plurality of pancake coils wherein the pancake coils may individually or commonly heat each EM pump tube. The pancake coils may be retractable along the vertical axis of the generator. The pancake coils may be retractable with the reservoir coil and may be part of the reservoir coil. The antenna may comprise a plurality of separate components. The antenna may comprise two antennas each comprising a pair of pancake coils. The two pancake coils may each comprise an upper one to heat at least one of a portion of the blackbody radiator and the reservoir. The upper pancake coil may be fitted around the heated surface. Exemplary shapes are a C-shape around the bottom of the spherical or oval blackbody radiator and a U-shape around the cylindrical reservoir, respectively. The coils may be retractable along a plurality of axes such a horizontal axis and then a vertical axis to be stored after startup. The actuator may move each antenna 5f along these axes to achieve the storage. The connecting portion of the antenna may comprise flexible conducting water lines such as flexible metal tubing such as bellows tubing. The tubing may comprise copper.

In an embodiment, the pancake or other coil 5f may comprise at least one flexible section. The flexible section may permit the coil to be retracted about a cell component such as the EM pump magnets 5k4, yolk 5k5, or protrusion on the Faraday cage that house at least one magnet optionally comprising a magnetic flux concentrating yoke. Alternatively, the EM pump may comprise at least one of movable yokes such as ones that may slip off that may be outside of the Faraday cage and movable magnets 5k4 that may be on tracks to facilitate the retraction of the pancake coil. In an embodiment, sections of a heated component such as the EM pump tube 5k6 at the region of the EM pump ignition bus bars 5k2a may be selectively heated by the inductively couple heater antenna 5f by at least one of the antenna comprising a portion of its coil having close proximity to the component and by the component comprising a material that better couples to the RF field such as magnetic steel over stainless steel or molybdenum. Similar materials may be attached together with a transition attachment to magnetic metal. Exemplary attachments are welds and bolt and nut fasteners. The EM pump ignition bus bars 5k2a may comprise stainless steel welded to a stainless steel pump tube 5k6 and magnetic steel welded or fastened to the stainless steel portion of the EM pump ignition bus bars 5k2a. In an embodiment, the ignition bus bars 5k2a may be attached to the baseplate 5b8.

The antenna coil 5f may comprise at least one coiled loop wherein the coil loop is reversible extendible and contractible so that the coil can be collapsed in close proximity to the cell to achieve good RF power coupling and then expanded to permit retraction and storage of the antenna. The antenna storage may be achieved with an actuator of the disclosure. Each loop of the coil may comprise a telescopic or bellows section. In an embodiment, at least one loop of the antenna coil 5f may be reversibly expandable and contractible. The loop may comprise a telescopic or bellows section. The water-cooling may be achieved with tubing sealed inside of the reversibly expandable and contractible section the coil loop. The tubing may comprise Teflon or other high temperature water tubing that may be inserted inside of the conducting coil loop to at least bridge the reversibly expandable and contractible section. The tubing may be coated with a conductor such as a flexible conductor such as braided metal such as braided copper wire. An exemplary flexible antenna section is wire braided Teflon tubing or elastic tubing such as surgical tubing. The wire braid may comprise copper braid. Alternatively, the extendible section may comprise a metalized plastic such as Mylar. The antenna coil 5f may further comprise an actuator to expand or contract the at least one loop. In an embodiment, the loop may be contracted to achieve a closer proximity to the heated cell component such as the reservoir. The proximity may achieve greater RF coupling to the cell component. The same or at least one additional actuator may expand the loop to permit the same or another actuator to move the coil to store it. The movement may be vertically. The storage may be in the lower chamber 5b5. The coil may be expanded and contracted by water and vacuum pressure applied to the antenna coil wherein the cooling loop of the inductively coupled heater power supply and capacitor may be bypassed by a solenoid valve. The downward linear motion of the actuator moving a spring-loaded coil over a spreader may expand the coil.

In an embodiment shown in FIGS. 2I148-2I152, a circumferential coil about at least one of the two reservoirs 5c of a dual molten metal injection system and at least a portion of the blackbody radiator 5b4 is reversibly expandable and contractible. The coil may be split vertically in two locations per loop of the coil that extends axially (vertically along the cell). A flexible electrical connector such as a wire such as Litz wire may bridge the spit loop sections. The wire may be highly conductive such as copper wire. The wire may be refractory such as W or Mo. The each bridge such as a wire may be cooled externally by means such as conduction, convection, and radiation. The bridge may be cooled with a gas such as one with a high heat transfer capability such as helium. The bridge gas cooling system may comprise a forced convection or conduction system. The bridge cooling system may comprise an external heat exchanger such as an external coolant heat exchanger. The bridge such as a wire may coil when in the collapsed position. The bridge coil may comprise a spring wire that reversibly extends and contracts. In an exemplary embodiment, the antenna may comprise a refractory metal spring to electrically jump the retractable coil sections of the inductively coupled heater antenna. The jumpers may be helium cooled or cooled by other external system such as a separate coiling system such as a heat exchanger in thermal contact with the antenna wire jumper. Alternatively, the jumper may be not actively cooled.

In an embodiment of the split oval helical coil, the connections between opposing split coil loop sections comprise contact connections (FIGS. 2I151-2I152). The contacts may comprise coil loop end plates. The contacts on the ends of the opposing coil loop sections may comprise male 5f4 and female 5f5 connectors or other electrical contact connectors known by those skilled in the art. The contacts may be engaged and disengaged by the actuator 5f1 as it translates the split coil sections horizontally into and out of contact. Each male plug connector 5f4 may comprise a rounded or pointer end so that it aligns more easily with the female connector 5f5 when the two antenna halves are slid together. The connected two half antenna sections may form an oval helix. The antenna may operate as an oval helix with an attached vertical plane pancake coil when in the closed (plugged together) configuration. In another embodiment, the antenna comprises a spilt oval coil wherein each of the two sections comprises an attached member of a pair of pancake coils that may optionally comprise electrical connectors for mating the pair. The antenna may operate as an oval helix a vertical plane pancake coil comprising two connected or non-connected sections when the antenna is in the closed (plugged together) configuration. In the case that the closed antenna comprises two non-connected members of the two-piece pancake coil, each member may comprise a separate system of water-cooling connectors. In an embodiment, at least one EM pump magnet 5k4 that may further comprise a Faraday cage 5k1a may be reversibly movable to accommodate the engagement and disengagement of the split antenna by the actuator. The retraction of the magnets may allow the pancake coil to pass during its movement by the actuator. The magnets may be moved in to the operating position such as in close proximity to the EM pump tube 5k6 after the pancake coils have been moved into their operating position.

The coil loops of each half of the split coil may comprise water conduits 5f2 that run between vertically contiguous coil loop ends. The conduits may be oppositely threaded to screw into a face or edge of the coil. The loops of the antenna may be separated and supported by antenna spacers and supports 5f3. In an embodiment, the water conduits 5f2 and coil loop sections provide a continuous flow path for coolant such as water. The coolant conduits may be electrically isolated or comprise an electrical insulator such as a high-temperature polymer, a ceramic, or glass. The coolant conduits may comprise a conductor that is electrically isolated at the coil loops. The coolant conduits may be heat shielded. Exemplary Teflon or Delrin acetal water conduits connect the ends of contiguous loop sections of each half coil to water cool each half coil independently. The conduits may be fabricated by extrusion, injection molding, stamping, milling, machining, and 3D laser printing. The conduits may connect to coolant tubes that may be welded to the antenna coil loops. The water conduits such as Teflon pipes may also serve as structural supports. In an embodiment, the water-cooling conduit channel may be bidirectional within each loop section. In an embodiment, the antenna may comprise separate coolant conduits such as Teflon water conduits 5f2 and structural supports or spacers 5f3. The structural supports may comprise refractory insulator spacers such as boron nitride or silicon nitride ones that may further be resistant to thermal shock. In an embodiment, each half coil is connected to the capacitor box of the antenna RF power supply 90a. The power connection may be cooled and serve as coolant line. Each half coil may further comprise another coolant line or connection coolant line to serve as a conduit to form a closed coolant loop through the corresponding half antenna and a heat exchanger such as a chiller. Each of the connection coolant lines may be for cooling only wherein each may comprise an electrical insulator or may be electrically isolated from the antenna.

In an embodiment, the SunCell® comprises a plurality of antennas such as two coils that envelop and heat the reservoirs 5c and at least one pancake coil that heats the EM pump tubes 5k6. Each coil may comprise at least one of its own capacitor box and power supply. The power source may comprise a power splitter. The antenna may comprise two upper C coils and at least one pancake coil that may comprise separate power sources and separate controllers such as each one comprising a temperature sensor such as an infrared sensor such as an optical pyrometer and a power controller. The coils may be retracted by at least one accuator when not being operated. In an embodiment, at least one coil such as the pancake coil or coils may be drained of coolant when not in use and remain in the operating position (un-retracted). The coil may comprise a pump, a coolant reservoir or supply, and controller to reversibly add and drain the coolant during operation and storage modes, respectively.

In an embodiment, the SunCell® comprises a plurality of antennas such as two coils that envelop and heat the reservoirs 5c and at least one pancake coil that heats the EM pump tubes 5k6 wherein the chopping frequency of each antenna is independently modulated to prevent coupling between antennas. At least one of the antennas may be retractable. The SunCell® may comprise at least one actuator to achieve the retraction. Alternatively, at least one antenna may be stationary. The stationary antenna may serve a secondary role as a heat exchanger to remove excess heat during SunCell® power generation operation. The heat exchanger antenna may comprise a conductor with a high melting point such as a refractory metal such as molybdenum or another of the disclosure. The antenna may comprise water or another coolant such as a molten metal, molten salt, or another of the disclosure or known in the art. The coolant of a stationary antenna may be drained following SunCell® startup. Alternatively, the coolant may be used to remove heat from the SunCell® when operating to generate power. The stationary antenna may be used to heat at least one SunCell® component during startup and cool at least one component during power generation. The SunCell® component may be at least one of the group of a component of the cell such as at least one of the EM pump 5ka, the reservoirs 5c, and the reaction cell chamber 5b31, and a component of the MHD converter such as at least one of the MHD nozzle section 307, MHD generator section 308, MHD condensation section 309, return conduits 310, return reservoirs 311, return EM pumps 312, and return EM pump tube 313.

In an embodiment, the antenna 5f may comprise an RF coupling material that may transfer the heating power to the reservoirs. The RF coupling material may comprise carbon. The carbon may comprise blocks that fit into the antenna to be space filling and forming to the antenna and reservoirs. The RF coupling material may be deformable to permit storage of the antenna following cell startup. The carbon blocks may be deformable. The carbon blocks may be telescoping. The telescoping carbon blocks may be spring loaded to provide good RF coupling and thermal contact to the reservoirs. The carbon blocks may be contracted so that the antenna may be stored. The graphite blocks may be extended and contracted by an actuator system such as a pneumatic, hydraulic, electronic, mechanical system or other actuator of the disclosure. A hydraulic system may apply pressure from the antenna coolant provided by the coolant pump wherein the inductively coupled heater cooling loop may be bypassed using a solenoid valve. A pneumatic system may apply vacuum or pressure provided by the vacuum pump. A mechanical actuator may comprise a rack and pinion or ball screw actuator or other of the disclosure.

Each magnet may be housed in a separate Faraday cage (FIG. 2I116). In another embodiment, the pancake coil may be shaped to have a section under each EM magnet to permit its retraction. A retractable pancake coil on one side of the plane defined by the EM pump tubes may comprise at least one of an inverted doubled-back or looped-back C shaped coil and a doubled-back W shaped coil wherein the coil passes under each magnet at those positions. The coil 5f such as the pancake coil may be circumferential to the heated part such as the EM pump tube to increase the heating efficiency. The coil such as the doubled-back W shaped coil shown in FIGS. 2I151-2I152 may selectively heat at least a portion of each EM pump tube such as the inlet and outlet sides while application of RF power to the magnets is reduced. To achieve good RF power transfer from the doubled-back W shaped coil to the EM pump tube, the EM pump tubes may be sufficiently separated in the middle between the reservoirs to allow each leg of the antenna to run outside of the corresponding pump tube in the inverted V-shaped section of the antenna. At least one of the EM pump tube and antenna may be fabricated by using the systems and method of coil tube bending to achieve the tight fit of the pump tube inside of the antenna coils. In another embodiment, the winding of a double coil crosses over in the middle such the path along the antenna coil is outer-inner-outer-inner versus outer-outer-inner-inner.

The coils 5f such as at least one of the circumferential and pancake coils may be electrically insulated. The tubing of the antenna may comprise wide flat tubing to cover more surface area to better couple heating power to the cell component. Components that do not effectively absorb RF power such as boron nitride reservoirs may be covered with an RF absorber covering that may comprise a material such as carbon that has better RF coupling or absorption. The carbon for indirect RF heating of the reservoir such as a BN reservoir may be attached as sections such as two circumferential clamshells that may be held in place with a fastener such as a W clamp, band, or wire. In an embodiment, the clamshell is designed to prevent electrical contact between electrically polarized parts of the cell to avoid electrical shorting. To avoid reactivity to form iron carbide, a carbon clamshell should not make contact with part comprising iron; the clamshell may comprise a material other than carbon in the case that the clamshell contacts iron or a part such as a nut comprising iron. Other such chemical incompatibilities should be avoided as well. In an embodiment, the RF absorber covering may comprise a material such as carbon weave, honeycomb, or foam that serves to absorb RF power from the inductively coupled heater and serve as thermal insulation. The antenna electrical insulation may comprise at least one of Fibrex, Kapton tape, epoxy, ceramic, quartz, glass, and cement. At least one coil may be retracted and stored following startup. The storage may be in a second compartment inside the chamber that houses the blackbody radiator. Other special geometry coils such as hairpin or pancake coils such as one along portions of the ends, sides, or bottom of the EM pump tube outside of the reservoir are within the scope of the disclosure. Any of the coils may comprise concentrators. In another embodiment, the generator comprises a plurality of coil actuators wherein the antenna to heat the cell may comprise a plurality of coils that may be retracted along a plurality of axes. In an exemplary embodiment, the coils may be retracted horizontally and then retracted vertically. In an embodiment, the generator may comprise at least one EM pump tube heater coil and at least one coil actuator and at least one EM pump magnet actuator. The heater coil or coils may heat the EM pump tube section outside of the reservoir with the EM pump magnets retracted, the coil or coils may be retracted with the coil actuator or actuators, and the EM pump magnet actuator or actuators may move the EM pump magnets into place to support pumping before the EM pump tube cools below the melting point of the molten metal inside such as silver. The motion of the coil retraction and magnet positioning may be coordinated. The coordination may be achieved by mechanical connections or by a controller such as one comprising a computer and sensors.

In an embodiment, the EM pump tube 5k6 may be selectively heated while maintaining the EM pump magnets 5k4 cool by at least one of (i) using at least one of an RF shield and a magnetic shield or Faraday cage to decrease the RF power incident the EM pump magnets, (ii) using concentrators to selectively intensify the electromagnetic field at the EM pump tube and consequently increase the RF currents and heating in the EM pump tube wherein the magnetic field of the concentrator may be along a direction that avoids interference with the EM pump such as in the direction of the EM pump current or in the direction of the EM pump tube, (iii) using a RF coil 5f that selectively heats the EM pump tube 5k6, (iv) using a heat transfer means such as heat transfer blocks 5k7, an EM pump tube with a larger cross section, or heat pipes to transfer heat from the heated upper cell components to the less heated EM pump tube, and (v) increasing the magnet cooling by a cooler such as electromagnetic pump heat exchanger 5k1. The reservoir baseplate may comprise a material such as ceramic that resists absorption of RF from the inductively coupled heater such that more power may be selectively absorbed by the EM pump tube with heating applied in the corresponding region.

The heater coil and capacitor box may be mounted to the actuator that may be moved into heating position during startup and retracted into a storage compartment when not in use. The storage compartment may comprise a section in the outer pressure vessel chamber 5b3a1 that may also contain power conditioners. The coil may further serve to water cool the storage compartment that may cool the power conditioners. The means to move the heater may comprise one of the disclosure such as a motor driven ball screw or rack and pinion mechanism that may be mounted in the heater storage compartment. The heater storage compartment may comprise the power conditioning equipment chamber.

In an embodiment, the actuator may comprise a drive mechanism such as a servo-motor that is mounted in a recessed chamber such as one in the base of the outer pressure vessel 5b3b. The servo-motor or gear motor may drive a mechanical movement device such as a screw, piston, or rack and pinion. At least one of the coil 5f and the capacitor for the inductively coupled heater may be moved by the movement device wherein the motion may be achieved by moving a guided mount to which the moved components are attached. In an embodiment, the actuator may be at least partially located outside of the outer pressure vessel 5b3a. The actuator may be at least partially located outside of the base of the outer pressure vessel 5b3b. The lifting mechanism may comprise at least one of a pneumatic, hydraulic, electromagnetic, mechanical, or servomotor-driven mechanism. The coil may be moved with mechanical devices known by those skilled in the art such as a screw, rack and pinion, and piston. The actuator may comprise at least one lift piston with piston penetrations that may be sealed in bellows wherein the mechanism to move the pistons vertically may be outside of the pressure vessel 5b3a such as outside of the base of the outer pressure vessel 5b3b. An exemplary actuator of this type comprises that of an MBE/MOCVD system such as a Veeco system comprising exemplary shutter blade bellows. In an embodiment, the accuator may comprise a magnetic coupling mechanism wherein an external magnetic field can cause a mechanical movement inside of the outer pressure vessel 5b3a. The magnetic coupling mechanism may comprise an external motor, an external permanent or electromagnet, an internal permanent or electromagnet and a mechanical movement device. The external motor may cause the rotation of the external magnet. The rotating external magnet may couple to the internal magnet to cause it to rotate. The internal magnet may be connected to the mechanical movement device such as a rack and pinion or screw wherein the rotation causes the device to move at least one of the coil 5f and the capacitor. The actuator may comprise an electronic external source of rotating magnetic field and an internal magnetic coupler. In an embodiment, the external rotating magnetic field coupling to an internal magnet may be achieved electronically. The rotating outer field may be produced by a stator, and the coupling may be to an internal rotor such as the ones of an electric motor. The stator may be an electronically commutating type. In another embodiment, actuator parts that mechanically move over each other such as gear teeth or glide parts may be lubricated with a high temperature lubricant such as MoS₂ or graphite.

In an embodiment such as shown in FIGS. 2I95-2I149, the motor 93 such as a servomotor or gear motor may drive a mechanical movement device such as a ball screw 94 with bearing 94a, piston, rack and pinion, or tight cable suspended on pulleys. At least one of the antenna and inductively coupled heater actuator box may be attached to the cable that is moved by a drive pulley that is rotated by an electric motor. The drive connection between the motor 93 and the mechanical movement device such as a ball screw mechanism 94 may comprise a gearbox 92. The motor such as the gear motor and the mechanical movement device such as the rack and pinion or ball and screw 94, and guide rails 92a may be inside or outside of the outer pressure vessel 5b3a such as outside of the base plate of the outer pressure vessel 5b3b and may further comprise a linear bearing 95 and bearing shaft that may be capable of at least one of high-temperature and high-pressure. The linear bearing 95 may comprise a glide material such as Glyon. The bearing shaft may penetrate the outer pressure vessel chamber 5b3a1 such as through the base plate of the outer pressure vessel 5b3b and attach to at least one of the heater coil 5f and the heater coil capacitor box to cause their vertical movement when the shaft is driven vertically in either the upward or downward direction by the mechanical movement device. The linear bearing may be mounted in a recessed chamber such as one in the base of the outer pressure vessel 5b3b. The bearing shaft may penetrate the base plate of the outer pressure vessel 5b3b through a hole. At least one of the coil 5f and the capacitor 90a for the inductively coupled heater may be moved by the movement device wherein the motion may be achieved by moving a guided mount to which the moved components are attached.

In an embodiment, the cell components such as the lower hemisphere 5b41, the upper hemisphere 5b42, the reservoirs 5c and connectors may be capable of being pressurized to the pressure at the operating temperature of the blackbody radiator such as 3000K corresponding to a silver vapor pressure of 10 atm. The blackbody radiator may be covered with a mesh bottle of carbon fiber to maintain the high pressure. The outer pressure vessel chamber 5b3a1 may not be pressurized to balance the pressure in the reaction cell chamber 5b31. The outer pressure vessel may be capable of atmospheric or less than atmospheric pressure. The outer pressure vessel chamber 5b3a1 may be maintained under vacuum to avoid heat transfer to the chamber wall. The actuator may comprise a sealed bearing at the base plate 5b3b of the outer vessel 5b3a for the penetration of a turning or drive shaft driven by an external motor such as a servo or stepper motor controller by a controller such as a computer. The drive system may comprise at least one of a stepper motor, timing belt, tightening pulley, drive pulley or gearbox for increased torque, encoder, and controller. The drive shaft may turn a gear such as a worm gear, a bevel gear, a rack and pinion, a ball screw and nut, a swashplate, or other mechanical means to move the heater coil 5f. The bearing for the drive shaft penetration may be capable of sealing against at least one of vacuum, atmospheric, and elevated pressure. The bearing may be capable of operating at elevated temperature. In an embodiment, the bearing may be offset from the base plate 5b3b by a collar or tube and flange fitting to position the bearing in a lower operating temperature environment.

It is a well-established phenomenon that the vapor pressure of any gas in equilibrium with its liquid phase is that of the coldest liquid in which is in contact and equilibrium with. In an embodiment, the temperature of the molten metal liquid in the reservoir 5c at its surface in contact with the reaction cell chamber 5b31 atmosphere is much lower than the reaction cell chamber 5b31 temperature such that the metal vapor pressure in the reaction cell chamber 5b31 is much lower that silver vapor pressure at the temperature of the blackbody radiator. In an exemplary embodiment, the temperature of silver liquid at its surface in contact with the reaction cell chamber 5b31 atmosphere is in the range of about 2200° C. to 2800° C. such that the silver vapor pressure in the reaction cell chamber 5b31 is slightly above one atmosphere wherein pressure above this will result in condensation to liquid at the gas-liquid interface. In an embodiment, the cell comprises a means to establish a high temperature gradient between the reaction cell chamber 5b31 and the interior of the reservoir 5c. The high temperature gradient may ensure that the molten metal liquid-vapor interface is at a temperature sufficiently below the melting point of the reservoir 5c. The temperature may also provide a desired metal vapor pressure. The temperature gradient means may comprise at least one of heat shields, baffles, insulation, and narrowing of the reservoir diameter, and narrowing the opening between the reaction cell chamber 5b31 and the reservoir 5c. Another option is at least one of narrowing the reservoir wall thickness, increasing the reservoir wall area, and maintaining reservoir cooling with a heat exchanger and heat rejecter such as a water cooled radiator to increase the heat transfer from the reservoir.

In an embodiment to increase the thermal gradient from the reaction cell chamber 5b31 to the reservoir 5c liquid metal interface wherein the power in the reaction cell chamber 5b31 is transferred predominantly by radiation and the molten metal such as silver has a very low emissivity for the molten metal and its vapor, essentially all of the power from the reaction cell chamber 5b31 is reflected at the liquid silver interface. In an embodiment, the reservoir is designed to exploit the reflection of the power back into the reaction cell chamber 5b31. The reservoir may comprise at least one of reflectors and baffles to create a temperature gradient at the reservoir 5c by at least one of mechanism of the group of increased reflection, reduced conduction and reduced convection. In another embodiment, the molten metal such as silver comprises an additive comprising a less dense material that may float on the top of the liquid metal and change the emissivity at the interface to increase the power refection. The additive may also perform at least one function of increasing the condensation rate of the metal vapor and decreasing the vaporization rate of the metal vapor.

In an embodiment, the power may be supplied to the outer pressure vessel chamber 5b3a1 by feed throughs to an axillary system power supply that powers at least one axillary system such as at least one of the inductively coupled heater, at least one electromagnetic pump, the ignition system, and at least one vacuum pump. In an embodiment, the power to run at least one axillary system is provided by the output of the PV converter 26a. The axillary system power supply may comprise at least one power conditioner that receives power output from the PV converter 26a within the outer pressure vessel chamber 5b3a1 and powers at least one auxiliary system. The axillary system power supply may comprise an inverter sufficient to provide power to the parasitic generator loads such as those of the inductively coupled heater, at least one electromagnetic pump, and the ignition system. The ignition system may be powered by AC power directly from the inverter or indirectly following power conditioning. The ignition system may be powered by DC power that may be supplied by the PV converter 26a. The PV converter may charge a capacitor bank capable of outputting a desired voltage and current such as a voltage in the range of about 1 V to 100 V and a current in the range of about 10 A to 100,000 A. The main power of the PV may be output as DC power though feed throughs. The corresponding external feed throughs of the parasitic loads may be replaced by the internal source of power comprising internally conditioned power from the PV converter. In an embodiment, the outer pressure vessel chamber 5b3a1 may comprise a power conditioning equipment chamber that houses the at least one power conditioner. The power conditioning equipment chamber may be at least one of heat shielded, thermally insulated, and cooled. The outer pressure vessel 5b3a may comprise a housing that may be operated at about atmospheric pressure such as atmospheric pressure within plus or minus 100%. The outer pressure vessel 5b3a may be any desired shape such as rectangular.

The generator may comprise a heater system. The heater system may comprise a movable heater, an actuator, temperature sensors such as thermocouples, and a controller to receive the sensor input such as temperatures of the cell components such as those of the upper hemisphere, the lower hemisphere, the reservoir, and the EM pump components. The thermocouples may comprise one in a thermocouple well that provides access to the temperature in the cell interior such as at least one of the temperature inside of the EM pump tube and the temperature inside of the reservoir. The thermocouple may penetrate into at least one of the EM pump tube and reservoir through the wall of the EM pump tube. The thermocouple may measure the temperature of the connector of the EM pump tube and the reservoir such as the Swagelok temperature that may be measured internal to the EM pump tube. The Swagelok temperature may be measured with an external thermocouple that has good thermal contact to the Swagelok surface by means such as a bonding means or thermal conductor such as thermal paste. The thermocouple may be mounted in a thermowell such as a welded in one in the EM pump assembly 5kk. The controller may at least one of drive the actuator to move the heater coil and control the heater power to control the temperatures of the cell components in desired ranges. The ranges may each be above the melting point of the molten metal and below the melting point or failure point of the cell component. The thermocouples may be capable of high temperature operation such as ones comprised of lead selenide, tantalum, and others known in the art. The thermocouples may be electrically isolated or biased to prevent interference for external power sources such as the inductively coupled heater. The electrical isolation may be achieved with an electrically insulating, high temperature capable sheath such as a ceramic sheath. The thermocouples may be replaced by infrared temperature sensors. The optical sensors may comprise fiber optic temperature sensors. At least one fiber optic cable may transmit the light emitted by the blackbody radiator 5b4 to an optical thermal sensor to measure the temperature of the blackbody radiator 54b. An exemplary optical temperature sensor that may be scanned is Omega iR2P. The optical sensor may be spatially scanned to measure the temperature of a plurality of positions on the generator. The spatial scanning may be achieved by an actuator such as electromagnetic or other actuator of the disclosure or known by those skilled in the art.

The thermocouples that measure at least one of the lower and upper hemisphere temperatures may be retractable. The reaction may occur when the measured temperature reaches an upper limit of its operation. The retractor may comprise a mechanical, pneumatic, hydraulic, piezoelectric, electromagnetic, servomotor-driven or other such retractor known by those skilled in the art. The retraction may be within or more distal to the PV converter that is cooled. The temperature of at least one of the lower and upper hemisphere above the operating temperature of the thermocouple may be measured by at least one of an optical sensor such as a pyrometer or spectrometer and by the PV converter response.

The coil may be lowered after cell startup. The base plate 5b3b may have recessed housings for at least one of the coil 5f and the corresponding capacitor bank mounted on the actuator. The coil may comprise a water-cooled radio frequency (RF) antenna. The coil may further serve as a heat exchanger to provide cooling water-cooling. The coil may serve to water cool the electromagnetic pump when its operating temperature becomes too high due to heating from the hydrino reaction in the reaction cell chamber 5b31 wherein heat is conducted to the EM pump along the reservoirs 5c. Cell components such as the EM pump and reservoirs may be insulated to maintain the desired temperature of the component with the heating power lowered or terminated wherein the antenna may also provide cooling to non-insulated components. An exemplary desired temperature is above the melting point of the molten metal injected by the EM pump.

In an embodiment, the inductively coupled heater may extend to the EM pump region to heat the EM pump tube to maintain the molten metal when needed such as during startup. The magnets may comprise an electromagnetic radiation shield to reflect a substantial portion of the heating power from the inductively coupled heater. The shield may comprise a highly electrically conductively covering such as one comprising aluminum or copper. The EM pump magnets may be shielded with an RF reflector to allow the coil 5f to be at the level of the magnets. The avoidance of heating the EM pump magnets may be at least partially achieved by using a notched coil design wherein the notch is at the magnet location. The inductively coupled heater power may be increased as the EM pump power is decreased and vice versa to maintain a stable temperature to avoid rapid changes that cause EM pump and reservoir connector thread failures.

The EM magnets 5k4 may comprise a conduit for internal cooling. The internal cooling system may comprise two concentric water lines. The water lines may comprise an internal cannula that delivers water to the EM-pump-tube end of the magnet and an outer return water line. The water lines may comprise a bend or elbow to permit a vertical exit of the outer pressure vessel 5b3a through the base 5b3b. The two concentric internal water lines of each magnet may be on the center longitudinal axis of the magnets. The water lines may press into a channel in the magnets. The internal cooling system may further comprise heat transfer paste to increase the thermal contact between the cooling lines and the magnets. The internal water-cooling lines may decrease the size of the magnet cooling system to allow the heater coil 5f to move vertically in the region of the EM pump. The magnets may comprise a non-linear geometry to provide axial magnetic field across the pump tube while further providing a compact design. The design may allow passage of the coil 5f over the magnets. The magnets may comprise an L-shape with the L oriented such that the cooling lines may be directed in a desired direction to provide a compact design. The water lines may be directed downwards towards the base of the outer pressure vessel 5b3b or to horizontally such as towards the center between the two reservoirs. Consider a clockwise circular path of the latter case that follows the axes of the four EM pump magnets of two reservoirs. The magnetic poles may be oriented S-N-S-N//S-N-S-N wherein // designates the two sets of EM pump magnets, and the current orientation of one EM pump relative to the other may be reversed. Other compact magnet cooling designs are within the scope of the present disclosure such magnet-fitted coolant jackets and coils.

The EM pump may comprise a RF shield at EM pump magnets 5k4 to prevent the magnets from being heated by the inductively coupled heater coil 5f. The shield can later serve as a heat transfer plate when the RF coil 5f contacts it in cooling mode with RF of the inductively coupled heater off. In another embodiment, the coolant lines may penetrate through the sides of the magnets in a coolant loop through each magnet. Other coolant geometries may be used that are favorable for removing the heat from the magnets while permitting the heater coil to pass by them when moved vertically.

In an embodiment, the heater indirectly heats the pump tube 5k6 by heating the reservoir 5c and the molten metal contained in the reservoir. Heat is transferred to the pump tube such as the section having an applied magnetic field through at least one of the molten metal such a silver, the reservoir wall, and the heat transfer blocks 5k7. The EM pump may further comprise a temperature sensor such as a thermocouple or thermistor. The temperature reading may be input to a control system such as a programmable logic controller and a heater power controller that reads the pump tube temperature and controls the heater to maintain the temperature in a desired range such as above the melting point of the metal and below the melting point of the pump tube such as within 100° C. of the melting point of the molten metal such as in the range of 1000° C. to 1050° C. in the case of molten silver.

Cell components such as at least one of the lower hemisphere 5b41, the upper hemisphere 5b42, the reservoirs 5c, the heat transfer blocks 5k7, and the EM pump tube 5k6 may be insulated. The insulation may be removable following startup. The insulation may be reusable. The insulation may comprise at least one of particles, beads, grains, and flakes such as ones comprising at least one of MgO, CaO, silicon dioxide, alumina, silicates such as mica, and alumina-silicates such as zeolites. The insulation may comprise sand. The insulation may be dried to remove water. The insulation may be held in a vessel 5e1 (FIGS. 2I102 and 2I103) that may be transparent to the radiation from the inductively coupled heater. The vessel may be configured to permit the heater coil 5f to move along the vertical axis. In an exemplary embodiment, the insulation comprising sand is contained in a fiberglass or ceramic vessel 5e1 wherein the heater coil can move vertically along the vessel inside of the coil 5f. The particulate insulation vessel 5e1 may comprise an inlet 5e2 and an outlet 5e3. The insulation may be drained or added back to change the insulation. The insulation may be drain out of the vessel by gravity. The removal may be such that the insulation is removed in order from the top of the reservoir to the bottom of the EM pump tube. The insulation may be removed in order from the closest to the farthest from the power producing hydrino reaction. The removed insulation may be stored in an insulation reservoir. The insulation may be recycled by returning it to the vessel. The insulation may be returned by at least one of mechanical and pneumatic means. The insulation may be mechanically moved by an auger or conveyor belt. The insulation may be pneumatically moved with a blower or suction pump. The insulation may be moved by other means known by those skilled in the art. In an embodiment, the particulate insulation such as sand may be replaced by a heat transfer medium such as copper shot that may be added from a storage container following generator startup to remove heat from at least one of the reservoirs and EM pump. The heat transfer may be to the water-cooled antenna of the inductively coupled heater.

The reaction may self sustain under favorable reaction conditions such as at least one of an elevated cell temperature and plasma temperature. The reaction conditions may support thermolysis at a sufficient rate to maintain the temperature and the hydrino reaction rate. In an embodiment wherein the hydrino reaction becomes self-sustaining, at least one startup power source may be terminated such as at least one of the heater power, the ignition power, and the molten metal pumping power. In an embodiment, the electromagnetic pump may be terminated when the cell temperature is sufficiently elevated to maintain a sufficiently high vapor pressure of the molten metal such that the metal pumping is not required to maintain the desired hydrino reaction rate. The elevated temperature may be above the boiling point of the molten metal. In an exemplary embodiment, the temperature of the walls of the reaction cell chamber comprising the blackbody radiator 5b4 is in the range of about 2900K to 3600K and the molten silver vapor pressure is in the range of about 5 to 50 atm wherein the reaction cell chamber 5b31 serves as a boiler that refluxes molten silver such the EM pump power may be eliminated. In an embodiment, the molten metal vapor pressure is sufficiently high such that the metal vapor serves as a conductive matrix to eliminate the need for the arc plasma and thereby the need for the ignition current. In an embodiment, the hydrino reaction provides the heat to maintain the cell components such as the reservoirs 5c, the lower hemisphere 5b41, and upper hemisphere 5b42 at a desired elevated temperature such that the heater power may be removed. The desired temperature may be above the melting point of the molten metal. In an embodiment, the cell startup may be achieved with at least one removable power source such as at least one of removable heater, ignition, and EM pump power sources. The cell may be operated in continuous operation once started. In an embodiment, the startup may be achieved with an energy storage device such as at least one of battery and capacitor such as supercapacitor devices. The devices may be charged by the electrical power output of the generator or by an independent power source. In an embodiment, the generator may be started up at the factory using independent startup power supplies and shipped in continuous operation absence the startup power supplies such as at least one of heater, ignition, and pumping power supplies.

In exemplary embodiments, the SunCell® comprises molten aluminum (M.P.=660° C., B.P.=2470° C.) or molten silver (M.P.=962° C., B.P.=2162° C.) in carbon reservoirs injected into a reaction cell chamber 5b31 comprising carbon lower 5b41 and carbon upper 5b42 hemispheres by dual EM pumps comprising at least one of stainless steel such as Hayes 230, Ti, Nb, W, V and Zr fasteners such as Swageloks 5k9 and at least one of stainless steel such as Haynes 230 or SS 316, Ti, Nb, W, V and Zr EM pump tube, carbon or iron heat transfer blocks 5k7, at least one of a stainless steel, Ti, Nb, W, V and Zr initial section of nozzle pump tube with a tack welded W end nozzle section 5k61 of the pump tube and a W nozzle. Each EM pump tube may further comprise an ignition source bus bar for connection to a terminal of the source of electrical power 2 comprising the same metal as the EM pump tube. In an embodiment, the ignition system may further comprise a circuit comprising a switch that when closed shorts the ignition source EM pump tube bus bars to heat the pump tube during startup. The switch in the open position during cell operation causes the current to flow through the crossed molten metal streams. Carbon heat transfer blocks may comprise heat transferring carbon powder to line the indentation for the EM pump tube. The reservoirs may be made longer to reduce the temperature at the EM pump components such as fasteners 5k9 and EM pump tube 5k6. The oxide source of HOH catalyst with added source of hydrogen such as argon-H₂ (3%) may comprise at least one of CO, CO₂, LiVO₃, Al₂O₃, and NaAlO₂. HOH may form in the ignition plasma. In an embodiment, cell components in contact with molten aluminum may comprise a ceramic such as SiC or carbon. The reservoir and EM pump tube and nozzle may comprise carbon. The component may comprise a metal such a stainless steel that is coated with a protective coating such as a ceramic. Exemplary ceramic coatings are those of the disclosure such as graphite, aluminosilicate refractories, AlN, Al₂O₃, Si₃N₄, and sialons. In an embodiment, the cell component in contact with molten aluminum may comprise at least one corrosion resistant material such as Nb-30Ti-20W alloy, Ti, Nb, W, V, Zr, and a ceramic such as graphite, aluminosilicate refractories, AlN, Al₂O₃, Si₃N₄, and SiAlON.

In an embodiment, the splitter comprises an EM pump that may be located at the region of the joining of the two reservoirs. The EM pump may comprise at least one of electromagnets and permanent magnets. The polarity of at least one of the current on the EM pump bus bars and the electromagnet current may be reversed periodically to direct the returning silver to one and then the other reservoir to avoid an electrical short between the reservoirs. In an embodiment, the ignition circuit comprises an electrical diode to force the current in one direction through the dual EM pump injector liquid electrodes.

In an embodiment, the cell components comprised of carbon are coated with a coating such as a carbon coating capable of maintaining about zero vapor pressure at the operating temperature of the cell component. An exemplary operating temperature of the blackbody radiator is 3000K. In an embodiment, the coating to suppress sublimation applied to the surface such as the outside surface of a carbon cell component such as the blackbody radiator 5b4 or reservoir 5c comprises pyrolytic graphite, a Pyrograph coating (Toyo Tanso), graphitized coating (Poco/Entegris), silicon carbide, TaC or another coating of the disclosure or known in the art that suppresses sublimation. The coating may be stabilized at high temperature by applying and maintaining a high gas pressure on the coating. In an embodiment, the EM pump tube 5k6, current bus bar 5k2, heat transfer blocks 5k7, nozzle 5q and fittings 5k9 may comprise at least one of Mo and W. In an embodiment, the Swagelok-type and VCR-type fittings 5k9 may comprise carbon wherein the reservoir may comprise carbon. Carbon fittings may comprise a liner such as a refractory metal mesh or foil such as W ones. In an embodiment, the electrodes penetrate the pressure vessel wall at feed throughs 10a and at least one of the lower hemisphere 5b41 of the blackbody radiator 5b4 and the reservoir 5c. The electrodes 8 may be locked in place with an electrode O-ring lock nut 8a1. The electrode bus bars 9 and 10 may be connected to the source of electrical power through bus bar current collectors 9a. The electrodes penetrations may be coated with an electrical insulator such as ZrO. Since C has low conductivity, the electrodes may be sealed directly at the penetration such as ones at the reservoir wall with a sealant such as graphite paste. Alternatively, the electrodes may be sealed at the penetrations with VCR or Swagelok feed throughs. The mechanical joining of parts with different thermal coefficients of expansion such as at least one of the VCR-type or Swage-like type fittings between the EM pump tube and the base of the reservoir 5c and the electrodes and the reservoir wall may comprise a compressible seal such as a carbon gasket or washer such as a Perma-Foil or Graphoil gasket or washer or a hexagonal boron nitride gasket. The gasket may comprise pressed MoS₂, WS₂, Celmet™ such as one comprising Co, Ni, or Ti such as porous Ni C6NC (Sumitomo Electric), cloth or tape such as one comprising ceramic fibers comprising high alumina and refractory oxides such as Cotronics Corporation Ultra Temp 391, or another material of the disclosure.

In an exemplary embodiment, the reaction cell chamber power is 400 kW, the operating temperature of the carbon blackbody radiator having a 6 inch diameter is 3000 K, the pumping rate of the EM pump is about 10 cc/s, the inductively coupled heater power to melt the silver is about 3 kW, the ignition power is about 3 kW, the EM pump power is about 500 W, the reaction cell gases comprise Ag vapor and argon/H₂(3%), the outer chamber gas comprises argon/H₂(3%), and the reaction cell and outer chamber pressures are each about 10 atm.

The outer pressure vessel may be pressurized to balance the pressure of the reaction cell chamber 5b31 wherein the latter pressure increases with temperature due to the vaporization of the matrix metal such as silver. The pressure vessel may be initially pressurized, or the pressure may be increased as the reaction cell chamber temperature increases. Hydrogen may be added to the pressure vessel to permeate into the reaction cell chamber. In an embodiment wherein the blackbody radiation is isotropic carbon, the dome is at least partially permeable to gases such as at least one of hydrogen and an inert gas such as argon to balance the pressure and supply hydrogen to the reaction. In an embodiment, the power may be controlled by controlling the hydrogen flow to the hydrino reaction in the reaction cell chamber 5b31. The hydrino reaction may be stopped by purging or evacuating the hydrogen. The purging may be achieved by flowing an inert gas such as argon gas.

The SunCell® may comprise a high-pressure water electrolyzer such as one comprising a proton exchange membrane (PEM) electrolyzer having water under high pressure to provide high-pressure hydrogen. Each of the H₂ and O₂ chambers may comprise a recombiner to eliminate contaminant O₂ and H₂, respectively. The PEM may serve as at least one of the separator and salt bridge of the anode and cathode compartments to allow for hydrogen to be produced at the cathode and oxygen at the anode as separate gases. The cathode may comprise a dichalcogenide hydrogen evolution catalyst such as one comprising at least one of niobium and tantalum that may further comprise sulfur. The cathode may comprise one known in the art such as Pt or Ni. The hydrogen may be produced at high pressure and may be supplied to the reaction cell chamber 5b31 directly or by permeation such as permeation through the blackbody radiator. The SunCell® may comprise a hydrogen gas line from the cathode compartment to the point of delivery of the hydrogen gas to the cell. The SunCell® may comprise an oxygen gas line from the anode compartment to the point of delivery of the oxygen gas to a storage vessel or a vent. In an embodiment, the SunCell® comprises sensors, a processor, and an electrolysis current controller. The sensors may sense at least one of (i) the hydrogen pressure in at least one chamber such as the electrolysis cathode compartment, the hydrogen lines, the outer chamber 5b3a1, and the reaction cell chamber 5b31, (ii) the power output of the SunCell®, and (iii) the electrolysis current. In an embodiment, the hydrogen supply into the cell is controlled by controlling the electrolysis current. The hydrogen supply may increase with increasing electrolysis current and vice versa. The hydrogen may be at least one of under high pressure and comprise a low inventory such that the hydrogen supply to the cell may be controlled with a quick temporal response by controlling the electrolysis current.

In another embodiment, the hydrogen may be produced by thermolysis using supplied water and the heat generated by the SunCell®. The thermolysis cycle may comprise one of the disclosure or one known in the art such as one that is based on a metal and its oxide such as at least one of SnO/Sn and ZnO/Zn. In an embodiment wherein the inductively coupled heater, EM pump, and ignition systems only consume power during startup, the hydrogen may be produced by thermolysis such that the parasitic electrical power requirement is very low. The SunCell® may comprise batteries such as lithium ion batteries to provide power to run systems such as the gas sensors and control systems such as those for the reaction plasma gases.

The pressure of the reaction chamber 5b31 may be measured by measuring the extension or displacement of at least one cell component due to the internal pressure. The extension or displacement due to internal pressure may be calibrated at a given reaction chamber 5b31 temperature by measuring at least one of these parameters as a function of the internal pressure caused by a non-condensable gas at the given reaction chamber temperature.

In an embodiment, the coating of a graphite cell component such as a surface of the blackbody radiator, the reservoir, and VCR-type fittings may comprise pyrolytic graphite, silicon carbide, or another coating of the disclosure or known in the art that is resistant to reaction with hydrogen. The coating may be stabilized at high temperature by applying and maintaining a high gas pressure on the coating.

In an embodiment, a negative (reducing) potential is applied to cell components such as at least one of the blackbody radiator 5b4, reservoir 5c, and pump tube that may undergo an oxidation reaction with at least one of H₂O and oxygen. The generator may comprise a voltage source, at least two electrical leads, a conductive matrix, a positive electrode, and counter electrode to apply the negative voltage to the cell component. In an embodiment, at least one of the blackbody radiator 5b4, one reservoir 5c, and one EM pump 5ka may be biased with a negative or reducing voltage. The negative electrode of the pair of electrodes 8 may comprise at least one component of the group of one EM pump 5ka, the blackbody radiator 5b4, and one reservoir 5c such that the component is biased with a negative or reducing voltage. The electrodes 8 may comprise molten metal injector electrodes. The conductive matrix may comprise at least one of plasma and metal vapor.

The positive molten electrode may comprise a first EM pump 5ka and a first reservoir 5c that is electrically isolated from at least one of the blackbody radiator 5b4, the other or second reservoir 5c, and the other or second EM pump 5ka. The first reservoir 5c may at least partially comprise an electrical insulator. At least one of the ignition power and positive bias to first EM pump 5ka may be supplied by the source of electrical power 2. The first injector nozzle 5q of the first positively biased EM pump 5ka may be submerged. The submersion may reduce or prevent at least one of plasma and water reaction damage to the nozzle.

At least one of the blackbody radiator 5b4, the second reservoir 5c, and the second EM pump 5ka may be biased with a negative or reducing voltage. At least one of the ignition power and negative bias to at least one of the blackbody radiator 5b4, the second reservoir 5c, and the second EM pump 5ka may be supplied by the source of electrical power 2. The second reservoir may comprise an electrical conductor such as graphite. Alternatively, the second reservoir may comprise an electrical insulator, and the cell further comprising an electrical short from the negative bias source such as ignition electromagnetic bus bar 5k2a to the blackbody radiator 5b4. The short may comprise an electrical conductor between conductive parts of the EM pump assembly 5kk and the blackbody radiator 5b4. An exemplary short comprises a graphite clamshell applied to a boron nitride tube wherein the clamshell contacts the EM pump assembly 5kk and the blackbody radiator 5b4. The clamshell may also assist with absorption of RF radiation from the inductively coupled heater. The blackbody radiator 5b4, the second reservoir 5c, and the second EM pump 5ka may be electrically connected at the negative bias.

The negative bias may be sufficient to prevent at least one of the blackbody radiator 5b4, the second reservoir 5c, and the second EM pump 5ka from reacting with at least one of H₂O and oxygen. At least one of the molten metal vapor such as silver vapor and ignition and hydrino-reaction supported plasma in the reaction cell chamber 5b31 may serve as the means to complete an electrolysis circuit between the positive electrode and the negatively biased cell component such as at least one of the blackbody radiator 5b4, the second reservoir 5c, and the second EM pump 5ka. At least one of H₂O, H₂, CO, and CO₂ may be permeated through at least one of the blackbody radiator 5b4 and at least one reservoir 5c. At least one of H₂O, H₂, CO, and CO₂ may be supplied by a passage to the reaction cell chamber 5b31 such as one comprising the EM pump tube 5k6. The H₂O may serve as a source of at least one of H and HOH catalyst. The hydrogen may at least one of serve as a source of H to form hydrinos and react with oxygen to form water wherein oxygen may be the product from the H₂O as source of H to form hydrinos. The carbon oxidation reaction may be further suppressed by maintaining an atmosphere of at least one of hydrogen, carbon dioxide, and carbon monoxide.

In an embodiment, the generator may comprise only the first reservoir 5c and first EM pump 5ka comprising a molten metal injector electrode. The counter electrode may comprise the blackbody radiator 5b4. The electrodes may be powered by the source of electricity 2. The molten metal injector electrode may be positive and the blackbody radiator electrode negative. The negatively biased blackbody radiator may be at least partially protected from reaction with at least one of H₂O and O₂. Gases such as at least one of CO, CO₂, H₂, and H₂O may be supplied by systems and methods of the disclosure. At least one of H₂O, H₂, CO, and CO₂ may be permeated through at least one of the blackbody radiator 5b4 and the reservoir 5c. At least one of H₂O, H₂, CO, and CO₂ may be supplied by a passage to the reaction cell chamber 5b31 such as one comprising the EM pump tube 5k6.

In an embodiment, the SunCell® comprises a molten metal additive that chemically prevents oxidation or chemically reduces at least one oxidized cell component such as at least one of the EM pump tube, blackbody radiator, the inlet riser, and the nozzle. The reductant/protectant may be added to the silver to prevent oxidation of the EM pump tube by at least one of H₂O and O₂. The additive may comprise a reductant known in the art such as thiosulfate, Sn, Fe, Cr, Ni, Cu, or Bi. The additive may reduce the reaction of a carbon reaction cell chamber with at least one of water, oxygen, carbon dioxide, and carbon monoxide. The additive may protect carbon from oxidation when the carbon component such as the reaction cell chamber 5b31 is biased positively. The additive may comprise at least one of carbon, a hydrocarbon, and hydrogen. In another embodiment, at least one of the molten metal and the additive may coat or wet the walls of the cell component to protect it from oxidation. At least one of the inside of the EM pump tube 5k6 and the reaction cell chamber 5b31 such as a carbon one may be protected. The supplied hydrino reactant such as H₂O may be supplied through the EM pump tube 5k6 in the case that the corresponding gas is not permeable to the cell component such as the blackbody radiator 5b4 or reaction cell chamber 5b31 such as a carbon one due to the coating or wetting.

The EM pump tube may also be protected by the application of a negative potential. The negative potential may be applied using the ignition power source 2. The potential may be reversibly applied to each of the two EM pump tubes of the dual molten metal injectors. The ignition power source 2 may comprise a switch that cyclically reverses the polarity at each of the ignition bus bars 5k2a. The SunCell® may comprise a blackbody radiator 5b4 such as a carbon blackbody radiator further comprising a bus bar to a negative terminal of a voltage source. The voltage source may comprise the ignition power supply 2. The negative bus bar may be connected to the top slip nut that connects the reservoir and the base of the blackbody radiator 5b4. The connector to hot carbon parts such as the top slip nut may comprise carbon to avoid metal carbide formation of a metal connector. Any metal carbon connection may be made through an extension that places the connection in a zone wherein the connection temperature is below one that would result in metal carbide formation. The negative potential may comprise a constant negative potential. The bus bars may comprise a refractory electrical conductor such as Mo or W. In an embodiment, the connection to provide the negative bias to the blackbody radiator may comprise a mechanical jumper to reversibly form an electrical connection directly or indirectly with ignition bus bar and the base of the blackbody radiator. The connection may comprise at least one reversible mechanical switch and a conductor encasing a portion of the reservoir 5c such as carbon clamshells on the outside of the reservoir such as on the outside of BN tubes. Chemical incompatibilities should be avoided. For example, contact of a part comprising iron with a part comprising iron should be avoided since iron and carbon may react to form iron carbide.

The oxidized additive may be regenerated following reduction of an oxidized cell component by electrolytic reduction or by chemical reduction. The electrolytic reduction may be provided by the negative potential applied to at least one cell component. The reaction cell chamber atmosphere 5b31 may comprise water vapor. The reaction cell chamber 5b31 may comprise an electrolytic cell cathode wherein the plasma completes the circuit between the cathode and the anode. The anode may comprise the positively biased molten metal electrode. Hydrogen that forms at the negative (cathode) discharge electrode of a cell such as at the reaction cell chamber 5b31 wall may protect the electrode (wall) from oxidation by the H₂O. The water reduction/oxidation reactions may be

Cathode: 2H₂O+2e⁻ to H₂+2OPH⁻ (41)

Anode: 4OH⁻ to O₂+2H₂O+4e⁻ (42)

In an embodiment, the inside of the EM pump tube 5k6 may be coated with a molten metal coating to protect it from corrosion by a species such as at least one of water, CO₂, CO, and O₂ in at least one of the reaction cell chamber 5b31, reservoir 5c, and EM pump tube 5k6. A silver-wetting coat may protect at least one component of the SunCell®. In an embodiment at least one metal surface such as that of the inside of the EM pump tube 5k6 may be treated to remove the oxide coat to permit the molten metal such as silver to wet the surface. The oxide coating may be removed to improve the conductivity across the bus bars through the molten metal such as silver. The oxide coating may be removed by at least one method such as one or more of mechanical and chemical removal. The oxide coat may be removed by using an abrasion tool such as a wire brush or by sand blasting. The oxide coating may be removed by an etchant such as an acid such as HCl or HNO₃ or a reductant such as hydrogen. The molten metals such as silver may from a coating to protect the interior of the reaction cell chamber 5b31, reservoir 5c, and EM pump tube 5k6. At least one of the electrodes may be submerged to protect it from corrosion or erosion by the plasma. In an embodiment, the walls of the reaction cell chamber may comprise at least one of silver coated carbon such as isotropic carbon, pyrolytic carbon, and silver coated pyrolytic carbon. The silver coating may form during cell operation or may be applied by coating methods such as plasma spray, electroplating, vapor deposition, cold spray, and other methods known by those skilled in the art.

The components of the cell may comprise at least one of a material and coating to prevent or reduce an oxidation reaction such as one with at least one of oxygen and water vapor. In an embodiment, the EM pump tube 5k4 may comprise boiler-rated stainless steel or nickel, or the tube may be internally coated with nickel. In an embodiment, a refractory EM pump tube 5k61 may comprise a water resistant material such as a Mo superalloy such as TZM. The nozzle or injection section of the EM pump tube 5k61 may comprise carbon such a pyrolytic carbon. The interior of the EM pump tube may be coated with silver to prevent reaction with water. In an embodiment, at least one of the inlet riser tube 5qa, the nozzle section of the EM pump tube 5k61, and the nozzle 5q may comprise a refractory material that is stable to oxidation such as a refractory oxide such as MgO (M.P. 2825° C.), ZrO₂ (M.P. 2715° C.), magnesia zirconia that is stable to H₂O, strontium zirconate (SrZrO₃ M.P. 2700° C.), HfO₂ (M.P. 2758° C.), thorium dioxide (M.P. 3300° C.), or another of the disclosure. The reaction cell chamber 5b31 may comprise carbon such as pyrolytic carbon that may be coated with protective silver. The reaction cell chamber 5b31 may be negatively biased to protect it from oxidation. The reservoir may comprise boron nitride that may comprise an additive or surface coating to protect it from oxidation such as at least one of CaO, B₂O₃, SiO₂, Al₂O₃, SiC, ZrO₂, and AlN wherein at least one of water and oxygen may comprise the oxidant. Boron nitride may comprise a crystalline structure such as a BN that is resistant to water reaction. The reaction mixture may comprise an additive such as HₓB_{y}O_{z} that may comprise a gas to suppress the oxidation of BN. In an embodiment, the cell component such as the reservoir 5c may comprise a refractory oxide such as MgO (M.P. 2825° C.), ZrO₂ (M.P. 2715° C.), magnesia zirconia that is stable to H₂O, strontium zirconate (SrZrO₃ M.P. 2700° C.), HfO₂ (M.P. 2758° C.), or thorium dioxide (M.P. 3300° C.) that is stable to oxidation at the operating temperature.

In an embodiment, the gaseous source of oxygen such as water vapor, CO₂, CO, and O₂ may be buoyed to the top of the reaction cell chamber 5b31. In addition to metal vapor such as silver vapor, the reaction cell chamber gas comprises a dense gas such as xenon that causes water vapor to be displaced to the top of the reaction cell chamber due to the higher buoyancy of water. In an embodiment, the silver vapor is maintained at a pressure that is sufficient to cause the water vapor to be buoyed to the top of the reaction cell chamber. The upward displacement of water vapor may prevent it from causing corrosion with cell components such as the EM pump tube 5b6. At least one reactant gas such as H₂O and H₂ may be supplied through the EM pump tube.

The chemical reduction may be provided by a reducing gas such as hydrogen. An exemplary reducing atmosphere comprises Ar/H₂(3%) gas. The hydrogen may permeate through at least one cell component such as at least one of the blackbody radiator 5b4 and the EM pump tube 5k6. The EM pump tube may comprise a hydrogen permeable metal such as stainless steel (SS) such as 430 SS, vanadium, tantalum, or niobium, or nickel. Hydrogen may be permeated or injected into the positive EM pump tube. In this case, the oxidation reaction that produces oxygen may be avoided wherein the oxidation may comprise:

Anode: 2OH⁻+H₂ to 2H₂O+2e⁻ (43)

In an embodiment, the SunCell® further comprises a positive electrode, a bias source of electricity to apply a potential between the positive electrode and at least one cell component, and a controller of the bias source of electricity. The positive electrode may comprise a molten metal electrode. The positive electrode may comprise at least a potion of the molten metal such as silver such as that in at least one of the reservoir 5c or lower hemisphere of the blackbody radiator 5b41. The positive electrode may comprise a conductor that is stable to oxidation such as noble metal that may also be a refractory metal such as Pt, Re, Ru, Rh, or Ir. The positive bias may be applied external to the EM pump tube such that the interior of the tube is not positively biased. The inside of the pump tube may comprise a Faraday cage. The EM pump tube may comprise the positive electrode that is at least one of submerged and coated with silver that flows over the surface. The flowing silver may be form pores in at least one of the nozzle and the EM pump tube. The pores may be selectively on the EM pump tube section that is exposed to plasma.

At least one cell component such as at least one of the blackbody radiator 54b, the reservoirs 5c, and the EM pump 5ka may be protected from oxidation by a cell reactant or product such as at least one of a source of oxygen, CO, CO₂, H₂O, and O₂ by the application of a negative bias between the cell component and the positive electrode. The bias potential may be one at least that which causes at least one of reduction of an oxide of a cell component and prevents oxidation of a cell component. The bias voltage may be in at least one range of about 0.1 V to 25 V, 0.5 V to 10 V, and 0.5 V to 5 V. The positive electrode may be at least one of consumable and replaceable. The positive electrode may comprise carbon. The carbon positive electrode may be attached to the positive EM pump tube and nozzle 5q wherein the positive electrode may be closer to the reaction cell chamber than the tip of the nozzle. The positive electrode may be in electrical contact with the positive EM pump tube and nozzle. The source of at least one of hydrogen and oxygen may comprise H₂O. The hydrino reaction product may comprise H₂(1/p) such as H₂(1/4) and oxygen. The positive electrode may react with oxygen product. The carbon electrode may react with excess oxygen and form CO₂. The CO₂ may be removed from the reaction cell chamber 5b31. The CO₂ may be removed by at least one of pumping and diffusion through at least one cell component such as the blackbody radiator 5b4.

In an embodiment shown in FIGS. 2I80-2I173, at least one of inert gas, water or steam, hydrogen, and oxygen may be supplied to the reaction cell chamber 5b31 by at least one of injection into the pump tube 5k6 such as at the nozzle 5q end and injection into the reaction cell chamber 5b31. The generator may comprise at least one inert gas, water or steam, hydrogen, and oxygen sources such as tanks and delivery lines. Valves such as flow or pressure valves such as solenoid valves may control the injection. In an embodiment, the SunCell® may comprise a water injector comprising at least one of a nozzle, a water line, a flow and pressure controller, a water source such as a tank of water, and a means to vaporize the water to form gaseous H₂O. The means to vaporize the water to form gaseous H₂O may comprise a steam generator. The water flow into the interior of the cell may prevent molten metal back flow into the nozzle. The size of the nozzle opening or orifice may be such that the minimum desired flow rate to maintain the hydrino reaction may be provided by a water pressure in the line that is at least that of the reaction cell chamber 5b31 pressure. Increasing the water pressure in the line may provide a higher water supply rate. At least one of the nozzle and nozzle orifice may comprise a material that is resistant to corrosion and erosion due to the high-pressure water injection. The material such as a ceramic such as an oxide ceramic such as Al₂O₃, zirconia, or hafnia may be very hard and resistant to oxidation.

In an embodiment, the source of HOH catalyst and source of H comprises water that is injected into the electrodes. A high current is applied to cause ignition into a brilliant light emitting plasma. A source of water may comprise bound water. A solid fuel that is injected into the electrodes may comprise water and a highly conductive matrix such as a molten metal such as at least one of silver, copper, and silver-copper alloy. The solid fuel may comprise a compound that comprises the bound water. The bound-water compound that may be supplied to the ignition may comprise a hydrate such as BaI₂ 2H₂O having a decomposition temperature of 740° C. The compound that may comprise bound water may be miscible with the molten metal such as silver. The miscible compound may comprise flux such as at least one of hydrated Na₂CO₃, KCl, carbon, borax such as Na₂B4O₇.10H₂O, calcium oxide, and PbS. The bound water compound may be stable to water loss up to the melting point of the molten metals. For example, the bound water may be stable to over 1000° C., and loses the water at the in the ignition event. The compound comprising bound water may comprise oxygen. In the case that the oxygen is released, the molten metal may comprise silver since silver does not form a stable oxide at its melting point. The compound comprising bound water may comprise hydroxide such as at least one of an alkali, alkaline earth, transition metal, inner transition metal, rare earth, Group 13, Group 14, Group 15, and Group 16 hydroxide, and a mineral such as talc, a mineral composed of hydrated magnesium silicate with the chemical formula H₂Mg₃(SiO₃)₄ or Mg₃Si₄O₁₀(OH)₂, and muscovite or mica, a phyllosilicate mineral of aluminum and potassium with formula KAl₂(AlSi₃O₁₀)(F,OH)₂, or (KF)₂(Al₂O3)₃(SiO₂)6(H₂O). In an embodiment, the dehydrated compound serves as a desiccant to maintain a low reaction cell chamber pressure. For example, barium hydroxide decomposes to barium oxide and H₂O when heated to 800° C. and the boiling point of the resulting BaO is 2000° C. such that it remains substantially vaporized for a plasma temperature above 2300 K. In an embodiment, the source of water comprises an oxide and hydrogen that may also serve as the source of H. The source of hydrogen may comprise hydrogen gas. The oxide may be capable of being reduced by hydrogen to form H₂O. The oxide may comprise at least one of Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, and Zn. At least one of the source of H₂O compound, the concentration of the source of H₂O compound, the water vapor pressure in the reaction cell chamber, the operating temperature, and the EM pumping rate may be controlled to control the amount of water supplied to the ignition. The concentration of the source of H₂O compound may be in at least one range of about 0.001 mole % to 50 mole %, 0.01 mole % to 20 mole %, and 0.1 mole % to 10 mole %. In an embodiment, water is dissolved into the fuel melt such as one comprising at least one of silver, copper, and silver-copper alloy. The solubility of water is increased with the partial pressure of water in contact with the melt such as the water vapor partial pressure of the reaction cell chamber. The water pressure in the reaction cell chamber may be equilibrated with the water vapor pressure in the cell chamber. The equilibration may be achieved by means of the disclosure such as those for other gases such as argon. The reaction cell chamber water vapor pressure may be in at least one range of about 0.01 Torr to 100 atm, 0.1 Torr to 10 atm, and 0.5 Torr to 1 atm. The EM pumping rate may be in at least one range of about 0.01 ml/s to 10,000 ml/s, 0.1 ml/s to 1000 ml/s, and 0.1 ml/s to 100 ml/s.

The SunCell® may comprise at least one of radiant heat exchanger and a radiant boiler (FIGS. 2I153-2I160). The SunCell® may comprise a radiant energy absorber such as a primary heat exchanger 87 surrounding the blackbody radiator 5b4. The radiant energy absorber may comprise a blackbody absorber such as a carbon absorber and may further comprise boiler tubes to receive the heat from the blackbody absorber wherein steam may form in the tubes and exit through hot water or steam outlet 111. The tubes may be embedded in the blackbody absorber. The steam may be delivered to a load such as a municipal steam heating system. The SunCell® may comprise a secondary heat exchanger 87a that may transfer heat absorbed from the blackbody radiator 5b4 or reaction cell chamber 5b31 by a primary heat exchanger 87 and transfer the heat to a secondary medium such as a solid, liquid, or gaseous medium. In an embodiment, the secondary heat exchanger may transfer heat to air that may be blown through or over the heat exchanger 87a by fans 31j1. The air may exit a hot air duct 112 to flow to a thermal load.

In a thermal generator embodiment shown in FIGS. 2I156-2I160, cold collant such as cold water is supplied to the thermal generator through water inlet 113, and at least one of hot water and steam are output through at least one of steam and hot water outlet 111. The heat generated in the reaction cell chamber 5b31 may be radiated to the boiler tubes of the upper heater exchanger 114 to create steam in boiler chamber 116. The steam boiler further comprises a high-pressure capable upper heat exchanger and boiler chamber housing 5b3a and base plate 5b3b. Heat from the reservoirs 5c and lower cell components may radiate to the lower heat exchanger 115 to form at least one of hot water and steam that exits the outlet 111. In an embodiment, the boiler tubes may carry hot water rather than steam.

The SunCell® power may be harnessed as thermal power in the form of direct radiation, hot air, hot water, and steam. In another embodiment, the boiler or heat exchanger may comprise a liquid droplet radiator comprising particle absorbers such as aerosol or metal vapor entrained in a gas stream or fluid stream wherein the particles absorb the heat flux and transfer it to the moving gas or fluid coolant. The droplet cooling system may comprise a droplet spray and collection system such as one comprising an ink jet printer. The heat transfer from the blackbody radiator to the particle absorbers may be predominantly radiative in nature. An exemplary embodiment comprising refractory particles and a gas have a high heat transfer capability comprises tungsten micro-particles suspended in a hydrogen or helium gas flow.

In another embodiment, the boiler or heat exchanger may comprise a heat transfer medium such as a solid, liquid, or gas medium to transfer heat from at least one of the reaction cell chamber 5b31 or blackbody radiator 5b4 to the coolant of the boiler or heat exchanger. The heat transfer mechanism may comprise at least one of radiation, convection, and conduction. An exemplary liquid heat transfer medium comprises at least one of water, a molten metal, and a molten salt. An exemplary gas heat transfer medium may comprise at least one of an inert gas, hydrogen, helium, a noble gas, and nitrogen. The boiler or heat exchanger may comprise a gas heat transfer medium and a means to regulate its pressure such as a supply such as a tank, a regulator, a pressure gauge, a pump, and a controller to achieve a desired constant or desired variable pressure to control the heat transfer rate.

The SunCell® may comprise a heat exchanger 87 such as fins on the outer surface 5b4 of the reaction cell chamber 5b31 to heat the flowing working medium such as coolant such as molten salt such as a eutectic mixture, molten metal, water, or gas such as air. The heat exchanger may also comprise a heat absorber and heat transfer fins on the heat absorber wherein the heat absorber may absorb heat from the blackbody radiator 5b4. The fins may exchange heat with gas or liquid coolant/working medium. The absorber may comprise a high emissivity material such as carbon. The Brayton cycle system may comprise a closed, pressurized gas loop and turbine, and an ambient heat exchanger wherein the gas is heated by the SunCell®, flows at the highest pressure into the gas turbine, and may be dropped in pressure at the back-end of the turbine by heat loss to the ambient through the heat exchanger. The chemical system may comprise a means such as a thermolysis system to convert water to H₂ using heat from the hydrino reaction. The hydrogen may be used in a known converter such as a combustion turbine or fuel cell such as a PEM fuel cell to produce electricity. Alternatively, the electrochemical cycle may comprise a fuel cell having a hydride ion electrolyte, a hydrogen cathode, and a metal hydride anode. Metal hydride may be thermally decomposed to maintain reversible metal hydride/metal plus hydrogen cycle that uses heat from the hydrino process to make electricity. The hydride ion fuel cell was described in my Prior Application such as US Patent Applications such as Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, and PCT/IB2014/058177 filed PCT Jan. 10, 2014 which are incorporated by reference in their entirety.

In an embodiment, a plurality of generators may be ganged to provide a desired power output. A plurality of generators may be interconnected in at least one of series and parallel to achieve the desired power output. The system of ganged generators may comprise a controller to control at least one of series and parallel connections between the generators to control at least one of the power, voltage, and current of the superimposed output electricity of the plurality of ganged generators. A plurality of generators may each comprise a power controller to control the power output. The power controller may control the hydrino reaction parameters to control the generator power output. Each generator may comprise switches between at least one of PV cells or groups of PV cells of the PV converter 26a and further comprise a controller to control at least one of series and parallel connections between PV cells or groups of PV cells. The controller may switch the interconnections to achieve at least one of a desired voltage, current, and electrical power output from the PV converter. The central controller of the ganged plurality of generators may control at least one of the series and parallel interconnections between ganged generators, hydrino reaction parameters of at least on generator, and connections between PV cells or groups of PV cells of at least one PV converter of at least one generators of the plurality of ganged generators. The central controller may control at least one of the generator and PV connections and hydrino reaction parameters directly or through the individual generator controllers. The power output may comprise DC or AC power. Each generator may comprise a DC to AC inverter such as an inverter. Alternatively, the DC power of a plurality of generators may be combined through the connections between generators and converted to AC power using a DC to AC converter such as an inverter capable of converting the superimposed DC power. Exemplary output voltages of at least one of the PV converter and ganged generator systems is about 380V DC or 780V DC. The about 380V output may be converted into two phase AC. The about 760V output may be converted into three phase AC. The AC power may be converted to another desirable voltage such as about 120 V, 240 V, or 480 V. The AC voltage may be transformed using a transformer. In an embodiment, DC voltage may be changed to another DC voltage using an IGBT. In an embodiment, at least one IGBT of the inverter may also be used as the IGBT of the inductively coupled heater 5m.

In an embodiment, the converter comprises a plurality of converters that are ganged to comprise combined cycles. The combined cycle converters may be selected from the group of a photovoltaic converter, a photoelectronic converter, a plasmadynamic converter, a thermionic converter, a thermoelectric converter, a Sterling engine, a Brayton cycle engine, a Rankine cycle engine, and a heat engine, and a heater. In an embodiment, the SF-CIHT cell produces predominantly ultraviolet and extreme ultraviolet light. The converter may comprise a combined cycle comprising a photoelectron converter then a photoelectric converter wherein the photoelectric converter is transparent to ultraviolet light and may be primarily responsive to extreme ultraviolet light. The converter may further comprise additional combined cycle converter elements such as at least one of a thermoelectric converter, a Sterling engine, a Brayton cycle engine, a Rankine cycle engine, and a magnetohydrodynamic converter.

Magnetohydrodynamic (MHD) Converter

Charge separation based on the formation of a mass flow of ions or an electrically conductive medium in a crossed magnetic field is well known art as magnetohydrodynamic (MHD) power conversion. The positive and negative ions undergo Lorentzian direction in opposite directions and are received at corresponding MHD electrode to affect a voltage between them. The typical MHD method to form a mass flow of ions is to expand a high-pressure gas seeded with ions through a nozzle to create high-speed flow through the crossed magnetic field with a set of MHD electrodes crossed with respect to the deflecting field to receive the deflected ions. In an embodiment, the pressure is typically greater than atmospheric, and the directional mass flow may be achieved by hydrino reaction to form plasma and highly conductive, high-pressure-and-temperature molten metal vapor that is expanded to create high-velocity flow through a cross magnetic field section of the MHD converter. The flow may be through an MHD converter may be axial or radial. Further directional flow may be achieved with confining magnets such as those of Helmholtz coils or a magnetic bottle.

Specifically, the MHD electric power system shown in FIGS. 2I161-2I195 may comprise a hydrino reaction plasma source of the disclosure such as one comprising an EM pump 5ka, at least one reservoir 5c, at least two electrodes such as ones comprising dual molten metal injectors 5k61, a source of hydrino reactants such as a source of HOH catalyst and H, an ignition system comprising a source of electrical power 2 to apply voltage and current to the electrodes to form a plasma from the hydrino reactants, and a MHD electric power converter. The components of the MHD power system comprising a hydrino reaction plasma source and a MHD converter may be comprised of at least one of oxidation resistant materials such as oxidation resistant metals, metals comprising oxidation resistant coatings, and ceramics such that the system may be operated in air. In a dual molten metal injector embodiment, a high electric field is achieved by maintaining a pulsed injection comprising intermittent current. The plasma is pulsed by the silver streams disconnecting and reconnecting. The voltage may be that applied until the dual molten metal streams connect. The pulsing may comprise a high frequency by causing a corresponding high frequency of disconnect-reconnect of the metal steams. The connection-reconnection may occur spontaneously and may be controlled by controlling at least one of the hydrino reaction power by means such as those of the disclosure and the rate of molten metal injection by means of the disclosure such as by controlling the EM pump current. In an embodiment, the ignition system may comprise a source of voltage and current such as a DC power supply and a bank of capacitor to deliver pulsed ignition with the capacity for high current pulses.

The magnetohydrodynamic power converter shown in FIGS. 2I161-2I195 may comprise a source of magnetic flux transverse to the z-axis, the direction of axial molten metal vapor and plasma flow through the MHD converter 300. The conductive flow may have a preferential velocity along the z-axis due to the expansion of the gas along the z-axis. Further directional flow may be achieved with confining magnets such as those of Helmholtz coils or a magnetic bottle. Thus, the metal electrons and ions propagate into the region of the transverse magnetic flux. The Lorentzian force on the propagating electrons and ions is given by

F=ev×B (44)

The force is transverse to the charge's velocity and the magnetic field and in opposite directions for positive and negative ions. Thus, a transverse current forms. The source of transverse magnetic field may comprise components that provide transverse magnetic fields of different strengths as a function of position along the z-axis in order to optimize the crossed deflection (Eq. (44)) of the flowing charges having parallel velocity dispersion.

The reservoir 5c molten metal may be in at least one state of liquid and gaseous. The reservoir 5c molten metal may defined as the MHD working medium and may be referred to as such or referred to as the molten metal wherein it is implicit that the molten metal may further be in at least one state of liquid and gaseous. A specific state such as molten metal, liquid metal, metal vapor, or gaseous metal may also be used wherein another physical state may be present as well. An exemplary molten metal is silver that may be in at least one of liquid and gaseous states. The MHD working medium may further comprise an additive comprising at least one of an added metal that may be in at least one of a liquid and a gaseous state at the operating temperature range, a compound such as one of the disclosure that may be in at least one of a liquid and a gaseous state at the operating temperature range, and a gas such as at least one of a noble gas such as helium or argon, water, H₂, and other plasma gas of the disclosure. The MHD working medium additive may be in any desired ratio with the MHD working medium. In an embodiment, the ratios of the medium and additive medium are selected to give the optional electrical conversion performance of the MHD converter. The working medium such as silver or silver-copper alloy may be run under supersaturated conditions.

In an embodiment, the MHD electrical generator 300 may comprise at least one of a Faraday, channel Hall, and disc Hall type. In a channel Hall MHD embodiment, the expansion or generator channel 308 may be oriented vertically along the z-axis wherein the molten metal plasma such as silver vapor and plasma flow through an accelerator section such as a restriction or nozzle throat 307 followed by an expansion section 308. The channel may comprise solenoidal magnets 306 such as superconducting or permanent magnets such as a Halbach array transverse to the flow direction along the x-axis. The magnets may be secured by MHD magnet mounting bracket 306a. The magnet may comprise a liquid cryogen or may comprise a cryo-refrigerator with or without a liquid cryogen. The cryo-refrigerator may comprise a dry dilution refrigerator. The magnets may comprise a return path for the magnetic field such as a yoke such as a C-shaped or rectangular back yoke. An exemplary permanent magnet material is SmCo, and an exemplary yoke material is magnetic CRS, cold rolled steel, or iron. The generator may comprise at least one set of electrodes such as segmented electrodes 304 along the y-axis, transverse to the magnetic field (B) to receive the transversely Lorentzian deflected ions that creates a voltage across the MHD electrodes 304. In another embodiment, at least one channel such as the generator channel 308 may comprise geometry other than one with planar walls such as a cylindrically walled channel. Magnetohydrodynamic generation is described by Walsh [E. M. Walsh, Energy Conversion Electromechanical, Direct, Nuclear, Ronald Press Company, NY, N.Y., (1967), pp. 221-248] the complete disclosure of which is incorporated herein by reference.

The MHD magnets 306 may comprise at least one of permanent and electromagnets. The electromagnet(s) 306 may be at least one of uncooled, water cooled, and superconducting magnets with a corresponding cryogenic management. Exemplary magnets are solenoidal or saddle coils that may magnetize a MHD channel 308 and racetrack coils that may magnetize a disc channel. The superconducting magnet may comprise at least one of a cryo-refrigerator and a cryogen-dewar system. The superconducting magnet system 306 may comprise (i) superconducting coils that may comprise superconductor wire windings of NbTi or NbSn wherein the superconductor may be clad on a normal conductor such as copper wire to protect against transient local quenches of the superconductor state induced by means such as vibrations, or a high temperature superconductor (HTS) such as YBa₂Cu₃O₇, commonly referred to as YBCO-123 or simply YBCO, (ii) a liquid helium dewar providing liquid helium on both sides of the coils, (iii) liquid nitrogen dewars with liquid nitrogen on the inner and outer radii of the solenoidal magnet wherein both the liquid helium and liquid nitrogen dewars may comprise radiation baffles and radiation shields that may be comprise at least one of copper, stailess steel, and aluminum and high vacuum insulation at the walls, and (iv) an inlet for each magnet that may have attached a cyropump and compressor that may be powered by the power output of the SunCell® generator through its output power terminals.

In one embodiment, the magnetohydrodynamic power converter is a segmented Faraday generator. In another embodiment, the transverse current formed by the Lorentzian deflection of the ion flow undergoes further Lorentzian deflection in the direction parallel to the input flow of ions (z-axis) to produce a Hall voltage between at least a first MHD electrode and a second MHD electrode relatively displaced along the z-axis. Such a device is known in the art as a Hall generator embodiment of a magnetohydrodynamic power converter. A similar device with MHD electrodes angled with respect to the z-axis in the xy-plane comprises another embodiment of the present invention and is called a diagonal generator with a “window frame” construction. In each case, the voltage may drive a current through an electrical load. Embodiments of a segmented Faraday generator, Hall generator, and diagonal generator are given in Petrick [J. F. Louis, V. I. Kovbasyuk, Open-cycle Magnetohydrodynamic Electrical Power Generation, M Petrick, and B. Ya Shumyatsky, Editors, Argonne National Laboratory, Argonne, Ill., (1978), pp. 157-163] the complete disclosure of which is incorporated by reference.

In a further embodiment of the magnetohydrodynamic power converter, the flow of ions along the z-axis with v_{∥}>>v_{⊥} may then enter a compression section comprising an increasing axial magnetic field gradient wherein the component of electron motion parallel to the direction of the z-axis v_{∥} is at least partially converted into to perpendicular motion v_{⊥} due to the adiabatic invariant

$$\frac{{v}_{⊥}^{2}}{B} = constant .$$

An azimuthal current due to v_{⊥} is formed around the z-axis. The current is deflected radially in the plane of motion by the axial magnetic field to produce a Hall voltage between an inner ring and an outer ring MHD electrode of a disk generator magnetohydrodynamic power converter. The voltage may drive a current through an electrical load. The plasma power may also be converted to electricity using a \vec{E}×\vec{B} direct converter or other plasma to electricity devices of the disclosure or known in the art.

The MHD generator may comprise a condenser channel section 309 that receives the expansion flow and the generator further comprises return flow channels or conduits 310 wherein the MHD working medium such as silver vapor cools as it loses at least one of temperature, pressure, and energy in the condenser section and flows back to the reservoirs through the channels or conduits 310. The generator may comprise at least one return pump 312 and return pump tube 313 to pump the return flow to the reservoirs 5c and EM pump injectors 5ka. The return pump and pump tube may pump at least one of liquid, vapor, and gas. The return pump 312 and return pump tube 313 may comprise an electromagnetic (EM) pump and EM pump tube. The inlet to the EM pump may have a greater diameter than the outlet pump tube diameter to increase the pump outlet pressure. In an embodiment, the return pump may comprise the injector of the EM pump-injector electrode 5ka. In a dual molten metal injector embodiment, the generator comprises return reservoirs 311 each with a corresponding return pump such as a return EM pump 312. The return reservoir 311 may at least one of balance the return molten metal such as molten silver flow and condense or separate silver vapor mixed in with the liquid silver. The reservoir 311 may comprise a heat exchanger to condense the silver vapor. The reservoir 311 may comprise a first stage electromagnetic pump to preferentially pump liquid silver to separate liquid from gaseous silver. In an embodiment, the liquid metal may be selectively injected into the return EM pump 312 by centrifugal force. The return conduit or return reservoir may comprise a centrifuge section. The centrifuge reservoir may be tapered from inlet to outlet such that the centrifugal force is greater at the top than at the bottom to force the molten metal to the bottom and separate it from gas such as metal vapor and any working medium gas. Alternatively, the SunCell® may be mounted on a centrifuge table that rotates about the axis perpendicular to the flow direction of the return molten metal to produce centrifugal force to separate liquid and gaseous species.

In an embodiment, the condensed metal vapor flows into the two independent return reservoirs 311, and each return EM pumps 312, pumps the molten metal into the corresponding reservoir 5c. In an embodiment, at least one of the two return reservoirs 311 and EM pump reservoirs 5c comprises a level control system such as one of the disclosure such as an inlet riser 5qa. In an embodiment, the return molten metal may be sucked into a return reservoir 311 due at a higher or lower rate depending on the level in the return reservoir wherein the sucking rate is controlled by the corresponding level control system such as the inlet riser.

In an embodiment, the MHD converter 300 may further comprise at least one heater such as an inductively coupled heater. The heater may preheat the components that are in contact with the MHD working medium such as at least one of the reaction cell chamber 5b31, MHD nozzle section 307, MHD generator section 308, MHD condensation section 309, return conduits 310, return reservoirs 311, return EM pumps 312, and return EM pump tube 313. The heater may comprise at least one actuator to engage and retract the heater. The heater may comprise at least one of a plurality of coils and coil sections. The coils may comprise one known in the art. The coil sections may comprise at least one split coil such as one of the disclosure. In an embodiment, the MHD converter may comprise at least one cooling system such as heat exchanger 316. The MHD converter may comprise coolers for at least one cell and MHD component such as at least one of the group of chamber 5b31, MHD nozzle section 307, MHD magnets 306, MHD electrodes 304, MHD generator section 308, MHD condensation section 309, return conduits 310, return reservoirs 311, return EM pumps 312, and return EM pump tube 313. The cooler may remove heat lost from the MHD flow channel such as heat lost from at least one of the chamber 5b31, MHD nozzle section 307, MHD generator section 308, and MHD condensation section 309. The cooler may remove heat from the MHD working medium return system such as at least one of the return conduits 310, return reservoirs 311, return EM pumps 312, and return EM pump tube 313. The cooler may comprise a radiative heat exchanger that may reject the heat to ambient atmosphere.

In an embodiment, the cooler may comprise a recirculator or recuperator that transfers energy from the condensation section 309 to at least one of the reservoirs 5c, the reaction cell chamber 5b31, the nozzle 307, and the MHD channel 308. The transferred energy such as heat may comprise that from at least one of the remaining thermal energy, pressure energy, and heat of vaporization of the working medium such as one comprising at least one of a vaporized metal, a kinetic aerosol, and a gas such as a noble gas. Heat pipes are passive two-phase devices capable of transferring large heat fluxes such as up to 20 MW/m² over a distances of meters with a few tenths of degree temperature drop; thus, reducing dramatically the thermal stresses on material, using only a small quantity of working fluid. Sodium and lithium heat pipes can transfer large heat flues and remain nearly isothermal along the axial direction. The lithium heat pipe can transfer up to 200 MW/m². In an embodiment, a heat pipe such as molten metal one such as liquid alkali metal such as sodium or lithium encased in a refractory metal such as W may transfer the heat from the condenser 309 and recirculate it to the reaction cell chamber 5b31 or nozzle 307. In an embodiment, at least one heat pipe recovers the silver heat of vaporization and recirculates it such that the recovered heat power is part of the power input to the MHD channel 308.

In an embodiment, at least one of component of the SunCell® such as one comprising a MHD converter may comprise a heat pipe to at least one of transfer heat from one part of the SunCell® power generator to another and transfer heat from a heater such as an inductively coupled heater to a SunCell® component such as the EM pump tube 5k6, the reservoirs 5c, the reaction cell chamber 5b31, and the MHD molten metal return system such as the MHD return conduit 310, MHD return reservoir 311, MHD return EM pump 312, and MHD return EM tube. Alternatively, the SunCell® or at least one component may be heated within an oven such as one known in the art. In an embodiment, at least one SunCell® component may be heated for at least startup of operation. The heater may be a resistive heater or an inductively coupled heater. In an embodiment, the heat of the hydrino reaction may heat at one SunCell® component. In an exemplary embodiment, a heater such as an inductively coupled heater heats the EM pump tube 5k6, the reservoirs 5c, and at least the bottom portion of the reaction cell chamber 5b31. At least one other component may be heated by the heat release of the hydrino reaction such as at least one of the top of the reaction cell chamber 5b31, the MHD nozzle 307, MHD channel 308, MHD condensation section 309, and MHD molten metal return system such as the MHD return conduit 310, MHD return reservoir 311, MHD return EM pump 312, and MHD return EM tube. In an embodiment, the MHD molten metal return system such as the MHD return conduit 310, MHD return reservoir 311, MHD return EM pump 312, and MHD return EM tube may be heated with elevated temperature molten metal or metal vapor such as molten silver or vapor having a temperature in at least one range of about 1000° C. to 7000° C., 1100° C. to 6000° C., 1100° C. to 5000° C., 1100° C. to 4000° C., 1100° C. to 3000° C., 1100° C. to 2300° C., 1100° C. to 2000° C., 1100° C. to 1800° C., and 1100° C. to 1500° C. The elevated temperature molten metal or metal vapor may be caused to flow through the MHD component with bypass or disablement of the MHD conversion into electricity. The disablement may be achieved by removing the electric field or by electrically shorting the electrodes.

In an embodiment, at least one component of the cell and MHD converter may be insulated to prevent heat loss. At least one of the group of chamber 5b31, MHD nozzle section 307, MHD generator section 308, MHD condensation section 309, return conduits 310, return reservoirs 311, return EM pumps 312, and return EM pump tube 313 may be insulated. Heat lost from the insulation may be dissipated in the corresponding cooler or heat exchanger. In an embodiment, the working fluid such as silver may serve as a coolant. The EM pump injection rate may be increased to provide silver to absorb heat to cool at least one cell or MHD component such as the MHD nozzle 307. The vaporization of silver may cool the nozzle MHD 307. A recirculator or recuperator may comprise the working medium used for cooling. In an exemplary embodiment, silver is pumped over the component to be cooled and is injected into the reaction cell chamber and MHD converter to recover the heat while providing the cooling.

At least the high-pressure components such as the reservoirs 5c, reaction cell chamber 5b31, and high-pressure portions of the MHD converter 307 and 308 may be maintained in the pressure chamber 5b3a1 comprising housing 5b3a and 5b3b. The pressure chamber 5b3a1 may be maintained at a pressure to at least counter balance at least a portion of the high internal reaction chamber 5b31 and MHD nozzle 307 and MHD generator channel 308. The pressure balance may reduce the strain on the joints of the generator components such as those between the reservoirs 5c and the EM pump assembly 5kk. The high-pressure vessel 5b3a may selective house the high-pressure components such as at least one of the reaction cell chamber 5b31, the reservoirs 5c, and the MHD expansion channel 308. The other cell components may be housed in a lower-pressure vessel or housing.

A source of hydrino reactant such as at least one of H₂O, H₂, CO₂, and CO may be permeated thorugh a permeable cell components such as at least one of the cell chamber 5b31, the reservoirs 5c, the MHD expansion channel 308, and the MHD condensation section 309. The hydrino reaction gases may be introduced into the molten metal stream in at least one location such as through the EM pump tube 5k6, the MHD expansion channel 308, the MHD condensation section 309, the MHD return conduit 310, the return reservoir 311, the MHD return pump 312, the MHD return EM pump tube 313. The gas injector such as a mass flow controller may be capable of injecting at high pressure on the high-pressure side of the MHD converter such as through at least one of the EM pump tube 5k6, the MHD return pump 312, and the MHD return EM pump tube 313. The gas injector may be capable of injection of the hydrino reactants at lower pressure on the low-pressure side of the MHD converter such as at least one location such as through the MHD condensation section 309, the MHD return conduit 310, and the return reservoir 311. an embodiment at least one of water and water vapor may be injected through the EM pump tube 5k4 by a flow controller that may further comprise a pressure arrestor and a back-flow check valve to present the molten metal from flowing back into the water supplier such as the mass flow controller. Water may be injected through a selectively permeable membrane such as a ceramic or carbon membrane. In an embodiment, the converter may comprise a PV converter wherein the hydrino reactant injector is capable of supplying reactants by at least one of means such as by permeation or injection at the operating pressure of the site of delivery. In another embodiment, the SunCell® may further comprise a source of hydrogen gas and a source of oxygen gas wherein the two gases are combined to provide water vapor in the reaction cell chamber 5b31. The source of hydrogen and the source of oxygen may each comprise at least one of a corresponding tank, a line to flow the gas into reaction cell chamber 5b31 directly or indirectly, a flow regulator, a flow controller, a computer, a flow sensor, and at least one valve. In the latter case, the gas may be flowed into a chamber in gas continuity with the reaction cell chamber 5b31 such as at least one of the EM pump 5ka, the reservoir 5c, the nozzle 307, the MHD channel 308, and other MHD converter components such as any return lines 310a, conduits 313a, and pumps 312a. In an embodiment, at least one of the H₂ and O₂ may be injected into the injection section the EM pump tube 5k61. O₂ and H₂ may be injected through separate EM pump tubes of the dual EM pump injectors. Alternatively, a gas such as at least one of oxygen and hydrogen may be added to the cell interior through an injector in a region with lower silver vapor pressure such as the MHD channel 308 or MHD condensation section 309. At least one of hydrogen and oxygen may be injected through a selective membrane such as a ceramic membrane such as a nano-porous ceramic membrane. The oxygen may be supplied through an oxygen permeable membrane such as one of the disclosure such as BaCo_{0.7}Fe_{0.2}Nb_{0.1}O_{3-δ} (BCFN) oxygen permeable membrane that may be coated with Bi₂₆Mo₁₀O₆₉ to increase the oxygen permeation rate. The hydrogen may be supplied through a hydrogen permeable membrane such as a palladium-silver alloy membrane. The SunCell® may comprise an electrolyzer such as a high-pressure electrolyzer. The electrolyzer may comprise a proton exchange membrane where pure hydrogen may be supplied by the cathode compartment. Pure oxygen may be supplied by the anode compartment. In an embodiment, the EM pump parts are coated with a non-oxidizing coating or oxidation protective coating, and hydrogen and oxygen are injected separately under controlled conditions using two mass flow controllers wherein the flows may be controlled based on the cell concentrations sensed by corresponding gas sensors.

In an embodiment, at least one component of the SunCell® and MHD converter comprising an interior compartment such as the reservoirs 5c, the reaction cell chamber 5b31, the nozzle 307, the MHD channel 308, the MHD condensation section 309, and other MHD converter components such as any return lines 310a, conduits 313a, and pumps 312a are housed in a gas-sealed housing or chamber wherein the gases in the chamber equilibrate with the interior cell gas by diffusion across a membrane permeable to gases and impermeable to silver vapor. The gas selective membrane may comprise a semipermeable ceramic such as one of the disclosure. The cell gases may comprise at least one of hydrogen, oxygen, and a noble gas such as argon or helium. The outer housing may comprise a pressure sensor for each gas. The SunCell® may comprise a source and controller for each gas. The source of noble gas such as argon may comprise a tank. The source for at least one of hydrogen and oxygen may comprise an electrolyzer such as a high-pressure electrolyzer. The gas controller may comprise at least one of a flow controller, a gas regulator, and a computer. The gas pressure in the housing may be controlled to control the gas pressure of each gas in the interior of the cell such as in the reservoirs, reaction cell chamber, and MHD converter components. The pressure of each gas may be in the range of about 0.1 Torr to 20 atm. In an exemplary embodiment shown in FIGS. 2I179-2I195, the straight MHD channel 308 and MHD condensation section 309 comprises a gas housing 309b, a pressure gauge 309c, and gas supply and evacuation assembly 309e comprising a gas inlet line, a gas outlet line, and a flange wherein the gas permeable membrane 309d may be mounted in the wall of the MHD condensation section 309. The mount may comprise a sintered joint, a metalized ceramic joint, a brazed joint, or others of the disclosure. The gas housing 309b may further comprise an access port. The gas housing 309b may comprise a metal such as an oxidation resistant metal such as SS 625 or an oxidation resistant coating on a metal such as an iridium coating on a metal of suitable CTE such as molybdenum. Alternatively, the gas housing 309b may comprise ceramic such as a metal oxide ceramic such as zirconia, alumina, magnesia, hafnia, quartz, or another of the disclosure. Ceramic penetrations through a metal gas housing 309b such as those of the MHD return conduits 310 may be cooled. The penetration may comprise a carbon seal wherein the seal temperature is below the carbonization temperature of the metal and the carbo-reduction temperature of the ceramic. The seal may be removed for the hot molten metal to cool it. The seal may comprise cooling such as passive or forced air or water-cooling.

In exemplary embodiments, the inductively coupled heater antenna 5f may comprise one coil, three separate coils as shown in FIGS. 2I178-2I179, three continuous coils as shown in FIGS. 2I182-2I183, two seperated coils, or two continuous coils as shown in FIGS. 2I180-2I181. An exemplary inductively coupled heater antenna 5f comprises an upper elliptical coil and a lower EM pump tube pancake coil that may comprise a spiral coil that may comprise concentric boxes with a continuous circumferential current direction (FIGS. 2I180-2I181). The reaction cell chamber 5b31 and MHD nozzle 307 may comprise planar, polygonal, rectangular, cylindrical, spherical, or other desired geometry as shown in FIGS. 2I162-2I195. The inductively coupled heater antenna 5f may comprise a continuous set of three turnings comprising two helices circumferential to each reservoirs 5c and a pancake coil parallel to the EM pump tubes as shown in FIGS. 2I182-2I183. The turns of the opposing helices about the reservoirs may be wound such that the currents are in the same direction to reinforce the magnetic fields of the two coils or opposite directions to cancel in the space between the helices. The inductively coupled heater antenna 5f may further serve to cool at least one component such as at least one of the EM pump 5kk, the reservoirs 5c, the walls of the reaction cell chamber 5b31, and the yoke of an induction ignition system. At least one cooled component may comprise a ceramic such as one of the disclosure such as silicon nitride, quartz, alumina, zirconia, magnesia, or hafnia.

The SunCell® may comprise one MHD working medium return conduit from the end of the MHD expansion channel to the reservoir 5c wherein the reservoir 5c may comprise a sealed top cover that isolates lower pressure in the reservoir from the higher reaction cell chamber 5b31 pressure. The EM pump injector section 5k61 and nozzle 5q may penetrate the cover to inject molten metal such as silver in the reaction cell chamber 5b31. The penetration may comprise a seal of the disclosure such as a compression seal, slip nut, gasket braze, or stuffing box seal. The reservoir may comprise an inlet riser tube 5qa to control the molten metal level in the reservoir 5c. The covered reservoir and EM pump assembly 5kk that receives return molten metal flow may comprise a first injector of a dual molten metal injector system. The second injector comprising a second reservoir and EM pump assembly may comprise an open reservoir that receives return flow indirectly from the first injector. The second injector may comprise the positive electrode. The second injector may be maintained submerged below the molten metal level in the reservoir. The corresponding inlet riser tube 5qa may control the submersion.

The SunCell® may comprise at least one gaseous metal return conduit 310 from the end of the MHD generator channel 308 to at least one reservoir 5c of a molten metal injector system. The SunCell® may comprise two return conduits 310 from the end of the MHD generator channel 308 to the two corresponding reservoirs 5c of a dual molten metal injector system. Each reservoir 5c may comprise a sealed top cover that isolates lower pressure in the reservoir 5c from the higher reaction cell chamber 5b31 pressure. The EM pump injector section 5ka and 5k61 and nozzle 5q may penetrate the reservoir top cover to inject molten metal such as silver in the reaction cell chamber 5b31. The penetration may comprise a seal of the disclosure such as a compression seal, slip nut, gasket, braze, or stuffing box seal. Each reservoir 5c may comprise an inlet riser tube 5qa to control the molten metal level in the reservoir 5c. The temperature of the reaction cell chamber 5b31 may be above the boiling point of the molten metal such that the liquid metal that is injected into reaction cell chamber is vaporized and is returned through return conduits 310.

The SunCell® may comprise at least one MHD working medium return conduit 310 from the end of the MHD condenser channel 309 to at least one reservoir 5c of a molten metal injector system. The SunCell® may comprise two MHD working medium return conduits 310 from the end of the MHD condenser channel 309 to the two corresponding reservoirs 5c of a dual molten metal injector system. Each reservoir 5c may comprise a sealed top cover that isolates lower pressure in the reservoir 5c from the higher reaction cell chamber 5b31 pressure. The EM pump injector section 5ka and 5k61 and nozzle 5q may penetrate the reservoir top cover to inject molten metal such as silver in the reaction cell chamber 5b31. The penetration may comprise a seal of the disclosure such as a compression seal, slip nut, gasket, braze, or stuffing box seal. Each reservoir 5c may comprise an inlet riser tube 5qa to control the molten metal level in the reservoir 5c. The temperature of the reaction cell chamber 5b31 may be above the boiling point of the molten metal such that the liquid metal that is injected into reaction cell chamber is vaporized, the vapor is accelerated through the MHD nozzle section 307, the kinetic energy of the vapor is converted to electricity in the generator channel 308, the vapor is condensed in the MHD condenser section 309, and the molten metal is returned through return conduits 310.

The SunCell® may comprise at least one MHD working medium return conduit 310, one return reservoir 311, and corresponding pump 312. The pump 312 may comprise an electromagnetic (EM) pump. The SunCell® may comprise dual molten metal conduits 310; return reservoirs 311, and corresponding EM pumps 312. A corresponding inlet riser tube 5qa may control the molten metal level in each return reservoir 311. The return EM pumps 312 may pump the MHD working medium from the end of the MHD condenser channel 309 to return reservoirs 311 and then to the corresponding injector reservoirs 5c. In another embodiment, molten metal return flow is through the return conduit 310 directly to the corresponding return EM pumps 312 and then to the corresponding injector reservoirs 5c. In an embodiment, the MHD working medium such as silver is pumped against a pressure gradient such as about 10 atm to complete a molten metal flow circuit comprising injection, ignition, expansion, and return flow. To achieve the high pressure, the EM pump may comprise a series of stages. The SunCell® may comprise a dual molten metal injector system comprising a pair of reservoirs 5c, each comprising an EM pump injector 5ka and 5k61 and an inlet riser tube 5qa to control the molten metal level in the corresponding reservoir 5c. The return flow may enter the base 5kk1 of the corresponding EM pump assembly 5kk.

In an embodiment, the velocity of the working medium in at least one position comprising the at position in an MHD component such as the entrance of the nozzle, the nozzle, exit of the nozzle, and a desired portion of the MHD channel may be sufficiently high such that condensation such as shock condensation does not occur even in the case that metal vapor saturation conditions are met. The condensation may not occur due to the short transit time compared to the condensation time. The condensation kinetics may be altered or selected by controlling the plasma pressure, plasma temperature, jet velocity, working medium composition, and magnetic field strength. The metal vapor such as silver vapor may condense on the condenser 309 that may have high surface area, and the collected liquid silver may be returned through the return conduit and EM pumping system. In an embodiment, a short transit time in the nozzle that avoids shock condensation is exploited to allow the production of favorable MHD conversion conditions in the MHD channel 307 that otherwise would result in shock condensation.

In an embodiment, the MHD expansion or generator channel also know as the MHD channel comprises a flared MHD channel to continuously derive power conversion with the heat gradient converted to a pressure gradient that drives kinetic energy flow. Heat from silver condensation may contribute to the pressure gradient or mass flow in the MHD channel. The heat of vaporization released by the condensing silver may serve the function of an afterburner in a jet engine to create higher velocity flow. In an exemplary embodiment, the silver heat of vaporization serves the function of combustion in a jet afterburner to increase or contribute to the velocity of the silver jet stream. In an embodiment, the heat of vaporization released by condensation of the silver vapor increases the pressure above the pressure in the absence of the condensation. The MHD channel may comprise geometry such as a flare or nozzle geometry to convert the pressure into directed flow or kinetic energy that is converted into electricity by the MHD converter. The magnetic field provided by the MHD magnets 306 may be adjusted to prevent plasma stall in the case that the silver vapor condenses with a corresponding change in conductivity. In an embodiment, the walls of the MHD channel 308 are maintained at an elevated temperature to prevent metal vapor condensation on the walls with the corresponding mass and kinetic energy loss. The high electrode temperature may also protect from plasma arcing that may occur in the opposite case of cooled electrodes having a less electrically conductive or more insulating boundary layer relative to hotter plasma.

The MHD channel 308 may be maintained at a desired elevated temperature by transferring heat from the reaction cell chamber 5b31 to the walls of the MHD channel. The MHD converter may comprise a heat exchanger to transfer the heat from the reaction cell chamber to the walls of the MHD channel. The heat exchanger may comprises a conductive or convective heat exchanger such as one comprising heat transfer blocks that conducts heat from the reaction cell chamber to the walls of the MHD channel. The heat exchanger may comprise a radiative heat exchanger wherein the outer wall of at least a portion of reaction cell chamber comprises a blackbody radiator to emit power and at least a portion of the wall of the MHD channel may comprise a blackbody radiator to absorb the blackbody radiation. The heat exchanger may comprise a coolant that may be pumped. The pump may comprise an EM pump wherein the coolant is a molten metal. In another embodiment, the hydrino reaction is further propagated and maintained in the MHD channel 308 to maintain the MHD channel wall temperature above the condensation temperature of the metal vapor flowing in the channel. The hydrino reaction may be maintained by supplying reactants such as H and HOH catalyst or sources thereof. The reaction may be selectively maintained at the electrodes due to their conductivity that supports and accelerates the hydrino reaction rate. The MHD converter may comprise at least one temperature sensor to record the MHD channel wall temperature and a controller to control at least one of the heat transfer means such as a heat exchanger and the hydrino reaction rate to maintain the desired MHD channel wall temperature. The hydrino reaction rate may be controlled by means of the disclosure such as means to control the flow of hydrino reactants to the MHD channel.

In another embodiment, at least one of the plasma, metal vapor, and condensed metal vapor is confined to the channel and prevented from collecting on the MHD walls by a channel confinement means such as one comprising a source of at least one of electric and magnetic fields. The confinement means may comprise a magnetic confinement means such as a magnetic bottle. The confinement means may comprise an inductively couple field such as an RF field. The MHD converter may comprise at least one of an RF power source, at least one antenna, electrostatic electrodes and power source, and at least one magnetostatic magnetic field source to achieve the confinement.

In an embodiment, the working medium comprises a vaporized metal in the MHD channel 308 wherein the pressure and temperature of working medium is increased by the heat released by condensation of the metal vapor along the MHD channel as it looses kinetic energy due to MHD conversion to electricity. The energy from the condensation of the silver may increase at least one of the pressure, temperature, velocity, and kinetic energy of the working medium in the MHD channel. The flow velocity may be increased by a channel geometry that exploits the Venturi effect or Bernoulli principle. In an embodiment, flowing liquid silver may serve as an aspirator medium for the vapor to cause it to flow in the MHD channel.

In an embodiment, at least one of the MHD channel 308 diameter and volume are reduced as a function of the distance along the flow axis or z-axis of the MHD channel from the nozzle 307 exit to the MHD channel 308 exit. The MHD channel 308 may comprise a channel that converges alone the z-axis. In another embodiment, the channel size along the z-axis remains the same or diverges less than that of a conventional seeded-gas MHD working medium converter. The channel volume may be reduced to maintain pressure and velocity along the z-axis as the silver condenses and releases heat to maintain energetic plasma. The heat of vaporization released from condensing silver vapor (254 kJ/mole) with plasma flow along the z-axis may increase the temperature and pressure of the working medium to cause increased flow of the non-condensed silver at any given position along the z-axis of the channel. The increase in flow velocity may be caused by the Venturi effect or Bernoulli principle. The magnetic flux may be varied permanently or dynamically along the flow axis (z-axis) of the MHD channel to extract MHD power as a function of z-axial position to maintain a desired pressure, temperature, velocity, power, and energy inventory along the channel wherein the channel size as a function of distance along the z-axis may be matched to z-axial magnetic flux variation to at least partially achieve the extraction of the energy of the heat of vaporization from the vaporized metal as electricity. The plasma gas flow may also serve as a carrier gas for the condensed silver vapor.

The condensed silver may comprise a mist or fog. The fog state may be favored due to the tendency of silver to form an aerosol at a temperature well below its boiling point at a given pressure. The working medium may comprise oxygen and silver wherein molten silver has a tendency to form an aerosol in the presence of oxygen at a temperature well below its boiling point at a given pressure wherein silver may absorb large amounts of oxygen. The working medium may comprise an aerosolizing gas such as nitrogen, oxygen, water vapor, or a noble gas such as argon in addition to metal vapor such as silver vapor to form an aerosol of condensed silver. In an embodiment, the pressure of the aerosolizing gas throughout the reaction cell chamber and MHD channel may be maintained at its steady state distribution under operating conditions. The MHD converter may further comprise a supply of the aerosolizing gas such as a tank of the aerosolizing gas, a pump, and at least one gauge to selectively measure the aerosolizing gas pressure at one or more locations. The aerosolizing gas inventory may be maintained at a desired level by addition or removal of aerosolizing gas using the pump and aerosolizing gas supply. In an exemplary embodiment, liquid silver forms a fog or aerosol at a temperature just above the melting point such that a constant ambient pressure aerosolizing gas such as argon in the MHD channel 308 causes the silver vapor to liquid transition to occur in the form of an aerosol that may be carried with the plasma flow and aggregated on the MHD condenser 309. In an embodiment, the velocity of the condensing vapor is conserved in the condensate. The velocity of the condensate may increase from the release of the heat of vaporization. The MHD channel may comprise a geometry that converts the heat of vaporization into condensate kinetic energy. In an embodiment, the channel may narrow to convert the heat of vaporization into condensate kinetic energy. In another embodiment, the heat of vaporization may increase the channel pressure, and the pressure may be converted to kinetic energy by a nozzle. In an embodiment, copper or silver-copper alloy may replace silver. In an embodiment, the molten metal that serves as the source of metal aerosol comprises at least one of silver, copper, and silver-copper alloy. The aerosol may form in the presence of a gas such as at least one of oxygen, water vapor, and a noble gas such as argon.

In an embodiment, the SunCell® comprises a means to maintain a flow of cell gas in contact with molten silver to form molten metal aerosol such as silver aerosol. The gas flow may comprise at least one of forced gas flow and convection gas flow. In an embodiment, at least one of the reaction cell chamber 5b31 and the reservoirs 5c may comprise at least one baffle to cause a circulation of the cell gas to increase the gas flow. The flow may be driven by at least one of convection and pressure gradients such as those caused by at least one of thermal gradients and pressure from the plasma reaction. The gas may comprise at least one of a noble gas, oxygen, water vapor, H₂, and O₂. The means to maintain the gas flow may comprise at least one of a gas pump or compressor such as MHD gas pump or compressor 312a, the MHD converter, and the turbulent flow caused by at least one of the EM pump molten metal injectors and the hydrino plasma reaction. At least one of the gas flow rate and composition of the gas may be controlled to control that aerosol production rate. In an embodiment wherein water vapor is recirculated, the SunCell® further comprises a recombiner to recombine any H₂O thermalized into H₂ and O₂ back into H₂O, a condenser to condense the water vapor to liquid water, and a liquid water pump to inject pressurized water into a line that supplies at least one interior cell component such as the reservoir 5c or reaction cell chamber 5b31 wherein the pressurized water may transition into steam in route to injection inside of the cell. The recombiner may be one known in the art such as one comprising at least one of Raney nickel, Pd, and Pt. The water vapor may be recirculated in a loop comprising high-pressure compartments such as between the reaction cell chamber 5b31 and the reservoirs 5c.

In an embodiment, at least one of the reservoirs 5c and the reaction cell chamber 5b31 comprises a source of gas having a temperature sufficiently low to at least one of condense silver vapor to silver aerosol and cool silver aerosol. The heat released by the energetic hydrino reaction may form the silver vapor. The vaporization may occur in the hydrino reaction plasma. The ambient gas in contact with the hydrino reaction comprises the cell gas. A portion of at least one of the cell gas and aerosol may be cooled by a heat exchanger and chiller in a region inside of at least one of the reservoirs and reaction cell chamber containing at least one of gas, aerosol, and plasma. At least one of the cell gas and aerosol may be sufficiently cooled to at least one of condense silver vapor to aerosol and cool aerosol. At least one of the vapor condensation rate and the temperature and pressure of the cool cell gas-aerosol-vapor mixture may be controlled by controlling at least one of heat transfer during cooling and the temperature and pressure of the cool cell gas and aerosol.

In an embodiment to avoid mass loss along the channel, the silver vapor is caused to from fog as the vapor is condenses. The molar fraction that loses its kinetic energy to electricity along the channel may be caused to form fog wherein the corresponding heat of vaporization imparts kinetic energy to the corresponding aerosol particles to maintain the constant initial velocity of the otherwise lost mass. The channel may be straight to converging to maintain the velocity with reduced particle number due to partial atomic aggregation into aerosol particles flowing with remaining gas atoms. In an embodiment, the MHD channel 308 walls may be maintained at a temperature such as greater than the melting point of silver to avoid condensed liquid condensation by supporting fog formation.

In an embodiment, the MHD channel components and surfaces that the silver plasma jet contacts may comprise materials that resist wetting by the silver liquid. At least one of the MHD channel walls 308 and MHD electrodes 304 may comprise surfaces that resist wetting.

The aerosol particles may be charged and collected. The collection may occur at the end of the MHD channel. The aerosol particles may be removed by electrostatic precipitation or electrospray precipitation. In an embodiment, the MHD converter may comprise an aerosol particle charging means such as at least one particle charging electrode, an electrical power supply such as a source of high voltage, and a charged particle collector such as at least one electrode that is electrically biased to collect the charged particles. The charged particles may be collected at the end of the MHD channel by an applied electric field.

In an embodiment, metal vapor droplets are carried out by the plasma flow. The droplets may form a thin film on the surface of at least one of the MHD electrodes and MHD channel walls. Excess condensed liquid may be mechanically ablated and carried with the plasma and mass flow. In an embodiment, a Faraday current passes through condensed metal vapor such as condensed silver vapor and a Hall current is produced that forces the condensed silver particles along the trajectory of the plasma jet from the MHD nozzle 307. The Hall current may cause condensed silver to flow out of the MHD channel to be returned to the reservoirs 5c. The current may preferentially flow though the condensed silver due to the higher conductivity than the metal vapor. In another embodiment, the transport may be assisted by at least one of a divergence and convergence of the MHD channel. In an embodiment, the MHD converter such as a disc generator may comprise electrodes that contact the plasma at the entrance and exit of the MHD channel such that the effect of molten metal shorting in the channel is ameliorated.

In an embodiment, the working medium comprises a metal such silver that may sublime at a temperature below its boiling point to prevent the metal from condensing on the walls of the MHD channel such that it flows to the recirculation system. In an embodiment, the pressure at the exit of the MHD channel is maintained at a low pressure such as one below atmospheric pressure. A vacuum may be maintained at the exit of the MHD channel such that the working medium metal vapor does not condense in the MHD channel 308. The vacuum may be maintained by a MHD gas pump or compressor 312a (FIGS. 2I67-2I73).

In an embodiment, the MHD channel may comprise a generator in the entrance section and a compressor in the exit section. The compressor may cause condensed vapor to be pumped out of the MHD channel. The MHD converter may comprise a source of current and a current controller to controllably apply current to the working medium of the MHD channel in a perpendicular direction to the applied magnetic field to cause the condensed working medium vapor to flow from the channel wherein the channel conditions may be controlled to cause vapor condensation to achieve the release of the heat of vaporization of the vapor.

In another embodiment, the heat of vaporization of the metal vapor such as silver metal vapor may be recovered by condensing the vapor at a heat exchanger such as MHD condenser 309. The condensation may occur at a temperature that is higher than the boiling point of the metal such as silver. The heat may be transferred to a portion of the reservoir 5c by a means known in the art such as by convection, conduction, radiation, or by a coolant. The heat transfer system may comprise refractory heat transfer blocks such as Mo, W, or carbon bocks that transfer the heat by conduction. The heat may cause the silver in the reservoir to vaporize. The heat may be conserved in the heat of vaporization. The hydrino reaction may further increase the pressure and temperature of the vaporized metal. In an embodiment comprising a working medium additive such as a noble gas such as argon or helium, the MHD converter further comprises a gas pump or compressor 312a (FIGS. 2I67-2I73) to recirculate the gas from the low-pressure to the high-pressure part of the MHD converter. The gas pump or compressor 312a may comprise a drive motor 312b and blades or vanes 312c. The MHD converter may comprise a pump inlet that may comprise a gas passage 310a from the MHD condensation section 309 to the pump inlet and a pump outlet that may comprise a gas passage 313a from the pump or compressor 312a to the reaction cell chamber 5b31. The pump may pump gas from a low pressure such as about 1 to 2 atm to high pressure such as about 4 to 15 atm. The inlet conduit 310a from the MHD condensation section 309 to the pump 312a may comprise a filter such as a selective membrane or metal condenser at the inlet to separate the gas such as a noble gas from the metal vapor such as silver vapor. Baffles 309a in the MHD condenser section 309 may direct the molten metal such as that condensed in the MHD condensation section 309 into the MHD return conduit 310. At least one of the height of the baffles in the center and the molten metal return inlet to the MHD return conduit 310 may be at a position wherein the upward gas pressure exceeds the force of gravity on condensed or liquid molten metal particles to facilitate their flow into the MHD return conduit 310.

The SunCell® may comprise a metal vapor condenser such as a constant pressure condenser that may be located in the MHD condensation section 309 and may comprise a heat exchanger 316. The working medium may comprise metal vapor seeded carrier or working gas such as silver vapor seeded noble gas such as helium or argon. The condenser may condense the metal vapor so that liquid metal and noble gas may be separately pumped. The separation may be by at least one of method of the group of gravity sedimentation, centrifugal separation, cyclone separation, filtration, electrostatic precipitation, and other methods known to those skilled in the art. In an exemplary embodiment, the separated noble gas is removed from the top of the condenser, and the separated liquid metal is removed from the bottom of the condenser. The liquid and gas may be separated by at least one of baffles 309a, filters, a selectively permeable membrane, and a liquid barrier that is passable for the gas.

A compressor 312a may pump or cause the gas to recirculate to the reaction cell chamber 5b31. An EM pump 312 may pump the liquid silver to return it to the reservoir 5c to be re-injected into the reaction cell chamber 5b31. The compressor 312a and EM pump 312 re-pressurizes the working medium gas such as argon or helium and liquid metal such as liquid silver, respectively. The working medium gas may be returned to reaction cell chamber through a conduit 313a that may connect at least one of the EM pump tube 5k6, the reservoir 5c, the base 5kk1 of the EM pump assemble 5kk, and the reaction cell chamber 5b31. Alternatively, the gas may be returned to the reaction cell chamber 5b31 through a conduit 313a connected to a delivery tube 313b such as one that provides a direct passage into the reservoir 5c or the reaction cell chamber 5b31. The gas may serve to inject the molten metal into the reaction cell chamber. The molten metal may become entrained in the gas injection to replace or supplement the EM pump molten metal injectors. The injected molten metal and vapor such as the liquid and gaseous silver vapor flow rates may be controlled by controlling the gas flow rate, gas pressure, gas temperature, reservoir temperature, reaction cell temperature, nozzle inlet pressure, MHD nozzle flow rate, MHD nozzle outlet pressure, and hydrino reaction rate.

The return conduit tube 313b for at least one of the working medium gas and molten metal such as one that runs through the molten metal of the reservoir 5c may comprise a refractory material such as at least one of Mo, W, rhenium, rhenium coated Mo or W, a ceramic such as a metal oxide such as ZrO₂, HfO₂, MgO, Al₂O₃, and another of the disclosure. The conduit may comprise a refractory material tube that is threaded into a collar or seat in the EM pump tube assembly base 5kk1. The height of the return conduit tube 313b may be one desired to deliver the gas while allowing desired performances of other components such as metal injection and level control by the injection section of the EM pump tube 5k61 and the inlet riser tube 5qa, respectively. The height may be about the reservoir molten metal level.

In an embodiment shown in FIGS. 2I71-2I73, the gas pump or compressor 312a may pump a mixture of gaseous working medium species such as at least two of noble gas, molten metal seed, and molten metal vapor such as silver vapor. In an embodiment, the gas pump or compressor 312a may pump both gaseous and liquid working medium such as at least one of noble gas, metal vapor and liquid molten metal such as liquid silver. The liquid and gas may be returned to reaction cell chamber through a conduit 313a that may connect at least one of the EM pump tube 5k6, the reservoir 5c, the base 5kk1 of the EM pump assemble 5kk, and the reaction cell chamber 5b31. Alternatively, the gas may be returned to the reaction cell chamber 5b31 through a conduit 313a connected to a delivery tube 313b such as one that provides a direct passage into the reservoir 5c or the reaction cell chamber 5b31.

In an embodiment, the gas and liquid may flow through the EM pump tube 5k6. The gas may serve to inject the molten metal into the reaction cell chamber. The molten metal may become entrained in the gas injection to at least one of augment and replace the EM pump to pump molten metal through the injector tubes 5k61 and nozzles 5q. The injection rate may be controlled by controlling at least one of the flow rate and pressure of the gas pump or compressor 312a and by other means of the disclosure. The molten metal levels of the reservoirs 5c may be controlled by a level sensor and controller of the disclosure that controls at least one of the pressure and flow rate of one gas pump or compressor 312a relative to the other of a pair.

In an embodiment comprising a gas pump or compressor that pumps all of the working medium such as silver-seeded noble gas and an embodiment comprising a gas pump or compressor that pumps noble gas alone, the compression may be operated isothermally. The MHD converter may comprise a heat exchange or cooler to at least one of cool the gaseous working medium before and during compression. The gas pump or compressor may comprise an intercooler. The gas pump or compressor may comprise a plurality of stages such as a multistage intercooler compressor. The cooling may increase the efficiency of compressing the gas to match the operating pressure of the reaction cell chamber 5b31.

After the pumping stage in the return cycle, the return gaseous working medium may be heated to increase its pressure. The heating may be achieved with a heat exchanger that receives heat from the MHD converter or the regenerator that may receive heat from the MHD condensation section 309 or other hot component such at least one of the group of the reaction cell chamber 5b31, MHD nozzle section 307, MHD generator section 308, and MHD condensation section 309. In an embodiment, the gas pump power may be reduced substantially, by using inlet and outlet valves for gas flow into the reaction cell chamber 5b31 and out the MHD nozzle, respectively, wherein low pressure gas is pumped into the reaction cell chamber and the pressure is increased to the desired pressure such as 10 atm by the plasma reaction power. The resulting pulsed MHD power may be conditioned to steady DC or AC power. The return MHD gas tube 313a may comprise a valve that opens to permit flow of gas of lower pressure than the peak reaction cell chamber operating pressure, and the MHD nozzle section 307 may comprise a valve that opens to allow high pressure gas to flow out the nozzle following the gas heating by the reaction cell chamber 5b31 plasma. The valves may facilitate low-pressure gas injection into the reaction cell chamber by the gas pump or compressor wherein the gas is heated to high pressure by the hydrino reaction plasma. The valves may be synchronized to permit the reaction chamber pressure build up by plasma heating. The valves may be 180° out of phase. The valves may comprise a rotating shutter type. The MHD nozzle may be cooled to permit operation of the MHD nozzle valve. The return gas conduit 313a valve may be at or near the base of the EM pump assembly 5kk1 to avoid silver condensation in the corresponding gas delivery tube 313b. The MHD converter may comprise a pulsed power system such as the one comprising inlet and outlet valves for the working medium gas of the reaction cell chamber 5b31. The pulsed MHD power may be leveled to a constant power output by power conditioning equipment such as equipment comprising power storage such as batteries or capacitors.

In an embodiment, the molten metal such as silver that is recirculated remains in a gaseous state wherein the temperatures of the MHD converter including any return lines 310a, conduits 313a, and pumps 312a are maintained at a temperature above the boiling temperature of the silver at the operating pressure or silver partial pressure in the MHD system.

The pump 312a may comprise a mechanical pump such as a gear pump such as a ceramic gear pump or another known in the art such one comprising an impeller. The pump 312a may operate at high temperature such as in the temperature range of about 962° C. to 2000° C. The pump may comprise a turbine type such as that used in a gas turbine or of the type used as a turbocharger of an internal combustion engine. The gas pump or compressor 312a may comprise at least one of a screw pump, an axial compressor, and a turbine compressor. The pump may comprise a positive displacement type. The gas pump or compressor may create a high gas velocity that would be converted to pressure in a fixed reaction cell chamber volume according to Bernoulli's law. The return gas conduit 313a may comprise valves such as backpressure arresting valves to force the flow from the compressor into the reaction cell chamber and then the MHD converter.

The mechanical parts that are prone to wear by the working medium such as the pump 312a vanes or turbine blades may be coated with molten metal such as molten silver to protect them from abrasion or wear. In an embodiment, at least one component of the gas and molten metal return system comprising a gas pump or compressor such as the components of the group of the MHD return conduit 310a, the return reservoir 311a, the MHD return gas pump or compressor 312a parts in contact with the return gas and molten metal such as the vanes, and the MHD pump tube 313a (FIGS. 2I67-2I73) comprise a coating that performs at least one function of thermal protection and prevention of wetting by the molten metal to facilitate the return metal flow to the reservoir 5c.

In an embodiment, during SunCell® startup the compressor 312a may recirculate the working medium such as helium or argon gas to preheat at least one of the reaction cell chamber 5b31 and an MHD component such as the MHD nozzle section 307, the MHD channel 308, the MHD condensation section 309, and at least one component of the EM return pump system comprising the MHD return conduit 310, the return reservoir 311, the MHD return EM pump 312, and MHD return EM pump tube 313. The working medium may be diverted to at least one component of the EM return pump system. The inductively coupled heater such as that corresponding to antenna 5f may heat the working medium that may be recirculated to cause preheating of at least one of the reaction cell chamber 5b31 and at least one MHD component.

In an exemplary embodiment, the MHD system comprises a working medium comprising silver-seeded or silver-copper-alloy-seeded argon or helium wherein most of the pressure may be due to argon or helium. The silver or silver-copper alloy mole fraction drops with increasing noble gas such as argon gas partial pressure that is controlled using an argon supply, sensing, and control system. The SunCell® may comprise cooling systems for the reaction cell chamber 5b31 and MHD components such as at least one of the MHD nozzle section 307, the MHD channel 308, and the MHD condensation section 309. At least one parameter such as the wall temperature of the reaction cell chamber 5b31 and MHD channel, and the reaction and gas mixture conditions may be controlled that determines the optimal silver or silver-copper alloy inventory or vapor pressure. In an embodiment, an optimal silver vapor pressure is one that optimizes the conductivity and energy inventory of the metal vapor to achieve optimal power conversion density and efficiency. In an embodiment, some metal vapor condenses in the MHD channel to release heat that is converter to additional kinetic energy and converted to electricity in the MHD channel. The pump or compressor 312a may comprise one such as a mechanical pump for both silver and argon, or the MHD converter may comprise two pump types, gas 312a and molten metal 312.

In an embodiment, the MHD converter may comprise a plurality of nozzles to create high velocity conducting streams of molten metal in a plurality of stages. The first nozzle may comprise nozzle 307 in connection with the reaction cell chamber 5b31. Another nozzle may be positioned at the condensation section 309 wherein heat released from condensing silver may create high pressure at the entrance of the nozzle. The MHD converter may comprise an MHD channel having crossed magnets and electrodes downstream of each nozzle to convert the high velocity conductive flow into electricity. In an embodiment, the MHD converter may comprise a plurality of reaction cell chambers 5b31 such as in a position immediately preceding the nozzle.

In an embodiment comprising no return reservoirs 311 wherein the end of the MHD channel 309 behaves like the lower hemisphere of the blackbody radiator 5b41 and the return EM pump 312 speeds are fast (not return rate limiting), then the silver will distribute back to the injection reservoirs 5c in the same manner as it does in the blackbody radiator design of the disclosure. The relative injection rates may then be controlled by the inlet riser tube 5qa of each reservoir 5c as in the case of the blackbody radiator design of the disclosure.

In an embodiment, the SunCell® comprises an EM pump at the position just downstream of the acceleration nozzle 307 to pump condensed molten metal back to at least one reservoir of a molten metal injector system such as the reservoirs 5c of an open dual molten metal injector system 5ka and 6k61.

In an embodiment, the SunCell® comprises other combinations and configurations of return conduits 310 and 310a, return reservoirs 311 and 311a, return EM pumps 312 and compressors 312a, open injector reservoirs 5c, closed injector reservoirs 5c, open EM pump injector sections 5k61 and nozzles 5q, and closed EM pump injector sections 5k61 and nozzles 5q that may be selected by one skilled in the art to achieve the desired flow circuit of the MHD working medium through the reaction cell chamber 5b31 and the MHD converter 300. In an embodiment, the molten metal level controller 5qa of any reservoir such as at least one of the return reservoir 311 and the injection reservoir 5c may comprise at least one of an inlet riser tube 5qa, another of the disclosure, and one known to those skilled in the art.

In an embodiment, the working medium may comprise a mixture of gaseous and liquid phases such as at least one liquid metal and at least one gas such as at least one of a metal vapor and a gas such as a noble gas. Exemplary working media comprise liquid silver and gaseous silver or liquid silver, gaseous silver, and at least one other gas such as a noble gas or another metal vapor.

In an embodiment, the MHD converter may comprise a liquid metal MHD (LMMHD) converter such as one known in the art. The LMMHD converter may comprise a heat exchanger to cause heat to flow form the reaction cell chamber 5b31 to the LMMHD converter. The MHD converter may comprise systems that exploit at least one of the Rankine, Brayton, Ericsson, and Allam cycles. In an embodiment, the working medium comprises a high density and retains a high density relative to a noble gas such that at least one of recuperation and recirculation pumping of the working fluid is achieved with at least one of less expansion of the working fluid and more heat retention. The working medium may comprise a molten metal and its vapor such as silver and silver vapor. The working medium may further comprise at least one of an additional metal in at least one of liquid and vapor state and a gas such as a noble gas, steam, nitrogen, Freon, nitrogen, and other known in the art of liquid metal MHD (LMMHD) converters. In an embodiment, the MHD converter may comprise at least one of an EM pump, a MHD compressor, and a mechanical compressor or pump to recirculate the working medium.

The MHD converter may further comprise a mixer to mix liquid with gas wherein at least one phase may be heated prior to mixing. Alternatively, the mixed phases may be heated. The hot working medium comprising the mixture of phases flows into the MHD channel to generate electricity due to the pressure created in the working medium due to the heating. In another embodiment, the liquid may comprise a plurality liquids such as one that serves as the conductive matrix such as silver and another that has a lower boiling point to serve as the gaseous working medium due to its vaporization in the reaction cell chamber. The vaporization of the metal may permit a thermodynamic MHD cycle. Electrical power is generated with two-phase conductive flow in the MHD channel. The working medium may be heated by a heat exchanger to produce the pressure to provide the flow in the channel. The reaction cell chamber may provide the heat to the inlet of the heat exchanger that flows to the heat exchanger outlet and then to the working medium.

In an embodiment, the hydrino plasma vapor is mixed with liquid silver in a mixer to form a two-phase working medium. The heating creates a high-pressure flow of predominantly molten silver through the MHD channel wherein the thermal-kinetic energy is converted to electricity and the cooler, lower-pressure working medium at the exit of the MHD channel is recirculated by the MHD EM pumps.

In an embodiment comprising a hybrid cycle that is an open gas cycle and a closed metal cycle, the working medium may comprise at least one of oxygen, nitrogen, and air that is seeded with metal vapor such as silver metal vapor. Liquid metal such as silver that is vaporized in the reaction cell chamber 5b31 to comprise gas seed may be condensed upon exit of the MHD channel 308 and recirculated to the reservoirs 5c. The gas such as air that exists the MHD channel may be separated from the seed and may be vented to atmosphere. The heat may be recuperated from the vented gas. Ambient gas such as air may be drawn in by the gas pumps or compressors 312a.

In an embodiment, the MHD converter may comprise a homogeneous MHD generator comprising a metal or metal mixture that is heated to cause metal vaporization at the inlet to the MHD channel. The converter may further comprise a channel inlet heat exchanger to transfer heat from the reaction cell chamber to the working medium to cause it to vaporization before the entrance to the MHD channel. The homogeneous MHD generator may further comprise a channel outlet heat exchanger at the exit of the MHD channel to serve as a regenerator to transfer heat to the working medium before it flow to the inlet heat exchanger. The inlet heat exchanger may comprise a working medium conduit through the reaction cell chamber. The metal working medium may be condensed at a condensation heat exchanger downstream of the outlet heat exchanger wherein the molten metal is then pumped by a recirculation EM pump.

In an embodiment, the working medium comprises a metal and a gas that is soluble in the molten metal at low temperature and insoluble or less soluble in the molten metal at elevated temperature. In an exemplary embodiment, the working medium may comprise at least one of silver and oxygen. In an embodiment, the oxygen pressure in the reaction cell chamber is maintained at a pressure that substantially prevents the molten metal such a silver form undergoing vaporization. The hydrino reaction plasma may heat the oxygen and liquid silver to a desired temperature such as 3500K. The mixture comprising the working medium may flow under pressure such as 25 atm through a tapered MHD channel wherein the pressure and temperature drop as the thermal energy is converted into electricity. As the temperature drops, the molten metal such as silver may absorb the gas such as oxygen. Then, the liquid may be pumped back to the reservoir to be recycled in the reaction cell chamber wherein the plasma heating releases the oxygen to increase the maintain the desired reaction cell chamber pressure and temperature condition to drive the MHD conversion. In an embodiment, the temperature of the silver at the exit of the MHD channel is about the melting point of the molten metal wherein the solubility of oxygen is about 20 cm³ of oxygen (STP) to 1 cm³ of silver at one atm O₂. The recirculation pumping power for the liquid comprising the dissolved gas may be much less than that of the free gas. Moreover, the gas cooling requirements and MHD converter volume to drop the pressure and temperature of the free gas during a thermodynamic power cycle may be substantially reduced.

In an embodiment, the MHD channel may be vertical and the pressure gradient of the working medium in the channel may be greater than the pressure equivalent due to the force of gravity such that working medium flow of the molten metal is maintained in a cycle from the reaction cell chamber 5b31 to the exit of the MHD channel where the molten metal is pumped back to the reservoirs 5c. In an embodiment, the minimum pressure P is

P=pgh (45)

wherein ρ is the density (1.05×10⁴ kg/m³ for silver) g is the gravitational constant, and h is the height of the metal column. For an exemplary h=0.2 m, P=0.2 atm.

The expansion in the nozzle 307 may be isentropic. In an embodiment, the hydrino reaction conditions in the reaction cell chamber 5b31 may provide and maintain a suitable MHD nozzle 307 temperature and pressure such that the nozzle may produce a high velocity jet while avoiding condensation shock. At least one of about a constant velocity condition and continuity condition whereby the product of the density, velocity, and area is about constant may be maintained during the expansion in the MHD channel 308. In an embodiment, supersonic silver vapor is injected at the entrance to the MHD channel 308 from the MHD nozzle 307. Some silver may condense in the channel, but due to the isentropic expansion, the condensation may be limited. Remaining energy in the jet comprising vapor and any condensed liquid as well as the heat of vaporization of the silver may be by at least partially recovered by condensation at the condenser 309 and recirculation by a recirculator or regenerator such as a heat pipe. In an embodiment, regeneration is achieved using a heat pipe whereby the heat pipe recovers at least the silver heat of vaporization and recirculates it such that the recovered heat power is part of the power input to the MHD channel; then this component of power balance is only reduced by the efficiency of the heat pipe. The percentage of the metal vapor that condenses may be insignificant such as in the range of about 1 to 15%. In an embodiment, condensed vapor may be caused to form an aerosol. The reaction cell chamber, nozzle, and MHD channel may contain a gas such as argon that causes the condensing vapor to from an aerosol. The vapor may be condensed at the end of the MHD channel 308 at condenser such as condenser 309. The liquid metal may be recirculated, and the heat of vaporization may be at least partially recovered by the regenerator such as one comprising a heat pipe.

In another embodiment, the vapor may be forced to condense in a desired region such as the nozzle 307 section. The nozzle expansion may be isentropic wherein condensation of a pure gas such as silver vapor is limited to a liquid mole fraction of 50% starting at the critical temperature and critical pressure which for silver are 506.6 MPa and 7480 K, respectively. In an embodiment, this limitation for condensation from expansion of a pressurized vapor may be overcome by means such as at least one of removal of heat such that the entropy may decrease and by pressurizing the condensing region with at least one other gas. The gas pressure may be equal in all portions of the regions in which there is gas continuity such as in the reaction cell chamber 5b31, the nozzle 307, and the MHD channel 308 regions. The MHD converter may further comprise a tank of other gas, a gas pressure gauge, a gas pump, and a gas pressure controller. The at least one other gas pressure may be controlled by the pressure controller. The gas pressure may be controlled to cause the metal vapor to condense to a greater extent than that of the isentropic expansion of the pure metal vapor. In an embodiment, the gas comprises one that is soluble in the vapor metal. In an exemplary embodiment, the metal comprises silver and the gas comprises at least one of O₂ and H₂O.

In an embodiment, pressure generation in at least one of the nozzle 307 and MHD channel 308 is achieved by the creation of a condensation shock when the metal vapor phase is quickly condensed onto a stream of the liquid metal, producing rapid transformation from two-phase into single-phase flow with a resulting release of the heat of vaporization. The energy release is manifest as kinetic energy of the liquid stream. The kinetic energy of the liquid stream is converted into electricity in the MHD channel 308. In an embodiment, the vapor is condensed as a fog or aerosol. The aerosol may form in a gas ambient atmosphere such as one comprising an aerosol-forming gas such as oxygen and optionally a noble gas such as argon. The MHD channel 308 may be straight to maintain a constant velocity and pressure of the MHD channel flow. The aerosol-forming gas such as oxygen and optionally a noble gas such as argon may be flowed through at least one of the reservoirs 5c, the reaction cell chamber 5b31, the MHD nozzle 307, the MHD channel 308, and other MHD converter components such as any return lines 310a, conduits 313a, and pumps 312a. The gas may be recirculated by the MHD return gas pump or compressor 312a.

In an embodiment, the nozzle 307 comprises a condensing jet injector comprising a two-phase jet device in which the molten metal in the liquid state is mixed with its vapor phase, producing a liquid stream with a pressure that is higher than the pressure of either of the two inlet streams. The pressure may be developed in at least one of the reaction cell chamber 5b31 and in the nozzle 307. The nozzle pressure may be converted to stream velocity at the exit of the nozzle 307. In an embodiment, the reaction cell chamber plasma comprises one phase of the jet device. Molten metal from at least one EM pump injector may comprise the other phase of the jet device. In an embodiment, the other phase such as the liquid phase may be injected by an independent EM pump injector that may comprise an EM pump 5ka, a reservoir such as 5c, an nozzle section of the EM pump tube 5k61, and a nozzle 5q.

In an embodiment, the MHD nozzle 307 comprises an aerosol jet injector that converts the high-pressure plasma of the reaction cell chamber 5b31 into an high velocity aerosol flow or jet in the MHD channel 308. The kinetic energy of the jet may be from at least one source of the group of the pressure of the plasma in the reaction cell chamber 5b31 and the heat of vaporization of metal vapor condensed to form the aerosol jet. In an embodiment, the molar volume of the condensed vapor is about 50 to 500 times smaller than the corresponding vapor at standard conditions. The condensation of the vapor in the nozzle 307 may cause a decrease in pressure at the exit section of the nozzle. The decreased pressure may result in an increase in velocity of the condensed flow that may comprise at least one of a liquid and aerosol jet. The nozzle may be extended and may be convergent to convert the local pressure into kinetic energy. The channel may comprise a larger cross sectional area than that of the nozzle exit, and may be straight to allow the propagation of the aerosol flow. Other nozzle 307 and MHD channel 308 geometries such as ones having convergent, divergent, and straight sections may be selected to achieve the desired condensation of the metal vapor with at least a portion of the energy converted to a conductive flow in the MHD channel 308.

In an embodiment, some residual gas may remain uncondensed in the MHD channel 308. The uncondensed gas may support plasma in the MHD channel to provide an electrically conductive MHD channel flow. The plasma may be maintained by the hydrino reaction that may be propagated in the MHD channel 308. The hydrino reactants may be provided to at least one of the reaction cell chamber 5b31 and the MHD channel 308.

In an embodiment, pressure generation in at least one of the nozzle 307 and MHD channel 308 is achieved by the condensation of the metal vapor such as silver metal vapor with a release of the heat of vaporization. The energy release is manifest as kinetic energy of the condensate. The kinetic energy of the flow may be converted into electricity in the MHD channel 308. The MHD channel 308 may be straight to maintain a constant velocity and pressure of the MHD channel flow. In an embodiment, the vapor is condensed as a fog or aerosol. The aerosol may form in an ambient atmosphere comprising an inert gas such as one comprising argon. The aerosol may form in an ambient atmosphere comprising oxygen. The MHD converter may comprise a source of metal aerosol such as silver aerosol. The source may comprise at least one of the dual molten metal injectors. The aerosol source may comprise an independent EM pump injector that may comprise an EM pump 5ka, a reservoir such as 5c, an nozzle section of the EM pump tube 5k61, and a nozzle 5q wherein the molten metal injection at least partially converts to metal aerosol. The aerosol may flow or be injected into the region wherein it is desired to condense the metal vapor such as in the MHD nozzle 307. The aerosol may condense the metal vapor to a greater extent than that possible for metal vapor that undergoes isentropic expansion such as isentropic nozzle expansion. The metal vapor condensation may release the metal vapor heat of vaporization that may increase at least one of the temperature and pressure of the aerosol. The corresponding energy and power may contribute to the kinetic energy and power of the aerosol and plasma flow at the exit of the nozzle. The power of the flow may be converted to electricity with an increase in efficiency due to the contribution of the power from the metal vapor heat of vaporization. The MHD converter may comprise a controller of the source of metal aerosol to control at least one of the aerosol flow rate and aerosol mass density. The controller may control the rate of EM pumping of an EM pump source of aerosol. The aerosol injection rate may be controlled to optimize the vapor condensation to recover the vapor heat of vaporization and the MHD power conversion efficiency.

In an embodiment, the heat of vaporization released by the condensation of vapor in the nozzle is at least partially transferred to the reaction cell chamber plasma directly or indirectly. The nozzle may comprise a heat exchanger to transfer heat to the reaction cell chamber. The heat may be transferred by at least one method of radiation, conduction, and convection. The nozzle may be heated by the released heat of vaporization and the heat may be transferred by conduction to the reaction cell chamber. The nozzle may comprise a material that is highly heat conductive such as a refractory heat conductor that may comprise an oxidation resistant coating. In exemplary embodiments, the nozzle may comprise boron nitride or carbon that may be coated with an oxidation resistance refractory coat such as a ZrO₂ coating. The material may comprise other refractory materials and coatings of the disclosure.

In an embodiment, pressure generation in at least one of the nozzle 307 and MHD channel 308 is achieved by the condensation of the metal vapor such as silver metal vapor with a release of the heat of vaporization. The energy release is manifest as kinetic energy of the condensate. The kinetic energy of the flow may be converted into electricity in the MHD channel 308. The MHD channel 308 may be straight to maintain a constant velocity and pressure of the MHD channel flow. In an embodiment, the vapor is condensed as a fog or aerosol. The aerosol may form in an ambient atmosphere such as one comprising at least one of argon and oxygen. The aerosol may be formed by injection, passive flow, or forced flow of at least one of oxygen and a noble gas through the liquid silver. The gas may be recirculated using the compressor 312a. The gas may be recirculated in a high-pressure gas flow loop such as one that receives gas at the reaction cell chamber 531 and recirculates it to the reservoir 5c wherein it flows through molten silver to increase the aerosol formation. In an embodiment, the silver may comprise an additive to increase the aerosol formation rate and extent. In an alternative embodiment, a high rate of aerosol production may be a formed by circulating the liquid metal at a high rate. The metal may be injected at high rate by at least one molten metal injector such as the dual molten metal injectors comprising EM pumps 5kk. The pump rate may be in at least one range of about 1 g/s to 10 g/s, 10 g/s to 100 g/s, 1 kg/s to 10 kg/s, 10 kg/s to 100 kg/s, and 100 kg/s to 1000 kg/s. In an embodiment, the energy efficiency to form silver aerosol by pumping molten metal in a maintained cell atmosphere such as one comprising a desired concentration of oxygen may be higher than pumping the gas through the molten silver.

The MHD converter may comprise a source of metal aerosol such as silver aerosol. The source may comprise one or more of at least one of the dual molten metal injectors and aerosol formation from at least one reservoir due to a temperature of the metal contained in the reservoir of above the metal's melting point. The aerosol source may comprise an independent EM pump injector that may comprise an EM pump 5ka, a reservoir such as 5c, an nozzle section of the EM pump tube 5k61, and a nozzle 5q wherein the molten metal injection at least partially converts to metal aerosol. The aerosol may flow or be injected into the region wherein it is desired to condense the metal vapor such as in the MHD nozzle 307. The aerosol may condense the metal vapor to a greater extent than that possible for metal vapor that undergoes isentropic expansion such as isentropic nozzle expansion. The metal vapor condensation may release the metal vapor heat of vaporization that may increase at least one of the temperature and pressure of the aerosol. The corresponding energy and power may contribute to the kinetic energy and power of the aerosol and plasma flow at the exit of the nozzle. The power of the flow may be converted to electricity with an increase in efficiency due to the contribution of the power from the metal vapor heat of vaporization. The MHD converter may comprise a controller of the source of metal aerosol to control at least one of the aerosol flow rate and aerosol mass density. The controller may control the rate of EM pumping of an EM pump source of aerosol. The aerosol injection rate may be controlled to optimize the vapor condensation to recover the vapor heat of vaporization and the MHD power conversion efficiency.

The entropy decrease to cause condensation of the silver vapor during otherwise isentropic expansion can be estimated by the entropy of vaporization of silver AS, given by

$$Δ {S}_{vap} = \frac{Δ {H}_{vap}}{{T}_{vap}} = \frac{254 kJ \text{/} mol}{2435 K} = 104 J {mole}^{- 1} {K}^{- 1} \qquad ( 46 )$$

wherein Tᵥₐₚ is the silver boiling point and ΔHᵥₐₚ is the silver enthalpy of vaporization. In the case that silver vapor contacts silver fog or aerosol having the exemplary temperature of the reservoir of 1500 K, the entropy change to reach the boiling point is

$$\begin{matrix}Δ {S}_{fog} = \int \frac{{dH}_{fog}}{{T}_{fog}} = \int \frac{{C}_{p} dT}{{T}_{fog}} = {C}_{p} ln \frac{{T}_{vap}}{{T}_{res}} \\ = 25.4 J {mole}^{- 1} {K}^{- 1} ln \frac{2435 K}{1500 K} = 12.3 J {mole}^{- 1} {K}^{- 1}\end{matrix} \qquad ( 47 )$$

wherein dH_{fog} is the differential fog enthalpy, T_{fog} is the fog temperature, Cₚ is the specific heat capacity of silver at constant pressure, and Tᵣₑₛ is the reservoir and the initial fog temperature. Thus, in the case that the mass flow of fog is about 8 times that of the metal vapor, the metal vapor will condense to release its heat of vaporization in the nozzle with the corresponding energy available to be significantly converted to kinetic energy. Given that an exemplary molar volume of the condensed vapor as fog or aerosol is about 50 times smaller than the corresponding vapor, the fog flow need only be about 15% of the total gas/plasma volumetric flow to achieve condensation of the vapor to result in about pure fog or aerosol plasma flow. The flog flow rate may be controlled by controlling the reservoir temperature, the fog source injection rate such as the EM pump rate, and the pressure of the aerosol-forming gas such as oxygen and optionally argon.

In an embodiment, the MHD thermodynamic cycle comprises the process of maintaining a hydrino reaction plasma that maintains superheated silver vapor and condensing it to a high kinetic energy aerosol jet of liquid droplets by adding at least one of cold silver aerosol or liquid silver metal injection. The aerosol jet power inventory may comprise predominantly kinetic energy power. The electrical power conversion may be predominantly from the kinetic energy power change in the MHD channel 308. The mode of operation of the MHD converter may comprise the opposite of that of a railgun or the opposite of a DC conductive electromagnetic pump.

The vapor condensation to form the high kinetic energy jet of liquid silver droplets may substantially avoid the loss of the heat of vaporization in the energy and power balance. The cold silver aerosol may be formed in the reservoirs and transported to at least one of the reaction cell chamber 5b31 and the MHD nozzle 307. The cell may further comprise a mixing chamber at the down-stream side of the plasma flow through the reaction cell chamber to the MHD converter. The mixing of cold aerosol and superheated vapor may occur in at least one of the reaction cell chamber 5b31, the mixing chamber, and the MHD nozzle 307. In an embodiment, the SunCell® comprises a source of oxygen to form fuming molten silver to facilitate silver aerosol formation. The oxygen may be supplied to at least one of the reservoirs 5c, the reaction cell chamber 5b31, the MHD nozzle 307, the MHD channel 308, the MHD condensation section 309, and another interior chamber of the SunCell®-MHD converter generator. The oxygen may be absorbed by molten silver to form an aerosol. The aerosol may be enhanced by the presence of a noble gas such as an argon atmosphere inside of the generator. The argon atmosphere may be added and maintained at a desired pressure by systems of the disclosure such as an argon tank, line, valve, controller and injector. The injector may be in the condensation section 309 or other appropriate region to avoid silver back flow. In an embodiment, the super heated silver vapor may be condensed to form an aerosol jet by the injection of silver directly or indirectly into the nozzle. In an embodiment, the reaction cell chamber 5b31 may be operated under at least one of lower temperature and lower pressure to permit a larger fraction of the vapor to be liquefied under expansion such as isentropic expansion. An exemplary lower temperature and pressure are about 2500 K and about 1 atm, versus 3500 K and 10 atm, respectively.

In the case that the flow velocity decreases, the density of the fog may increase to maintain constant flow in the channel. The density may increase by aggregation of silver fog droplets. The channel may comprise a straight channel. In other embodiments, the channel may be convergent or divergent or have another geometry appropriate to optimize the MHD power conversion.

In an embodiment, the nozzle may comprise at least one channel for relatively cold metal vapor aerosol and at least another for silver vapor or super heated silver vapor. The channels may deliver corresponding aerosol to be mixed in the nozzle 307. The mixing may decrease the entropy to cause silver vapor condensation. The condensation and nozzle flow may result in a fast aerosol jet at the nozzle exit. The flow rate of the relatively cold aerosol may be controlled by controlling the temperature of the source such as the reservoir temperature wherein the reservoir may serve as the source. The flow rate of the superheated vapor may be controlled by controlling at least one of the hydrino reaction rate and the rate of molten metal injection.

In an embodiment, the nozzle exit pressure and temperature are about those at the MHD channel 308 exit, and the input power Pᵢₙₚᵤₜ at the entrance of the MHD channel 308 is about that given by the kinetic energy associated with the mass flow rate m at its velocity v.

Pᵢₙₚᵤₜ=0.5 \dot{m}v³ (48)

The electrical conversion power P_{electric} in the MHD channel is given by

P_{electric}=VI=ELJ=ELσ(vB−E)A=vBWLσ(vB−WvB)d²=σv²B²W(1−W)Ld² (49)

wherein V is the MHD channel voltage, I is the channel current, E is the channel electric field, J is the channel current density, L is the channel length, σ is the flow conductivity, v is the flow velocity, B is the magnetic field strength, A is the current cross sectional area (the nozzle exit area), d is the electrode separation, and W is the loading factor (ratio of the electric field across the load to the open circuit electric field). The efficiency η is given by the ratio of the electrical conversion power in the MHD channel (Eq. (49)) and the input power (Eq. (48)):

$$η = \frac{{P}_{electric}}{{P}_{input}} = \frac{σ {v}^{2} {B}^{2} W ( 1 - W ) {Ld}^{2}}{0.5 \dot{m} {v}^{2}} = \frac{σ {B}^{2} W ( 1 - W ) {Ld}^{2}}{0.5 \dot{m}} \qquad ( 50 )$$

In the case that the mass flow m is 1 kg/s, the conductivity a is 50,000 S/m, the velocity is 1200 m/s, the magnetic flux B is 0.25 T, the load factor W is 0.5, the channel width and the electrode separation d of the exemplary straight square rectangular channel is 0.05 m, and the channel length L is 0.2 m, the powers and efficiency are:

Pᵢₙₚᵤₜ=720 kW (51)

P_{electric}=562 kW (52)

and

η=78% (53)

Eq. (53) is the total enthalpic efficiency when the total energy inventory is essentially the kinetic energy wherein the heat of vaporization is also converted to kinetic energy in the nozzle 307.

In an embodiment, the differential Lorentz force dF_{L} is proportional to the silver plasma flow velocity and the differential distance dx along the MHD channel 308:

dF_{L}=σvB²(1−W)d²dx (54)

The differential Lorentz force (Eq. (54)) can be rearranged as

$$\begin{matrix}\frac{{dF}_{L}}{dx} = \frac{{δ}^{2} ( mv )}{δ x δ t} = \frac{{δ}^{2} ( mv )}{δ t δ x} = \frac{δ}{δ t} ( m \frac{dv}{dx} ) = \dot{m} \frac{dv}{dx} = σ {vB}^{2} ( 1 - W ) {d}^{2} \\ or & ( 55 ) \\ \frac{dv}{dx} = \frac{σ {vB}^{2} ( 1 - W ) {d}^{2}}{\dot{m}} = \frac{σ {B}^{2} ( 1 - W ) {d}^{2}}{\dot{m}} v & ( 56 )\end{matrix}$$

wherein (i) the conductivity σ and the magnetic flux B may be constant along the channel, (ii) ideally there is no mass loss along the channel such that the mass m is a constant with respect to distance and the mass flow rate in the channel \dot{m} is constant due to a constant rate of injection into the channel entrance and continuity of flow under steady state conditions, and (iii) the differential of velocity with distance

$$\frac{dv}{dx}$$

is time independent at a steady flow condition. The constant mass flow rate with decreasing velocity along the channel may correspond to increasing aggregation of aerosol particles to the limit of complete liquefaction at the MHD channel exit. Then, the rate of change in velocity with respect to channel distance is proportional to the velocity:

$$\frac{dv}{dx} = - kv \qquad ( 57 )$$

wherein k is a constant determined by the boundary conditions. Integration of Eq. (57) gives

v=v₀e^{-kx} (58)

By comparing Eq. (57) to Eq. (56) the constant k is

$$k = \frac{σ {B}^{2} ( 1 - W ) {d}^{2}}{\dot{m}} \qquad ( 59 )$$

By combining Eq. (58) and Eq. (59), the velocity as a function of channel distance is

$$v = {v}_{0} {e}^{- \frac{σ {B}^{2} ( 1 - W ) {d}^{2}}{\dot{m}} x} \qquad ( 60 )$$

From Eq. (49), the corresponding power of the channel is given by

$$\begin{matrix}P = {\int }_{0}^{L} σ {v}_{0}^{2} {e}^{- \frac{2 σ {B}^{2} ( 1 - W ) {d}^{2}}{\dot{m}} x} {B}^{2} W ( 1 - W ) {d}^{2} dx \\ = σ {v}_{0}^{2} {B}^{2} W ( 1 - W ) {d}^{2} \frac{\dot{m}}{2 σ {B}^{2} ( 1 - W ) {d}^{2}} ( 1 - {e}^{- \frac{2 σ {B}^{2} ( 1 - W ) {d}^{2}}{\dot{m}} L} ) \\ = 0.5 \dot{m} {v}_{0}^{2} W ( 1 - {e}^{- \frac{2 σ {B}^{2} ( 1 - W ) {d}^{2}}{\dot{m}} L} )\end{matrix} \qquad ( 61 )$$

In the case that the mass flow \dot{m} is 0.5 kg/s, the conductivity σ is 50,000 S/m, the velocity is 1200 m/s, the magnetic flux B is 0.1 T, the load factor W is 0.7, the channel width and the electrode separation d of the exemplary straight square rectangular channel is 0.1 m, and the channel length L is 0.25 m, the powers and efficiency are:

Pᵢₙₚᵤₜ=360 kW (62)

P_{electric}=196 kW (63)

and

η=54% (64)

Eq. (64) corresponds to 54% of the initial channel kinetic energy converted to electricity to power an external load and 46% of the power dissipated in the internal resistance wherein the electrical power density is 80 kW/liter.

The electrical power converges to the kinetic energy power input to the MHD channel 0.5 \dot{m}vₒ² times the loading factor W of the MHD channel. The power density may be increased by increasing the input kinetic energy power and by decreasing the channel dimensions. The latter may be achieved by increasing at least one of the mass flow rate, the magnetic flux density, and the flow conductivity. In the case that the mass flow \dot{m} is 2 kg/s, the conductivity σ is 500,000 S/m, the velocity is 1500 m/s, the magnetic flux B is 1 T, the load factor W is 0.7, the channel width and the electrode separation d of the exemplary straight square rectangular channel is 0.05 m, and the channel length L is 0.1 m, the powers and efficiency are:

Pᵢₙₚᵤₜ=2.25 MW (65)

P_{electric}=1.575 MW (66)

and

η=70% (67)

Eq. (67) corresponds to 70% of the initial channel kinetic energy converted to electricity to power an external load and 30% of the power dissipated in the internal resistance wherein the electrical power density is 6.3 MW/liter.

The power given by Eq. (61) may be expressed as

$$P = {K}_{0} W ( 1 - {e}^{- \frac{2 σ {B}^{2} ( 1 - W ) {d}^{2}}{\dot{m}} L} ) \qquad ( 68 )$$

wherein K₀ is the initial channel kinetic energy. The maximum power output can be determined by taking the derivative of P with respect to W and setting it equal to 0.

$$\begin{matrix}\frac{dP}{dW} = - {K}_{0} W \frac{2 σ {B}^{2} {d}^{2}}{\dot{m}} {Le}^{- \frac{2 σ {B}^{2} ( 1 - W ) {d}^{2}}{\dot{m}} L} + \\ {K}_{0} ( 1 - {e}^{- \frac{2 σ {B}^{2} ( 1 - W ) {d}^{2}}{\dot{m}} L} ) \\ = - {K}_{0} {sWe}^{- s ( 1 - W )} + {K}_{0} ( 1 - {e}^{- s ( 1 - W )} ) \\ = 0\end{matrix} \qquad ( 69 )$$

wherein

$$s = \frac{2 σ {B}^{2} {d}^{2}}{\dot{m}} L \qquad ( 70 )$$

Then,

(1+sW)=e^{s(1-W)} (71)

In the exemplary case of Eqs. (65-67) wherein s=125, using a reiterative method, the power is optimal when W=0.96. In this case, the efficiency for the conditions of Eqs. (65-66) is 96%.

In an embodiment, at least one of the reaction cell chamber 5b31 and the nozzle 307 may comprise a magnetic bottle that may selectively form a plasma jet along the longitudinal axis of the MHD channel 308. The power converter may comprise a magnetic mirror which is a source of a magnetic field gradient in a desired direction of ion flow where the initial parallel velocity of plasma electrons v− increases as the orbital velocity 12, decreases with conservation of energy according to the adiabatic invariant

$$\frac{{v}_{⊥}^{2}}{B} = constant ,$$

the linear energy being drawn from that of orbital motion. As the magnetic flux B decreases, the ion cyclotron radius α will increase such that the flux πα²B remains constant. The invariance of the flux linking an orbit is the basis of the mechanism of a “magnetic mirror”. The principle of a magnetic mirror is that charged particles are reflected by regions of strong magnetic fields if the initial velocity is towards the mirror and are ejected from the mirror otherwise. The adiabatic invariance of flux through the orbit of an ion is a means to form a flow of ions along the z-axis with the conversion of v_{⊥} to v_{∥} such that v_{∥}>v_{⊥}. Two magnetic mirrors or more may form a magnetic bottle to confine plasma such as that formed in the reaction cell chamber 5b31. Ions created or contained in the bottle in the center region will spiral along the axis, but will be reflected by the magnetic mirrors at each end. The more energetic ions with high components of velocity parallel to a desired axis will escape at the ends of the bottle. The bottle may be more leaky at the MHD channel end. Thus, the bottle may produce an essentially linear flow of ions from the end of the magnetic bottle into the channel entrance of the magnetohydrodynamic converter.

Specifically, the plasma may be magnetized with a magnetic mirror that causes the component of ion motion perpendicular to the direction of the MHD channel or z-axis v_{|}to at least partially convert into to parallel motion v_{∥} due to the adiabatic invariant

$$\frac{{v}_{⊥}^{2}}{B} = constant .$$

The ions have a preferential velocity along the z-axis and propagate into the magnetohydrodynamic power converter wherein Lorentzian deflected ions form a voltage at electrodes crossed with the corresponding transverse deflecting field. The voltage may drive a current through an electrical load. In an embodiment, the magnetic mirror comprises an electromagnet or a permanent magnet that produces the field equivalent to a Helmholtz coil or a solenoid. In the case of an electromagnetic magnetic mirror, the magnetic field strength may be adjustable by controlling the electromagnetic current to control the rate at which ions flow from the reaction cell chamber to control the power conversion. In the case that

$${v}_{‖ 0}^{2} = {v}_{⊥ 0}^{2} = 0.5 {v}_{0}^{2} and \frac{B ( z )}{{B}_{0}} = 0.1$$

at the entrance to the MHD channel 308, the velocity given by

$${v}_{‖ 0}^{2} = {v}_{0}^{2} - {v}_{⊥ 0}^{2} \frac{B ( z )}{{B}_{0}}$$

may be is about 95% parallel to the z-axis.

In an embodiment, the hydrino reaction mixture may comprise at least one of oxygen, water vapor, and hydrogen. The MHD components may comprise materials such as ceramics such as metal oxides such as at least one of zirconia and hafnia, or silica or quartz that are stable under an oxidizing atmosphere. In an embodiment, the MHD electrodes 304 may comprise a material that may be less susceptible to corrosion or degradation during operation. In an embodiment, the MHD electrodes 304 may comprise a conductive ceramic such as a conductive solid oxide. In another embodiment, the MHD electrodes 304 may comprise liquid electrodes. The liquid electrodes may comprise a metal that is liquid at the electrode operating temperature. The liquid metal may comprise the working medium metal such as molten silver. The molten electrode metal may comprise a matrix impregnated with the molten metal. The matrix may comprise a refectory material such as a metal such as W, carbon, a ceramic that may be conductive or another refractory material of the disclosure. The negative electrode may comprise a solid refractory metal. The negative polarity may protect the negative electrode from oxidizing. The positive electrode may comprise a liquid electrode.

The liquid electrode may comprise a means to apply electromagnetic restraint (Lorentz force) to maintain free surface liquid metal. The liquid metal electrodes may comprise a source of magnetic field and a source of current to maintain the electromagnetic restraint. The magnetic field source may comprise at least one of the MHD magnets 306 and another set of magnetic such a permananet magnets, electromagnets, and superconducting magnets. The current source may comprise at least one of the MHD current and an applied current from an external current source.

In an embodiment, the conductive ceramic electrodes may comprise one of the disclosure such as a carbide such as ZrC, HfC, or WC or a boride such as ZrB₂ or composites such as ZrC—ZrB₂, ZrC—ZrB₂—SiC, and ZrB₂ with 20% SiC composite that may work up to 1800° C. The electrodes may comprise carbon. In an embodiment, a plurality of liquid electrodes may be supplied liquid metal through a common manifold. The liquid metal may be pumped by an EM pump. The liquid electrodes may comprise molten metal impregnated in a non-reactive matrix such as a ceramic matrix such as a metal oxide matrix. Alternatively, the liquid metal may be pumped through the matrix to continuous supply molten metal. In an embodiment, the electrodes may comprise continuously injected molten metal such as the ignition electrodes. The injectors may comprise a non-reactive refractory material such as a metal oxide such as ZrO₂. In an embodiment, each of the liquid electrodes may comprise a flow stream of molten metal that is exposed to the MHD channel plasma.

In an embodiment, the electrodes may be arranged in a Hall generator design. The negative electrode may be in proximity to the entrance of the MHD channel and the positive electrode may be in proximity to the exit of the MHD channel. The electrode may be in proximity to the entrance of the MHD channel may comprise a liquid electrode such as a submerged electrode. The electrode in proximity to the exit of the MHD channel may comprise a conductor that is resistant to oxidation at the electrode operating temperature wherein the operating temperature may be significantly lower at the exit than that entrance of the MHD channel. Exemplary oxidation resistant electrodes at the MHD exit may comprise a carbide such as ZrC or a boride such as ZrB₂. In an embodiment, the electrodes may comprise a series of electrode sections separated by insulator sections that comprise protrusions of the MHD channel wall that may comprise and electrical insulator. The protruding sections may be maintained at a temperature that prevents the metal vapor from condensing. The insulating sections may comprise wall strips that are at least one of heated and insulated to maintain the strip temperature above the boiling point of the metal at the operating pressure of the MHD channel. The electrode at the exit of the channel may comprise an oxidation resistant electrode such as a carbide or boride that may be stable to oxidation at the exit temperature. In an embodiment, the MHD channel may be maintained at a temperature below that which results in at least one of condensation of metal vapor on the insulator portion of the walls and corrosion of the electrodes such as carbide or boride electrodes such as ones comprising ZrC or ZrB₂ or composites such as ZrC—ZrB₂ and ZrC—ZrB₂—SiC composite that may work up to 1800° C. In an embodiment, the working medium comprises a metal such silver that may sublime at a temperature below its boiling point to prevent the metal from condensing on the walls of the MHD channel such that it flows to the recirculation system.

In an embodiment, the MHD magnets 306 may comprise alternating field magnets such as electromagnets that may apply a sinusoidal or alternating magnetic field to the MHD channel 308. The sinusoidal or alternating applied field may cause the MHD electrical output to be alternating (AC) power. The alternating current and voltage frequency may be a standard one such as 50 or 60 Hz. In an embodiment, the MHD power is transferred out of the channel by induction. The induction generator may eliminate the electrodes that contact the plasma.

The unions and seals between components such as the seal 314 connecting the reaction cell chamber 5b31 and MHD acceleration channel or nozzle 307 to the MHD expansion or generator channel 308 may comprise a gasketed flange seal or other of the disclosure. Other seals such as ones of the return conduits 310, the return reservoirs 311, the return EM pumps 312, the injection reservoirs 5c, and the injection EM pump assembly 5kk may comprise one of the disclosure. An exemplary gasket comprises carbon such as graphite or Graphoil wherein joined metal oxide parts such as ones comprising at least one of alumina, hafnia, zirconia, and magnesia are maintained below the carboreduction temperature such as below the range of about 1300° C. to 1900° C. The components may comprise different materials of the disclosure such as the refractory materials and stainless steel based on their operating parameters and requirements. In an exemplary embodiment, i.) at least one of the EM pump assembly 5kk, return conduits 310, return reservoirs 311, and return EM pump tube 312 comprises stainless steel wherein the inside may be coated with an oxidation protective coating such as nickel, Pt, rhenium, or other noble metal, ii.) at least one of the reservoirs 5c, the reaction cell chamber 5b31, the nozzle 307, and the MHD expansion section 308 comprises an electrical insulating refractory material such as boron nitride or a refractory oxide such as MgO (M.P. 2825° C.), ZrO₂ (M.P. 2715° C.), magnesia zirconia that is stable to H₂O, strontium zirconate (SrZrO₃ M.P. 2700° C.), HfO₂ (M.P. 2758° C.), or thorium dioxide (M.P. 3300° C.) that is stable to oxidation at the operating temperature, iii.) the reaction cell chamber 5b31 comprises graphite such as at least one of isotropic and pyrolytic graphite, and iv.) at least one of the inlet riser tube 5qa, the nozzle section of the electromagnetic pump tube 5k61, the nozzle 5q, and the MHD electrodes 304 may comprise at least one of carbon, Mo, W, rhenium, rhenium coated Mo, rhenium coated W. In an exemplary embodiment, at least one of the EM pump assembly 5kk, return conduits 310a, return reservoirs 311a, and return gas pump or compressor 312a comprises stainless steel wherein the inside may be coated with an oxidation protective coating such as nickel, Pt, rhenium, or other noble metal.

The electrodes may comprise a noble metal coated conductor such as Pt on copper, nickel, nickel alloys, and cobalt alloys or these metals uncoated wherein cooling may be applied by a backing heat exchanger or cold plate. The electrodes may comprise spinel type electrodes such as 0.75 MgAl₂O₄-0.25 Fe₃O₄, 0.75 FeAl₂O₄-0.25 Fe₃O₄, and lanthanum chromite La(Mg)CrO₃. In an embodiment, the MHD electrodes 304 may comprise liquid electrodes such as liquid silver coated refractory metal electrodes or cooled metal electrodes. At least one of the Ni and rhenium coatings may protect the coated component from reaction with H₂O. The MHD atmosphere may comprise hydrogen to maintain a reducing condition of metals such as those of the EM pump tube 5k6, inlet riser tube 5qa, the nozzle section of the electromagnetic pump tube 5k61, the nozzle 5q, and the MHD electrodes 304. The MHD atmosphere may comprise water vapor to maintain the oxide ceramic such as strontium zirconate, hafnia, ZrO₂ or MgO of the ceramic components such as at least one of the reaction cell chamber 5b31, the nozzle 307, and the MHD expansion section 308. Metal oxides parts may be glued or cemented together using ceramic glues such as zirconia phosphate cement, ZrO₂ cement, or calcia-zirconia cement. Exemplary Al₂O₃ adhesives are Rescor 960 Alumina (Cotronics) and Ceramabond 671. Further exemplary ceramic glues are Resbond 989 (Cotronics) and Ceramabond 50 (Aremco). In an embodiment, the wall components may comprise a thermally insulating ceramic such as ZrO₂ or HfO₂ that may be stabilized with MgO, and the electrode insulators of the segmented electrodes may comprise a thermally conducting ceramic such as MgO. To prevent loss by vaporization from the outer surface, the ceramic may be at least one of thick enough to be sufficiently cool externally, actively or passively cooled, or wrapped in insulation.

Several oxides may be add to the ZrO₂ (zirconia) or HfO₂ (hafnia) to stabilize the materials such as yttrium oxide (Y₂O₃), magnesium oxide (MgO), calcium oxide (CaO), strontium oxide (SrO), tantalum oxide (Ta₂O₅), boron oxide (B₂O₃), TiO₂, cerium oxide (Ce₂O₃), SiC, yttrium, and iridium. The crystal structure may be cubic phase that is referred to as cubic stabilized zirconia (hafnia) or stabilized zirconia (hafnia). In an embodiment, at least one cell component such as the reaction cell chamber 5b31 is permeable to at least one of oxygen and oxide ions. An exemplary oxide permeable material is ZrO₂. The oxygen content of the reaction cell chamber 5b31 may be controlled by controlling the oxide diffusion rate through the oxide permeable or oxide mobile material such as ZrO₂. The cell may comprise a voltage and current source across the oxide permeable material and a voltage and current control system wherein the flow of oxide ions across the material is controlled by the voltage and current. Other suitable refractory component materials comprise at least one of SiC (M. P.=2830° C.), BN (M. P.=2970° C.), HfB₂ (M. P.=3250° C.), and ZrB₂ (M. P.=3250° C.).

To avoid MHD electrode electrical shorting by the molten metal vapor, the electrodes 304 (FIG. 2I161) may comprise conductors, each mounted on electrical-insulator-covered conducting posts or leads 305 that serve as standoff leads that further serve as a spacer of the electrode from the wall of the generator channel 308. The electrodes 304 may be segmented and may comprise a cathode 302 and anode 303. Except for the standoff leads 305, the electrodes may be freely suspended in the generator channel 308. The electrode spacing along the vertical axis may be sufficient to prevent molten metal shorting. The electrodes may comprise a refractory conductor such as W or Mo. The leads 305 may be connected to wires that may be insulated with a refractory insulator such as BN. The wires may join in a harness that penetrates the channel at a MHD bus bar feed through flange 301 that may comprise a metal. Outside of the MHD converter, the harness may connect to a power consolidator and inverter.

In an exemplary embodiment, the blackbody plasma initial and final temperatures during MHD conversion to electricity are 3000K and 1300K. In an embodiment, the MHD generator is cooled on the low-pressure side to maintain the plasma flow. The Hall or generator channel 308 may be cooled. The cooling means may be one of the disclosure. The MHD generator 300 may comprise a heat exchanger 316 such as a radiative heat exchanger wherein the heat exchanger may be designed to radiate power as a function of its temperature to maintain a desired lowest channel temperature range such as in a range of about 1000° C. to 1500° C. The radiative heat exchanger may comprise a high surface are to minimize at least one of its size and weight. The radiative heat exchanger 316 may comprise a plurality of surfaces that may be configured in pyramidal or prismatic facets to increase the radiative surface area. The radiative heat exchanger may operate in air. The surface of the radiative heat exchanger may be coated with a material that has at least one property of the group of (i) capable of high temperature operation such as a refractory material, (ii) possesses a high emissivity, (iii) stable to oxidation, and provides a high surface area such as a textured surface with unimpeded or unobstructed emission. Exemplary materials are ceramics such as oxides such as MgO, ZrO₂, HfO₂, Al₂O₃, and other oxidative stabilized ceramics such as ZrC—ZrB₂ and ZrC—ZrB₂—SiC composite.

The generator may further comprise a regenerator or regenerative heat exchanger. In an embodiment, flow is returned to the injection system after passing in a counter current manner to receive heat in the expansion section 308 or other heat loss region to preheat the metal that is injected into the cell reaction chamber 5b31 to maintain the reaction cell chamber temperature. In an embodiment, at least one of working medium such as at least one of silver and a noble, a cell component such as the reservoirs 5c, the reaction cell chamber 5b31, and an MHD converter component such as at least one of the MHD condensation section 309 or other hot component such as at least one of the group of the reservoirs 5c, reaction cell chamber 5b31, MHD nozzle section 307, MHD generator section 308, and MHD condensation section 309 may be heated by a heat exchanger that receives heat from at least one other cell or MHD component such as at least one of the group of the reservoirs 5c, reaction cell chamber 5b31, MHD nozzle section 307, MHD generator section 308, and MHD condensation section 309. The regenerator or regenerative heat exchanger may transfer the heat from one component to another.

In an embodiment, at least one of the emissivity, area, and temperature of the radiative heater exchanger 316 may be controlled to control the rate of heat transfer. The area may be controlled by controlling the extent of covering of a heat shield over the radiator. The temperature may be controlled by controlling the heat flow to the radiator. In another embodiment, the heat exchanger 316 may comprise coolant loops wherein the MHD heat exchanger 316 receives coolant through the MHD coolant inlet 317 and removes heat through the MHD coolant outlet 318. The heat may be used in the regenerative heat exchanger to preheat the return silver flow, a cell component or a MHD component. Alternatively, the heat may be used for heating and cogeneration applications.

The nozzle throat 307 may comprise a refractory material that is resistant to wear such as a metal oxide such as ZrO₂, HfO₂, Al₂O₃, or MgO, a refractory nitride, a refractory carbide such as tantalum carbide, tungsten carbide, or tantalum tungsten carbide, pyrolytic graphite that may comprise a refractory cladding such as tungsten, or another refractory material of the disclosure alone or one that may be clad on a refractory material such as carbon. The electrodes 304 may comprise a refractory conductor such as W or Mo. The generator channel 308 or an electrically insulating support such as those of the electrodes 305 may be a refractory insulator such as one of the disclosure such as a ceramic oxide such as ZrO₂, boron nitride, or silicon carbide. In another embodiment wherein the MHD component is cooled, the MHD component such as at least one of the nozzle 307 and channel 308 may comprise a transition metal such as Cu or Ni that may be coated with a refractory material such as Al₂O₃, ZrO₂, Mullite, or another of the disclosure. The electrodes may comprise a transition metal that may be cooled wherein the surface may be coated with a refractory conductor such as W or Mo. The component may be cooled by water, molten salt, or other coolant known by those skilled in the art such as at least one of thermal oils such as silicon based polymers, molten metals such as Sn, Pb, Zn, alloys, molten salts such as alkali salts and eutectic salt mixtures such as alkali halide-alkali hydroxide mixtures (MX-MOH M=Li, Na, K, Rb, Cs; X═F, Cl, Br, I). The hot coolant may be recirculated to preheat the molten metal injected into the reaction cell chamber 5b31. The corresponding heat recovery system may comprise a recuperator.

In an embodiment, the MHD component such as the MHD nozzle 307, MHD channel 308, and MHD condensation section 309 may comprise a refractory material such as one of the disclosure such as at least one of carbide, carbon, and boride, and metal. The refractory material may be susceptible to oxidation to at least one of oxygen and water. To suppress the oxidation reaction, the source of oxygen for the HOH catalyst may be comprise a compound comprising oxygen such as at least one of CO, an alkaline or alkaline earth oxide, or another oxide or compound comprising oxygen of the disclosure. The boride may comprise ZrB₂ that may be doped with SiC. The carbide may comprise at least one of ZrC, WC, SiC, TaC, HfC, and Ta₄HfC₅. Conductive materials such as carbides may be electrically isolated with an insulating spacer or bushing where indicated such as in the case of electrical isolation of at least one of the ignition and MHD electrodes.

An exemplary MHD volumetric conversion density is about 70 MW/m³ (70 kW/liter). Most of the problems with historical MHD originate from the low conductivity feature in the gas-fired case and in the low conductivity plus slagging environments in the coal-fired counterpart. The conductivity of the silver SunCell® plasma is estimated to be about 1 m from the current of 10,000 A at a voltage of 12 V. From the arc dimensions, the corresponding conductivity is estimated to be 1×10⁵ Sim compared to about 20 S/m for an alkali seeded inert MHD working gas wherein the power density is proportional to the conductivity.

In an embodiment, the working medium may comprise at least one of silver vapor and silver-vapor-seeded noble gas such as He, Ne, or Ar. In an embodiment, the conductivity of the working medium may be controlled by controlling at least one of the molten metal vapor pressure such as the silver vapor pressure and the ionization of the working medium. The ionization of the working medium may be controlled by controlling at least one of the hydrino reaction power, the intensity of the EUV and UV light emitted by the hydrino reaction, the ignition voltage, the ignition current, the EM pumping rate of the molten metal streams, and the operating temperatures such as at least one of the gas, electron, ion, and blackbody temperatures. At least one temperature may be controlled by controlling at least one of the ignition and hydrino reaction conditions. Exemplary hydrino reaction conditions are the gas pressure and gas composition such as H₂O, H₂, and inert gas composition. The hydrino reaction conditions and the corresponding controls may be ones of the disclosure or other suitable ones.

In an embodiment, the SunCell® may further comprise a molten metal overflow system such as one comprising an overflow tank, at least one pump, a cell molten metal inventory sensor, a molten metal inventory controller, a heater, a temperature control system, and a molten metal inventory to store and supply molten metal as required to the SunCell® as may be determined by at least one sensor and controller. A molten metal inventory controller of the overflow system may comprise a molten metal level controller of the disclosure such as an inlet riser tube and an EM pump. The overflow system may comprise at least one of the MHD return conduit 310, return reservoir 311, return EM pump 312, and return EM pump tube 313.

In an embodiment, the expansion of the working medium is maintained under conditions to assure isentropic flow. In an embodiment, the inlet working medium conditions are selected for the supersonic nozzle expansion that would ensure reversible expansion in the nozzle and a strong driving pressure gradient in the MHD channel. Since saturation, if it occurs in the nozzle, will lead to strong non-equilibrium sub-cooling due to the rapid cooling rate (such as of about 15 K/us) and this may further will trigger condensation shock in the diverging portion of the nozzle, the nozzle inlet conditions may be highly superheated in order that the vapor does not become saturated during the expansion. In an embodiment, condensation shock is to be avoided because it causes irreversibilities that deviates from the desired isentropic flow condition and sharply reduces the nozzle exit velocity, and the resulting highly dense liquid Ag droplets entrained in the vapor flow in the supersonic/diverging part of the nozzle may lead to accelerated erosion of the nozzle surface. In an embodiment wherein the Lorentz force acts adverse to the flow direction such that a weak driving pressure gradient in the MHD channel may lead to reduced volume flow through the system, the nozzle inlet temperature is as high as possible to allow adequate superheat, and the pressure is also moderately high to assure a strong driving pressure gradient in the MHD section downstream of the nozzle. In an exemplary embodiment, the reaction cell chamber 5b31 pressure at the nozzle entrance is about 6 atm, and the plasma temperature is about 4000 K to result in an isentropic expansion and dry vapor exiting the nozzle at about Mach number 1.24 with about 722 m/s velocity and a pressure of more than 2 atm. Lower inlet temperatures are also possible but these may each yield smaller exit velocity and pressure.

In an embodiment wherein the Lorentz force may stall the plasma jet before the desired MHD channel 308 exit temperature is achieved, at least one of the plasma conductivity, magnetic field strength, gas temperature, electron temperature, ion temperature, channel inlet pressure, jet velocity, and working medium flow parameters are optimized to achieve the desired MHD conversion efficiency and power density. In an embodiment comprising a molten metal seeded noble gas plasma such as a silver vapor seeded argon or helium plasma, the relative flow of metal vapor to noble gas is controlled to achieve at least one of the desired conductivity, plasma gas temperature, reaction chamber 5b31 pressure, and MHD channel 308 inlet jet velocity, pressure, and temperature. In an embodiment, the noble gas and metal vapor flows may be controlled by controlling the corresponding return pumps to achieve the desired relative ratios. In an embodiment, the conductivity may be controlled by controlling the amount of seeding by controlling the relative noble gas and metal injection rates to the reaction cell chamber 5b31. In an embodiment, the conductivity may be controlled by controlling the hydrino reaction rate. The hydrino reaction rate may be controlled by means of the disclosure such as by controlling the injection rate of at least one of the source of catalyst, the source of oxygen, the source of hydrogen, water vapor, hydrogen, the flow of the conductive matrix such as the injection of molten silver, and the ignition parameters such as at least one of the ignition voltage and current. In an embodiment, the MHD converter comprises sensors and control systems for the hydrino reaction and MHD operating parameters such as (i) the reaction conditions such as reactant pressures, temperatures, and relative concentrations, reactant flows such as those of HOH and H or their sources and the flow and pumping rate of the conductive matrix such as liquid and vaporized silver, and ignition conditions such as the ignition current and voltage, (ii) plasma and gas parameters such as pressures, velocities, flow rates, conductivities, and temperatures through the stages of the MHD converter, (iii) return and recycle material parameters such as the pumping rates and physical parameters of the noble gas and molten metal such as flow rates, temperatures, and pressures, and (iv) plasma conductivity sensors in at least one of the reaction cell chamber 5b31, MHD nozzle section 307, MHD channel 308, and MHD condensation section 309.

In an embodiment, a source of gas such as hydrogen such as at least one of H₂ gas and H₂O may be supplied to the reaction cell chamber 5b31. The SunCell® may comprise at least one mass flow controller to supply the source of hydrogen such as at least one of H₂ gas and H₂O that may be in at least one of liquid and gaseous form. The supply may be through at least one of the base if the EM pump assembly 5kk1, the reservoir 5c wall, the wall of the reaction cell chamber 5b31, the injection EM pump tube 5k6, the MHD return conduit 310, the MHD return reservoir 311, the pump tube of the MHD return EM pump 312, and the MHD return EM pump tube 313. The gas added to the cell or MHD interior may be injected in the MHD condensor section 309 or at any convenient cell or MHD converter component that is connected to the interior. In an embodiment, hydrogen gas may be supplied through a selective membrane such as a hydrogen permeable membrane. The hydrogen supply membrane may comprise a Pd or Pd—Ag H₂ permeable membrane or similar membrane known by those skilled in the art. The penetration into the EM pump tube wall for the gas may comprise a flange that may be welded-in or threaded in. The hydrogen may be supplied from a hydrogen tank. The hydrogen may be supplied from release from hydride wherein the release may be controlled be means known by those skilled in the art such as by controlling at least one of pressure and temperature of the hydride. Hydrogen may be supplied by electrolysis of water. The water electrolyzer may comprise a high-pressure electrolyzer. At least one of the electrolyzer and the hydrogen mass flow controller may be controlled by a controller such as one comprising a computer and corresponding sensors. The hydrogen flow may be controlled based on the power output of the SunCell® that may be recorded by a converter such as a thermal measuring device, the PV converter, or the MHD converter.

In an embodiment, H₂O may be supplied to the reaction cell chamber 5b31. The supply may comprise a line such as one through the EM pump tube 5k6 or EM pump assembly 5kk. The H₂O may provide at least one of H and HOH catalyst. The hydrino reaction may produce O₂ and H₂(1/p) and products. The H₂(1/p) such as H₂(1/4) may diffuse from at least one of the reaction cell chamber and MHD converter to an outside region such as ambient atmosphere or a H₂(1/p) collection system. H₂(1/p) may diffuse through the wall of at least one of the reaction cell chamber and MHD converter due to its small volume. The O₂ product may diffuse from at least one of the reaction cell chamber and MHD converter to an outside region such as ambient atmosphere or an O₂ collection system. The O₂ may diffuse through a selective membrane, material, or value. The selective material or membrane may comprise one capable of conducting oxide such as a yttria, nickel/yttria stabilized zirconia (YSZ)/silicate layered, or other oxygen or oxide selective membrane known by those skilled in the art. The O₂ may diffuse through a permeable wall such as one capable of conducting oxide such as a yttria wall. The oxygen permeable membrane may comprise a porous ceramic of a low-pressure component of the reaction cell and MHD converter such as a ceramic wall of the MHD channel 308. The oxygen selective membrane may comprise BaCo_{0.7}Fe_{0.2}Nb_{0.1}O_{3-δ} (BCFN) oxygen permeable membrane that may be coated with Bi₂₆Mo₁₀O₆₉ to increase the oxygen permeation rate. The oxygen selective membrane may comprise at least one of Gd₁₋ₓCaₓCoO_{3-d} and Ce₁₋ₓGdₓO_{2-d}. The oxygen selective membrane may comprise a ceramic oxide membrane such as at least one of SrFeCo_{0.5}Oₓ, SrFe_{0.2}Co_{0.5}Oₓ, Ba_{0.5}Sr_{0.5}Co_{0.8}Fe_{0.2}Oₓ, BaCo_{0.4}Fe_{0.4}Zr_{0.2}Oₓ, La_{0.6}Sr_{0.4}.CoOₓ, and Sr_{0.5}La_{0.5}Fe_{0.8}Ga_{0.2}Oₓ.

The EM pump or components such as at least one of the EM pump assembly 5kk, the EM pump 5ka, the EM pump tube 5k6, the inlet riser 5qa, and the injection EM pump tube 5k61 may comprise a material or coating that is stable to the oxygen such as a ceramic such as at least one of Al₂O₃, ZrC, ZrC—ZrB₂, ZrC—ZrB₂—SiC, and ZrB₂ with 20% SiC composite or at least one noble metal such as at least one of platinum (Pt), palladium (Pd), ruthenium (Ru), rhodium (Rh), and iridium (Ir).

In an embodiment shown in FIGS. 2I174-2I181, at least one of the EM pump assembly 5kk, the EM pump 5ka, the EM pump tube 5k6, the inlet riser 5qa, and the injection EM pump tube 5k61 may comprise a ceramic that is resistant to oxidation. The ceramic may be non-reactive with O₂. The ceramic may comprise an electrical conductor that is stable to reaction with oxygen to elevated temperature. Exemplary ceramics are ZrC, ZrB₂, ZrC—ZrB₂, ZrC—ZrB₂—SiC, and ZrB₂ with 20% SiC composite. The conductive ceramic may be doped with SiC to provide protection from oxidation.

Iridium (M.P.=2446° C.) does not form an alloy or solid solution with silver; thus, iridium may serve as a suitable anti-oxidation coating of at least one of the EM pump assembly 5kk and EM pump tube 5k6 to avoid oxidation. The iridium coating may be applied to a metal of about matching coefficient of thermal expansion (CTE). In an exemplary embodiment, the inside of the EM pump assembly 5kk and EM pump tube 5k6 are electroplated with iridium wherein the electroplated components comprise stainless steel (SS) such as Haynes 230, 310 SS, or 625 SS that has a similar CTE as iridium. Alternatively, a molybdenum EM pump assembly 5kk may be coated with iridium wherein there is a CTE match (e.g. ˜7 ppm/K). In an embodiment, the interior of the EM pump tube is electroplated using the tube as the cathode, and the counter electrode may comprise a wire with insulating spacers that is periodically moved on the counter electrode to electroplate areas covered by the spacers. In an embodiment, the iridium coating may be applied by vapor deposition such a method comprising the chemical deposition of an organic molecule comprising iridium such as thermal decomposition of tetrairidium dodecacarbonyl to cause the iridium to deposit on the desired surface maintained at an elevated temperature. Iridium may be deposited by one or more methods known in the art such as at least one of magnetron sputtering (both direct current magnetron sputtering (DCMS) and radio frequency magnetron sputtering (RFMS)), chemical vapor deposition (CVD), metal-organic CVD (MOCVD), atomic layer deposition (ALD), physical vapor deposition (PVD), laser-induced chemical vapor deposition (LCVD), electrodeposition, pulsed laser deposition (PLD), and double glow plasma (DGP). In an embodiment, the inside of the EM pump 5k6 tube may be clad with iridium. The ends of the cladding may be coated with iridium by a means of the disclosure such as CVD or electroplating.

In another embodiment, the EM pump assembly such as a stainless steel EM pump assembly may be coated with a refractory, oxidation resistant coating such as at least one of an oxide and a carbide. The coating may comprise at least one of a carbide such as hafnium carbide/silicon carbide (HfC/SiC) and an oxide such as at least one of HfO₂, ZrO₂, Y₂O₃, Al₂O₃, SiO₂, Ta₂O₅, and TiO₂.

In another embodiment, the EM pump tube 5k6 comprises an oxidation-resistant stainless steel (SS) such as that used in the water wall of coal fireboxes and boiler tubes such as austenitic stainless steels. Exemplary materials are Haynes 230, SS 310, and SS 625, an austenitic nickel- chromium-molybdenum-niobium alloy possessing a rare combination of outstanding corrosion resistance coupled with high strength from cryogenic temperatures to 1800° F. (982° C.). In an embodiment, the material such as Haynes 230, SS 310, or SS 625 may be pre-oxidized to form a protective oxide coat. The protective oxide coat may be formed by heating in an atmosphere comprising oxygen. The SS such as Haynes 230 may be pre-oxidized in air or a controlled atmosphere such as one comprising oxygen and a noble gas such as argon. In exemplary embodiments, the Haynes 230 such as Ni-Cr alloy with W and Mo alloy is pre-oxidized in air at 1000° C. or in argon 80%/oxygen 20% for 24 hours. The oxide coat may be formed under the desired operating temperature and oxygen concentration. In an embodiment, metal parts such as those comprising SS 625 such as the EM pump assembly 5kk may be 3D printed. In an embodiment, the outside of the EM pump assembly may be protected from oxidation. The protection may comprise a coating with an oxidation resistant coating such as one of the disclosure. Alternatively, at least a portion of the EM pump assembly 5kk may be embedded in an oxidation resistant material such as ceramic, quartz, glass, and cement. The oxidation-protected part may be operated in air. In an embodiment, the molten metal such as silver may comprise an additive that may prevent or reduce the oxidation of the interior of the EM pump tube. The additive may comprise a reducing agent such as thiosulfate or an oxidation product of the EM pump tube such that further oxidation is inhibited by stabilization of a protective oxide of the tube wall. Alternatively, the molten metal additive may comprise a base that stabilizes the protective metal oxide on the wall of the pump tube.

In an embodiment, the EM pump assembly may comprise a plurality of ceramics such as conductive and non-conductive ceramics. In an exemplary embodiment, the EM assembly 5kk except the EM pump bus bars 5k2 may comprise a non-conductive ceramic such as an oxide such as Al₂O₃, zirconia, or hafnia, and the EM pump bus bars 5k2 may comprise a conductive ceramic such as ZrC, ZrB₂, or a composite such as ZrC—ZrB₂—SiC. The reservoirs 5c may comprise the same non-conductive ceramic as the EM pump assembly 5kk. In an embodiment, the ceramic EM pump may comprise at least one brazed or metallized ceramic part to form a union between parts.

The electromagnetic pumps may each comprise one of two main types of electromagnetic pumps for liquid metals: an AC or DC conduction pump in which an AC or DC magnetic field is established across a tube containing liquid metal, and an AC or DC current is fed to the liquid through electrodes connected to the tube walls, respectively; and induction pumps, in which a travelling field induces the required current, as in an induction motor wherein the current may be crossed with an applied AC electromagnetic field. The induction pump may comprise three main forms: annular linear, flat linear, and spiral. The pumps may comprise others know in the art such as mechanical and thermoelectric pumps. The mechanical pump may comprise a centrifugal pump with a motor driven impeller.

The molten metal pump may comprise a moving magnet pump (MMP) such as that described in M. G. Hvasta, W. K. Nollet, M. H. Anderson” Designing moving magnet pumps for high-temperature, liquid-metal systems”, Nuclear Engineering and Design, Volume 327, (2018), pp. 228-237 which is incorporated in its entirety by reference. The WIMP may MMP's generate a travelling magnetic field with at least one of a spinning array of permanent magnets and polyphase field coils. In an embodiment, the WIMP may comprise a multistage pump such as a two-stage pump for MHD recirculation and ignition injection. A two-stage MMP pump may comprise a motor such as an electric motor that turns a shaft. The two-stage MMP may further comprise two drums each comprising a set of circumferentially mounted magnets of alternating polarity fixed over the surface of each drum and a ceramic vessel having a U-shaped portion housing the drum wherein each drum may be rotated by the shaft to cause a flow of molten metal in the ceramic vessel. In another MMP embodiment, the drum of alternating magnets is replaced by two discs of alternating polarity magnets on each disc surface on opposite sites of a sandwiched strip ceramic vessel containing the molten metal that is pumped by rotation of the discs. In another embodiment, the vessel may comprise a magnetic field permeable material such as a non-ferrous metal such as stainless steel or ceramic such as one of the disclosure. The magnets may be cooled by means such as air-cooling or water-cooling to permit operation at elevated temperature.

An exemplary commercial AC EM pump is the CMI Novacast CA15 wherein the heating and cooling systems may be modified to support pumping molten silver. The heater of the EM pump tube comprising the inlet and outlet sections and the vessel containing the silver may be heated by a heater of the disclosure such as a resistive or inductively coupled heater. The heater such as a resistive or inductively coupled heater may be external to the EM pump tube and further comprise a heat transfer means to transfer heat from the heater to the EM pump tube such as a heat pipe. The heat pipe may operate at high temperature such as one with a lithium working fluid. The electromagnets of the EM pump may be cooled by systems of the disclosure such as by water-cooling loops and chiller.

In an embodiment (FIGS. 2I184-2I185), the EM pump 400 may comprise an AC, inductive type wherein the Lorentz force on the silver is produced by a time-varying electric current through the silver and a crossed synchronized time-varying magnetic field. The time-varying electric current through the silver may be created by Faraday induction of a first time-varying magnetic field produced by an EM pump transformer winding circuit 401a. The source of the first time-varying magnetic field may comprise a primary transformer winding 401, and the silver may serve as a secondary transformer winding such as a single turn shorted winding comprising an EM pump tube section of a current loop 405 and a EM pump current loop return section 406. The primary winding 401 may comprise an AC electromagnet wherein the first time-varying magnetic field is conducted through the circumferential loop of silver 405 and 406, the induction current loop, by a magnetic circuit or EM pump transformer yoke 402. The silver may be contained in a vessel such as a ceramic vessel 405 and 406 such as one comprising a ceramic of the disclosure such as silicon nitride (MP 1900° C.), quartz, alumina, zirconia, magnesia, or hafnia. A protective SiO₂ layer may be formed on silicon nitrite by controlled passive oxidation. The vessel may comprise channels 405 and 406 that enclose the magnetic circuit or EM pump transformer yoke 402. The vessel may comprise a flattened section 405 to cause the induced current to have a component of flow in a perpendicular direction to the synchronized time-varying magnetic field and the desired direction of pump flow according to the corresponding Lorentz force. The crossed synchronized time-varying magnetic field may be created by an EM pump electromagnetic circuit 403c comprising AC electromagnets 403 and EM pump electromagnetic yoke 404. The magnetic yoke 404 may have a gap at the flattened section of the vessel 405 containing the silver. The electromagnet 401 of the EM pump transformer winding circuit 401a and the electromagnet 403 of the EM pump electromagnetic circuit 403c may be powered by a single-phase AC power source or other suitable power source known in the art. The magnet may be located close to the loop bend such that the desired current vector component is present. The phase of the AC current powering the transformer winding 401 and electromagnet winding 403 may be synchronized to maintain the desired direction of the Lorentz pumping force.

In an embodiment (FIGS. 2I184-2I185), the induction current loop may comprise the inlet EM pump tube 5k6, the EM pump tube section of the current loop 405, the outlet EM pump tube 5k6, and the path through the silver in the reservoir 5c that may comprise the walls of the inlet riser 5qa and the injector 561 in embodiments that comprise these components. The EM pump may comprise monitoring and control systems such as ones for the current and voltage of the primary winding and feedback control of SunCell power production with pumping parameters. Exemplary measured feedback parameters may be temperature at the reaction cell chamber 5b31 and electricity at MHD converter. The monitoring and control system may comprise corresponding sensors, controllers, and a computer.

In an MHD converter embodiment having only one pair of electromagnetic pumps 400, each MHD return conduit 310 is extended and connects to the inlet of the corresponding electromagnetic pump 5kk. The connection may comprise a union such as a Y-union having an input of MHD return conduit 310 and the bosses 308 of the base of the reservoir such as those of the reservoir baseplate assembly 409. In an embodiment comprising a pressurized SunCell® having an MHD converter, the injection side of the EM pumps, the reservoirs, and the reaction cell chamber 5b31 operate under high pressure relative to the MHD return conduit 310. The inlet to each EM pump may comprise only the MHD return conduit 310. The connection may comprise a union such as a Y-union having an input of MHD return conduit 310 and the boss of the base of the reservoir wherein the pump power prevents back flow from the inlet flow from the reservoir to the MHD return conduit 310.

In an MHD power generator embodiment, the injection EM pumps and the MHD return EM pump may comprise any of the disclosure such as DC or AC conduction pumps and AC induction pumps. In an exemplary MHD power generator embodiment (FIG. 2I184), the injection EM pumps may comprise an induction EM pump 400, and the MHD return EM pump 312 may comprise an induction EM pump or a DC conduction EM pump. In another embodiment, the injection pump may further serve as the MHD return EM pump. The MHD return conduit 310 may input to the EM pump at a lower pressure position than the inlet from the reservoir. The inlet from MHD return conduit 310 may enter the EM pump at a position suitable for the low pressure in the MHD condensation section 309 and the MHD return conduit 310. The inlet from the reservoir 5c may enter at a position of the EM pump tube where the pressure is higher such as at a position wherein the pressure is the desired reaction cell chamber 5b31 operating pressure. The EM pump pressure at the injector section 5k61 may be at least that of the desired reaction cell chamber pressure. The inlets may attach to the EM pump at tube and current loop sections 5k6, 405, or 406.

The EM pump may comprise a multistage pump (FIGS. 2I186-2I195). The multistage EM pump may receive the input metal flows such as that from the MHD return conduit 310 and that from the base of the reservoir 5c at different pump stages that each correspond to a pressure that permits essentially only forward molten metal flow out the EM pump outlet and injector 5k61. In an embodiment, the multistage EM pump assembly 400a (FIG. 2I188) comprises at least one EM pump transformer winding circuit 401a comprising a transformer winding 401 and transformer yoke 402 through an induction current loop 405 and 406 and further comprises at least one AC EM pump electromagnetic circuit 403c comprising an AC electromagnet 403 and an EM pump electromagnetic yoke 404. The induction current loop may comprise an EM pump tube section 405 and an EM pump current loop return section 406. The electromagnetic yoke 404 may have a gap at the flattened section of the vessel or EM pump tube section of a current loop 405 containing the pumped molten metal such as silver.

In an embodiment, the multistage EM pump may comprise a plurality of AC EM pump electromagnetic circuits 403c that supply magnetic flux perpendicular to both the current and metal flow. The multistage EM pump may receive inlets along the EM pump tube section of a current loop 405 at locations wherein the inlet pressure is suitable for the local pump pressure to achieve forward pump flow wherein the pressure increases at the next AC EM pump electromagnetic circuit 403c stage. In an exemplary embodiment, the MHD return conduit 310 enters the current loop such the EM pump tube section of a current loop 405 at an inlet before a first AC electromagnet circuit 403c comprising AC electromagnets 403a and EM pump electromagnetic yoke 404a. The inlet flow from the reservoir 5c may enter after the first and before a second AC electromagnet circuit 403c comprising AC electromagnets 403b and EM pump electromagnetic yoke 404b wherein the pumps maintain a molten metal pressure in the current loop 405 that maintains a desired flow from each inlet to the next pump stage or to the pump outlet and the injector 5k61. The pressure of each pump stage may be controlled by controlling the current of the corresponding AC electromagnet of the AC electromagnet circuit.

In an embodiment, the EM pump current loop return section 406 such as a ceramic channel may comprise a molten metal flow restrictor or may be filled with a solid electrical conductor such that the current of the current loop is complete while preventing molten metal back flow from a higher pressure to a lower pressure section of the EM pump tube. The solid may comprise a metal such as a stainless steel of the disclosure such as Haynes 230, Pyromet® alloy 625, Carpenter L-605 alloy, BioDur® Carpenter CCM® alloy, Haynes 230, 310 SS, or 625 SS. The solid may comprise a refractory metal. The solid may comprise a metal that is oxidation resistant. The solid may comprise a metal or conductive cap layer or coating such as iridium to avoid oxidation of the solid conductor.

In an embodiment, the magnetic windings of at least one of the transformers and electromagnets are distanced from the EM pump tube section of a current loop 405 containing flowing metal by extension of at least one of the transformer magnetic yoke 402 and the electromagnetic circuit yoke 404. The extensions allows for at least one of more efficient heating such as inductively coupled heating of the EM pump tube 405 and more efficient cooling of at least one of the transformer windings 401, transformer yoke 402, and the electromagnetic circuits 403c comprising AC electromagnets 403 and EM pump electromagnetic yoke 404. In the case of a two-stage EM pump, the magnetic circuits may comprise AC electromagnets 403a and 403b and EM pump electromagnetic yokes 404a and 404b. At least one of the transformer yokes 402 and electromagnetic yokes 404 may comprise a ferromagnetic material with a high Curie temperature such as iron or cobalt. At least one of the EM pump transformer winding circuits 401a and EM pump electromagnetic circuits 403c may comprise a water-cooling system such as one of the disclosure such as one of the magnets 5k4 of the DC conduction EM pump (FIGS. 2I115-2I116). At least one of the induction EM pumps 400b may comprise an air-cooling system 400b (FIGS. 2I190-2I191). At least one of the induction EM pumps 400c may comprise a water-cooling system (FIG. 2I192).

An exemplary transformer comprises a silicon steel laminated transformer core. The ignition transformer may comprise (i) a winding number in at least one range of about 10 to 10,000, 100 to 5000, and 500 to 25,000 turns; (ii) a power in at least one range of about 10 W to 1 MW, 100 W to 500 kW, 1 kW to 100 kW, and 1 kW to 20 kW, and (iii) a primary winding current in at least one range of about 0.1 A to 10,000 A, 1 A to 5 kA, 1 A to 1 kA, and 1 to 500 A. In an exemplary embodiment, the ignition current is in a voltage range of about 6 V to 10 V and the current is about 1000 A; so a winding with 50 turns operates at about 500 V and 20 A to provide an ignition current of 10 V at 1000 A. The EM pump electromagnets may comprise a flux in at least one range of about 0.01 T to 10 T, 0.1 T to 5 T, and 0.1 T to 2 T. In an exemplary embodiment, about 0.5 mm diameter magnet wire is maintained under about 200° C.

The EM pump tube may be heated with an inductively coupled heater antenna such as a pancake coil antenna. The antenna may be water-cooled. In an embodiment, the reservoirs 5c may be heated with an inductively coupled heater. The heater antenna 5f may comprise two cylindrical helices around the reservoirs 5c that may further connect to a coil such as a pancake coil to heat the EM pump tube. The turns of the opposing helices about the reservoirs may be wound such that the currents are in the same direction to reinforce the magnetic fields of the two coils or opposite directions to cancel in the space between the helices. In an exemplary embodiment, the inductively coupled heater antenna 5f may comprise a continuous set of three turnings comprising two helices circumferential to each reservoirs 5c and a pancake coil parallel to the EM pump tubes as shown in FIGS. 2I182-2I183, 2I186, and 2I190-2I192 wherein both helices are wound clockwise and the current flows from the top to bottom of one helix, flows into the pancake coil, and then flows from the bottom to the top of the second helix. The EM pump tube section of a current loop 405 may be selectively heated by at least one of flux concentrators, additives to the EM pump tube 405 material such as additives to quartz or silicon nitride, and cladding to the pump tube 405 such as carbon sleeves that increase the absorption of RF from the inductively coupled heater. In an embodiment, the EM pump tube section of a current loop 405 may be selectively heated by an inductively coupled heater antenna comprising a helix about the pump tube 405. At least one line (FIGS. 2I192-2I195) such as at least one of the MHD return conduit 310, EM pump reservoir line 416, and EM pump injection line 417 may be heated by an inductively coupled heater that may comprise an antenna 415 wrapped around the line wherein the antenna may be water-cooled. The components wrapped with the inductively coupled heater antenna such as 5f and 415 may comprise an inner layer of insulation. The inductively coupled heater antenna can serve a dual function or heating and water-cooling to maintain a desired temperature of the corresponding component. The SunCell may further comprise structural supports 418 that secure components such as the MHD magnet housing 306a, the MHD nozzle 307, and MHD channel 308, electrical output, sensor, and control lines 419 that may be mounted on the structural supports 418, and heat shielding such as 420 about the EM pump reservoir line 416, and EM pump injection line 417.

The EM pump tube section of a current loop 405 may comprise molten metal inlet and outlet channels that connect to corresponding EM pump tube 5k6 sections (FIGS. 2I185). Each inlet and outlet of the EM pump tube 5k6 may be fastened to the corresponding reservoir 5c, inlet riser 5qa, and injector 5k61. The fastener may comprise a joint, fastener, or seal of the disclosure. The seal 407a may comprise ceramic glue. The joints may each comprise a flange sealed with a gasket such as a graphite gasket. Each reservoir 5c may comprise ceramic such as a metal oxide connected to a reservoir baseplate that may be ceramic. The baseplate connection may comprise a flange and gasket seal wherein the gasket may comprise carbon. The baseplate may comprise a reservoir baseplate assembly 409 (FIG. 2I187) comprising a baseplate 409a with attached inlet riser 5qa and injector tube 5k61 having nozzle 5q. The tubes may penetrate the base of the reservoir baseplate 409a as bosses 408. The bosses 408 from the reservoir 5c may be connected to the ceramic inlet and outlet of the EM pump tube of the induction-type EM pump 400 by at least one of flanged unions 407 having fasteners such as bolts such as carbon, molybdenum, or ceramic bolts, and a gasket such as a carbon gasket wherein the union comprising at least one ceramic component is operated below the carbo-reduction temperature. In other embodiments, the unions may comprise others known in the art such as Swageloks, slip nuts, or compression fittings. In an embodiment, the ignition current is supplied by a source of electricity having its positive and negative terminals connected to conductive component of one of opposing pump tubes, reservoirs, bosses, and unions.

In another embodiment, the ignition system comprises an induction system (FIGS. 2I186, 2I189-2I195) wherein the source of electricity applied to the conductive molten metal to cause ignition of the hydrino reaction provides an induction current, voltage, and power. The ignition system may comprise an electrode-less system wherein the ignition current is applied by induction by an induction ignition transformer assembly 410. The induction current may flow through the intersecting molten metal streams from the plurality of injectors maintained by the pumps such as the EM pumps 400. In an embodiment, the reservoirs 5c may further comprise a ceramic cross connecting channel 414 such as a channel between the bases of the reservoirs 5c. The induction ignition transformer assembly 410 may comprise an induction ignition transformer winding 411 and an induction ignition transformer yoke 412 that may extend through the induction current loop formed by the reservoirs 5c, the intersecting molten metal streams from the plurality of molten metal injectors, and the cross connecting channel 414. The induction ignition transformer assembly 410 may be similar to that of the EM pump transformer winding circuit 401l a.

In an embodiment, the ignition current source may comprise an AC, inductive type wherein the current in the molten metal such as silver is produced by Faraday induction of a time-varying magnetic field through the silver. The source of the time-varying magnetic field may comprise a primary transformer winding, an induction ignition transformer winding 411, and the silver may at least partially serve as a secondary transformer winding such as a single turn shorted winding. The primary winding 411 may comprise an AC electromagnet wherein an induction ignition transformer yoke 412 conducts the time-varying magnetic field through a circumferential conducting loop comprising the molten silver. The transformer electromagnet may be powered by a single phase AC power source or other suitable power source known in the art. The transformer frequency may be increased to decrease the size of the transformer yoke 412. The transformer frequency may be in at least range of about 1 Hz to 1 MHz, 1 Hz to 100 kHz, 10 Hz to 10 kHz, and 10 Hz to 1 kHz. The reservoirs 5c may comprise a molten metal channel such as the cross connecting channel 414 that connects the two reservoirs 5c. The current loop enclosing the transformer yoke 412 may comprise the molten silver contained in the reservoirs 5c, the cross connecting channel 414, the silver in the injector tube 5k61, and the injected streams of molten silver that intersect to complete the induction current loop. The induction current loop may further at least partially comprise the molten silver contained in at least one of the EM pump components such as the inlet riser 5qa, the EM pump tube 5k6, the bosses, and the injector 5k61.

The cross connecting channel 414 may be at the desired level of the molten metal such as silver in the reservoirs. Alternatively, the cross connecting channel 414 may be at a position lower than the desired reservoir molten metal level such that the channel is continuously filled with molten metal during operation. The cross connecting channel 414 may be located towards the base of the reservoirs 5c. The channel may form part of the induction current loop or circuit and further facilitate molten metal flow from one reservoir with a higher silver level to the other with a lower level to maintain the desired levels in both reservoirs 5c. A differential in molten metal head pressure may cause the metal flow between reservoirs to maintain the desired level in each. The current loop may comprise the intersecting molten metal streams, the injector tubes 5k61, a column of molten metal in the reservoirs 5c, and the cross connecting channel 414 that connects the reservoirs 5c at the desired molten silver level or one that is lower than the desired level. The current loop may enclose the transformer yoke 412 that generates the current by Faraday induction. In another embodiment, at least one EM pump transformer yoke 402 may further comprise the induction ignition transformer yoke 412 to generate the induction ignition current by additionally supplying the time-varying magnetic field through an ignition molten metal loop such as the one formed by the intersecting molten metal streams and the molten metal contained in the reservoirs and the cross connecting channel 414. The reservoirs 5c and the channel 414 may comprise an electrical insulator such as a ceramic. The induction ignition transformer yoke 412 may comprise a cover 413 that may comprise at least one of an electrical insulator and a thermal insulator such as a ceramic cover. The section of the induction ignition transformer yoke 412 that extends between the reservoirs that may comprise circumferentially wrapped inductively coupled heater antennas such as helical coils may be thermally or electrically shielded by the cover 413. The ceramic of at least one of the reservoirs 5c, the channel 414, and the cover 413 may be one of the disclosure such as silicon nitride (MP 1900° C.), quartz such as fused quartz, alumina, zirconia, magnesia, or hafnia. A protective SiO₂ layer may be formed on silicon nitrite by controlled passive oxidation.

The ceramic parts such as quartz parts may be cast using a mold such as graphite or other refractory inert mold. In an exemplary embodiment, the mold to cast quartz by hot or cold liquid methods known in the art such as that of Hellma Analytics (http://www.hellma-analytics.com/assets/adb/32/32e6a909951dc0e2.pdf) comprises four parts comprising two mirror pairs of inner and outer surfaces of the cell components such as the reservoirs 5c and reaction cell chamber 5b31.

In an embodiment, the cross-connecting channel 414 maintains the reservoir silver levels near constant. The SunCell® may further comprise submerged nozzles 5q of the injector 5k61. The depth of each submerged nozzle and therefore the head pressure through which the injector injects may remain essentially constant due to the about constant molten metal level of each reservoir 5c. In an embodiment comprising the cross-connecting channel 414, inlet riser 5qa may be removed and replaced with a port into the reservoir boss 408 or EM pump reservoir line 416.

At least one of the transformer windings 401 and 411, electromagnets 403, yokes 402, 404, and 412, and magnetic circuits 401a, 403a, and 410 of at least one of the EM pumps and the ignition system may be shielded from the RF magnetic field of the inductively coupled heater to reduce the heating effect. The shield may comprise a Faraday cage. The cage wall thickness may be greater than the skin depth of the RF field of the inductively coupled heater. In an embodiment comprising an induction ignition system 410, the transformer yoke 412 may be at least partially cooled by proximity of the water-cooled antenna 5f that may further serve to cool at least one of the SunCell® and reservoirs 5c during operation.

The ignition current may be time varying such as about 60 Hz AC, but may have other characteristics and waveforms such as a waveform having a frequency in at least one range of 1 Hz to 1 MHz, 10 Hz to 10 kHz, 10 Hz to 1 kHz, and 10 Hz to 100 Hz, a peak current in at least one range of about 1 A to 100 MA, 10 A to 10 MA, 100 A to 1 MA, 100 A to 100 kA, and 1 kA to 100 kA, and a peak voltage in at least one range of about 1 V to 1 MV, 2 V to 100 kV, 3 V to 10 kV, 3 V to 1 kV, 2 V to 100 V, and 3 V to 30 V wherein the waveform may comprise a sinusoid, a square wave, a triangle, or other desired waveform that may comprise a duty cycle such as one in at least one range of 1% to 99%, 5% to 75%, and 10% to 50%.

In an embodiment, the ignition frequency is adjusted to cause a corresponding frequency of hydrino power generation in a least one of the reaction cell chamber 5b31 and the MHD channel 308. The frequency of the power output such as about 60 Hz AC may be controlled by controlling the ignition frequency. The ignition frequency can be adjusted by varying the frequency of the time-varying magnetic field of the induction ignition transformer assembly 410. The frequency of the induction ignition transformer assembly 410 may be adjusted by varying the frequency of the current of the induction ignition transformer winding 411 wherein the frequency of the power to the winding 411 may be varied. The time-varying power in the MHD channel 308 may prevent shock formation of the aerosol jet flow. In another embodiment, the time-varying ignition may drive a time-varying hydrino power generation that results in a time-varying electrical power output. The MHD converter may output AC electricity that may also comprise a DC component. The AC component may be used to power at least one winding such as at least one of one or more of the transformer and the electromagnet windings such as at least one of the winidng of the EM pump transformer winding circuit 401a and the winding of the electromagnets of the EM pump electromagnetic circuit 403c.

The pressurized SunCell® having an MHD converter may operate without a dependency on gravity. The EM pumps such as 400 such as two-staged air-cooled EM pumps 400b may be located in a position to optimize at least one of the packing and the minimization of the molten metal inlet and outlet conduits or lines. An exemplary packaging is one wherein the EM pumps are located midway between the end of the MHD condensation section 309 and the base of the reservoirs 5c (FIGS. 2I193-2I195).

In an embodiment, the silver vapor-silver aerosol mixture that exits the MHD nozzle 307 and enters the MHD channel 308 comprises a majority liquid fraction. To achieve the majority liquid fraction at the MHD channel 308 inlet, the mixture may comprise a majority liquid at the entrance to the MHD nozzle 307. The thermal power of the reaction cell chamber 5b31 generated by the hydrino reaction may be majority converted to kinetic energy by the MHD nozzle 307. In an embodiment to achieve the condition that the majority of energy inventory at the exit of the MHD nozzle 307 is kinetic energy, the mixture must be a majority liquid fraction, and the temperature and pressure of the mixture should approach that of the molten metal at its melting point. To convert a larger fraction of the thermal energy inventory of the mixture into kinetic energy, the nozzle area of the diverging section of a converging-diverging MHD nozzle 307 such as a de Laval nozzle must increase. As the thermal energy of the mixture is converted to kinetic energy in the MHD nozzle 307, the temperature of the mixture drops with a concomitant pressure drop. The low-pressure condition corresponds to a low vapor density. The low vapor density decreases the cross section to transfer forward momentum and kinetic energy to the liquid fraction of the mixture. In an embodiment, the nozzle length may be increased to create a longer liquid acceleration time before nozzle exit. In an embodiment, the cross sectional area of the aerosol jet at the MHD nozzle exit may be decreased. The area decrease may be achieved by one or more of at least one focusing magnet, baffles, and other means known in the art. The focused aerosol jet having a decreased area may permit the MHD channel 308 cross sectional area to be smaller. The MHD channel power density may be higher. The MHD magnets 306 may be smaller due to smaller volume of the magnetized channel 308.

In an embodiment, the temperature of the mixture at the entrance of the MHD channel 308 is close to the melting point of the molten metal. In the case of silver, the mixture temperature may be in at least one range of about 965° C. to 2265° C., 1000° C. to 2000° C., 1000° C. to 1900° C., and 1000° C. to 1800° C. In an embodiment, the silver liquid may be recirculated to the reservoirs 5c by the EM pumps 400, 400a, 400b, or 400c to recover at least a portion of the thermal energy in the liquid.

In an embodiment comprising unions comprising ceramic parts and carbon gaskets, the temperature of the recirculated silver may be below at least one of the carbo-reduction temperature of graphite with the ceramic and the failure temperature of the materials of the SunCell® components such as ceramic components. In an exemplary embodiment comprising yttria-stabilized-zirconia parts such as return conduits 310, EM pump tube section of the current loop 405, reservoirs 5c, reaction cell chamber 5b31, MHD nozzle 307, MHD channel 308, and MHD condensation section 309 having at least one carbon-gasketed flange union 407 between ceramic components, the silver temperature is lower than about 1800° C. to 2000° C. The power of the aerosol comprising kinetic energy and thermal energy may be converted to electricity in the MHD channel. The aerosol kinetic energy may be converted to electricity by a liquid MHD mechanism. Some residual thermal power such as that of any vapor of the mixture in the MHD channel 308 may be converted to electricity by the Lorentz force acting on the corresponding vapor. The conversion of thermal energy causes a drop in mixture temperature. The silver vapor pressure may be low corresponding to the low mixture temperature. The MHD channel 308 may be maintained at a low background pressure such as a pressure in at least one range of about 0.001 Torr to 760 Torr, 0.01 Torr to 100 Torr, 0.1 Torr to 10 Torr to prevent the aerosol jet from the nozzle 307 from undergoing shock such as condensation shock or turbulent flow whereby the aerosol creates increased pressure such as back pressure in the MHD channel 308.

In an embodiment, the vapor fraction of the mixture is minimized at the nozzle inlet to reduce it at the nozzle outlet. The vapor fraction may be in at least one range of about 0.01 to 0.3, 0.05 to 0.25, 0.05 to 0.20, 0.05 to 0.15, and 0.05 to 0.1. Given nozzle exemplary inlet parameters of 20 atm pressure, 0 m/s velocity, 3253 K temperature, 0.9 liquid mass fraction of the mixture, sonic velocity 137 m/s, Mach number 0, and 0 kJ/kg kinetic energy, exemplary parameters of the mixture at the nozzle outlet are about those given in TABLE 3.

TABLE 3
Nozzle Outlet Parameters for Initial Inlet Parameters of Pressure
of 20 atm, Liquid Fraction of 0.9, and Mass Flow of 1 kg/s.

| | Pressure [atm] | | | | | |
|---|---|---|---|---|---|---|
| Parameter | 20 | Throat | 1 | 0.1 | 0.01 | 0.001 |
| Velocity (m/s) | 0 | 149 | 412 | 548 | 647 | 727 |
| Temperature (K) | 3253 | 3108 | 2480 | 2104 | 1830 | 1613 |
| Liquid Mass Fraction | 0.9 | 0.887 | 0.847 | 0.836 | 0.832 | 0.833 |
| Kinetic Energy (kJ/kg) | 0 | 11.2 | 84.7 | 150 | 209 | 264 |
| Sonic Velocity (m/s) | 137 | 149 | 174 | 168 | 159 | 155 |
| Mach Number | 0 | 1 | 2.37 | 3.26 | 4.06 | 4.71 |
| Nozzle Radius (cm) | | 0.656 | 1.50 | 3.94 | 10.9 | 31.7 |
| Liquid Volume Fraction (ppm) | 9717 | 5450 | 340 | 35.6 | 3.80 | 0.397 |

In an embodiment, the vapor may be at least partially condensed at the end of the MHD channel such as in the MHD condensation section 309. The heat exchanger 316 may remove heat to cause the condensation. Alternatively, the vapor pressure may be sufficiently low that the MHD efficiency is increased by not condensing the vapor wherein the vapor maintains a static equilibrium pressure in the MHD channel 308. In an embodiment, the Lorentz force is greater than the collision frictional force of any uncondensed vapor in the MHD channel 308. The Lorentz force may be increased to that desired by increasing the magnetic field strength. The magnetic flux of the MHD magnets 306 may be increased. In an embodiment, the magnetic flux may be in at least one range of about 0.01 T to 15 T, 0.05 T to 10 T, 0.1 T to 5 T, 0.1 T to 2 T, and 0.1 T to 1 T. In an embodiment, the silver vapor is condensed such that the heat of vaporization heats the silver that is recycled to the reservoirs or the EM pump tube of a two-stage EM pump wherein the output is the injector 5k61. The vapor may be compressed with compressor 312a. The compressor may be connected to a two-stage EM pump such as 400c.

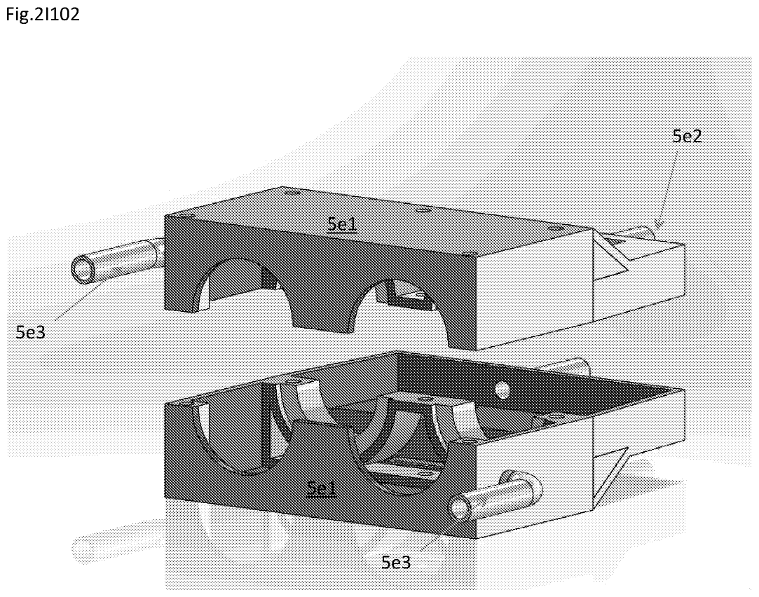

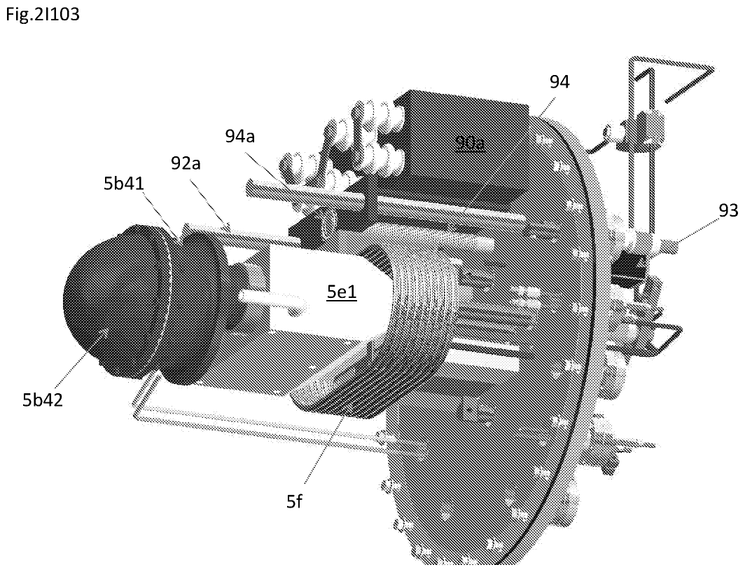

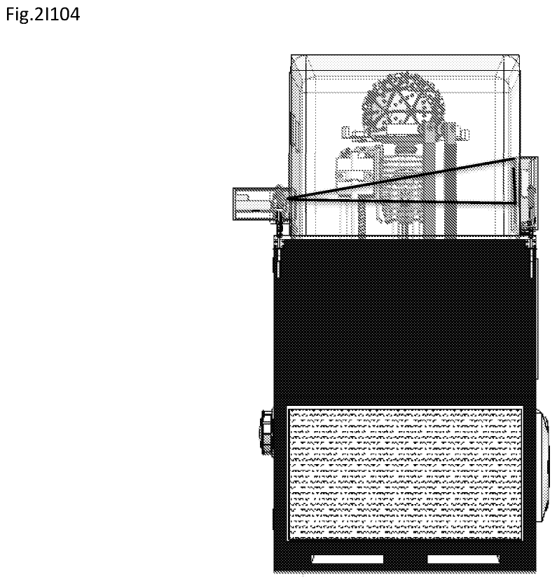

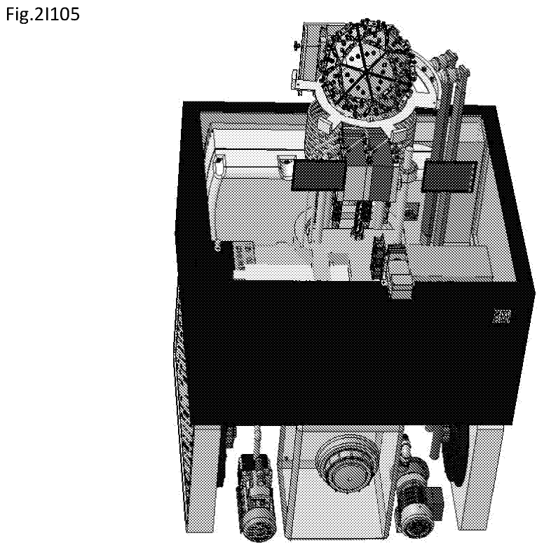

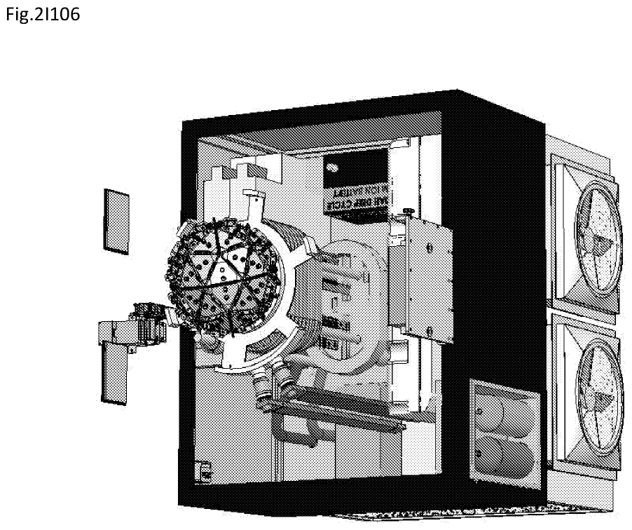

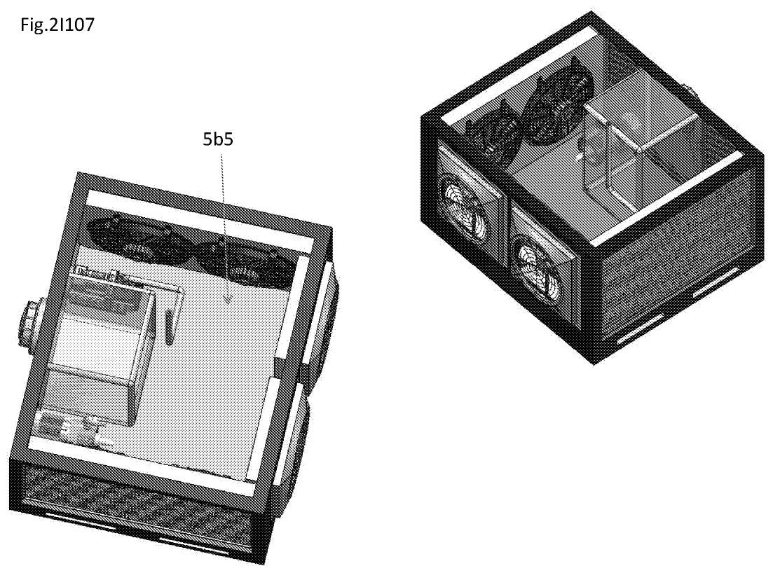

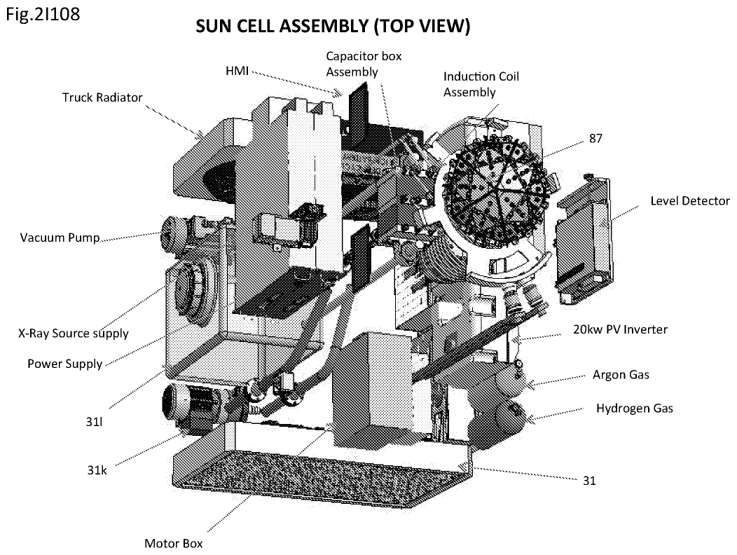

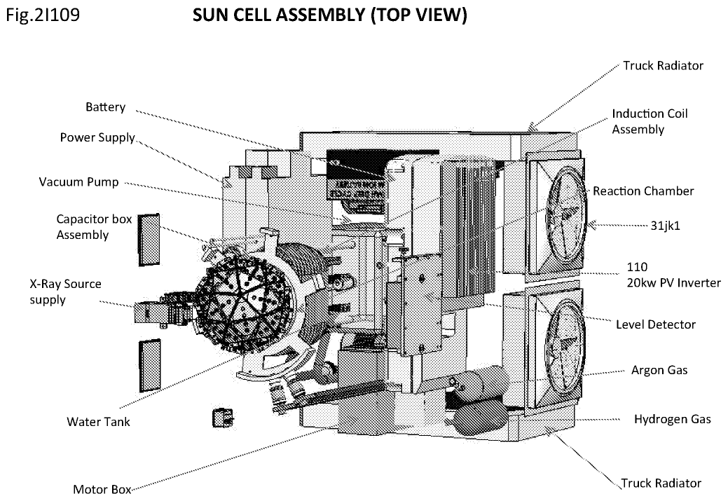

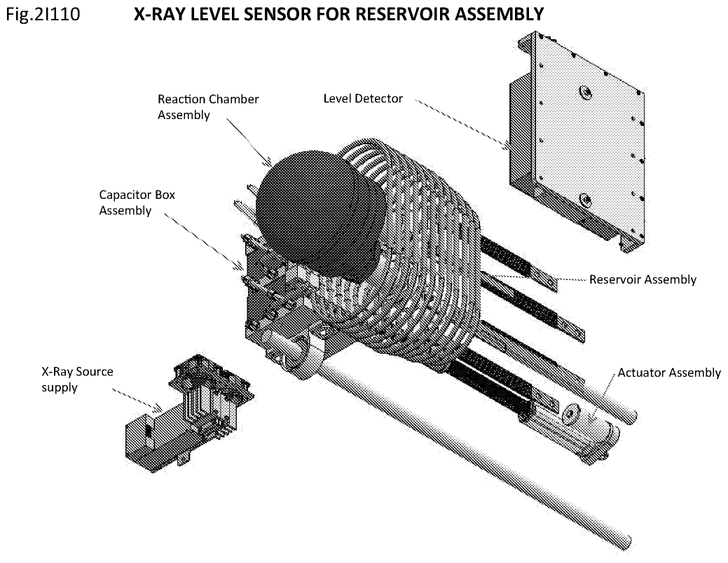

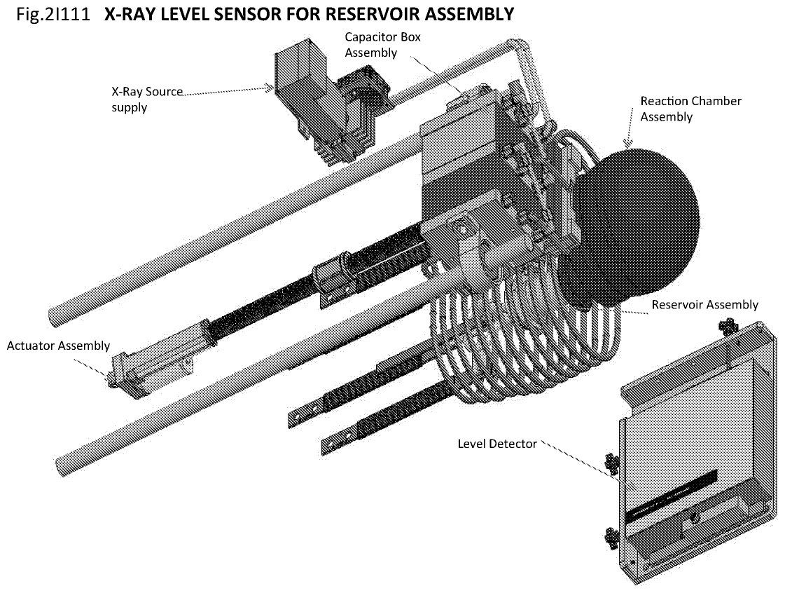

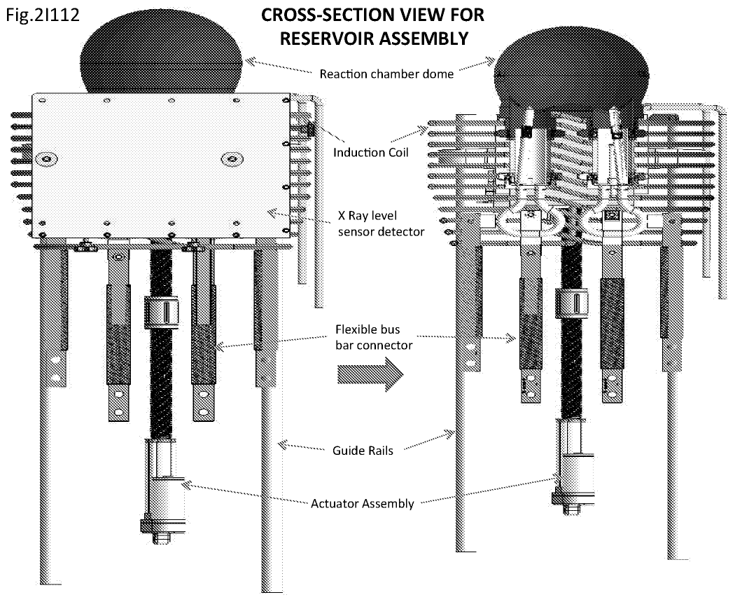

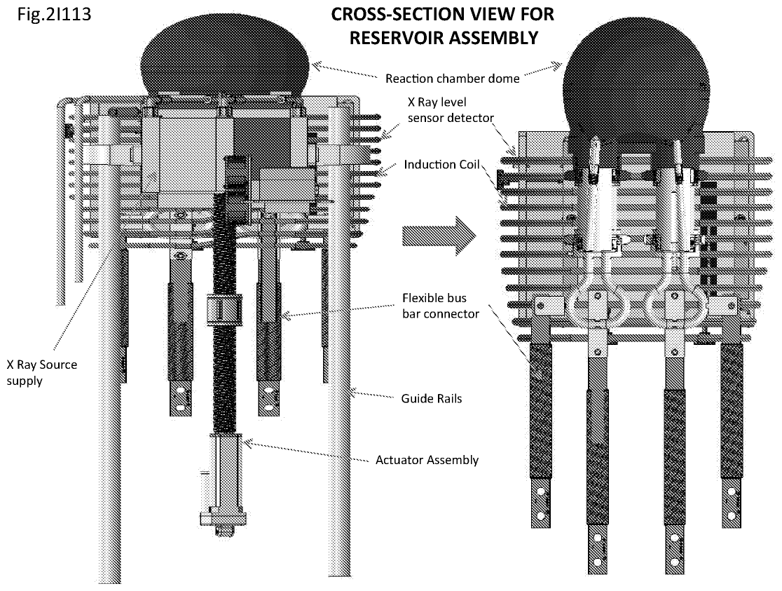

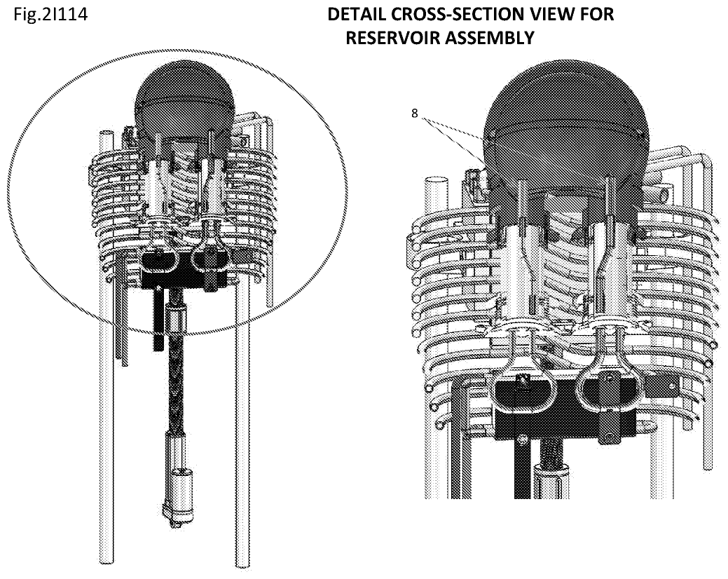

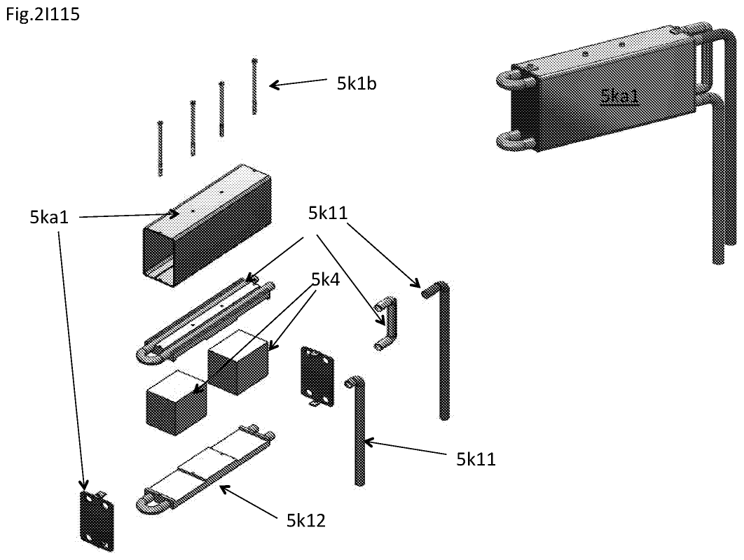

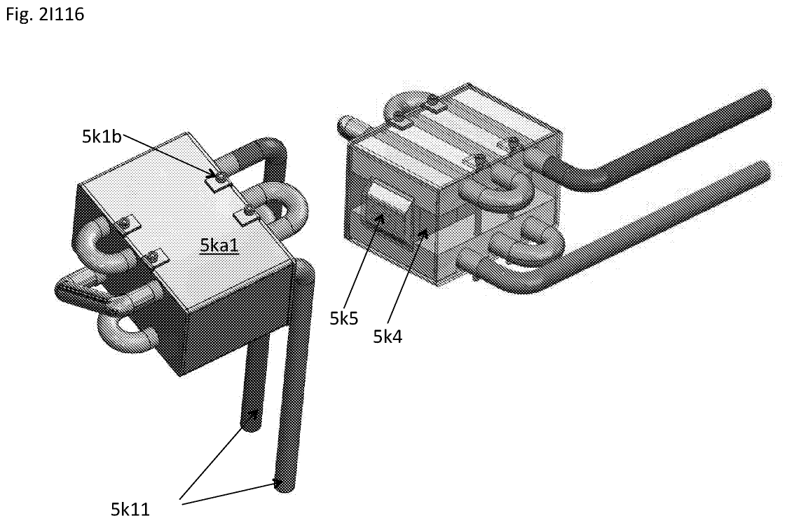

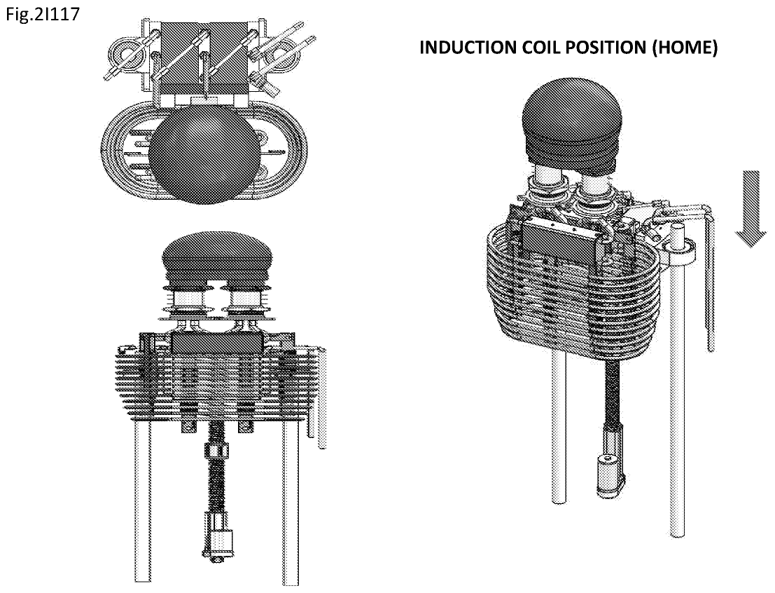

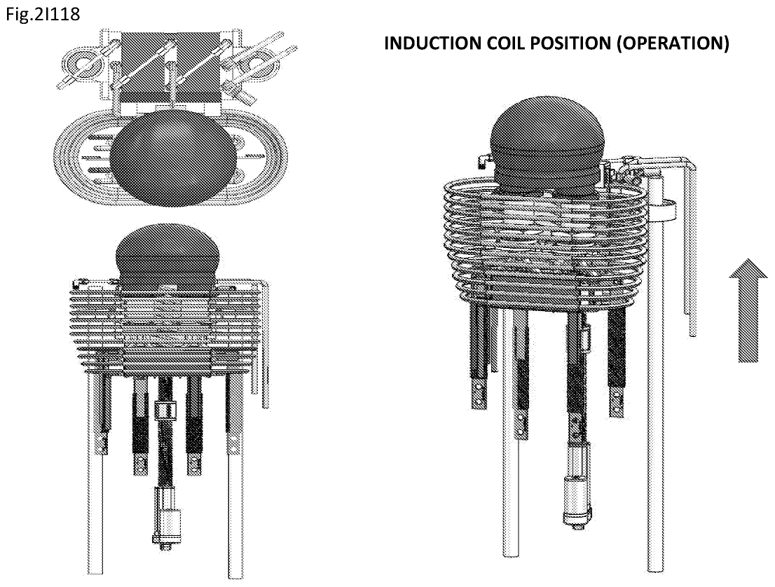

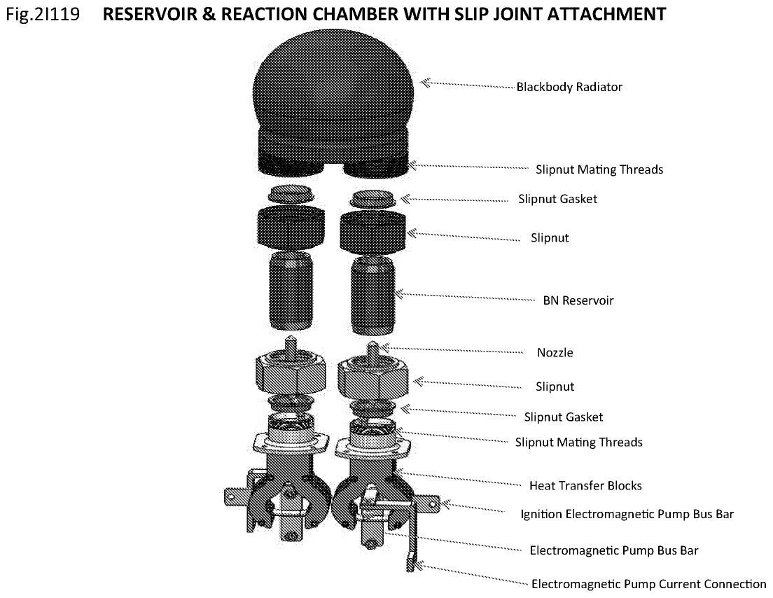

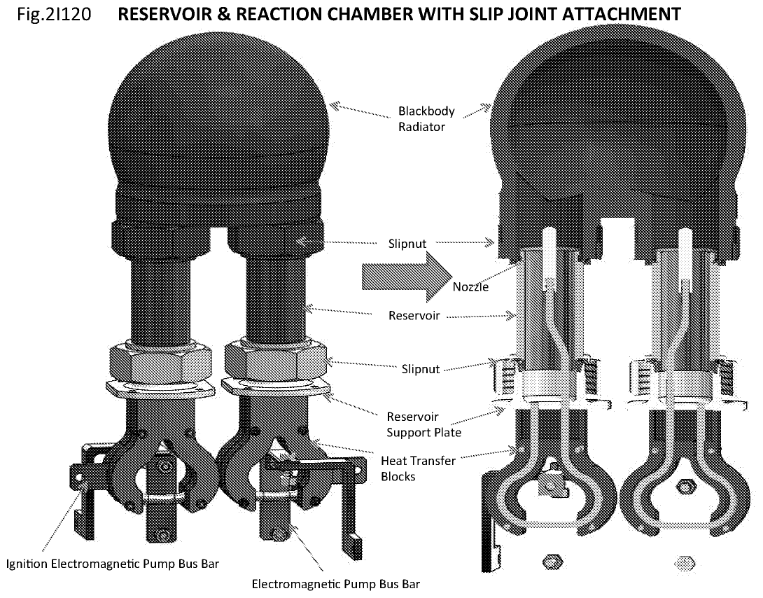

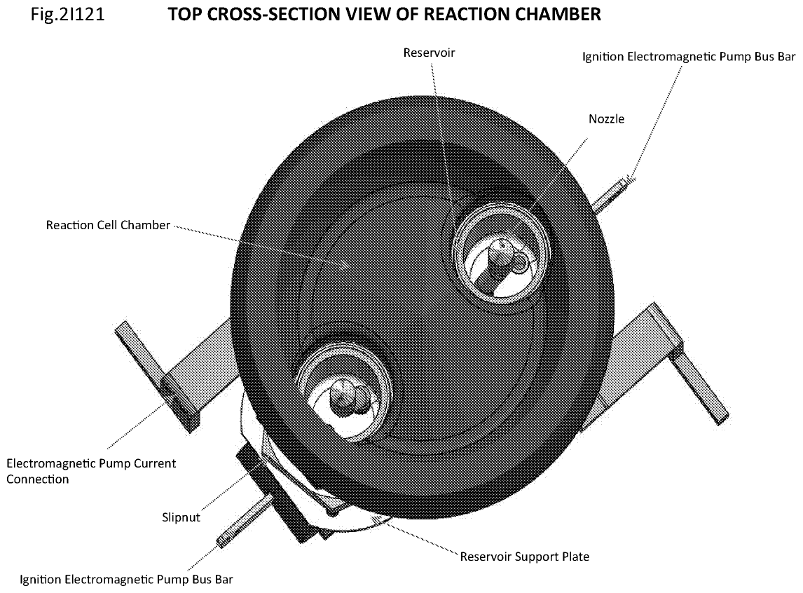

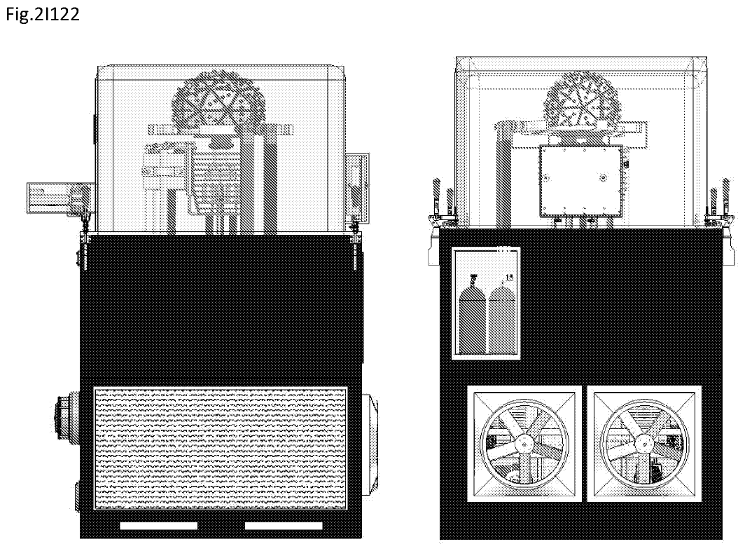

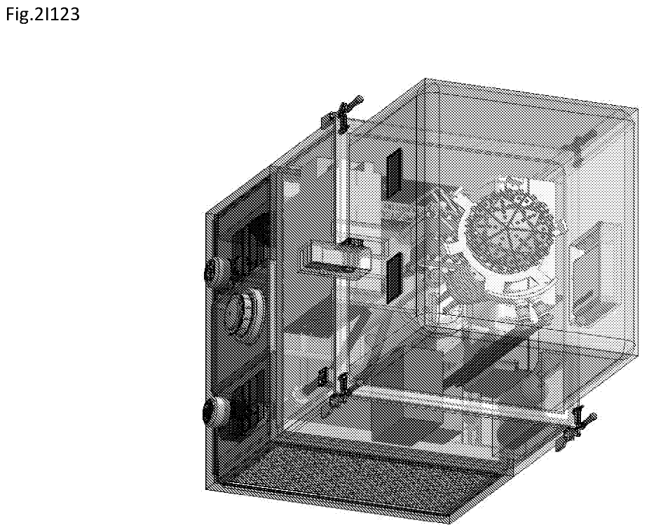

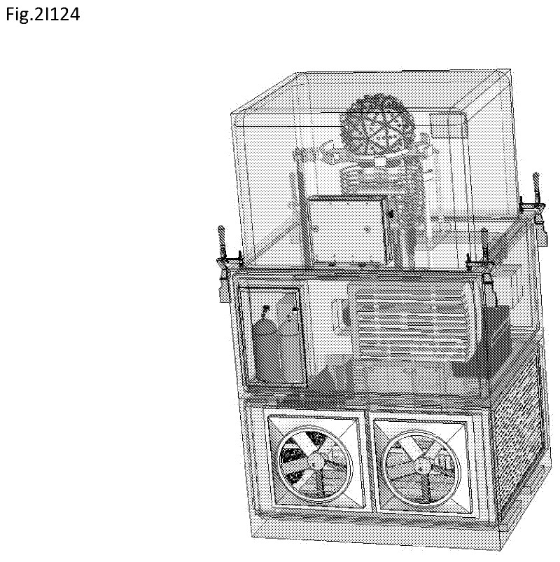

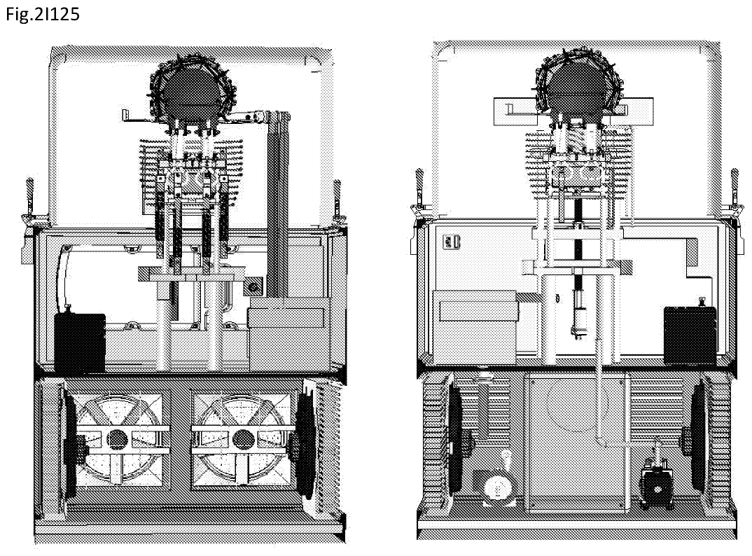

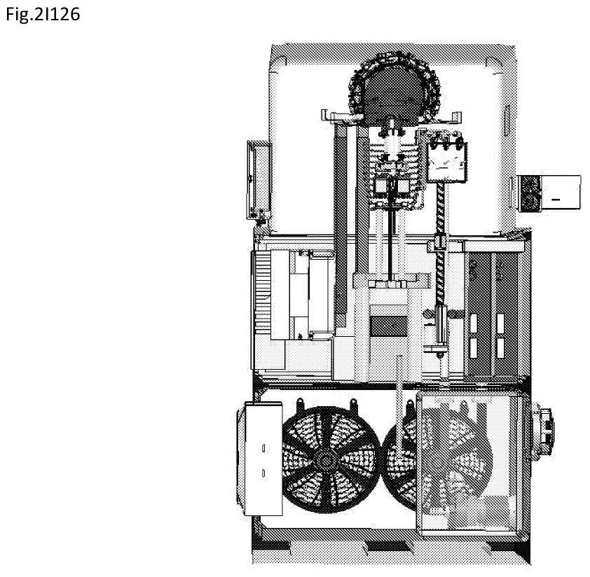

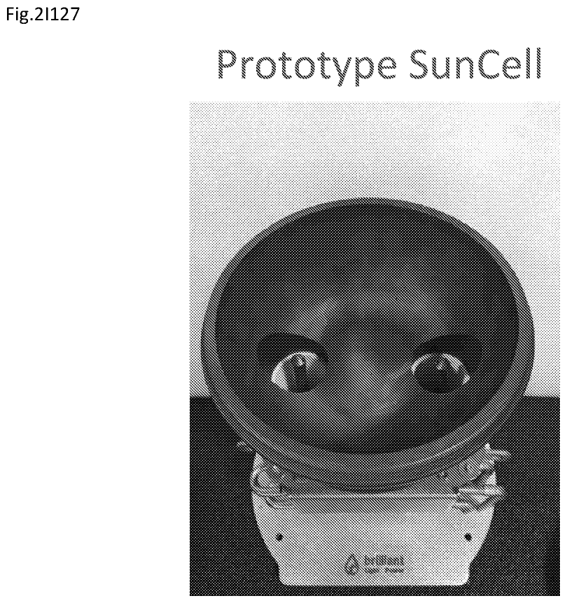

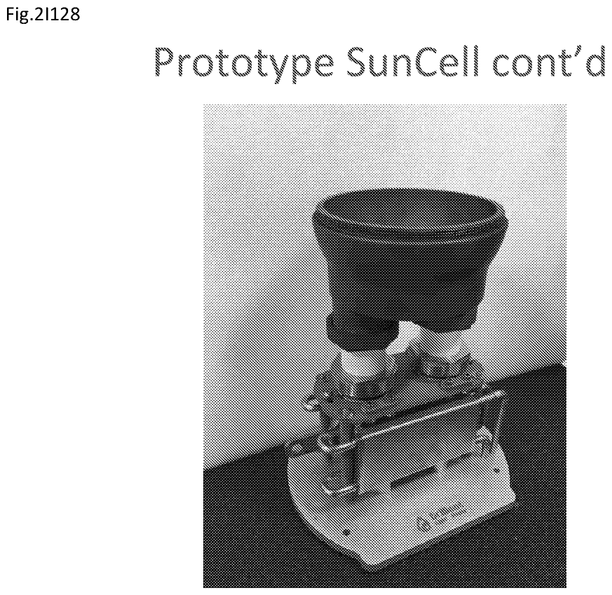

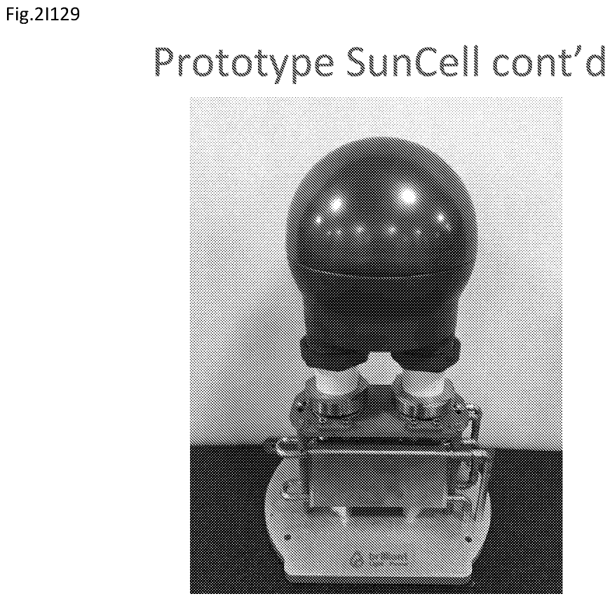

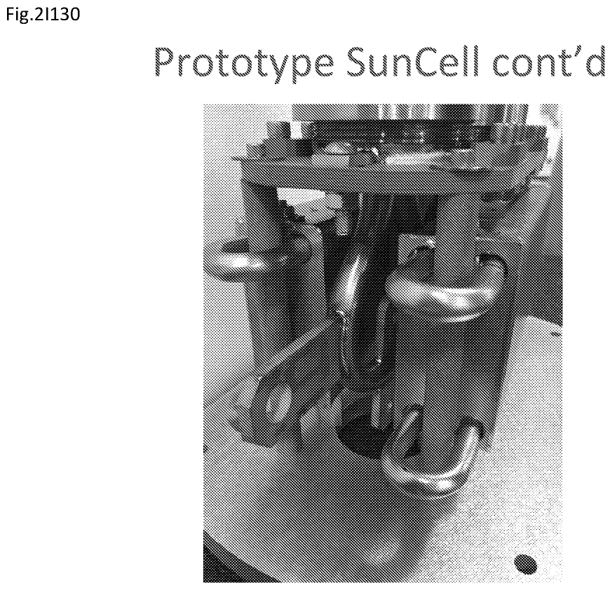

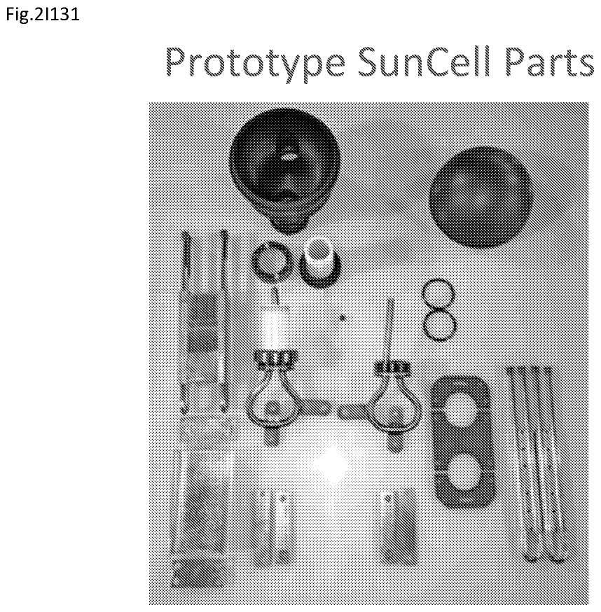

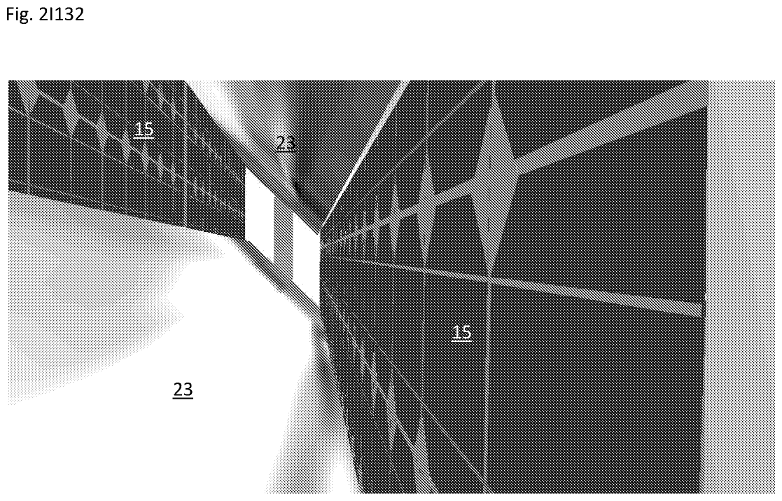

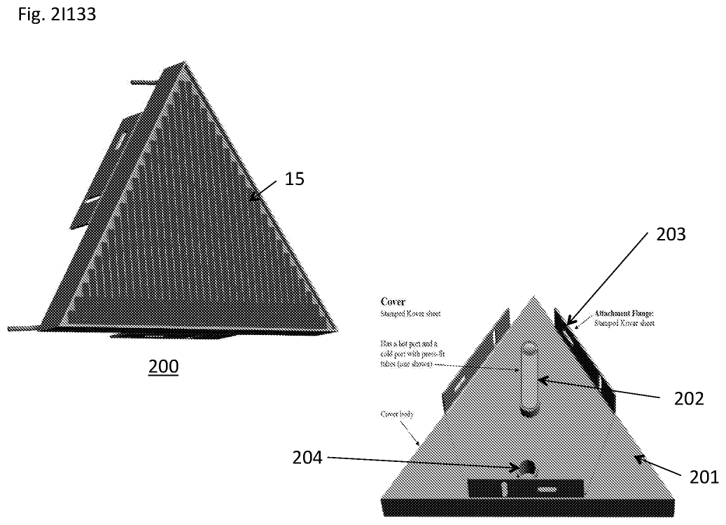

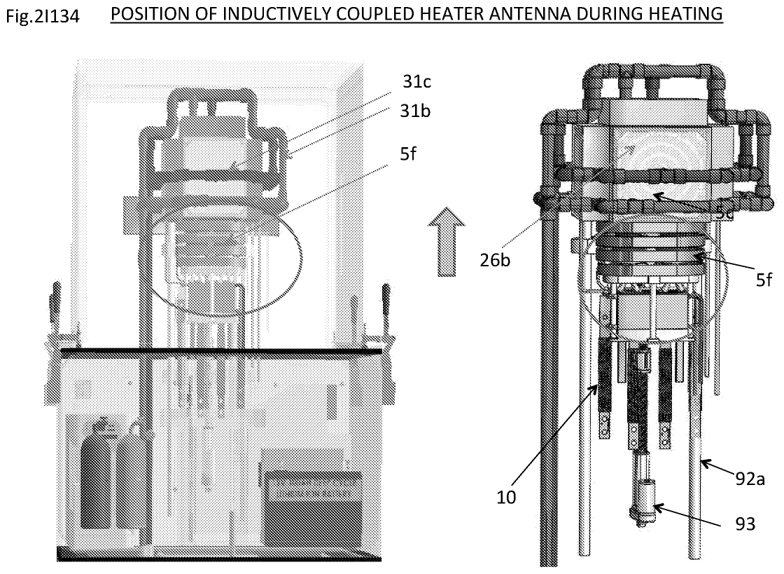

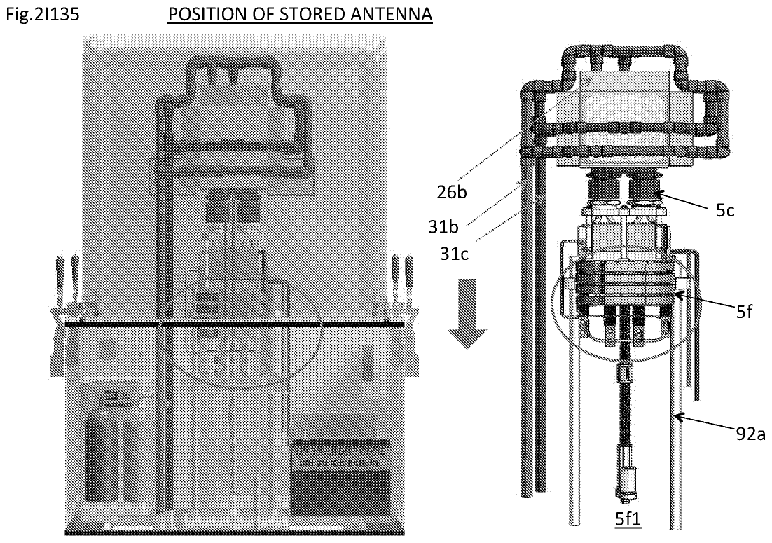

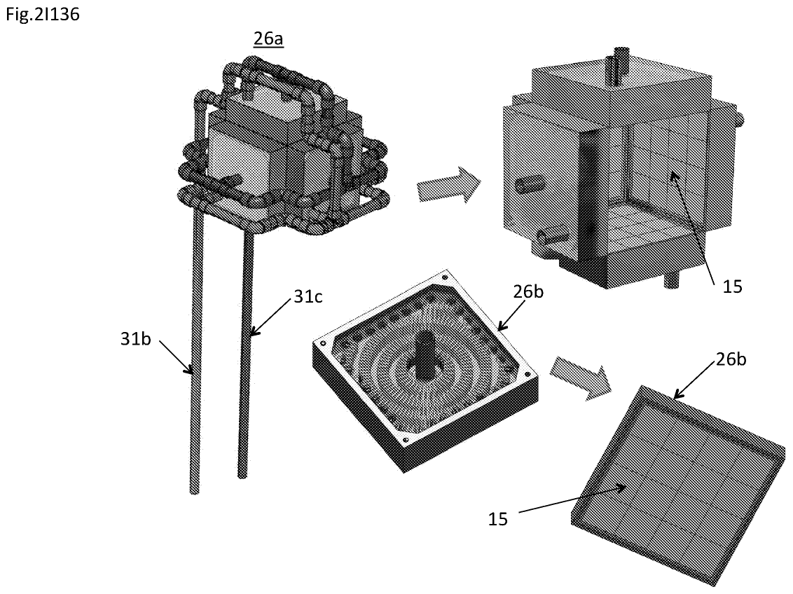

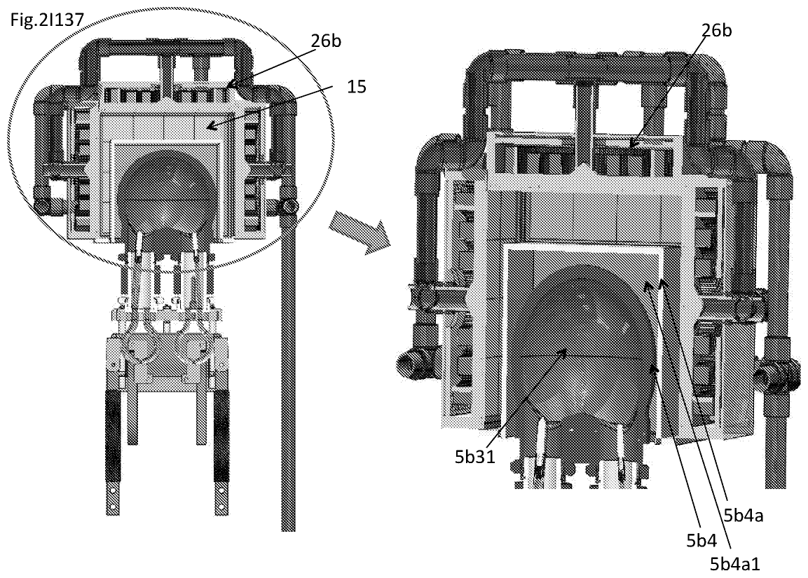

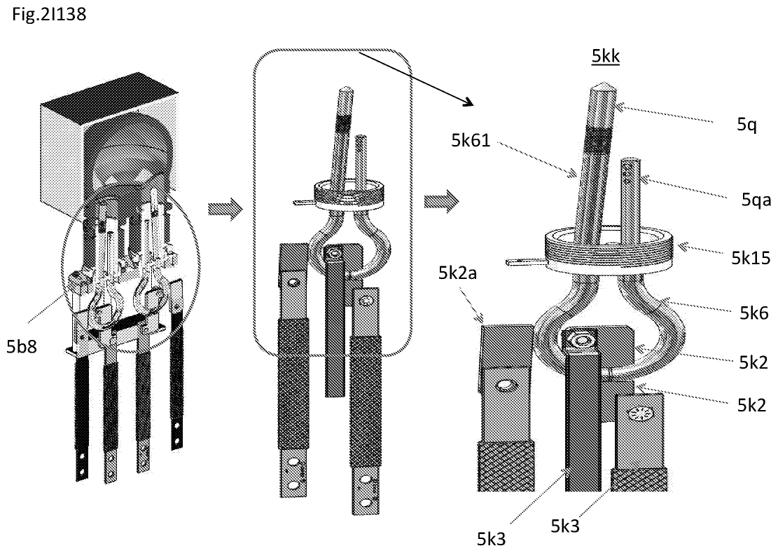

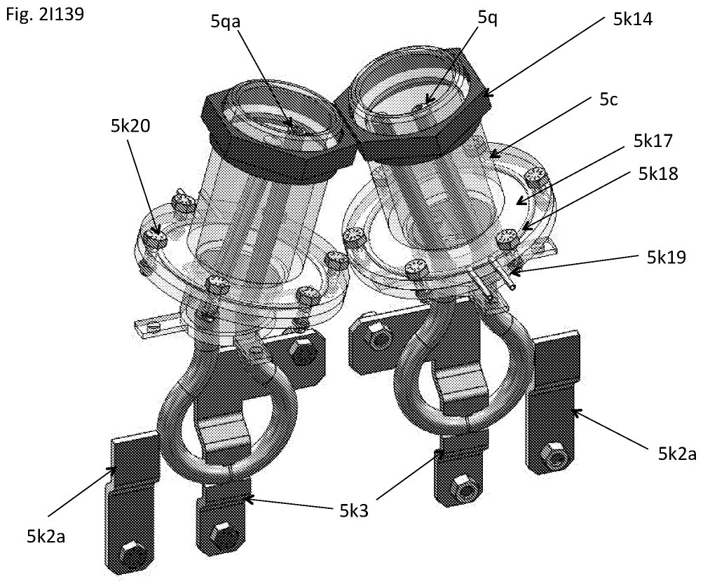

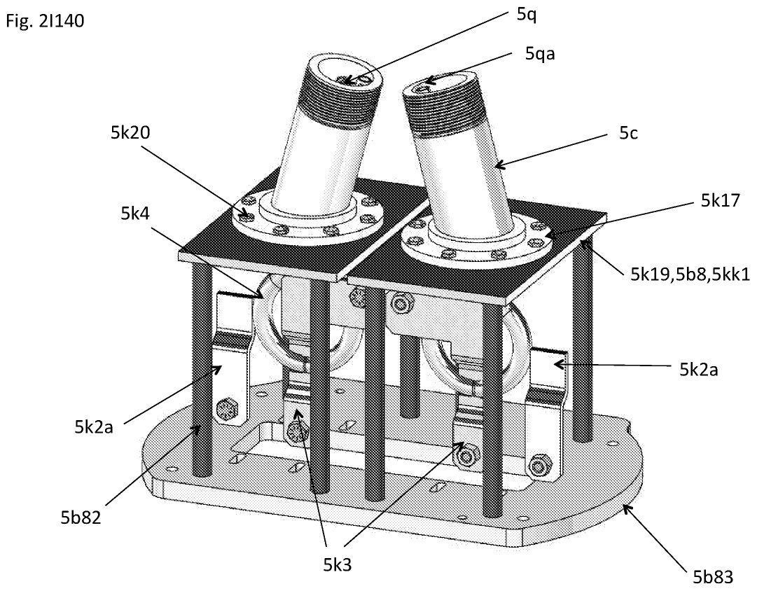

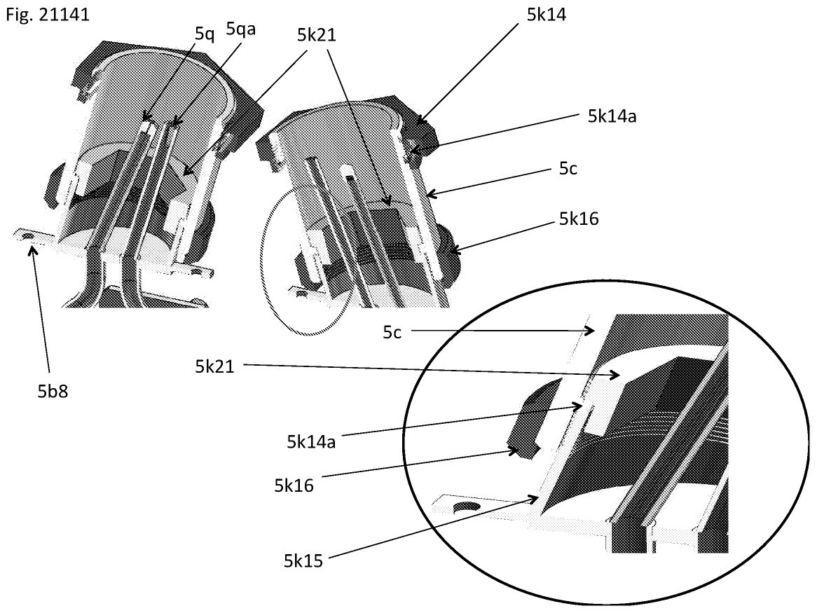

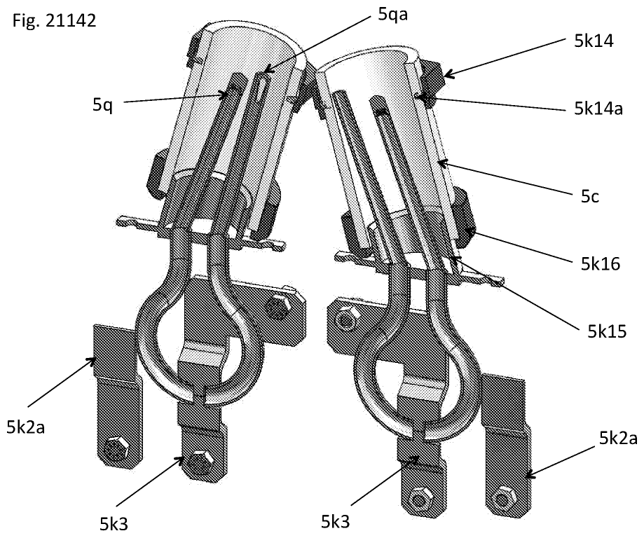

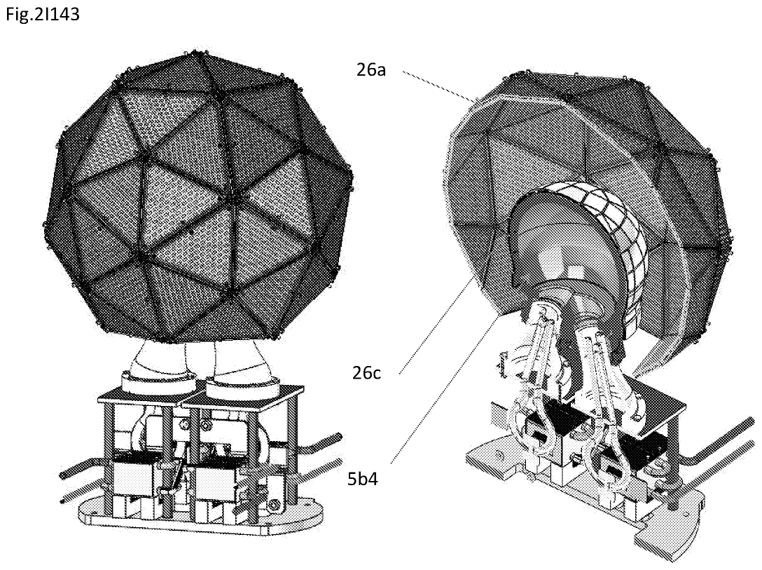

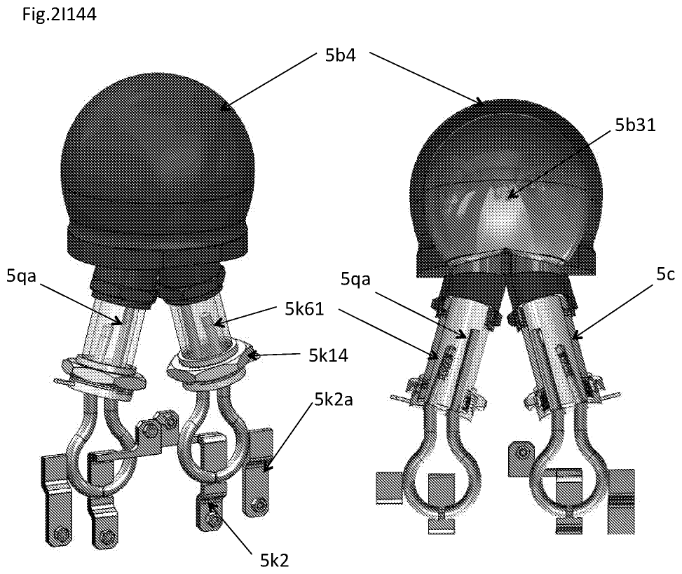

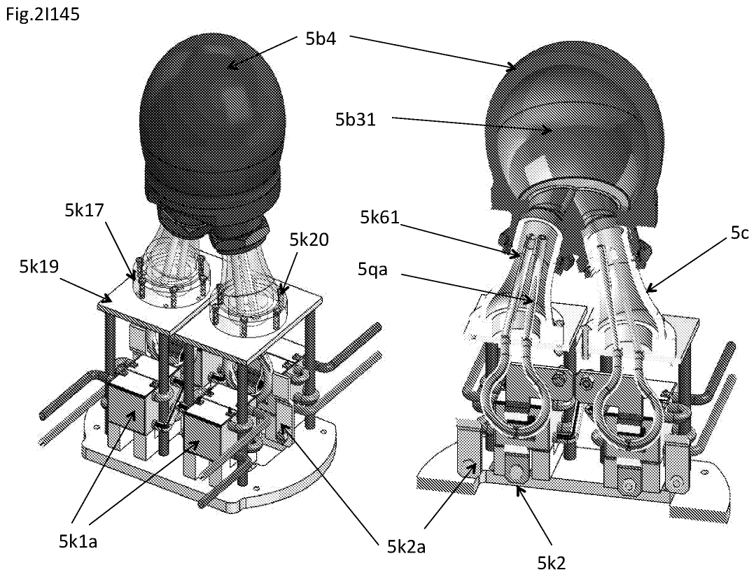

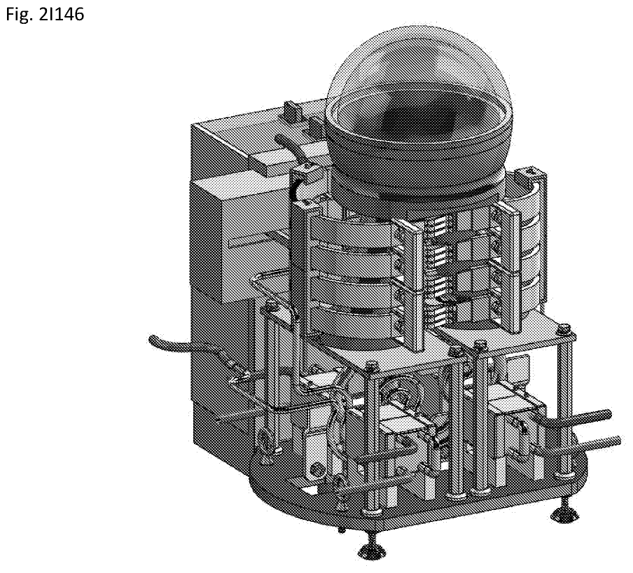

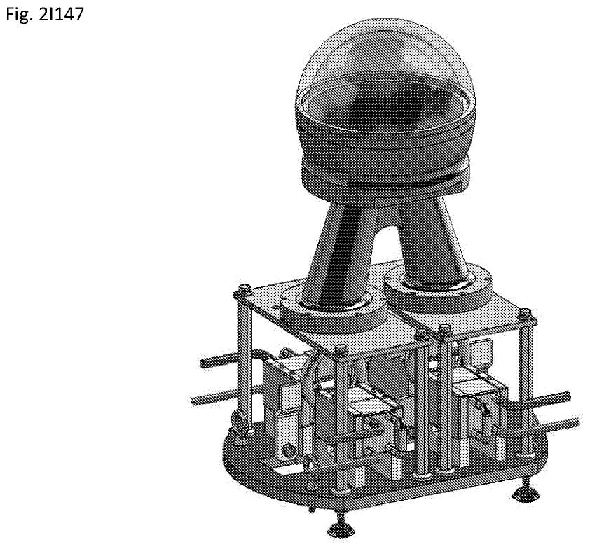

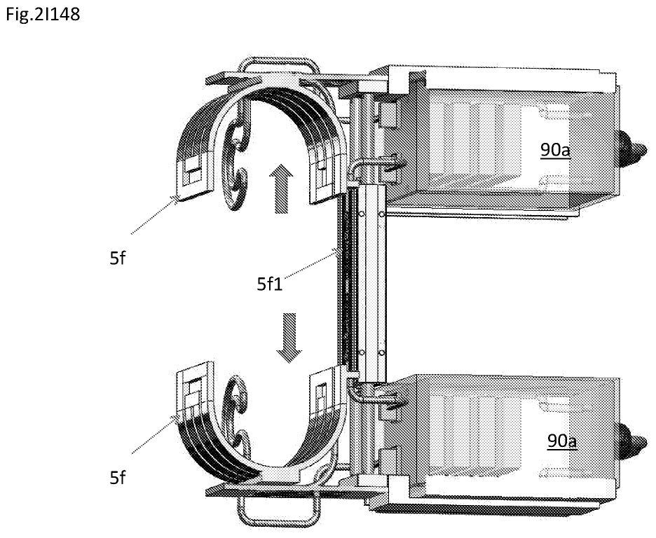

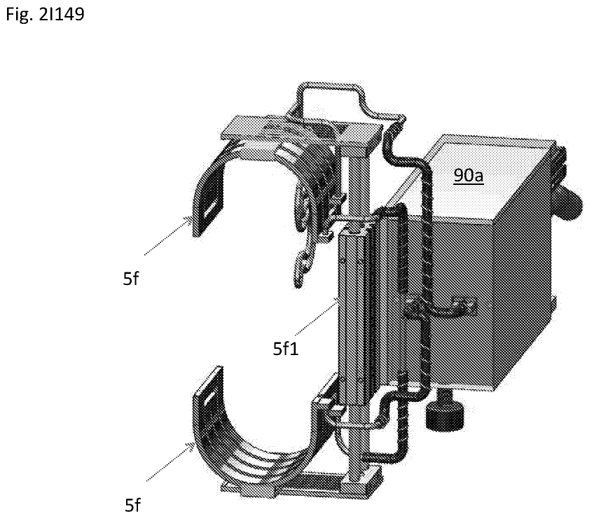

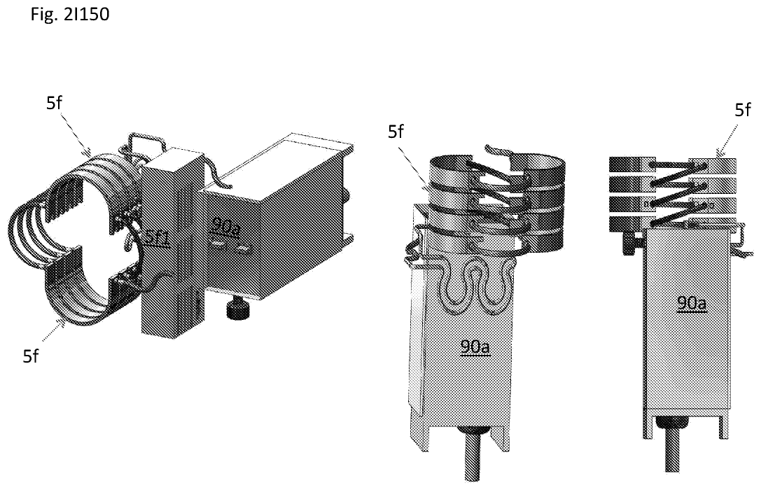

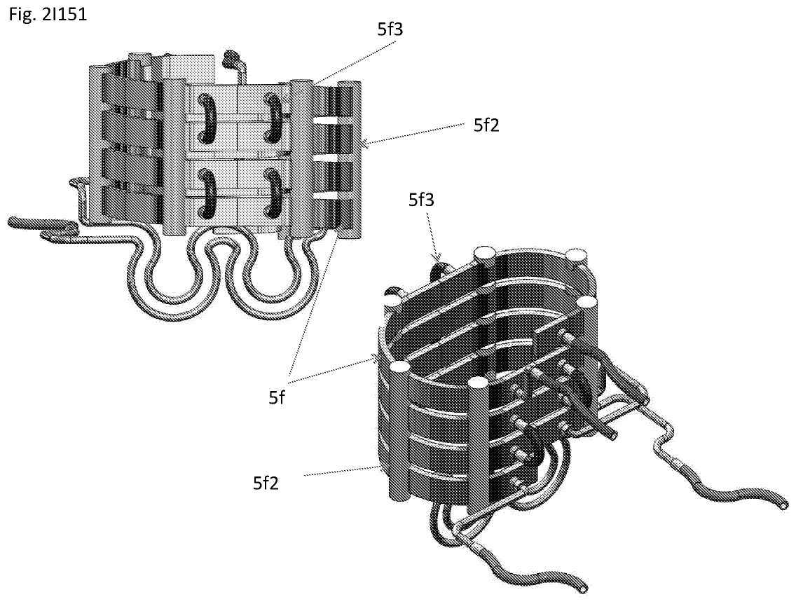

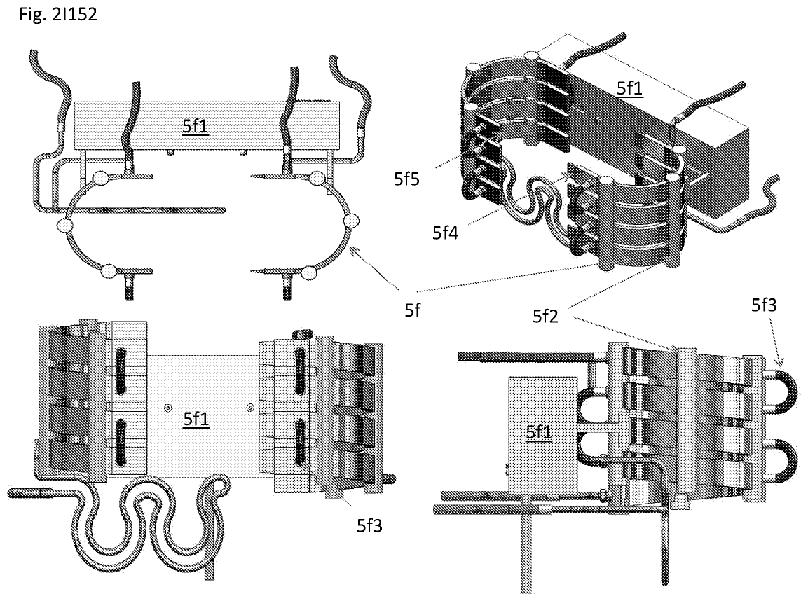

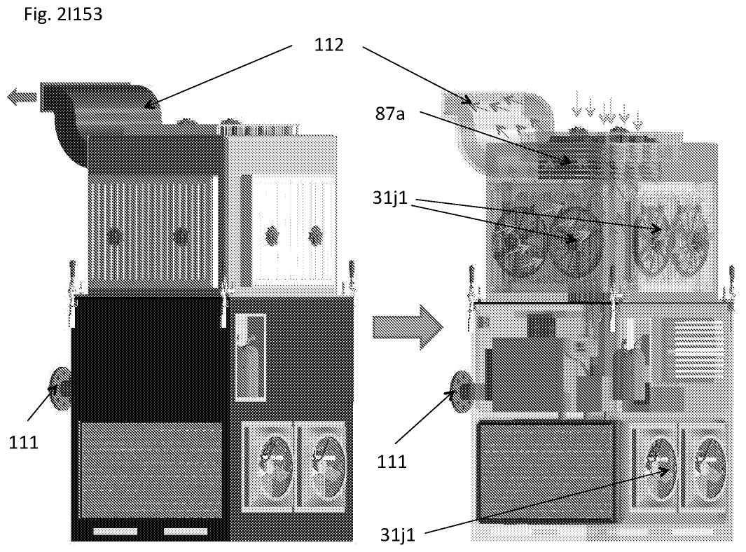

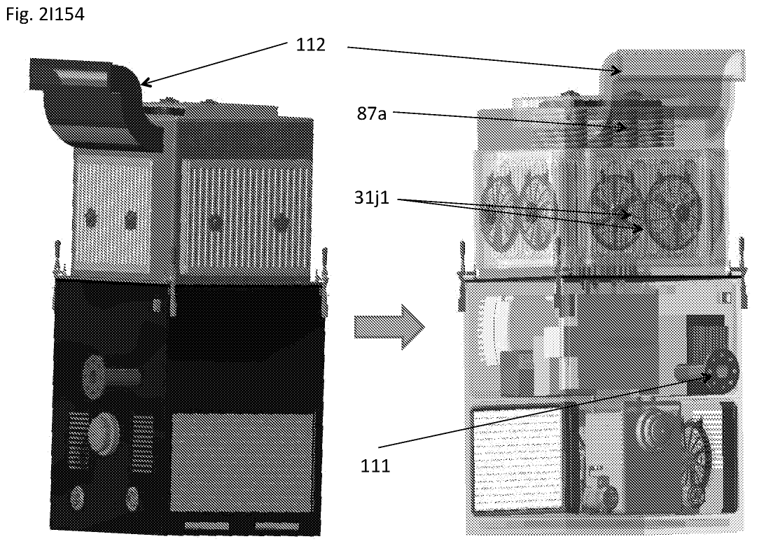

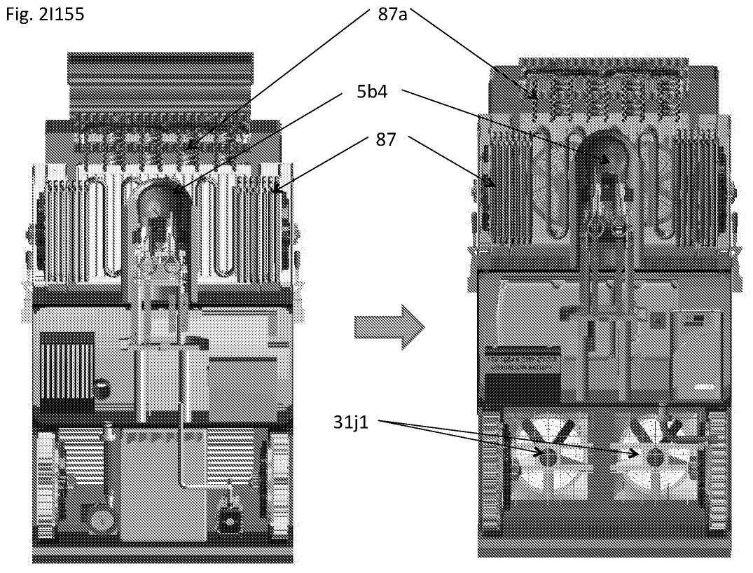

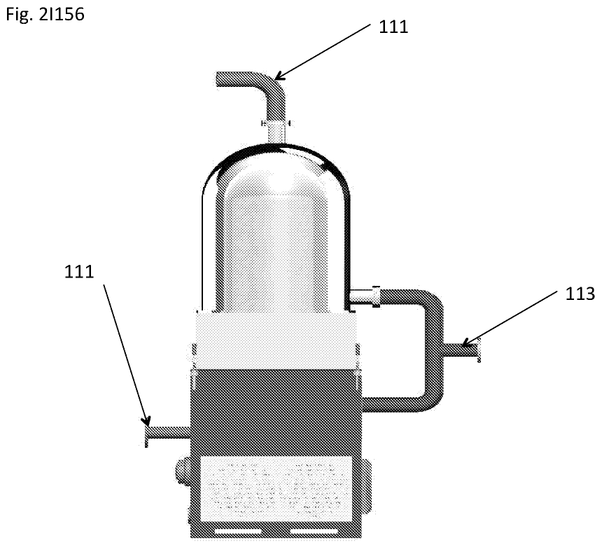

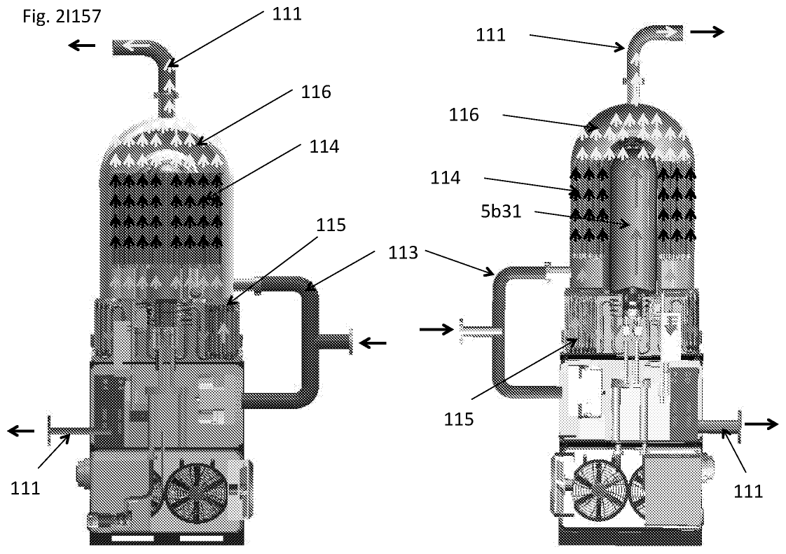

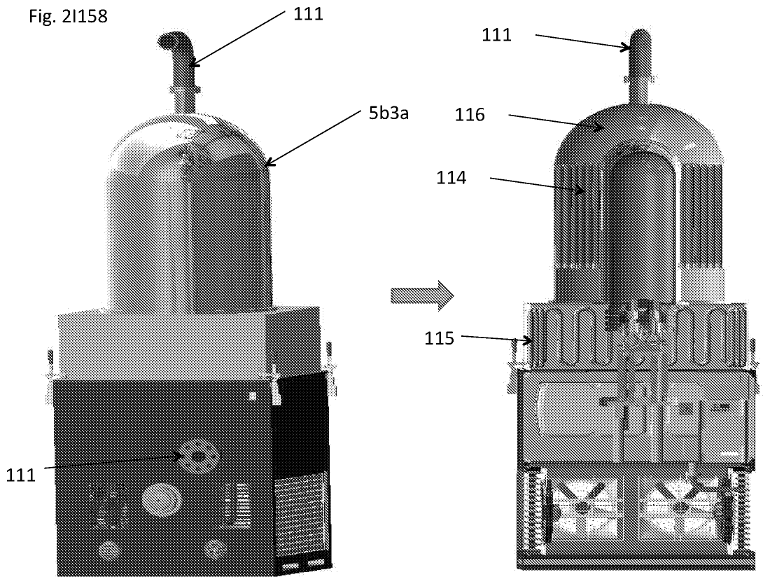

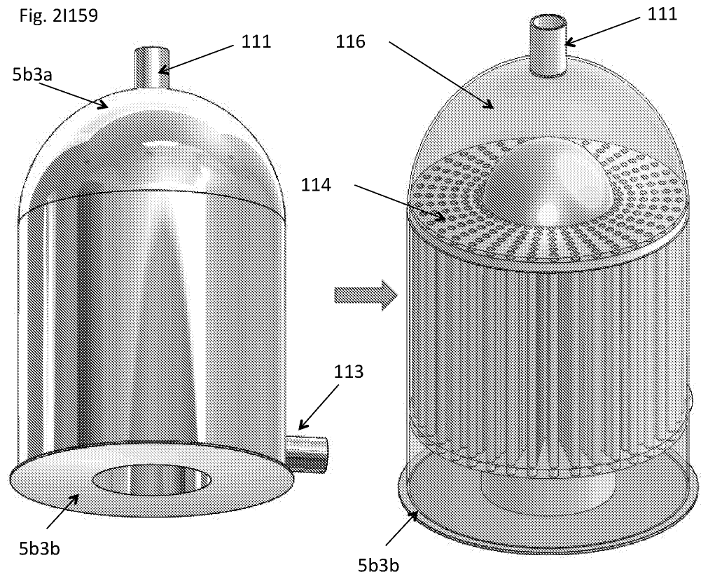

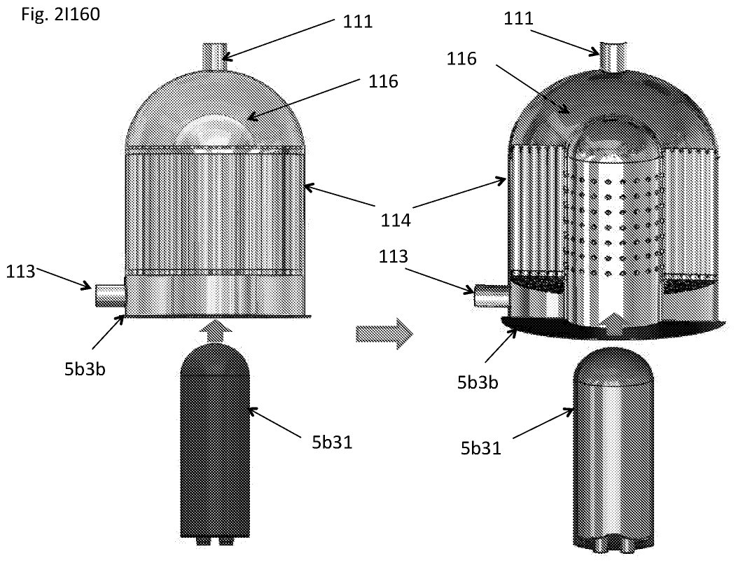

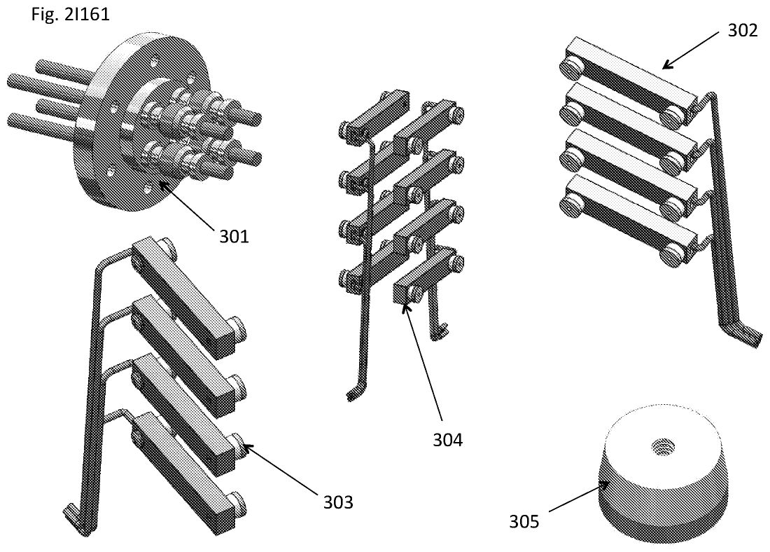

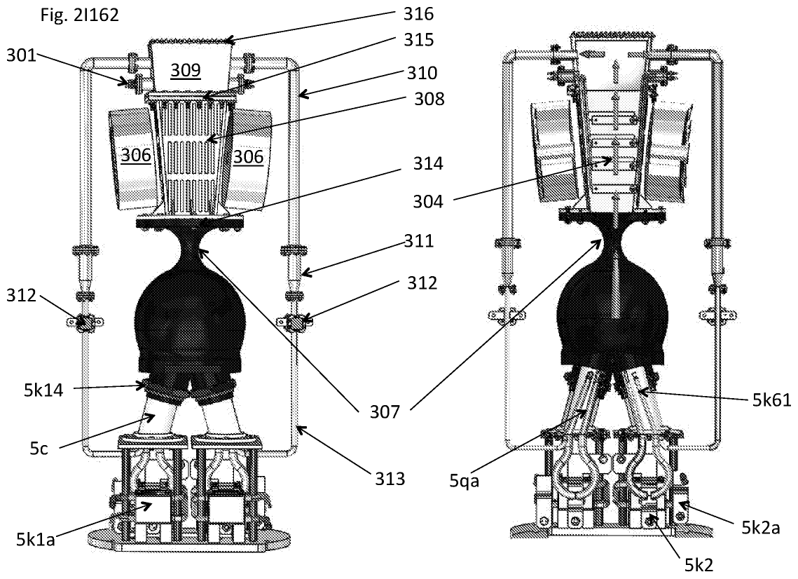

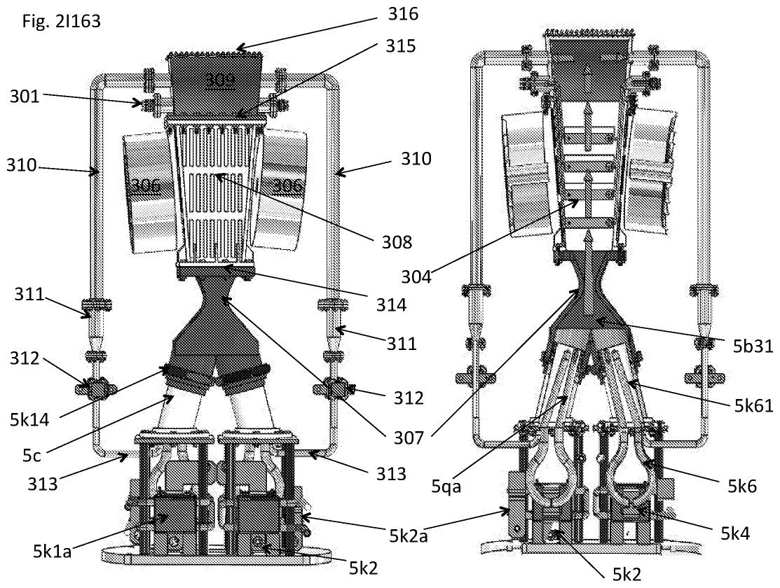

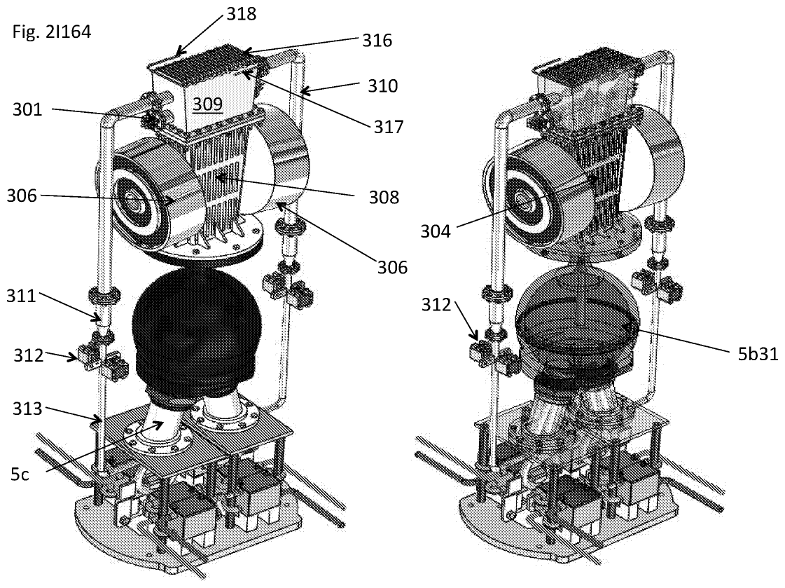

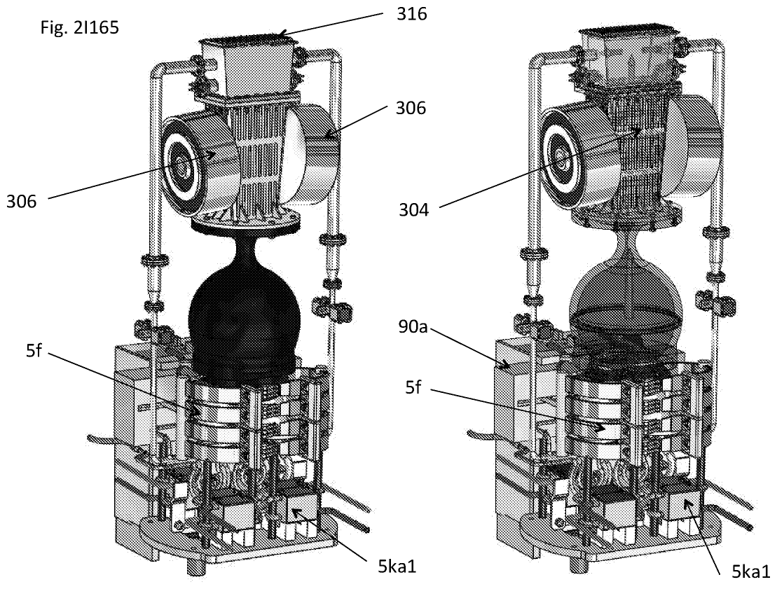

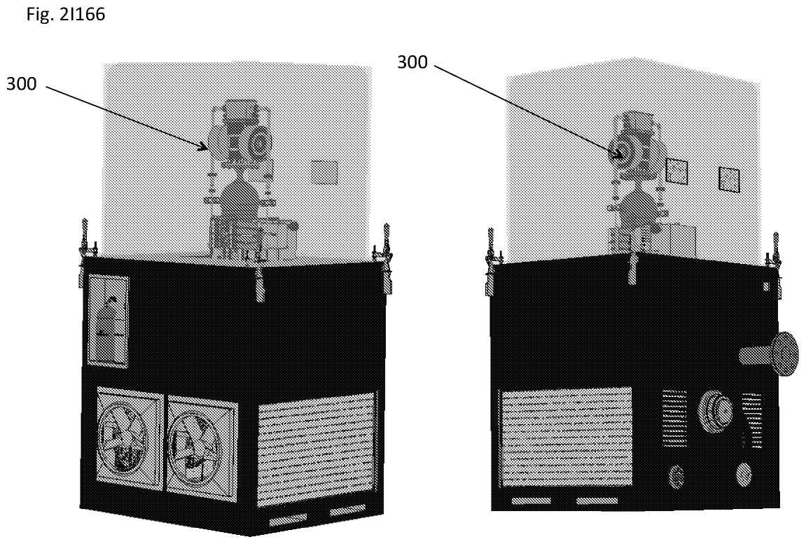

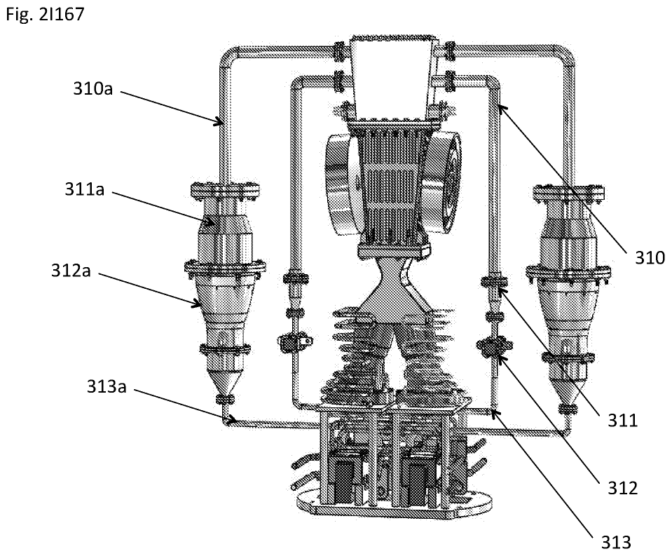

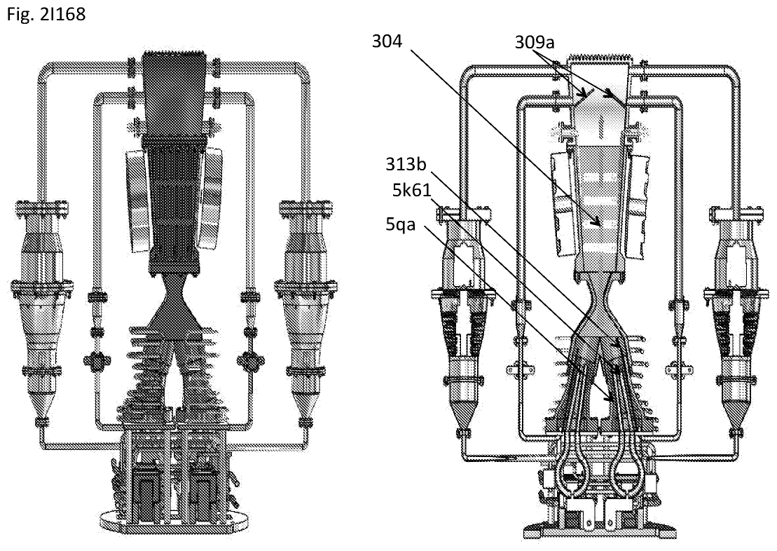

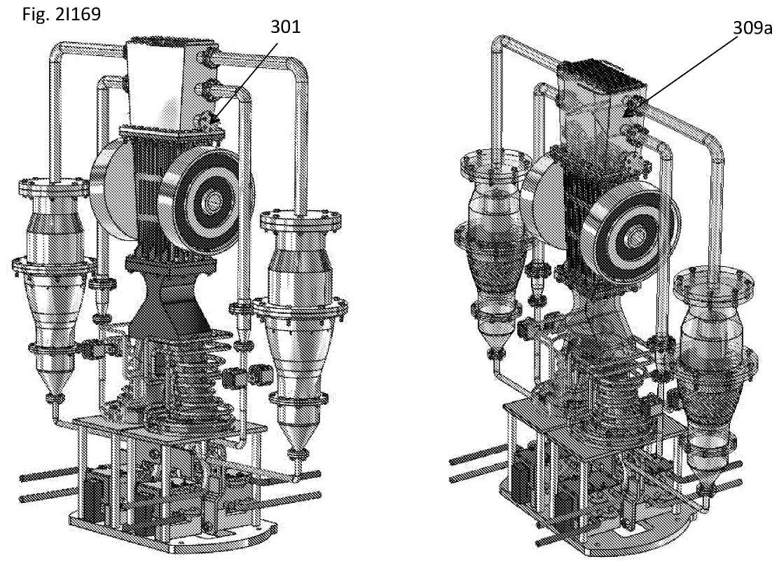

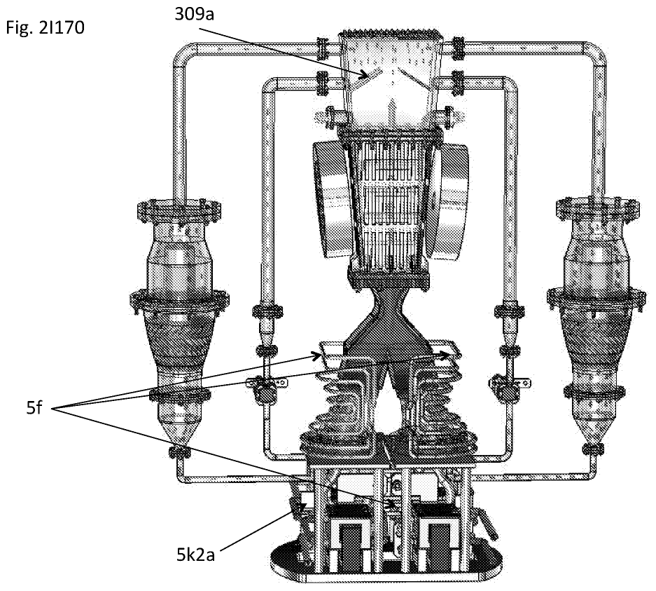

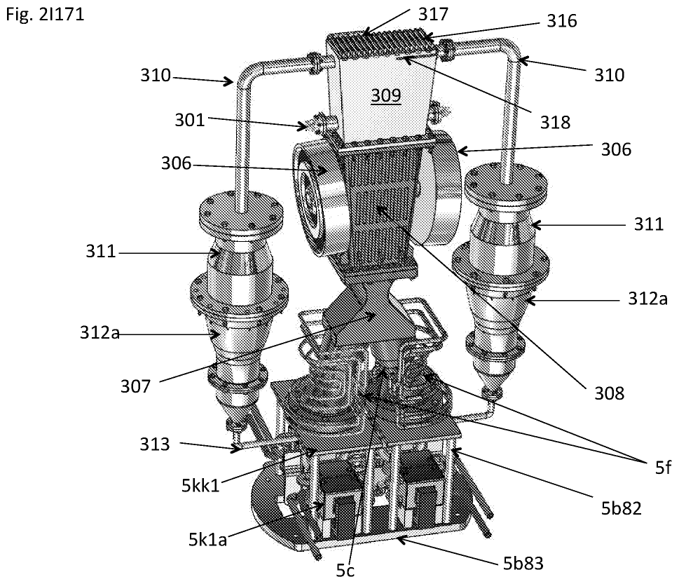

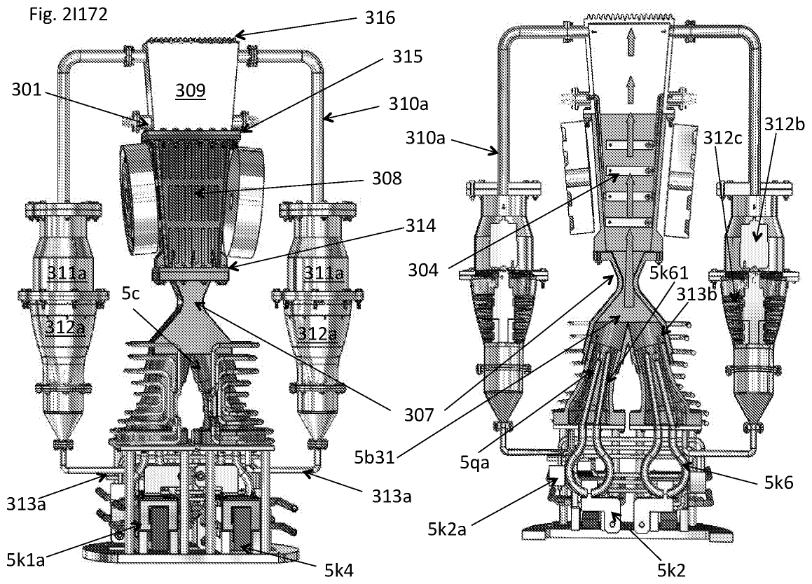

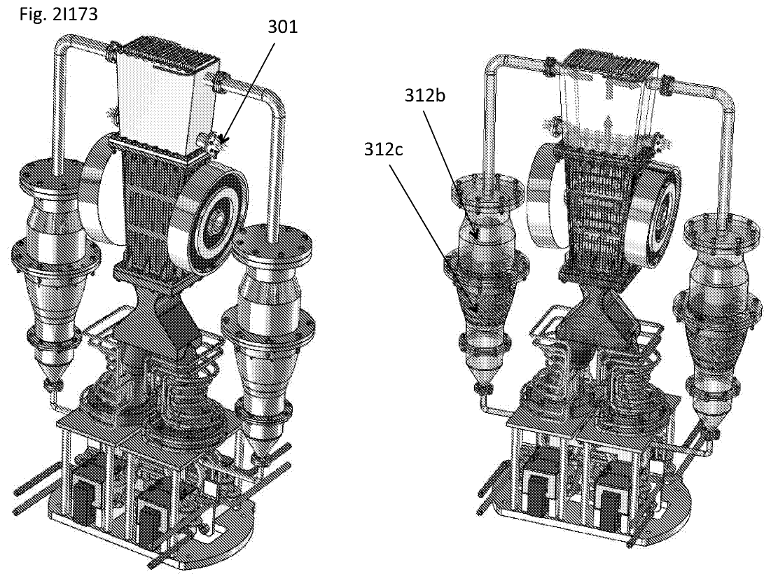

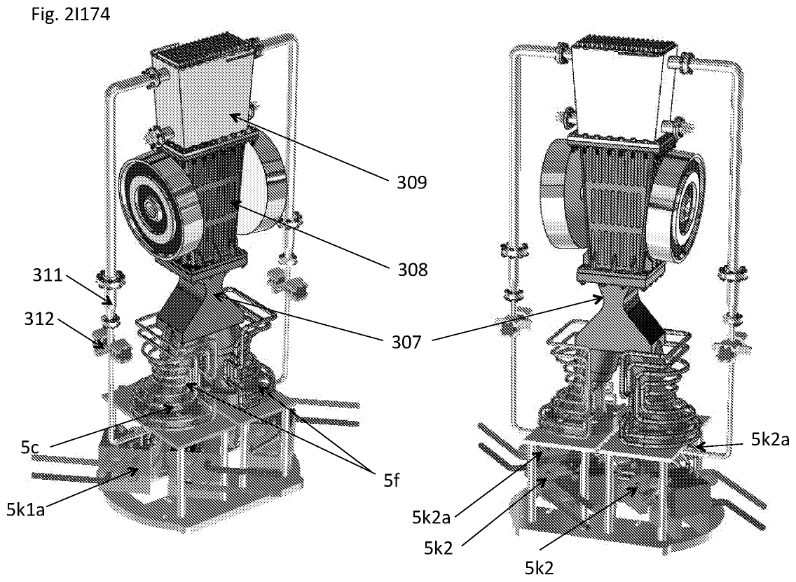

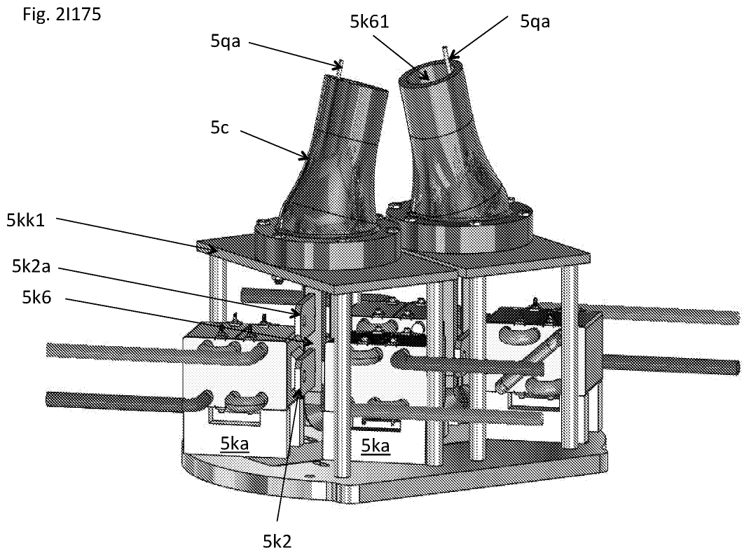

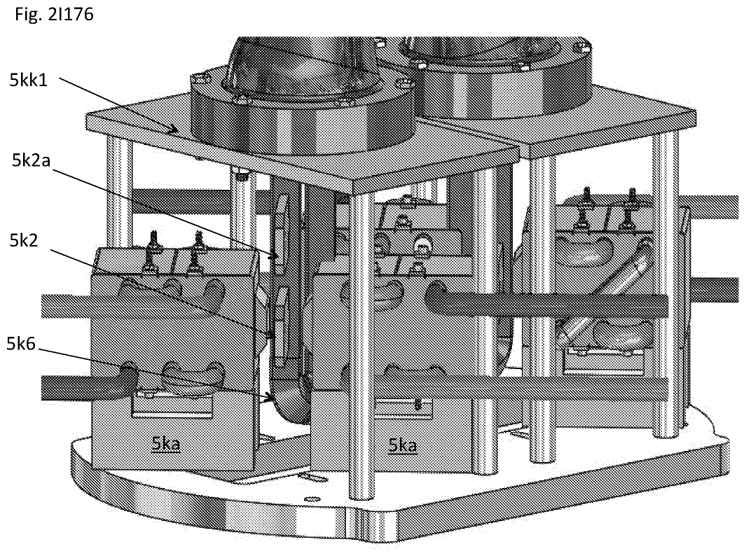

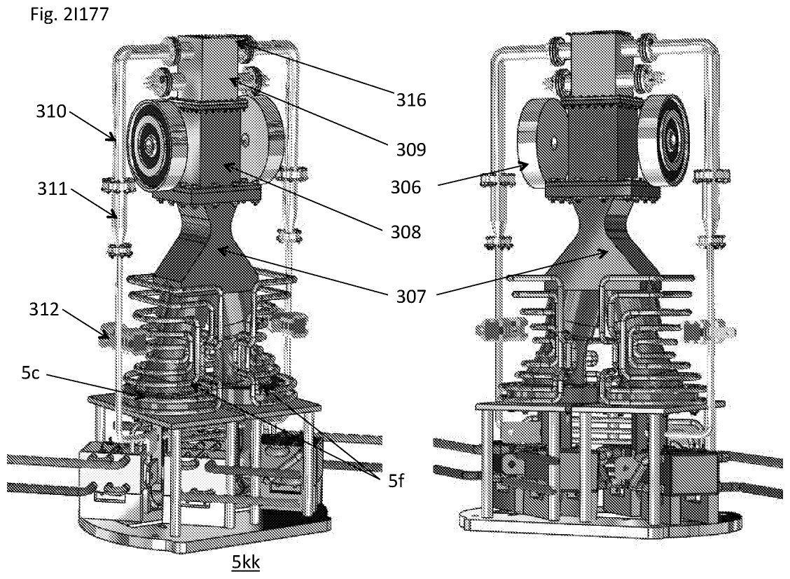

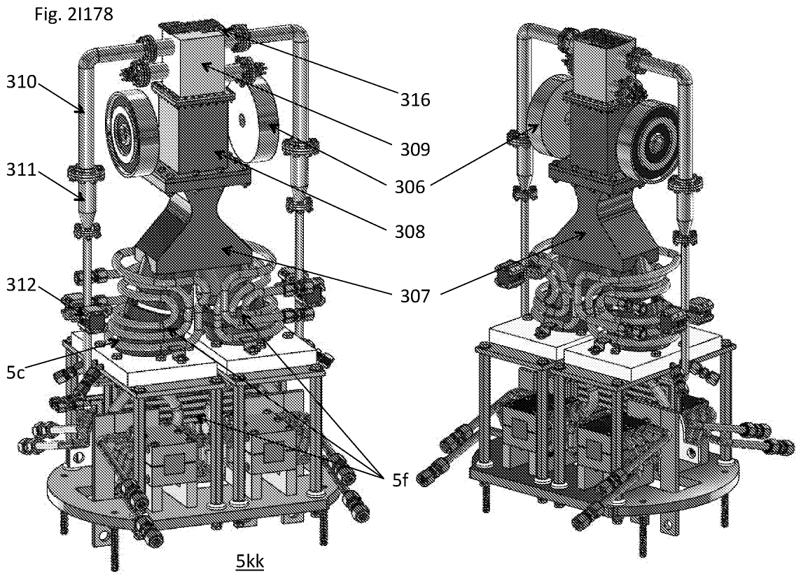

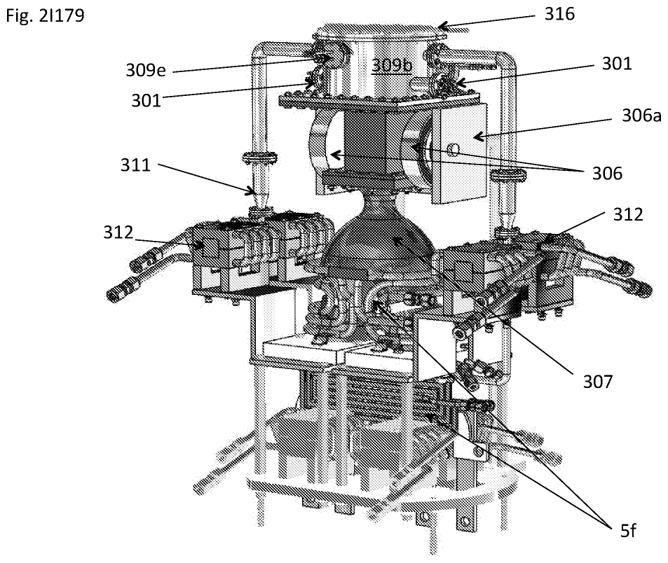

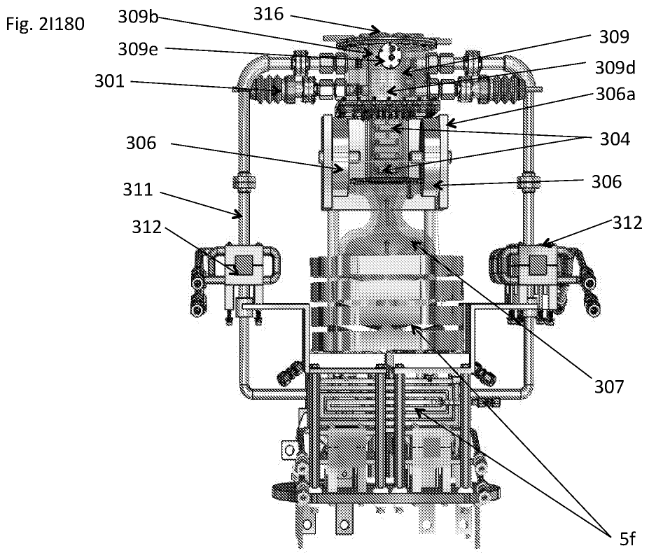

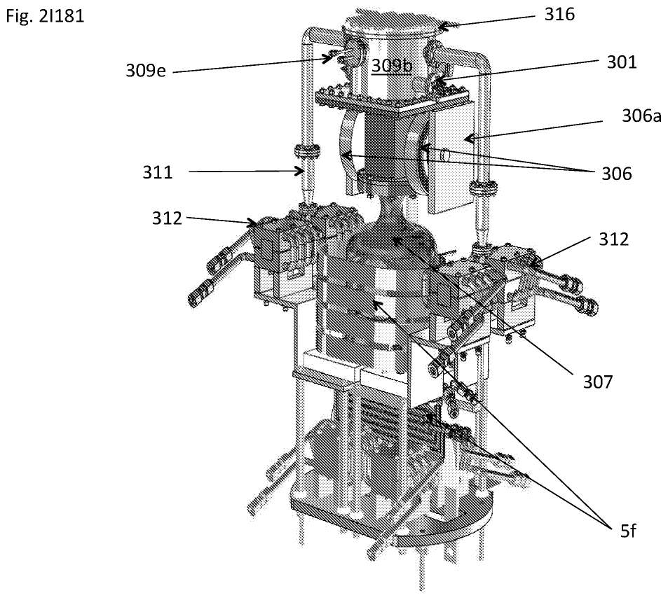

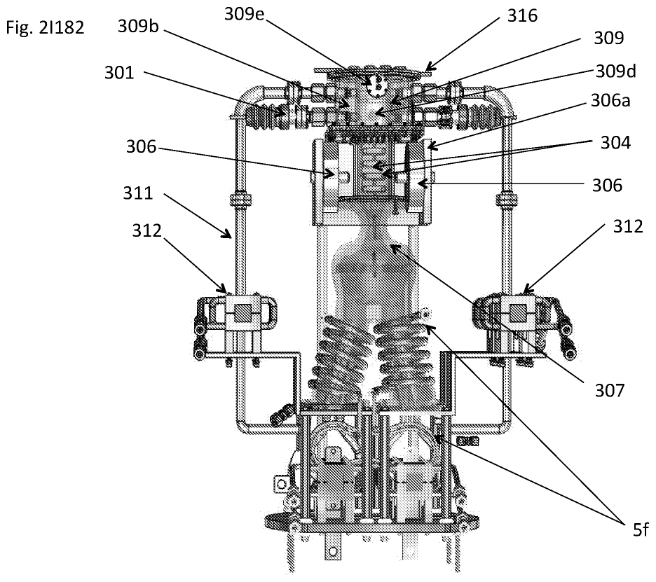

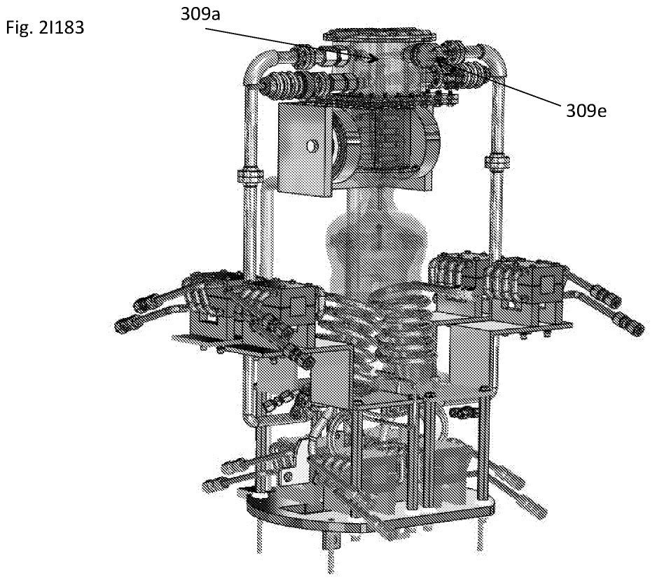

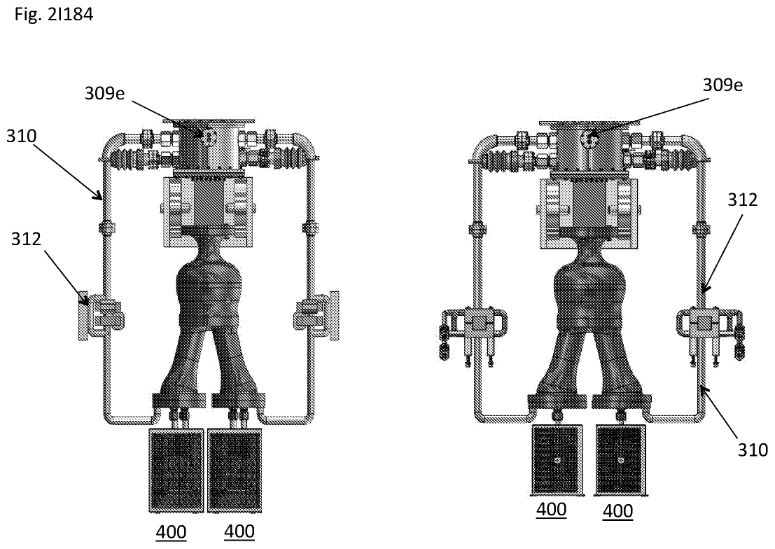

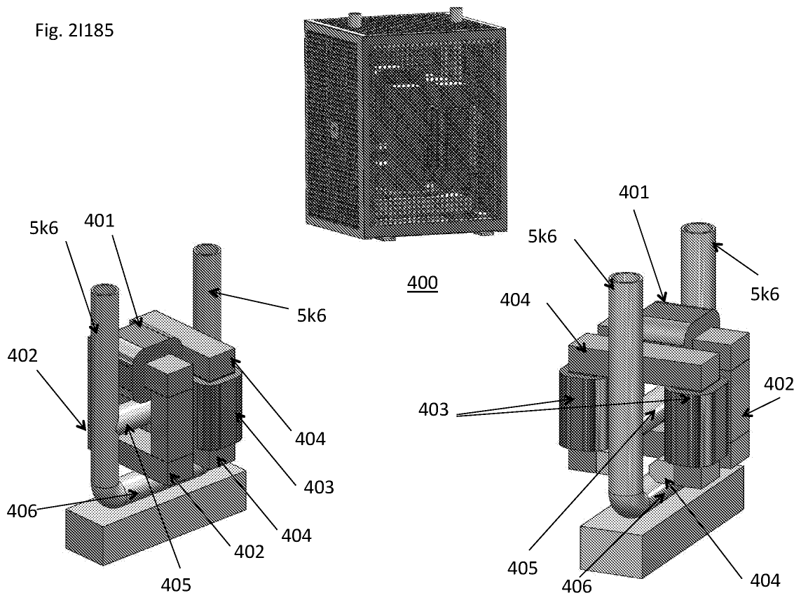

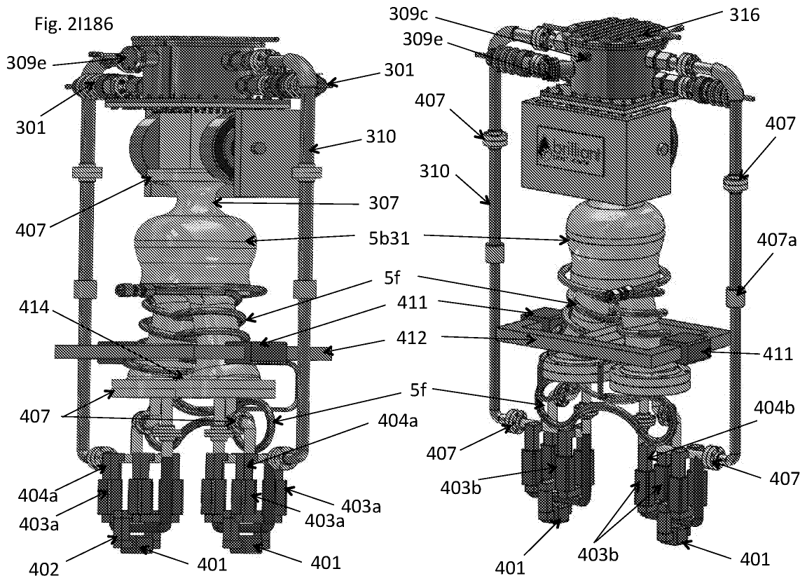

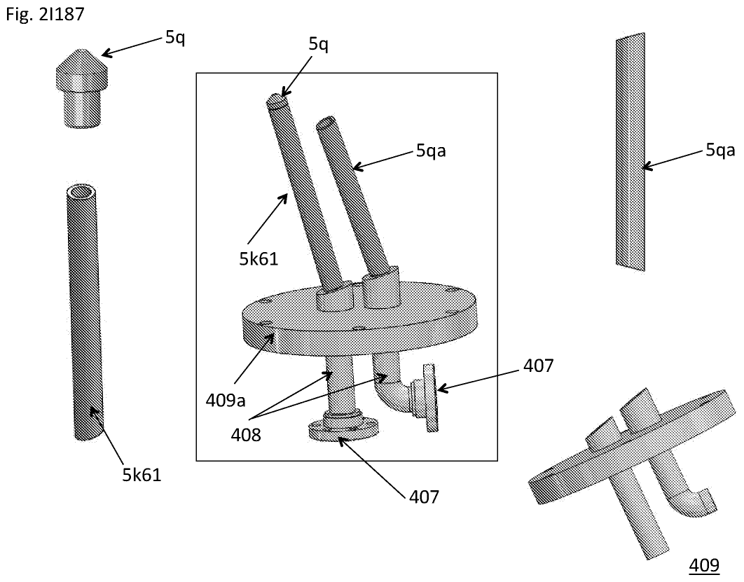

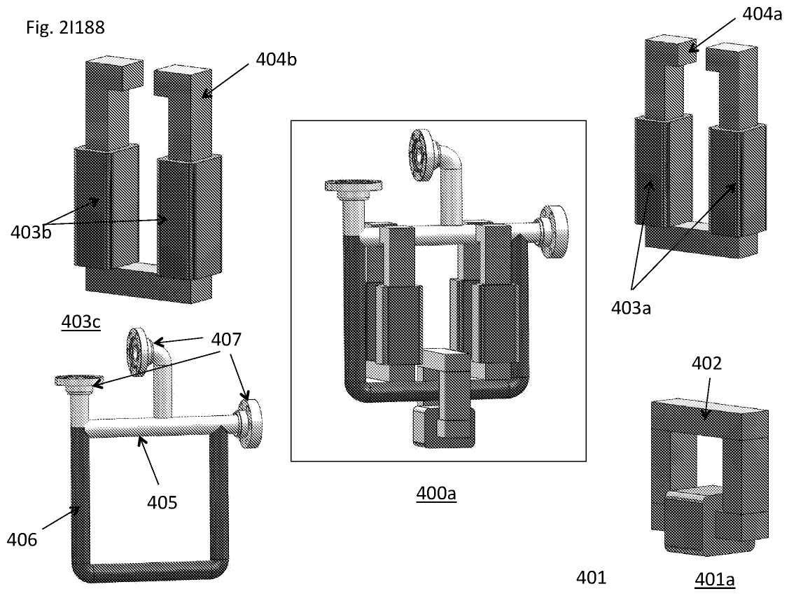

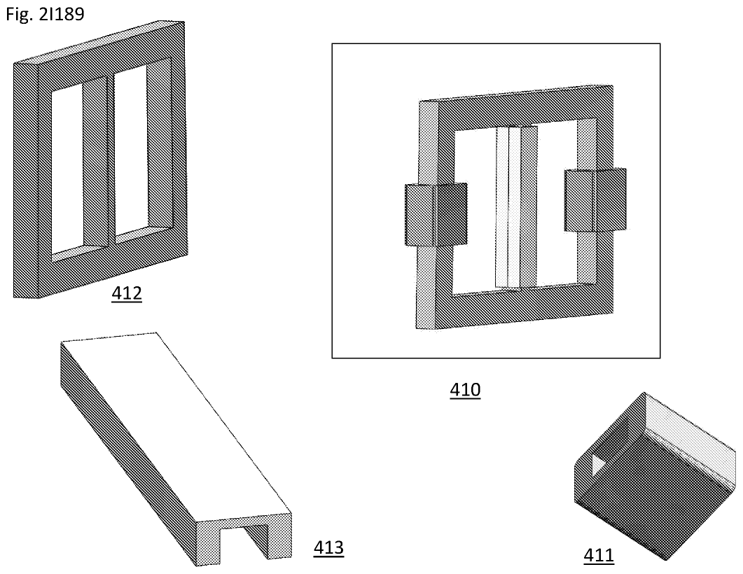

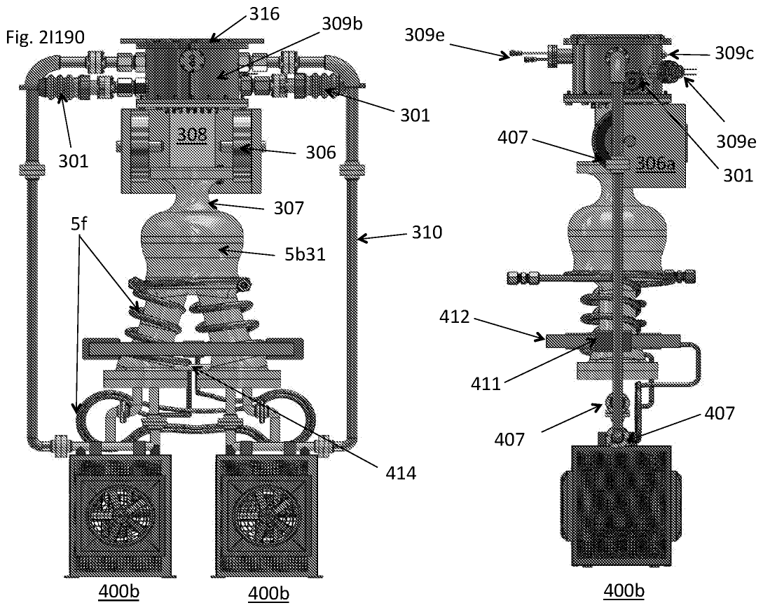

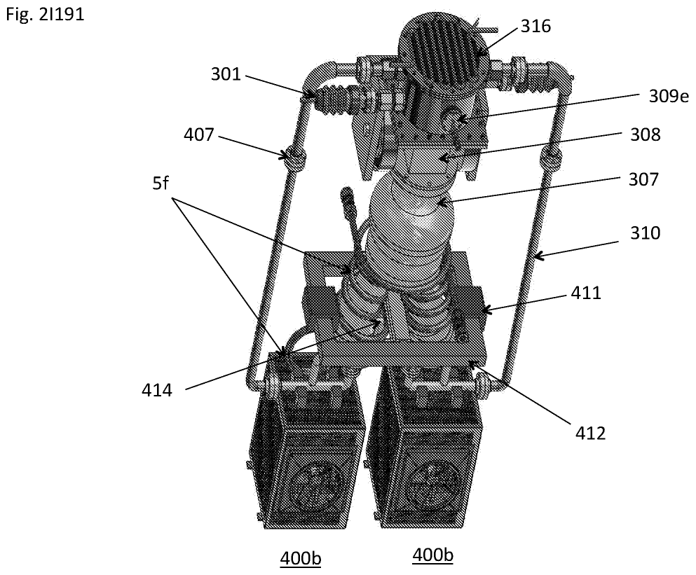

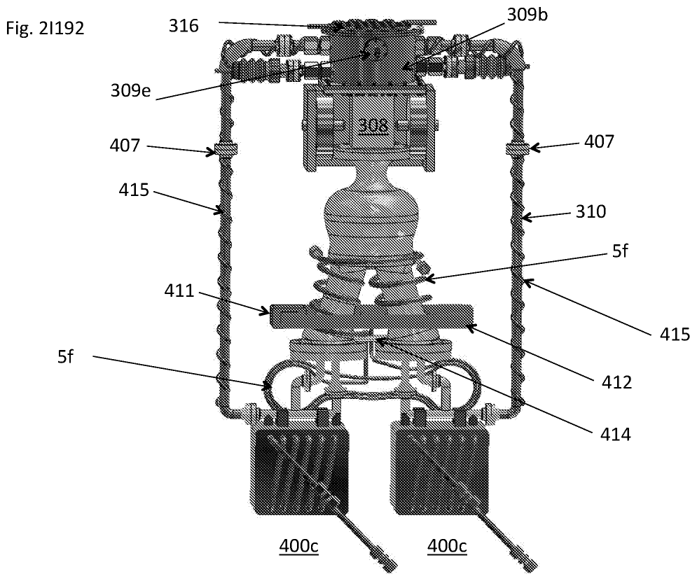

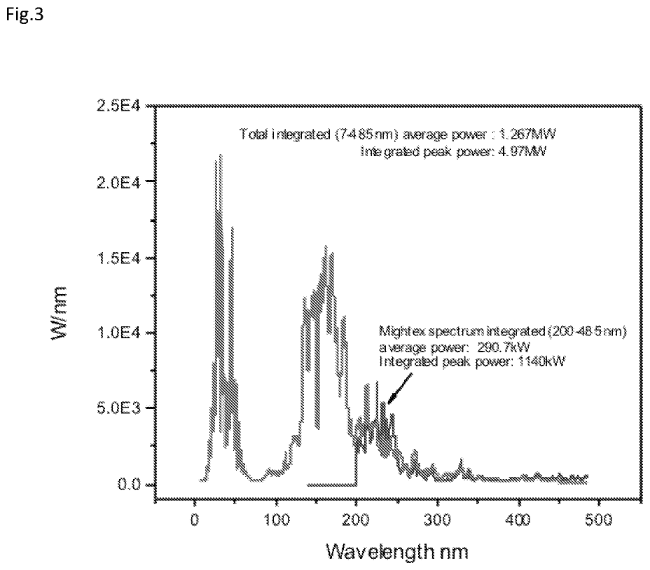

In an embodiment, the silver vapor/aerosol mixture is almost pure liquid plus oxygen at the exit of the MHD nozzle 307. The solubility of oxygen in silver increases as the temperature approaches the melting point wherein the solubility is up to about 40 to 50 volumes of oxygen for volume of silver (FIG. 3). The silver absorbs the oxygen at the MHD channel 308 such as at the exit and both the liquid silver and oxygen are recirculated. The oxygen may be recirculated as gas absorbed in molten silver. In an embodiment, the oxygen is released in the reaction chamber 5b31 to regenerate the cycle. The temperature of the silver above the melting point also serves as a means for recirculation or regeneration of thermal power. The oxygen concentration is optimized to enable a thermodynamic cycle wherein the temperature of the recirculated silver is less than the maximum operating temperature of the SunCell® components such as 1800° C. In an exemplary embodiment, (i) the oxygen pressure in at least one of the reaction cell chamber 5b31 and the MHD nozzle 307 is 1 atm, (ii) the silver at the exit of the MHD channel 308 is almost all liquid such as aerosol, (iii) the oxygen mass flow rate is about 0.3 wt %, and (iv) the temperature at the exit of the MHD channel is about 1000° C. wherein the O₂ accelerates the aerosol and then is absorbed by the 1000° C. silver. The liquid silver-oxygen mixture is recirculated to the reaction cell chamber 5b31 wherein the oxygen is released to form a thermodynamic cycle. The requirement of a gas compressor such as 312a and the corresponding parasitic power load may be reduced or eliminated. In an embodiment, the oxygen pressure may be in at least one range of about 0.0001 atm to 1000 atm, 0.01 atm to 100 atm, 0.1 atm to 10 atm, and 0.1 atm to 1 atm. The oxygen may have a higher partial pressure in one cell region such as at least one of the reaction cell chamber 5b31 and the nozzle 307 relative to the MHD channel exit 308. The SunCell® may have a background oxygen partial pressure than may be elevated in one cell region such as at least one of the reaction cell chamber 5b31 and the nozzle 307 relative to the MHD channel exit 308. Due to the much higher heat capacity of oxygen and non-condensability at operating temperature, the MHD nozzle may be reduced in size relative to that of an MHD converter that uses only silver vapor to achieve the aerosol jet acceleration.

The thermodynamic cycle may be optimized to maximize the electrical conversion efficiency. In an embodiment, the mixture kinetic energy is maximized while minimizing the vapor fraction. In an embodiment, the recirculation or regeneration of thermal power is achieved as a function of the temperature of recirculated silver from the exit of the MHD channel 308 to the reaction cell chamber 5b31. The temperature of the recirculated silver may be maintained less than the maximum operating temperature of the SunCell® components such as 1800° C. In another embodiment, the Lorentz force may cool the mixture to at least partially condense the liquid phase wherein the corresponding released heat of vaporization is at least partially transferred to the liquid phase. At least one of the MHD nozzle expansion, MHD channel 308 expansion, and Lorentz force cooling in the MHD channel 308 may lower the temperature of the mixture at one or more of the MHD nozzle 307 exit and the MHD channel 308 below the melting point of silver. The heat released by condensation of the vapor may be absorbed towards the heat of fusion of silver and silver heat capacity with temperature elevation. The silver heated by the heat of vaporization of condensed vapor may be recirculated to regenerate the corresponding thermal power. In another embodiment to raise the efficiency, relatively cold aerosol may be injected into a power conversion component such as the MHD nozzle 307 or the MHD channel 308 by means such as ducting from the reservoir 5c.

Ceramic parts of SunCell® may be joined by means of the disclosure such as by ceramic glue of two or more ceramic parts, braze of ceramic to metallic parts, slip nut seals, gasket seals, and wet seals. The gasket seal may comprise two flanges sealed with a gasket. The flanges may be drawn together with fasteners such as bolts. The slip nut joint or gasket seal may comprise a carbon gasket. At least one of the nut, the EM pump assembly 5kk, the reservoir base plate 5b8, and the lower hemisphere 5b41 may comprise a material that is resistant to carbonization and carbide formation such and nickel, carbon, and a stainless steel (SS) that is resistant of carbonization such as SS 625 or Haynes 230 SS. The slip nut joint between the EM pump assembly and a ceramic reservoir may comprise an EM pump assembly 5kk comprising a threaded collar and nut comprising a stainless steel (SS) that is resistant of carbonization such as SS 625 or Haynes 230 SS and a graphite gasket wherein the nut threads onto the collar to tighten against that gasket. The flange seal joint between the EM pump assembly 5kk and the reservior 5c may comprise a reservior base plate 5b8 with bolt holes, a ceramic reservoir having a flange with bolt holes, and a carbon gasket. The EM pump assembly having a reservoir base plate may comprise a stainless steel (SS) that is resistant of carbonization such as SS 625 or Haynes 230 SS. The flange of the reservoir may be fastened to the base plate 5b8 by the bolts tightened against the carbon or graphite gasket. In an embodiment, the carbon reduction reaction between carbon such as a carbon gasket a part comprising an oxide such as an oxide reservoir 5c such as a MgO, Al₂O₃, or ZrO₂ reservoir is avoided by maintaining the joint comprising oxide in contact with carbon at a non-reactive temperature, one below the carbon reduction reaction temperature. In an embodiment, the MgO carbon reduction reaction temperature is above the range of about 2000° C. to 2300° C.

In an exemplary embodiment, a ceramic such as an oxide ceramic such as zirconia or alumina may be metalized with an alloy such as Mo-Mn. Two metalized ceramic parts may be joined by braze. A metalized ceramic part and a metal part such as the EM pump bus bars 5k2 may be connected by braze. The metallization may be coated to protect it from oxidation. Exemplary coatings comprise nickel and noble metals in the case of water oxidant, and a noble metal in the case of oxygen. In an exemplary embodiment, an alumina or zirconia EM pump tube 5k6 is metallized at penetrations for the EM pump bus bars 5k2, and the EM pump bus bars 5k2 are connected to the metallized EM pump tube penetrations by braze. In another exemplary embodiment, the parts from the list of at least two of the EM pump assembly 5kk, the EM pump 5ka, the EM pump tube 5k6, the inlet riser 5qa, the injection EM pump tube 5k61, the reservoirs, the MHD nozzle 307, and the MHD channel 308 may be glued together with ceramic glue. Ceramic parts may be fabricated using methods of the disclosure or known in the art. Ceramic parts may be molded, cast, or sintered from powder, or glued together, or threaded together. In an embodiment, the component may be fabricated in green ceramic and sintered. In an exemplary embodiment, alumina parts may be sintered together. In another embodiment, a plurality of parts may be fabricated as green parts, assembled, and sintered together. The dimensions of the parts and the materials may be selected to compensate for part shrinkage.

In an embodiment, a ceramic SunCell® part such as one comprising at least one of ZrC—ZrB₂—SiC may be formed by ball milling a stoichiometric mixture of the component powders, formed into the desired shape in a mold, and sintered by means such as hot isostatic pressing (HIP) or spark plasma sintering (SPS). The ceramic may have relatively high density. In an embodiment, hollow parts such as the EM pump tube 5k6 may be cast using a balloon for the hollow part. The balloon may be deflated following casting and the part sintered. Alternatively, the parts may be fabricated by 3D printing. Parts such as at least one of the lower hemisphere 5b41 and upper hemisphere 5b42 may be slip cast, and parts such as the reservoirs 5c may be formed by at least one of extrusion and pressing. Other methods of fabrication comprise at least one of spray drying, injection molding, machining, metallization, and coating.

In an embodiment, carbide ceramic parts may be fabricated as graphite that is reacted with the corresponding metal such as zirconium or silicon to make ZrC or SiC parts, respectively. Parts comprising different ceramics may be joined together by methods of the disclosure or methods known in the art such as threading, gluing, wet sealing, brazing, and gasket sealing. In an embodiment, the EM pump tube may comprise tube sections and elbows and bus bar tabs 5k2 that are glued together. In an exemplary embodiment, the glued EM pump tube parts comprise ZrC or graphite that is reacted with Zr metal to form ZrC. Alternatively, the parts may comprise ZrB₂ or similar non-oxidative conductive ceramic.

In an embodiment, the MHD electrodes 304 comprise liquid electrodes such as liquid silver electrodes. At least one of the MHD electrical leads 305 and feed throughs 301 may comprise solidified molten metal such as solidified silver analogous to a wet seal wherein at least one of the leads or feed throughs may be cooled to maintain the solid metal state. The MHD converter may comprise a patterned structure that comprises at least one component of the group of the MHD electrodes 304, electrically insulated leads such as 305, insulating electrode separators, and feed throughs such as ones that penetrate MHD bus bar feed through flange such as 310. The patterned structure components comprising the liquid electrodes such as silver ones and insulating separators may comprise a wicking material to maintain the liquid metal in the desired shape and spacing of the liquid electrodes such as silver ones with the insulating electrode separators in between. At least one of the wicking material and insulating separators of the patterned structure may comprise ceramic. The wicking material of the liquid electrodes may comprise porous ceramic. The electrical insulating separator may comprise dense ceramic that may be non-wetting towards the silver. The leads may comprise electrical insulating channels and tubes that may be cooled such as water-cooled to maintain the solidity of the lead. An exemplary embodiment comprises the electrically insulated MHD electrode lead 305 that is cooled to maintain solidified silver inside to serve as the conductive lead. In another embodiment, at least one of the MHD electrical leads 305 and feed throughs 301 may comprise iridium such as a coating such as iridium-coated Mo or an oxidation resistant stainless steel such as 625 SS.

Exemplary materials for the SunCell® with a MHD converter comprise (i) reservoirs 5c, reaction cell chamber 5b31, and nozzle 307: solid oxide such as stabilized zirconia or hafnia, (ii) MHD channel 308: MgO or Al₂O₃, (iii) electrodes 304: ZrC, or ZrC—ZrB₂, ZrC—ZrB₂—SiC, and ZrB₂ with 20% SiC composite that may work up to 1800° C., or metal coated with a noble metal, (iv) EM pump 5ka: metal such as stainless steel coated with a noble metal such as at least one of platinum (Pt), palladium (Pd), ruthenium (Ru), rhodium (Rh), and iridium (Ir) or 410 stainless steel coated with a material having a similar coefficient of thermal expansion such as Paloro-3V palladium-gold-vanadium alloy (Morgan Advanced Materials), (v) reservoir 5c-EM pump assembly 5kk union: an oxide reservoir such as ZrO₂, HfO₂, or Al₂O₃ that is brazed to a 410 stainless steel EM assembly 5kk base plate wherein the braze comprises Paloro-3V palladium-gold-vanadium alloy (Morgan Advanced Materials), (vi) injector 5k61 and inlet riser tube 5qa: solid oxide such as stabilized zirconia or hafnia, and (vii) oxygen selective membrane: BaCo_{0.7}Fe_{0.2}Nh_{0.1}O_{3-δ} (BCFN) oxygen permeable membrane that may be coated with Bi₂₆Mo₁₀O₆₉ to increase the oxygen permeation rate.

In an embodiment, the SunCell® further comprises an oxygen sensor and an oxygen control system such as a means to at least one of dilute the oxygen with a noble gas and pump away the noble gas. The former may comprise at least one of a noble gas tank, valve, regulator, and pump. The latter may comprise at least one of a valve and pump.

The hydrino reaction mixture of the reaction cell chamber 5b31 may further comprise a source of oxygen such as at least one of H₂O and a compound comprising oxygen. The source of oxygen such as the compound comprising oxygen may be in excess to maintain a near constant oxygen source inventory wherein during cell operation a small portion reversibly reacts with the supplied source of H such as H₂ gas to form HOH catalyst. Exemplary compounds comprising oxygen are MgO, CaO, SrO, BaO, ZrO₂, HfO₂, Al₂O₃, Li₂O, LiVO₃, Bi₂O₃, Al₂O₃, WO₃, and others of the disclosure. The oxygen source compound may be the one used to stabilize the oxide ceramic such as yttria or hafnia such as yttrium oxide (Y₂O₃), magnesium oxide (MgO), calcium oxide (CaO), strontium oxide (SrO), tantalum oxide (Ta₂O₅), boron oxide (B₂O₃), TiO₂, cerium oxide (Ce₂O₃), strontium zirconate (SrZrO₃), magnesium zirconate (MgZrO₃), calcium zirconate (CaZrO₃), and barium zirconate (BaZrO₃).

In an exemplary embodiment wherein the conductivity is greater than about 20 kS/m and the plasma gas temperature is about 4000 K, the reaction chamber pressure is maintained in the range of about 15 MPa to 25 MPa to maintain flow in the MHD channel 308 against the Lorentz force. In an exemplary embodiment, the conductivity is maintained at about 700 S/m, the plasma gas temperature is about 4000 K, the reaction cell chamber 5b31 pressure is about 0.6 MPa, the nozzle 307 exit velocity is about Mach 1.24, the nozzle exit area is about 3.3 cm², the nozzle exit diameter is about 2.04 cm, the nozzle exit pressure is about 213 kPa, the temperature at the nozzle exit is about 2640 K, mass flow through the nozzle is about 250 g/s, the magnetic field strength in the MHD channel 308 is about 2 T, the MHD channel 308 length is about 0.2 m, the MHD channel exit pressure is about 11 kPa, the MHD channel exit temperature is about 1175 K, and the output electrical power is about 180 kW. In an ideal embodiment, the efficiency is determined by the Carnot equation wherein the non-avoidable losses of power from the plasma temperature to ambient temperature are the gas and liquid metal pump losses.

In an embodiment, an MHD converter for any power source such as nuclear or combustion capable of heating silver to form at least one of silver vapor and silver aerosol comprises the MHD converter of the disclosure further comprising at least one heat exchanger to transfer heat from the power source to heat at least one of the reservoirs 5c and the reaction cell chamber 5b31 to produce at least one of silver vapor and silver aerosol. The MHD converter may further comprise a source of ionization such as at least one of seeding such as an alkali metal such as cesium that is thermally ionized and an ionizer such as a laser, an RF discharge generator, a microwave discharge generator, and a glow discharge generator.

In an embodiment of the SunCell® power system comprising a heater power converter, the EM pumps of the dual molten metal injectors may each comprise an inductive type electromagnetic pump to inject the stream of the molten metal that intersects with the other inside of the vessel. The source of electrical power of the ignition system may comprise an induction ignition system 410 that may comprise a source of alternating magnetic field through a shorted loop of molten metal that generates an alternating current in the metal that comprises the ignition current. The source of alternating magnetic field may comprise a primary transformer winding 411 comprising a transformer electromagnet and a transformer magnetic yoke 412, and the silver may at least partially serve as a secondary transformer winding such as a single turn shorted winding that encloses the primary transformer winding and comprises as an induction current loop. The reservoirs 5c may comprise a molten metal cross connecting channel 414 that connects the two reservoirs such that the current loop encloses the transformer yoke 412 wherein the induction current loop comprises the current generated in molten silver contained in the reservoirs 5c, the cross connecting channel 414, the silver in the injector tubes 5k61, and the injected streams of molten silver that intersect to complete the induction current loop. The reaction gases such as hydrogen and oxygen may be supplied to the cell through the gas inlet and evacuation assembly 309e of gas housing 309b. The gas housing 309e may be outside of a spherical heat exchanger along the axis of the top pole of the sphere. The gas housing may comprise a thin gas line connection to the top of the spherical reaction cell chamber 5b31 at a flange connection. The gas line connection may run inside of a concentric coolant flow pipe that supplies coolant flow to the spherical heat exchanger. On the reaction cell side, the flange connection to the gas line may connect to a semipermeable gas 309d membrane such as a porous ceramic membrane.

A SunCell® heater or thermal power generator embodiment (FIG. 2I196) comprises a spherical reactor cell 5b31 with a spatial separated circumferential half-spherical heat exchanger 114 comprising panels or sections 114a that receive heat by radiation from the spherical reactor 5b4. Each panel may comprise a section of a spherical surface defined by two great circles through the poles of the sphere. The heat exchanger 114 may further comprise a manifold 114b such as a toroid manifold with coolant lines 114c from each of the panels 114a of the heat exchanger and a manifold coolant outlet 114f. Each collant line 114c may comprise a coolant inlet port 114d and a coolant outlet port 114e. The thermal power generator may further comprise a gas cylinder 421 with has inlet and outlet 309e and a gas supply tube 422 that runs through the top of the heat exchanger 114 to the gas permeable membrane 309d on top of the spherical cell 5b31. The gas supply tube 422 can run through the coolant collection manifold 114b at the top of the heat exchanger 114. In another SunCell® heater embodiment (FIGS. 2I156-2I160 and 2I196), the reaction cell chamber 5b31 may be cylindrical with a cylindrical heat exchanger 114. The gas cylinder 421 may be outside of the heat exchanger 114 wherein the gas supply tube 422 connects to the semipermeable gas membrane 309d on the top of the reaction cell chamber 5b31 by passing through the heat exchanger 114. Cold water may be fed in inlet 113 and heated in heat exchanger 114 to form steam that collects in boiler 116 and exists steam outlet 111. The thermal power generator may further comprise dual molten metals injectors comprising induction EM pumps 400, reservoirs 5c, and reaction cell chamber 5b31. At least one SunCell® heater component such as the reservoirs 5c may be heated with an inductively coupled heater antenna 5f. The SunCell® heater may comprise an induction ignition system such as one comprising an induction ignition transformer winding 411 and an induction ignition transformer yoke 412.

### Exemplary Embodiments

In an exemplary embodiment of a SunCell® electrical generator of the disclosure comprising a PV converter: (i) the EM pump assembly 5kk may comprise stainless steel wherein surfaces exposed to oxidation such as the inside of the EM pump tube 5k6 may be coated with an oxidation resistant coating such as a nickel coating wherein the stainless steel such as Inconel is selected to have a similar coefficient of thermal expansion as that of nickel, (ii) the reservoirs 5c may comprise boron nitride such as BN—Ca that may be stabilized against oxidation, (iii) the union between the reservoir and the EM pump assembly 5kk may comprise a wet seal, (iv) the molten metal may comprise silver, (v) the inlet riser 5qa and injection tube 5k61 may comprise ZrO₂ threaded into a collar in the EM pump assembly base plate 5kk1, (vi) the lower hemisphere 5b41 may comprise carbon such a pyrolytic carbon that is resistant to reaction with hydrogen, (vii) the upper hemisphere 5b42 may comprise carbon such a pyrolytic carbon that is resistant to reaction with hydrogen, (viii) the source of oxygen may comprise CO wherein the CO may be added as a gas, supplied by the controlled thermal or other decomposition of a carbonyl such as a metal carbonyl (e.g. W(CO)₆, Ni(CO)₄, Fe(CO)₅, Cr(CO)₆, Re₂(CO)₁₀, and Mn₂(CO)₁₀), and supplied as a source of CO₂ or CO₂ gas wherein the CO₂ may decompose in the hydrino plasma to release CO or may react with carbon such as supplied sacrificial carbon powder to supply the CO, or O₂ may be added through an oxygen permeable membrane of the disclosure such as one of the disclosure such as BaCo_{0.7}Fe_{0.2}Nb_{0.1}O_{3-δ} (BCFN) oxygen permeable membrane that may be coaled with Bi₂₆Mo₁₀O₆₉ to increase the oxygen permeation rate wherein added O₂ that may react with sacrificial carbon powder to maintain a desired CO concentration as monitored with a detector and controlled with a controller, (ix) the source of hydrogen may comprise H₂ gas that may be supplied through a hydrogen permeable membrane such as a Pd or Pd—Ag membrane in the EM pump tube 5k4 wall using a mass flow controller to control the hydrogen flow from a high-pressure water electrolyzer, (x) the union between the reservoir and the lower hemisphere 5b41 may comprise a slip nut that may comprise a carbon gasket and a carbon nut, and (xi) the PV converter may comprise a dense receiver array comprising multi junction III-V PV cells that are cooled by cold plates. The reaction cell chamber 5b31 may comprise a source of sacrificial carbon such as carbon powder to scavenge O₂ and H₂O that would otherwise react with the walls of a carbon reaction cell chamber. The reaction rate of water with carbon is dependent on the surface area that is many orders of magnitude greater in the case of the sacrificial carbon compared to the surface area of the reaction cell chamber 5b31 walls. In an embodiment, the inside wall of the carbon reaction cell chamber comprises a carbon passivation layer. In an embodiment, the inner wall of the reaction cell chamber is coated with a rhenium coating to protect the wall from H₂O oxidation. In an embodiment, the oxygen inventory of the SunCell® remains about constant. In an embodiment, addition oxygen inventory may be added as at least one of CO₂, CO, O₂, and H₂O. In an embodiment, the added H₂ may react with the sacrificial powdered carbon to form methane such that the hydrino reactants comprise at least one hydrocarbon formed from the elements of O, C, and H such as methane and at least one oxygen compound formed from the elements of O, C, and H such as CO or CO₂. The oxygen compound and hydrocarbon may serve as the oxygen source and H source, respectively, to form HOH catalyst and H.

The SunCell® may further comprise carbon monoxide safety systems such as at least one of CO sensors, a CO vent, a CO diluent gas, and a CO absorbent. CO may be limited in at least one of concentration and total inventory to provide safety. In an embodiment, the CO may be confined to the reaction chamber 5b31 and optionally the outer vessel chamber 5b3a1. In an embodiment, the SunCell® may comprise a secondary chamber to confine and dilute any CO that leaks from the reaction cell chamber 5b31. The secondary chamber may comprise at least one of the cell chamber 5b3, the outer vessel chamber 5b3a1, the lower chamber 5b5, and another chamber that may receive the CO to at least one of contain and dilute leaked CO to a safe level. The CO sensor may detect any leaked CO. The SunCell® may further comprise at least one of a tank of dilution gas, a diluent gas tank valve, an exhaust valve, and a CO controller to receive input from the CO sensor and control the opening and flow in the valves to dilute and release or vent the CO at a rate such that its concentration does not exceed a desired or safe level. A CO absorbent in a chamber to which the leaked CO is contained may also absorb the leaked CO. Exemplary CO absorbents are cuprous ammonium salts, cuprous chloride dissolved in HCl solution, ammoniacal solution, or ortho anisidine, and others known by those skilled in the art. Any vented CO may be in a concentration of less than about 25 ppm. In an exemplary embodiment wherein the reaction cell chamber CO concentration is maintained at about 1000 ppm CO and the reaction cell chamber CO comprises the total CO inventory, the outer containment or secondary chamber volume relative to reaction cell chamber volume is greater than 40 times larger such that the SunCell® is inherently safe to CO leakage. In an embodiment, the SunCell® further comprises a CO reactor such as an oxidizer such as a combustor or a decomposer such as a plasma reactor to react CO to a safe product such as CO₂ or C and O₂. An exemplary catalytic oxidizer product is Marcisorb CO Absorber comprising Moleculite (Molecular, http://www.molecularproducts.com/productslinarcisorb-co-absorber).

In an embodiment, hydrogen may serve as the catalyst. The source of hydrogen to supply nH (n is an integer) as the catalyst and H atoms to form hydrino may comprise H₂ gas that may be supplied through a hydrogen permeable membrane such as a Pd or Pd—Ag such as 23% Ag/77% Pd alloy membrane in the EM pump tube 5k4 wall using a mass flow controller to control the hydrogen flow from a high-pressure water electrolyzer. The use of hydrogen as the catalyst as a replacement for HOH catalyst may avoid the oxidation reaction of at least one cell component such as a carbon reaction cell chamber 5b31. Plasma maintained in the reaction cell chamber may dissociate the H₂ to provide the H atoms. The carbon may comprise pyrolytic carbon to suppress the reaction between the carbon and hydrogen.

In an exemplary embodiment of the SunCell® heater of the disclosure: (i) the EM pump assembly 5kk may comprise stainless steel wherein surfaces exposed to oxidation such as the inside of the EM pump tube 5k6 may be coated with an oxidation resistant coating such as a nickel coating, (ii) the reservoirs 5c may comprise ZrO₂ stabilized in the cubic form by MgO or Y₂O₃, (iii) the union between the reservoir and the EM pump assembly 5kk may comprise a wet seal, (iv) the molten metal may comprise silver, (v) the inlet riser 5qa and injection tube 5k61 may comprise ZrO₂ threaded into a collar in the EM pump assembly base plate 5kk1, (vi) the lower hemisphere 5b41 may comprise ZrO₂ stabilized in the cubic form by MgO or Y₂O₃, (vii) the upper hemisphere 5b42 may comprise ZrO₂ stabilized in the cubic form by MgO or Y₂O₃, (viii) the source of oxygen may comprise a metal oxide such as and alkali or alkaline earth oxide or mixtures thereof, (ix) the source of hydrogen may comprise H₂ gas that may be supplied through a hydrogen permeable membrane in the EM pump tube 5k4 wall using a mass flow controller to control the hydrogen flow from a high-pressure water electrolyzer, (x) the union between the reservoir and the lower hemisphere 5b41 may comprise ceramic glue, (x) the union between the lower hemisphere 5b41 and the upper hemisphere 5b42 may comprise ceramic glue and (xi) the heat exchanger may comprise a radiant boiler. In an embodiment, at least one of the lower hemisphere 5b41 and the upper hemisphere 5b42 may comprise a material with high thermal conductivity such as a conductive ceramic such as one of the disclosure such as at least one of ZrC, ZrB₂, and ZrC—ZrB₂ and ZrC—ZrB₂—SiC composite that is stable to oxidation to 1800° C. to improve the heat transfer from the interior to the exterior of the cell.

In an exemplary embodiment of a SunCell® electrical generator of the disclosure comprising a magnetohydrodynamic (MHD) converter: (i) the EM pump assembly 5kk may comprise stainless steel wherein surfaces exposed to oxidation such as the inside of the EM pump tube 5k6 may be coated with an oxidation resistant coating such as a nickel coating, (ii) the reservoirs 5c may comprise ZrO₂ stabilized in the cubic form by MgO or Y₂O₃, (iii) the union between the reservoir and the EM pump assembly 5kk may comprise a wet seal, (iv) the molten metal may comprise silver, (v) the inlet riser 5qa and injection tube 5k61 may comprise ZrO₂ threaded into a collar in the EM pump assembly base plate 5kk1, (vi) the lower hemisphere 5b41 may comprise ZrO₂ stabilized in the cubic form by MgO or Y₂O₃, (vii) the upper hemisphere 5b42 may comprise ZrO₂ stabilized in the cubic form by MgO or Y₂O₃, (viii) the source of oxygen may comprise a metal oxide such as and alkali or alkaline earth oxide or mixtures thereof, (ix) the source of hydrogen may comprise H₂ gas that may be supplied through a hydrogen permeable membrane in the EM pump tube 5k4 wall using a mass flow controller to control the hydrogen flow from a high-pressure water electrolyzer, (x) the union between the reservoir and the lower hemisphere 5b41 may comprise ceramic glue, (x) the union between the lower hemisphere 5b41 and the upper hemisphere 5b42 may comprise ceramic glue, (xi) the MHD nozzle 307, channel 308, and condensation 309 sections may comprise ZrO₂ stabilized in the cubic form by MgO or Y₂O₃, (xii) the MHD electrodes 304 may comprise Pt coated refractory metal such as Pt-coated Mo or W, carbon that is stable to water reaction to 700° C., ZrC—ZrB₂ and ZrC—ZrB2—SiC composite that is stable to oxidation to 1800° C., or a silver liquid electrode, and (xiii) the MHD return conduit 310, return EM pump 312, return EM pump tube 313 may comprise stainless steel wherein surfaces exposed to oxidation such as the inside of the tubing and conduits may be coated with an oxidation resistant coating such as a nickel coating. The MHD magnet 306 may comprise a permanent magnet such as a cobalt samarium magnet having 1 T magnetic flux density.

In an exemplary embodiment of a SunCell® electrical generator of the disclosure comprising a magnetohydrodynamic (MHD) converter: (i) the EM pump may comprise a two-stage induction-type wherein the 1^{st} stage serves as the MHD return pump and the 2^{nd} stage serves as the injection pump, (ii) the EM pump tube section of the current loop 405, the EM pump current loop 406, the joint flanges 407, the reservoir baseplate assembly 409, and the MHD return conduit 310 may comprise quartz such as fused quartz, silicon nitride, alumina, zirconia, magnesia, or hafnia, (iii) the transformer windings 401, the transformer yokes 404a and 404b, and the electromagnets 403a and 403b may be water cooled; (iv) the reservoirs 5c, the reaction cell chamber 5b31, the MHD nozzle 307, MHD channel 308, MHD condensation section 309, and gas housing 309b may comprise quartz such as fused quartz, silicon nitride, alumina, zirconia, magnesia, or hafnia wherein the ZrO₂ stabilized in the cubic form by MgO or Y₂O₃, (v) at least one of the gas housing 309b and MHD condensation section 309 may comprise may comprise stainless steel such as 625 SS or iridium coated Mo, (vi) (a) the unions between components may comprise flange seals with gaskets such as carbon gaskets, glued seals, or wet seals wherein wet seal may join dissimilar ceramics or ceramic and metallic parts such as stainless steel parts, (b) flange seals with graphite gaskets may join metallic parts or ceramic to metallic parts that operated below the carbonization temperature of the metal, and (c) flange seals with gaskets may join metallic parts or ceramic to metallic parts wherein graphite gaskets contacts a metallic portion of the seal comprising a metal or coating such as nickel that is not prone to carbonization, or another high-temperature gasket is used at a suitable operating temperature, (vii) the molten metal may comprise silver, (viii) the inlet riser 5qa and injection tube 5k61 may comprise ZrO₂ threaded into a collar in the reservoir baseplate assembly 409, (ix) the source of oxygen and the source of hydrogen may comprise O₂ gas and H₂ gas, respectively, that may be supplied through a gas permeable membrane 309d in the MHD condensation section 309 wall using a mass flow controller to control each gas flow from a high-pressure water electrolyzer, (x) the MHD electrodes 304 may comprise Pt coated refractory metal such as Pt-coated Mo or W, carbon that is stable to water reaction to 700° C., ZrC—ZrB₂ and ZrC—ZrB₂—SiC composite that is stable to oxidation to 1800° C. or a silver liquid electrode, and (xi) the MHD magnets 306 may comprise permanent magnets such as a cobalt samarium magnets having a magnetic flux density in the range of about 0.1 to 1 T.

In an embodiment, the SunCell® power source may comprise an electrode such as the cathode that comprises a refractory metal such as tungsten that may penetrate the wall of the blackbody radiator 5b4 and a molten metal injector counter electrode. The counter electrode such as the EM pump tube injector 5k61 and nozzle 5q may be submerged. Alternatively, the counter electrode may be comprised of an electrically insulating, refractory material such as cubic ZrO₂ or hafnia. The tungsten electrode may be sealed at the penetration of the blackbody radiator 5b4. The electrodes may be electrically isolated by an electrical insulator bushing or spacer between the reservoir 5c and the blackbody radiator 5b4. The electrical insulator bushing or spacer may comprise BN or a metal oxide such as ZrO₂, HfO₂, MgO, or Al₂O₃. In another embodiment, the blackbody radiator 5b4 may comprise an electrical insulator such as a refractory ceramic such as BN or metal oxide such as ZrO₂, HfO₂, MgO, or Al₂O₃.

### Other Embodiments

In an embodiment, the SunCell® may comprise a water absorber that reversibly bonds water from the atmosphere, a means to transfer heat from a hot component of the SunCell® such as the heat exchanger 26a to the water laden absorber, a condenser to condense released water, and a collection vessel to receive the condensed water to be used in the SunCell®. In an embodiment, at least one of the source of HOH catalyst and the source of H to provide HOH catalyst and H reactant to form hydrinos may be atmospheric water. The water may be collected using water absorbing material and then dehydrated to release the absorbed water. The water may be dehydrated or desorbed by using heat provided by the SunCell®. The water absorbing material may comprise a metal organic framework such as a combination of zirconium metal and adipic acid or M₂Cl₂(BTDD) (M=Mn (1), Co (2), Ni (3); BTDD=bis(1H-1,2,3-triazolo[4,5-b],[4′,5′-l]dibenzo[1,4]dioxin that binds water vapor and releases it to a condenser upon heating.

In an embodiment, the SunCell® comprises a reaction mixture that forms hydrinos as a reaction product. The reaction may form energetic plasma. The reaction mixture may further comprise a source of carbon such as at least one of graphite and a hydrocarbon. The energetic plasma may bombard solid carbon or carbon deposited on a substrate from the source of carbon. In an embodiment, the bombardment converts graphitic carbon to diamond form of carbon. In exemplary embodiments described in Mills publications R. L. Mills, J. Sankar, A. Voigt, J. He, B. Dhandapani, “Synthesis of HDLC Films from Solid Carbon,” J. Materials Science, J. Mater. Sci. 39 (2004) 3309-3318 and R. L. Mills, J. Sankar, A. Voigt, J. He, B. Dhandapani, “Spectroscopic Characterization of the Atomic Hydrogen Energies and Densities and Carbon Species During Helium-Hydrogen-Methane Plasma CVD Synthesis of Diamond Films,” Chemistry of Materials, Vol. 15, (2003), pp. 1313-1321 incorporated by reference, the SunCell® comprises the energetic plasma source to cause formation of diamond from non-diamond form of carbon. The production of diamond may be measured by the presence of the 1333 cm⁻¹ Raman peak.

Molecular hydrino gas may be purified and isolated by ionizing ordinary hydrogen. The ionized hydrogen may be separated removed by at least one of electric and magnetic fields. Alternatively, the ordinary hydrogen can be removed by reaction with a reactant that forms a condensable reaction product wherein the reaction is made favorable by the plasma condition. An exemplary reactant is nitrogen that forms condensable ammonia that is removed in a cryotrap to yield purified molecular hydrino gas. Alternatively, molecular hydrino gas may be purified and isolated using molecular sieves that separate ordinary hydrogen from molecular hydrino gas based on the higher diffusion of the latter. An exemplary separatory molecular sieve is Na₈(Al₆Si₆O₂₄)Cl₂.

In an embodiment, the thermal energy from the blackbody radiator may be used to heat a catalyst such as CeO₂ that reacts with a mixture of CO₂ and H₂O to form syngas (CO+H₂). The syngas may be used to form hydrocarbon fuel. The fuels reactor may comprise a Fischer Tropsch reactor.

In an embodiment, the hydrino reaction plasma comprising water vapor may further comprise argon. The argon may serve at least one role of increasing the H atom concentration by increasing the H₂ molecular recombination time, increasing the nascent HOH concentration by interfering with water hydrogen bonding, and providing an additional source of catalyst such as Ar⁺ catalyst.

The hydrino reaction may be propagated in a solid fuel comprising water in an organized or repeating structure such a crystalline lattice. The solid fuel may comprise a hydrate that may be crystalline. The solid fuel may comprise a crystalline form of water such as ice such as Type I ice. The ice solid fuel may be energetic wherein the energy release may comprise an impulse. The impulse may be carried out in a sequential manner to provide power over an extended to indefinite duration such as in the case of ignition of air-fuel in an internal combustion engine. The ice fuel system comprises a means to cause a shock wave in ice. The ice fuel system may comprise a means of shock wave confinement. The means of confinement may comprise an ice encasement. The encasement may comprise a shell such as a metal shell. At lease one of the shock wave and confinement may cause the shock wave to break at least one of some of the hydrogen bonds between the water molecules of ice and at least one oxygen hydrogen bond of some of the water molecules. The ice fuel system may comprise an explosive to create the shock wave in the crystalline structure comprising H₂O such as ice. The explosive may comprise one of the C—N—O—H type, another such as a hydrogen-oxygen explosive, or another known to those skilled in the art. The explosive may be in close proximity to the crystalline structure such as ice to effectively couple the shock wave into the crystalline structure. The explosive may be embedded in at least one channel in the crystalline structure such as ice.

Alternatively, the ice fuel system may comprise an electrical means to create the shock wave in ice such as at least one exploding wire. The exploding wire may comprise a source of high power such as a source of at least one of high voltage and current. The source of high electrical power may comprise at least one capacitor. The capacitor may be capable of high voltage and current. The discharge of the at least one capacitor through the at least one wire may cause it to explode. The wire explosive system may comprise a thin conductive wire and a capacitor. Exemplary wires are ones comprising gold, aluminum, iron, or platinum. in an exemplary embodiment, the wire may be less than 0.5 mm in diameter, and the capacitor may have an energy consumption of about 25 kWh/kg and discharge a pulse of charge density of 10⁴-10⁶ A/mm², leading to temperatures up to 100,000 K wherein the denotation may occur over a time period of about 10⁻⁵-10⁻⁸ seconds. Specifically, a 100 μF oil filled capacitor may be charged to 3 kV using a DC power supply, and the capacitor may be discharged through a 12 inch length of 30 gauge bare iron wire using a knife switch or gas arc switch wherein the wire is embedded in ice that is confined in a steel casing. The ice fuel system may further comprise a source of electricity such as at lest one of a battery, a fuel cell, and a generator such as a SunCell® to charge the capacitor. An exemplary energetic material comprises Ti+Al+H₂O (ice) that is ignited by the exploding wire that may comprise at least one of Ti, Al, and another metal.

In an embodiment, an energetic reaction mixture and system may comprise a hydrino fuel mixture such as one of those of the disclosure and in Prior Applications, which are incorporated by reference. The reaction mixture may comprise water in at least one physical state such as frozen solid state, liquid, and gaseous. The energetic reaction may be initiated by applying a high current such as a current in the range of about 20 A to 50,000 A. The voltage may be low such as in the range of about 1 V to 100 V. The current may be carried through a conductive matrix such as a metal matrix such as Al, Cu, or Ag metal powder. Alternatively, the conductive matrix may comprise a vessel such as a metal vessel wherein the vessel may enclose or encase the reaction mixture. Exemplary metal vessels comprise Al, Cu, or Ag DSC pans. Exemplary energetic reaction mixtures comprising frozen water (ice) or liquid water comprise at least one of Al crucible Ti+H₂O; Al crucible Al+H₂O; Cu crucible Ti+H₂O; Cu crucible Cu+H₂O; Ag crucible Ti+H₂O; Ag crucible Al+H₂O; Ag crucible Ag+H₂O; Ag crucible Cu+H₂O; Ag crucible Ag+H₂O O+NH₄NO₃ (mole 50:25:25); Al crucible Al+H₂O+NH₄NO₃ (mole 50:25:25).

In addition to being in a frozen state as ice, the water may comprise a solid state in the bound form such as one in the form of a hydrate. The reaction mixture may comprise a (i) a source of oxygen such as a peroxide, (ii) a source of hydrogen such as at least one of a metal hydride, water and a water reactant such as a reductant such as a metal such as a metal powder, and a hydrocarbon such as fuel oil, and (iii) a conductive matrix such as a metal powder. An exemplary reaction mixture comprises Al crucible Ti or TiH+Na₂O₂ or hydrated Na₂O₂ such as at least one of Na₂O_{2.}2H₂O₂.4H₂O, Na₂O₂.2H₂O, Na₂O₂.2H₂O₂, and Na₂O₂.8H₂O. The reaction mixture may be ignited with a low voltage high current such as about 15 V and 27,000 A, respectively.

In an embodiment, the hydrino reaction mixture may comprise water reactive metal such as an alkali or alkaline earth metal that may have a high surface area such as a particulate metal. The metal particles may comprise a protective coat such as an oxide coat. An exemplary hydrino reactant comprises particulate Li metal having an oxide coat. The reaction mixture may further comprise water or ice. In an embodiment, the particulate metal is added to cold water such as 1° C. water and is rapidly frozen. The rapid freezing may be achieved with liquid nitrogen to avoid the metal reacting. The reaction mixture may comprise a conductive matrix such as one of the disclosure.

The exploding wire may be in proximity to the crystalline structure such as ice to cause a shock wave to propagate in the ice. The wire may be embedded in the ice to cause the shock wave to effectively couple to the ice. In an embodiment, a plurality of wires embedded in ice are detonated such that the shock wave and compression propagate through the ice shattering the crystalline ice structure to form H and HOH catalyst to form hydrinos. The exploding wires may create electrically conductive plasma pathways that support high kinetics due to conductive arc currents that at least one of recombine ions and reduce the space change due to ionization of the catalyst during catalysis to increase the reaction rate. The crystalline structure such as ice may further comprise a conductor such as embedded metal such as metal wires, metal power, or metal grids to increase the kinetics due to their conductivity. The metal may be highly conductive and chemically stable to water such as silver or copper. In an embodiment, the ice is embedded in a conductive matrix such as a metal mesh such as copper, nickel, silver, or aluminum mesh such as a Celmet (Sumitomo Electric Industries, Ltd.) type mesh.

In an embodiment, the ice fuel system may comprise reactants that release heat and produce hydrogen that detonates with oxygen to create a shock wave in ice wherein the reactants may be embedded and confined in the ice. The reactants may comprise thermite such as Fe₂O₃/Al metal powder mixture that is at least partially embedded and encased in ice. The encasement may comprise a metal container. The thermite may comprise a molar excess of aluminum to react with water to form H₂ gas to serve as an explosive with atmospheric oxygen. The excess metal may also serve as a conductor to increase the reaction rate.

In an embodiment, recruitment of the energetic material such as one comprising water in a suitable form such as ice and optionally an additive such as such one that comprises at least one of a source of hydrogen and conductivity such as a metal such as a high surface area metal such as Al powder or an alkali metal powder such as lithium powder. The energetic material may be confined such that the shock wave produced by the ignition of the energetic material is confined. The confinement of the shock wave may facilitate the breaking of bonds of H₂O to supply H and HOH. The energetic material may be encased in a sealed vessel such as metal vessel to provide the confinement. In an embodiment, the ignition may be performed by passing high current through at least one wire that passes through the energetic material or is in close proximity to the energetic material wherein the high current may cause the wire or wires to explode. The wire explosion may produce a shock wave in the energetic material. The wires may be arranged to enhance the shock wave in the energetic material. In an exemplary embodiment, the wires may run parallel to each other to compress the energetic material from a plurality of directions. In another embodiment, an implosion may be created in the energetic material wherein the shock wave in the energetic material is directed inward. The inward shock wave may be spherically inward. The implosion may be created by at least one of wire detonation(s) and detonation of conventional explosives such as TNT. The explosives may be shaped to produce the implosion. The explosives may comprise spherically shaped charges. The implosion and shock wave in ice may cause ice to detonate. An exemplary energetic material device may comprise ice having a surrounding spherical shockwave source such as a conventional explosive ignited with an exploding wire. At least one of confinement and implosion involving energetic material may cause detonation recruitment of additional energetic material. In an embodiment, the detonating wire may comprise an enclosing structure such as a solenoid or toroid that surrounds the source of HOH and H such as water such as ice to cause it to implode to more effectively form the HOH and H to react to form hydrinos.

In another embodiment, the crystalline solid fuel is replaced with the corresponding liquid such as liquid water.

In an embodiment, an energetic reaction system comprises a source of at least one of HOH catalyst and H such as water in any physical state such as gas, liquid, or solid such as Type I ice and a source of detonation to cause a shock wave. In an embodiment, the energetic reaction system comprises a plurality of source of shock waves. The source of the shock wave may comprise at least one of one or more exploding wires such as one of the disclosure and one or more charges of conventional energetic material such as TNT or another of the disclosure. The energetic reaction system may comprise at least one detonator of the conventional energetic material. The energetic reaction system may further comprise a sequential trigger means such as delay line or at least one timed switch to cause the formation of a plurality of shock waves with a time delay between at least a first and another shock wave. The sequential trigger may cause a delay in detonation to cause a delay between a first and at least one other detonation wherein each detonation forms a shock wave. The trigger may delay power applied to at least one of the exploding wire and the detonator of the conventional energetic material. The delay time may be in at least one range of about 1 femtosecond to 1 second, 1 nanosecond to 1 second, 1 microsecond to 1 second, and 10 microseconds to 10 milliseconds.

In an embodiment, the SunCell® may comprise a chemical reactor wherein reactions other than or in addition to hydrino reactants may be supplied to the reactor to form a desired chemical product. The reactant may be supplied thorugh the EM pump tube. The product may be extracted through the EM pump tube. The reactants may be added in batch before the reactor is closed and the reaction initiated. The products may be removed in batch by opening the reactor following its operation. The rection product may be extracted by permeation through the reactor wall such as the reaction cell chamber wall. The reactor may provide continuous plasma at a blackbody temperature in the range of 1250 K to 10,000K. The reactor pressure may be in the range of 1 atm to 25 atm. The wall temperature may be in the range of 1250 K to 4000 K. The molten metal may comprise one the supports the desired chemical reaction such as at least one of silver, copper, and silver-copper alloy.

In an embodiment, the exploding wire packed in ice may comprise a transition metal such as at least one of Sc, Ti, V, Cr, Mn, Fe, Co, Ni, Cu, and Zn. The wire may further comprise aluminum. The detonation voltage may be a high voltage such as a voltage in at least one range of 1000 V to 100,000 V and 3000 V to 10,000 V. A thin film comprising transition metal and hydrino hydrogen may form such as iron, chromium, or manganese hydrino hydride, molecular hydrino complex, or atomic hydrino complex. FeH wherein H comprises hydrino was formed by detonation of a wire comprising an alloy of Fe, Cr, and Al using 4000 V and kiloamps. The FeH was identified by ToF-SIMs. Other compounds comprising hydrino hydrogen and another element such as another metal may be formed by using an exploding wire comprising the corresponding element such as another metal.

In an embodiment, a means to form macro-aggregates or polymers comprising lower-energy hydrogen species such as molecular hydrino comprises a source of HOH and a source of H such as water in any physical state such as at least one of gas, liquid, and ice, and may further comprise a source of high current such as a detonating wire. The means to form macro-aggregates or polymers comprising lower-energy hydrogen species such as molecular hydrino further comprises a reaction chamber to confine the hydrino reaction products. Exemplary hydrino reactants are water vapor in air or another gas such as a noble gas. The water vapor pressure may be in the range of 1 mTorr to 1000 Torr. The hydrino reaction may be initiated by the detonation of a wire by electrical power. In an exemplary embodiment, a wire of the disclosure is detonated in a cavity containing ambient water vapor in air by using a detonation means of the disclosure. The ambient water vapor pressure may be in the range of about 1 to 50 Torr. Exemplary products are iron-hydrino polymer such as FeH₂(1/4) and molybdenum-hydrino polymer such as MoH(1/4)₁₆. The products may be identified by unique physical properties such as novel composition such as ones comprising metal and hydrogen such as iron-hydrogen, zinc-hydrogen, chromium-hydrogen, or molybdenum-hydrogen. The unique composition may be magnetic in the absence of known magnetism of corresponding composition comprising ordinary hydrogen if it exists. In exemplary embodiments, unique compositions polymeric iron-hydrogen, chromium-hydrogen, titanium-hydrogen, zinc-hydrogen, molybdenum-hydrogen, and tungsten-hydrogen are magnetic. The macro-aggregates or polymers comprising lower-energy hydrogen species such as molecular hydrino may be identified by (i) time of flight secondary ion mass spectroscopy (ToF-SIMS) that may unequivocally record the unique metal and hydrogen composition such as FeH and MoH₁₆ based on high mass resolution of the metal and hydride ions and high-mass fragments such as those of H₁₆ and H₂₄; (ii) Fourier transform infrared spectroscopy (FTIR) that may record at least one of the H₂(1/4) rotational energy at about 1940 cm⁻¹ and libation bands in the finger print region wherein other high energy features of known functional groups may be absent, (iii) proton magic-angle spinning nuclear magnetic resonance spectroscopy ('H MAS NMR) that may record an upfield matrix peak such as one in the −4 ppm to −6 ppm region, (iv) X-ray diffraction (XRD) that may record novel peaks due to the unique composition that may comprise a polymeric structure, (v) thermal gravimetric analysis (TGA) that may record a decomposition of the hydrogen polymers at very low temperature such as in the region of 200° C. to 900° C. and provide the unique hydrogen stoichiometry or composition such as FeH or MoH₁₆, (vi) e-beam excitation emission spectroscopy that may record the H₂(1/4) ro-vibrational band in the 260 nm region comprising peaks spaced at 0.25 eV; (vii) photoluminescence Raman spectroscopy that may record the second order of the H₂(1/4) ro-vibrational band in the 260 nm region comprising peaks spaced at 0.25 eV; (viii) Raman spectroscopy that may record the H₂(1/4) rotational peak at about 1940 cm⁻¹, and (ix) X-ray photoelectron spectroscopy (XPS) that may record the total energy of H₂(1/4) at about 500 eV.

In an embodiment, an apparatus to collect molecular hydrino in gaseous, physi-absorbed, liquefied, or in other state comprises a source of macro-aggregates or polymers comprising lower-energy hydrogen species, a chamber to contain the macro-aggregates or polymers comprising lower-energy hydrogen species, a means to thermally decompose the macro-aggregates or polymers comprising lower-energy hydrogen species in the chamber, and a means to collect the gas released from the macro-aggregates or polymers comprising lower-energy hydrogen species. The decomposition means may comprise a heater. The heater may heat the first chamber to a temperature greater that the decomposition temperature of the macro-aggregates or polymers comprising lower-energy hydrogen species such as a temperature in at least one range of about 10° C. to 3000° C., 100° C. to 2000° C., and 100° C. to 1000° C. The means to collect the gas from decomposition of macro-aggregates or polymers comprising lower-energy hydrogen species may comprise a second chamber. The second chamber may comprise at least one of a gas pump, a gas valve, a pressure gauge, and a mass flow controller to at least one of store and transfer the collected molecular hydrino gas. The second chamber may further comprise a getter to absorb molecular hydrino gas or a chiller such as a cryogenic system to liquefy molecular hydrino. The chiller may comprise a cryopump or dewar containing a cryogenic liquid such as liquid helium or liquid nitrogen.

The means to form macro-aggregates or polymers comprising lower-energy hydrogen species may further comprise a source of field such as a source of at least one of an electric field or a magnetic field. The source of the electric field may comprise at least two electrodes and a source of voltage to apply the electric field to the reaction chamber wherein the aggregate or polymers are formed. Alternatively, the source of electric field may comprise an electrostatically charged material. The electrostatically charged material may comprise the reaction cell chamber such as a chamber comprising carbon such as a Plexiglas chamber. The detonation of the disclosure may electrostatically charge the reaction cell chamber. The source of the magnetic field may comprise at least one magnet such as a permanent, electromagnet, or a superconducting magnet to apply the magnetic field to the reaction chamber wherein the aggregate or polymers are formed.

Molecular hydrino may comprise a finite £ quantum number corresponding to orbital angular momentum. The electron orbital angular momentum of a plurality of hydrino molecules such as H₂(1/4) may phase couple to give rise to permanent magnetization. Ordinarily, the angular momentum and the corresponding magnetic moment averages to zero and there is no net macroscopic or bulk magnetism due to orbital angular momentum. However, molecular hydrino may give rise to non-zero or finite bulk magnetism when the angular momentum magnetic moments of a plurality of molecules interact cooperatively wherein magnetic self assemble may occur. The trigonometric function spatial-temporal dependence Eqs. (1.67, 1.76, 1.77, 2.66-2.71) of Mills GUT transforms to a trigonometric function squared term that does not average to zero. Due to the magnetism, molecular hydrino may be uniquely identified by electron paramagnetic resonance spectroscopy (EPR). Unique EPR nuclear coupling as well as electron nuclear double resonance spectroscopy (ENDOR) signatures due to the reduced electron radius and internuclear distance are further characteristic and uniquely identify molecular hydrino.

Molecular hydrino such as H₂(1/4) may have non-zero l and mₗ quantum numbers corresponding to orbital angular momentum with a corresponding magnetic moment. The magnetic characteristic of molecular hydrino is demonstrated by proton magic angle spinning nuclear magnetic resonance spectroscopy (¹H MAS NMR). The presence of molecular hydrino in a solid matrix such as an alkali hydroxide-alkali halide matrix that may further comprise some waters of hydration gives rise to an upfield ¹H MAS NMR peak, typically at −4 to −6 ppm due to the molecular hydrinos' paramagnetic matrix effect. A convenient method to produce molecular hydrino in non-zero angular momentum states is by wire detonation in the presence of H₂O to serve as the hydrino catalyst and source of H. Wire detonations in an atmosphere comprising water vapor produces magnetic linear chains comprising hydrino hydrogen such as molecular hydrino possessing nonzero l and mₗ quantum states with metal atoms or ions that may aggregate to forms webs. The self-assembly mechanism may comprise a magnetic ordering or self-assembly mechanism. It is well known that the application of an external magnetic field causes colloidal magnetic nanoparticles such as magnetite (Fe₂O₃) suspended in a solvent such as toluene to assemble in to linear structures. Due to the small mass and high magnetic moment molecular hydrino magnetically self assembles even in the absence of a magnetic field. In an embodiment to enhance the self-assembly and to control the formation of alternative structures of the hydrino products, an external magnetic field is applied to the hydrino reaction such as the wire detonation. The magnetic field may be applied by placing at least one permanent magnet in the reaction chamber. Alternatively, the detonation wire may comprise a metal that serves as a source of magnetic particles such as magnetite to drive the magnetic self-assembly of molecular hydrino wherein the source may be the wire detonation in water vapor or another source.

In an embodiment, molecular hydrino may comprise a nonzero angular momentum quantum number. The molecular hydrino may be magnetic wherein the magnetism may be due to a nonzero angular momentum quantum number. Due to its intrinsic magnetic moment, molecular hydrino may self assemble into macroaggregates. In an embodiment, molecular hydrino such as H₂(1/4) may assemble into linear chains bound by magnetic dipole forces. In another embodiment, molecular hydrino can assemble into three-dimensional structures such as a cube having H₂(1/p) such as H₂(1/4) at each of the eight vertices. In an embodiment, eight H₂(1/p) molecules such as H₂(1/4) molecules are magnetically bound into a cube wherein the center of each molecule is at one of the eight vertices of the cube, and each inter-nuclear axis is parallel to an edge of the cube centered on a vertex. The magnetic alignment is such that the each north and south-pole of each molecular diploe is oppositely oriented with each of its three nearest neighbors of the cube. H₁₆ may serve as a unit or moiety for more complex macrostructures formed by self-assembly. In another embodiment, units of Hₛ comprising H₂(1/p) such as H₂(1/4) at each of the four vertices of a square may be added to the cuboid H₁₆ to comprise H₁₆₊₈ₙ wherein n is an integer. Exemplary additional macroaggregates are H₁₆, H₂₄, and H₃₂. The hydrogen macroaggregate neutrals and ions may combine with other species such as O, OH, C, and N as neutrals or ions. In an embodiment, the resulting structure gives rise to an H₁₆ peak in the time-of-flight secondary ion mass spectrum (ToF-SIMS) wherein fragments may be observed masses corresponding to integer H loss from H₁₆ such as H₁₆, H₁₄, H₁₃, and H₁₂. Due to the mass of H of 1.00794 u, the corresponding +1 or −1 ion peaks have masses of 16.125, 15.119, 14.111, 13.103, 12.095 . . . . The hydrogen macroaggregate ions such as H₁₆⁻ or H₁₆⁺ may comprise metastables. The hydrogen macroaggregate ions H₁₆⁻ and H₁₆⁺ having metastable features of broad peaks were observed by ToF-SIMS at 16.125 in the positive and negative spectra. H₁₅⁻ was observed in the negative ToF-SIMS spectrum at 15.119. H₂₄ metastable species H₂₃ and H₂₅ were observed in the positive and negative ToF-SIMS spectra, respectively.

In an embodiment, a molecular hydrino macroaggregate such as H₁₆ or a decomposition product such as H₂(1/p) such as H₂(1/4) may comprise a magnetic resonance imaging (MM) contrast agent such as spin polarized Xeon. Molecular hydrino may be inhaled and used in MRI imaging due at least one of its NMR active protons that are imaged or its effect on normal protons such as those of water molecules of the body of the imaged person, animal, or object wherein the paramagnetism of molecular hydrino effects at least one of the corresponding NMR shift or a relaxation time such as at least one of T₁ and T₂. In an embodiment, para form of molecular hydrino may be converted to the NMR active ortho form by spin exchange. The spin exchange may be achieved using a spin exchange agent such as a magnetic species such as magnetite (Fe₂O₃) particles. The gas may be incubated with the spin exchange agent to achieve the conversion to ortho form of H₂(1/p). The lifetime of the ortho form in the body may be used as the basis of a MRI contrast agent.

In an embodiment, a hydrino species such as atomic hydrino, molecular hydrino, or hydrino hydride ion is synthesized by the reaction of H and at least one of OH and H₂O catalyst. In an embodiment, the product of at least one of the SunCell® reaction and the energetic reactions such as ones comprising shot or wire ignitions of the disclosure to form hydrinos is a hydrino compound or species comprising a hydrino species such as H₂(1/p) complexed with at least one of (i) an element other than hydrogen, (ii) an ordinary hydrogen species such as at least one of H⁺, ordinary H₂, ordinary H⁻, and ordinary H₃⁺, an organic molecular species such as an organic ion or organic molecule, and (iv) an inorganic species such as an inorganic ion or inorganic compound. The hydrino compound may comprise an oxyanion compound such as an alkali or alkaline earth carbonate or hydroxide or other such compounds of the present disclosure. In an embodiment, the product comprises at least one of M₂CO₃.H₂ (1/ 4) and MOH.H₂ (1/ 4) (M=alkali or other cation of the present disclosure) complex. The product may be identified by ToF-SIMS as a series of ions in the positive spectrum comprising M(M₂CO₃.H₂ 1/4))ₙ⁻, and M(MOH.H₂(1/4))ₙ⁺, respectively, wherein n is an integer and an integer and integer p>1 may be substituted for 4. In an embodiment, a compound comprising silicon and oxygen such as SiO₂ or quartz may serve as a getter for H₂(1/4). The getter for H₂(1/4) may comprise a transition metal, alkali metal, alkaline earth metal, inner transition metal, rare earth metal, combinations of metals, alloys such as a Mo alloy such as MoCu, and hydrogen storage materials such as those of the present disclosure.

The compounds comprising hydrino species synthesized by the methods of the present disclosure may have the formula MH, MH₂, or M₂H₂, wherein M is an alkali cation and H is a hydrino species. The compound may have the formula MHₙ wherein n is 1 or 2, M is an alkaline earth cation and H is hydrino species. The compound may have the formula MHX wherein M is an alkali cation, X is one of a neutral atom such as halogen atom, a molecule, or a singly negatively charged anion such as halogen anion, and H is a hydrino species. The compound may have the formula MHX wherein M is an alkaline earth cation, X is a singly negatively charged anion, and H is H is a hydrino species. The compound may have the formula MHX wherein M is an alkaline earth cation, X is a double negatively charged anion, and H is a hydrino species. The compound may have the formula M₂HX wherein M is an alkali cation, X is a singly negatively charged anion, and H is a hydrino species. The compound may have the formula MHₙ wherein n is an integer, M is an alkaline cation and the hydrogen content Hₙ of the compound comprises at least one hydrino species. The compound may have the formula M₂Hₙ wherein n is an integer, M is an alkaline earth cation and the hydrogen content Hₙ of the compound comprises at least one hydrino species. The compound may have the formula M₂XHₙ wherein n is an integer, M is an alkaline earth cation, X is a singly negatively charged anion, and the hydrogen content Hₙ of the compound comprises at least one hydrino species. The compound may have the formula M₂X₂Hₙ wherein n is 1 or 2, M is an alkaline earth cation, X is a singly negatively charged anion, and the hydrogen content Hₙ of the compound comprises at least one hydrino species. The compound may have the formula M₂X₃H wherein M is an alkaline earth cation, X is a singly negatively charged anion, and H is a hydrino species. The compound may have the formula M₂XHₙ wherein n is 1 or 2, M is an alkaline earth cation, X is a double negatively charged anion, and the hydrogen content Hₙ of the compound comprises at least one hydrino species. The compound may have the formula M₂XX′H wherein M is an alkaline earth cation, X is a singly negatively charged anion, X′ is a double negatively charged anion, and H is hydrino species. The compound may have the formula MM′Hₙ wherein n is an integer from 1 to 3, M is an alkaline earth cation, M′ is an alkali metal cation and the hydrogen content Hₙ of the compound comprises at least one hydrino species. The compound may have the formula MM′XHₙ wherein n is 1 or 2, M is an alkaline earth cation, M′ is an alkali metal cation, X is a singly negatively charged anion and the hydrogen content Hₙ of the compound comprises at least one hydrino species. The compound may have the formula MM′XH wherein M is an alkaline earth cation, M′ is an alkali metal cation, X is a double negatively charged anion and H is a hydrino species. The compound may have the formula MM′XX′H wherein M is an alkaline earth cation, M′ is an alkali metal cation, X and X′ are singly negatively charged anion and H is a hydrino species. The compound may have the formula MXX′Hₙ wherein n is an integer from 1 to 5, M is an alkali or alkaline earth cation, X is a singly or double negatively charged anion, X′ is a metal or metalloid, a transition element, an inner transition element, or a rare earth element, and the hydrogen content Hₙ of the compound comprises at least one hydrino species. The compound may have the formula MHₙ wherein n is an integer, M is a cation such as a transition element, an inner transition element, or a rare earth element, and the hydrogen content Hₙ of the compound comprises at least one hydrino species. The compound may have the formula MXHₙ wherein n is an integer, M is an cation such as an alkali cation, alkaline earth cation, X is another cation such as a transition element, inner transition element, or a rare earth element cation, and the hydrogen content Hₙ of the compound comprises at least one hydrino species. The compound may have the formula (MHₘMCO₃)ₙ wherein M is an alkali cation or other +1 cation, m and n are each an integer, and the hydrogen content H., of the compound comprises at least one hydrino species. The compound may have the formula (MHₘMNO₃)ₙ⁻ nX⁻ wherein M is an alkali cation or other +1 cation, m and n are each an integer, X is a singly negatively charged anion, and the hydrogen content Hₘ of the compound comprises at least one hydrino species. The compound may have the formula (MHMNO₃)ₙ wherein M is an alkali cation or other +1 cation, n is an integer and the hydrogen content H of the compound comprises at least one hydrino species. The compound may have the formula (MHMOH)ₙ wherein M is an alkali cation or other +1 cation, n is an integer, and the hydrogen content H of the compound comprises at least one hydrino species. The compound including an anion or cation may have the formula (MHₘM′X)ₙ wherein m and n are each an integer, M and M′ are each an alkali or alkaline earth cation, X is a singly or double negatively charged anion, and the hydrogen content Hₘ of the compound comprises at least one hydrino species. The compound including an anion or cation may have the formula (MHₘM′X′)ₙ⁺ X⁻ wherein m and n are each an integer, M and M′ are each an alkali or alkaline earth cation, X and X′ are a singly or double negatively charged anion, and the hydrogen content Hₘ of the compound comprises at least one hydrino species. The anion may comprise one of those of the disclosure. Suitable exemplary singly negatively charged anions are halide ion, hydroxide ion, hydrogen carbonate ion, or nitrate ion. Suitable exemplary double negatively charged anions are carbonate ion, oxide, or sulfate ion.

In an embodiment, the hydrino compound or mixture comprises at least one hydrino species such as a hydrino atom, hydrino hydride ion, and dihydrino molecule embedded in a lattice such as a crystalline lattice such as in a metallic or ionic lattice. In an embodiment, the lattice is non-reactive with the hydrino species. The matrix may be aprotic such as in the case of embedded hydrino hydride ions. The compound or mixture may comprise at least one of H(1/p), H₂(1/p), and H⁻(1/p) embedded in a salt lattice such as an alkali or alkaline earth salt such as a halide. Exemplary alkali halides are KCl and Kl. The salt may be absent any H₂O in the case of embedded H⁻(1/p). Other suitable salt lattices comprise those of the present disclosure.

The hydrino compounds of the present invention are preferably greater than 0.1 atomic percent pure. More preferably, the compounds are greater than 1 atomic percent pure. Even more preferably, the compounds are greater than 10 atomic percent pure. Most preferably, the compounds are greater than 50 atomic percent pure. In another embodiment, the compounds are greater than 90 atomic percent pure. In another embodiment, the compounds are greater than 95 atomic percent pure.

Experimental

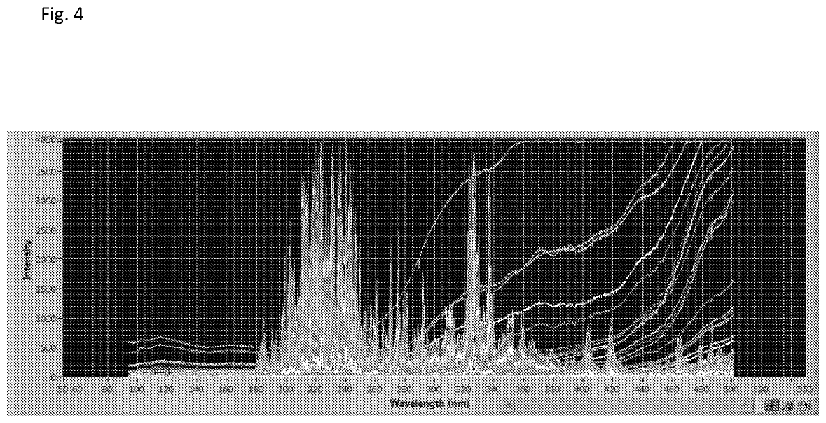

The SF-CIHT cell power generation system includes a photovoltaic power converter configured to capture plasma photons generated by the fuel ignition reaction and convert them into useable energy. In some embodiments, high conversion efficiency may be desired. The reactor may expel plasma in multiple directions, e.g., at least two directions, and the radius of the reaction may be on the scale of approximately several millimeters to several meters, for example, from about 1 mm to about 25 cm in radius. Additionally, the spectrum of plasma generated by the ignition of fuel may resemble the spectrum of plasma generated by the sun and/or may include additional short wavelength radiation. FIG. 4 shows an exemplary the absolute spectrum in the 5 nm to 450 nm region of the ignition of a 80 mg shot of silver comprising absorbed H₂O from water addition to melted silver as it cooled into shots showing an average optical power of 1.3 MW, essentially all in the ultraviolet and extreme ultraviolet spectral region. The ignition was achieved with a low voltage, high current using a Taylor-Winfield model ND-24-75 spot welder. The voltage drop across the shot was less than 1 V and the current was about 25 kA. The high intensity UV emission had duration of about 1 ms. The control spectrum was flat in the UV region. The radiation of the solid fuel such as at least one of line and blackbody emission may have an intensity in at least one range of about 2 to 200,000 suns, 10 to 100,000 suns, 100 to 75,000 suns. In an embodiment, the inductance of the welder ignition circuit may be increased to increase the current decay time following ignition. The longer decay time may maintain the hydrino plasma reaction to increase the energy production.

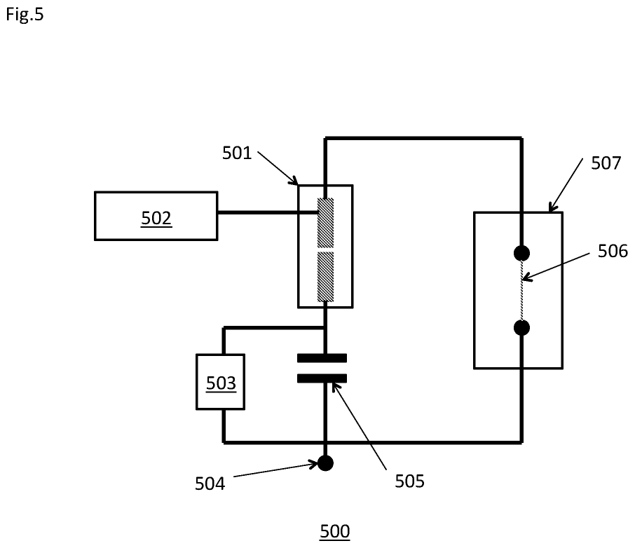

The UV and EUV spectrum may be converted to blackbody radiation. The conversion may be achieved by causing the cell atmosphere to be optically thick for the propagation of at least one of UV and EUV photons. The optical thickness may be increased by causing metal such as the fuel metal to vaporize in the cell. The optically thick plasma may comprise a blackbody. The blackbody temperature may be high due to the extraordinarily high power density capacity of the hydrino reaction and the high energy of the photons emitted by the hydrino reaction. The spectrum (100 nm to 500 nm region with a cutoff at 180 nm due to the sapphire spectrometer window) of the ignition of molten silver pumped into W electrodes in atmospheric argon with an ambient H₂O vapor pressure of about 1 Torr is shown in FIG. 5. The source of electrical power 2 comprised two sets of two capacitors in series (Maxwell Technologies K2 Ultracapacitor 2.85V/3400F) that were connected in parallel to provide about 5 to 6 V and 300 A of constant current with superimposed current pulses to 5kA at frequency of about 1 kHz to 2 kHz. The average input power to the W electrodes (1 cm×4 cm) was about 75 W. The initial UV line emission transitioned to 5000K blackbody radiation when the atmosphere became optically thick to the UV radiation with the vaporization of the silver by the hydrino reaction power. The power density of a 5000K blackbody radiator with an emissivity of vaporized silver of 0.15 is 5.3 MW/m². The area of the observed plasma was about 1 m². The blackbody radiation may heat a component of the cell 26 such as top cover 5b4 that may serve as a blackbody radiator to the PV converter 26a in a thermophotovoltaic embodiment of the disclosure.

An exemplary test of a melt comprising a source of oxygen comprised the ignition an 80 mg silver/1 wt % borax anhydrate shot in an argon/5 mole % H₂ atmosphere with the optical power determined by absolute spectroscopy. Using a welder (Acme 75 KVA spot welder) to apply a high current of about 12 kA at a voltage drop of about 1 V 250 kW of power was observed for duration of about 1 ms. In another exemplary test of a melt comprising a source of oxygen comprised the ignition an 80 mg silver/2 mol % Na₂O anhydrate shot in an argon/5 mole % H₂ atmosphere with the optical power determined by absolute spectroscopy. Using a welder (Acme 75 KVA spot welder) to apply a high current of about 12 kA at a voltage drop of about 1 V 370 kW of power was observed for duration of about 1 ms. In another exemplary test of a melt comprising a source of oxygen comprised the ignition an 80 mg silver/2 mol % Li₂O anhydrate shot in an argon/5 mole % H₂ atmosphere with the optical power determined by absolute spectroscopy. Using a welder (Acme 75 KVA spot welder) to apply a high current of about 12 kA at a voltage drop of about 1 V 500 kW of power was observed for duration of about 1 ms.

Based on the size of the plasma recorded with an Edgertronics high-speed video camera, the hydrino reaction and power depends on the reaction volume. The volume may need to be a minimum for optimization of the reaction power and energy such as about 0.5 to 10 liters for the ignition of a shot of about 30 to 100 mg such as a silver shot and a source of H and HOH catalyst such as hydration. From the shot ignition, the hydrino reaction rate is high at very high silver pressure. In an embodiment, the hydrino reaction may have high kinetics with the high plasma pressure. Based on high-speed spectroscopic and Edgertronics data, the hydrino reaction rate is highest at the initiation when the plasma volume is the lowest and the Ag vapor pressure is the highest. The 1 mm diameter Ag shot ignites when molten (T=1235 K). The initial volume for the 80 mg (7.4×10⁻⁴ moles) shot is 5.2×10⁻⁷ liters. The corresponding maximum pressure is about 1.4×10⁵ atm. In an exemplary embodiment, the reaction was observed to expand at about sound speed (343 m/s) for the reaction duration of about 0.5 ms. The final radius was about 17 cm. The final volume without any backpressure was about 20 liters. The final Ag partial pressure was about 3.7E-3 atm. Since the reaction may have higher kinetics at higher pressure, the reaction rate may be increased by electrode confinement by applying electrode pressure and allowing the plasma to expand perpendicular to the inter-electrode axis.

The power released by the hydrino reaction caused by the addition of one mole % or 0.5 mole % bismuth oxide to molten silver injected into ignition electrodes of a SunCell® at 2.5 ml/s in the presence of a 97% argon/3% hydrogen atmosphere was measured. The relative change in slope of the temporal reaction cell water coolant temperature before and after the addition of the hydrino reaction power contribution corresponding to the oxide addition was multiplied by the constant initial input power that served as an internal standard. For duplicate runs, the total cell output powers with the hydrino power contribution following oxygen source addition were determined by the products of the ratios of the slopes of the temporal coolant temperature responses of 97, 119, 15, 538, 181, 54, and 27 corresponding to total input powers of 7540 W, 8300 W, 8400 W, 9700 W, 8660 W, 8020 W, and 10,450 W. The thermal burst powers were 731,000 W, 987,700 W, 126,000 W, 5,220,000 W, 1,567,000 W, 433,100 W, and 282,150 W, respectively.

The power released by the hydrino reaction caused by the addition of one mole % bismuth oxide (Bi₂O₃), one mole % lithium vanadate (LiVO₃), or 0.5 mole % lithium vanadate to molten silver injected into ignition electrodes of a SunCell® at 2.5 ml/s in the presence of a 97% argon/3% hydrogen atmosphere was measured. The relative change in slope of the temporal reaction cell water coolant temperature before and after the addition of the hydrino reaction power contribution corresponding to the oxide addition was multiplied by the constant initial input power that served as an internal standard. For duplicate runs, the total cell output powers with the hydrino power contribution following oxygen source addition were determined by the products of the ratios of the slopes of the temporal coolant temperature responses of 497, 200, and 26 corresponding to total input powers of 6420 W, 9000 W, and 8790 W. The thermal burst powers were 3.2 MW, 1.8 MW, and 230,000 W, respectively.

In an exemplary embodiment, the ignition current was ramped from about 0 A to 2000 A corresponding to a voltage increase from about 0 V to 1 V in about 0.5, at which voltage the plasma ignited. The voltage is then increased as a step to about 16 V and held for about 0.25 s wherein about 1 kA flowed through the melt and 1.5 kA flowed in series through the bulk of the plasma through another ground loop other than the electrode 8. With an input power of about 25 kW to a SunCell® comprising Ag (0.5 mole % LiVO₃) and argon-H₂ (3%) at a flow rate of 9 liters/s, the power output was over 1 MW. The ignition sequence repeated at about 1.3 Hz.

In an exemplary embodiment, the ignition current was about 500 A constant current and the voltage was about 20 V. With an input power of about 15 kW to a SunCell® comprising Ag (0.5 mole % LiVO₃) and argon-H₂ (3%) at a flow rate of 9 liters/s, the power output was over 1 MW.

In an embodiment shown in FIG. 6, the system 500 to form macro-aggregates or polymers comprising lower-energy hydrogen species comprises a chamber 507 such as a Plexiglas chamber, a metal wire 506, a high voltage capacitor 505 with ground connection 504 that may be charged by a high voltage DC power supply 503, and a switch such as a 12 V electric switch 502 and a triggered spark gap switch 501 to close the circuit from the capacitor to the metal wire 506 inside of the chamber 507 to cause the wire to detonate. The chamber may comprise water vapor and a gas such as atmospheric air or a noble gas.

An exemplary system to form macro-aggregates or polymers comprising lower-energy hydrogen species comprises a closed rectangular cuboid Plexiglas chamber having a length of 46 cm and a width and height of 12.7 cm, a 10.2 cm long, 0.220.5 mm diameter metal wire mounted between two stainless poles with stainless nuts at a distance of 9 cm from the chamber floor, a 15 kV capacitor (Westinghouse model 5PH349001AAA, 55 uF) charged to about 4.5 kV corresponding to 557 J, a 35 kV DC power supply to charge the capacitor, and a 12 V switch with a triggered spark gap switch (Information Unlimited, model-Trigatron10, 3 kJ) to close the circuit from the capacitor to the metal wire inside of the chamber to cause the wire to detonate. The wire may comprise a Mo (molybdenum gauze, 20 mesh from 0.305 mm diameter wire, 99.95%, Alpha Aesar), Zn (0.25 mm diameter, 99.993%, Alpha Aesar), Fe—Cr—Al alloy (73%-22%-4.8%, 31 gauge, 0.226 mm diameter, KD Cr—Al—Fe alloy wire Part No #1231201848, Hyndman Industrial Products Inc.), or Ti (0.25 mm diameter, 99.99%, Alpha Aesar) wire. In an exemplary run, the chamber contained air comprising about 20 Torr of water vapor. The high voltage DC power supply was turned off before closing the trigger switch. The peak voltage of about 4.5 kV discharged as a damped harmonic oscillator over about 300 us at a peak current of 5 kA. Macro-aggregates or polymers comprising lower-energy hydrogen species formed in about 3-10 minutes after the wire detonation. Analytical samples were collected from the chamber floor and wall, as well as on a Si wafer placed in the chamber. The analytical results matched the hydrino signatures of the disclosure.

In an embodiment, the hydrino ro-vibrational spectrum is observed by electron-beam excitation of a reaction mixture gas comprising inert gas such as argon gas and water vapor that serves as the source of HOH catalyst and atomic hydrogen. The argon may be in a pressure range of about 100 Torr to 10 atm. The water vapor may be in the range of about 1 micro-Torr to 10 Torr. The electron beam energy may be in the range of about 1 keV to 100 keV. Rotational lines were observed in the 145-300 nm region from atmospheric pressure argon plasmas comprising about 100 mTorr water vapor excited by a 12 keV to 16 keV electron-beam incident the gas in a chamber through a silicon nitride window. The emission was observed through MgF₂ another window of the reaction gas chamber. The energy spacing of 4² times that of hydrogen established the internuclear distance as 1/4 that of H₂ and identified H₂(1/4) (Eqs. (29-31)). The series matched the P branch of H₂(1/4) for the H₂(1/4) vibrational transition v=1→v=0 comprising P(1), P(2), P(3), P(4), P(5), and P(6) that were observed at 154.94, 159.74, 165.54, 171.24, 178.14, and 183.14 nm, respectively. In another embodiment, a composition of matter comprising hydrino such as one of the disclosure is thermally decomposed and the decomposition gas comprising hydrino such a H₂(1/4) is introduced into the reaction gas chamber wherein the hydrino gas is excited with the electron beam and the ro-vibrational emission spectrum is recorded.

In another embodiment, hydrino gas such as H₂(1/4) is absorbed in a getter such as an alkali halide or alkali halide alkali hydroxide matrix. The rotational vibrational spectrum may be observed by electron beam excitation of the getter in vacuum. The electron beam energy may be in the range of about 1 keV to 100 keV. The rotational energy spacing between peaks may be given by Eq. (30). The vibrational energy given by Eq. (29) may be shifted to lower energy due to a higher effective mass caused by the crystalline matrix. In an exemplary experimental example, ro-vibrational emission of H₂ (1/4) trapped in the crystalline lattice of getters was excited by an incident 6 KeV electron gun with a beam current of 10-20 μA in the pressure range of 5×10⁻⁶ Torr, and recorded by windowless

UV spectroscopy. The resolved ro-vibrational spectrum of H₂(1/4) (so called 260 nm band) in the UV transparent matrix KCl that served as a getter in a 5 W CIHT cell stack of Mills et al. (R. Mills, X Yu, Y. Lu, G Chu, J. He, J. Lotoski, “Catalyst induced hydrino transition (CIHT) electrochemical cell,” (2012), Int. J. Energy Res., (2013), DOI: 10.1002/er.3142 which is incorporated by reference) comprised a peak maximum at 258 nm with representative positions of the peaks at 222.7, 233.9, 245.4, 258.0, 272.2, and 287.6 nm, having an equal spacing of 0.2491 eV. In general, the plot of the energy versus peak number yields a line given by y=−0.249 eV +5.8 eV at R²=0.999 or better in very good agreement with the predicted values for H₂(1/4) for the transitions v=1→v=0 and Q(0), R(0), R(1), R(2), P(1), P(2), P(3), and P(4) wherein Q(0) is identifiable as the most intense peak of the series.

Furthermore, positive ion ToF-SIMS spectra of the getter having absorbed hydrino reaction product gas showed multimer clusters of matrix compounds with di-hydrogen as part of the structure, M:H₂ (M=KOH or K₂CO₃). Specifically, the positive ion spectra of prior hydrino reaction products comprising KOH and K₂CO₃ [26-27] or having these compounds as getters of hydrino reaction product gas showed K⁺(H₂:KOH)ₙ and K⁺(H₂:K₂CO₃)ₙ consistent with H₂(1/p) as a complex in the structure.

In another embodiment, the hydrino ro-vibrational spectrum is observed by electron-beam excitation of a composition matter comprising hydrino such as a molecular hydrino compound or macroaggregate such as H₁₆ or a decomposition product such as H₂(1/p). The composition of matter comprising hydrino may comprise a hydrino compound of the disclosure. The electron beam energy may be in the range of about 1 keV to 100 keV. The emission spectrum may be recorded in vacuum by EUV spectroscopy. In an exemplary experimental embodiment, H₂(1/4) ro-vibrational lines were observed in the 145-300 nm region from zinc hydrino hydride by 12 keV to 16 keV electron-beam exciation. The beam was incident the compound in vacuum. The zinc hydrino hydride was formed by zinc wire detonation in the presence of water vapor in air according to the methods of the disclosure. The energy spacing of 4² times that of hydrogen established the internuclear distance as 1/4 that of H₂ and identified H₂(1/4) (Eqs. (29-31)). The series matched the P branch of H₂(1/4) for the H₂(1/4) vibrational transition v=1→v=0 comprising P(1), P(2), P(3), P(4), P(5), P(6), and P(7).

1. A power system that generates at least one of electrical energy and thermal energy comprising:
at least one vessel capable of a maintaining a pressure of below, at, or above atmospheric; reactants, the reactants comprising:
a. at least one source of catalyst or a catalyst comprising nascent H₂O;
b. at least one source of H₂O or H₂O;
c. at least one source of atomic hydrogen or atomic hydrogen; and
d. a molten metal;
a molten metal injection system comprising at least two metalreservoirs each molted comprising a pump and an injector tube;
at least one reactant supply system to replenish reactants that are consumed in a reaction of the reactants to generate at least one of the electrical energy and thermal energy;
at least one ignition system comprising a source of electrical power to supply opposite voltages to the at least two molten metal reservoirs each comprising an electromagnetic pump, and
at least one power converter or output system of at least one of the light and thermal output to electrical power and/or thermal power.

2. The power system of Claim I wherein the molten metal injection system comprises the at least two molten metal reservoirs each comprising an electromagnetic pump to inject streams of the molten metal that intersect inside of the vessel.

3. The power system of claim 1 wherein each reservoir comprises a molten metal level controller comprising an inlet riser tube.

4. The power system of claim 1 wherein the ignition system comprises a source of electrical power to supply opposite voltages to the at least two molten metal reservoirs each comprising an electromagnetic pump that supplies current and power flow through the intersecting streams of molten metal to cause the reaction of the reactants comprising ignition to form a plasma inside of the vessel.

5. The power system of claim 1 wherein the ignition system comprises:
a. the source of electrical power to supply opposite voltages to the at least two molten metal reservoirs each comprising an electromagnetic pump;
b. at least two intersecting streams of molten metal ejected from the at least two molten metal reservoirs each comprising an electromagnetic pump wherein the source of electrical power is capable of delivering a short burst of high-current electrical energy sufficient to cause the reactants to react to form plasma.

6. (canceled)

7. The power system of claim 1 wherein each electromagnetic pump comprises one of a
a. DC or AC conduction type comprising a DC or AC current source supplied to the molten metal through electrodes and a source of constant or in-phase alternating vector-crossed magnetic field, or
b. induction type comprising a source of alternating magnetic field through a shorted loop of molten metal that induces an alternating current in the metal and a source of in-phase alternating vector-crossed magnetic field.

8-9. (canceled)

10. The power system of claim 4 wherein the molten metal ignition system current is in the range of 10 A to 50,000 A.

11. The power system of claim 10 wherein the circuit of the molten metal ignition system is closed by the intersection of the molten metal streams to cause ignition to further cause an ignition frequency in the range of 0 Hz to 10,000 Hz.

12. The power system of claim 7 wherein the induction-type electromagnetic pump comprises ceramic channels that forms the shorted loop of molten metal.

13. (canceled)

14. The power system of claim 1 wherein the molten metal comprises at least one of silver, silver-copper alloy, and copper.

15. (canceled)

16. The power system of claim 1 wherein the at least one power converter or output system of the reaction power output comprises at least one of the group of a thermophotovoltaic converter, a photovoltaic converter, a photoelectronic converter, a magnetohydrodynamic converter, a plasmadynamic converter, a thermionic converter, a thermoelectric converter, a Sterling engine, a Brayton cycle engine, a Rankine cycle engine, and a heat engine, a heater, and a boiler.

17. (canceled)

18. The power system of claim 16 wherein a portion of the vessel comprises a blackbody radiator that is maintained at a temperature in the range of 1000 K to 3700 K.

19-21. (canceled)

22. The power system of claim 21 comprising a therrnophotovoltaic converter or a photovoltaic converter wherein the light emitted by the blackbody radiator is predominantly blackbody radiation comprising visible and near infrared light, and the photovoltaic cells are concentrator cells that comprise at least one compound chosen from crystalline silicon, germanium, gallium arsenide (GaAs), gallium antimonide (GaSb), indium gallium arsenide (InGaAs), indium gallium arsenide antimonide (InGaAsSb), indium phosphide arsenide antimonide (InPAsSb), InGaP/InGaAs/Ge; InAlGaPIAIGaAs/GaInNAsSb/Ge; GaInP/GaAsP/SiGe; GaInP/GaAsP/Si; GaInP/GaAsP/Ge GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge.

23. (canceled)

24. The power system of claim 16 wherein the magnetohydrodynamic power converter comprises a nozzle connected to the reaction vessel, a magnetohydrodynamic channel, electrodes, magnets, a metal collection system, a metal recirculation system, a heat exchanger, and optionally a gas recirculation system.

25-29. (canceled)

30. The power system of claim 24 wherein the molten metal comprises silver and the magnetohydrodynatnic converter further comprises a source of oxygen to form an aerosol of silver particles supplied to at least one of the reservoirs, reaction vessel, magnetohydrodynamic nozzle, and magnetohydrodynamic channel.

31. (canceled)

32. The power system of claim 12 wherein the inductive type electromagnetic pump comprises a two-stage pump comprising a first stage that comprises a pump of the metal recirculation system, and a second stage that comprises the pump of the metal injection system to inject the stream of the molten metal that intersects with the other inside of the vessel.

33. The power system of claim 32 wherein ignition system comprising a source of electrical power comprises an induction ignition system.

34. The power system of claim 33 wherein induction ignition system comprises a source of alternating magnetic field through a shorted loop of molten metal that generates an alternating current in the metal that comprises the ignition current.

35. The power system of claim 34 wherein the source of alternating magnetic field may comprise a primary transformer winding comprising a transformer electromagnet and a transformer magnetic yoke, and the molten metal at least partially serves as a secondary transformer winding such as a single turn shorted winding that encloses the primary transformer winding and comprises as an induction current loop.

36. The power system of claim 35 wherein the reservoirs comprise a molten metal cross connecting channel that connects the two reservoirs such that the current loop encloses the transformer yoke wherein the induction current loop comprises the current generated in molten metal contained in the reservoirs, the cross connecting channel, the silver in the injector tubes, and the injected streams of molten metal that intersect to complete the induction current loop.
